(19) United States
(12) Patent Application Publication
(10) Pub. No.: US 2017/0058858 A1
(43) Pub. Date: Mar. 2, 2017

(54) MagnaFloat device generating clean electricity by using gravity, buoyancy, speed manipulation procedures and by passing magnets through inductors

(71) Applicant: Robert David Moose, East windsor, CT (US)

(72) Inventor: Robert David Moose, East windsor, CT (US)

(21) Appl. No.: 14/842,396

(22) Filed: Sep. 1, 2015

(51) Int. Cl. F03B 17/02

(52) U.S. Cl. CPC F03B 17/02

(57) ABSTRACT

The MagnaFloat, an energy generation device using gravity, buoyancy, pressure differentials, speed controls and linear motors to control the movement of buoyant canisters over and through a series of open, non-restricted pathways. Each canister has a magnet inside. While moving downward through Air (Drop Phase), ascending through Fluid (Floatation-ascent Phase), and upward through Air, these magnet-canisters pass through permanently attached inductors and electricity is produced. At conclusion of Floatation-ascent Phase, canisters exit Fluid and continue moving upward through Air into Pivot Bucket; Pivot Bucket is then rotated and canisters are ejected onto Inclined Platform. At bottom of overall device Passive Roller System changes direction of travel for canisters from downward vertical motion to horizontal motion, then later to upward vertical motion. While traveling horizontally, kinetic energy is extracted from fast moving canisters by acquiring and storing increased hydraulic pressure, which is converted into electricity.

### FIELD OF THE INVENTION

The present invention relates to the field of energy generation, and more specifically to a device that uses gravity and buoyancy to propel canisters containing magnets, in a speed-controlled environment, through a series of open, non-restricted pathways, and at certain points while either moving in air or ascending in a water-like fluid, these canisters with magnets inside pass through inductors and electricity is produced.

### BACKGROUND OF THE INVENTION

Mankind is more and more dependent on energy for: transportation, production of goods, heating and cooling, cooking, economic growth and even for basic human survival. This growing need for available energy is a combination of: a) an ever-expanding base of technology-related products that require more electricity, and b) population growth across the entire planet. Unfortunately, the fossil fuel sources for energy are pollution intensive; oil is harder to find now and is more expensive, major spills can occur, and eventually oil reserves will run out anyway. The “new” renewables of wind and solar do not produce much electricity and only work if nature cooperates. With regards to using nuclear technology, if there is an accident this can create a cancerous environment within twenty minutes for tens of thousands of people and within two weeks can leave entire regions of the earth uninhabitable for 20,000 years.

Another problem with current methods is that the majority of electricity is generated hundreds of miles from where that electricity is used. This creates an on-going need to construct, maintain, protect and preserve a massive power grid. Also, the electricity delivery process to end users for this type of power grid results in a huge waste of energy due to the transmission losses occurring over the interconnected maze of long distance power lines. And another related flaw is that systemic power outages can occur without warning, leaving tens of thousands of people without basic electricity for several days.

And even though it has not happened yet, every power grid in every nation is susceptible to an “off-world vulnerability” which is that if just one giant solar flare ever overpowers the earth's magnetic field, the entire planet could be left without electricity for years. The present invention has the ability to solve all of these problems, including even softening the threat from a massively destructive solar flare, because the present invention allows for literally millions of Local Power Grids to be created. With regards to the solar flare issue, three inherent protective advantages of the present invention are:

a) MagnaFloat technology (MagnaFloat device; MF device) functions by combining basic physics principles with low technology equipment (solenoids, stationary roller conveyors, motion sensors, basic hydraulic equipment, strands of wire wrapped in circular loops, etc.), and

b) the greatest majority of a MF device is underground, and even the electricity distribution hub of the device can be surrounded with extra layers of anti-EM-pulse shielding, and

c) because MF technology should create a global transportation shift to electric vehicles, there is at least some chance individuals could have transportation available even after a solar-related disaster.

Since a devastating Cosmic EM Pulse would surge through almost every electronic device and electric circuit board on the planet (or at least will destroy those electronic devices on the side of the earth that is facing the sun if such a solar flare hits), one might ask, “What good is having electricity available if there are no sophisticated electronic devices left to use that electricity?” The answer is that things like hot plates and light bulbs can still be used for cooking and for lighting. Plus as a society (and an economy) tries to rebuild itself, it will be essential for the factories that are producing the replacement products to have electricity available to power the manufacturing equipment being used in that rebuilding process. A MagnaFloat device, as a stand-alone electricity generation source, can provide that essential electricity to any factory, anywhere, anytime, without the need for even a city-wide power grid.

For the billions of people who would try to survive in houses and apartments with only “survival electricity” for a few years, that same MF-created electricity could also provide the power for electric vehicles, if circuit repair could be performed on these damaged vehicles over time. In this type of post-EM-surge world, MF technology could give people the ability to move themselves and products around, from place to place. Imagine three years of no electricity without transportation vs. three years of basic electricity with transportation—for a society or for the entire world. In conclusion of these types of discussions, because the present invention is much simpler than existing power generation and power grid technologies, the present invention is much more reliable in virtually any possible situation that could occur.

But moving past these improbable cosmic-related troubles, and in just thinking about everyday life, the undeniable fact is that the human race, for its own sake and for the sake and protection of the earth, itself, needs a safe, non-polluting, constantly available, inexpensive and localized method, technology or device to efficiently produce all the power required to “Run the 21st Century” and beyond. In attempts to satisfy this need, some prior art has been presented where the primary focus of such prior art was to go beyond all of the “traditional” energy sources and find a new way to provide energy to the citizens of the world. Specifically, one area of investigation has focused on two readily available, dynamic, free, clean and virtually unlimited sources of power: gravity and buoyancy. In particular, some prior art has attempted to show how these two eternal forces could be used in combination with each other in one device, a dual-sided device powered by gravity on one side and buoyancy on the other, that would be a device capable of generating a positive net amount of power on a continuous basis.

However, not even one of these inventors has been able to successfully develop a workable and commercially viable device or method that employs the dual interaction of gravity and buoyancy to produce electricity (or to produce rotational power). I have never seen one newscaster speak about, nor have I ever read one piece of information explaining how a new and successful source of energy is being marketed that uses gravity and buoyancy to produce commercial electricity or to provide any form of rotational power. Instead, people are still crying out everywhere for “some device” (some solution) that will provide the public with the real benefits just described, but no one until now has been able to define what that device is.

The present invention has an essential key, which is a key that all of these creators of this related prior art have failed to grasp, when it comes to combining the power of gravity and buoyancy in one device, in an attempt to produce electrical power. In “35 U.S.C. 101 Inventions patentable,” it is written, “Whoever invents or discovers any new and useful process, machine, manufacture, or composition of matter . . . .”

The obvious reality is that in order for a process or machine to be useful, it first must work. The key that the present invention has, a key that endows the present invention with the attribute of “usefulness,” is to Not use a closed loop passageway, closed containment loop system, closed loop system or a containment loop system. Below are eight references to various patents that might be considered somewhat relevant to the present invention or that have been cited by patent examiners who have scrutinized devices that allegedly could generate power and that were using the concepts of buoyancy and gravity, either using these forces individually or in combination with each other, in one way or another.

In U.S. Pat. No. 5,001,357, Adams does not use buoyancy but does use gravity in the form of applying the weight of Fluid to the system, thereby getting mechanical energy to move buckets up and down. The buckets are in essence permanent magnets and they pass through Coils to generate electricity (linear gravitational generator).

In U.S. Pat. No. 7,434,396, McGahee uses buoyancy but does not use a free-fall drop or magnetic fields passing through Coils; seeks to produce rotational power through buoyancy, alone (economy of motion machine).

In U.S. Pat. No. 7,134,283, Villalobos uses buoyancy and gravity but does not use magnetic fields passing through Coils; seeks to produce rotational power (sealed shaft gravity buoyancy system and method and use thereof).

In U.S. Patent Application 2009/0252563, Gillespie uses buoyancy and gravity but does not use magnetic fields passing through Coils; seeks to produce rotational power (apparatus and method utilizing buoyancy).

In U.S. Pat. No. 3,496,871, Stengel does not use buoyancy or directly use gravity but does pass “magnetized pistons” through a “Coil wound toroidal pipe.” This “pipe” is basically an enclosed loop, except for an “inlet and outlet port” (energy conversion device).

In U.S. Pat. No. 3,859,789, Fawcett does not specifically or directly use buoyancy or gravity but does use magnetic fields passing through Coils; all of this is in a “closed continuous loop passageway” (method and apparatus for converting one form of energy into another form of energy).

In U.S. Pat. No. 4,381,181, Clegg does not use buoyancy or gravity, but does use a “closed fluid conducting loop” and in one embodiment electromagnetic force is used to propel an iron core “impeller” around the loop (solenoid-actuated centrifugal pump and method).

In U.S. Pat. No. 6,734,574 Shin uses buoyancy, gravity and does use magnetic fields passing through Coils, thus seeking to produce electricity directly from the Coils; this system operates within a “closed containment loop” (buoyancy-driven electric power generator). [Note: explanation is given herein as to why Shin's '574 lacks the required attribute of “usefulness;” furthermore, '574 is in violation of Appendix R Patent Rules, §1.84 Standards for drawings, (p)(5), as described below in “10” of an “operational shortcomings” section focused specifically on a realistic analysis of this '574 device.]

Perhaps the primary reason why no device has ever been created in a manner similar to the present invention is that putting everything inside a “closed loop system” is the quick and easy way to avoid digging deeper into the real problems associated with creating a successful, workable energy production device that combines gravity and buoyancy. Perhaps this general “quick and easy” attitude can best be summarized by Shin's '574 device, where it is written (in Shin-[0008]), “The containment loop ensures that the magnet capsules move in a predetermined path.”

Yes, the magnet capsules are neatly restricted to an unwavering path inside a closed loop, but all this “closed loop concept” really accomplishes is to produce a severely flawed device which could be called “inefficient” except for the larger issue, which is that such a device will not work at all, so it cannot be inefficient if the device is non-existent and/or non-operative. It should be noted that the definition of “a device that works” is a device that produces Net Positive Electricity (or Net Positive Energy). There is no usefulness to any device such as Shin's '574 device and more specifically, it is quite likely that all devices designed to produce energy, where those devices are attempting to do so by combining gravity and buoyancy and where such devices are using a “closed containment loop,” or a “containment loop system,” or a “closed loop system,” fall into the same category and unfortunately end up in the same place: a dead end road, because there is no “usefulness” in today's world for a device that does not work.

Specifically, there are at least six major disadvantages inherent in any “closed loop system” that is trying to use the combination of gravity and buoyancy to produce electricity (or some form of rotational energy), compared to the present invention.

1. There can be very little speed achieved by the moving magnet-objects (“capsules” in “Shin '574”) built-up during either of the two “phases,” that is, during the Drop Phase (where gravity is applied) and during the Floatation-ascent Phase (where buoyancy is applied). In theory, relatively moderate speed can be achieved during the fall and also during the Floatation-ascent stage, but when a magnet-object reaches the end of its vertical descent or ascent and this magnet-object is forced to enter into a curved portion of the “closed loop,” then such magnet-object immediately encounters a stationary wall (the inner wall of the “containment tube”) and enormous friction is created. This counter-force that exists will result in the walls, themselves, inhibiting and restricting the movement of the magnet-object that is trying to make its way around the inside of the “loop.” The term “friction” will be used to categorize the overall concept of these obstructions (that are being placed upon the forward motion of a magnet-object by the inner walls of the “containment tube”), regardless of more specific, varied and/or particular inhibiting qualities of the various obstructions to the motion of the magnet-object. (Note: “capsule” will be used for “magnet-object” below.)

This friction felt by the capsule is a critically negative factor in at least three ways. First, it causes deterioration on the body of the capsule and on the walls of the “enclosed tube,” from all the continual rubbing and this friction also causes extreme vibration, which will lead to a weakening of the overall structure. Second, the friction produces large amounts of unnecessary heat inside the “enclosed tube.” Third, this friction dictates and diminishes the speed of a capsule in the straight (non-curved) sections of the system, because the only way the system can actually function overall is if the speed of a capsule is slow enough in the curved sections of the loop (the “arcs”) so that this slower speed will minimize the effects of the friction just described. All capsules must go slow enough in the “arcs” to keep the machine from vibrating apart, etc. So the speed in the straight-aways must be reduced in anticipation of what is to come in the “closed curves” (similar to what happens in car racing). FIG. 31 and FIG. 32, from the Prior Art of Stengel in U.S. Pat. No. 3,496,871, provide a way to better visualize this issue.

2. Having an “enclosed tube” creates an environment for heat to build up quickly and even though the (magnet) capsules do pass through some type of fluid for part of their journey (on one side of the “loop”), essentially the capsules do not stay in that fluid long enough to really cool down, relative to the collective amount of heat that is continuously building up, in a combined and ever-growing effect from each and every time a magnet passes through a Coil and electrical power, heat, and counter-EMF are produced.

3. There is no way for Launching Equipment (such as Linear Motors) to have access to the magnet-capsules, for the purpose of adding additional speed at the beginning of each Drop Phase (through air) or each Floatation-ascent Phase (through fluid), but as just stated, additional speed will destroy the infrastructure of the containment loop, anyway. The reason there is no access to the capsule for any such equipment is that the closed loop system inherently is using the inner walls of the “loop” as the Guidance System for the movement of the capsules (once again, Shin's '574 quote, at Shin-[0008], says, “The containment loop ensures that the magnet capsules move in a predetermined path.”) and the diameter of this “guiding structure,” the inner diameter of the (circular) walls of the containment housing, is only slightly wider than the outer surface-edges of the capsules, so there is no room inside the loop for any such equipment. FIG. 31 and FIG. 32, from the Prior Art of Stengel in U.S. Pat. No. 3,496,871 provide a way to better visualize this issue, as well.

4. Similarly, there is no way for Deceleration Equipment to have access to the capsules, for the same reason just stated above in #3.

5. As a result of having no Deceleration Equipment in the system, there is no chance to recover any of the kinetic energy acquired by a (magnetic) capsule during its fall; there is no way to convert that energy into electricity through a Hydraulic Motor connected to an Electric Generator, or some other method like that.

6. As another result of having no Deceleration Equipment in the system, at the conclusion of the Drop Phase, the magnet capsules can only go crashing into each other, each and every time a capsule has ended its “Drop Phase.” The interval rate of a “Cycle” has never been stated in any relative prior art, but it is obvious that a system designed according to any of the prior art would have Cycle-intervals that were probably 3, 4, or 5 seconds apart. This continuous event of capsules crashing into each other is very bad because: a) the continuous jarring of magnets will cause them to lose their magnetic properties quicker, b) these violent-and-continuous crashes can cause the capsule housings around the magnets and/or the magnets themselves to crack, and c) the wall of the “closed containment loop” will suffer severe abuse at the point(s) where these crashes are continuously occurring.

The above-mentioned design defects are all critical shortcomings that exist in any device that attempts to use a Closed Containment Loop System in an effort to generate power by combining the forces of gravity and buoyancy in one device. Now, for even more detail on related patent and non-operational issues along these lines, below are Nine Additional Impediments particularly found in Shin's '574 device and these impediments cause such severe barriers to the functionality of this '574 device, that either individually or combined, these Clear and Specific Impediments render the device described in '574 to be inoperable (to not be “useful” as a result of being non-operational). These critical design and operational shortcomings are:

1. Because of the constraining factors of the “containment loop” design, it is impossible to use a magnet-object (Shin's “capsule”) that has a length multiple times longer than its diameter. In addition, because Shin's '574 device has four straight sections (plus the “capsule injector;” Shin-{110}, which is a “straight” chamber) and four curved sections, the shape of a capsule for the device cannot be made to mirror the shape of the walls of the “loop” (the “pipe”), because some “containment pipe” sections will be curved and some sections will be straight. Once again, FIG. 31 from the Prior Art of Stengel in U.S. Pat. No. 3,496,871 (Stengel's FIG. 5) shows what problems an elongated cylindrical object (a magnetic piston; Stengel-{150}) has when an attempt is made to propel such an object through a curved section of pipe (“torus wall;” Stengel-{110}).

In this diagram Stengel shows a cylindrical object (the magnetic piston) whose length is about 1.875 times its diameter. However, in the drawing the cylindrical object almost appears to be “stuck” inside the curved walls of the “torus.” Obviously this diagram illustrates that a “closed loop system” restricts the overall functionality of the device in such a way that the “magnet-capsules” cannot have lengths that are multiple times their diameter. Taking this issue back to Shin's '574 device, because a capsule in Shin's '574 device will not be able to have a length that is substantially longer than the diameter of the capsule, the whole concept of whether or not a capsule can even attain buoyancy status becomes a critical issue, resulting in inoperability for the '574 device.

Therefore, as shown in Shin's '574, where the capsule (Shin-{120}; see FIG. 33, Prior Art) is basically egg shaped, there will be no possible way to increase the Buoyancy Factor of the capsule by adding more volume of air or gas, etc. by elongating the shape of the capsule. Also, because Shin's “120 Capsule” uses a curved surface for the top and the bottom of a capsule, this inherently minimizes the potential volume of the capsule, which has an effect to decrease the buoyancy that a capsule has. An egg shaped capsule will not have as much buoyancy as a cylindrically shaped capsule of the same length (from tip-to-tip).

Furthermore, it is worth noting that even if the “egg shape” shown in the related diagram (FIG. 33; FIG. 5 of Shin '574) is used, simply adding a gas to the inside of a capsule as it is currently designed, for the purpose of giving the capsule more buoyant force (which is a benefit on the “buoyancy section” Shin-{130}), does not increase the net electricity output of the device, because the added buoyancy of the capsule will also reduce the rate of fall in the “gravitational section” (Shin-{140}) at a reduced level approximately equal to the rate of speed increase in the “buoyancy section.” Thus, if a “lighter than air” gas is used inside the capsules, the quantity of additional electricity produced in the “buoyancy section” (due to increased speed of a magnet passing upward through the Coils) is merely subtracted away by an equal amount of electricity Not generated during the fall downward through the “gravitational section,” because a capsule Falls Equally Slower in the “gravitational section.”

2. This restrictive design circumstance (the use of a closed loop system) with regards to the inability to elongate the capsules, produces even more dire results. In Shin '574 (at Shin-[0037]) it is only assumed (merely said to be true in the wording of the patent) and not proven by any means in the diagrams and descriptions, that a capsule will have enough momentum to “fly out of the Fluid” at the top of the “buoyancy section,” and thereby be able to propel itself the required distance through the air to traverse the “release portion” (Shin-{142}) and reach the “slide-and-fall” section (Shin-{144}) of the '574 device. As previously mentioned, the magnet capsules of '574 being discussed have no buoyancy, because the weight of the magnet (relative to the inner volume of the capsule) in combination with the weight of the (relatively small) capsule, will be greater than the weight of an equal amount of Fluid (or of most readily and commercially available fluids) that is being displaced by the '574 capsule. Therefore it is doubtful that the capsules will even actually float.

In addition, regarding the speed of the ascent of a non-buoyant or “barely buoyant” capsule, even Shin, himself, explains how as a capsule rises through the “buoyancy section,” factors will be present that will be working to slow the capsule down even more. From Shin-[0036] we read: “In addition to velocity reduction caused by the fluid drag, intermittent velocity reductions will occur due to inducement drag.” But in the unlikely event a capsule can reach the Top of the “buoyancy section” (as referenced in Shin-[0037]) and as further described above, the capsule will begin to encounter friction from the curved inside wall of the containment loop, itself.

Next, as the capsule (theoretically): a) begins to climb out of the fluid from some type of momentum this '574 capsule has acquired as a result of its rise through the fluid, and b) then eventually reaches the point where no buoyant force exists to counteract the force of gravity trying to pull the capsule (with the relatively heavy magnet inside) back down into the fluid, even Shin, himself, questions whether or not the capsule will actually have enough upward kinetic energy (momentum) to overcome all of these combined restricting factors and actually move into the “release portion” (Shin-{142}). We see this skepticism from Shin in this statement at Shin-[0037], where it is written: “If the steady-state velocity is sufficient, the momentum of the magnet capsule will carry it into the buoyancy release portion (Shin-{142}), which meets the top of the buoyancy section.” Obviously, a new device expected to solve the energy needs of the U.S. and/or the entire planet, cannot be presented with the idea that . . . maybe if the capsules go fast enough, there is a chance they might be able to go from one side of the device to the other.

3. Also, focusing once again on the shape of the (magnetic) “capsule” in Shin's '574, because the capsules cannot have a reasonably “elongated” shape, another big problem occurs, and in effect makes the device inoperable. This critical condition is that The Magnet Capsules Will Not Be Able To Separate From Each Other. This is one of the many reasons why the device presented in Shin's '574 lacks the quality of “usefulness.” No capsule can ever be fed, individually, into the “capsule injector” (Shin-{110}) because of how the '574 capsule has been designed.

Magnetic forces will be causing a mutual attraction between each and every adjacent magnet capsule, and these attractive forces will never allow one capsule to merely “float away” from the capsule next to it, to casually disjoin itself from an adjacent capsule that is touching it and that is also connected to it by a strong magnetic attraction. The obvious way to overcome this problem and to eliminate any magnetic attraction between the individual magnet-objects is to elongate the object (Shin's “capsule,” in this case) enough that is holding the magnet inside of it so that any two adjacent magnets are far enough apart that their magnetic fields will not reach each other, and therefore no magnetic interaction will exist between the magnets (in Shin's device, “capsules;” in the current device, “canisters”).

4. Even in Shin's own words, we see confirmation that this problem of “capsule” size and weight (and therefore buoyancy) exists. In Shin-[0054] it says, “ . . . because the size of the magnet is determined by the size and weight constraints of the capsule (Shin-{120}), the magnitude of the EMF that can be attained in a single Coil module (Shin-{150}) is limited.” What is being admitted here, however, goes beyond the physical problems with the capsule design, and extrapolates into the bigger picture, which is that poor capsule design (a requirement of a Closed Containment Loop System because of the very limited length a capsule can have) results in a device that at best can produce only limited amounts of electricity. What is left unsaid in this sentence is that “the size and weight constraints of the capsule” exist as a consequence of the overall anti-functionality of the closed loop design, itself.

5. Another failure in the art of U.S. Pat. No. 6,734,574 is that since the '574 “containment loop” device has been designed in such a way that no other monitoring devices or speed control equipment will be operating inside the “closed loop” to monitor, accelerate or slow down the capsules (because as previously stated above, the closed loop design leaves no room to put such devices inside “the loop”), each individual capsule will continuously be accelerated as it falls down through the “Drop Phase” and then the method of deceleration for the capsules can be disastrous and/or internally destructive to the device, itself (Shin-{140} in Shin-[0038] and [0039]).

Amazingly enough from a design perspective, in Shin's '574 device, every capsule's downward movement is stopped simply by allowing the fast-falling capsule to crash, at maximum velocity, into the topmost stationary capsule that is positioned at the bottom of the “buoyancy section” (Shin-{130} and the “capsule holding section;” Shin-{146}, in Shin-[0039]). And not only do these “Crashing Events” affect these two capsules when these impact(s) occur, but there is a whole line of capsules all touching each other and cramped inside the “capsule holding section” (Shin-{146}) that are positioned in adjacent fashion below the topmost capsule just described, and so all of the energy of these crashes, over and over, is transferred to a large number of other capsules, as well.

As a result of many capsules in the '574 device experiencing some level of extreme vibration every time a falling capsule crashes into a capsule that is at the “tail end” (upper end) of the cue of capsules headed towards the “capsule injector” (in other words, is the top-right capsule in the “capsule holding section,” Shin-{146}), these vibrations: a) will cause the magnetic fields of the permanent magnets (inside the capsules) to weaken much quicker than if this constant “jarring” is not present, b) will cause the “casing” of the magnet capsules (Shin-{410} in Shin-[0046]) to also deteriorate in a rapid manner, and c) will also cause severe strain on the walls of the containment loop, itself, where these walls are absorbing impacts from each and every crash in each and every multiple location where a “vibration” exists—the spot where each of these individual capsules is being shoved against the inner wall of the “containment loop” (Shin-{100}) itself. To put this in perspective, in Shin-[0023] it says, “Additionally, it is preferable to utilize a large elevation range to increase the amount of buoyant and gravitational force acting during a Cycle around the BDS loop 100. Construction on a hilltop, in the ocean, drilling into the ground, or in a tall building may all provide a large elevation range.”

So for example, even using a small building (less than 100 feet tall) where the “gravitational section” allows a capsule to Free Fall a distance of 60 feet (18.29 meters), if a capsule is acted upon solely by gravity, it will attain a speed of about 42 mph by the time it crashes into the “top” capsule that is at the bottom of the “gravitational section” (Shin-{140}) and that is there waiting for the falling capsule to make contact with it. (Note: it is true there will be some degree of counter-forces created by the Coils, that will be acting to repel the downward motion of the falling capsule, but these forces will never slow a capsule down more than 15%.).

To make another example, if: a) the building is 70 feet tall, and b) the speed of a capsule is reduced by 15% due to counter-EMF forces from the Coil Stack, and c) if the magnet capsule in Shin's '574 weighs five pounds, which includes the weight of the magnet, the capsule housing and anything else that might be inside the capsule (the mystery material, Shin-{420}; see “10” of an “operational shortcomings” section below for more details on that subject), then each and every capsule in '574, by the time it reaches its fall through the “gravitational section,” would be like a 5-pound cannon ball moving at a speed of about 39 mph. Such an object would basically have enough force to smash through the hood of a car and destroy portions of the upper part of the engine underneath the hood.

6. Another astonishing and bewildering shortcoming of this '574 Prior Art is that the system is designed to continuously be losing water; this condition is a critical and unnecessary waste of the precious resource, water. In Shin-[0045] we find, “Because the water, or other liquid, from the buoyancy section 130 is displaced to the capsule in waiting portion 146 of the BDS loop 100, a drain 160, as shown in FIG. 1, may be utilized to remove liquid from the gravitational section 140 of the BDS loop 100. A refill pipe 170 may also be used to refill the water, or other liquid, into the top of the buoyancy section 130.” It is basically unclear the exact details of what is being described with regards to the preferred embodiment of the “capsule injector” (described and represented in: Shin-[0043] and Shin-{FIG. 4}; Shin-[0042] and Shin-{FIGS. 3A-3D}; Shin-[0049-0053] and Shin-{FIG. 7}).

What is consistent in these related explanations just referenced, however, is that: a) the drawings all show there is a “separation gap” between both outer edges of the capsules and the inner wall of the “containment tubes” and/or the inner walls of the “capsule injector” and these gaps will allow water (or any other fluid used in the “buoyancy section” Shin-{130}) to flow downward and out of the “capsule injector” into the “capsule waiting area” (Shin-{146}), thus leading to a situation where that specific amount of water will then flow out of the drain (Shin-{160}) and b) it appears that when the lower “gate” is opened for the “next” capsule to begin entering the “capsule injector,” the pressure inside the “capsule injector” will be much higher than the pressure of the water (or other fluid) in the “capsule waiting section.” Therefore, these combined factors seem to substantiate the reasoning behind the statement quoted above from Shin-[0045] regarding continuous water loss out through the “drain” (Shin-{160}).

It is also not clear what happens to this wasted water that passes out of the drain ({Shin-160}); perhaps the water is just left to seep its way into the ground or perhaps additional resources, financial and otherwise, are continuously provided (to power a pumping device) to create a situation where the water that is “leaking out” of the system (near the bottom of the system) can be pumped 30 to 60 to 100 feet upwards so that water can be dumped back into the top of the “buoyancy section” (Shin-{130}). The cost of such continuous pumping action would be substantial. In any event, for this critical part of the system, which is responsible for maintaining water in the “buoyancy section” (Shin-{130}) of the device, for the device to be designed so that the device is either: a) continuously wasting a precious resource such as clean water, or b) requiring constant resources be used to continuously elevate water back up to the top of the “buoyancy section” (Shin-{130}) is definitely an inferior, unnecessary, inefficient and costly design defect.

7. In Shin-[0011] it is stated that, “The only energy consumed in the BDS is through the operation of the capsule injector and, if used, a refill pump for recycling the liquid utilized.” This attitude to limit the functionality of the '574 device is another severe design flaw, but unfortunately is one that must exist because of the way in which so many overall restrictions are inherently imposed when using a Closed Containment Loop System.

For any device combining gravity and buoyancy and that is using a “closed containment loop” to be efficient and/or to even work at all, it should be a basic design feature for the magnet-object (Shin's “capsules”) to reach maximum speeds, and to also be decelerated. But in order to really achieve Maximum Speed for the capsules, the device must have some type of enhanced launching capabilities for each capsule, to “launch” the capsule downward every time it is starting the “Drop Phase” (in Shin's “gravitational section”) and to launch the capsule upward every time it is starting the “Floatation-ascent” phase (in Shin's “buoyancy section”). In addition, there should be a way to recover some of the kinetic energy at the end of the Drop Phase (especially as opposed to letting all this kinetic energy be applied to adjacent capsules in these “Crashing Scenarios,” as described a few paragraphs above in “5”).

Furthermore, a device that Does contain “Speed Manipulation Equipment” also needs: a) to be able to monitor those speeds and other position-related data at key locations during the overall journey of the magnet-object, b) to have control over other factors that can have an effect on the journey a magnet-object makes through the device, and/or c) to understand how all the other pieces of equipment are working together in a coordinated manner. To satisfy all of these essential requirements, a device must be fully equipped with Sensors, Positioning Solenoids, Retaining Pins, Speed-adjusting Electromagnets and things like that for such a device to operate successfully and to be able to produce substantial amounts of continuous electricity. Shin-[0011] finishes the paragraph by saying, “Thus, with the appropriate design characteristics, the BDS can be a self-sustaining system.” It is highly debatable that the '574 device is “self-sustaining,” because as stated above, it is very doubtful that any device designed along the lines of Shin's '574 device will function at all. But assuming the device did work, then perhaps it would be “self-sustaining.”

However, even more importantly, a system like the current invention, that utilizes all of the items just mentioned (Sensors, Positioning Solenoids, etc) can also be self-sustaining and in fact can produce far greater amounts of electricity by using the “Peripheral Enhancement Equipment” because of the increased speeds attained by the magnet-objects (“canisters” in the present invention). In a successful device that combines gravity, buoyancy and passes magnets through Coils to produce electricity, the net output of electricity is Not based on how much energy is Not used by other peripheral equipment to assist and bolster the overall operation of the device (the idea is not to think about how much electricity could be saved if there was no peripheral equipment). The net output of electricity is simply relative to how much total electricity is produced minus what is consumed by the supporting equipment used to monitor, control and intensify the core operation of the overall device.

8. Shin's '574 provides a rather complicated and vague explanation of how one capsule causes another capsule to exit out of the “capsule injector” (Shin-[0050]-[0054]). In addition, in Shin's '574 device there are two other embodiments for this capsule injector process, but one of those is performed with the “capsule injector” in a horizontal position and the other with the “capsule injector” pointed upward at an angle. The embodiment with the horizontal “capsule injector” also seems unworkable because it is unclear what would actually move a capsule out of the (horizontal) injector; it appears as though a capsule would just remain (stuck) “resting” with the top of the capsule making contact with the inside (lowest) surface of the top side of the capsule injector, as a result of (theoretical) buoyancy causing the capsule inside the capsule injector to rise to the top of the (horizontal) capsule injector.

In any event, whether the descriptions are clear or unclear, what is described in Shin's '574 with regards to the launching of each capsule out of the “capsule injector” appears to be a very slow and tedious process that takes precious time for each and every capsule to “launch into the fluid.” Even though one or more other capsules may be going up or down in the device and generating electricity while the “next” capsule is passing through the “capsule injector,” the speed at which each individual capsule passes through the “capsule injector” will in fact dictate the overall tempo of the entire electricity generation process, and the more rapid the tempo of the overall process, the more electricity will be produced by the device.

9. Repeatedly, in four separate places, Shin's '574 states that the Coils are mounted externally, on the exterior surface of the containment loop. Only in one place does the description rather casually state that the Coils can be placed inside the “pipe.” However, this extremely nonchalant 3-word phrase “internally or externally” (see Shin-[0024] below) essentially demands, defines and calls for an entirely different environment inside the “pipe.” If the Coils are put inside the “pipe,” then a whole new set of equipment must be utilized to ensure that any object falling or rising within the “pipe” will always be in perfect alignment with the open inner diameter of each and every Coil.

This easygoing way of describing this very serious and complicated design change, where in an almost impromptu manner Shin happens to add this one word, “internally,” is not in tune with the reality of using a “closed containment loop.” The idea of internally-positioned Coils is virtually impossible to declare as a workable scenario in a “closed containment loop” device, and/or especially without adding an extensive amount of explanation as to exactly what equipment and methods will be utilized so the Coil devices can be positioned Inside of the “closed loop” and whereby the capsules will still be able to move around inside the “loop” with the proper internal alignment, relative to the open areas of the inner diameter of the Coils. And as expressed in various places above, the Closed Containment Loop Design inhibits “equipment” (such as Coils) from being placed inside the inner walls of the containment structure, itself.

Below are five statements taken directly from Shin '574, which help to complete the explanation provided in the previous two paragraphs.

. . . in a plurality of Coil modules that are situated on the exterior surface of portions of the loop.

The Coil modules may be placed on the exterior surface of the liquid-filled portion and/or the empty portion of the loop.

The Coil modules 150, situated on the exterior of the pipe, generate power . . . .

The Coil module 150 is a Coil of wire wound and mounted on the exterior surface of the BDS loop 100.

In a preferred embodiment, the Coil modules 150 surround portions of the BDS loop 100. The Coil modules 150 may be placed at any location on the BDS loop, internally or externally.

10. Also, in the illustrations and descriptions of the magnet capsule (Shin-{410} in Shin-[0046]), it is even a fact that the '574 patent is in non-compliance with Appendix R Patent Rules, §1.84 Standards for drawings, (p)(5), as a result of this “Rule” being violated in the patent document, itself. Once again, anything related to the inside of the capsule (Shin-120; -400; -410; -420) is of ultimate importance, especially since the general design of the capsule shows it as not having buoyancy. But to make matters worse, Shin's '574 designates a component of the '574 device “420” (inside the capsule; in Shin's FIG. 5), shown here in FIG. 33, Prior Art, but then it is never stated anywhere in the related description of the patent what component “420” is. One can make assumptions and/or mix and match phrases in the description to try and make a “best guess” as to what Shin's “420” component is (or is not), but nowhere in the '574 patent does Shin tell us what component “420” is. This is a direct violation of Appendix R Patent Rules, §1.84 Standards for drawings, (p)(5).

In conclusion, Shin-[0056] admits that, “The operation of the BDS may be effected by several variables including the design of the magnet capsules 120, the Coil modules 150, the type of fluid utilized, and the capsule injector 110.” What is said here about the “design of the magnet capsules” and the “(design of) the capsule injector” is certainly true. It is quite insightful that these two absolutely critical components of Shin's '574 device, the magnet capsules and the capsule injector, are referred to as “variables” and not specifically referred to or thought of as solid design elements.

Key operational equipment as important to Shin's '574 device as the “magnet capsules” and the “capsule injector” must be described in terms specific enough so that these operational elements can be totally understood by people trained in the art, so a “Yes” or “No” confirmation can be made as to whether or not these important pieces of equipment (the “magnet capsules” and the “capsule injector”) will in fact provide clearly defined, specific and workable contributions to the operation of the device. It is impossible to consider Shin's '574 device as having the attribute of “usefulness” (let alone analyzing whether or not the device is commercially viable), when two of the most important “core design elements” are being defined as “variables” in the '574 patent.

### BRIEF SUMMARY OF THE MAGNAFLOAT

### Technical Overview

In the preferred embodiment, as well as in one or more other embodiments, the present invention overcomes the numerous disadvantages and critical obstacles of prior art, and especially solves all the operational and technical barriers related to the aforementioned U.S. Pat. No. 6,734,574. But what is even more important, The MagnaFloat has a dynamic assortment of new and innovative features that utilize an array of well-designed and highly functional equipment built into the device, to enhance and bolster the core operation of the device. The exciting results are that a MagnaFloat device is able to function in a smooth and consistent manner and is able to successfully produce large amounts of electricity by combining three of the most powerful and ever-abundant forces in physics and nature, gravity, buoyancy and the ability to produce electricity by passing a magnet through a coil of wire.

The present invention is called The MagnaFloat (“MF device” or “MF” and including “MF technology”). In the overall MF device, there is a set of canisters that travel along a series of exposed, unobstructed, open and in the case of the Fluid Column, open-ended, sections of a seamlessly connected and integrated pathway. Each canister has a magnet inside of it and electricity is generated when the magnets pass through Coils of wire arranged in Two Separate Coil “Stacks;” one Coil Stack is on the “Air Side” of the device (the left side, when looking at the drawings), and one Coil Stack is on the “Fluid Side” of the device (the right side). Additional electricity is also provided in two ways:

1.) in the preferred embodiment, by recovering a substantial amount of kinetic energy from a moving canister after the canister has begun moving in a horizontal direction (when a canister goes through the Arc B section of the device, FIG. 1D, the canister's direction of movement changes, from moving vertically to moving horizontally). This kinetic energy is “captured” in a Hydraulic Accumulator Energy Recovery System, as a result of Two Slowdown Plungers (141PF and 141PR) putting pressure into the Hydraulic System, while at the same time taking kinetic energy (and speed) away from the fast-moving canister. The Hydraulic Accumulator sends the “captured pressure” through a Hydraulic Motor which causes the Hydraulic Motor to spin, and this spinning action turns an Electric Generator that is connected onto an extension of the shaft of the Hydraulic Motor; and

2.) by passing magnets through permanently positioned Coils (that are directly under the Pivot Bucket Area) during the “Fly into the Air” Phase 312. More specifically, towards the end of a “Cycle,” (definition of a Cycle is given in the second paragraph below), a canister is shot up into the air as a result of being propelled through the entire Fluid Column by a composite upward force that combines three individual upward forces. More detail is given later about these three forces, but these forces are: buoyancy, the Canister Length Pressure Differential Force (see third paragraph below), and a Constant Velocity Force that is initially supplied by Linear Motor #3 during the Underwater Launch (see “13 Topics; #3, Underwater Launch”). It is worth noting that Linear Motor #3 (LM-3) is actually positioned and operates completely inside the Fluid Column and is therefore totally “inside the fluid” (a fluid such as water).

The strength of this three-pronged composite upward force is so strong and the canisters achieve such high velocities from these forces during the Floatation-ascent Phase 311, that by the time a canister reaches the top of the Fluid Column (meaning in the preferred embodiment, for example, the canister has been accelerated through the fluid for about 60 feet, vertically), the canister literally shoots up about 18 feet above the Fluid Column Exit Point 315, which is where the canister came out of the Fluid Column.

[A “Cycle” is: the completed journey a canister makes, by going from the starting position at the Drop Point 301 and moving counterclockwise around the entire overall MF device, and then eventually returning back again to the Drop Point 301, where that canister is then ready to enter the next Cycle.

The Canister Length Pressure Differential Force (CLPDF) exists because the length of a canister is long enough that when a canister is “in the fluid,” the force pushing up on the bottom surface of the canister is substantially more than the pressure pushing down on the top (leading) surface of the canister. This is Not the force of buoyancy and is a Second Upward Force In Addition to the force of buoyancy. Furthermore, the CLPDF is a Constantly Applied Force (an Accelerating Force) that does not change, regardless of what depth the canister is at, except at the very end of the Floatation-ascent Phase, when the canister physically begins to exit the Fluid Column. The reason this upward force is constant is because it is a Relative Pressure Differential, so this CLPDF will always be the same, regardless of how far “down into the fluid” the canister is; for example, if a canister is about 26 inches long, the pressure differential between two feet of water and four feet of water is exactly the same differential as between 50 feet of water and 52 feet of water.

Any reference to “Leading Surface” or “Leading Edge” of a canister refers to the circular surface on the front-end of a canister that is specifically perpendicular to the body of the canister, and does Not refer to the cone-like protrusion in the center of the Leading Edge of a canister. However, the Front-end of a canister is the end where this Nose Cone Protrusion 70 is located. Another way to look at it is that the Front-end is always the end that is “in the front,” according to the direction the canister is moving. This is important to note, because since the canisters are heading downward on one side of the device (the left side in the accompanying drawings) and upward on the other side, the Front-end, the Leading Surface, of a canister is on the bottom of the canister (the lowest part) in the Drop Phase 304 and is on the top of the canister (the highest part) in the Floatation-ascent Phase 311.

On a linear motor (LM), the “drive coils” of a Forcer establish a moveable Magnetic Field that interacts with the alternating positive and negative Magnetic Fields of the stationary magnetic track of the linear motor. In all of the LMs used in a MF device, the Forcers move in a vertical manner.

In any descriptions of the Pre-launch Process, the term “Lower Canister” and “Ascending Canister” are interchangeable, and during the first part of a Pre-launch Process, an “Upper Canister” is either in a suspended state or for a very brief moment in a descending state, and therefore to say “Ascending Canister” does clearly differentiate a Lower Canister from an Upper Canister. The only time an Upper Canister is ascending is when a Lower Canister has already coupled up with an Upper Canister, and the elevation process (which is the main portion of the Pre-launch Process) for that Upper Canister is a result of: a) the Lower Canister being coupled up underneath the Upper Canister, and b) the Lower Canister being elevated and so therefore both canisters are pushed upwards at the same time.]

Of course the speed at which a canister exits the Fluid Column is not only determined by these three forces mentioned seven paragraphs above, but this Exit Speed is also obviously directly related to the Total Height of the Fluid Column. The higher the Fluid Column, the longer the two forces (the buoyancy force and the Canister Length Pressure Differential Force) will have to accelerate a canister. The Launch Force from LM-3 should not be considered as an accelerating force, but instead is a constant additional velocity (that is passed on to the canister by the force of the Underwater LM-3 Launch Platform 233 pushing the canister upwards during the Underwater Launch by LM-3). In any event, one embodiment of the MF uses a Drop Phase 304 and a Floatation-ascent Phase 311 where each of these “Phases” has Coil Stacks that are about 60 feet high. In addition, for such an embodiment where the canister length (of the Cylindrical Body, not counting the Nose Cone Protrusion 70) is about 26 inches, as an example, and with a magnet weighing about 45 pounds (as an example) inside the canister and a canister body that weighs about three pounds (as an example), under these conditions the “Fly into the Air” Phase 312 is about 18 feet high.

A certain amount of electricity is produced every time a magnet passes through a Coil, but the faster a magnet moves through a Coil (the quicker the change in the magnet flux), the more EMF (voltage) will be produced. And of course, a canister will be moving much faster at the bottom of its fall on the Air Side and at the top of its ascent through the Fluid Column (on the other side of the device). So as a result of these very high speeds in both the lower portion of the Drop Phase 304 (on the Air Side) and the upper portion of the Floatation-ascent Phase 311 (on the Fluid Side), electricity is basically created in explosion type bursts through each and every one of the Coils in these areas. A “burst” in each of these Coils has a duration of only a few thousandths of a second. For example, in the preferred embodiment where the Air Side Coil Stacks is about 60 feet high (as an example), by the time a canister is passing through the very last (the lowest) Coil on the Air Side, the canister will be going approximately 42 miles per hour.

The vertical height of a Coil in all the embodiments presented, as an example, can be (about) four inches. Mathematics shows that at 42 mph, a canister will move four inches in: 0.0054112 seconds (42 miles=2,661,120 inches; one hour=3,600 seconds; 2,661,120/3,600=739.2 inches/second; 4/739.2=0.0054112 seconds). So under these conditions for that one individual Coil, the “blast” of electricity generation will last for about five one-thousandths of a second. On the other hand, for the First Coil at the top of the Air Side Coil Stack 321, the time for the magnet to pass through that Coil will be much longer.

When calculating the EMF (voltage) produced in such a (short) blast, the length of time is in the denominator of the equation, so the shorter the time the magnetic flux is changing within the Coil, the higher the voltage will be. However, when taking the calculations one step further to compute the power produced, the length of time during which the electricity is produced is also a factor in the final result, and the shorter the time during which the electricity is being generated, then less power is generated, as well. In any event, a MF device achieves maximum power output by achieving maximum velocity for the canisters, and this applies to the velocity of canisters going in both directions, falling on the Air Side and ascending on the Fluid Side.

The bottom line is that all embodiments of the current invention, The MagnaFloat device, produce an unexpected and sizeable amount of electricity, and this outcome is a combination of several contributing factors, which include: direct electricity generation when a magnet passes through a Coil with very little “Air Gap” between the outer diameter of the magnet and the inner diameter of the Coil, three different types of “launches” for a canister during each Cycle, and Energy Recovery and Energy Conversion Procedures (for the preferred embodiment). For example, one noteworthy and beneficial feature of the preferred embodiment of the device is that the kinetic energy a canister has immediately after it has completed the Drop Phase 304 and is moving horizontally, is Recovered and Converted. This is done by using Two Slowdown Plungers 141PF and 141PR whose hydraulic fluid is compressed as a result of these Two Slowdown Plungers acting in opposition to the traveling canister over a very short period of time.

Much more description is given on this “Energy Recovery Process” (see FIG. 1E, FIG. 1E-2, and Cycle-sequence Descriptions; FIG. 19, “Slowdown Area 306”), but in summary, Recovered Pressure is captured into a Hydraulic Accumulator and this Hydraulic Accumulator then passes the pressure through a Hydraulic Motor. The Shaft of the Hydraulic Motor 174Sh is directly connected to an Electric Generator 175, so when the recovered pressure turns the Hydraulic Motor, electricity is produced by a spinning Electric Generator. But what is just as important about this overall “Energy Recovery Process” is that by removing a specific amount of kinetic energy from the fast-moving canister, the canister's Final Speed in the Pre-launch Area 308 can be precisely regulated, and even starting this Speed Regulation Process back in the Slowdown Area 306.

Because a precise amount of kinetic energy is extracted from a canister by the Slowdown Plungers and the overall Hydraulic Accumulator Energy Recovery System (HAERS) 314, by the time that canister enters the Pre-launch Area and is preparing to couple up with another canister that is waiting in the Pre-launch Area (see 13 Topics; #1, “Coupling Process”), this very precise Coupling Event will be executed to perfection, with regards to how fast the Lower Canister (the canister whose speed has been manipulated by the HAERS) is traveling when contact is made between that (lower) canister and the waiting (upper) canister during the Coupling Process.

In addition to the MF producing these large amounts of electricity due to the high speed at which the canisters are moving (in the lower portion of the Drop Phase 304 and the upper portion of the Floatation-ascent Phase 311, as described above), the second reason for this unexpectedly large amount of electricity produced by a MF is that electricity is produced on a never-ending basis.

This is possible because in general, no parts of the MF device are put under any substantial stress and a MF is designed so that there is minimum or even non-existent wear-and-tear on almost all parts of the device. For example, except for the rotational movement of: a) the Pivot Bucket 261, and b) the Hydraulic Motor (in the HAERS, that helps convert kinetic energy into electrical energy), all parts that help accelerate, or slow down the canisters basically move back and forth with a simple linear motion, so there is no ongoing or occasional effects of torque on these parts. Of course, there are specific times once or twice a year when a MF device is serviced for regular maintenance.

Technological and Sociological Considerations.

There are a great number of benefits MagnaFloat technology can provide to society. Some of these benefits are technological and economical; some benefits are sociological and environmental. If MF technology is fully implemented and becomes the primary supply source for electrical energy for the planet, this will not only revolutionize how people get their electricity but will also forever change how people think about electricity. In short, people will be getting “almost free” electricity that is created “just down the street.” MagnaFloat technology takes the mystery out of electricity and parents, with their children, will be able to go on a short stroll down the street or over to the next block to actually see the device that is: a) producing and providing the electricity the family is using for everyday living needs inside their home, and also b) supplying the Electric Fuel these people are using to transport themselves from place to place in their cars.

The idea of “almost free” electricity provides a very compelling argument for why all developed societies would totally convert to electric cars in the shortest time possible. Who will want to pay $6 to $8 per gallon for (fossil fuel) gasoline when they can drive just as far for a few pennies worth of (almost free) Electric Fuel?

The conditions and advantages surrounding the use of one MagnaFloat device, where that device is built along the lines of the preferred embodiment, are as follows:
a) one MF device can provide all the electricity needed to run 70 “average-sized” residential homes;
   i) this also includes each member-household having enough electricity available to charge two car batteries on a daily basis,
   ii) the “local neighborhood power grid” (LNPG) for these 70 homes can be installed underground, thereby eliminating unsightly power lines out by the sidewalks,
   iii) in order for a LNPG to successfully supply the required electricity during peak usage periods, the available electricity for the LNPG at any given time comes from more than just the single MagnaFloat device, itself. Specifically, each member-household location has one or two fairly large storage batteries (located in the basement or garage), in addition to the one or two car batteries that may be plugged into the LNPG, if the cars are not out on the road.

Take for example what a 70-home LNPG consists of at 2:00 a.m., while the majority of the people are asleep and each home has one or two storage batteries being charged, plus the one or two car batteries that are also being charged. Part of the “cooperation agreement” for this neighborhood organization is that if a car is not on the road, then it is left plugged into the LNPG. So at 2:00 a.m. while home usage demand is at its lowest level, the MF device can supply almost all of its output to: 140 large storage batteries and 140 car batteries. Then as daytime rolls around, and people wake up and the demand for household electricity starts to grow, each home can first draw on the power stored in the two large storage batteries that are located inside the respective home, or since all of the 140 storage batteries are interconnected, one home may need to take power from another home's storage battery. The LNPG can also be a “smart grid” and the precise usage for each individual home can be calculated month by month, and if “Home A” is using less electricity than “Home B” (put another way, Home A is actually providing some of its stored electricity to Home B), then a small monthly “usage adjustment” amount can be factored into each member-household's monthly bill (see “c” below).

Since these 70 interconnected member-households are all sharing the same power source, a reasonable level of cooperation is expected, which is specifically focused on the second car battery. In other words, the primary distribution rule for the LNPG has to do with “priority” and there is a logical charging hierarchy for the matrix of “destination modules” that are all hooked into this LNPG. For example, the “primary car” for each of the 70 member-households are all at the top of the charging hierarchy. Then comes the “second car” for each member-household, and if that household knows they rarely use their second car (for example, on average they only drive 15 miles per week to do very local shopping and pick kids up from school) then that car battery can be considered by the LNPG more as a storage battery (and as a power source that is plugged into the Grid almost all the time) and the LNPG can call on that particular battery to give back some power to the Grid when required during peak usage times, as long as a substantial portion of charge is always left in that battery.
iv) for practical purposes, a LNPG can still be linked to five or six of the surrounding LNPGs, thus forming a “Local Community Power Grid” (connected together by Local Community Grid Interconnecting Lines, which can be run underground). And by the very nature of this system, any particular LNPG would then become linked to many more than just five or six other LNPGs, because these “first tier” LNPGs would also be connected to other LNPGs in an ever-widening circle going out from the “original” LNPG. (Note: this type of system would not be susceptible to a massive power outage, because each individual LNPG would still have its own MF power source and its 350+ charged batteries; this larger “community-oriented share-and-swap option” would only be used under special circumstances.) One of the key reasons for linking one LNPG to a few other LNPGs is for maintenance purposes and in the event of an unexpected breakdown of a MF device. However, as stated below in the “d” section, a MF device is expected to have very few breakdowns. Also, if a MF device is intentionally shutdown once a year for inspection and repair, the maintenance crew could come with a “portable power truck” that would have a large number of storage batteries with enough overall power to provide a level of power similar to what the MF device being worked on was providing. But also being able to supplement the power required for a disabled MF device, with power from five or six surrounding MF devices, would be a significant benefit. And of course, a scheduled service maintenance session for a MF device could be done during the night when general power demands from the device were at their lowest.
b) ownership of, or leasing rights for, a MagnaFloat device by a 70-home Neighborhood Cooperative; the size of the distribution area for a Local Neighborhood Power Grid is typically a 2-3 square block area and this determination, on a case-by-case basis, is a factor of: a) average power usage of the co-op's member-households, b) willingness by the members of a Neighborhood Co-op to pay more per member and have less members in the co-op, and c) finally (least important) how far these homes are apart from each other;

[Note: a “70-home Neighborhood Co-op” is subject to adjustment, according to the level at which electricity is used by the consumers who are living within the distribution area. In a 35-home co-op, where each member-household is willing to pay twice as much for their portion of the initial cost to purchase and install the co-op's MF, each individual home will obviously have double the amount of electricity available to use, compared to the amount of electricity available to each member-household that is part of a 70-home Neighborhood Co-op.]
c) a closer analysis of the real price for “almost free” MF-created electricity for a typical member-household of a 70-home Neighborhood Co-op is the total of three separate costs, on a monthly basis: a) an amortized cost for the initial installation, b) an on-going licensing fee to use the technology, and c) maintenance fee for the actual parts and labor to keep the device running properly. (A fourth cost element could be a small “usage adjustment” that would vary from user to user, based on actual consumption of one household relative to another household.)

Roughly speaking, if a MF device similar to that of the preferred embodiment costs about $300,000 (including installation), if the Federal Government will step in and provide federal loan guarantees to keep financing interest rates low, if annual licensing fees are $3,000 for the device, and if annual maintenance is $8,000, then a member-household for a 70-home Neighborhood Co-op could expect an Annual Electricity cost (without taxes) of about $400, but the added bonus is that this also includes providing all the electricity needed to keep Two car batteries Fully Charged for the cars owned by the residents of these 70 homes (the preferred embodiment is: the “70-home” embodiment of a MF device). This means the cost for all the electricity for the household, and to have two (electric) cars running on the street (with zero gasoline expenses), will be $33.33 per month.

One cost variable not mentioned above is whether or not local governments would try to tax the value of the electricity being consumed, even though this electricity was being created by a member-owned power source, and basically distributed only to those same member-households. Also, it is assumed the Federal Government would provide very low government-backed loan guarantees on the initial installation price of a MF device, so that the initial installation cost could be divided up into more than a hundred small payments and paid for over a ten year period, for example. In any event, each member-household would only be paying a tiny fraction (1.43%) of the overall cost of a device. The pure and simple reason for this great benefit for a member-household is that one MF device is powerful enough to provide electricity for 70 “typical” homes, including providing Electric Fuel to run two cars per member-household.

It remains to be seen whether or not a Neighborhood Co-op paying the $300,000 for the initial installation of a MF device is given ownership rights of the physical device or if paying for the device (and the installation) only allows the co-op the opportunity to have the right to license the technology (and receive the electricity), but in any event the end result for each member-household to be paying only $33 Per Month for all the electricity needed to power their home and to also run two cars is an undeniable bargain in anyone's estimation;

[Note: the electricity generated by a MF device can be delivered as alternating current, either from a special embodiment of the MF device, itself, or from a computerized “switching sub-station” that uses an array of invertors (see: 13 Topics; #13, “Alternating Current”).]
d) the actual parts used on a MF device are as a whole, “low technology” parts and therefore the overall device should function for long periods of time with little or no maintenance (the projected maintenance schedule is once per year). As stated above, almost every (non-canister) moving part on a MF device performs a simple forward and backward action. Compare this to a typical car engine with hundreds of moving parts, many of which move in full 360 degree rotations, with some of these parts spinning at 3,000 revolutions per minute. And the majority of these car engines run for 100,000 miles (five years) with the only real maintenance being to have the oil changed;
e) there is no power loss related to long distance transmission lines; after the electricity is created in a Local 70-home MF device, that electricity only travels maybe a thousand feet or so before arriving at a member-household destination;
f) electricity created by a MF device has no pollution associated with the production of that electricity. The power used to create “MagnaFloat electricity” is the non-polluting power of gravity and the non-polluting power of buoyancy. In addition, if the factories used to create the parts for a MF device also use pollution-free MF technology to power the manufacturing processes, then the carbon footprint for a typical MF device is virtually zero [except maybe for: a) the CO2 dumped into the atmosphere by the tractor trailer truck(s) used to deliver the parts and b) the earth-moving equipment used to dig the installation cavity for the MF device.]
g) duplication of a “70-home Local Neighborhood Power Grid” across a nation, and across the globe; obviously this type of technology that is providing “almost free” electricity knows no boundaries.
   There are no special requirements related to the installation and use of a MF device. The same kind of device can be installed in Seattle, Boston, Miami, San Diego, London, Istanbul or Delhi. MF technology can provide power to run homes, offices, and factories Plus all the energy currently required to power vehicles (one exception: large tractor trailer trucks may still run on gasoline). So what is ultimately important to understand about all of this is MF technology can provide all the power to run “stationary items” that are in households, offices and factories, But can also supply (and replace) all the “fossil fuel” type energy that is currently being expended on the streets and highways of the world—if people and societies are willing to drive electric cars. Imagine a world with No CO2 being dumped into the air from power plants providing household and manufacturing electricity And Also No CO2 coming out of the tailpipes of all the cars on the roads. This is the kind of world MagnaFloat technology offers—and more.

Regarding business and manufacturing applications of MF technology, there are several unique commercial advantages for individual companies, industry segments and national economies:
use of MF technology can result in game-changing advantages for manufacturing and other industrial operations. Individual factories will be able to purchase their own MF device or in the event a corporation is leasing the building it is operating out of, such as in an “industrial complex,” the landlord for the complex property will be able to put one or two individual MFs on the property that will be dedicated to supplying electricity only to that company or those companies located on the property. In any event, if a company owns its own MF device, the electricity will be “almost free” and if a company is buying electricity from the landlord, that electricity will still be “very cheap;”
products will cost less to make, the retail price of those products will go down and what is now a period of “global recession” will be transformed into a period of Unprecedented Global Growth because there will be a positive shift in the available cash that companies and consumers have. And all of this can occur while the world enjoys and benefits from perhaps the most important feature of MF technology: the quality of the environment can be substantially improved because the electricity needed for this huge upsurge in manufacturing will be totally clean and pollution free. Also, as full implementation of MF technology is achieved, nuclear plants will no longer be necessary and this result will undoubtedly make the entire world a little safer, in general. (Job Creation is another benefit of MF technology; see three paragraphs below.)

### Other Applications and Points of Interest for MF Technology

Apartments—where apartment buildings are concerned, one MF device can supply the electrical power needed for about 150 apartments (with no car battery charging), or for about 100 apartments if the building has indoor or underground parking for the residents. A building owner will own a MF device, situate it somewhere on the property, and then supply the tenants with “almost free” electricity from that MF device. Each individual apartment can be provided with a relatively small storage battery that can operate in the same manner described above, regarding storage of electrical power during the nighttime, where such power will be needed more in the daytime, even on an apartment by apartment basis. For those people who live in an apartment, who have a car but whose building does not have a parking facility, these people will still be able to experience the benefits of MF technology when it comes to charging their car battery (see next paragraph).

Electric Stations and Public Charging Nodes—returning to the subject of electric cars and how to keep all these car batteries charged if society has decided to abandon gasoline engines for “almost free” MF-created electric power, one major change is that Gas Stations will become Electric Stations. Each Electric Station will have one MF (or two) supplying electricity that continuously flows into an underground (or above ground) matrix of large storage batteries located on the (electric) station property. Perhaps five storage batteries will be combined to funnel all their electricity into what today is one “pump.” (In other words, an Electric Station with six pumps would have 30 large storage batteries connected to these six pumps, five storage batteries per pump.) Then, when people who live in apartments or in other places (where there is no access to a MF device) need Electric Fuel for their cars, these people will drive to an Electric Station and purchase a “Tank's Worth of Electricity.”

This electricity will be transferred into the individual car battery in bulk and at high speed, at the Electric Pump which the driver has chosen to stop at. Public Charging Nodes will also be available, for example, at large corporations that have very large parking lots for their employees, at downtown municipal garages and where metered parking is provided by city governments, in parking lots around colleges campuses, at large college football stadiums and at professional sports stadiums, etc.

Job Creation—is another valuable consequence resulting from full-scale implementation of MF technology. In the preferred embodiment of the MF device, the Coil Stacks on the Air Side and the Fluid Side, for example, are about 60 feet high (and the device is then proportionately about 20 feet wide; that is, where the width is the distance from the left side of FIG. 1A, the Inclined Platform 59, going all the way to the right of FIG. 1L, which shows the Pivot Bucket 261 and supporting structure).

A reasonable estimate of the overall excavation in the U.S. to fully implement MF technology, just for 70-home Residential MF devices alone (not counting commercial-related devices or electric station devices or public charging node devices), will be to create over one million “very large holes” in the ground. The preferred embodiment of a MF device with 60 vertical feet of Coil Stacks, for example, will also need ample space below the Coil Stacks to accommodate for: the lower (horizontal) portion of the device (FIGS. 1D-1G). In addition, as shown in FIG. 1L and FIG. 1A, there is an “above ground” part of the device that accommodates the “Fly into the Air” Phase 312, the Pivot Bucket Area 313, and the Inclined Platform Area 59 (the Inclined Platform Area must be above ground if the Pivot Bucket Area is above ground, because the Pivot Bucket directly “dumps” a canister onto the far upper right end of the Inclined Platform). Of course, the entire device can be put underground, which means excavating a 100 foot hole in the ground, for example, as opposed to a 75 foot hole. Then there is also the installation, within a neighborhood, of the Local Power Lines that go (underground) to the 70 homes, per MF device, plus there are the Local Community Grid Interconnecting Lines that connect one MF device with a few other MF devices that are close by.

So as MF devices are systematically installed in 2-3 square block areas, in neighborhood after neighborhood, and as MF technology becomes “the” power source for the U.S. and the world, this technological conversion to “almost free” electricity will mean probably millions of jobs in the U.S. Also, economies of other developed countries around the world will benefit in the same way, as well, and as a result American exports will grow at a very fast pace (there will be more “global money” and American products will become cheaper first; American implementation of MF technology will probably be done faster, ahead of other countries, except for maybe China). And of course the net job creation resulting from MF technology is not strictly based on jobs created at the installation sites and on increased exports, because there is also the manufacturing of parts for the MF devices, the shipping of those parts, related sales and accounting jobs, and the trickle-over benefits of people spending their salaries in restaurants, at car dealerships, in department stores, etc. It's probable that the overall “feel” of the people regarding implementation of this MF technology will be one of national excitement and urgency, where the entire country will be united in one purpose, which is to move at a rapid pace, as fast as possible, to convert the U.S. over to a nation, an economy, and a reality that uses “almost free MF electricity” as an economic liberator and as the energy backbone of the United States.

Benefits as a Stand-alone Power Source to Africa and Poor Economies; Regarding Drinking Water, Education, and Human Progress—the stand-alone aspect of a MF device as a provider of Local Electricity gives it the unique ability to be used virtually anywhere on the planet as an independent power source. It is safe to assume that philanthropic organizations will pay for individual MF devices to be installed in or around remote villages, in Africa for example, where the people living there have never had electricity because the village is situated so far away from the civilized world that power lines were never brought into the village. A MF device can provide at least three benefits in this type of scenario. First, instead of using candles at night to illuminate their huts, the villagers will now be able to have light bulbs and the children will be able to read books at night before they go to sleep. Year by year, the general intelligence level of the children in these environments should increase, simply as a consequence of these children having an electric light to read by at night. Second, with a satellite hook-up, the village can enjoy at least one “village computer” that can be placed in a larger Public Hut where, for example, 30 kids and 15 adults can sit and stand around in the room and where everyone can watch a big screen monitor, that shows images from the internet or a CNN cable news broadcast, or they might watch educational videos or videos for practical purposes or for entertainment, etc. Also different villages will be able to communicate with each other, through the internet, and they can form “village networks” and can share ideas and innovations with each other about how to improve life in these types of villages, etc.

Third, and perhaps most important, a MF device will help the village have easier and better access to clean drinking water. Along with providing a village with a MF device, a golf-cart like vehicle can also be supplied, and of course the MF device will be able to charge the battery for this vehicle. Some of the independent power from the MF device can be stored in portable batteries and these batteries can be taken (using the golf cart) to spots close to the village where water can be found down in the Earth. These portable batteries can power drilling equipment, and once water is found (relatively close to the village or even further away) a large, fully charged battery can be taken once a week, for example, to the well and those batteries can run an electric pump or some type of hoist mechanism, so that the women in the village no longer have to pull up buckets of water by hand from the depths of a well. And with the golf cart, these women will not have to walk five miles with a big jug on their head to get the water back to the village. In general, it will be so much easier for these people to: a) find water as close as possible to the village, b) use power equipment to drill the related well, c) raise the water up out of the ground by pushing a button, and d) transport themselves and their water buckets to and from the well by riding in a shaded golf cart, as opposed to walking for miles and miles in the hot sun to get to the well, and then returning to the village with a bucket full of water balanced on their head.

The Oversized Embodiment—it is important not to confuse the “Industrial Complex” manufacturing-related MF device with a MF device that is much larger in size, as described in the Oversized Embodiment. The “Industrial Complex” or individual factory MF device is roughly the same size as a 70-home Neighborhood MF device (with Coil Stacks, for example, about 60 feet high); consider that a large factory might use the same amount of electricity as 70 “typical” residential households. On the other hand, the Oversized Embodiment of an MF device uses Air Side Coil Stacks (and respective Fluid-side Coil Stacks) that are approximately 200 feet high. Also, the Oversized Embodiment operates with the idea that long distance power lines are still intact and that a group of Oversized MFs can be located 50 miles or so outside of a city, and then the electricity created by these Oversized MFs can be transmitted back into that city or transmitted to other population centers (just as electricity is distributed over the power grid in present times).

For example, a group of Oversized MFs might be installed in places where strip mining has been performed or in some other type of large crater or even inside of a mountain that was at least 400 or 500 feet high. The output from a group of Oversized MFs can be comparable to one or more large power generators being used by power companies today. Of course, even though the size of an Oversized MF would be much taller (and a little wider and deeper), the electricity produced is still clean and non-polluting. Therefore, in a transitional period while a nation is installing 70-home MFs in local neighborhoods, it may still be feasible to use Oversized MFs and existing long distance power lines to provide additional electricity to cities and residential areas by using the existing power lines. The objective, however, would be that the long distance power lines and even the Oversized MFs, themselves, would be phased out as more and more 70-home units were installed across the country, and as the cities and residential areas became “self-sufficient” and were able to get electricity from their own Local Neighborhood MF devices.

Additional Technical Discussions about the MF Device

The first highly innovative feature of the MF is that even though, in the preferred embodiment, the Fluid Column 320 has a vertical height over 50 times greater than either the width dimension or the depth dimension (depth being the distance from front to back, when looking at the diagrams), and even though this fact means that the bottommost areas (surfaces) inside the Fluid Column will be experiencing substantially high Fluid Pressures (for example, using water at a depth of 60 feet produces a pressure of about 80 psi), the Fluid Column is Not a fully enclosed structure. In fact, the bottom surface of the Fluid Column has a large open “hole” in the middle of it that is wide enough for a canister to fit through. In addition, there is a similar “hole” in the top surface of the Fluid Column, except that the “hole” on the top surface is covered by a Splash Guard 253 (FIG. 1J), which is there to basically keep Fluid from splashing out when a canister exits (flies out of) the Fluid Column; this Splash Guard is also there to help decrease evaporation of the fluid. The “tight” portion of the Fluid Column is a straight, rectangular-like structure (going upwards), and the Direction Guidance Equipment inside this “tight” portion of the Fluid Column ensure that the canisters all move upwards inside the Fluid Column with True Vertical Alignment. What is unique in the overall design of the MF is that there is always a perfectly round canister positioned in the center of the “hole” at the bottom of the Fluid Column, where the Primary Seal 232 is located (see: 13 Topics; #2, “Pre-launch Process”).

[Note: this calculation above for the psi is a combination of several factors, such as the spatial configuration of the Upper Portion of the Fluid Column (the “tight” portion of the Fluid Column) and also more importantly, the spatial configuration of the Lower Portion of the Fluid Column (the Underwater Launch Area). Even though a force of 80 psi is a fairly accurate example for one embodiment of the device, that figure is given strictly for the sake of providing some perspective on the subject of Fluid Pressure in the Underwater Launch Area. The “tight” portion of the Fluid Column has a smaller surface area in the horizontal plane than the surface area in the Underwater Launch Area and so the Fluid Pressure will be much higher in the “tight” portion of the Fluid Column than in the Underwater Launch Area, at least at these greater depths.

But even more than that, it is always possible to expand the width and depth of the Underwater Launch Area (the height remains basically at a fixed distance; FIG. 35b and FIG. 35c, respectively, compare a “regular-sized” Underwater Launch Area with an Expanded Underwater Launch Area), and the result of such an “Expansion” of the Underwater Launch Area is that the Fluid Pressure in the Underwater Launch Area, at any given height inside the Underwater Launch Area, can be greatly reduced by increasing the “width” (the dimension going from the left side to the right side) and by increasing the “depth” (the dimension going away from the viewer in FIG. 1I). A much more detailed explanation of this subject is given in the latter portion of 13 Topics; #5, “Over-sized embodiment.” This “Expanded Underwater Launch Area” sub-embodiment of the MF device is especially useful in the Over-sized embodiment, where the Fluid Side Coil Stack can be over 200 feet high, which creates about three and one-half times more Fluid Pressure in the Underwater Launch Area than there is in the preferred embodiment.]

In any event, the MF device functions properly despite the fact there is a large, permanent “hole” in the bottom surface of the Fluid Column. The reason the device can still function under that condition is that there is also a Primary Seal 232 permanently mounted around the edges of this opening in the middle of the bottom surface of the Fluid Column, and the inner diameter of the Primary Seal is made at just the right diameter and made in just the right way so no Fluid leaks out between the Lip of the Primary Seal and the outer surface of the Cylindrical Body of any canister. The other crucial factor that allows the entire MF system to operate as it does is the fact that there is Always a canister in the opening in that bottom surface of the Fluid Column.

The inner edge of the Primary Seal (this is the “Lip” and is the edge that is making contact with a canister all the way around the canister's body in the horizontal plane), is slightly curved upward and always makes contact (lies against) a canister's round outer cylindrical surface. Therefore, Fluid Pressure at the bottom of the Fluid Column constantly pushes on the outer side (top side) of the Primary Seal, causing the inner side of the Lip of the Primary Seal to press even more tightly against the outer surface of a canister's round body so there is essentially a pressurized (temporary) bond between the Lip of the Primary Seal and the (perfectly round) outer surface of a canister. The result is that no Fluid ever leaks out between the Primary Seal and the body of a canister. This one advanced design feature, alone, allows for the elimination of the entire Closed Containment Loop System.

It should be noted that the reason why a canister can Always be positioned in the Primary Seal is that: a) either a canister is being held in place by the Two Suspension Support Rods 227L and 227R (or by the Two Notch Grips 219F and 219R) while that canister is waiting for another canister to come up underneath it and support it (and push it upwards a few inches) or b) a second canister (the Lower Canister, or Ascending Canister) is perfectly positioned underneath the Upper Canister (the Upper Canister is the canister whose upper portion is sticking up past the Primary Seal “into the Fluid,” see FIG. 1I, showing the Underwater Launch Area) and this Lower Canister is holding the Upper Canister up so that the Fluid pressure inside the Fluid Column cannot simply push the Upper Canister downward and out of the “hole” where the Primary Seal is.

Without one of these two conditions existing at all times, the pressure on the Leading Surface of the (Upper) canister (see Brief Summary; Par. 8, for definition of “Leading Surface”) would immediately push such Upper Canister down through the Primary Seal, all the fluid would quickly gush down through the open hole in the bottom surface of the Fluid Column and within minutes the Fluid Column would be dry. Also, after the Two Canisters have “Coupled” and one canister is sitting on top of the other one in the Pre-launch Area, these Two Canisters together have the characteristic of being One Vertical Unit as a result of how the Nose Cone Protrusion 70 of the Lower Canister fits perfectly up into a Matching Carved-out Impression 71 that has been carved-out of the bottom surface of the Upper Canister (see Additional Technical Discussions; Canister Section, C, “Nose Cone, Matching Impression Feature”).

So this physical illusion of the Two Canisters being One Seamless Vertical Unit is another innovative design feature that allows for the (coupled) canisters to move freely through a totally open hole in the Fluid Column but yet where no Fluid ever leaks out, over an entire year of operation or over 20 years of operation of the device. During the Pre-launch Process, the Two Canisters are always in perfect vertical alignment with each other so that there is always a perfectly round surface pressing against the inside Lip of the Primary Seal to ensure no Fluid leaks out of the Fluid Column, even while the canisters are moving together upwards through the Primary Seal. When upward motion begins in the Pre-launch Process, the Ascending Canister (the Lower Canister) begins pushing the Upper Canister up and through the Primary Seal. As the process continues, there will be a point when the bottom edge of the Upper Canister and the top edge of the Lower Canister are both touching and moving through the Primary Seal at the same instant.

However, because of this Seamless Coupling technique described above, this “point of confluence” shared by the Two Canisters moves past the Primary Seal with no Fluid leaking out because the two surfaces of the Coupled canisters (the bottom surface of the Upper Canister Coupled To the Leading Surface of the Lower Canister), move through the Primary Seal as though they were one perfectly round surface. Finally, the Pre-launch is completed and the Lower Canister becomes the Upper Canister (with the same approximate four inches of that canister's cylindrical body sticking above the Primary Seal “into the Fluid”).

The original Upper Canister has now moved up high enough that it is totally inside the Fluid Column and: a) has buoyancy and b) also has the very strong additional force called the “Canister Length Pressure Differential Force” (see Brief Summary; Par. 7, “CLPDF”). At that point, both upward forces combined, are trying to push this canister up further “into the fluid.” However, the canister's upward movement is stopped by the Two Floatation Point Retaining Pins 245L and 245R. Just prior to the actual Underwater Launch, the Underwater LM-3 Launch Platform 233 is positioned directly underneath the canister (this positioning occurs as a result of the LM-3 Positioning Solenoid 238B extending-out and moving the Underwater Launch Platform 233 into the Launch Position, which is directly underneath the waiting canister). More explanation is provided on this Underwater Launch Process (see 13 Topics; #3, “Underwater Launch Process”).

Canister Section.

Another original feature of the MF is in the shape and other design features of the Canisters. However, before discussing the actual canister design, it must hereby be stated that the canisters of the current invention are unrestrained, free-moving individual elements of the overall design of the MF device and no canister is inhibited by or forced to travel within any: “closed elongated tube,” “portion of closed pipe,” “closed containment loop,” “closed passageway,” “closed loop passageway,” “closed loop system” or “containment loop.”

In addition, no canister is coupled to or attached to any other canister at any point in a Cycle by any piece of equipment used to couple the canisters together (see Brief Summary; Par. 6, “A Cycle”). Even though there is a Coupling Process, there is no physical device keeping one canister attached to the other. It is only the force of gravity and the force of Fluid Pressure pushing down on the Upper Canister that keeps the Two Canisters “coupled” together. However, there is “perfect alignment” between the Two Canisters which comes as a result of the innovative design feature of having the Nose Cone Protrusion 70 of the Lower Canister insert itself into the Matching Carved-out Impression 71 in the bottom surface of the canister above it.

In the overall MF device there are many canisters and each individual canister has a magnet inside of it, and all of the magnets in all of the canisters are of equal size. In all of the embodiments presented, the magnet is positioned towards the front end of the canister (FIG. 2a). It would be possible to move the magnet further back towards the mid-section of the canister body, but at this point there appears to be no apparent advantage to creating or presenting such an embodiment. The canisters are identical and have lengths that are multiple times their diameters. The canister design (shown in FIG. 2a) in the presented embodiments, provides several benefits:

A.) the design allows for the Largest Possible Magnet to be used that will have the Strongest Magnetic Field (and therefore will cause the largest quantity of electricity to be generated in every Coil it passes through). The Largest Magnet will also naturally be the heaviest and therefore the canister has been designed to have the maximum amount of Air Space (Air Space Chamber 72) and still be able to “make the turns” in the overall horizontal and vertical space available in Arc B 305 and Arc C 307, in the bottom Horizontal Section of the overall MF device. Without this added Air Space 72 inside a canister, the canisters would not be able to float, there would be no buoyancy, and the device would be inoperable;

B.) the canister design allows for a specifically controlled level of buoyancy to be built into the functionality of the canisters, because for a fixed inner diameter of the Air Space Chamber 72, and a predetermined combined total weight of: i) the magnet being used, and ii) the Canister Housing 69H, and any other components of the canister, then the exact amount of added buoyancy is easily determined for every millimeter of additional length added to the Cylindrical Portion of the canister body (the term “Cylindrical Portion” is used because the overall canister body also has the Nose Cone Protrusion 70 and reference to the Cylindrical Portion does Not include the length of the Nose Cone Protrusion 70);

C.) each canister is made so that its Leading Surface has an aerodynamically designed Nose Cone Protrusion 70 that extends out from that front (leading) surface, which helps reduce air friction, and in conjunction with this design concept, the bottom surface of every canister has a Matching, Carved-out Impression 71. At specific points during a Cycle when Two Canisters come in contact with each other, one in front of another or one above another (on the Inclined Platform and while sitting on the Pre-launch Launch Platform, respectively), then at those times as a result of the “Nose Cone Protrusion and Matching Carved-out Impression” feature, the two contacting canisters inherently interlock with each other, and thereby create a perfect alignment (or temporary alignment bond) and are essentially moving as one body, in whatever direction the front canister is moving, even though no permanent or attached piece of hardware is being used to create that alignment.

On the Inclined Platform the canisters move in a downward and to-the-left motion (at an angle); in the Pre-launch Area the canisters move together in basically a straight-up vertical direction. As stated above, it is essential that during the Pre-launch Phase there is absolute “perfect vertical alignment” between the Two Canisters, because the Two Canisters are sharing the same Pre-launch experience and the motion of each canister moving through the Primary Seal must be seamless, so no Fluid leaks out: i) between the Primary Seal and the edge of either of the Two Canisters, and ii) at the point where the Two Canisters are moving as a “Coupled Unit” and passing through the Primary Seal 232 together at the same time (see 13 Topics; #2, “Pre-launch Process”).

D.) there is another important, inherent advantage of the canister design that provides two very important benefits, and both are related to an Accelerating Force designated as the “Canister Length Pressure Differential Force” (CLPDF). Because the canisters are as long as they are, there is a pressure differential between the (weaker) downward force of the fluid pushing down on the top surface of a canister vs. the (stronger) upward force of the fluid pushing up on the bottom surface of a canister. This force is Not a buoyancy force, but is in fact an additional, separate and constant force that is applied on a canister all the way through the entire Floatation-ascent Phase 311 made by a canister.

This CLPDF stays in effect all the way through the Floatation-ascent Phase and does not stop accelerating the canister upward until the precise instant when the bottom surface of the canister exits the fluid. (However, the CLPDF does diminish in a linear fashion during the last “canister length of distance” before a canister fully-exits the Fluid Column. In other words, when half of the canister is out of the Fluid, there will still be an upward force on the bottom of the canister, but it will be very weak, since, for example, if the length of the cylindrical body of the canister is about 26 inches, then the upward pressure at that point will only be formed in 13 inches of Fluid, and 13 inches of Fluid applies very little upward pressure, relatively speaking.)

So the two benefits provided by this Canister Length Pressure Differential Force are: i) it increases the speed of a canister all the way up through Fluid Side Coil Stack 322. For example, for a canister having a buoyancy factor of 1.125 relative to gravity, meaning a canister by this force alone would only accelerate upwards with a force one-eighth the force of gravity, then the CLPDF will increase the acceleration of the canister all the way through the Fluid Column by about 900 Percent. (Note: a “buoyancy factor” of only 1.125 might be considered as being rather small, but this situation exists because in a typical embodiment, the weight of a magnet inside a canister is about 45 pounds. Therefore even though the overall volume of the Air Space Chamber 72 is fairly large, the main purpose of this Air Space Chamber 72 is to ensure that a canister will still float, even though there is a 45-pound magnet inside of the canister.)

To explain more about why it can be said the CLPDF increases the acceleration by 900%, for a canister whose cylindrical body is about 26 inches, and traveling in Fluid, the Canister Length Pressure Differential is a constantly-applied (accelerating) upward force on the canister that is stronger than the force of gravity by about thirteen and one-half percent (13.5%). One way to look at this is to combine these two upward accelerating forces, which gives a total upward force of 2.26 times the force of gravity (1.125+1.135). Looked at another way, since the force of gravity has already been cancelled out by the “1” in the 1.125 for the Buoyancy Factor of the canister (in this example being described), all of the CLPDF can be applied as an upward force, just as if gravity was not there. The 900% comes from this analysis: if there were No CLPDF, the total upward acceleration from buoyancy alone would be 0.125 times the force of gravity, because gravity would “cancel out” the “1” in the 1.125. But since the CLPDF does exist and is 1.135 times the force of gravity on its own (regardless of the buoyancy), the “acceleration factor” of 1.135 is 9.08 TIMES the “acceleration factor” of 0.125. So as hard as this may be to consider, what has just been described means the canisters will be moving faster going up through the fluid (a Fluid such as water) in the Floatation-ascent Phase 311 than the canisters will be moving when falling down through the Drop Phase 304 in air.

And ii) because this CLPDF is acting as an accelerating force during the entire ascent of a canister, a canister “flies higher into the air” when it exits the Fluid Column than if this CLPDF were much weaker (meaning the canisters were shorter). Since the canisters will be “shooting up” such a substantial distance into the air, this means the Pivot Bucket 261 can be placed higher in the air as a result of these combined upward forces. And putting the Pivot Bucket higher into the air also means that the Inclined Platform can have a greater downward slope, which will: a) allow all canisters on the Inclined Platform to move faster, or at least to move more smoothly (to slide), when moving down the Inclined Platform toward the Drop Point 301 (which is on the far bottom left of the Inclined Platform), and b) create room for one additional canister on the Inclined Platform because of an increased angle in the Inclined Platform (according to the Laws of Geometry).

E.) another important canister design feature is that there is a Circular Notch 73 built into every canister. This Notch is an absolute critical element to the overall functionality of a MF device, because the Notch: i) allows for the Upper Canister to be held in a fixed vertical position during the entire period when that canister is waiting for a second canister (the Lower Canister) to come up underneath it and “Couple Up” with it, and ii) the Notch is used in the Inclined Platform Area in a process that “holds back” one canister from another and creates separation between these Two Canisters (creates an Air Gap 79). There is an in-depth discussion on: the execution of this process on the Inclined Platform, why the process is even necessary, and the entire operation for all the equipment on the Left Side of the Inclined Platform 60 (see 13 Topics; #4, “Equipment on the Left Side of the Inclined Platform”);

F.) the canisters have certain areas on them where extremely hard, virtually indestructible material (such as a relatively thin layer of nano-plastic or polycarbonate plastic; titanium could be used but it is paramagnetic, and this could cause problems) is built into the canisters (74a, 74b, and 74c). These “indestructible contact areas” are there to ensure there is no wear-and-tear on the bodies of the canisters in places where: i) the Notch Pins or Notch Grips come in contact with the canister or ii) the Leading Surface of a canister comes in contact with the Slowdown Plungers Tips, 140F and 140R (FIG. 2a shows the areas where such virtually Indestructible Material is embedded into the body of a canister).

Other Unique Features of the MF Device.

Another unique feature of the MF is the highly integrated system of equipment used to decelerate a canister after it has achieved such a high velocity during its fall through the Air Side Coil Stack (its fall through the Drop Phase 304). A canister has a sizeable amount of kinetic energy when it exits the Bottommost Coil (321BC in FIG. 20) of the Air Side Coil Stack 321. The preferred embodiment of the device uses a disc magnet of approximately 45 pounds (inside a canister) and Two Coil Stacks (one on the Air Side and one on the Fluid Side) each about 60 feet high. This means that when a canister weighing a total of about 47 pounds comes out of the bottommost Coil on the Air Side, this relatively heavy object will be traveling about 40 mph (a linear motor LM-1 is used to enhance the speed of the fall on the Air Side; another linear motor LM-3, is used for the same purpose on the Fluid Side, except that LM-3 is pushing a canister Upwards on the Fluid Side), so under these conditions, the speed of a falling canister is greater than the speed a falling object attains after falling sixty feet when acted upon solely by gravity.

In any event, the MF employs Two Slowdown Plungers and other Deceleration Equipment to extract kinetic energy out of these fast-moving canisters (see Cycle-sequence Descriptions; FIG. 19, “Slowdown Area 306”). FIG. 1E shows Two Slowdown Plungers, where a Slowdown Plunger Tip, 140F and 140R, from each Plunger makes contact with the Leading Surface of the canister on each side of the Nose-Cone Protrusion 70. (In another embodiment there can be Three Slowdown Plungers, where the Plunger “Tips” are positioned in a tight, triangular shape)

These Two Slowdown Plungers serve three very important purposes: a) they gently-but-quickly slow down a canister through the use of hydraulic backpressure; b) they allow for the conversion of a majority of the kinetic energy that a fast-moving, heavy canister has by using a Hydraulic Accumulator Energy Recovery System (HAERS) 314, where the kinetic energy of the canister is converted into Fluid Pressure, and then that pressure is sent through a Hydraulic Motor, which creates rotary motion. This rotary motion is then used to turn an Electric Generator that produces electricity and the electricity is used to power some of the peripheral equipment, such as Sensors and Solenoids; c) because the speed of the canisters is being reduced in, for example, a two foot section of the lower horizontal portion of the device (shown in FIG. 1E; this distance is the exact amount of distance during which the Two Slowdown Plunger Tips 140F and 140R make contact with the Leading Surface of the canister), the Overall MF device can have a much smaller width.

This means, for example, the hole dug in the ground can be much smaller, in terms of the width of the hole. Without the Slowdown Plungers quickly reducing the speed of a heavy canister which is virtually moving like a freight train as it travels across the horizontal portion at the “bottom” of the device (FIGS. 1D-1G), the overall device would have to be about 45 or 50 feet wide, instead of 20 feet wide. But most importantly; d) it is Imperative that each and every canister have a consistent speed when it enters the Pre-launch Area 308, because the Coupling Speed of a canister has to be within a Very Tight Range when it, acting as the Lower Canister, makes contact with the Upper Canister that is waiting in the Pre-launch Area 308 to be contacted by that Lower Canister (see 13 Topics; #1, “Coupling Process”); e) in relationship to the consistent speed just mentioned, the canisters need to have More than just “consistent speed” coming into Arc C and up into the Pre-launch Area, every canister needs to have Almost Perfect Speed, within a Very Tight Range.

This Perfect Final Speed can be achieved, at least in the initial stage of the speed-reduction process, by a perfectly calibrated Hydraulic Accumulator Energy Recovery System (HAERS) 314, which is being monitored and controlled by a very precise Pressure Gauge 164. More specifically, a Speed and Motion Sensor in the Arc B Area (Speed Sensor 131) is used to precisely determine a canister's speed just prior to the canister encountering the Slowdown Plungers. In this way, the HAERS can “understand” exactly how much pressure needs to be absorbed in order to extract the required amount of kinetic energy out of the canister's movement so that the canister will be able to “Couple Up” perfectly with the Upper Canister that is waiting in the Pre-launch Area 308. This means that at the point when the Two Slowdown Plunger Retracting Solenoids 147F (and its Rear Counterpart) retract and allow the canister to continue its journey along the Roller Conveyor 121 (moving towards the Mid-section of the Roller Conveyor 318), the Hydraulic Accumulator System will essentially have manipulated every canister coming out of the Slowdown Area 306, so that each canister is moving at Almost Exactly the Same Pre-determined Speed (within a tight range of speeds) when each of those canisters exits the Slowdown Area 306.

The next key feature of The MagnaFloat is that a MF device has Three “Speed Adjustment Electromagnets” (EMs) at various points along the overall path upon which the canisters move. Specifically, the second of those EMs is designated as: Arc C Pre-launch; Speed-adjusting Electromagnet (EM#2) 195. So in continuation of the previous paragraph, a canister exits the Slowdown Area 306, moves horizontally (to the right in FIG. 1E) towards the Mid-section of the Roller Conveyor 318 (FIG. 1F) and then on to the Arc C Area 307 (FIG. 1G). The canister enters Arc C and in the far right portion of the Arc C Area the canister's direction of motion is converted from horizontal movement to a vertical movement, according to the curvature of the Section of Roller Conveyor 121 in Arc C. And also as mentioned in the previous paragraph, that canister needs to exit the Slowdown Area 306 with a speed that falls within a Specific Range.

The reason that there is some flexibility by having a “Range of (desired) Speeds” is that there are Two Speed and Motion Sensors 194 and 196, positioned above And below EM#2 195 and these Sensor Systems will “understand” if a canister is going a little too fast or a little too slow when the canister exits EM#2 195, compared to what speed a canister Must have to make “perfect contact” (see 13 Topics; #1, “Coupling Process”) with the waiting canister during the Coupling Process in the Pre-launch Area 308. Therefore, at this critical point just prior to the canister entering the Pre-launch Area 308, EM#2 195 will be able to modify (to fine tune) the speed of the ascending canister, either to speed the canister up or slow it down, by generating an Electromagnetic Pulse aimed at the magnet inside the canister.

This pulse will be sent at precisely the right time and at precisely the right strength, so that after the canister passes through this EM#2 195, the canister will be going at Exactly the right Coupling Speed to execute a “smooth and gentle coupling” contact with the canister that is waiting in the Pre-launch Area 308 directly above. Furthermore, there is even another back-up process to this Final Speed Adjustment Procedure. In addition to the Sensor below EM#2 195, there is also a speed Sensor 196 above EM#2 195. Speed Sensor 196 confirms to EM#2 195 that the first Electromagnetic Pulse has modified the speed of the canister in exactly the right manner. For any reason by the time the canister has ascended further and is at a point when the canister is partially through EM#2 195 (the magnet inside the canister has moved slightly above EM#2 195), if the speed of the canister needs to be adjusted again, then EM#2 195 still has time to send another pulse (this EM Pulse effectively acts on the canister when the canister is Above the horizontal level of EM#2 195), and the pulse will either repel or attract the canister's magnet just enough to tweak the canister's speed to the “perfect amount” required for the Coupling Process. Also, at the time when the canister is moving in front of Speed Sensor 194 (and is ready to move through EM#2 195), the speed of the canister will be relatively slow, so EM#2 195 will have plenty of time to apply the right amount of magnetic attraction or repulsion to speed up or slowdown the canister.

Another key feature of the MF device is that it uses an extensive array of Alignment Equipment and each of these “Guidance Components” is solidly, securely and permanently attached to one or more of the Main Vertical Structural Beams (for example, the Vertical Structural Beams of the 298 and 299 Beam Systems), or is firmly attached to other beams, frames and other, non-moveable parts of the MF device. There are numerous places throughout the MF device where the importance of a canister being in “perfect alignment” with another part of the device or with another canister is absolutely critical for the MF device to operate successfully. For example, when a canister contacts the Slowdown Plunger Tips 140F and 140R (while the canister is initially moving at perhaps 40 miles per hour), and when a canister comes into the Pre-launch Area 308 and then moves up under a waiting canister in the Pre-launch Area, and when a canister has flown up into the air about 18 feet and is entering the Pivot Bucket 261, all of these “points of contact” require absolutely perfect alignment between a canister and the other parts of the device the canister is making contact with. The names of the components used to execute these alignment procedures are: Alignment Rings, Quadrilateral Guide Assemblies, (Pairs of) Guide Rails, and Stand-alone Canister Guides.

The purpose of any particular piece of this Direction Guidance Equipment is Not to totally change a direction of motion for a canister in some radical way, but instead to gently tweak the canister's direction and change that direction maybe one or two degrees from the direction that the canister was moving in before contact was made with that particular piece of Direction Guidance Equipment. For example, any Alignment Ring in the lower horizontal portion of the overall device (in FIGS. 1D-1G) is there mostly to tweak canister movement related to left and right directional alignment, and not necessarily to perform up and down Alignment Tweaks. It should also be noted that in general, when a perfectly round magnet (a disc magnet, like the ones used in the presented embodiments) passes through the “inner diameter area” of a perfectly round Coil of wire, all of the interactive forces that go completely around the entire areas of these two round objects also have a Natural Alignment Effect (in the horizontal plane), that tends to pull or align the body of the magnet into the precise center of the Coil.

Another reason that the Direction Guidance Equipment has been designed to “gently” modify the direction of motion for a canister is that in no way, whatsoever, is it beneficial for a piece of Direction Guidance Equipment to confront a moving canister so that the canister's forward motion is substantially decreased. As mentioned above, the maximum amount of electricity is generated by canisters (and magnets) that are traveling at maximum speed when the magnets are in the Air Side Coil Stack and in the Fluid Side Coil Stack, so all of the Direction Guidance Equipment has been designed and placed inside the device to never actually slow a canister down (the Slowdown Plunger System is not considered as a piece of Direction Guidance Equipment). In fact, all of the edges of all of the Direction Guidance Equipment are Rounded Edges and have Round Points of Contact, at any place where a piece of Direction Guidance Equipment would be making contact with a canister (FIG. 8a, that shows an enlarged Alignment Ring, clearly illustrates this point about Rounded Edges where contact is made by an Alignment Ring with the body of a canister).

The overriding factor for the “open-air, non-enclosed” (non-containment loop) design of the MF is that since there is no “closed containment housing structure” restricting the movement of the canisters, there Must Absolutely be continuous alignment provided to the canisters, which is performed by these non-moveable Alignment and Guidance Devices. Repeatedly, these High Speed Canisters are required to fit their way through, and position themselves perfectly onto, very precisely calibrated equipment, when it comes to vertically positioning, horizontally positioning, and/or making “perfect contact” with another canister, etc. If one canister ends up in the wrong place for even one second, then the entire system will be required to shut down, repair workers will have to come out to the device, parts will have to be replaced, and things like that. But by using this efficient and essential collection of Direction Guidance Equipment, the canisters are guaranteed to always be in perfect alignment and/or guaranteed to always be traveling in exactly the right direction through an entire Cycle, for every Cycle. Ten Numbered Points of Comparison between a MagnaFloat and the Operation (or non-operation) of Prior Art

At this point in time, it appears as though none of the prior art in this field has been successfully developed beyond the patent stage, to achieve a workable and commercially viable device or method that employs the dual interaction of gravity and buoyancy to produce electricity (or to produce rotational power) for the mass public. So it is important to look closely at the specific advantages built into the MF compared to prior art, in an effort to better understand the MF and to see why the MF will be able to satisfy the long-felt and unresolved need to produce inexpensive electricity on a global scale, even though all the other art before the MF has collectively failed to achieve such an outcome. This discussion can best begin by stating the ways in which the MF does Not function; as described above, the MF does Not use a “closed containment loop,” or a “closed containment loop system,” or a “closed loop passageway,” or a “containment loop system.”

1. Prior art has, for the most part, used a Closed Containment Loop Design, which causes friction in the curved pathway portions of any such loop. But the MF sends a canister through three different types of Arcs and these are Arcs where there is No inhibiting structure or wall to slow a canister down or cause friction. Therefore, the body of a canister is not subjected to continuous “rubbing” against any walls or permanent structures of the device. Except for the contact a canister makes with the Rollers 122 of the Roller Conveyor 121 in Arc B and Arc C (see three paragraphs below), the only contact a canister has with any “inhibiting” surfaces on a MF is when the direction of a canister is simply tweaked by a piece of alignment equipment (as previously described above in the end of the last section).

All such Direction Guidance Equipment has edges that are smooth and curved, at any point where the equipment comes in contact with a canister, the angle-of-contact is such that a canister's course of direction will only be changed one or two degrees by any such contact made with these pieces of Direction Guidance Equipment. This method of aligning (tweaking) the forward direction that a canister is moving in is immeasurably better than the highly restrictive, friction producing environment of a Closed Containment Loop Design.

Furthermore, regarding friction between the canisters and any other materials used in the MF, after a canister passes through the Bottommost Coil (321BC) in the Air Side Coil Stack 321, the next component that a canister contacts is a Set of Passive Rollers 122 mounted in a Roller Conveyor 121. All of the contact that a canister makes with any Roller in the Roller Conveyor could, potentially, create a certain amount of friction; the Roller Conveyor starts in the Arc B Area and continues on across the entire horizontal portion of the bottom of a MF device, and then continues on (to the right in the horizontal plane), all the way over-and-through Arc C 307 (all of this is shown in FIGS. 1D-1G).

However, to focus once again on the Arc B Area, and more specifically the curved portion of Arc B (shown in FIG. 1D), this particular area of the device is where potentially the greatest amount of friction could develop between the fast-traveling canister and the Roller Conveyor. When a canister first makes contact with that (slightly curved) area of the Roller Conveyor, the canister is still falling in a straight downward direction, but at that “point of contact” the Roller Conveyor begins gently guiding the canister in a way that forces the canister to gradually change its direction of motion, by forcing the canister to go from moving in a downward vertical direction to moving in a horizontal direction (and to the right) by the time the canister exits the curved portion of the Roller Conveyor 121 in Arc B.

It should be noted that at the initial point when a canister first makes contact with the Roller Conveyor, there will be very little friction anyway, because at that point (on the far left of the Roller Conveyor in FIG. 1D) the slope of the Roller Conveyor is almost in a vertical direction, so this angular match between the slope of the Roller Conveyor and the straight downward direction the canister is falling will result in very little friction between the two components. But as the canister moves even a little further down and to the right, and the Roller Conveyor begins “manipulating” the canister's angle of descent, this general “area of contact” is where the potential for friction exists.

However, a set of Canister Elevation Electromagnets is incorporated into the MF device, and the purpose of these Electromagnets is to eliminate virtually all of that potential friction between a canister and the Rollers 122. FIG. 1D shows the placement of Three Canister Elevation Electromagnets (EMs), 125a, 125b, and 125c, that are an integrated part of the Roller Conveyor in the Arc B Area, and FIG. 6 shows an enlargement of how these EMs are mounted into the underside of the Roller Conveyor. These Three Electromagnets are placed at specific intervals under the Roller Conveyor in the Arc B Area. There is a Speed and Motion Sensor 124, which works in conjunction with these Three Canister Elevation EMs, and when a canister passes in front of this Sensor 124, an instantaneous analysis of the motion data is performed by the Sensor System. Then this Sensor System 124 immediately sends a signal to the first Canister Elevation EM 125a, which causes that EM to create a Counter-magnetic Field which has a specific strength according to analyzed results of the data obtained by the Sensor 124.

This Counter-magnetic Field is pulsed outward from the electromagnet of Canister Elevation EM 125a (by “Counter-magnetic Field,” this means that the pulse will be opposing the Magnetic Field that is being generated by the magnet inside the canister, and where such field is extending out past the Leading Edge of the canister). At the point when the Magnetic Field of the magnet inside the canister encounters the opposing pulse from the Canister Elevation EM 125a, the canister will be at a “fairly high” angle, in relationship to the horizontal plane (see FIG. 1D). However, since Canister Elevation EM 125a is also positioned at roughly the same High Angle as the canister (relative to the horizontal) at that “point of contact,” the net result of this Counter Force by the EM on the canister will be that the canister is gently “lifted off the Roller System” (or “gently pushed away from the Roller System” to the right) for a brief instant, in that particular area of the Roller Conveyor 121 around where Canister Elevation EM 125a is.

This “pushing away” effect will only last for a split second (and the exact distance of how far away from the Rollers the canister is pushed depends on how strong the Electromagnetic Pulse is that was created by Canister Elevation EM 125a), but this “pushing-away” force will be enough to create an effect for the canister of “floating over the Rollers.” In other words, the Leading Edge of the canister will not be making blunt contact with the Rollers 122 as a result of this “pushing-away” process. Then, in a predetermined sequential manner, Canister Elevation EMs: 125b and 125c will also each “fire off a pulse” in accordance with the anticipated and calculated movement of the canister through the Rollers 122 (to the right), which was accurately analyzed and predicted by the Sensor System 124 according to the original analysis of the Motion Data taken from the canister's movement by the Speed Sensor 124.

So the end result is that all the way through this process of a fast-moving canister being forced to change its direction of movement from the “vertical” to the “horizontal,” by the Roller Conveyor forcing the canister to make those changes, in fact the canister will basically never have made “strong” contact with any of the Rollers and will have essentially “been guided along over the Rollers as if the canister had been floating in air.” Even though this whole process of three Electromagnetic Pulses will have been executed in terms of thousandths of a second, as one electromagnet has fired and then the next in the sequence, etc., this process will impede deterioration of: a) the Roller System, b) the front (leading) edges of the canisters (the “Indestructible Strip” 74c on the Leading Surface of a canister; FIG. 2a), and c) the overall front portion of the body of the canister. These canisters are very heavy and are traveling very fast, and also a Cycle occurs approximately every 5 seconds (17,280 times per day). Therefore, it is imperative that a system like this, to “float a canister over the Rollers,” be included as an integral part of the overall MF device, to minimize either direct wear-and-tear on all the related parts and/or to minimize overall vibration on the entire Roller Conveyor System, and everything else connected to the Roller Conveyor System. This same process of “pushing a canister away from the Rollers” is also used in the Arc C Area 307 (FIG. 1G).

2. Because the MF does not use a Closed Containment Loop System, much more heat can be dissipated out of the device because in every place but the Fluid Column, heat can drift off into the ambient air environment. This is of considerable importance because the magnets and the Coils will continually be generating heat every time a magnet passes through a Coil and electricity is produced. Also counter-EMF is generated by the Coil; this counter-EMF works against the forward movement of the magnet and the canisters and contributes to the creation of additional heat. Use of a Closed Containment Loop System works in just the opposite manner; any heat generated by the magnets Must, by definition of the Closed Containment Loop System, remain inside the loop and all of this heat will just keep increasing more and more every time a magnet passes through a Coil.

3. Any system that uses a restrictive “closed containment loop” as the primary structure over (or through) which the canisters (or capsules or magnet-objects) travel, prevents the overall device from having and using other essential equipment that must be built into the device to monitor, control, speed-up, and slow down canister movement, etc. The MF, by using an “Open and Free Design with a Series of Non-restrictive Pathways” for the canisters to travel down, on, through, over and up, creates a general situation where there is ample room to utilize many valuable pieces of peripheral equipment that can come in direct contact with the canisters and essentially this peripheral equipment can manipulate and fully control the movement of a canister in all the different ways required for a device to operate successfully and produce substantial (net) amounts of electricity.

4. Apparently no related prior art has used any equipment to decelerate a magnet capsule (or “object with an enclosed magnet”), as such magnet capsule has traveled around any “loops” or traveled in other manners in the process of generating electricity or generating other types of power. The MF, in the preferred embodiment, uses two (or there could be three or four in other embodiments) Slowdown Plungers, in conjunction with the HAERS to decelerate the canisters. This not only helps keep the overall device compact where the maximum width of the device is concerned (because the overall size of the entire MF device is in part determined by how quickly the canisters slow down during their horizontal movement at the bottom of the MF device), but also provides a way to Recycle Power, by converting the kinetic energy of a traveling canister (moving through the horizontal area shown in FIG. 1E) into a final form of converted energy, electricity (generated by the Energy Recovery Equipment shown in FIG. 1E-2).

In Shin's '574 patent where it is said, “The only energy consumed in the BDS is through the operation of the capsule injector and, if used, a refill pump for recycling the liquid utilized. Thus, with the appropriate design characteristics, the BDS can be a self-sustaining system,” the fact that the MF has an Energy Recovery Mechanism built into the design of the device, means that the energy recovered through the HEARS can be used to provide (recycled) power for many of the peripheral devices used to enhance the speed of the canisters on a continuous basis, Cycle after Cycle. When compared to Shin's '574 device, because the MF device makes use of this available kinetic energy (as opposed to allowing the kinetic energy of each canister at the end of each “fall” through the “gravitational section” to be wasted by having one canister smash into another canister at very high speeds), the net result for an MF device of Recovering and Recycling this (kinetic) energy is like receiving a substantial portion of these important benefits from those peripheral devices for free (from an energy consumption standpoint), since no outside energy source is required to operate a majority of those pieces of peripheral “speed-enhancement” equipment.

That is not to say the amount of energy recovered by the HAERS will be enough to power all of the peripheral equipment, but as a result of the tremendous amount of electricity generated by the overall MF device, a small portion of that overall electricity (like three to four percent) can be used as Operational Electricity for the device, so that any particular piece of peripheral equipment that is Not being powered by the Recovered Energy System can receive the energy it requires to function properly from the Operational Electricity available.

5. Since no prior art has used deceleration equipment anywhere along the inside of a “closed containment loop,” there has been no way to regulate what happens when one canister is at the point of impacting another canister, especially at the point when a “capsule” (from Shin's '574; or a “magnet object,” in general) is reaching the bottom of its “fall” through the “gravitational section,” or through any other similar medium. The MF solves this problem and in fact one canister makes contact with another canister (in the Pre-launch Area) with a firm but gentle continuous motion (see 13 Topics; #1, “Coupling Process”).

This whole “gentle contacting action” is performed by using: Two Slowdown Plungers 141PF and 141PR, Various Alignment Rings, the HAERS, a Roller Conveyor 121 in Arc C 307, another Alignment Ring 193, Two Speed and Motion Sensor Systems (194 and 196), a Speed-adjusting EM#2 195, a Pair of Suspension Support Rods (227L and 227R), the Release Movement of Two Notch Grips 219F and 219R, a Pair of Spring Matrices, 211SpL and 211SpR (to cushion the short fall of the Lower Canister downward), a Pair of Pre-launch Launch Platform (halves) 211L and 211R, and a Pair of LM-2 Positioning Solenoids 216L and 216R (as shown in FIGS. 1E, 1E-2, 1F, 1G, and 1H). Obviously this overall sub-system is extremely sophisticated and highly beneficial, as opposed to the methodology of the '574 patent, where one falling capsule simply crashes into another capsule that is waiting at the bottom of the “gravitational section” ({Shin-140}).

6. With special attention being given to the Shin '574 device, it is not clear that the capsule description for that device describes a capsule that will actually have buoyancy. This condition exists as an inherent flaw in the “Containment Loop” System, itself. The MF has no such problem regarding canister length (vs. canister diameter), and as shown in FIG. 2a, a canister used in the MF has a length which is multiple times its diameters, thus there is no doubt that a canister will have the power of buoyancy. This highly advantageous design component is made possible because the MF device uses a series exposed, unobstructed, open and in the case of the Fluid Column, open-ended sections of a seamlessly connected and integrated pathway upon which the canisters travel. This non-restrictive environment, with no “tight turns” allows the canisters to hold much larger magnets and this circumstance therefore provides the sought-after advantage of being able to produce more electricity in each and every Coil that these large magnets (and canisters) pass through.

It is worth noting that even the current professional dictionaries help to show the differences between Shin's '574 device and the MF device. The word “capsule” is defined as: a cylinder capped with hemispheres; a compact, often sealed, and detachable container or compartment (noun); extremely tiny or small and very compact (adj); a small case or container, especially a round or cylindrical one. The word “canister” is defined as: an often cylindrical container for holding a usually specific object or substance; round or cylindrical container; Synonym: barrel, can, drum.

The canister shown in FIG. 2a is only one example of the canister length vs. diameter; canisters for a MF device can be made even longer for the sake of having more buoyancy or holding larger magnets. However, as the length of the canisters is increased, then the rate of curvature of Arc B and Arc C must be “flattened out” and this design modification increases the overall dimensions of the entire MF device. Specifically, the “tightness” of Arc B and Arc C determines the overall horizontal distance between the Air Side Coil Stack and the Fluid Column. This horizontal distance, in fact, could roughly be considered as the “width” of the overall MF device. Therefore, according to how long the length of a canister is, this determines how wide the hole in the ground has to be or how wide the building has to be that will house the MF device, because of the relationship between the length of the canisters and the overall width-size of Arc B and Arc C. The overall MF device must, by nature, become taller and wider as the canister length is increased, so that each canister can “make the turns” properly through an Arc B and Arc C that have been “flattened out.”

7. Unlike the condition in Shin's '574, where it is evident the capsules will be unable to separate from each other (due to the magnetic attraction between adjacent capsules), at the point when one capsule is supposed to be pushed away from anther capsule and/or at the point when a capsule is supposed to “float away” into the '574 capsule injector (Shin-{110}), in a MF device, because of the Elongated canister (FIG. 2a) that is used, it is totally obvious there will be No magnetic attraction between the magnets in two adjacent canisters and therefore no magnetic forces, whatsoever, will ever inhibit any individual canister from separating from any adjacent canister, at any point along any of the pathways of a MF device. (It's worth noting that the absolute first design feature considered when the MF device was first designed was how to keep the magnets far enough apart from each other so that each canister would be “Magnetically Separated” from any adjacent canister. So in fact, the final design of a MF device is basically an extension of this first requirement of having a substantial distance between any adjacent magnets. And the second key issue in the initial design of a MF device was how to keep all the Fluid from falling out of the “hole” in the bottom of the Fluid Column.)

8. Unlike the condition explained in Shin's '574, where the patent describes how the design of the device calls for water to be exiting out of the device (into the “drain” Shin-{160}) as part of the routine operation of the device, the MF, in either the first set of embodiments or any other embodiments, has been specifically designed Not to lose Fluid (such as water) by having that Fluid leak out the bottom of the device (leak out through the “hole” in the bottom surface of the Fluid Column 320). And with respect to an alternative embodiment of the MF (the Over-sized embodiment, FIG. 1D-oz), Fluid is not allowed to exit the device at the point when the Fluid is exiting the Fluid Turbine Area 416.

The only expected loss of Fluid (such as water) from the Fluid Column, the Fluid Reservoir 419 (in the Over-sized embodiment) or from any embodiment of the MF is through evaporation, and those losses will be minor and are even further reduced by the use of Three Splash Guards, 253, 405, and 460, respectively, at points where canisters: a) exit the top of the Fluid Column in the preferred embodiment and the Over-sized embodiment, and b) for the Over-sized embodiment, when a canister: i) enters through Mouth of Low Pressure Fluid Reservoir 404, and ii) leaves the Fluid Reservoir 419 at the Exit Opening 459.

9. With further respect to point #3 above, regarding how it is impossible to put additional equipment inside the containment housing of a Closed Containment Loop System (for example, no equipment can be placed inside the “containment tube” of Shin's '574 because the containment housing walls are in effect, the “Alignment Guidance System” for the capsule motion), this design and (non)functionality feature of the '574 device dictates that there can be No Launch Enhancement Equipment used to give the capsules (in Shin's '574 device) initial velocity, either downward at the beginning of the Drop Phase (Shin's “gravitational section”) or upward after a capsule is coming out of the “capsule injector” (Shin's “buoyancy section”).

On the other hand, because The MagnaFloat uses an “Open and Free Design with a Series of Non-restrictive Pathways” upon which the canisters can move, Four Linear Motors are used overall, and Two of those Motors (Linear Motor #1, FIG. 1B and Linear Motor #3, FIG. 1I) are used to add initial velocity to the motion of the canisters. LM-1 96 is used to increase the downward speed of all the canisters on the Air Side (LM-1 96 is positioned near the top of the Drop Phase 304) and LM-3 236 is used to increase the upward speed of all canisters on the Fluid Side (LM-3 is positioned at the very bottom of the upward Floatation-ascent Phase 311). The third pair of linear motors (Linear Motors 218L and 218R, FIG. 1H) is a pair of Pre-launch Motors that collectively lift Two Canisters up together, in a Pre-launch Process, with the final result being the Upper Canister completely enters the Fluid Column and is lifted by buoyancy a short distance into the Launch Position (inside the Underwater Launch Area 310). As stated above, LM-3 236 is situated completely inside the Fluid Column, and therefore is immersed in and completely surrounded by the fluid (a Fluid such as water), thus this situation has spawned the name: “Underwater Launch Area.”

10. Again with respect to U.S. Patent '574, and again as a result of a “Containment Loop System” allowing for no equipment to be put inside the containment loop housing structure, the amount of electricity that the device in '574 can produce is automatically minimized because the Inner diameter of the Coils is far greater than it has to be, as compared to the design feature in the current invention where the Coils can be placed in a way so that the “Air Gap” between the outer surface of the magnetic object (inside a “capsule” or “canister”) and the inner (open) area of the Coil, is as small as possible. As noted above, the Coils in Shin's '574 must be mounted on the Outside of the containment housing because there is barely enough room for the capsules to travel through the “tubes” or “pipes” by themselves, without having any other peripheral equipment inside the tube(s). The maximum amount of generated electricity (when a magnet passes through a Coil) will be achieved when the inside diameter of a Coil is just slightly larger than the outside diameter of the magnet that is passing through that Coil.

Obviously in the present invention, as well as in Shin's '574 device, the thickness of the body of a canister or capsule will also need to be accounted for. This condition will automatically mean the inner diameter of the Coils will be approximately three-eighths inch to one-half inch wider than the outside diameter of the magnets, regardless of any of the other factors being discussed in this sub-section. However, because the MF is designed to use the Open, Unrestricted Method of Travel for the canisters, the Coils of a MF device can be made so the inside diameter of each Coil is just slightly larger (for example, one-quarter inch) than the outside diameter of the canisters. The MF does Not rely on any “inner walls” or “tubes” or “pipes” to keep the canisters in proper alignment, because this is done through the use of various highly calibrated Direction Guidance Equipment, specifically: Alignment Rings, Quadrilateral Guide Assemblies, (Pairs of) Guide Rails, and Stand-alone Canister Guides. The configuration of the Coil Stacks and the related Mounting Components, with respect to how the Coils and Alignment Rings are arranged in relationship to each other and also how the canisters will be traveling directly inside the Coils (with minimum air gap), on both the Air Side and in the Fluid Column can be seen in FIGS. 1C, 1I, and 1J, respectively. FIG. 1K shows the configuration of Above Ground Coils.

### Summary of Features of The MagnaFloat™ Device and Conclusion

Below is a list of many technical features and advantages found in the preferred embodiment of the MF, which are:

an array of different types of Direction Guidance Equipment spread throughout the device that continuously keep the canisters in perfect alignment;

a variety of other equipment that is all positioned close to the canisters so that this equipment can make direct contact with the canisters and perform a number of different procedures on the canisters to maximize the electrical output of the overall MF device and ensure that other necessary tasks for the continued operation of the device are performed at exactly the proper time;

Four Linear Motors used, whereby two of these Linear Motors provide Enhanced Launch Force to the canisters and the third pair of Linear Motors operate during the Pre-launch Process on the Fluid Side of the MF device to bring the topmost canister up far enough so that the canister moves past the Primary Seal and moves to a Launch Position “inside the fluid” and whereby such Pre-launch Process also causes the Lower Canister to become the Upper Canister;

Slowdown Plungers used to recover precious kinetic energy from the fast-moving canisters, as opposed to prior art where moving “capsules” or other magnetic objects were never decelerated by any equipment and in some cases the only way such objects or capsules were decelerated was by crashing into another (semi-stationary) capsule;

use of a Hydraulic System coupled to the Slowdown Plungers. The process of recovering kinetic energy (from canisters moving horizontally) is performed by a Speed and Motion Sensor being properly positioned and implemented so that the speed of a canister just prior to contacting the Slowdown Plungers is known. Therefore, the Hydraulic System also “knows” beforehand exactly how much kinetic energy must be extracted from the speeding canister, so that when the Slowdown Plungers retract and “get out of the way” of the canister, the canister will have just exactly the right amount of energy (velocity) remaining to be able to move into the Pre-launch Area (after moving through the Arc C Area and heading up vertically) in such a way that this “Lower Canister” will make contact with the other waiting canister (the Upper Canister) in the most firm but gentle way possible. Yet the amount of kinetic energy a Lower Canister has for this “coupling-contact” must definitely be enough (upward force) so that both canisters will be lifted up approximately four inches, before the Lower Canister exhausts all of its upward momentum. In addition, the Fluid Pressure within the Hydraulic System is precisely monitored by a Pressure Gauge throughout this entire Energy Recovery and Recycling Process, so that total accuracy is achieved with regards to: a) the specific amount of kinetic energy the canister is left with when the Slowdown Plungers are retracted, and b) the exact point when a canister must be “released” by this Hydraulic Accumulator Energy Recovery System so that the canister will actually retain that specific amount of kinetic energy as it leaves the Slowdown Area and continues traveling towards the Pre-launch Area;

a canister design that: a) allows for the largest possible magnets to be used, b) allows for the buoyancy force of the canister to be adjusted in the manufacturing stage, so that a Set of Canisters for a particular application can have exactly the specified amount of buoyancy (which will dictate the height of the Fluid Column and the height of the Pivot Bucket above the top of the Fluid Column, for a particular amount of electricity that needs to be generated by the device), c) is aerodynamically designed to reduce friction and drag, d) has an interlocking features that keeps “Seamlessly Connected” Adjacent Canisters moving as if they are one body, e) provides an additional upward force (Canister Length Pressure Differential Force) in the Fluid Column because of pressure differentials between the top (leading) surface of the canister and the bottom surface, f) has a Notch going completely around the canister (and parallel to the top and bottom surfaces) which is used for a critical positioning procedure during the Pre-launch Phase and is also used on the Inclined Platform to get separation between two adjacent canisters, and g) is designed with virtually indestructible titanium-like material permanently inserted in critical areas where wear-and-tear would be expected (such wear-and-tear would occur more rapidly if not for this special, non-degrading material being there);

a Pivot Bucket System that “catches” a canister high in the air and allows the canister to be deposited onto the Inclined Platform, so that the canisters will have self-initiated downward motion toward the Drop Point (as a result of gravity pulling the canisters down the Inclined Platform); no outside power is required to move the canisters, either: a) out of the Pivot Bucket or b) from the top of the Inclined Platform over to the Drop Point;

a variety of Electromagnetic Coils that generate electromagnetic “pulses” that can push up the Leading Surface of a fast traveling canister, so that the leading (contacting) surface of the canister will not “eat into” the Roller System. This “floating on air” innovation helps eliminate friction between the canisters and the Rollers on the Roller Conveyor and helps eliminate wear-and-tear on: a) the front edges of the canisters, and b) the Rollers;

Three Speed-adjusting Electromagnetic Coils used to fine tune the speed of a canister before it reaches a contact point with another canister or another piece of permanently-mounted equipment;

Two Sets of Spring Matrices and Four Pairs of Solenoids (these Solenoid Pairs are attached respectively to individual Springs). The Two Sets of Spring Matrices help a canister make contact with other surfaces in the gentlest way possible, which also helps preserve the integrity of the canister housings and the life expectancy of all the magnets. The individual solenoids attached to Springs make use of the Impact Cushioning Property of the respective Springs so that the Springs can absorb a substantial amount of “shock,” each time a canister makes contact with these bodies and compresses these Springs;

a pair of Notch Grips that allow a canister to be positioned in such a way that the top of the canister is inside the Fluid Column (and experiencing very high pressures from the weight of the fluid; a Fluid such as water), while the bottom of the canister is exposed to the air and is only feeling typical ambient air pressure.

a sophisticated combination of accelerating and decelerating Electromagnetic Coils are used in conjunction with a rotating Pivot Bucket, and as a result of coordinating all of these components as the Pivot Bucket is being rotated, a canister can quickly be “ejected” out of the Pivot Bucket so that within two or three seconds the canister can go from being inside the Pivot Bucket to being positioned on the Inclined Platform and becoming part of a “Waiting Cue” of other canisters that will move down the Inclined Platform, one “cue position” at a time, and systematically enter the Drop Phase of a Cycle.

### Conclusion.

Going beyond the prior art, and considering what is currently accepted as “viable” alternative energy sources, MagnaFloat technology has an obvious advantage over wind and solar power, in that MF technology is not dependent on the weather to produce electricity. Comparing MF technology to the burning or combustion of oil, natural gas, and coal, MF technology produces electrical energy without emitting CO2 into the atmosphere. Comparing MF technology to nuclear power, MF technology produces electricity without emitting harmful radiation. These features, objectives, and clear cut advantages will become apparent to one skilled in the art as the functionality of The MagnaFloat is disclosed in the accompanying drawings, detailed descriptions and appended claims.

Summarizing the social benefits and objectives of MF technology, the existence of the MF device signifies a revolution in the way people think about electricity, at the most basic level. A MF device can provide local, “almost free” electricity that is generated “just down the street.” A MF device creates no harmful greenhouse gases, works 24 hours per day with little or no maintenance, and can basically eliminate the need for unsightly long distance power lines to be running all across the country (and the planet).

Without going into detail on these figures, calculations have been made which show that a MF device built along the lines of the preferred embodiment produces about 1,620,900 kWh of retail electricity per year. Using U.S. Dept. of Energy statistics that show for some current-day power plants, one metric ton of CO2 is emitted into the atmosphere for every 1,120 kWh of delivered electricity. According to these numbers, this means that for each MF device installed and used in the U.S., about 1,447 metric tons of CO2 will be kept out of the atmosphere each year (1,620,900/1,120). And this statement does not even take into account the idea that a substantial portion of that MF-created electricity (if people convert to electric cars) will not simply be going to run household items, but will be used to power cars. Therefore, the 1,447 metric tons of CO2 kept out of the atmosphere each year per MF device is an artificially low amount, because the percentage of MF-created electricity that is used to power cars will cause this number to increase.

In any event, the objective is to reach the point where: a) virtually all the CO2 emitted by all the cars in the U.S. is stopped, b) for each fully-operational MF device in the U.S., a minimum of 1,447 metric tons of CO2 is kept out of the atmosphere Each Year, and c) there are over one million 70-home MF devices operating in the U.S. Upon reaching that objective, then a minimum of Two and One-Half Billion Metric Tons of CO2 will Not be entering the atmosphere Each Year, in the U.S. alone, because MF technology is being used to provide electricity to run homes and power cars (calculated as: 80% of electricity going to household operations stops 1.15 B Metric Tons and 20% of electricity to cars stops 1.35 B metric tons of “tailpipe emissions”). Extrapolate this scenario into one of global scale, and the true environmental benefit of MF technology, for the human race and for the planet itself, becomes obvious. And this objective is possible to reach because MF technology gives people legitimate hope built around real results, on an economical level and also on an environmental level. MF technology and “almost free” electricity is the smart choice for our future.

And also MF-created electricity affects people at even a deeper personal level; it is electricity made “just down the street, made just for me.” For example, people living in cold states (like Maine) will be happy to see their home heating bills come down to only a few dollars each month, thanks to their Local MF device. (Canadians will also greatly appreciate MF technology.) Because of a MF device operating in a remote spot in Africa, villagers will experience electricity for the first time, will have easier access to drinking water, can use light bulbs at night instead of candles, and may have their first encounter with a computer screen. People wanting to preserve the environment for their children will be able to drive a pollution-free electric car, and only pay a fraction of a penny per mile to do so, thanks to the MF device operating on their block. Plus people out of work will have jobs: creating and delivering parts, installing devices, and more.

From now on, there will be No scientists, environmentalists, politicians and regular citizens crying out that the “U.S. should get off its dependency on foreign oil.” There will be No pleading cries for someone to “find a clean source of energy to help stop global warming.” The reason for this is that The MagnaFloat is the embodiment of, realization for, and answer to both of these appeals. Today someone speaking about The MagnaFloat would probably call it an “Alternative” method of power generation, but later in this decade getting power from a MF will become the “Norm” and every other power generation source (except hydroelectric power from dams) will become the “Alternative” or the “ex-alternative.”

Because of numerous unique operational features incorporated in the present invention, the MF device goes far beyond all prior art in terms of a realistic design that will in fact function successfully. Put another way, The MagnaFloat solves operational problems in the prior art that have heretofore never even been recognized. Obviously no patent can be awarded to someone granting them the exclusive rights to use the concept of gravity, buoyancy, and the idea of producing electricity by passing a magnet through a coil, even though perhaps others have tried to do that. In the case of the present invention, The MagnaFloat combines these three very powerful forces, and much more, into one unique device that is unlike any other device that has been disclosed previously. The first and biggest difference is that it works.

### BRIEF DESCRIPTION OF THE DRAWINGS

FIG. 1A is a front view of the Inclined Platform 59.

FIG. 2a is a side sectional view of a canister. A Full View of a canister is shown with “phantom lines” as PhC, in FIG. 1B, but for the sake of clarity, no indication is given in FIG. 1B that shows the plane upon which this sectional view of the canister in FIG. 2a is taken. This side sectional view in FIG. 2a merely shows a round canister (with Nose Protrusion 70, Matching Impression 71, Circular Notch 73, and various insertions of “indestructible material,” 74a, 74b and 74c) cut right down the middle.

FIG. 2b is a front view of a canister.

FIG. 2c is an enlarged view of a Countersunk Screw 78 that attaches the Magnet Enclosure Inner Partition 76 to the Inner Canister Wall 69H. The hatched line areas in FIG. 2c correspond with those Same Two Components that are shown with hatched lines in FIG. 2a.

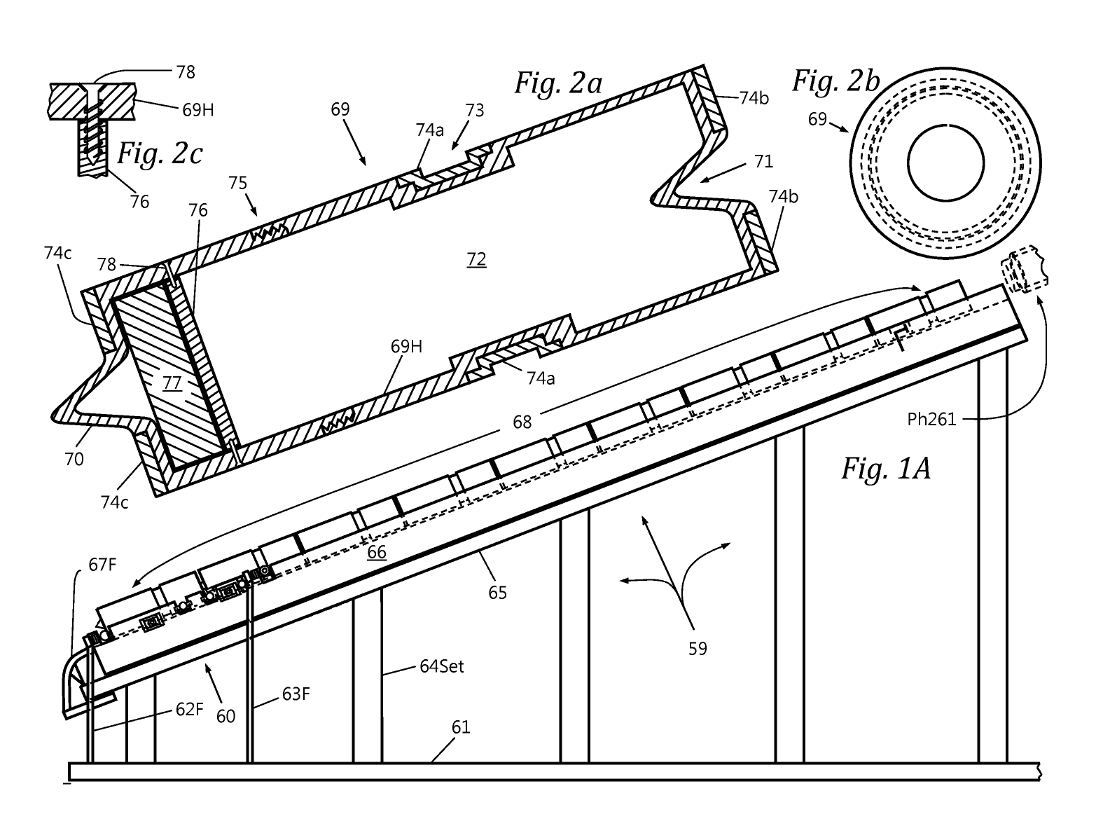

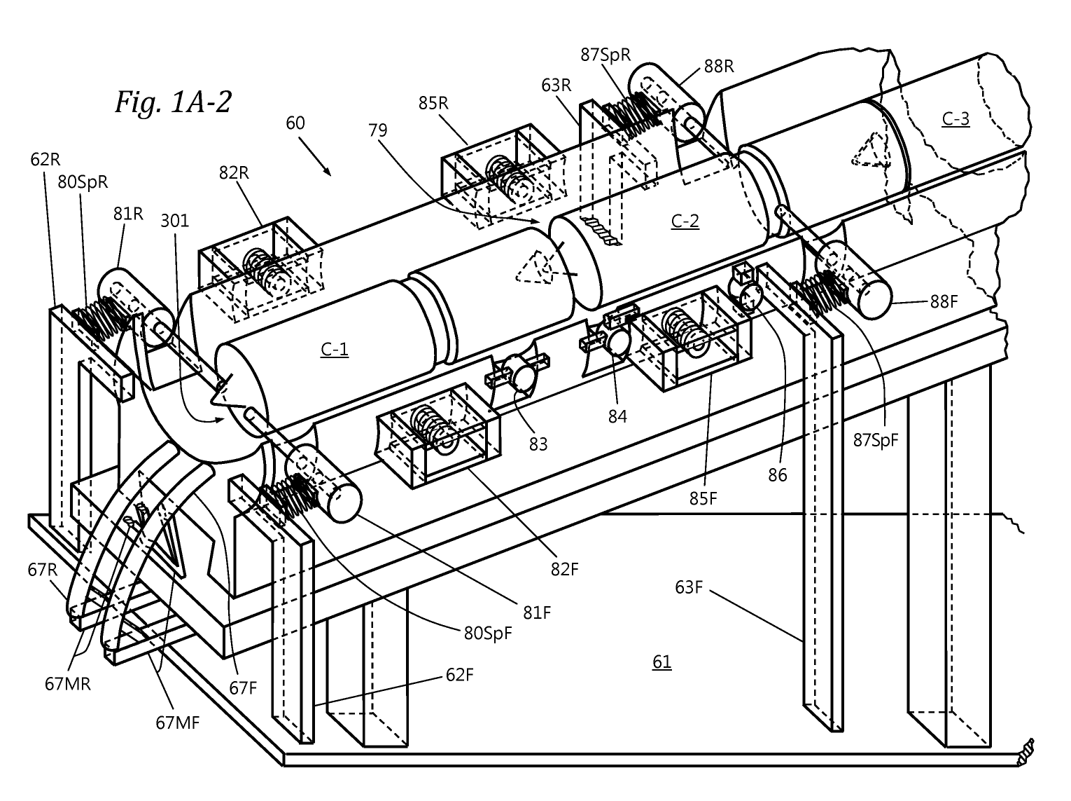

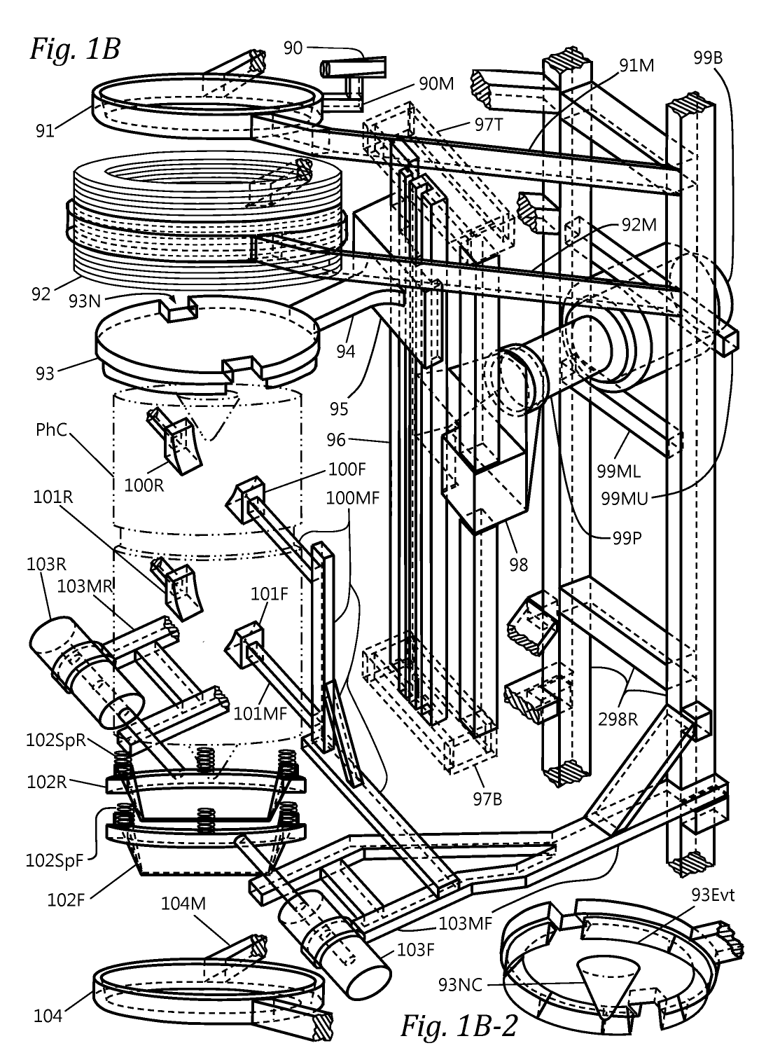

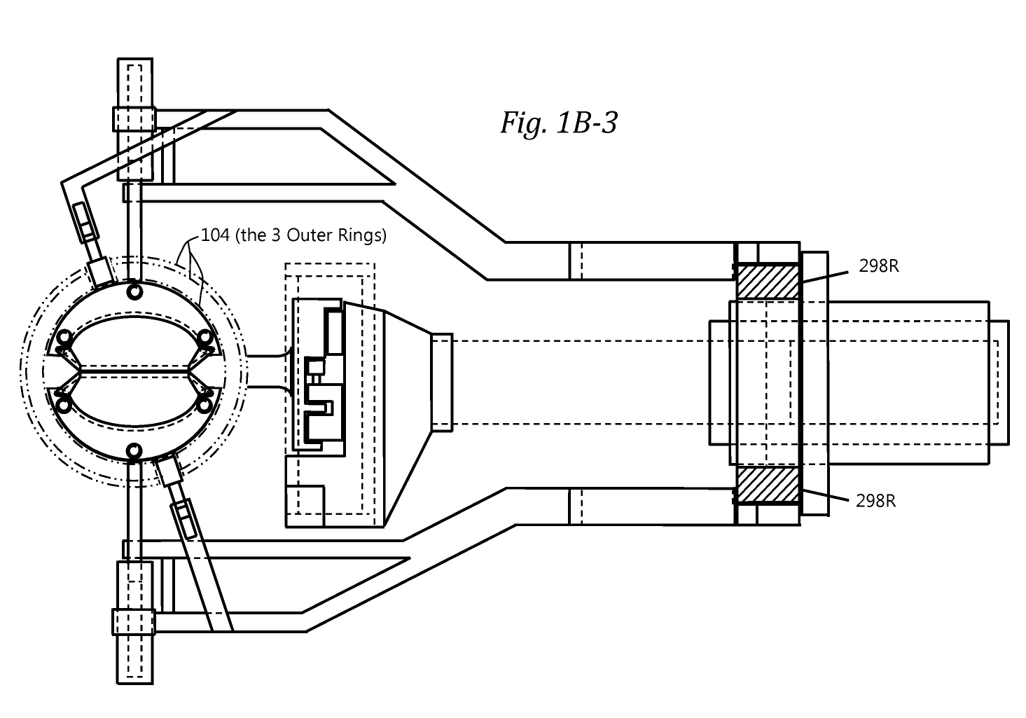

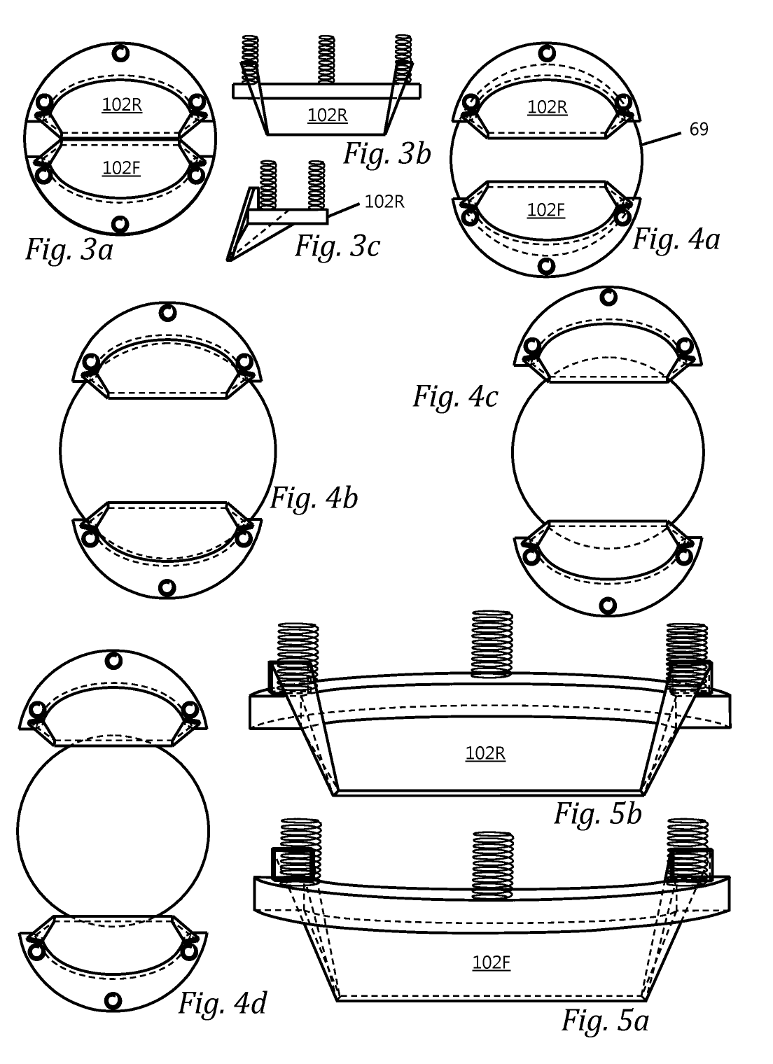

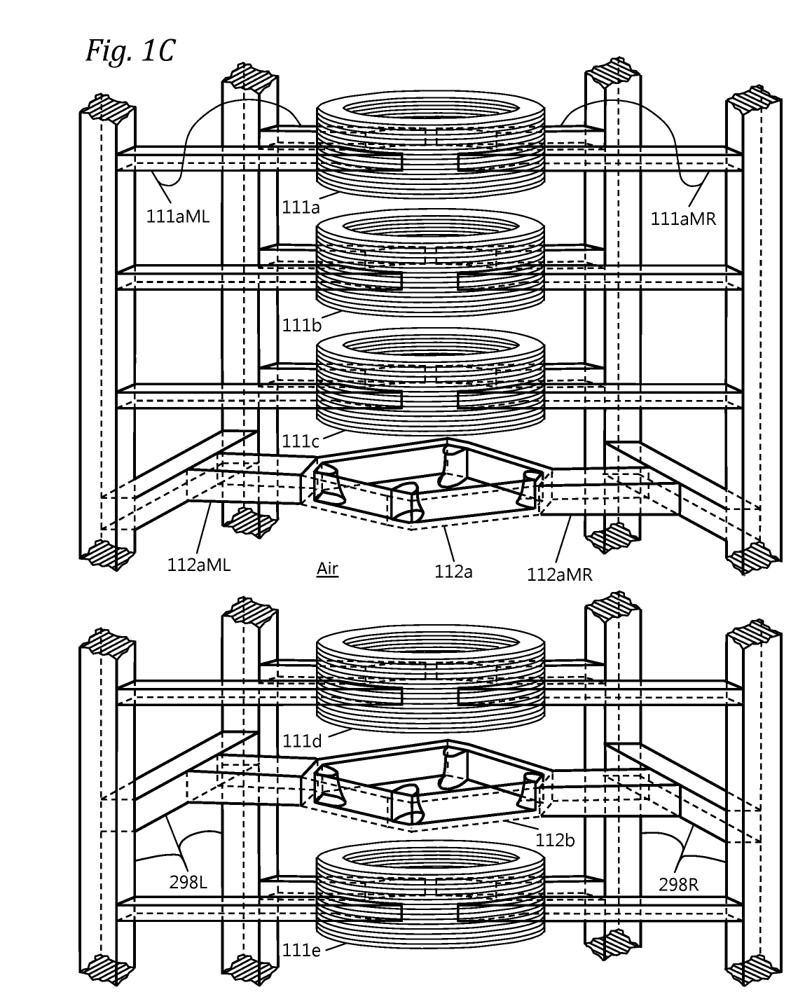

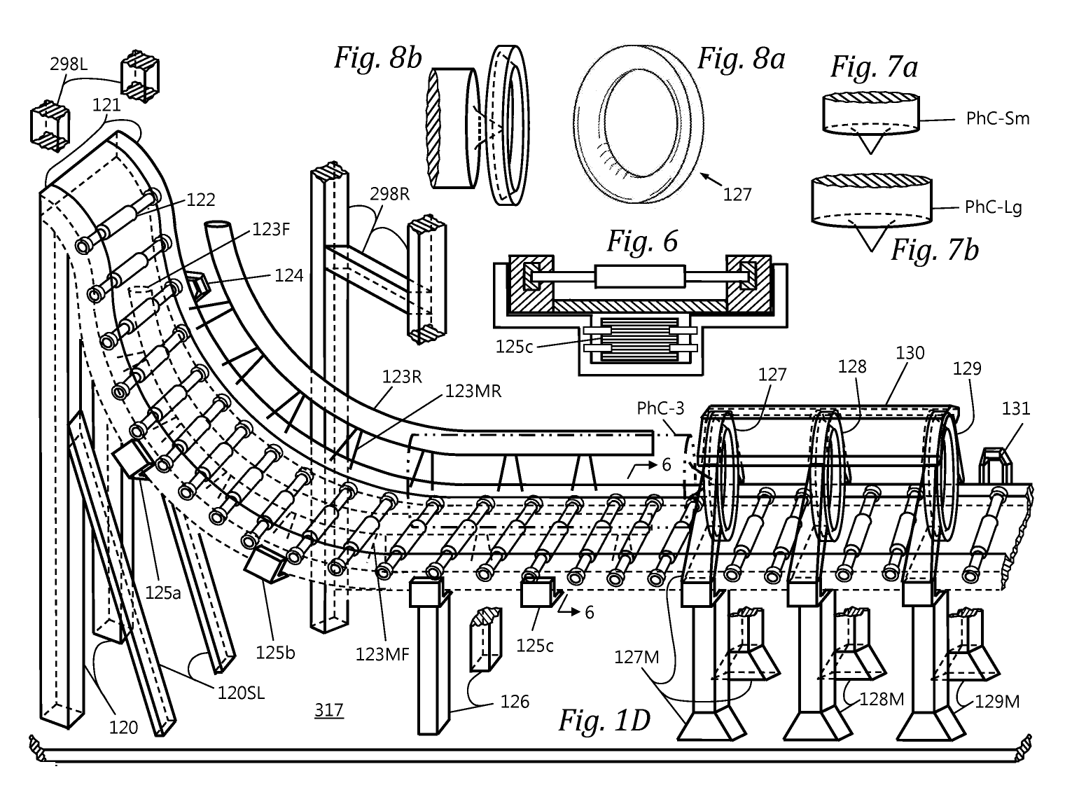

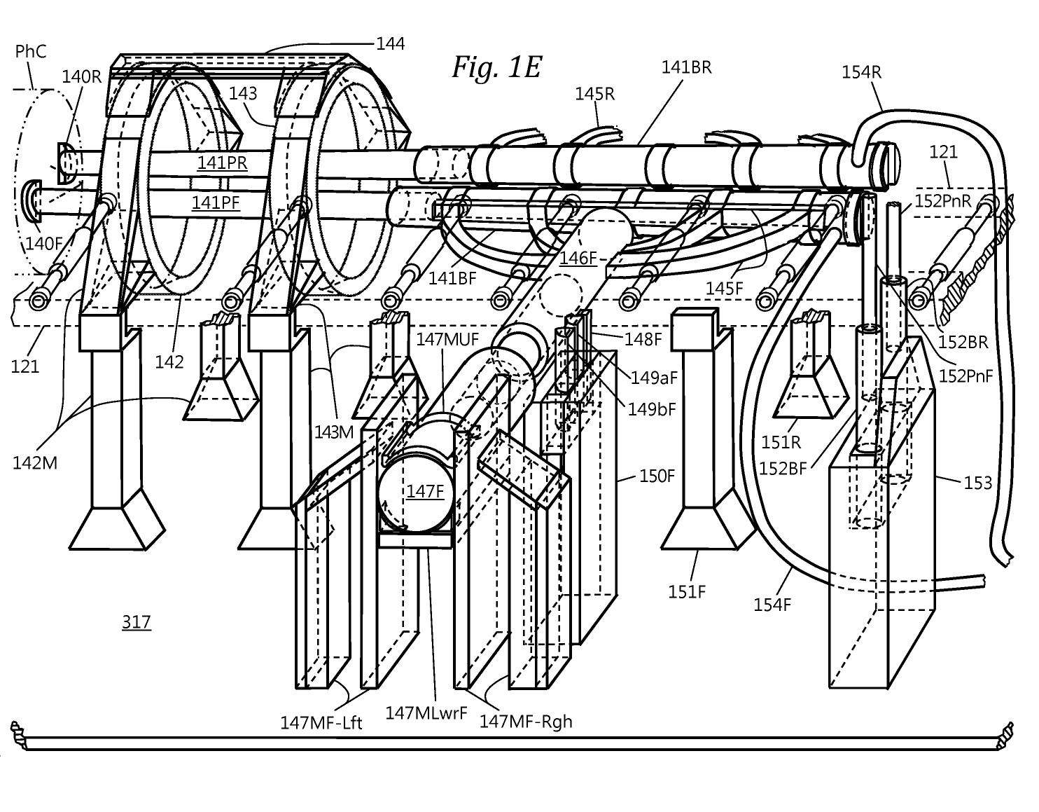

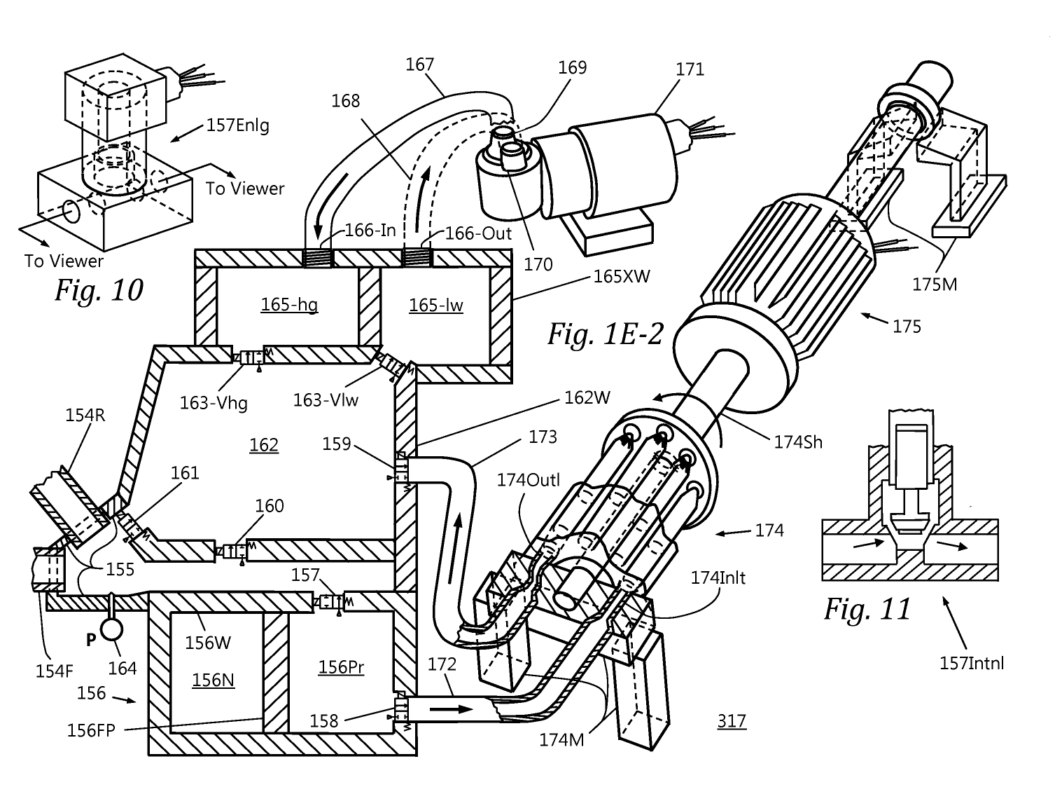

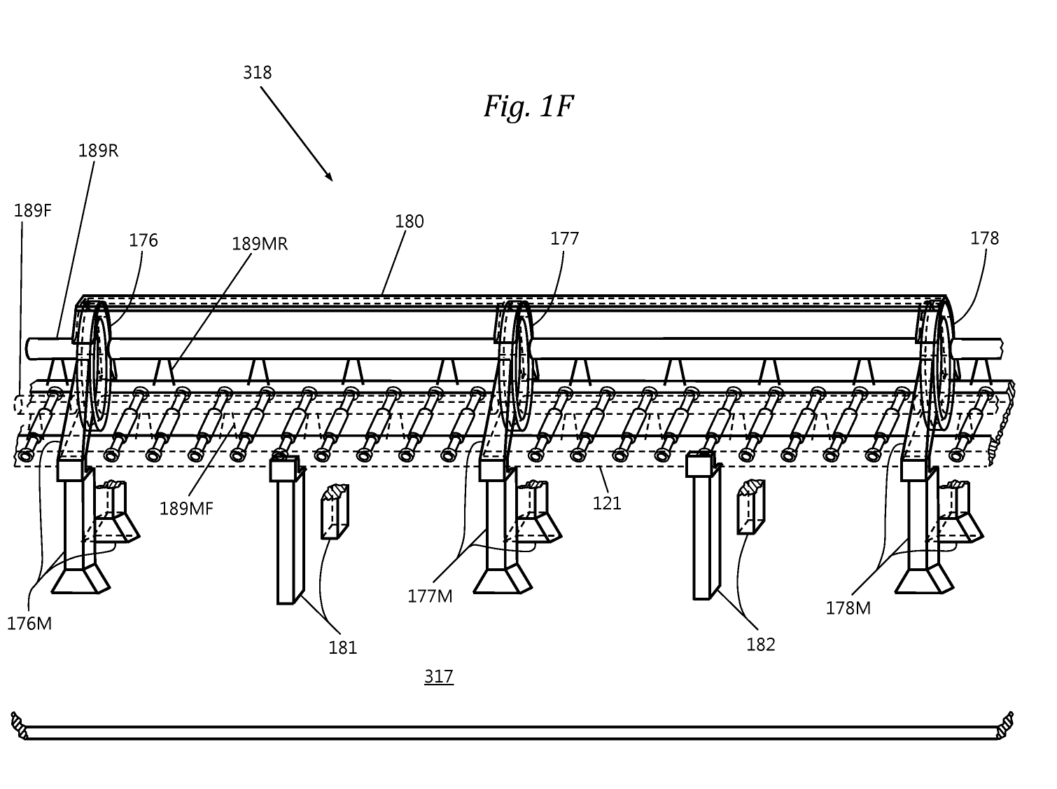

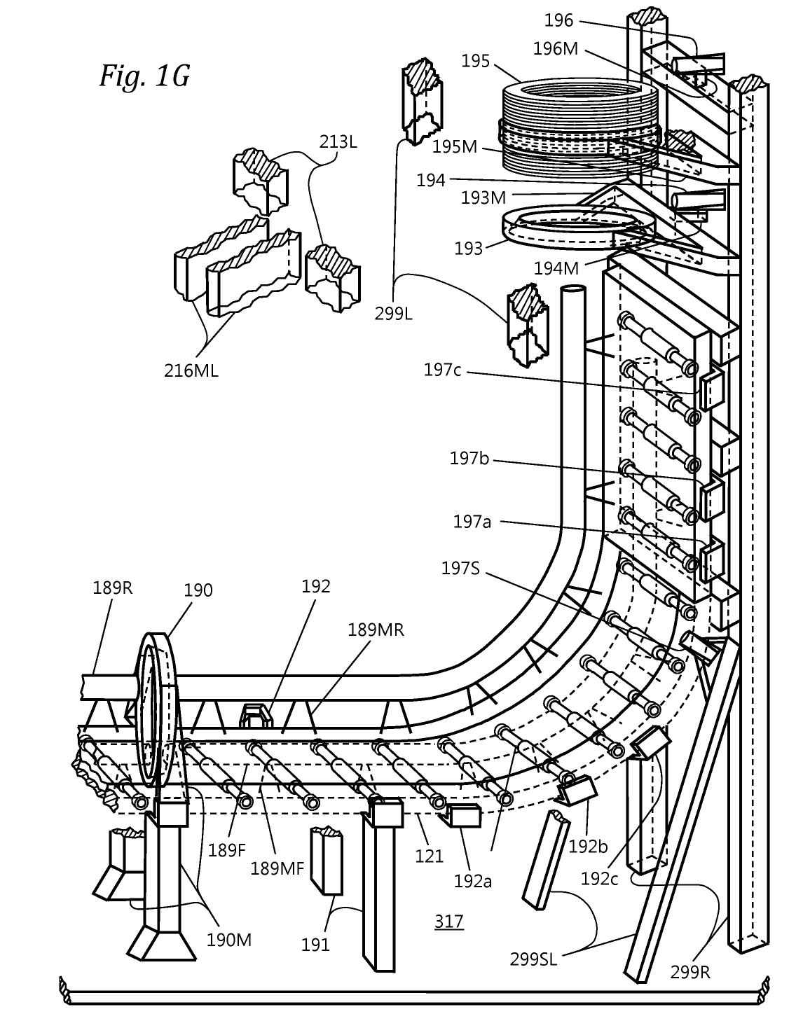

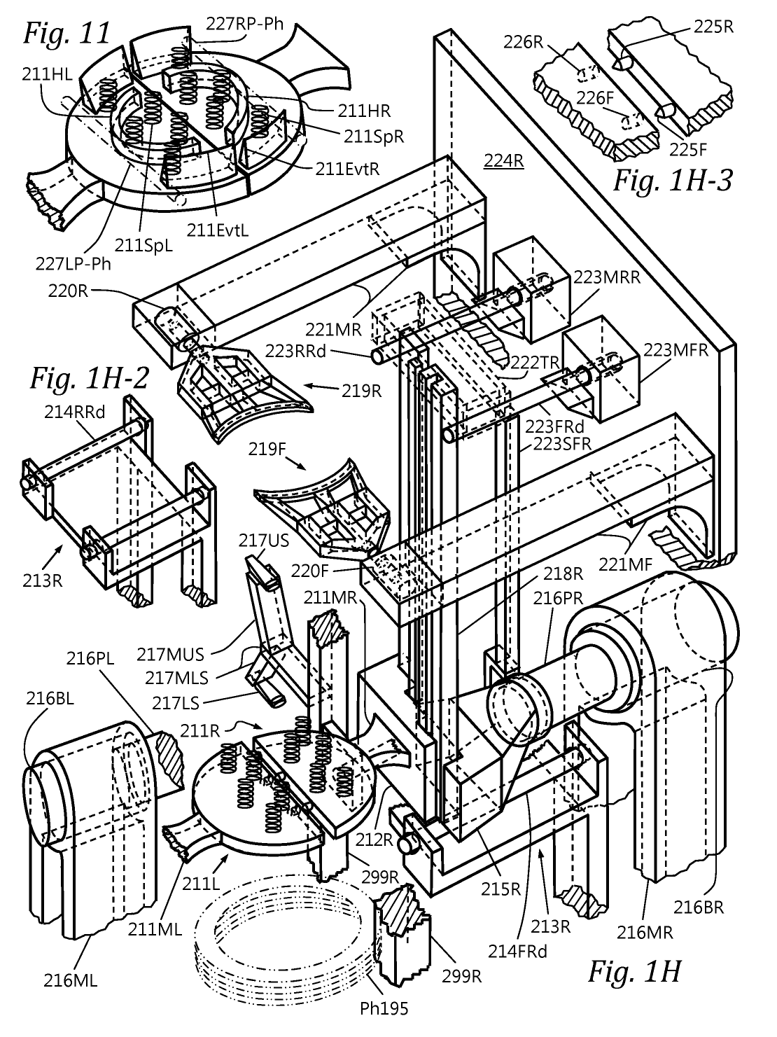

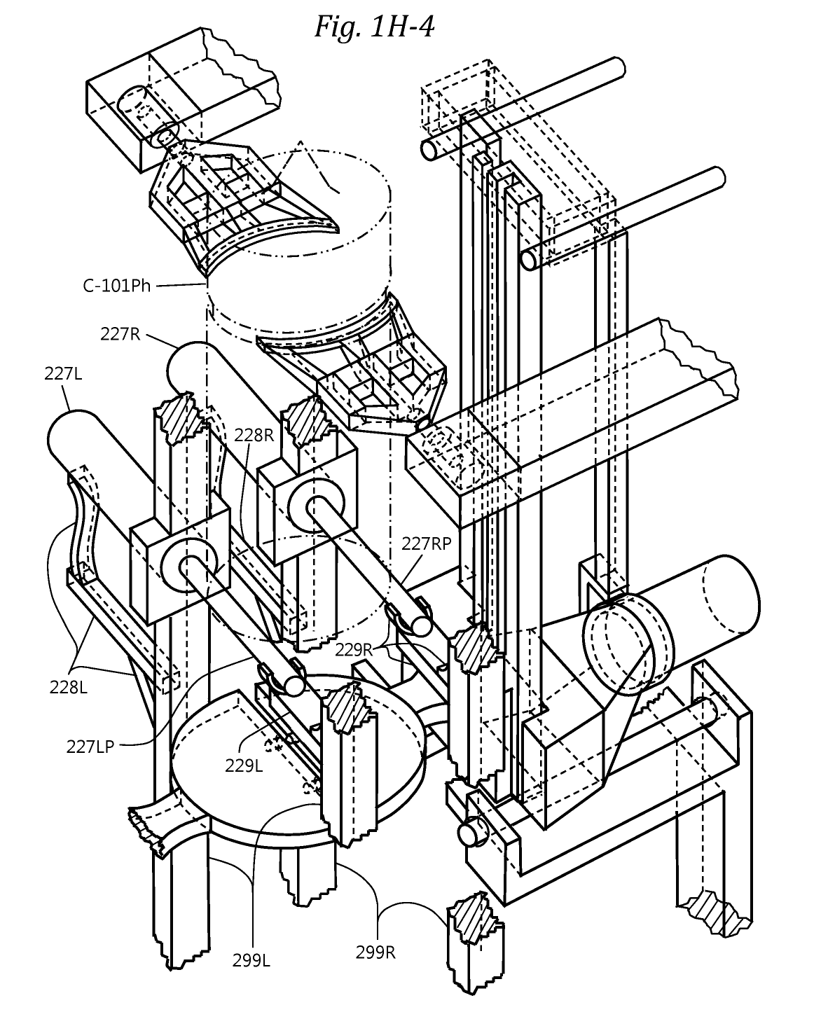

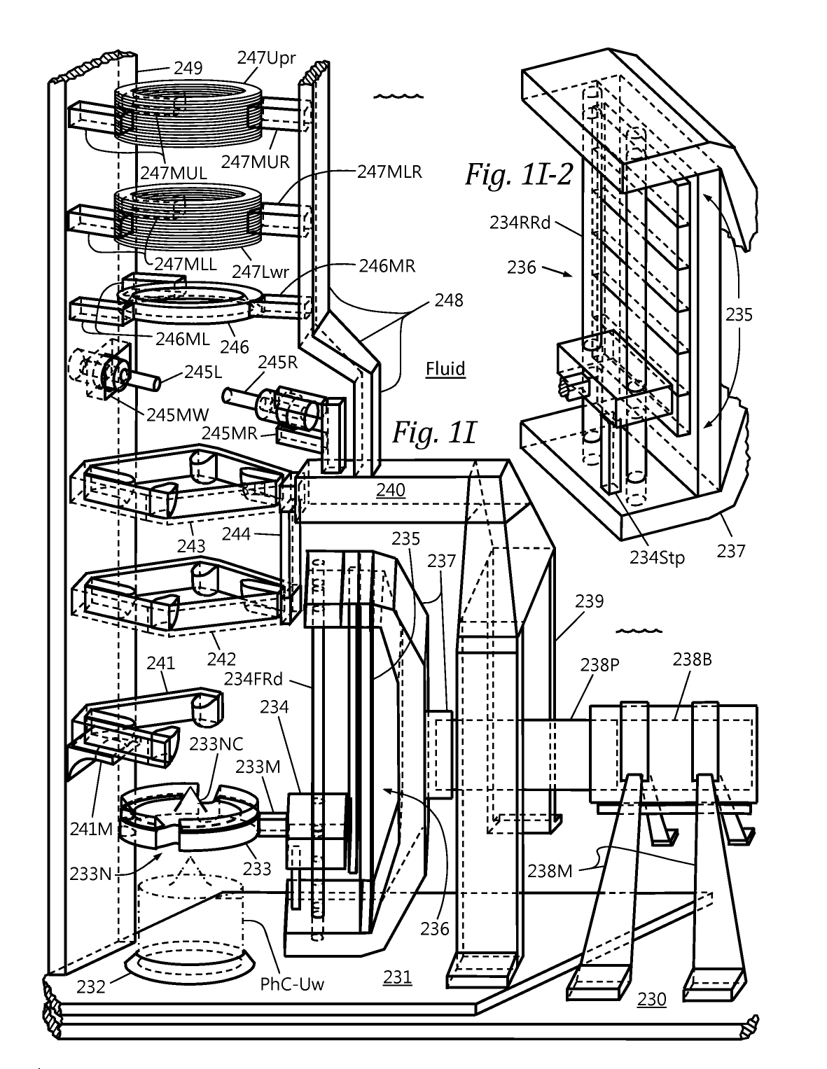

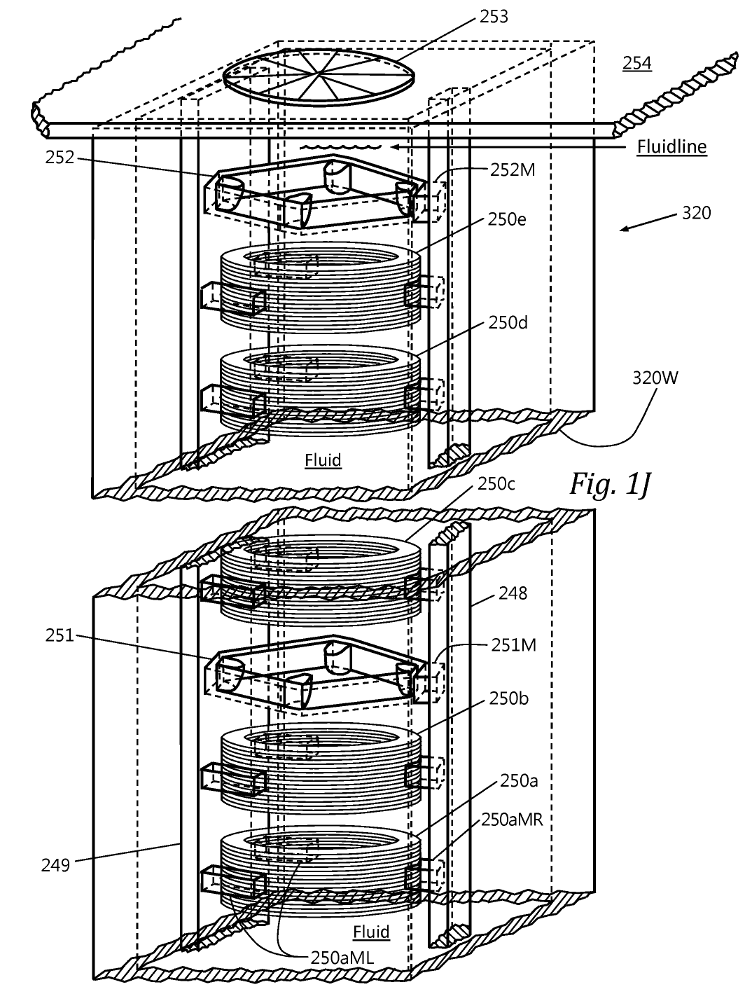

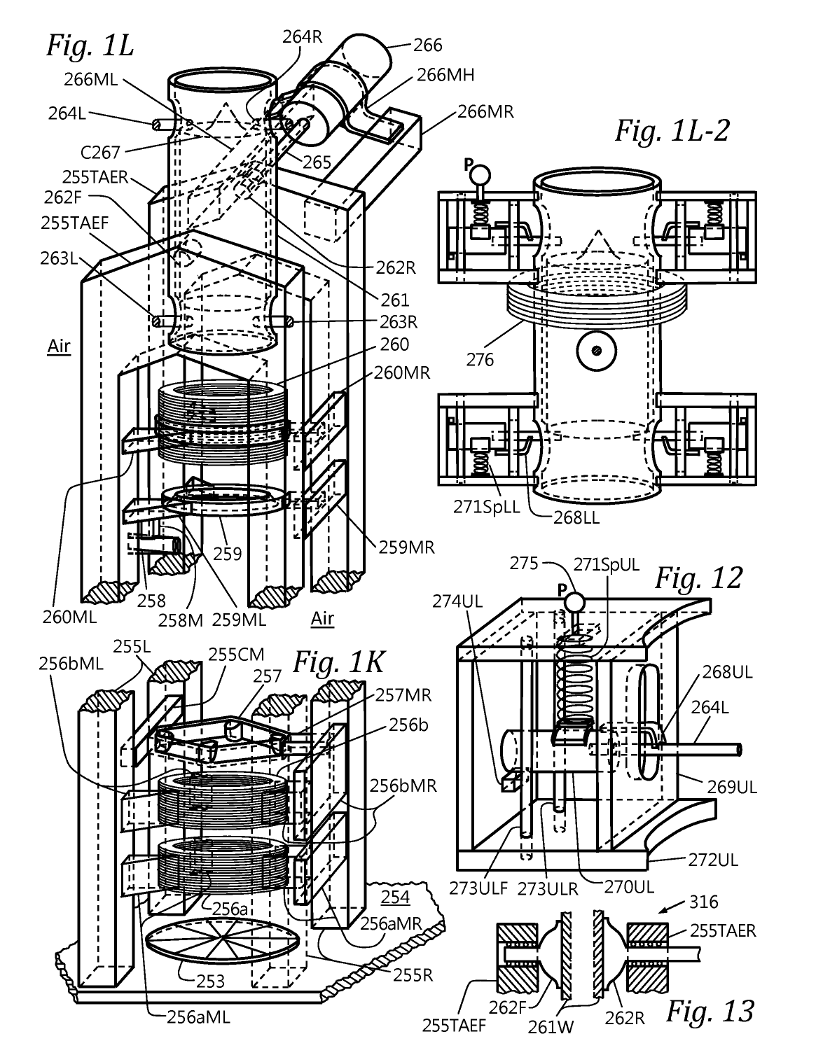

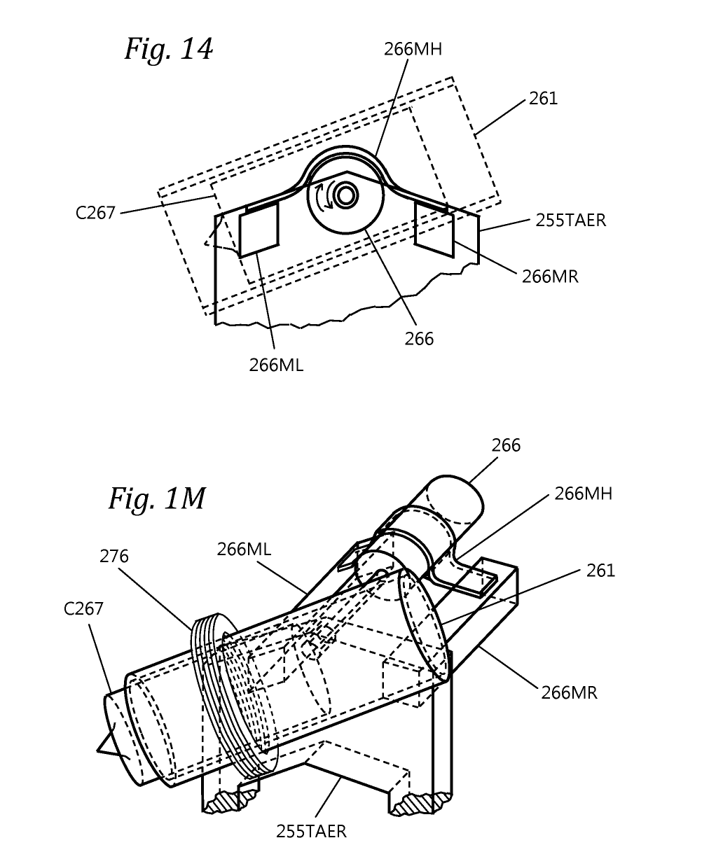

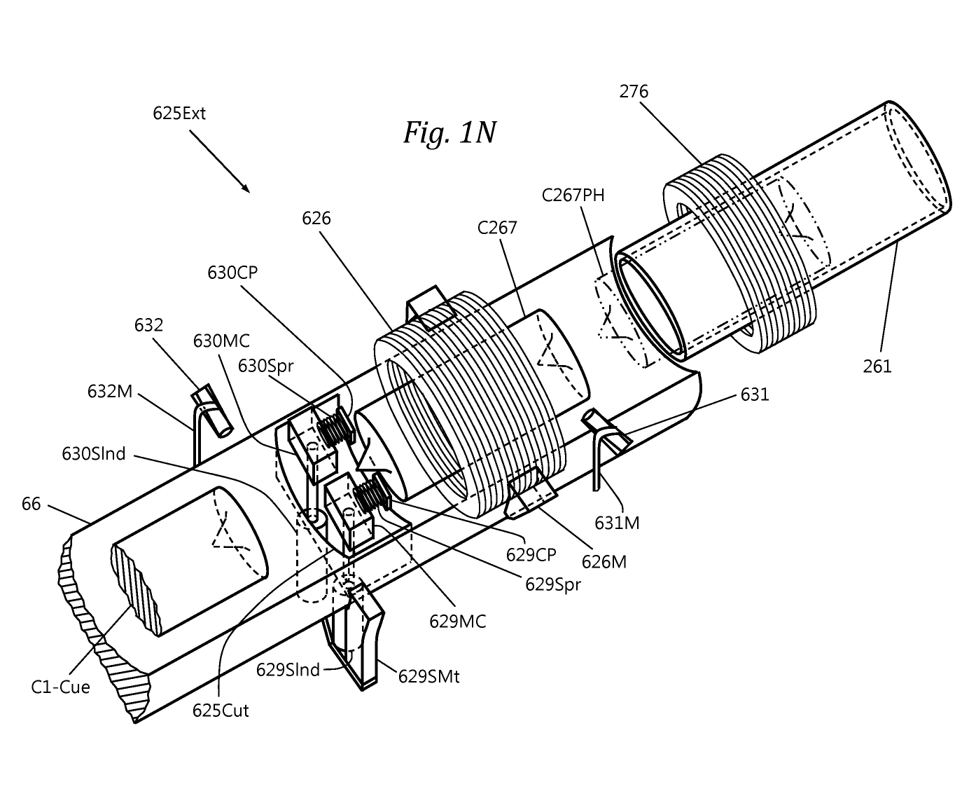

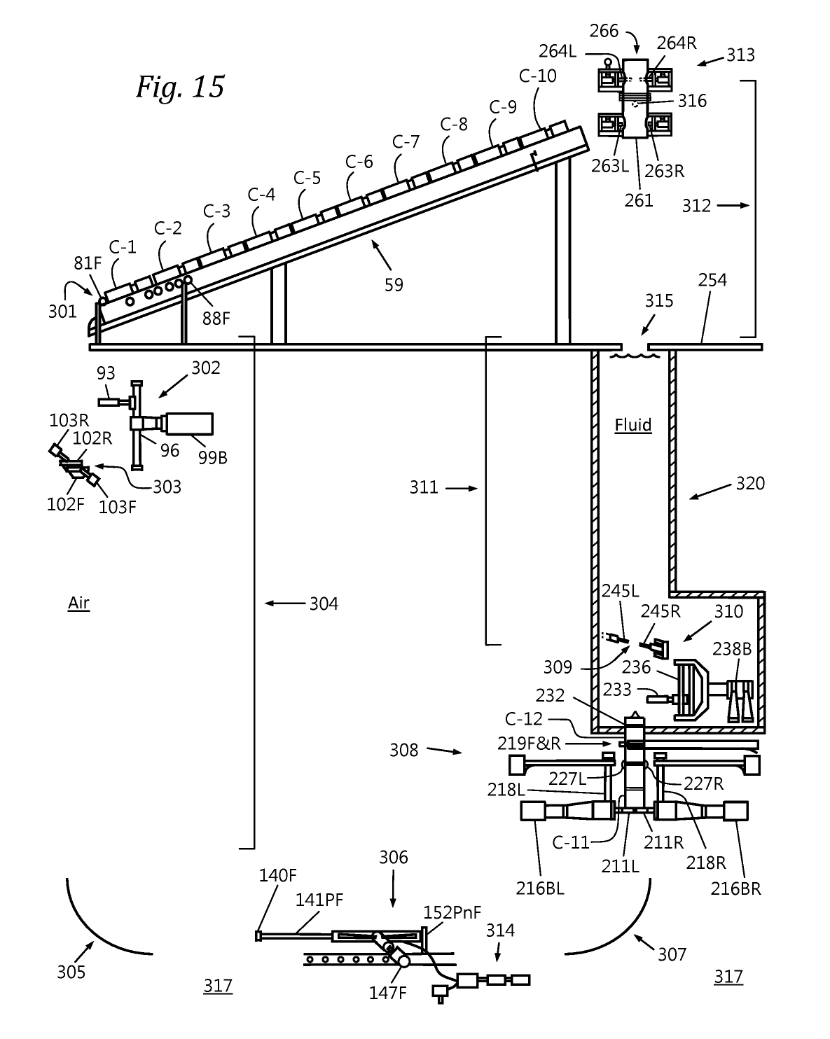

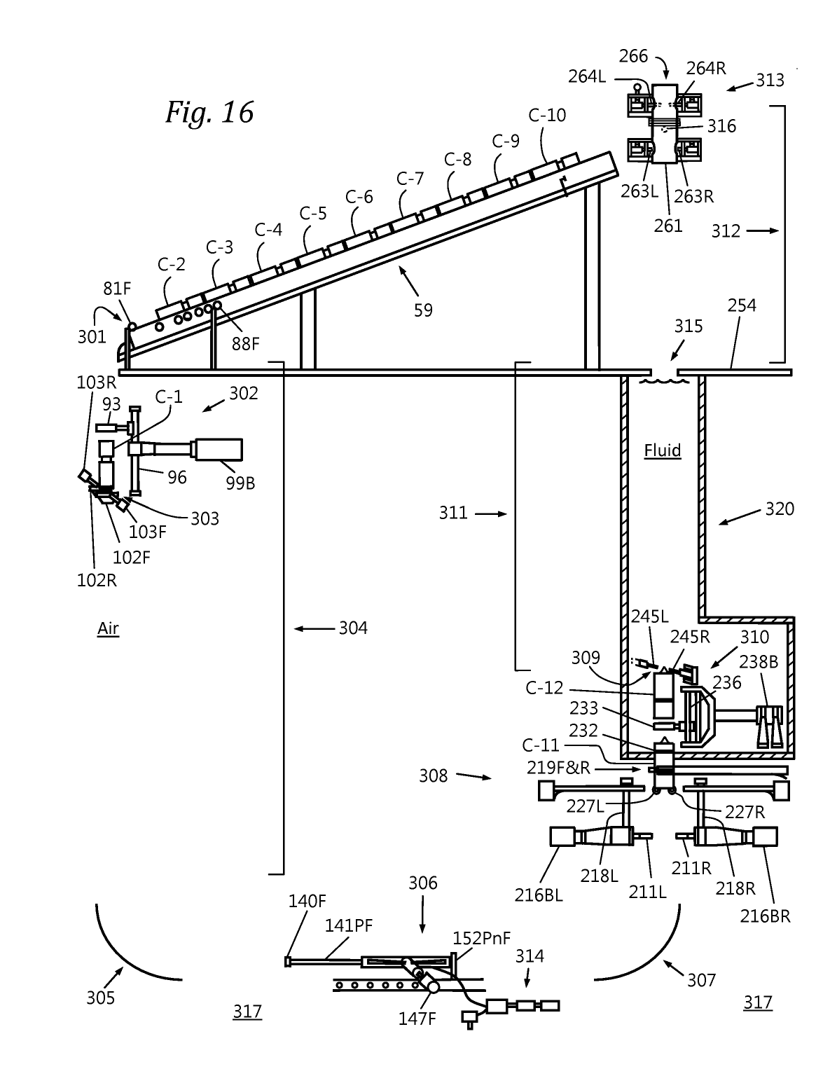

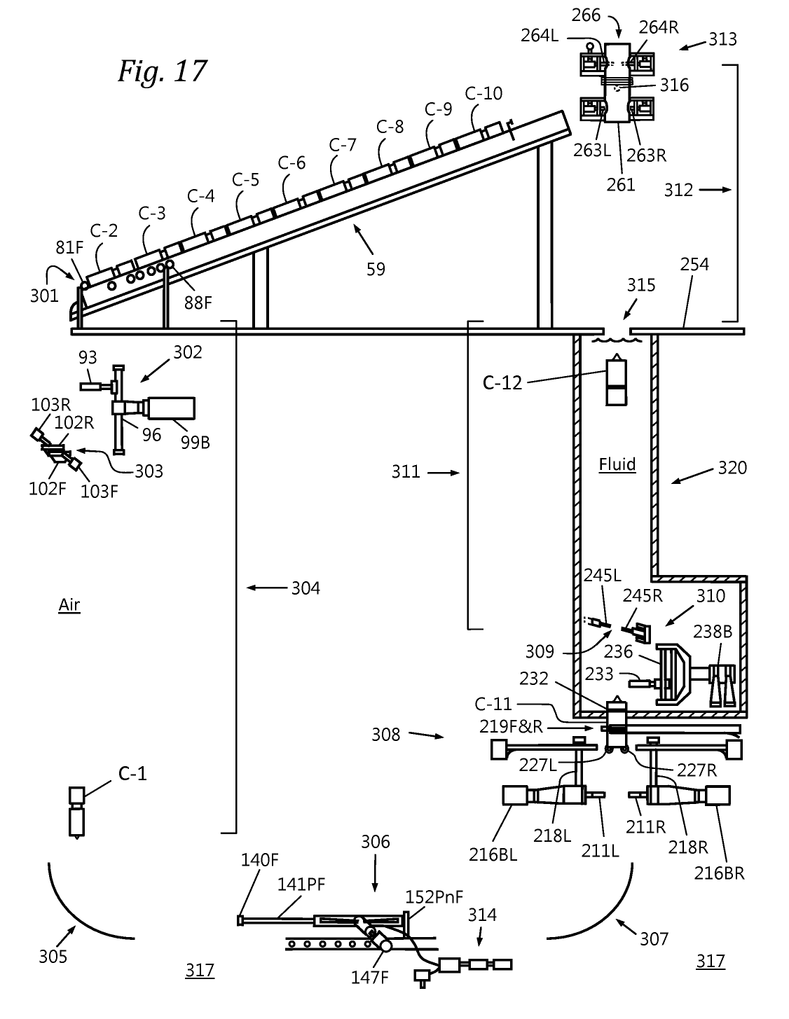

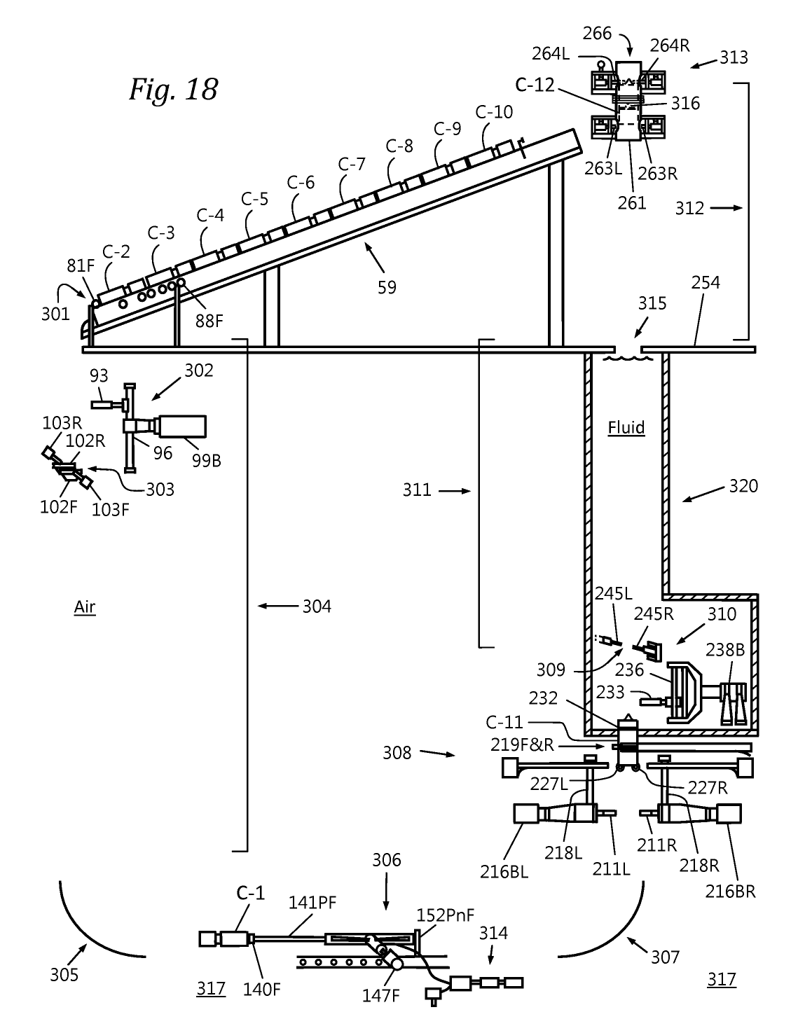

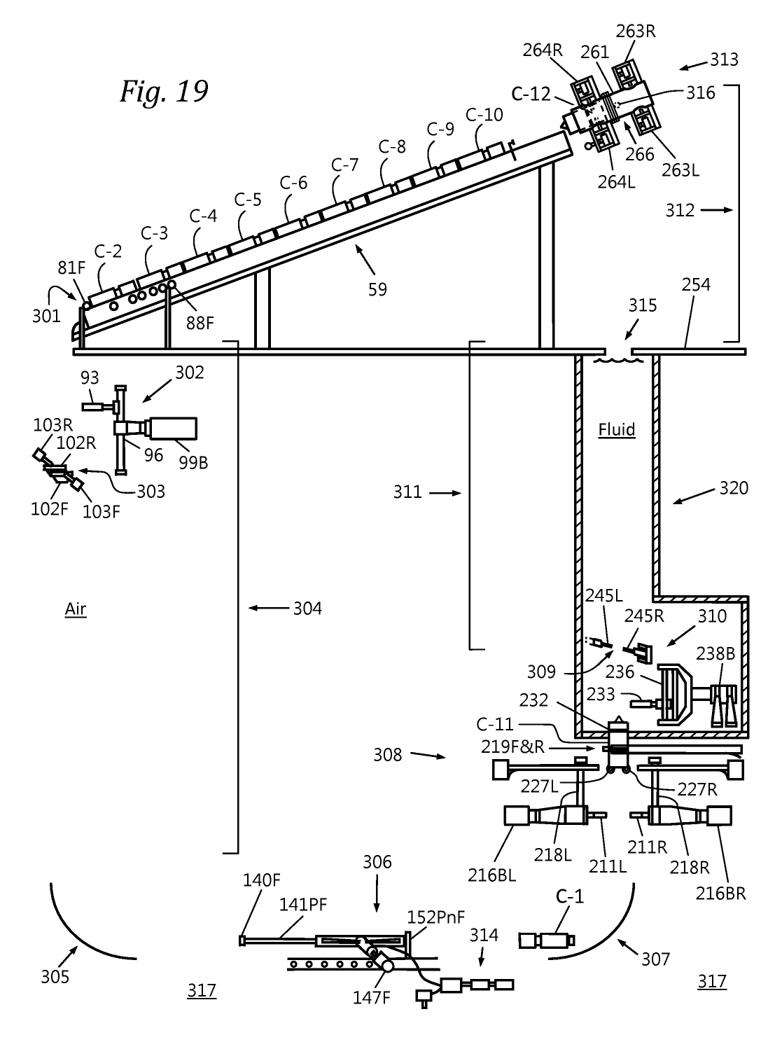

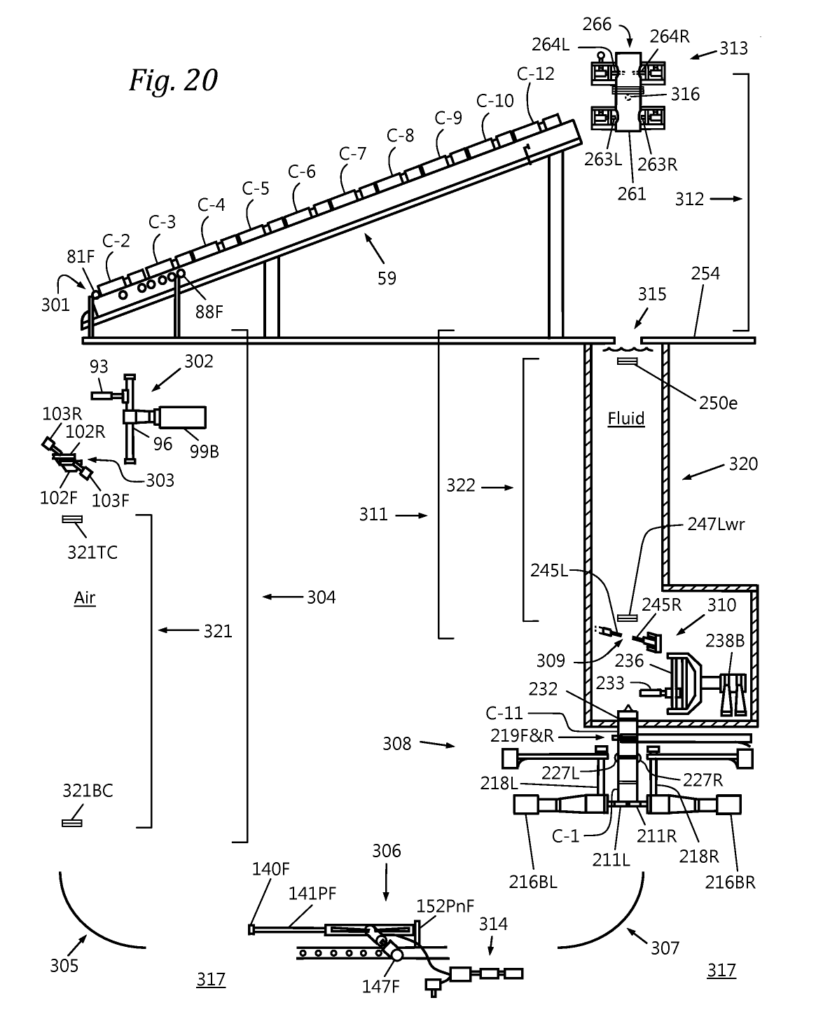

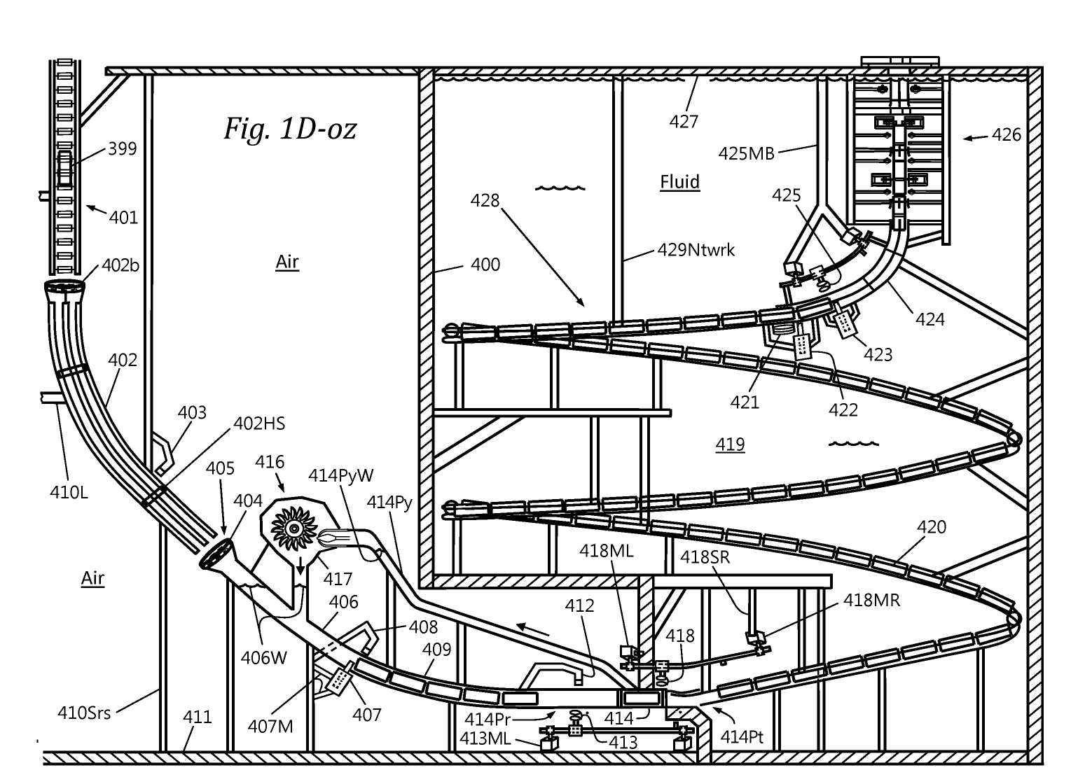

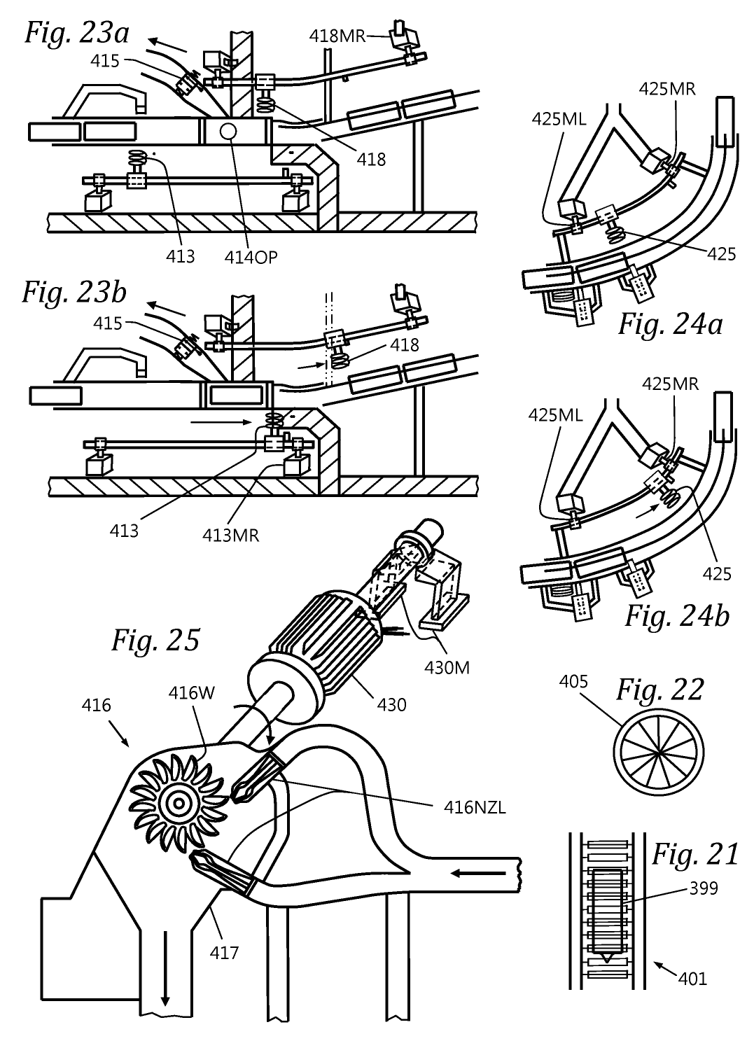

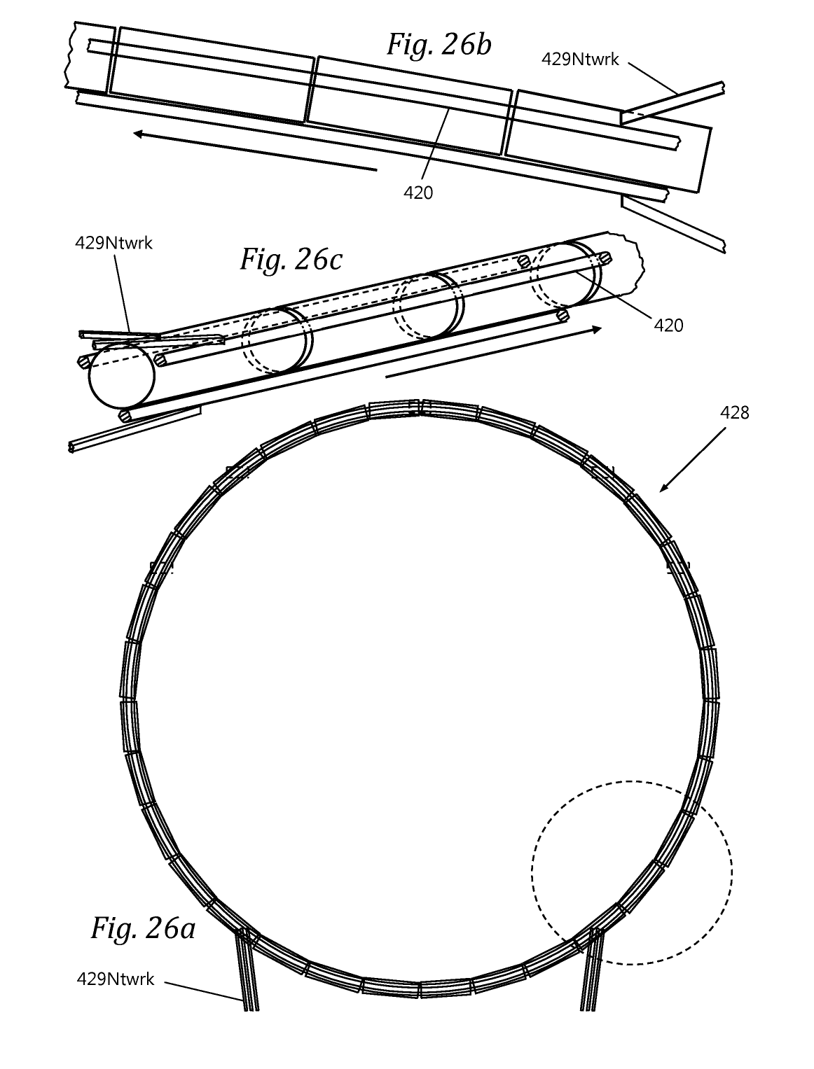

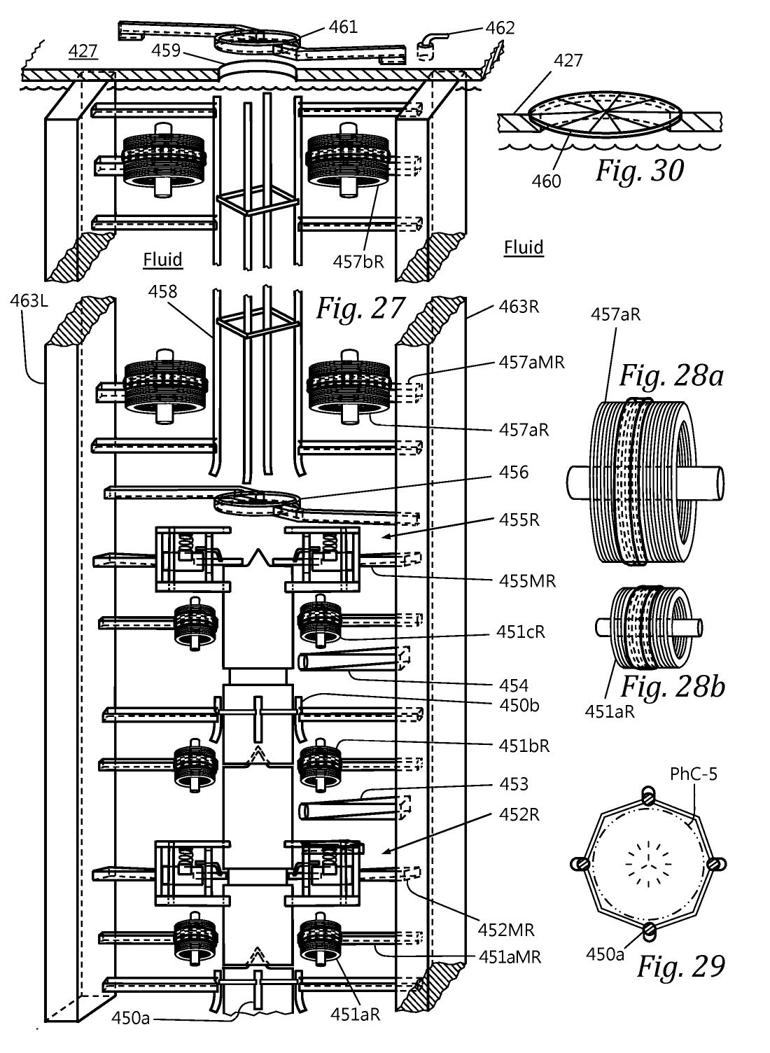

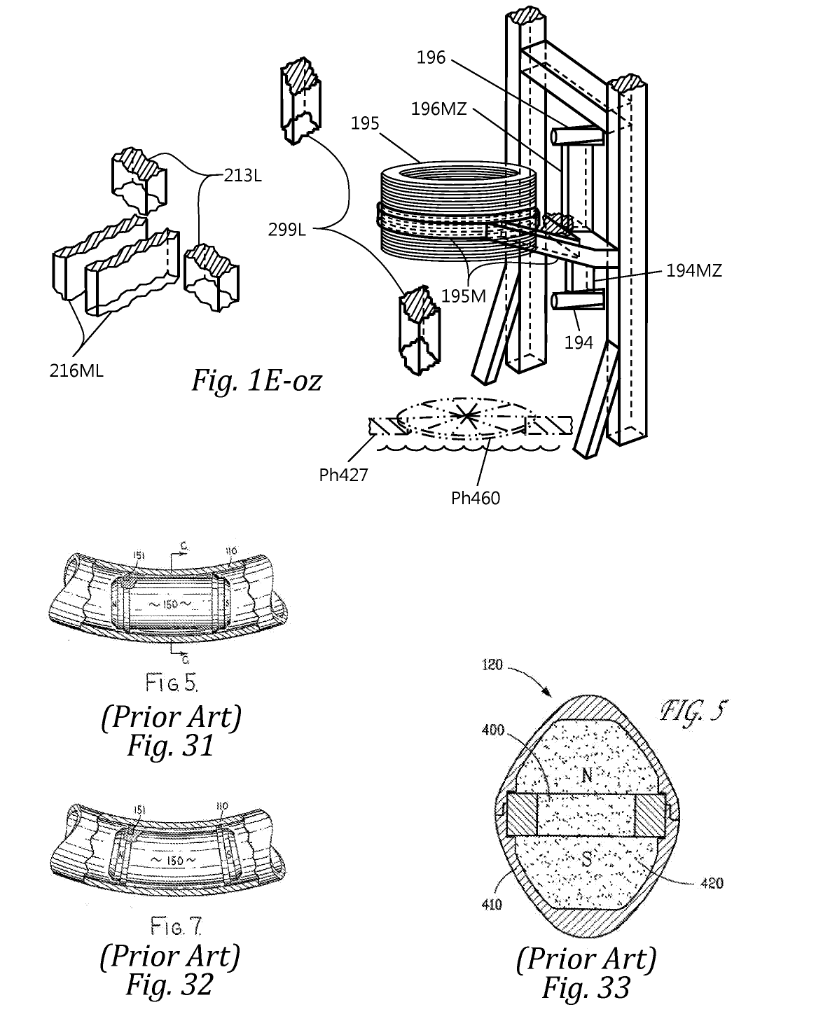

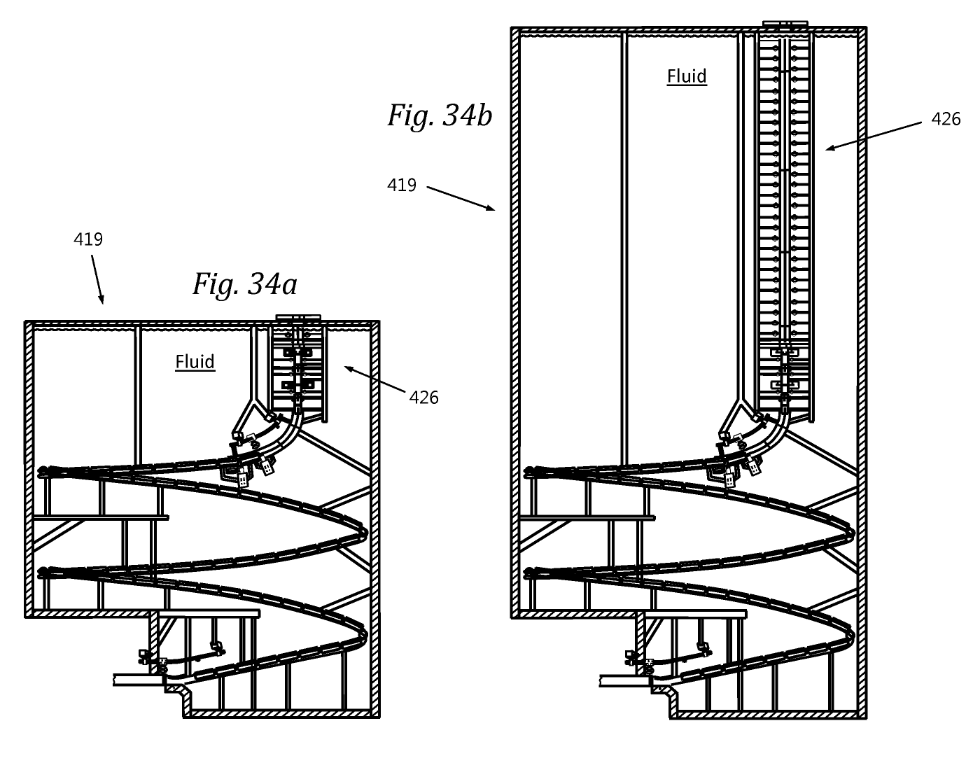

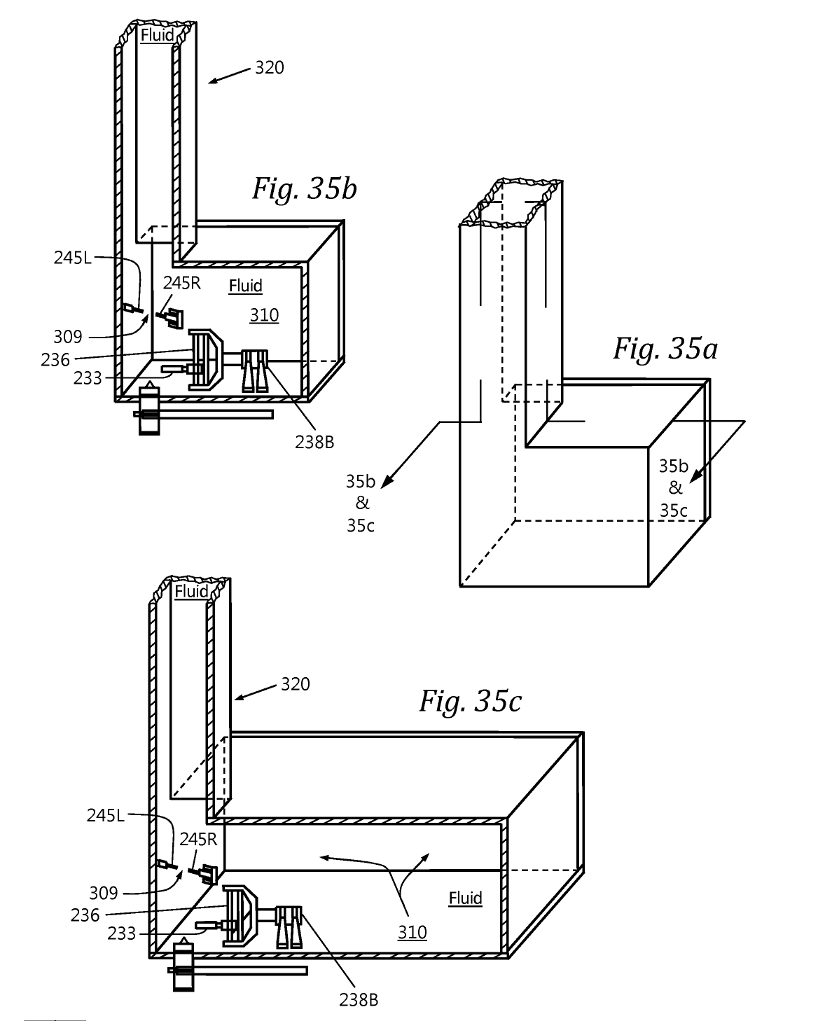

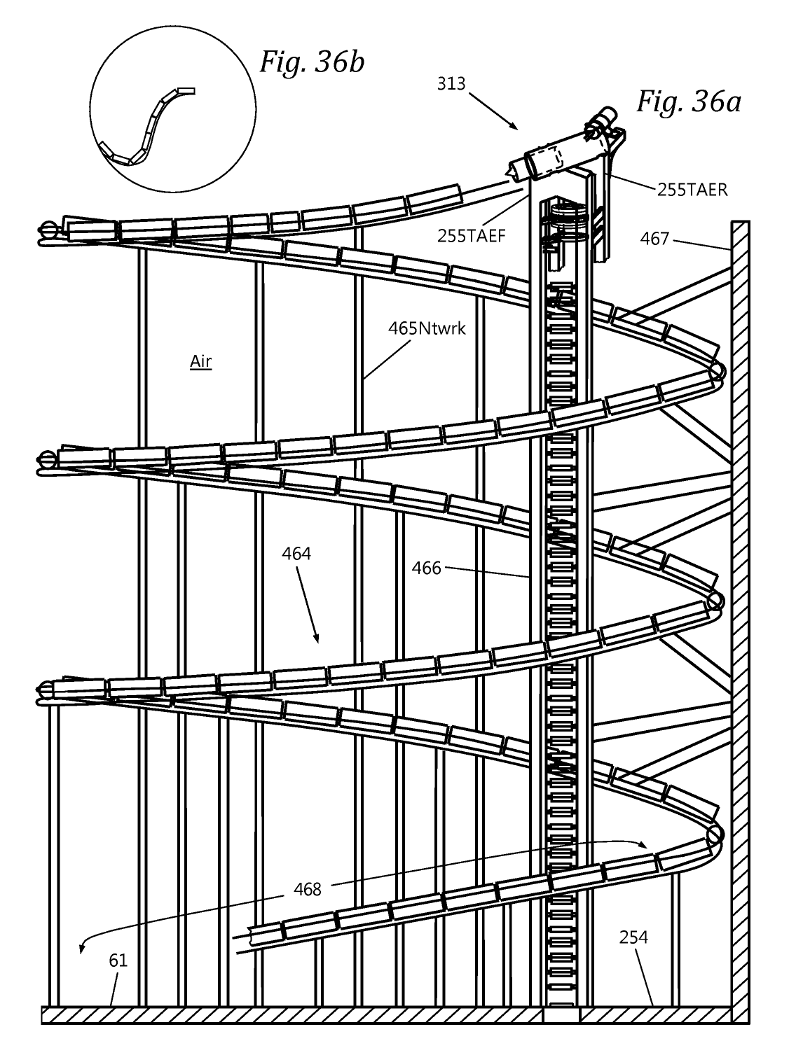

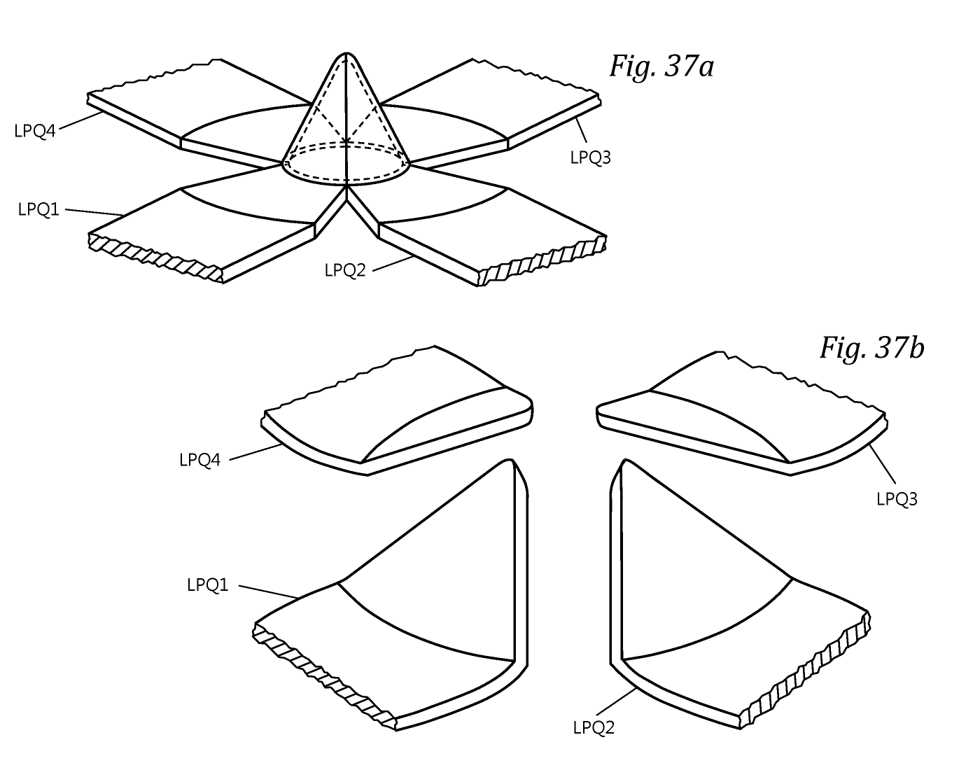

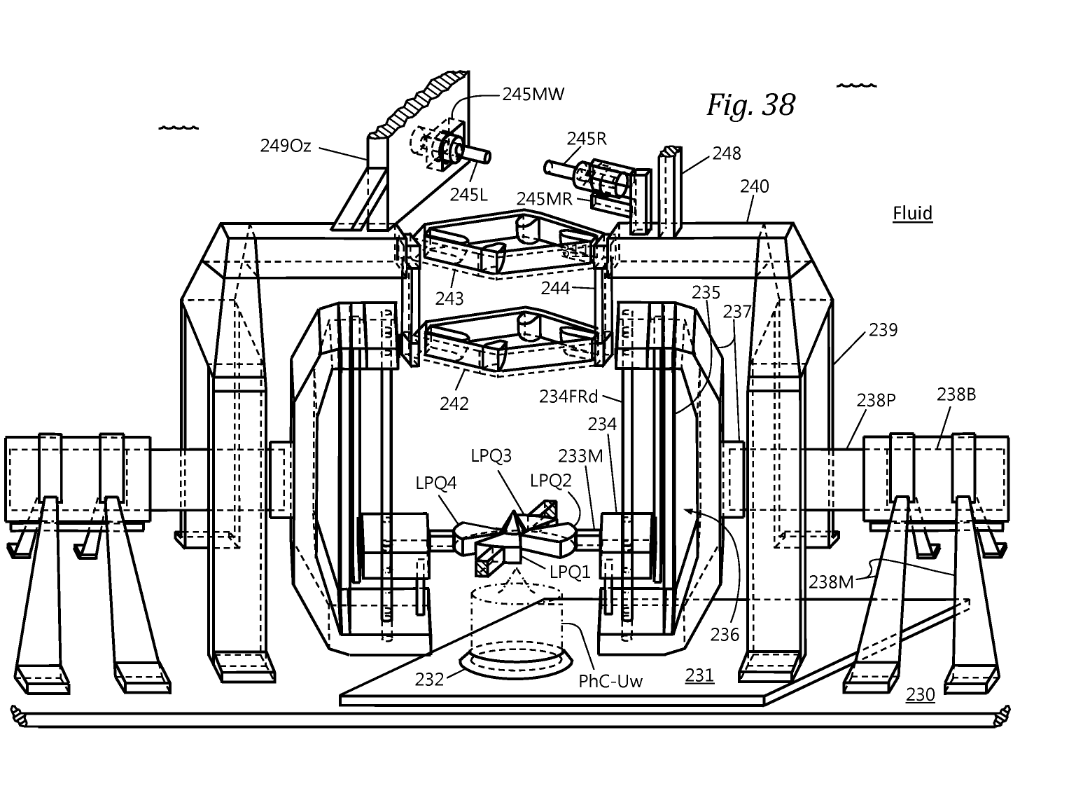

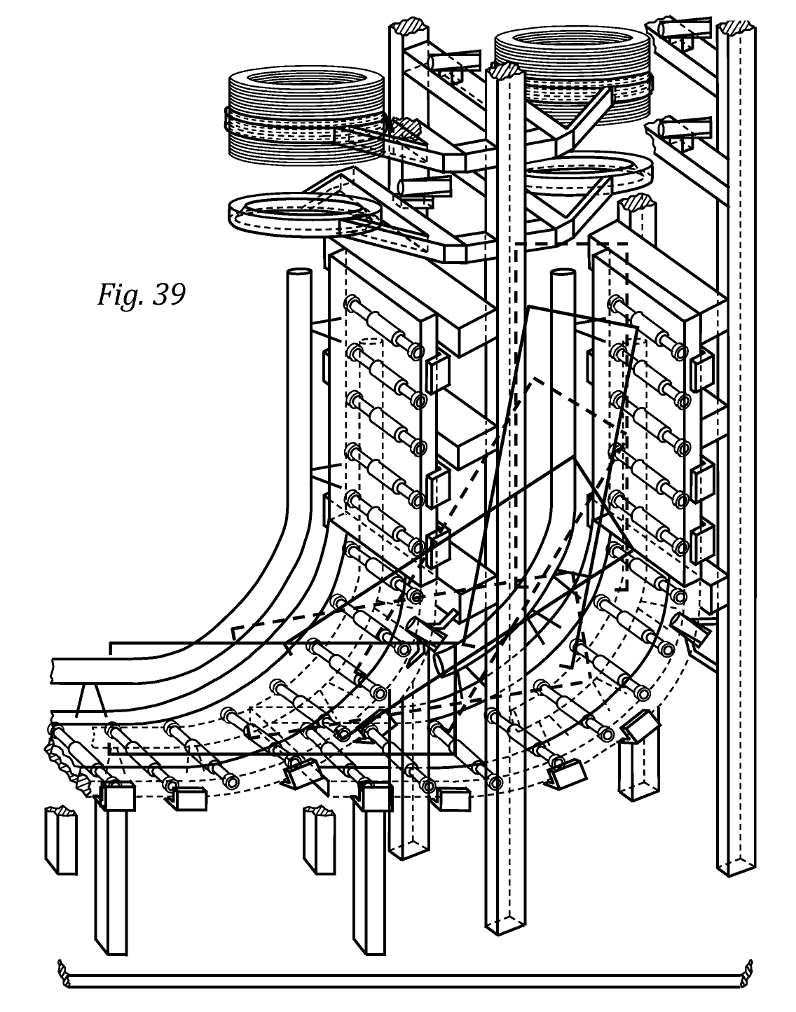

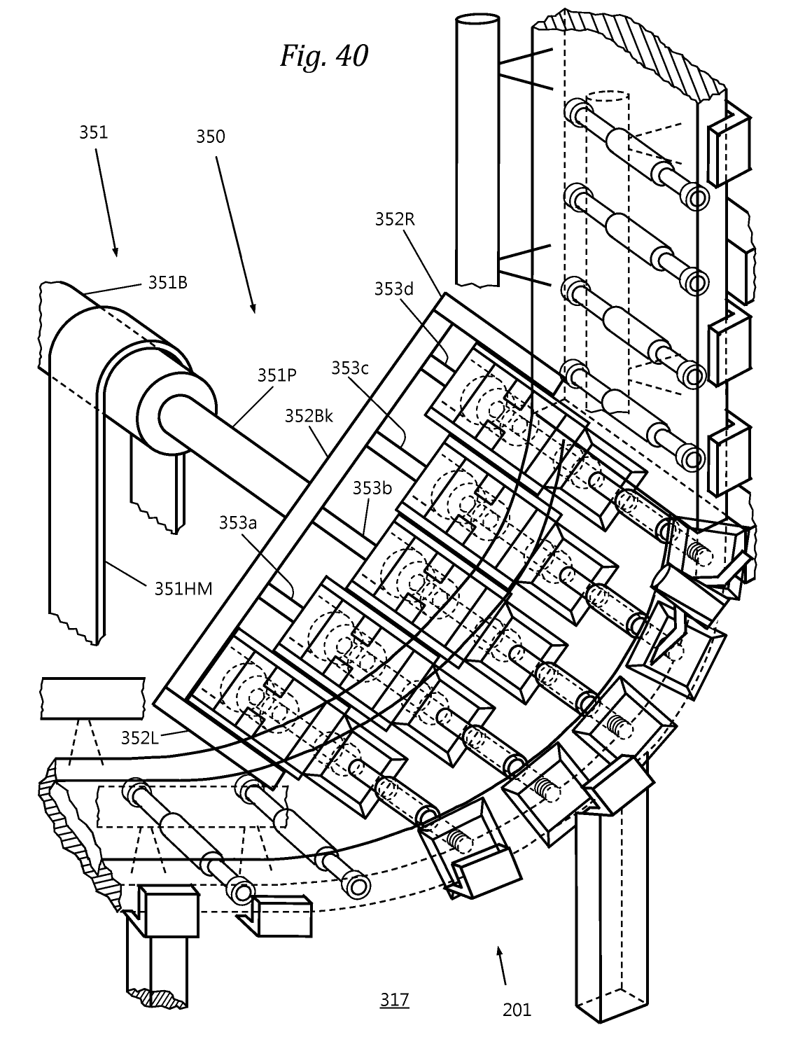

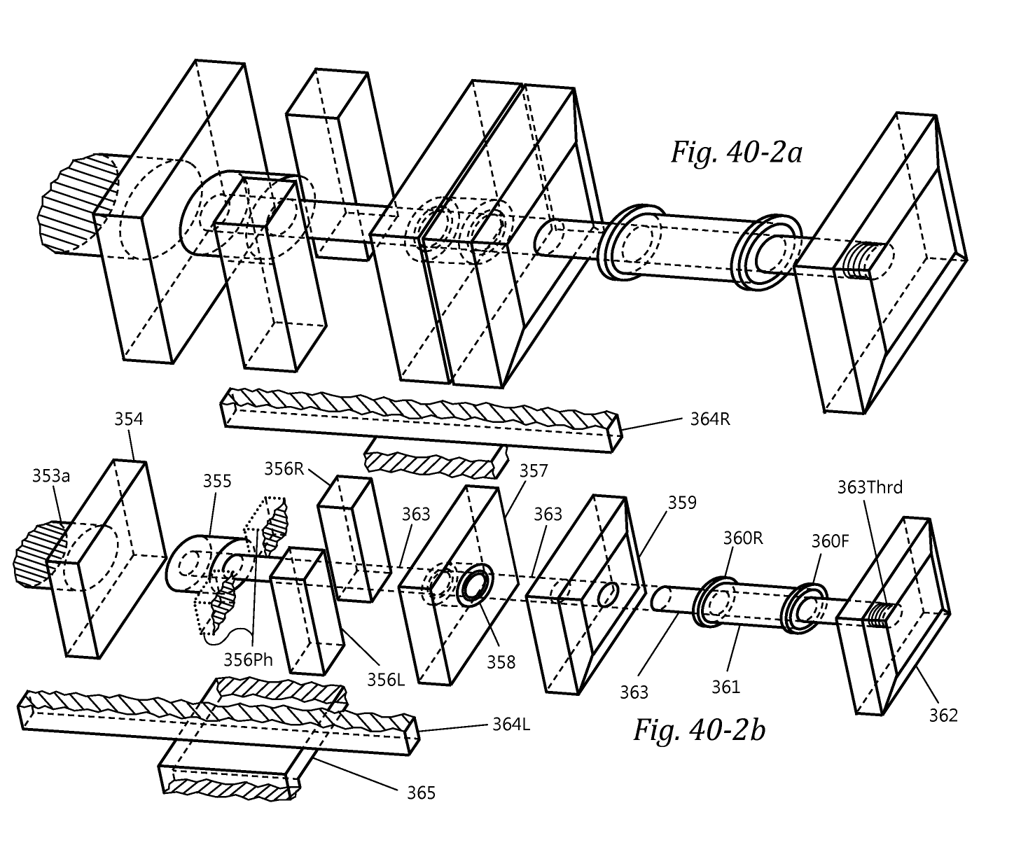

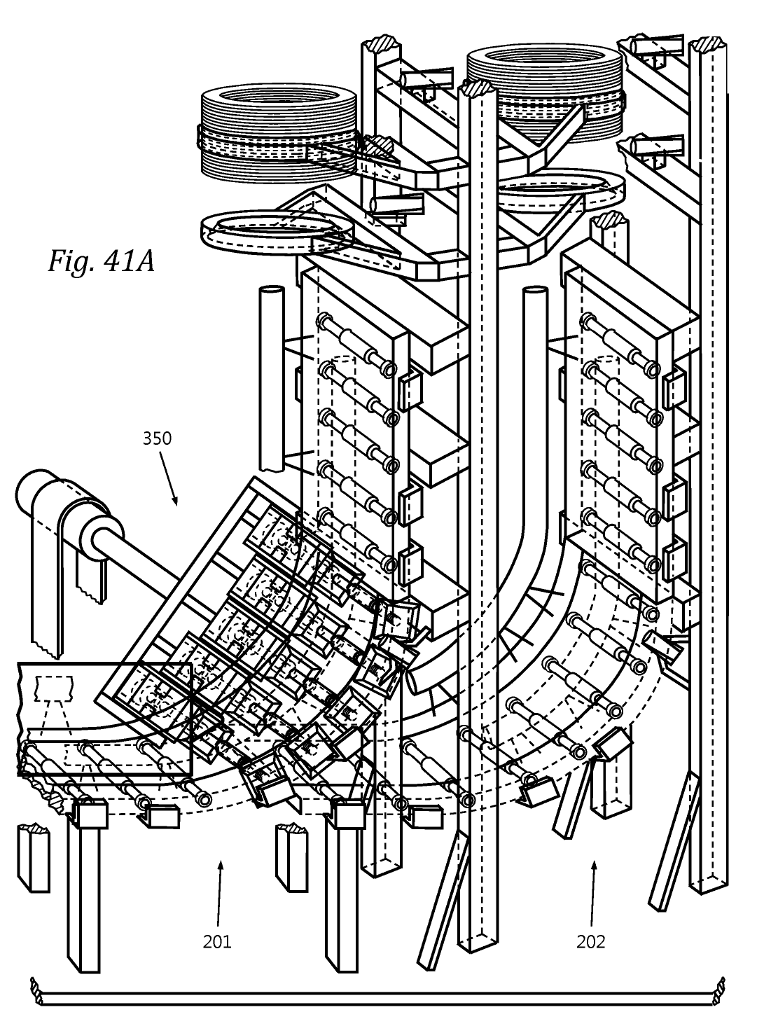

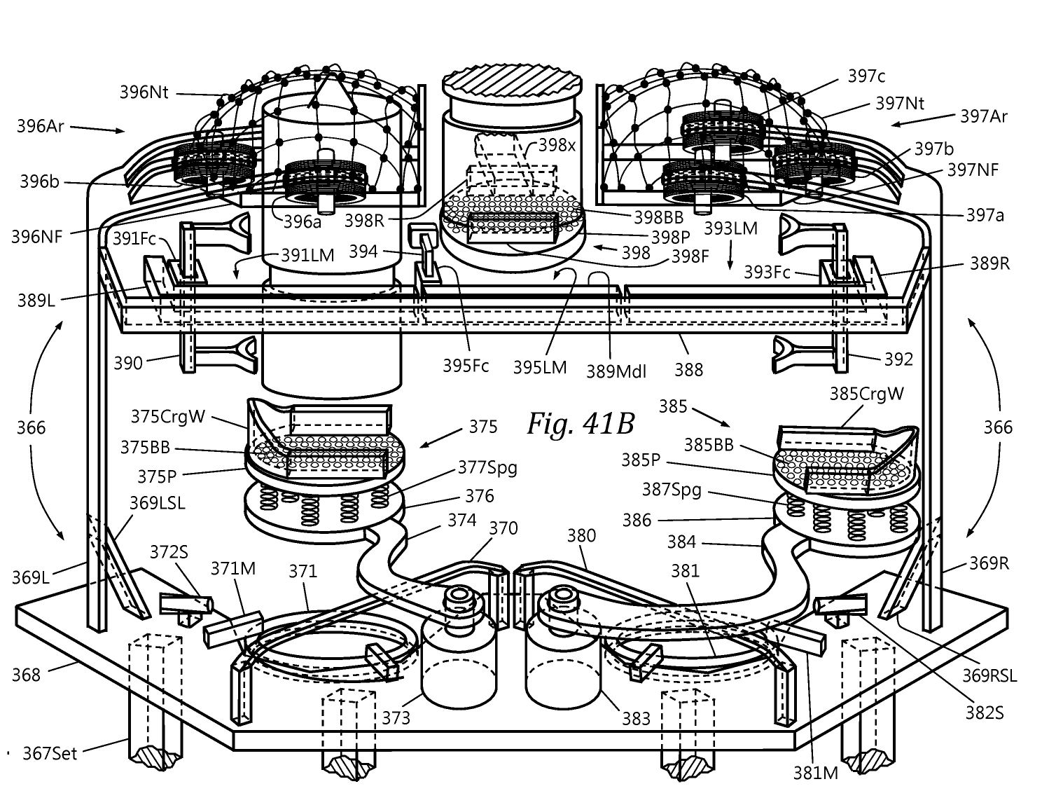

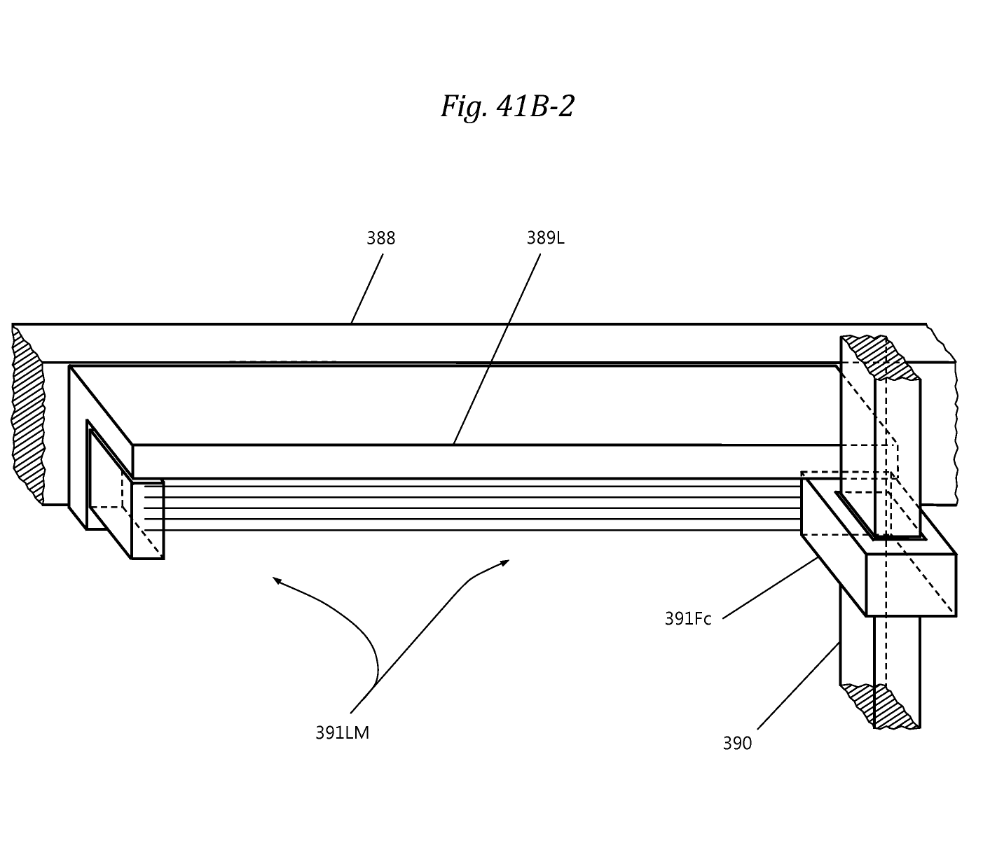

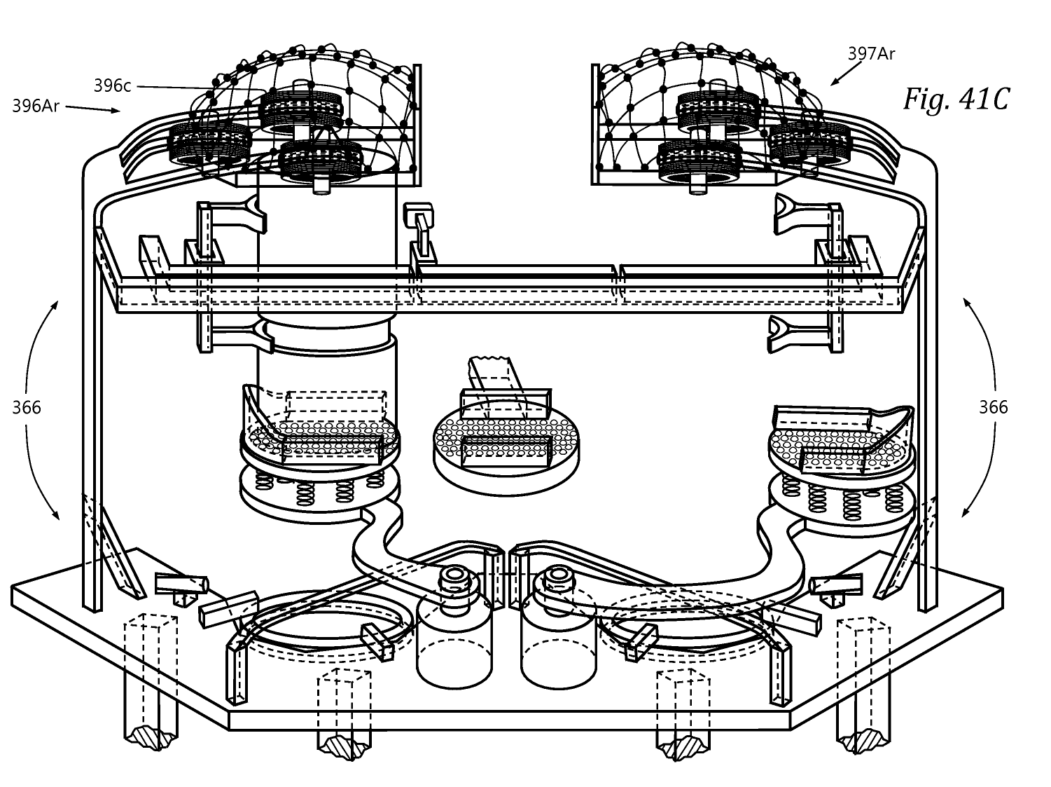

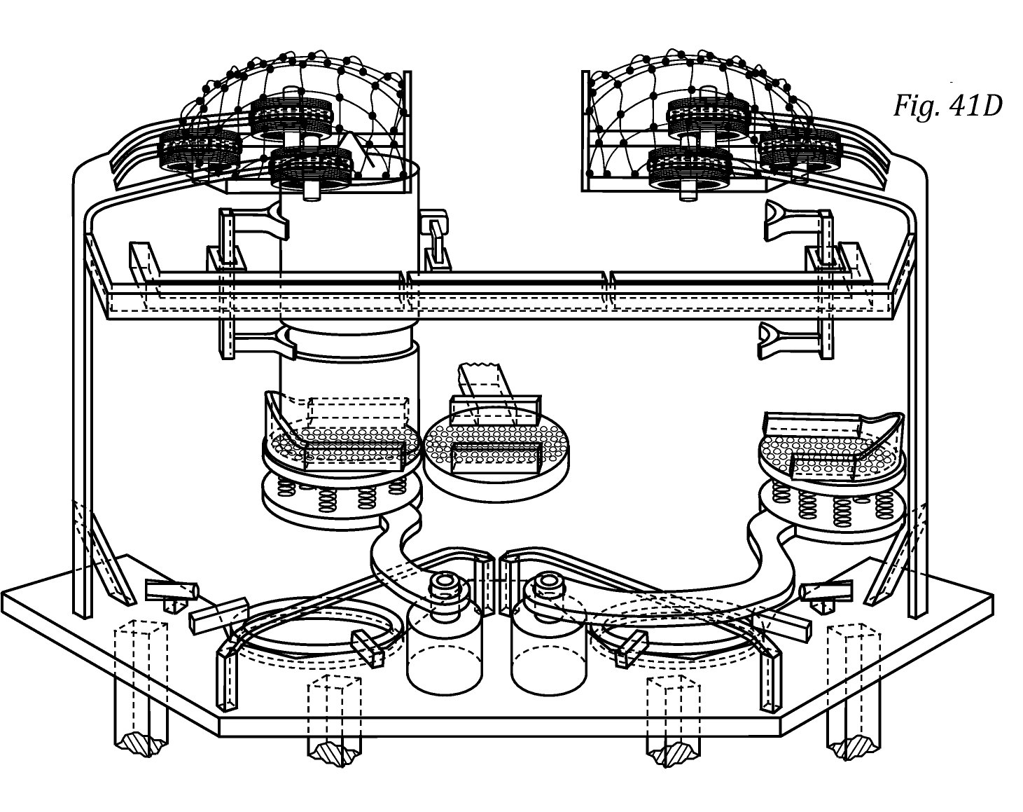

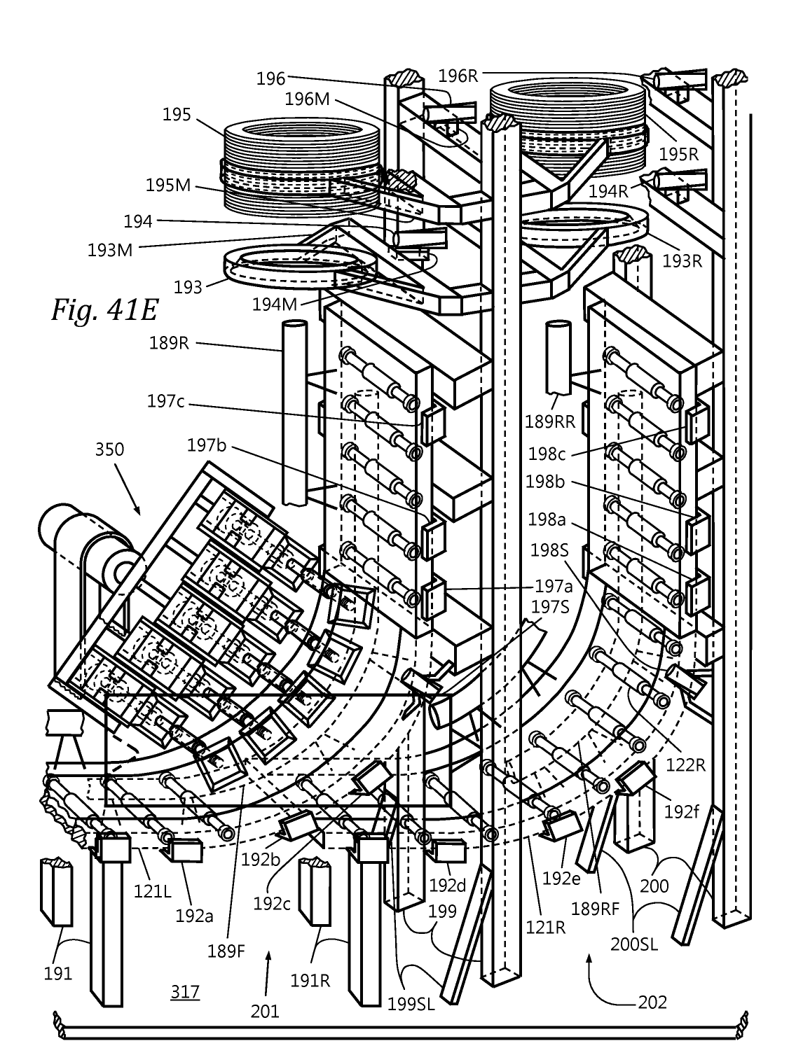

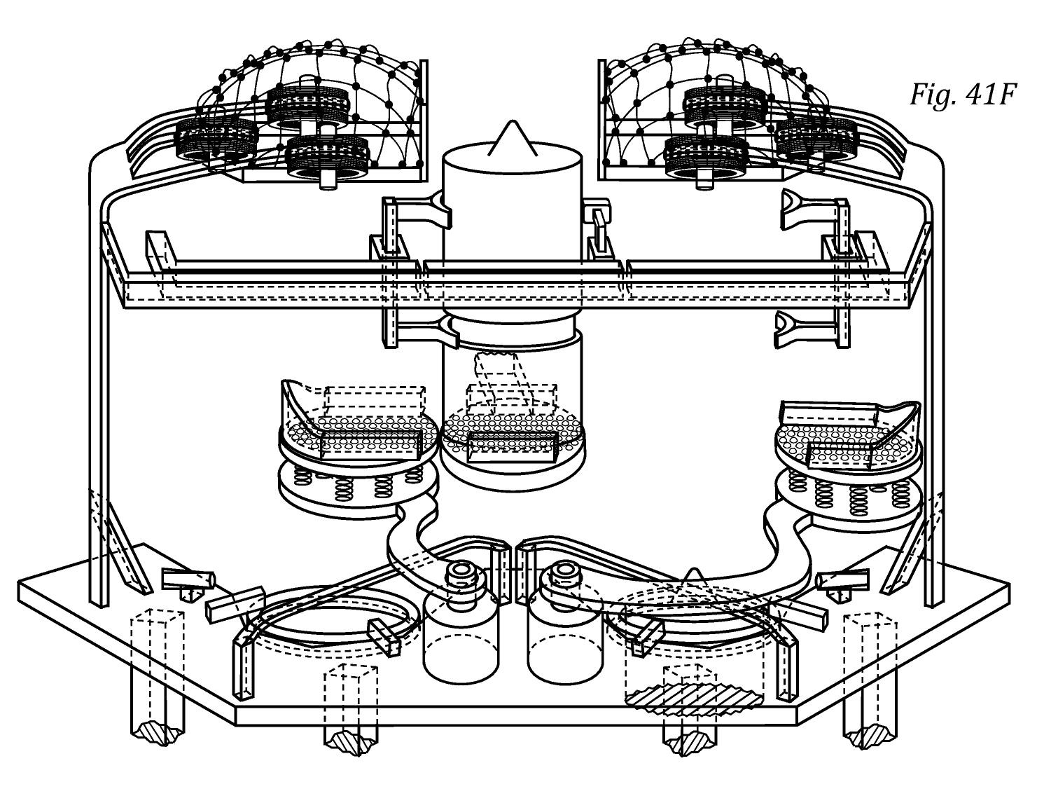

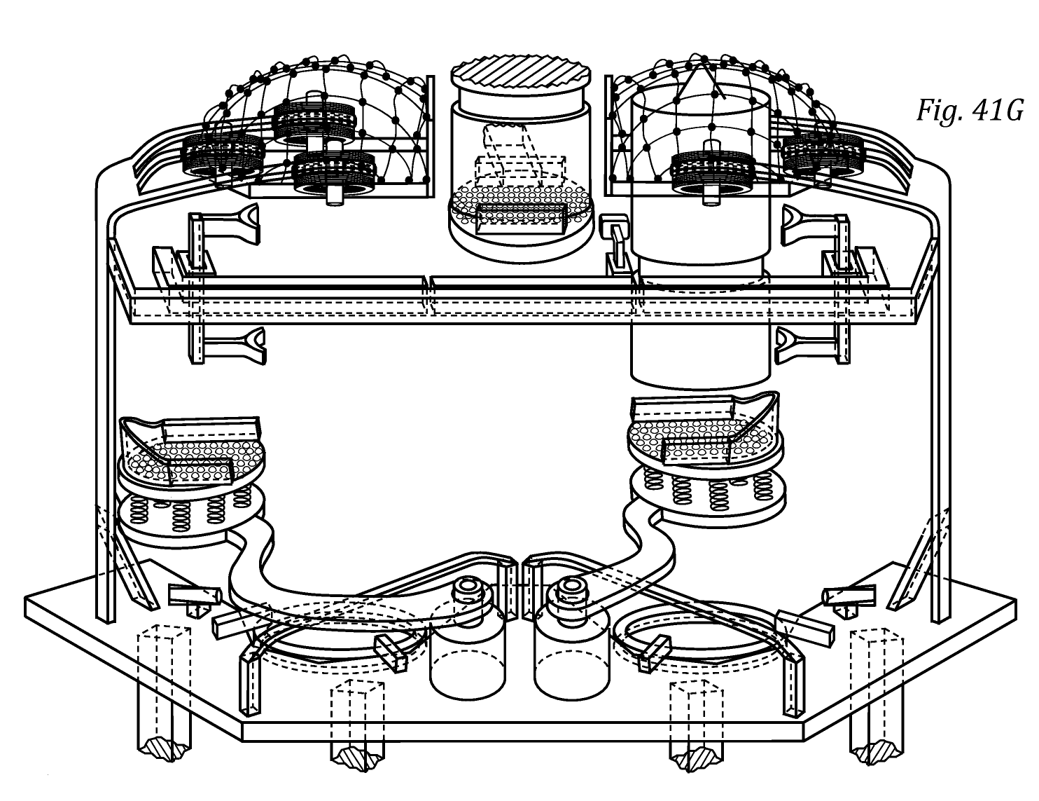

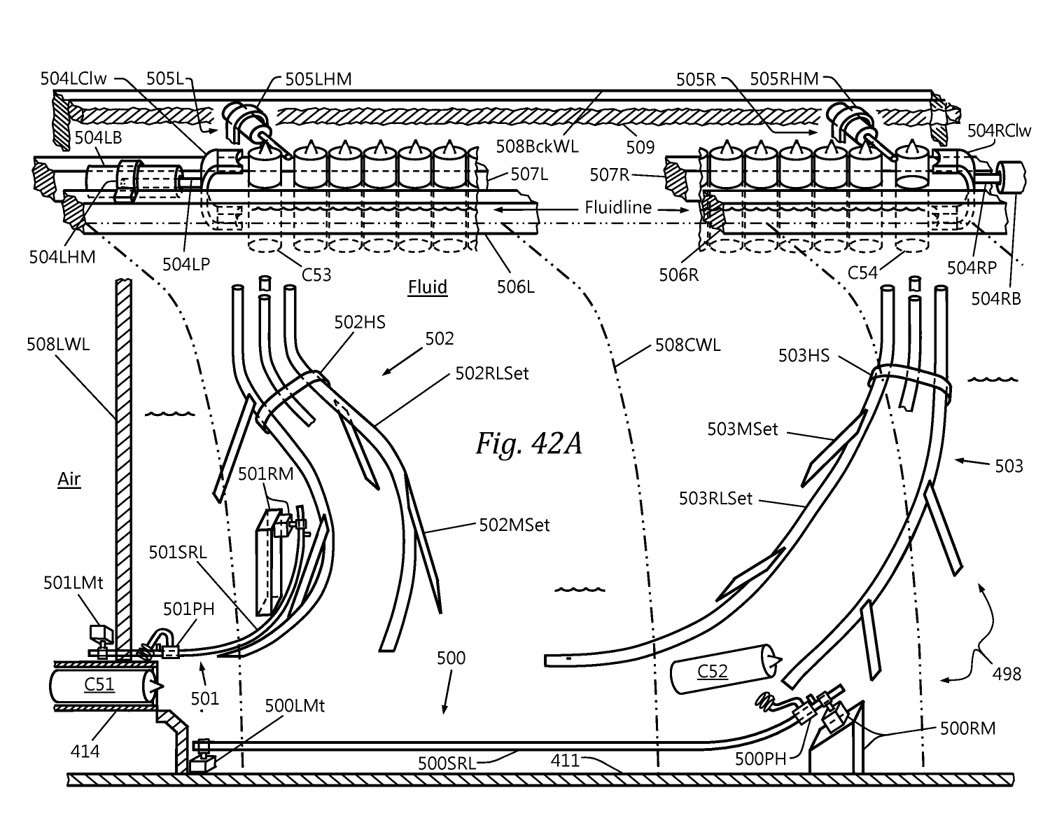

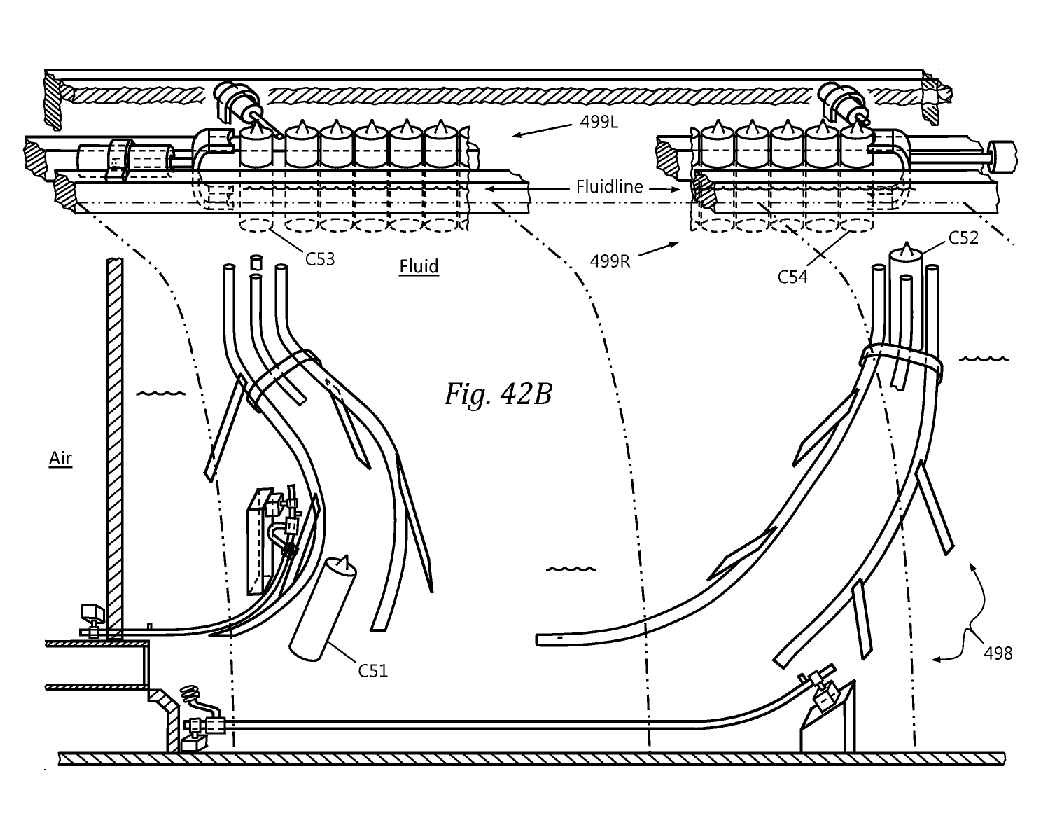

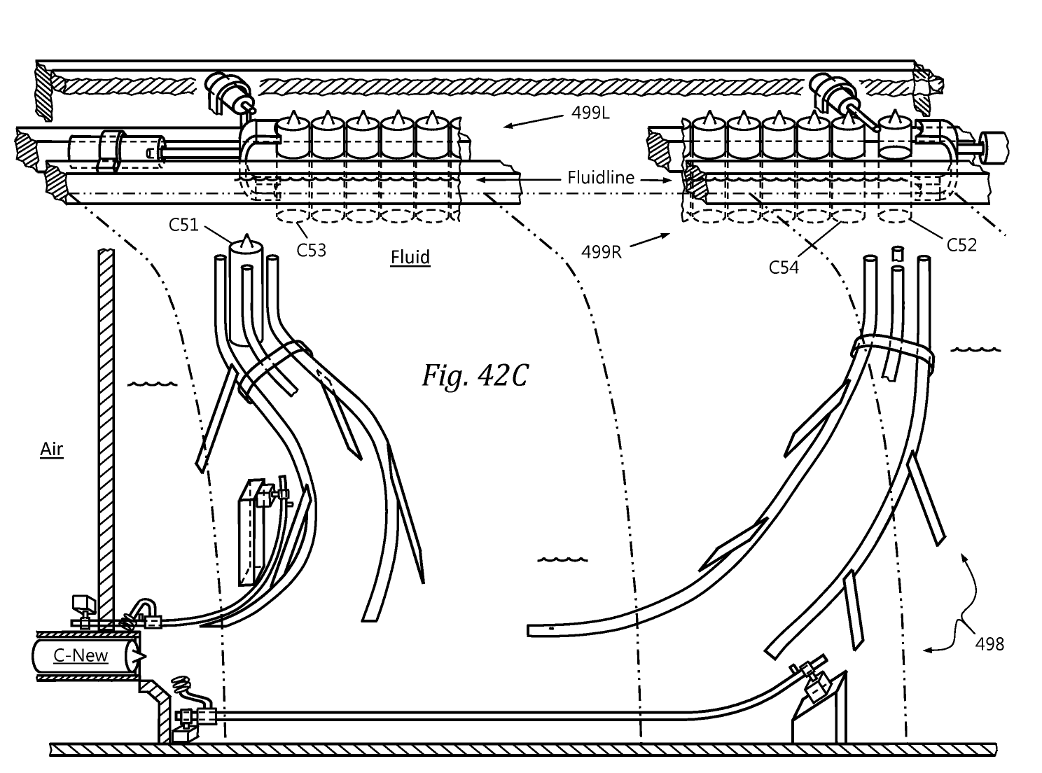

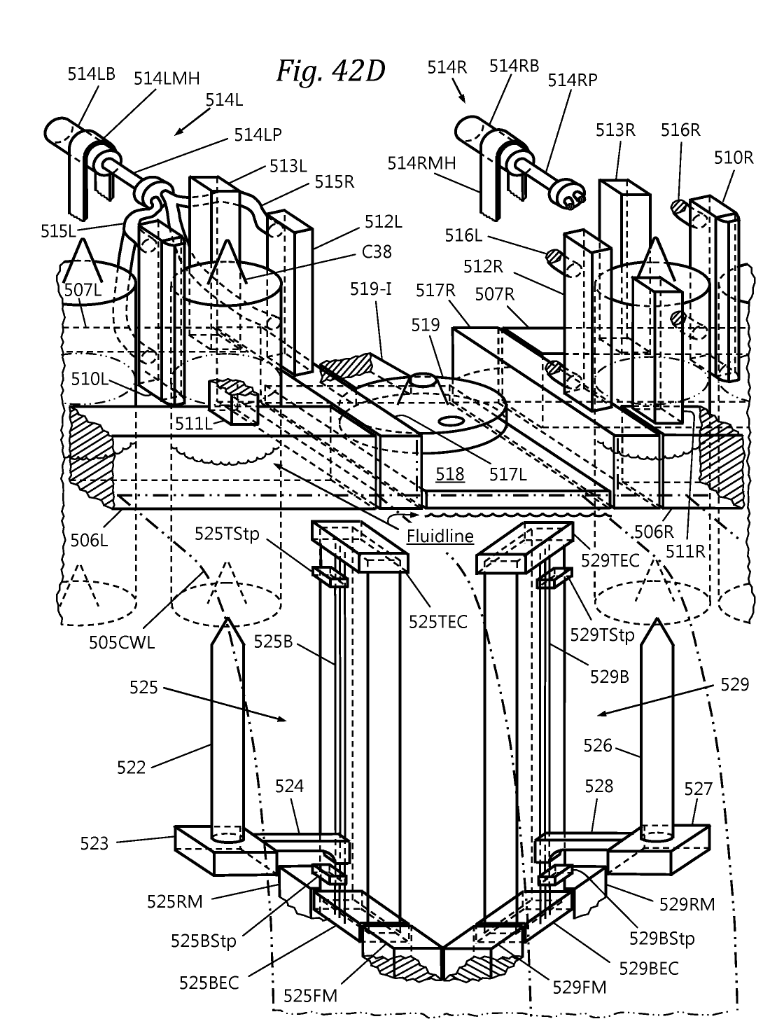

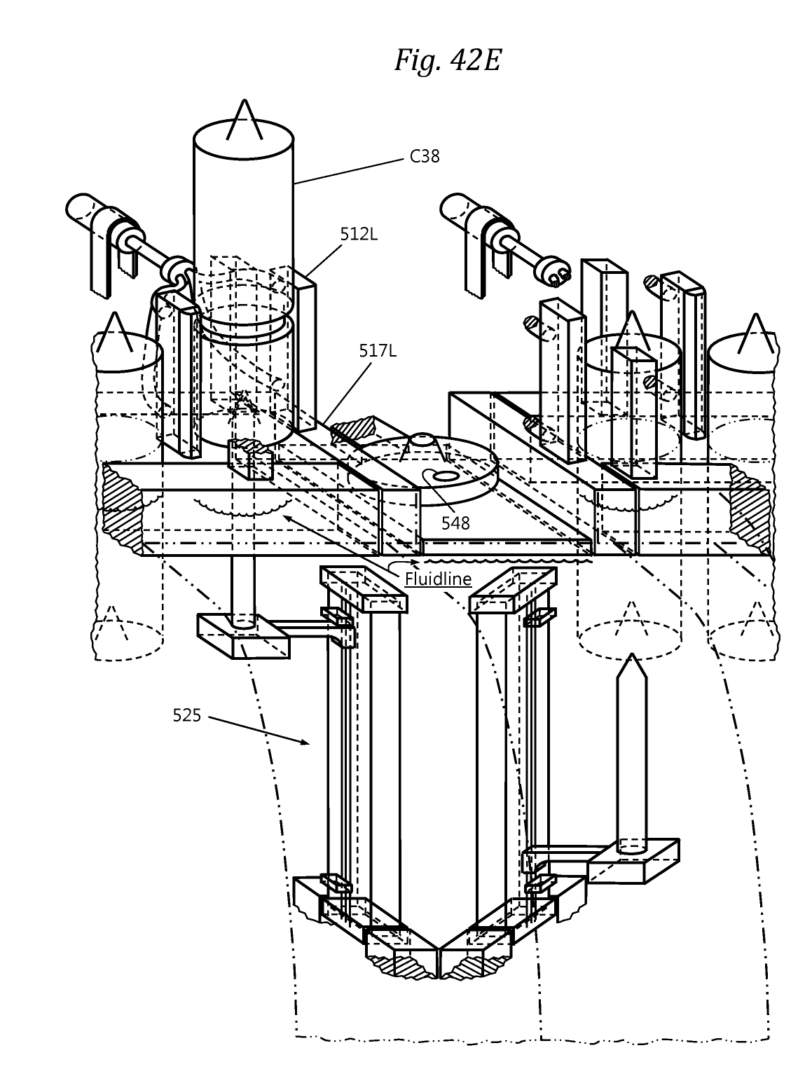

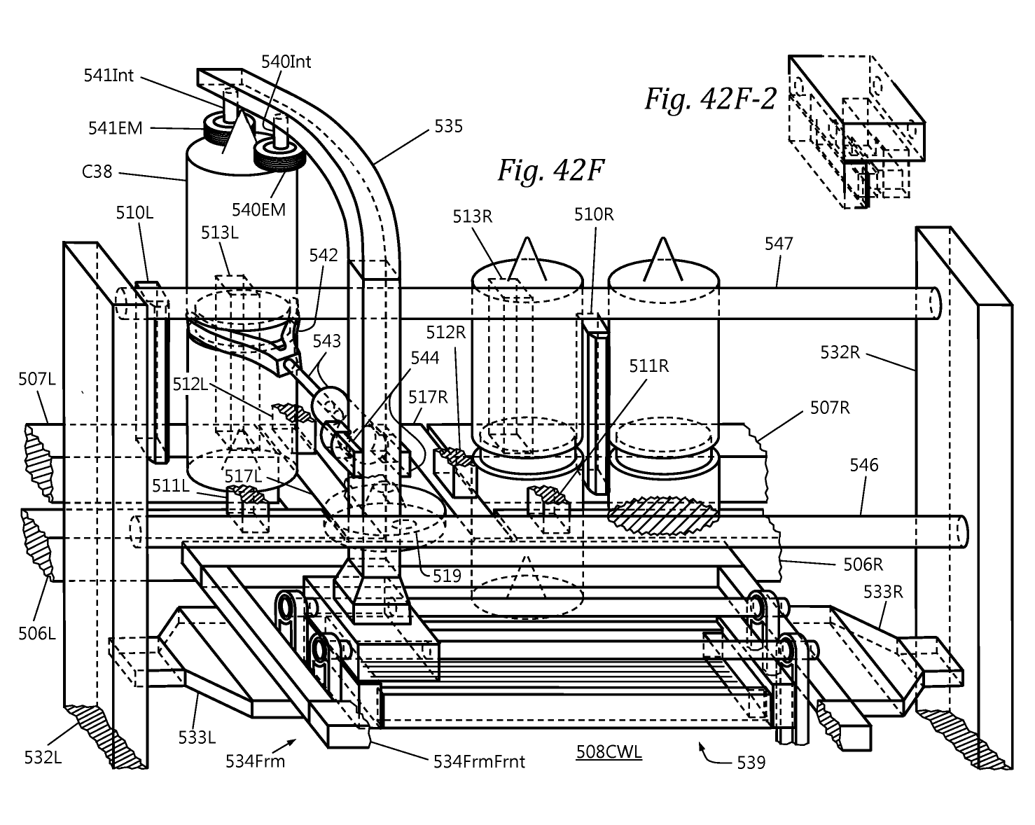

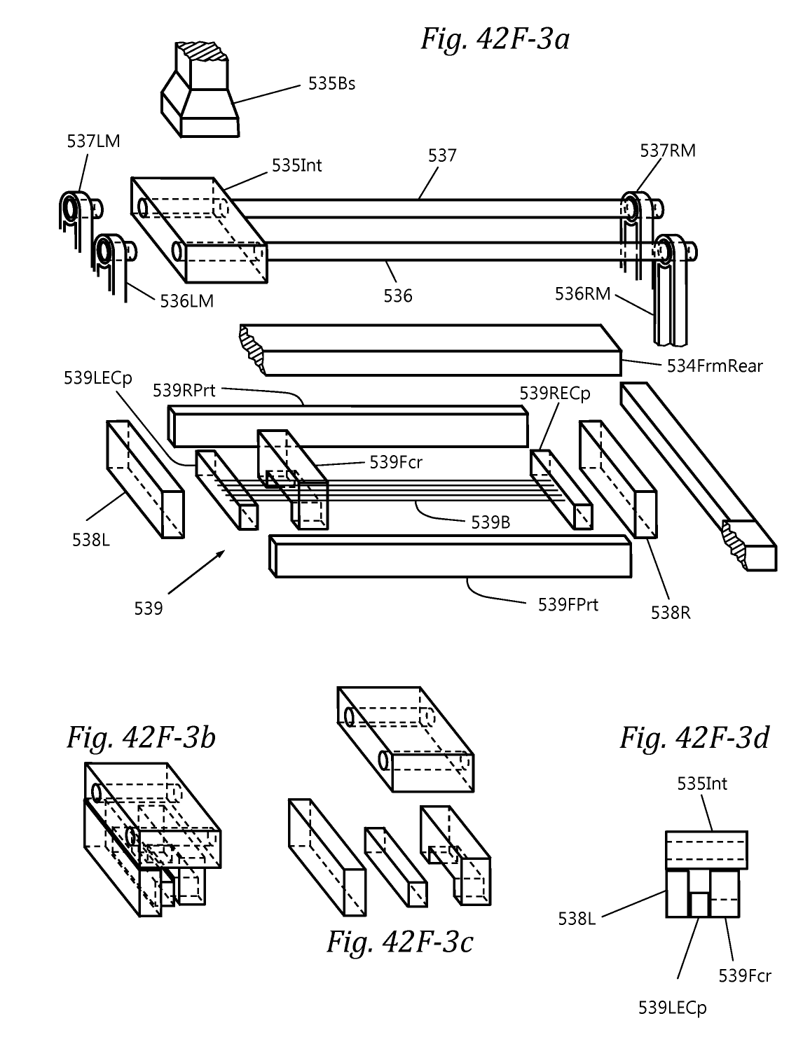

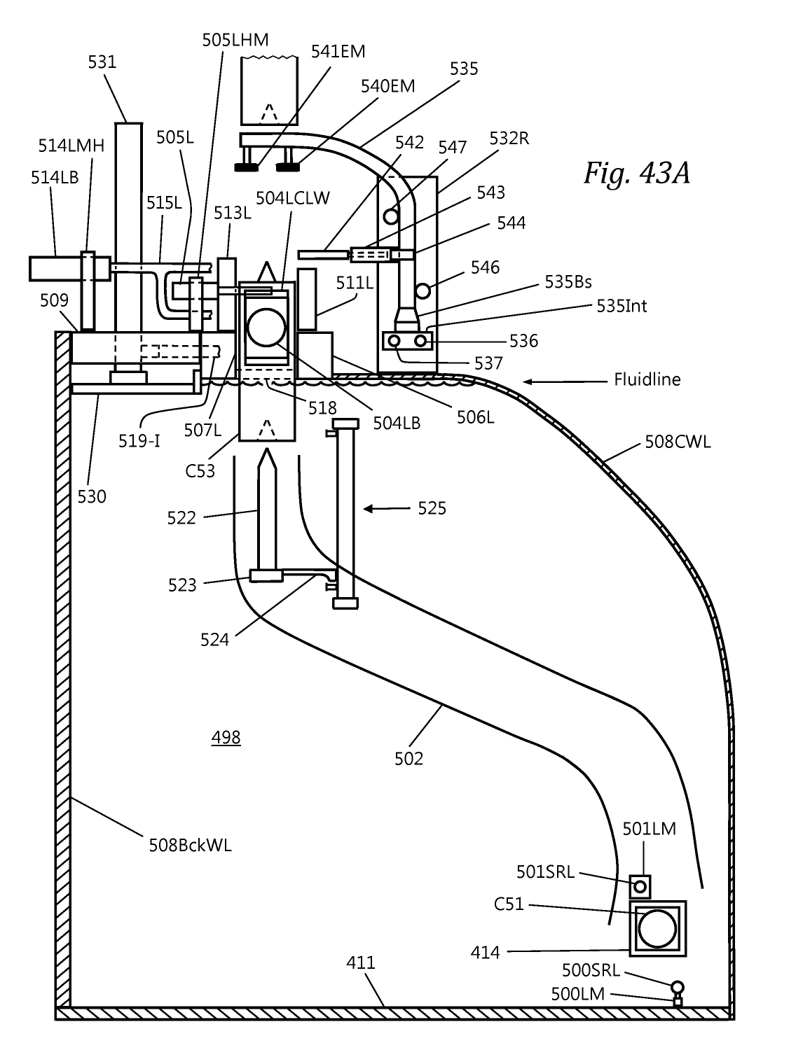

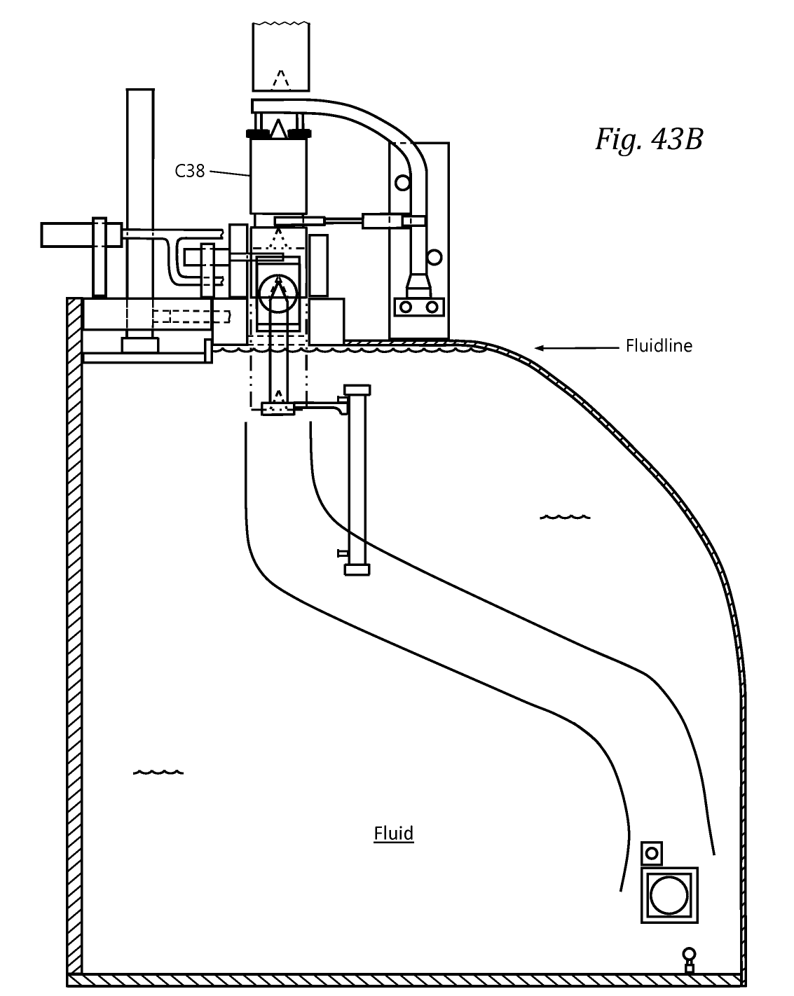

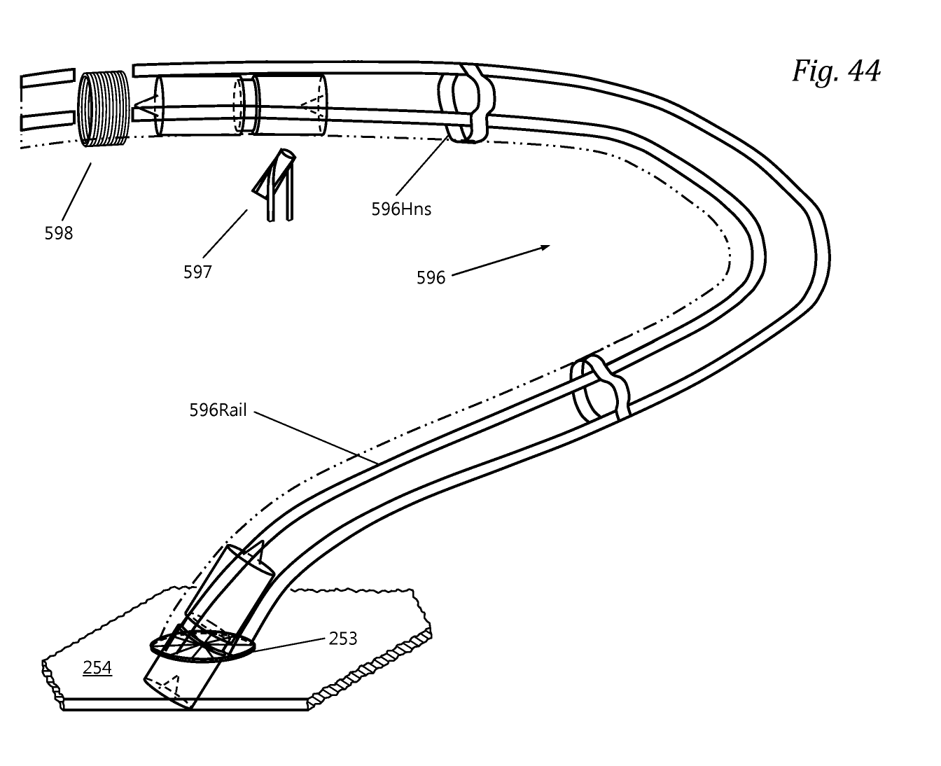

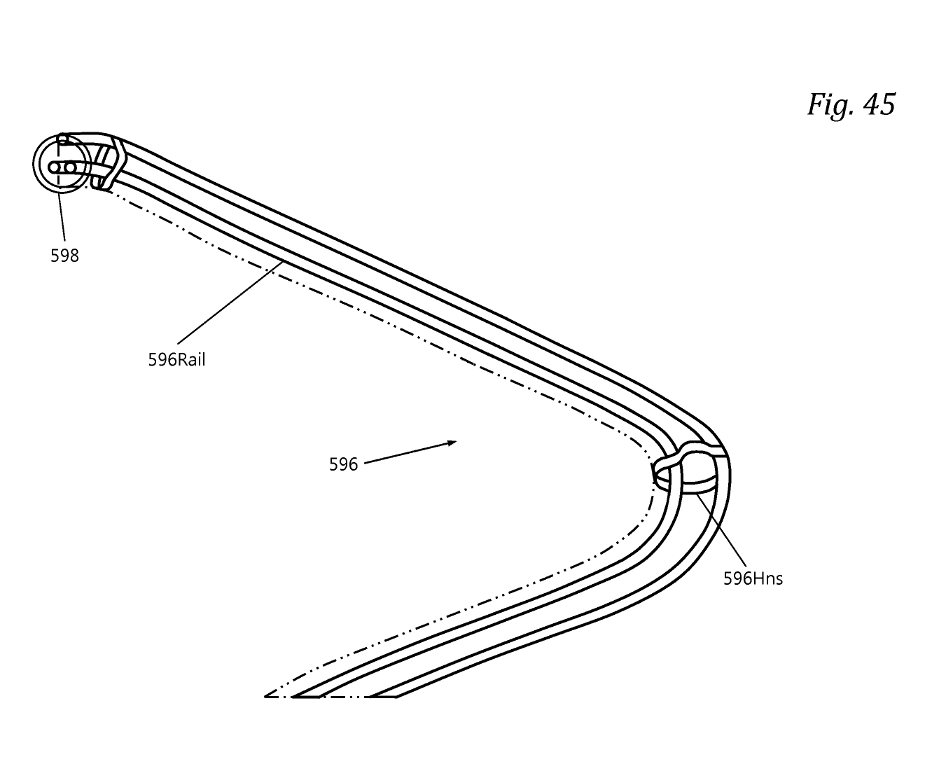

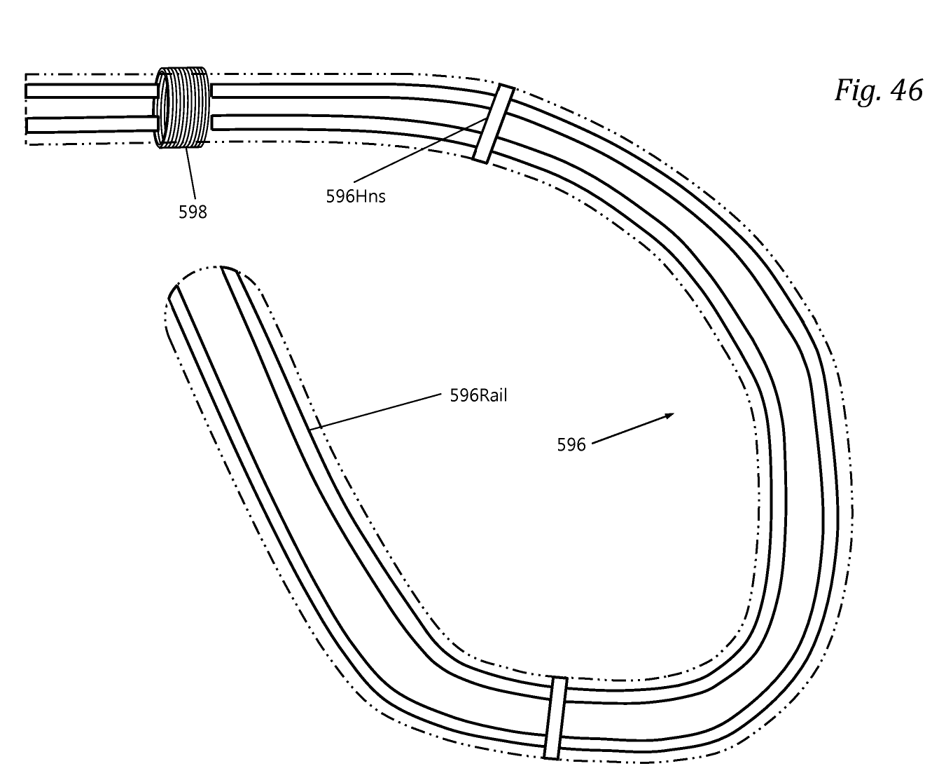

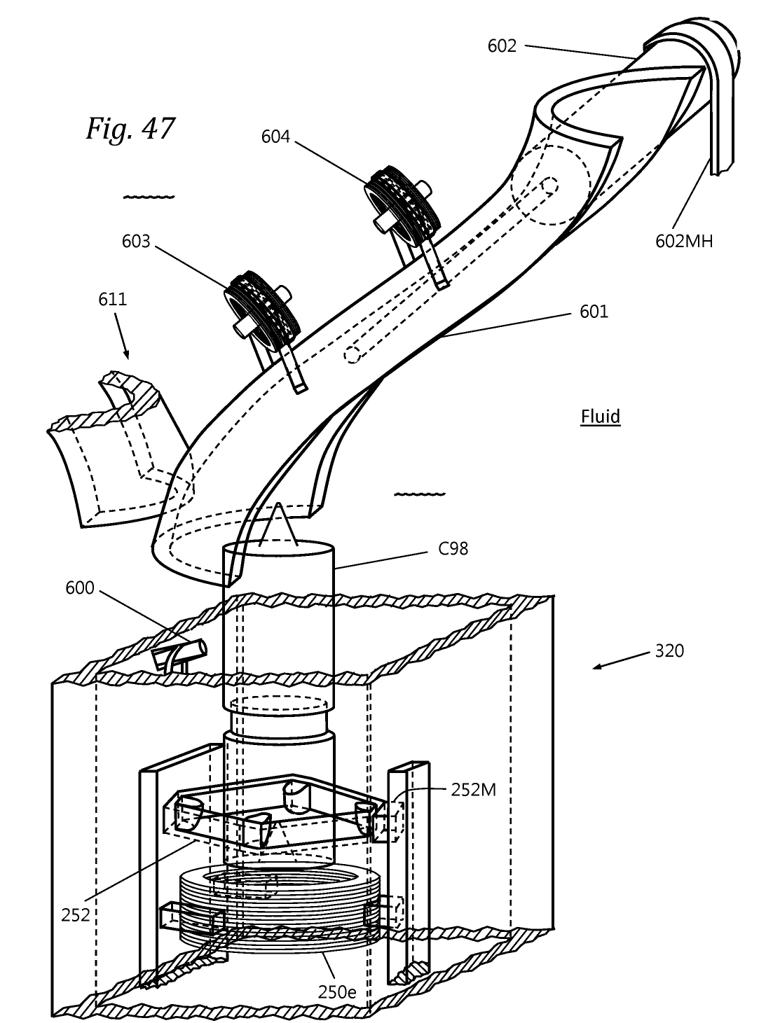

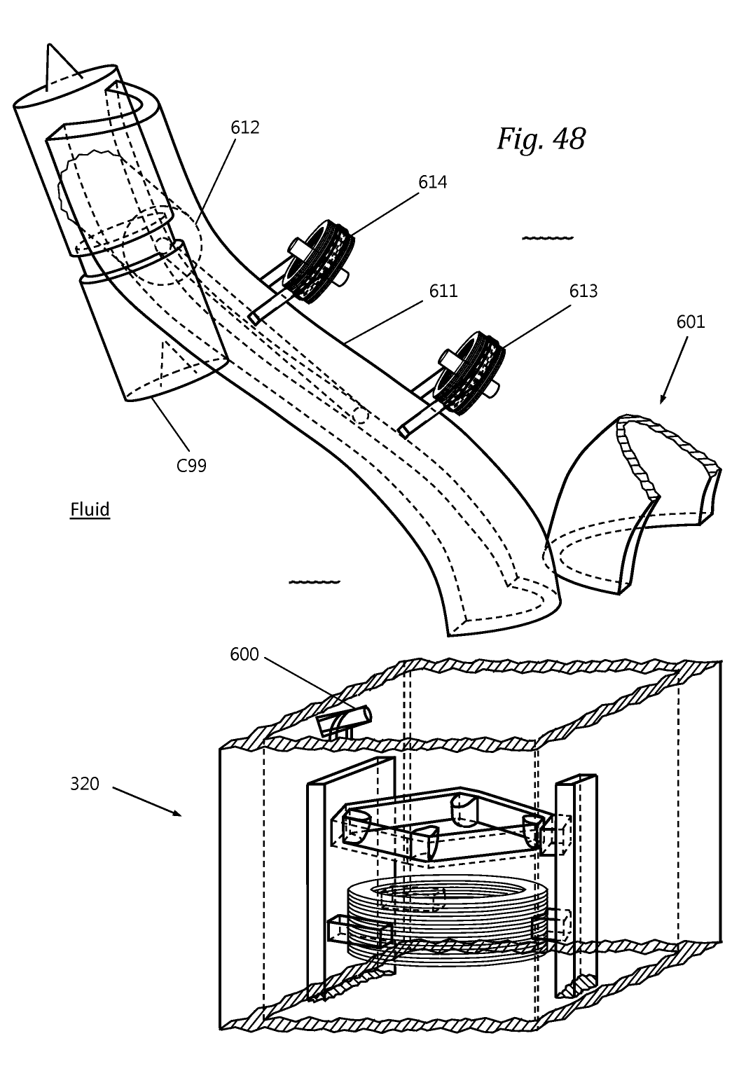

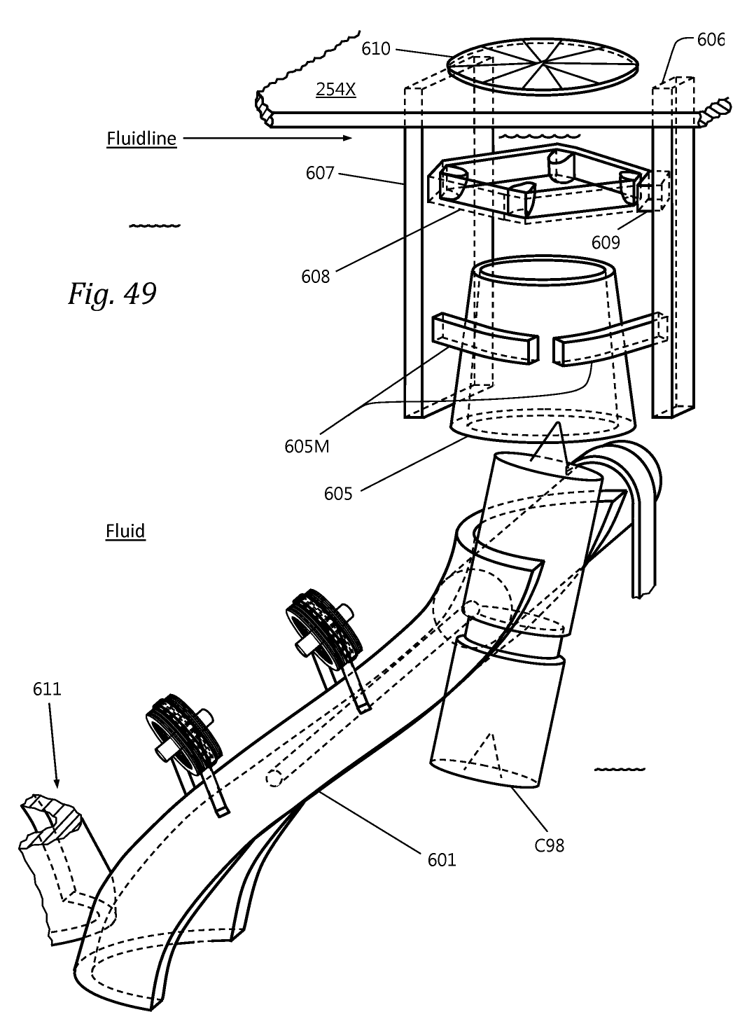

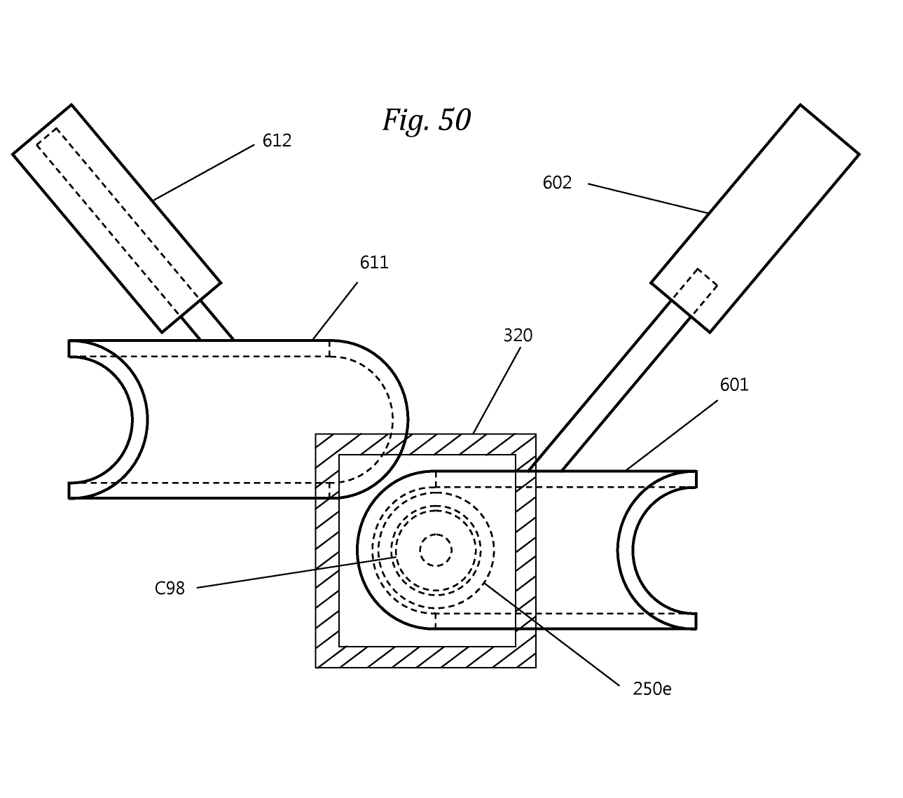

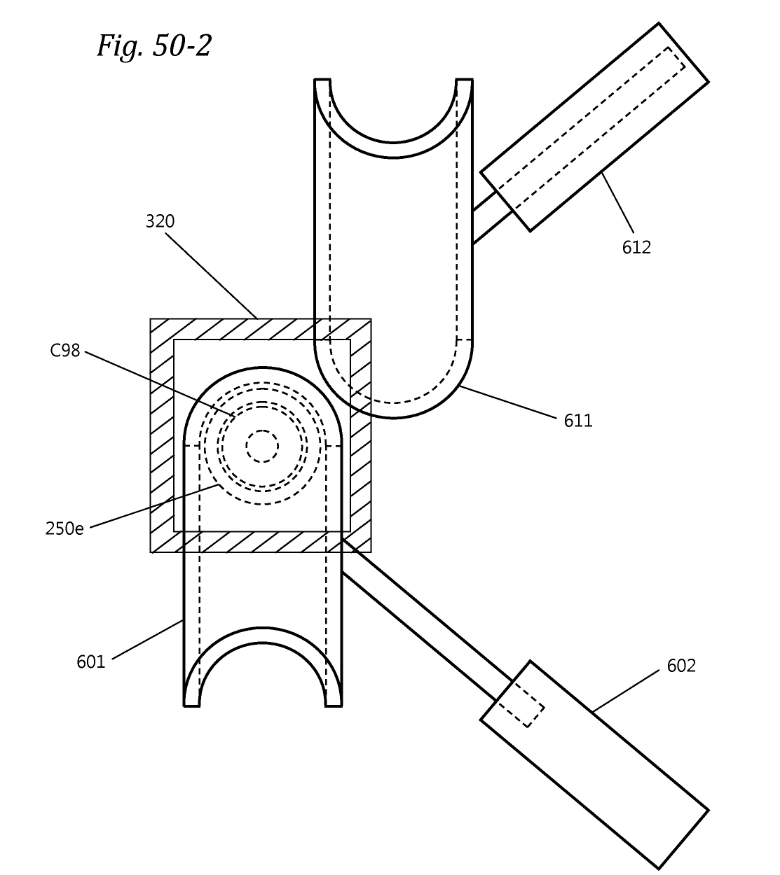

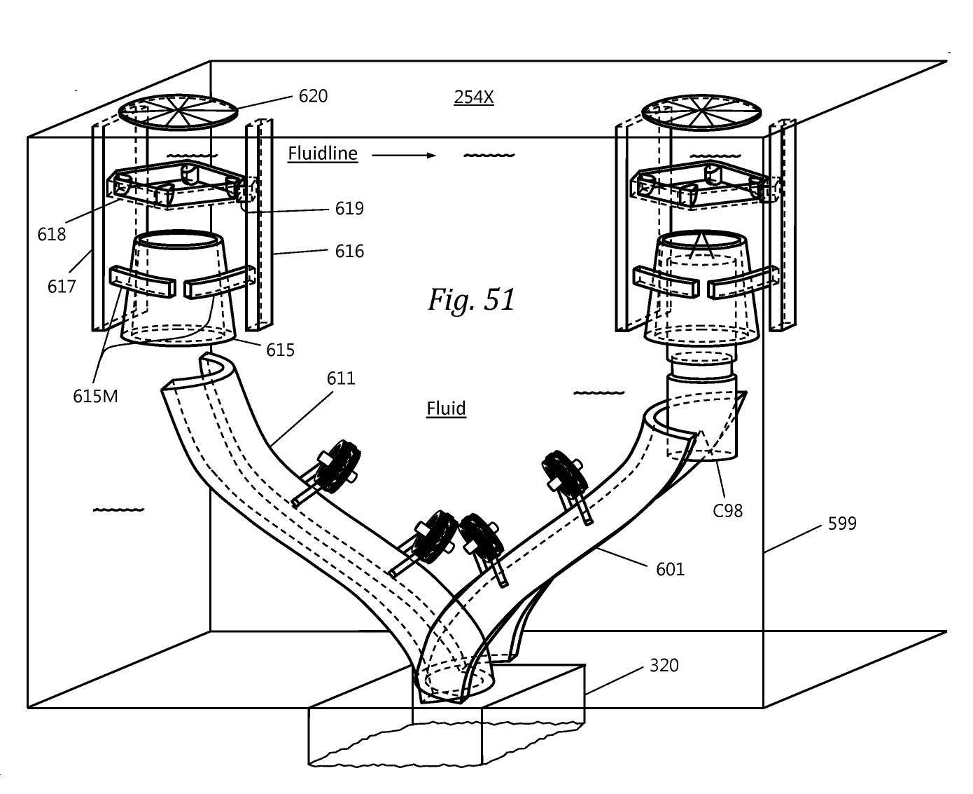

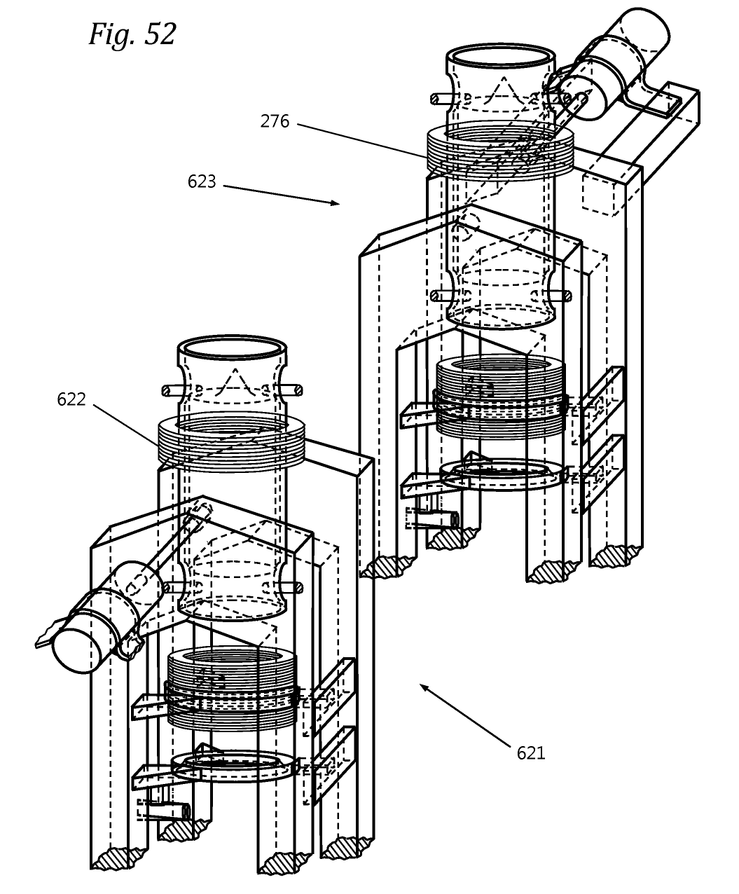

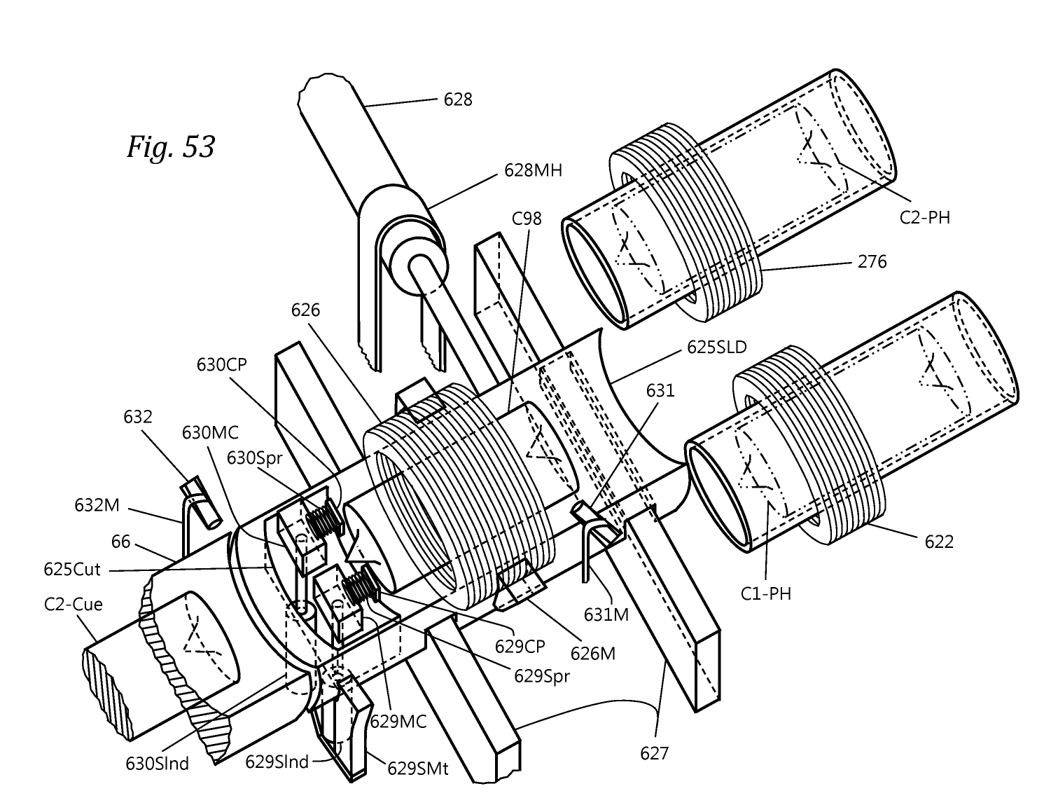

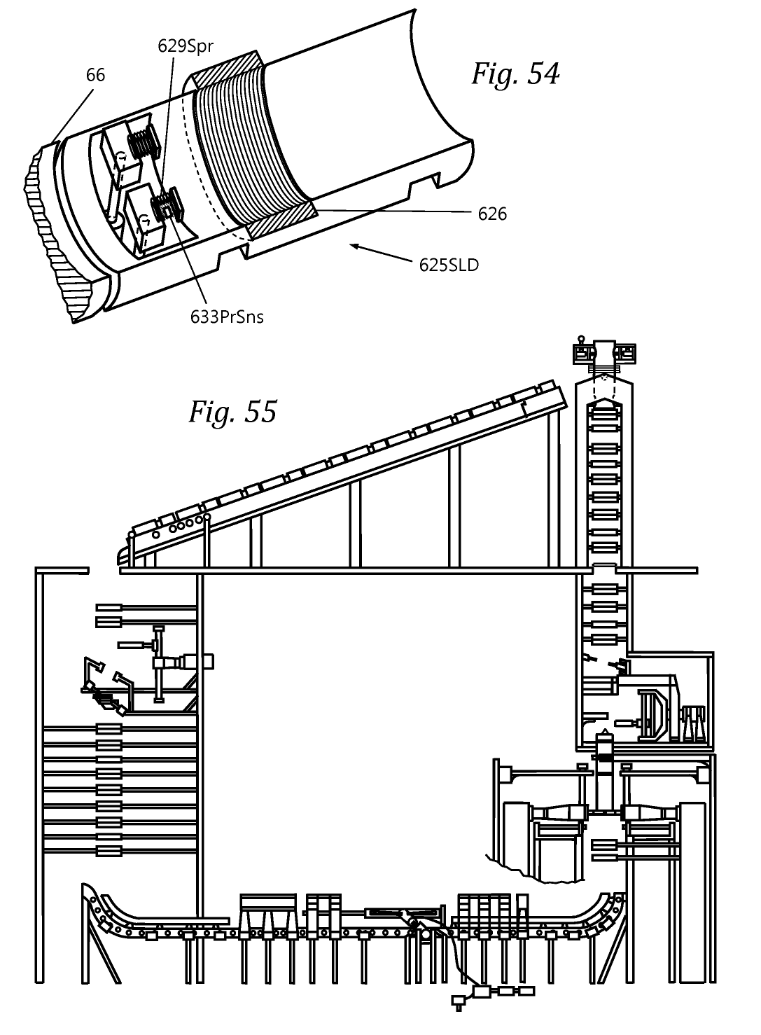

FIG. 1A-2 is an enlarged isometric front view of the Far Left Side of Inclined Platform 60. For the sake of clarity, Rear Vertical Beam 63R is “broken off” and this break is shown with hatched lines.

FIG. 1B is an isometric front view of the Air Side Launch Area. For the sake of clarity, various Mounting Beams, Vertical Structural Beams, and Other Structural Beams are “broken off” and these breaks are shown with hatched lines. Also, FIG. 1B-3 shows two small sectional views, with hatched lines, of the Front and Rear Beams of the Air Side Vertical Support Structural Beam System 298R. FIG. 1B does include the area from which these Two Sectional views in FIG. 1B-3 are taken, which is a plane that “cuts” the Front and Rear Beams (of the Beam System 298R) at a vertical point on the same horizontal level as the very top of the Body of Positioning Solenoid 99B (shown in FIG. 1B). For the sake of clarity, no indication is given for this “cutting plane” in FIG. 1B.

FIG. 1B-2 is an enlarged isometric view showing the underside of the LM-1 Air-side Launch Platform 93. Air Side Launch Platform Connecting Interface 94 is “broken off” and this break is shown with hatched lines due to space restrictions on drawing page.

FIG. 1B-3 is a top view of the equipment in the Air-side Launch Area (showing the equipment in FIG. 1B).

FIG. 1B-3 takes priority over FIG. 1B, in terms of showing the exact alignment of the equipment. The Two Sectioned Areas in FIG. 1B-3 are explained two paragraphs above, in the description for FIG. 1B.

FIG. 3a is a top view of a Final Release Funnel-tray.

FIG. 3b is a front view of a Final Release Funnel-tray.

FIG. 3c is a side view of a Final Release Funnel-tray.

FIGS. 4a-4d are relational views showing Sequence of Action as the Two Final Release Funnel-trays separate apart and a canister falls down into the “funneled portion” of the Funnel-trays.

FIGS. 5a and 5b are enlarged relational isometric front views showing both the Front and Rear Final Release Funnel-trays, in relationship to each other.

FIG. 1C is a separated and “broken” isometric front view showing two vertical sections of the Air Side Coil Stack (includes Mounting Structures). The Two Front and Two Rear Beams of the respective Air Side Vertical Support Structural Beam Systems, 298L and 298R, are “broken off” and these breaks are shown with hatched lines in multiple places due to space restrictions on drawing page.

FIG. 1D is an isometric front view of the Arc B Area, the Roller Conveyor 121, and Three Connected Alignment Rings. Due to space restrictions on drawing page, the following components are “broken off”: the Two Front and Two Rear Beams of the respective Air Side Vertical Support Structural Beam Systems, 298L and 298R; Subterranean Floor 317, on the far left and far right; Roller Conveyor 121 on the far right. All of these “breaks” are shown with hatched lines. For the sake of clarity, the Rear Arc B Stand-alone Vertical Support Beam (of Beam System 126) and the Rear Vertical Support Structures of the Three Alignment Ring Mounting Systems 127M, 128M, and 129M are “broken off.” All of these “breaks” are shown with hatched lines.

FIG. 6 is an enlarged front view of one of the Electromagnets (EMs), 125c, that is mounted under the Roller Conveyor 121; in the Arc B Area, these Three EMs are used to magnetically elevate the canisters off of the Roller Conveyor. The Roller Conveyor 121 and the Two Bearings (Left and Right) of a Roller 122 are shown with hatched lines.

FIG. 8a is an enlarged isometric front view of a typical Alignment Ring, 127.

FIG. 7a and FIG. 7b are partial views of two different sized canisters; the reason why these drawings are necessary on this Drawing Sheet is explained below in Drawing Exceptions #7. Due to space restrictions on the drawing page, the respective canister bodies in FIG. 7a and FIG. 7b are “broken off” and shown with hatched lines.

FIG. 8b is an isometric front relational view showing a larger canister section (like the canister section in FIG. 7b) just before the canister is entering an Alignment Ring. Due to space restrictions on the drawing page, the canister body in FIG. 8b is “broken off” and shown with hatched lines.

FIG. 1E is an isometric front view of the Slowdown Plunger Area. For the sake of clarity, the Rear Vertical Beams (of the Two Respective Mounting Systems: 142M and 143M), the Rear Slowdown Plunger Area Stand-alone Vertical Support Beam 151R, and the Rear Slowdown Plunger Back-end Stop-pin 152PnR are “broken off” and all of these “breaks” are shown with hatched lines. Due to space restrictions on the drawing page, on the far right of FIG. 1E, the Roller Conveyor 121 is “broken off” and shown with hatched lines. Also, “phantom canister” PhC is the same canister as shown in FIG. 1B, but this canister has simply traveled from the Air Side Launch Area (in FIG. 1B) to the Slowdown Area (in FIG. 1E).

FIG. 1E-2 is a sectioned front view of the Hydraulic Accumulator Fluid Holding Area (and more), and this front view is connected to an isometric front view of the Hydraulic Motor and attached Electric Generator. The Full Views for: Hydraulic Accumulator 156, Pressure Release Chamber 162, High Pressure Chamber 165-hg, Low Pressure Chamber 165-lw, and the 3-dimensional object related to Multi-Surface Mounting Interface Structure 155 are not shown. However, the related “Full Objects” to these Five Components are simply conventional cube-like or box-like objects, and the related Sectioned Surfaces shown in FIG. 1E-2, of: a) the Walls of the Hydraulic Accumulator 156W, b) the Walls of the Pressure Release Chamber 162W, c) the Walls of the Two Pressure Adjustment Chambers 165XW and e) the Three “Cut” Surfaces of Multi-Surface Mounting Interface Structure 155, are simply created by “cutting” these related “Full Objects” directly in half.

The Sectioned Areas of Pressure Hoses 172 and 173 are created by merely cutting the respective Hoses in half, down the middle, in the horizontal plane. The Sectioned Areas of Inlet Interface Area 174Inlt and Outlet Interface Area 174Outl are created by merely cutting the respective Interface Areas in half, down the middle, in the horizontal plane. The Horizontal Cross Beam (for Mounting Structure 174M, for the Front of the Hydraulic Motor) has a cube-like shape and the Sectioned Area for this Cross Beam is created by merely “cutting” this Cross Beam in half, down the middle, in the horizontal plane.

FIG. 10 is an enlarged isometric front view of a Pressure Check Valve; the particular Valve 157 (FIG. 1E-2) can be closed electronically, upon receiving a signal from the Pressure Gauge 164.

FIG. 11 is an enlarged isometric side sectional view of the Pressure Check Valve 157 shown in FIG. 10. The lower portion of the housing walls of this Valve 157 are shown with hatched lines.

FIG. 1F is an isometric front view of the Mid-section of the Roller Conveyor 318, which is a section of the Roller Conveyor between the Slowdown Plunger Area (from FIG. 1E) and the Arc C Area (from FIG. 1G). For the sake of clarity, the Rear Vertical Beams (of the Three Respective Alignment Ring Mounting Systems: 176M, 177M and 178M), and the Two Rear Beams of the Respective Roller Conveyor Mid-section Stand-alone Vertical Support Beam Systems, 181 and 182, are “broken off” and all of these “breaks” are shown with hatched lines. Also, due to space restrictions on the drawing page, on the far right of FIG. 1F, the Roller Conveyor 121 is “broken off;” the Subterranean Floor 317, on the far left and far right is “broken off.” All of these “breaks” are shown with hatched lines.

FIG. 1G is an isometric front view of the Arc C Area; includes (at top) broken sections of left side Vertical Structural Beams and other Mounting Equipment that extend down from the Pre-launch Area (FIG. 1H). Due to space restrictions on drawing page, the following components are “broken off”: the Two Front and Two Rear Beams of the respective Fluid Side Vertical Support Structural Beam Systems, 299L and 299R; the Subterranean Floor 317, on the far left and far right; the Roller Conveyor 121 on the far left. All of these “breaks” are shown with hatched lines. For the sake of clarity, various Support Beams and Mounting Beams (of the Respective Support and Mounting Systems: 190M, 191, 195M, 213L, 216ML, and 299SL) are “broken off” and all of these “breaks” are shown with hatched lines.

FIG. 1H is an isometric front view of the Pre-launch Area. Due to space restrictions on drawing page, the following components are “broken off”: the Front Support Beam of the Support Structure 213R (for Two Cylindrical Rods that support the Right Solenoid Interface); the far left side of the Connecting Interface 211ML (for Left Half of Pre-launch Launch Platform); the Front Support Beams in the Structural Beam System 299R. All of these “breaks” are shown with hatched lines. The Front Support Beams in Mounting Structure 216MR, and the Mounting Structure 216ML are “broken off” but these “breaks” are not shown with hatched lines. For the sake of clarity, the following components are “broken off”: the lower portion of the Right-side Vertical Support Wall 224R; Front and Rear Support Beams (of Structural Beam System 299R); Plunger 216PL (for the Left-side Pre-launch Positioning Solenoid). All of these “breaks” are shown with hatched lines.

FIG. 1H-2 is a separate (not enlarged) isometric front view of the Two Cylindrical Solenoid Interface Support Rods (and the Mounting Structure for the Rods). Due to space restrictions on drawing page, the Front and Rear Beams for the Support Structure 213R (for Two Cylindrical Rods that support the Right Solenoid Interface) are “broken off” and these “breaks” are shown with hatched lines.

FIG. 11 is an enlarged isometric view of the Two Pre-launch Launch Platform Halves; view shows the two halves (fully extended towards each other, by their related Solenoids); these Two Launch Platform Halves are making contact with each other. Due to space restrictions on drawing page, the left side of Connecting Interface 211ML is “broken off” on the far left side and this “break” is shown with hatched lines.

FIG. 1H-3 is an enlarged isometric front relational view showing the Locking Pin System for the Two Pre-launch Launch Platform Halves. Due to space restrictions on drawing page, Both Halves (of the Pre-launch Launch Platform), 211L and 211R, are “broken off” and Three of these Six “breaks” are shown with hatched lines.

FIG. 1H-4 is an isometric front view of the Pre-launch Area, focusing on showing the Left and Right Suspension Support Rods (227L and 227R, respectively), and also showing the related support components for these Two Suspension Support Rods. Due to space restrictions on drawing page, the following components are “broken off”: the bottom of a vertical support component of Support Structure 213R (for Two Cylindrical Rods that support the Right Solenoid Interface); the Front and Rear Support Beams in both Structural Beam Systems 299R and 299L. Most of these “breaks” are shown with hatched lines. The far left side of the Connecting Interface 211ML (for Left Half of Pre-launch Launch Platform) is “broken off” and shown with hatched lines.

The following components are “broken off” but not shown with hatched lines: 223FRd and 223RRd (Front and Rear Right Horizontal Support Rods; referenced in FIG. 1H); Mounting Assemblies 221MF and 221MR (for the Front and Rear Notch Grip Solenoids, respectively; referenced in FIG. 1H). For the sake of clarity, the Two Sensors 217LS and 217US are not shown, but would be positioned in the empty space between the Two Rear Support Beams, for the Fluid Side Vertical Structural Beam Systems 299L and 299R.

FIG. 1I is an isometric front view of the Underwater Launch Area. Due to space restrictions on drawing page, the following components are “broken off”: Bottom Partition 230 (of the Fluid Column) on the far left and far right; Mounting Plate 231; Main Vertical Beam (of the Support Beam-system 248 (that supports the entire Right Side of the Fluid Column Coil Stack); Vertical Structural Support Wall 249. All of these “breaks” are shown with hatched lines.

FIG. 1I-2 is an enlarged isometric front view of LM-3 (and Mounting Structure). Due to space restrictions on drawing page, Mounting Interface 233M (for the Underwater Launch Platform 233) is “broken off” and this “break” is shown with hatched lines. On the far right, the Attachment Interface 237 is “broken off” but is not shown with hatched lines.

FIG. 1J is a separated and “broken” isometric front view showing two vertical sections of the Fluid Side Coil Stack (includes Mounting Structures); includes Splash Guard that covers the Fluid Column Exit Point (at the top of the Fluid Column). Due to space restrictions on drawing page, the following components are “broken off” in multiple places: all of the Four Walls of the Fluid Column 320W; Main Vertical Beam (of the Support Beam-system 248, that supports the entire Right Side of the Fluid Column Coil Stack); Vertical Structural Support Wall 249; Ceiling of the Fluid Column 254, “broken” on the far left and far right. All of these “breaks” are shown with hatched lines.

FIG. 1K is an isometric front view of the Above Ground Short Coil Stack, which is directly below the Pivot Bucket Area. The Vertical Structural Beams in FIG. 1K are the same Beams that reach up into the Pivot Bucket Area and support the Pivot Bucket (FIG. 1L). Due to space restrictions on drawing page, the Front and Rear Beams of the Two Vertical Structural Beam Systems 255L and 255R (for the Left and Right Sides of the Above-ground Coils and for the Pivot Bucket) are “broken off” and these “breaks” are shown with hatched lines. The Ceiling of the Fluid Column 254 is “broken off” in multiple places but Two of these “breaks” are shown with hatched lines, on the far left and far right.

FIG. 1L is an isometric front view of the Pivot Bucket Area. Due to space restrictions on drawing page, the Front and Rear Beams of the Two Vertical Structural Beam Systems 255L and 255R (for the Left and Right Sides of Above-ground Coils and for Pivot Bucket) are “broken off.” These “breaks” are shown with hatched lines. For clarity, “Pins” of components, 263L, 263R, 264L, and 264R, are “broken off.” These “breaks” are shown with hatched lines.

Also, FIG. 13 shows sectional views, with hatched lines, of the Front and Rear Top Angled Extensions, 255TAEF and 255TAER (of the Two Front and Rear Vertical Structural Beams 255L and 255R, for the Above Ground Coil Stack and the Pivot Bucket). For the sake of clarity in FIG. 1L, the Two Planes in the Respective Angled Extensions, 255TAEF and 255TAER, upon which the Two Sectional Views in FIG. 13 are taken, are not shown in FIG. 1L. However, the Two Respective Sectioned Surfaces shown in FIG. 13 are created by “cutting” a straight vertical line down the center (going from front to rear) of Both of these Angled Extensions, 255TAEF and 255TAER, and starting such straight vertical line at the respective Apex of 255TAEF and 255TAER. (Note: the view of all components in FIG. 13 has been rotated 90 degrees in the horizontal plane; the “left” in FIG. 13 is the “front” in FIG. 1L and the “right” in FIG. 13 is the “rear” in FIG. 1L.) FIG. 1L-2 is an enlarged front view of the Pivot Bucket (includes attached peripheral equipment).

FIG. 12 is an enlarged isometric front view of the Upper Left Pivot Bucket Stop-pin System.

FIG. 13 is a relational side view (with cross-sectioning) showing the Pivot Bucket Swivel Point Assembly. The Two Sectioned Areas in FIG. 13 are explained in the second paragraph for the description of FIG. 1L above.

FIG. 14 is a front view of Pivot Bucket (Pivot Bucket with canister inside are shown in hidden lines and both are rotated down and to left); includes a front view of Pivot Bucket Rotational Solenoid. Due to space restrictions on drawing page, Rear Top Angled Extension 255TAER is “broken off” at bottom, but not shown with hatched lines.

FIG. 1M is isometric front view of Pivot Bucket and Pivot Bucket Rotational Solenoid (Pivot Bucket with canister inside are both rotated down and to left). Due to space restrictions on drawing page, the Left and Right Beams of Rear Top Angled Extension 255TAER are “broken off” at bottom and these “breaks” are shown with hatched lines.

FIG. 1N is a front isometric view showing a canister moving out of Pivot Bucket and down body of Inclined Platform Top Cue Position Canister Holder Section 625EXT. Also peripheral equipment in this area of device is shown. Inclined Canister Holder 66 and Canister C1-Cue (in lower left) have been “broken off” and “breaks” are shown with hatched lines. [Note: designation of Canister Holder Section 625EXT is used to clarify difference between non-sliding Canister Holder Section (625EXT—for single pivot bucket embodiment) and Sliding Canister Holder Section (625SLD—for Dual Pivot Bucket embodiment). Technically, the main component shown in FIG. 1N is an elongated (up and to the right) Inclined Canister Holder 66 and by comparing FIG. 1N to FIG. 53, it can be seen that with Canister Holder Section 625SLD, there is a gap between the lower left of this component and top right of Inclined Canister Holder 66. This gap is not present in FIG. 1N because Inclined Canister Holder 66 is longer and extends up and to right.]

On all of the Six “Sequence Diagrams,” FIGS. 15-20, the Walls of the Fluid Column 320W are “cut” with a straight vertical line going downward from the top of the Fluid Column, and all of the “cut surfaces” are shown with hatched lines (the plane for this cut is shown in FIG. 35a).

FIG. 15 is a front view of the overall MF device, which shows the equipment in the Initial, Start-up Condition.

FIG. 16 is a front view of the overall MF device, showing how the canisters move around the device in a counter-clockwise direction; also shown is the status of different equipment as a canister moves through a Cycle.

FIG. 17 is a front view of the overall MF device, showing how the canisters move around the device in a counter-clockwise direction; also shown is the status of different equipment as a canister moves through a Cycle.

FIG. 18 is a front view of the overall MF device, showing how the canisters move around the device in a counter-clockwise direction; also shown is the status of different equipment as a canister moves through a Cycle.

FIG. 19 is a front view of the overall MF device, showing how the canisters move around the device in a counter-clockwise direction; also shown is the status of different equipment as a canister moves through a Cycle.

FIG. 20 is a front view of the overall MF device, which shows that one entire Cycle has been completed; this drawing is exactly the same as FIG. 15, except that all canisters have advanced one canister position.

FIG. 1D-oz is front view of additional embodiment (the Over-sized embodiment). For the sake of clarity, the majority of “bounding surfaces” have been “cut open” and thus the following surfaces of Fluid Reservoir 419 are shown with hatched lines: Ceiling 427, Floor 411, and Walls 400. The extensions of Ceiling 427 and Floor 411, where these surfaces extend over (on left) into Air Side of the overall MF device, are also shown with hatched lines.

FIG. 21 is an enlarged relational front view of the bottommost part of the Extended Air Side Coil Stack and clearly shows that there is a descending canister inside this Extended Coil Stack. The general proportion and scale of the entire FIG. 1D-oz Drawing can be realized by visualizing the height of the Fluid Reservoir 419, relative to the size of this descending canister in FIG. 1D-oz (which is about 26 inches before down-scaling).

FIG. 22 is enlarged top view of Splash Guard that is positioned inside Mouth of Low Pressure Fluid Reservoir 404.

FIG. 23a is an enlarged front view of the Two (lower) Canister Puller Assemblies: a) the Pre-Chamber Horizontal Canister Puller Assembly, and b) the Post-Chamber Angled Canister Puller Assembly. All hatched lines are sections of the same surfaces that are shown with hatched lines in FIG. 1D-oz.

FIG. 23b illustrates motion for the Two (lower) Canister Puller-heads that are shown in FIG. 23a. All hatched lines are sections of the same surfaces that are shown with hatched lines in FIG. 1D-oz.

FIG. 24a is an enlarged front view of the (upper) Curved Pre-Exit Canister Puller Assembly.

FIG. 24b illustrates motion for the (upper) Canister Puller Assembly that is shown in FIG. 24a.

FIG. 25 is an enlarged front view (using graphic symbols) of the Fluid Turbine, with isometric front view of the Electric Generator mounted on the shaft of the Fluid Turbine.

FIG. 26a is a top view of one full circular section of the Circular Upward-Sloping Canister Pathway 420; a particular sub-section of this Pathway is noted by a reference circle around Three particular canisters.

FIG. 26b is enlarged side view of section of the Pathway (with Three canisters) that is referenced in FIG. 26a.

FIG. 26c is an enlarged isometric side view showing the rear, or opposite side, of what FIG. 26b is showing. The Three Rails of the Upward Sloping 3-sided Circular Guide Rail System 420 are all “broken off” on the right side and the left side, and all of these “breaks” are shown with hatched lines.

FIG. 27 is a separated and “broken” enlarged isometric front view showing two vertical sections of the overall Reservoir Exit Launching System. Due to space restrictions on the drawing page, the following components are “broken off” in multiple places: Left-side Equipment Support Wall 463L and Right-side Equipment Support Wall 463R. All of these “breaks” are shown with hatched lines. As in FIG. 1D-oz, the Ceiling 427 (of the Fluid Reservoir) is shown as a “cut surface” with hatched lines.

FIG. 28a is an enlarged isometric front view of a Reservoir Exit Acceleration Electromagnet 457aR, including iron-like core.

FIG. 28b is an enlarged isometric front view of a Miniature Speed-adjusting Electromagnet 451aR, including iron-like core.

FIG. 29 is a top view of the Lower Truncated Vertical Quad Alignment Rail Assembly 450a; includes a canister (PhC-5) inside the Rails shown by a phantom line. The horizontal connecting and strengthening bars of the Quad Alignment Rail Assembly are also shown. The purpose of FIG. 29 is to illustrate the clearance between the outside circular surface of a canister and the inner (curved) surfaces of the Four Rails. The Four Rails of the Quad Alignment Rail 450a are all shown as “cut surfaces” with hatched lines.

FIG. 30 is an enlarged isometric front view of the Splash Guard 460 that covers the Fluid Reservoir Exit Opening 459 at the top of the Fluid Reservoir. As in FIG. 1D-oz, the small section of the Ceiling 427 (of the Fluid Reservoir) is shown as a “cut surface” with hatched lines.

FIG. 1E-oz is isometric front view (for the “Over-sized” embodiment) showing the area directly above the Fluid Reservoir Exit Opening 459. FIG. 1E-oz is a “Version” of FIG. 1G, only without Arc C Roller Conveyor and equipment attached to Conveyor. FIG. 1E-oz also shows Splash Guard Ph460 and the Fluid Reservoir Ceiling Ph427 (with “phantom lines;” from FIG. 30), for the purpose of providing continuity between the equipment used in the preferred embodiment (shown in FIG. 1G) and the equipment used in the “Over-sized” embodiment (from FIG. 1E-oz). All sectioned surfaces shown with hatched lines were discussed above in the explanation for FIG. 1G.

FIG. 31 is a “schematic cross-section” view of Prior Art that shows “FIG. 5” from U.S. Pat. No. 3,496,871 (Stengel). This illustration shows a “straight, cylindrical magnet-object” inside a section of curved “tubing,” where such “tubing” is the housing component for a Closed Containment Loop System.

FIG. 32 is a “schematic cross-section” view of Prior Art that shows “FIG. 7” from U.S. Pat. No. 3,496,871 (Stengel). This illustration shows a “curved, cylindrical magnet-object” inside a section of curved “tubing,” where such “tubing” is the housing component for a Closed Containment Loop System.

FIG. 33 is a “cross-sectional view” of Prior Art view showing “FIG. 5” from U.S. Pat. No. 6,734,574 (Shin). This illustration shows inside of a “magnet-capsule.” This figure is included as part of explanation given above for Ten Numbered Points of Comparison, #10 about how, among other things, U.S. Pat. No. 6,734,574 is in violation of “Appendix R Patent Rules, §1.84 Standards for drawings, (p)(5),” with regards to component 420 in “FIG. 5” of Shin '574 patent.

FIG. 34a is front view of entire Fluid Reservoir 419 (in the Over-sized embodiment) and is part of a relational representation, along with FIG. 34b. FIG. 34a shows the original configuration and original size of the Fluid Reservoir. All sectioned surfaces shown with hatched lines in FIG. 34a were discussed above in the explanation for FIG. 1D-oz. There is a reference in FIG. 34a showing the original size of the Reservoir Exit Launching System 426.

FIG. 34b is a front view of the entire Fluid Reservoir 419, showing a “vertically expanded” size of: a) the Fluid Reservoir 419 and b) the Reservoir Exit Launching System 426. All sectioned surfaces shown with hatched lines in FIG. 34b were discussed above in the explanation for FIG. 1D-oz, except that the Two Vertical Walls of the Walls of the Fluid Reservoir 400 are much higher than the Two “Original” Vertical Reservoir Walls 400.

FIG. 35a is a front isometric view showing the entire Underwater Launch Area and also shows a connected section of the “tight” portion of the Fluid Column. FIG. 35a is only there to show the plane in which the section “cuts” for FIG. 35b and FIG. 35c are taken, in relationship to the complete Underwater Launch Area.

FIG. 35b is a front isometric view showing the relative size of the Underwater Launch Area (for the preferred embodiment), compared to the size of the “tight” area of the Fluid Column. Also, FIG. 35b is part of a relational representation, along with FIG. 35c. Due to space restrictions on drawing page, the top of the “tight” section of the Fluid Column is “broken off” and this “break” is shown with hatched lines on Three Walls 320W (from FIG. 1J). For the sake of clarity, the “Bounding Walls and Floor” of the Underwater Launch Area 310 have been “cut open” and the respective surfaces are shown with hatched lines.

FIG. 35c is a front isometric view showing an Enlarged Underwater Launch Area (for the Over-sized embodiment). FIG. 35c is a relational view in two ways, first within FIG. 35c, itself, the drawing compares the size of the Enlarged Underwater Launch Area 310 to the size of the “tight” area of the Fluid Column (in the Over-sized embodiment; the width and depth of the “tight” Fluid Column is the same as for the preferred embodiment, but in the Over-sized embodiment the height of the “tight” section of the Fluid Column is increased to at least 200 feet). Second, FIG. 35c compares the size of the Enlarged Underwater Launch Area to the size of the Underwater Launch Area in the preferred embodiment (in FIG. 35b). Due to space restrictions on drawing page, the top of the “tight” section of the Fluid Column is “broken off” and this “break” is shown with hatched lines on Three Walls 320W (from FIG. 1J). For the sake of clarity, the “Bounding Walls and Floor” of the Underwater Launch Area 310 have been “cut open” and the respective surfaces are shown with hatched lines.

FIG. 36a is a hybrid front view of a Downward-sloping 3-sided Modified Circular Guide Rail 464 (for the Over-sized embodiment). The Pivot Bucket portion of the drawing, including the long Vertical Structure Support Beams for the Pivot Bucket System, is shown with an isometric angle. The Floor of the Above Ground Pivot Bucket Area 254, the Above Ground Floor 61, and the Vertical Support Wall 467 have been “cut open” and the respective surfaces are shown with hatched lines. The Two Rear Vertical Support Beams of the Rear Top Angled Extension 255TAER have been “broken off” but are not shown with hatched lines.

FIG. 36b is a top view showing the very top section of the Downward-sloping 3-sided Modified Circular Guide Rail 464. This view shows that this final section of the Guide Rail for the eight canisters (that are at the top of the Guide Rail) curves back towards the center (of the circular shape) of the Guide Rail Pathway, so that the very top of the Guide Rail Pathway will be aligned with the point where the Pivot Bucket deposits a canister onto the Guide Rail Pathway after the Pivot Bucket is rotated.

FIG. 37a is a relational, isometric view showing the Four Individual Sections of the One Underwater Launch Platform that is shown in FIG. 37b. However, FIG. 37a shows these Four Sections after they have been “pushed together” and are basically forming One Unified Underwater Launch Platform. Each Individual Section is connected to a separate Linear Motor, and these Four Linear Motors move upward simultaneously and are used for an “Enhanced Underwater Launch” in the Over-sized embodiment. Due to space restrictions on the drawing page, all Four Quad Launch Platform Sections are “broken off,” but the “breaks” for Two Quad Launch Platform Sections, LPQ1 and LPQ2, are shown with hatched lines.

FIG. 37b is an isometric view showing Four Individual Sections of One Underwater Launch Platform (for the Quad LM Underwater Launch sub-embodiment, of the Over-sized embodiment). These Four Launch Platform Sections have been “pulled apart” from each other, and each individual section is represented to be at a 90 degree angle to the sections on either side of it. Due to space restrictions on drawing page, all Four Quad Launch Platform Sections are “broken off,” but the “breaks” for Two Quad Launch Platform Sections, LPQ1 and LPQ2, are shown with hatched lines.

FIG. 38 is an isometric front view of the Underwater Launch Area for the Over-sized embodiment. Shown are two of the Four Positioning Solenoids (and their related Interface Mounting Components) that connect a respective individual Section (of the Four Sections of the overall Quad LM Launch Platform) to a respective Linear Motor. The main purpose of FIG. 38 is to show how a Linear Motor is attached to each Section of the “Quad Launch Platform” and to give a broader perspective on how the overall “Quad Launching System” looks. Due to space restrictions on drawing page, the following components are “broken off”: Two Quad Launch Platform Sections, LPQ1 and LPQ3; Modified Vertical Structural Support Wall 2490z; Bottom Partition 230 (of the Fluid Column) on the far left and far right; Vertical Beam (of the Vertical Structural Support Beam System 248). All of these “breaks” are shown with hatched lines.

(FIGS. 39-41G all relate to the Dual Arc C Roller Sections sub-embodiment.)

FIG. 39 is an isometric front view showing six “snapshots” of different angles a canister has as it ascends up through the Right Arc C Roller Section 202 of the Dual Arc C Roller Sections sub-embodiment. Various Structural Beams, Cross-member Beams, and the Subterranean Floor are “broken off” and shown with hatched lines.

FIG. 40 is an enlarged isometric front view focusing on the Pullout Roller Section 350 that is situated in the Left Arc C Roller Section 201 of the Dual Arc C Roller Sections sub-embodiment. Arc C Roller Conveyor 121L, and one Structural Beam are “broken off” and shown with hatched lines. The Body 351B (of Retracting Solenoid 351), the Two “Legs” of Retracting Solenoid Harness Mount 351HM, and Rear Guide Rail 189RR are “broken off.”

FIG. 40-2a is an enlarged isometric side view showing the various internal components for one of the individual Housing-frames for one of the Roller Assemblies (the second from the bottom Roller Assembly) in the Pullout Roller Section 350. Connecting Rod 353a is “broken off” and shown with hatched lines.

FIG. 40-2b is an enlarged and exploded isometric side view showing the exact same components in FIG. 40-2a, except with the addition of: a Pair of “Phantom Puller Blocks” 356Ph; a Left and Right Housing Partition 364L and 364R; a Slide Support 365. Connecting Rod 353a, Left and Right “Phantom” Puller Blocks 356Ph, Left and Right Housing Partition (364L and 364R), and Slide Support 365 are “broken off” and shown with hatched lines.

FIG. 41A is an isometric front view and is the first drawing in a sequence of seven drawings (41A-41G) showing the progress of: a) a particular canister, and then b) in FIG. 41E showing a second canister as that canister enters the Left Arc C Roller Section 201. FIG. 41A shows the Pullout Roller Section 350 pushed in (to the front) and therefore the (partial) canister shown in FIG. 41A will be ascending up the Left Arc C Roller Section 201. Various Structural Beams, Cross-member Beams, Roller Conveyor 121L, and the Subterranean Floor are “broken off” and shown with hatched lines. Rear Guide Rail 189R and the left portion of an unreferenced canister are “broken off.”

FIG. 41B is an isometric front view of the Net-catch Canister Transport Area 366 showing the canister from FIG. 41A in the Net-catch Canister Transport Area 366; the Left-side Net-catch Area 396Ar is directly above the Left Arc C Roller Section 201. Also, an unreferenced canister is being elevated in a Pre-launch Process. The Four Vertical Beams in Beam Support System 367Set and the top portion of an unreferenced canister are “broken off” and shown with hatched lines.

FIG. 41B-2 is an isometric rear view showing the Left-side Linear Motor 391LM and how this Linear Motor 391LM it is “tucked inside” the Left-side Inner Housing 389L. The right side of Overall Housing Structure 388 is “broken off;” the left side of Overall Housing Structure 388 and the vertical beam of Left Upper-Lower Claw Positioner 390 are “broken off” and shown with hatched lines.

FIG. 41C is an isometric front view of the Net-catch Canister Transport Area 366 showing the canister from FIG. 41B after this canister has landed on the Left Transport Carriage 375. The Four Vertical Beams in Beam Support System 367Set are “broken off” and shown with hatched lines.

FIG. 41D is an isometric front view of the Net-catch Canister Transport Area 366 showing that the Left Transport Carriage has moved to the right and is making contact with the Pre-launch Launch Platform 398. The Four Vertical Beams in Beam Support System 367Set are “broken off” and shown with hatched lines.

FIG. 41E is an isometric front view showing the Pullout Roller Section 350 retracted and the “next” canister arriving in the Left Arc C Roller Section. However, this canister is passing through the Left Arc C Roller Section 201 and is heading into the Right Arc C Roller Section 202. Various Structural Beams, Cross-member Beams, Arc C Roller Conveyor 121L, and the Subterranean Floor are “broken off” and shown with hatched lines. Rear Guide Rails 189R and 189RR are “broken off.”

FIG. 41F is an isometric front view of the Net-catch Canister Transport Area 366. Both canisters are shown in this drawing. The original canister has been “transported” onto the Pre-launch Launch Platform. The second canister is entering the Net-catch Canister Transport Area 366 and will be ascending up into the Right-side Net-catch Area 397Ar. The Four Vertical Beams in Beam Support System 367Set are “broken off” and shown with hatched lines.

FIG. 41G is an isometric front view of the Net-catch Canister Transport Area 366, showing that the original canister and the Pre-launch Launch Platform 398 are both elevated as a result of the Pre-launch Process being in progress. Also shown is the second canister, which is up in the Catcher Net 397Nt in the Right-side Net-catch Area 397Ar. The Four Vertical Beams in Beam Support System 367Set and the top portion of an unreferenced canister are “broken off” and shown with hatched lines.

(FIGS. 42A-43B all relate to the Dual Floatation Holding Cues and Canister Sliding Transport sub-embodiment.)

FIG. 42A is an isometric front view showing the Curved-front Fluid Reservoir 498 and is the first drawing in a sequence of six drawings (42A-42F) showing the movement of canisters in various regions of the Dual Floatation Holding Cues and Canister Sliding Transport sub-embodiment. For FIG. 42A, FIG. 42B and FIG. 42C, the purpose of these three drawings is to show the “feeding” procedure regarding how canisters move from the Variable Pressure Chamber 414 up “through the Fluid” and end-up floating in one of the Floatation Holding Cues (Left or Right, 499L or 499R, respectively). Also, these three figures show the organizational methods and related equipment used to process canisters that are in the Two Floatation Holding Cues, 499L and 499R. The “middle/inner” portions of the Two Floatation Holding Cues are not shown (but are fully-shown in FIGS. 42D and 42E). Back Wall 508BckWL (for Fluid Reservoir), Spacer Partition-block 509, Left and Right Front Containment Blocks 506L and 506R, Left and Right Rear Containment Blocks 507L and 507R, Variable Pressure Chamber 414, Left Wall 508LWL (for Fluid Reservoir), and Subterranean Floor 411 (of the Over-sized embodiment) are “broken off” and shown with hatched lines.

FIG. 42B is an isometric front view of the Curved-front Fluid Reservoir 498 and is showing progress being made for canisters approaching, or inside, the Two Floatation Holding Cues and also showing operation of equipment in the Curved-front Fluid Reservoir 498 and in the Two Floatation Holding Cues, 499L and 499R. Back Wall 508BckWL (for Fluid Reservoir), Spacer Partition-block 509, Left and Right Front Containment Blocks 506L and 506R, Left and Right Rear Containment Blocks 507L and 507R, Variable Pressure Chamber 414, Left Wall 508LWL (for Fluid Reservoir), and Subterranean Floor 411 (of the Over-sized embodiment) are “broken off” and shown with hatched lines.

FIG. 42C is an isometric front view of the Curved-front Fluid Reservoir and is showing additional progress by the canisters and additional operation of equipment in the Curved-front Fluid Reservoir and the Two Floatation Holding Cues. Back Wall 508BckWL (for Fluid Reservoir), Spacer Partition-block 509, Left and Right Front Containment Blocks 506L and 506R, Left and Right Rear Containment Blocks 507L and 507R, Variable Pressure Chamber 414, Left Wall 508LWL (for Fluid Reservoir), and Subterranean Floor 411 (of the Over-sized embodiment) are “broken off” and shown with hatched lines.

FIG. 42D is an isometric front view of the Canister Elevation Areas (the “inner” portions) for each of the Floatation Holding Cues and also shows the Pre-launch Launch Platform Area (which is between the Two Floatation Holding Cues). Also shown are the Two respective Vertical Positioning Linear Motors, 525 and 529, which are situated directly below the Two Floatation Holding Cues. These Two Vertical Positioning Linear Motors, 525 and 529, are “inside the Fluid” (this condition of “being in the Fluid” is best shown in FIG. 43A). Two unreferenced canisters, and left and right Rear Mounting Blocks 525RM and 529RM are “broken off.” Left and Right Front Containment Blocks 506L and 506R, Left and Right Connecting Arm 516L and 516R, Front Stationary Alignment Block 511L, Launch Platform Interface 519-I, and Left and Right Front Mounting Blocks 525FM and 529FM are “broken off” and shown with hatched lines.

FIG. 42E is an isometric front view showing the same exact areas as FIG. 42D, but FIG. 42E is showing Canister C38 from FIG. 42D that has been elevated out of the Left Floatation Holding Cue 499L by the Left Vertical Positioning Linear Motor 525.). Two unreferenced canisters, and left and right Rear Mounting Blocks 525RM and 529RM are “broken off.” Left and Right Front Containment Blocks 506L and 506R, Left and Right Connecting Arm 516L and 516R, Front Stationary Alignment Block 511L, Launch Platform Interface 519-I, and Left and Right Front Mounting Blocks 525FM and 529FM are “broken off” and shown with hatched lines.

FIG. 42F is an isometric front view of a “sliding mechanism” that transports canisters, horizontally, from the left and right Floatation Holding Cues onto the Pre-launch Launch Platform 519. The Primary Support Beam, 535, in FIG. 42F, is shifted back and forth, horizontally, by a Horizontal Transport Linear Motor 539 (HTLM) shown in the lower middle portion of FIG. 42F. Right Front Containment Block 506R, and Right Rear Containment Block 507R are “broken off.” Left Front Containment Block 506L, Left Rear Containment Block 507L, Left and Right Support Walls 532L and 532R, Left and Right Front Stationary Alignment Blocks 511L and 511R, Left and Right Inner Moveable Alignment Block 512L and 512R, and one unreferenced canister are “broken off” and shown with hatched lines.

FIG. 42F-2 is an non-enlarged isometric front view that includes hidden lines of components situated directly below the Primary Support Beam, 535, and that are not shown (by hidden lines) in FIG. 42F.

FIG. 42F-3a is an enlarged and exploded isometric front view showing the Horizontal Transport Linear Motor 539, the Connecting Interface Block 535Int (of the Primary Support Beam), the Two Slide Rails (the Primary Support Beam 535 moves on horizontally), other components, and also showing the relationship of the Forcer 539Fcr (of HTLM 539) to Connecting Interface Block 535Int. Primary Support Beam 535, Rear Plank 534FrmRear and Front Plank 534FrmFrnt (both of Four-sided Support Frame 534Frm) are “broken off” and shown with hatched lines.

FIG. 43F-3b is a non-enlarged isometric front view which is almost identical to FIG. 42F-2, but which has a little more detail. This Figure is repeated on this drawing page to act as a reference for FIG. 43F-3c
FIG. 43F-3c is an exploded isometric front view showing the four primary components that are situated at the critical spot where the Primary Support Beam 535 meets with the Linear Motor 539.

FIG. 43F-3d is a front view of the four components in FIG. 43F-3c. The importance of FIG. 42F-3d is to show how (and where) the Forcer 539Fcr is attached to the Connecting Interface Block 535Int and how the Left Support Block 538L is there to also add essential support to the Primary Support Beam 535 (when the “Beam” is on the far left). There is also an identical Right Support Block 538R (shown in FIG. 43F-3a) that functions in the same way as the Left Support Block 538L, but that is on the far right side of HTLM 539.

FIG. 43A is a left side view of the entire Curved-front Fluid Reservoir 498 and is showing the spatial relationship between the main components in the Dual Floatation Holding Cues and Canister Sliding Transport sub-embodiment. FIG. 43A is showing the Notch Suspension Arm 542 in the retracted state and is also showing that Canister C53 (which is in the very front of the Pre-launch Launch Platform Area when looking from the left; Canister C53 can also be seen in FIG. 42A) is not elevated. However, the main purpose of FIG. 43A is to show how the “sliding components” (some of the main components shown in FIG. 42F) are all positioned on top of the flat portion of the Curved Front Wall 508CWL (of the Curved-front Fluid Reservoir 498). Back Wall 508BckWL (for Fluid Reservoir), Curved Front Wall 508CWL (for Fluid Reservoir), and Subterranean Floor 411 (of the Over-sized embodiment) are “broken off” and shown with hatched lines.

FIG. 43B is a side view of the same area as FIG. 43A but FIG. 43B is showing the canister from FIG. 42F (Canister C38) after this canister has been elevated by the Left Vertical Positioning Linear Motors 525. FIG. 43B is also showing the Notch Suspension Arm 542 and Two Electromagnet Grippers, 540EM and 541EM, engaged in the process of suspending this Canister C38 up high enough so the canister can be transported to the right (directly away from the viewer in FIG. 43B) and placed on top of the Pre-launch Launch Platform 519 (this Launch Platform is not shown in FIG. 43A or FIG. 43B). Back Wall 508BckWL (for Fluid Reservoir), Curved Front Wall 508CWL (for Fluid Reservoir), and Subterranean Floor 411 (of the Over-sized embodiment) are “broken off” and shown with hatched lines.

(FIGS. 44-46 all relate to the Above Ground Multi-Rail Curved Pathway sub-embodiment.)

FIG. 44 is a hybrid front view of the Above Ground Multi-Rail Curved Pathway sub-embodiment of the preferred embodiment, which also shows the Ceiling of the Fluid Column (254) in an isometric view. Since the part of the drawing that is showing the Curved Pathway (which has a total of three Guide Rails) is a “pure” front view, the third Guide Rail is not visible because that third Rail is directly behind the front most Guide Rail, which is the furthest left Rail coming out of the Splash Guard (253).

FIG. 45 is a left side view of the Above Ground Multi-Rail Curved Pathway sub-embodiment of the preferred embodiment. Even though this drawing might appear to be an error, because it looks so similar to the front view (FIG. 44), FIG. 45 is fairly accurate because the pathway is always curving in three directions at the same time (front-back; left-right; upwards).

FIG. 46 is a top view of the Above Ground Multi-Rail Curved Pathway sub-embodiment of the preferred embodiment, except that for the sake of clarity, the “middle” Guide Rail (which is the “top” Rail in FIG. 44 and FIG. 45) is not shown. The primary purpose of FIGS. 44-46 is to show the general shape of the Curved Pathway, and not to necessarily provide excessive details regarding individual components of this sub-embodiment.

(FIGS. 47-54 all relate to the Dual Pivot Bucket sub-embodiment.)

FIG. 47 is an isometric front view primarily showing the Right Ascent Pathway Conduit (601) and the relationship of that component to the Left Ascent Pathway Conduit (611) and also to the Top of the Fluid Column (320). FIG. 47 shows Canister C98 moving out of the Fluid Column and into the underside of the Right Ascent Pathway Conduit.

FIG. 48 is an isometric front view primarily showing the Left Ascent Pathway Conduit (611) and the relationship of that component to the Right Ascent Pathway Conduit (601) and also to the Top of the Fluid Column (320). FIG. 48 shows the “next” Canister (C99) about ready to move out of the Left Ascent Pathway Conduit as the Canister continues its journey upwards.

FIG. 49 is similar to FIG. 47 in that FIG. 49 primarily shows the Right Ascent Pathway Conduit (601), but instead of showing the components BELOW this Conduit, FIG. 49 shows the components ABOVE this Conduit. FIG. 49 also shows how Canister C98 is coming out of the Right Ascent Pathway Conduit and is about ready to enter into the bottom of Right Vertical Alignment Cone (605). [Note: FIGS. 47-49 are not in sequential order with regards to timing of canister movement, but instead show the spatial positioning of the components and do show how canisters move within those components. In actual operation of an MF Device, Canister C98 would be approximately five seconds “ahead” of Canister C99, which would put Canister C98 having been deposited onto the Inclined Canister Holder (66), as shown in FIG. 53, about the time Canister C99 was at the top of the Left Ascent Pathway Conduit, as shown in FIG. 48.]

FIG. 50 is a top view showing the Left and Right Ascent Pathway Conduits (and their attached Positioning Solenoids: 612 and 602, respectively) and also FIG. 50 specifically shows where one Conduit is positioned when the other Conduit is positioned directly over the Top of the Fluid Column (320).

FIG. 50-2 is exactly what is shown in FIG. 50, except all the components are rotated 90 degrees clockwise. The whole subject of “the need for this 90 degree rotation” is addressed in two places: a) in #35 of “Additional Drawing Exceptions and Comments,” and b) as an embedded explanation in the description of these components in the “Structural Composition of The MagnaFloat” Section.

A short explanation to be given here for this condition is that FIGS. 47-49 and FIG. 51 (which is a “zoomed-out” view of what is shown in FIGS. 47-49) all show a “Left and Right” Ascent Pathway Conduit configuration, but this was only done for the sake of visual clarity, because it is easier to show a Left and Right Ascent Pathway Conduit instead of a Front and Rear Pathway Conduit. (FIG. 50 also shows this “Left and Right” configuration, but FIG. 50 is merely a top view of the components shown in FIGS. 47-49, Before the 90 degree rotation.) In reality, the configuration for these Two Conduits is to have a Front and Rear Conduit, because these Two Conduits must be respectively aligned, vertically, directly underneath the Two individual Pivot Buckets, and these Pivot Buckets MUST be positioned in a Front and Rear configuration, in order to deposit the canisters to the left side of the Pivot Bucket area (as demonstrated in the combined drawings of FIG. 52 and FIG. 53).

FIG. 51 is a front isometric view (a “zoomed-out” view of what is shown in FIGS. 47-49) showing the entire Left and Right Pathway Conduit System Structures, and also shows the relationship of these System Structures to the Top of the Fluid Column (320) and to the Enlarged Uppermost Section of the Fluid Column (599). There is a “hidden line exception” explanation and also an “Additional Drawing Exceptions and Comments” (#35) for FIG. 51.

FIG. 52 is a front isometric view of the Pivot Bucket area, which shows both the Front and Rear Pivot Buckets (621 and 623, respectively) in their entirety, except that due to space restrictions on drawing page, the Front and Rear Vertical Structural Beam Systems for Both Pivot Buckets have been “broken off” and these “breaks” are shown with hatched lines.

FIG. 53 is a front isometric view that shows both Pivot Buckets having been rotated to their respective most downward point. In addition, the primary purpose of FIG. 53 is: a) to show the peripheral equipment related to Inclined Platform Sliding Canister Holder Section (625SLD), and b) to show the positioning relationship between this Sliding Canister Holder Section and: i) the Two Pivot Buckets and ii) the Inclined Canister Holder (66). Due to space restrictions on drawing page, the Inclined Canister Holder (66) and Canister C2-Cue (in the lower left of the drawing) have been “broken off” and these “breaks” are shown with hatched lines. (Please see Comment #37 in “Additional Drawing Exceptions and Comments” regarding the “hidden” canisters in each of the Two Pivot Buckets in FIG. 53.)

FIG. 54 is a hybrid Front view of the Inclined Platform Sliding Canister Holder Section (625SLD), which also shows all of the components from an elevated semi-top view. The primary purpose of FIG. 54 is to show how Deceleration EM 626 is embedded and “fitted into” a cut-away notch made in this Sliding Canister Holder Section. The importance of this design feature is to allow the canisters a seamless surface to slide over, going from sliding on the body of the Canister Holder Section, to moving inside a “coiled” EM, and then emerging out of this EM and back onto the body of the Canister Holder Section (on the left side of the EM), as the canisters, in general, pass down-and-along this Sliding Canister Holder Section (moving from right to left).

FIG. 55 is a front view that shows in the most detailed way possible, considering the scale of the drawing, the entire preferred embodiment of a MF device. According to Appendix R Patent Rules, §1.84 Standards for drawings, (j), Front page view, as the applicant I would like FIG. 55 to be included on the front page of the patent application publication and/or the patent.

### Hidden Line Exceptions.

In a few places in the drawings, it was beneficial to use hidden lines to show a piece of equipment that was IN FRONT of another component, in order for the more complex component (that was further back) to be shown in solid lines. The occurrences of such “Hidden Line Exceptions” are:

In FIG. 1D, the Front Arc B Conveyor Guide Rail 123F and the Front Arc B Conveyor Guide Rail Paired Mounts 123MF are shown in hidden lines so as not to conflict with showing the Rollers 122. Also, in all places in FIGS. 1D, 1E, 1F, and 1G (and for the Dual Arc C Roller Sections sub-embodiment, FIGS. 39, 40, 41A, and 41E), the front edge of the Roller Conveyor is shown in hidden lines, even though this Roller Conveyor (Frame) is in front of the Roller ends. In FIG. 1E, in the far upper right corner, the back edge of the Roller Conveyor Frame is shown in hidden lines. For the Dual Arc C Roller Sections sub-embodiment, FIGS. 39, 40, 41A, and 41E

Similarly, in FIG. 1F and FIG. 1G (and for the Dual Arc C Roller Sections sub-embodiment, FIGS. 39, 40, 41A, and 41E), the Front Arc C Conveyor Guide Rail 189F and the Front Arc B Conveyor Guide Rail Paired Mounts 189MF are shown in hidden lines so as not to conflict with showing the Rollers 122. For the Right Arc C Roller Section in FIGS. 39, 41A, and 41E the Front Guide Rail 189RF, which includes the paired mounts, is also shown in hidden lines even though these components are in front of other components.

In FIGS. 1C, 1I, 1J, and 1K, the front edge of all Quadrilateral Guide Assemblies is shown in hidden lines so as not to conflict with showing the Guides, themselves.

In FIG. 1E-2, the Outlet Pressure Hose 168 is in hidden lines, even though it is in front of the Inlet Connection 170 on Pressure Pump 171.

In FIG. 1H, the Top End-cap 222TR (for the 218R Right LM-2) is in hidden lines even though it is in front of other components, for the sake of being able to show the top ends of all the Vertical “Strips” within the Right Linear Motor, 218R, and also so the Two Horizontal Support Rods (for this Top End-cap 222TR) could be shown in solid lines.

In FIG. 1J, the front right outside corner of the related walls of the Fluid Column 320 is shown with a hidden line; this allows for the components behind these walls to be shown with solid lines.

In FIG. 1K, the Right Front Vertical Structural Beam 255R (for the Right Side of the Above-ground Coils and for the Pivot Bucket) is shown in hidden lines in order to better show the equipment behind it.

In FIG. 1L and FIG. 52, the lower portion of all the Pivot Buckets (including the parts of the Pivot Bucket which sit behind the Front Top Angled Extensions; for example the pairs of Two Lower Stop-pins 263L and 263R which are attached to the Pivot Buckets and which are behind 255TAEF in FIG. 1L) should be shown in hidden lines, but the primary focus of these particular drawings is on the Pivot Buckets more than on other components.

In FIG. 14, the Pivot Bucket 261 (with a canister 267 inside of this Pivot Bucket) is shown in hidden lines so that the Pivot Bucket Rotational Solenoid Body 266 can be better shown.

In FIG. 1N, the front portion of the Phantom Canister C267PH should be in solid lines, but this entire canister is a “phantom” because the “real” canister shown in the drawing is Canister C267.

In FIG. 1B-3, even though the three outer “circular surface-lines” of the Air Side Launch Area Bottommost Alignment Ring 104 would be visible as solid lines, these three circular lines are shown as phantom lines because the purpose of FIG. 1B-3 is to show the alignment of all the equipment in the Air Side Launch Area, and this Alignment Ring 104 is not really part of the Air Side Launch Area.

In FIG. 40-2b, for the sake of clarity a Roller Assembly Shaft 363 (that is one long continuous rod) is sometimes shown as a hidden line, even though this Shaft 363 is in front of other components.

In FIG. 44, the two canisters are not shown with any hidden lines portions, even though these canisters are partially behind the Rails that are shown.

In FIGS. 47-49, canisters are shown to be “inside of” (behind the walls of) various components, but these canisters are not shown with hidden lines in those places. Also, in FIG. 47 and FIG. 48 components inside the Fluid Column are shown as if the walls of the Fluid Column were invisible.

In FIG. 51, the bottom portions of the Right Ascent Pathway Conduit 601 and the Left Ascent Pathway Conduit 611 are shown without hidden lines and are in fact overlapping, as if both components could occupy the same space at the same time. This is only to illustrate that both components do end-up at the same place over the top of the Fluid Column 320, but in actual operation of a MF device for this Dual Pivot Bucket sub-embodiment, these Two Ascent Pathway Conduits are alternated on a Cycle by Cycle basis, and when one Conduit is over the Fluid Column, the other Conduit is pulled back and out of the way. Also, technically, everything except the Two Splash Guards (610 and 620) should be shown with hidden lines, because all components are “inside” the Enlarged Uppermost Section of the Fluid Column (599). However, this Uppermost Section of the Fluid Column is shown with thinner lines and the primary purpose of this drawing is to show all of these components as if the Walls of this Uppermost Section of the Fluid Column were invisible.

### OVERRIDING PRIORITIES

As a result of various interpretations and representations of angles of lines and relationships between pieces of equipment in the drawings, there are seven times when one Figure takes priority over another related Figure, in terms of being the “Best Representation” of the relational realities between pieces of equipment. These Overriding Priorities are:

1. FIG. 1B-3 takes priority over FIG. 1B, to show a more precise placement of equipment in the Air Side Launch Area 302.

2. Even though FIG. 15 is a simpler “graphical representation” of the various components, with regards to the Pre-launch Area and the Two Canisters in that Area, FIG. 15 takes priority over FIG. 1H. Specifically, FIG. 15 accurately shows the amount of distance that the lower portion of the Upper Canister extends down below the Two Notch Grips, 219F and 219R. Then also, FIG. 15 shows that there is a Full Canister Length of distance between the bottom surface of the Upper Canister [which is also the point where the upper surface (the Leading Surface) of the Lower Canister has joined that bottom surface of the Upper Canister, at a vertical height where those two long support rods are on either side of the “junction” of the Two Canisters] and the top edge of the Launch Platform Halves, 211L and 211R.

Obviously there has to be exactly (or at least) One Canister Length of distance (in the mid-portion of FIG. 1H) between the bottom surface of a suspended canister and the vertical location of the Launch Platform Halves (211L and 211R), if the Lower Canister is going to suspend the Upper Canister, as is described in the Pre-launch Process (see 13 Topics; #2, “Pre-launch Process”). However, in FIG. 1H, these simple facts are not shown because there was not enough height on the drawing page to raise the Two Notch Grip Systems as high as they should go. In fact, the vertical distance between the Upper Motion Sensor 217US and the Lower Motion Sensor 217LS should be about 57% of One Canister Length, and even though there is no canister shown in FIG. 1H, it is quite clear that the distance between these Two “217 Sensors” is definitely Not 57% of One Canister Length, even considering the point of view of the drawing is looking at a downward angle. Therefore, the description regarding the operation of the Sensor 217US and the Sensor 217LS references FIG. 15 in addition to referencing FIG. 1H.

FIG. 1H-4 does show a phantom canister C-101Ph being suspended by the Two Notch Grips, 219F and 219R, but FIG. 1H-4 basically has the same vertical limitations (because of the height of the drawing page) that FIG. 1H has. Also, for the sake of clarity, the two Sensors 217US and 217LS are not shown in FIG. 1H-4.

3. FIG. 21 takes priority over FIG. 1D-oz, with regards to how closely the Coils are positioned (vertically) next to each other in the Lowest Section of the Air Side Coil Stack 401. There are many Coils in FIG. 1D-oz that are not shown (around where the canister is) for the sake of clarity, but these Coils are shown in FIG. 21 because FIG. 21 is an enlargement of the area around where the canister is (falling) and therefore the “missing” Coils could be shown in a reasonable manner.

4. FIGS. 23a and 23b take priority over FIG. 1D-oz, with regards to the Outlet Port Valve 415; there was not enough room to show the graphic representation of this Valve in FIG. 1D-oz, but it is clearly shown in FIGS. 23a and 23b.

5. FIG. 25 takes priority over FIG. 1D-oz, to show there are Two High Pressure Nozzles that spray Fluid out onto the Fluid Turbine.

6. FIG. 30 takes priority over FIG. 27 because the Splash Guard 460 is not shown in FIG. 27 for the sake of clarity. This Splash Guard 460 is shown in its proper position in FIG. 30.

7. FIG. 37a takes priority over FIG. 37b, in terms of how the Four Sections of the Launch Platform align with each other and in terms of the angles that each of the Four individual Sections have, in relationship to each other.

8. FIG. 37a takes priority over FIG. 38 in terms of the shape of the Four Sections of the “Quad Launch Platform” and how these Four Sections mesh with each other when they are pushed together against each other. The main purpose of FIG. 38 is to show that there is a Linear Motor attached to each Section of the “Quad LM Launch Platform” and to give a broader perspective on how the overall “Quad Launching System” looks.

9. FIG. 40-2 takes priority over FIG. 40 in terms of clearly showing the inter-relationship between all of the individual components in a Housing-frame for any one of the Five Roller Assemblies in the Pullout Roller Section 350. (Because reference 353a is used in FIG. 40-2, this example is showing the Roller Assembly which is second from the bottom in FIG. 40.)

10. FIG. 41B-2 takes priority over FIG. 41B with regards to showing how the Left-side Linear Motor 391LM sits back inside (is tucked in under) the Left-side Inner Housing 389L. By example, 41B-2 is also showing how the other Two Linear Motors (in the Net-catch Canister Transport Area 366), the Right-side Linear Motor 393LM and the Middle Linear Motor 395LM, are also “tucked inside” their respective Inner Housings, 389R and 389Mdl. FIG. 41B does not show any of these Linear Motors because FIG. 41B is looking at these Three Inner Housing area(s) from the front and these Linear Motors can only be seen by looking forward from the rear.

11. FIG. 42D, FIG. 42E, and FIG. 42F take priority over FIG. 42A, FIG. 42B, and FIG. 42C in that FIGS. 42A-C do not show, at all, the components in the “inner areas” (“inner areas” are the opposite of the far left and far right portions) of the Two Floatation Holding Cues. Also, FIG. 42F takes priority over FIG. 42D and FIG. 42E, because FIG. 42D and FIG. 42E do not show, at all, any of the “slide-related” components that are shown in FIG. 42F; these slide-related components in 42F are in front of the components (towards the viewer) shown in FIG. 42D and FIG. 42E. However, FIG. 43A and FIG. 43B take priority over FIG. 42D, FIG. 42E, and FIG. 42F in terms of how and where ALL of the components in the Dual Floatation Holding Cues and Canister Sliding Transport sub-embodiment are located, with regards to each other.

12. FIG. 42F-2 takes priority over FIG. 42F related to the specific space directly below the Base of Primary Support Beam 535Bs. For the sake of clarity in FIG. 42F, the Left End Cap 539LECp and Forcer 539Fcr (for the Horizontal Transport Linear Motor 539) were not shown at all; they would have been shown completely with hidden lines. Even though FIG. 42F-2 is not enlarged, it is at least separated from other areas of the drawing. However, FIG. 42F-3a also takes priority over FIG. 42F related to the same physical area and basically for the same reason, but FIG. 42F-3a is a much more detailed drawing (than FIG. 42F) and shows these “hard to see” components directly under the Base of Primary Support Beam 535Bs in an exploded view.

13. The shape and overall configuration of the Pivot Bucket shown in FIG. 1L-2 takes priority over the Pivot Buckets shown in FIG. 1M, FIG. 1N, and FIG. 53. The purpose of showing the Pivot Buckets in FIGS. 1M, 1N, and 53 is to show how the Pivot Bucket is rotated and/or to show the relationship of those Pivot Buckets to other components, and not necessarily to show those Pivot Buckets in great detail. Also, for the sake of clarity, in FIG. 1L Pivot Bucket 261 was shown without Canister Ejection EM 276, so that other components behind Pivot Bucket 261 could be seen better. FIG. 1L-2 takes priority over FIG. 1L in that respect; Pivot bucket 261 in FIG. 1L should have Canister Ejection EM 276 going around the body of the Pivot Bucket.

14. FIG. 50-2 shows all the components in FIG. 50 rotated 90 degrees clockwise, and this configuration shown in FIG. 50-2 takes priority over what is shown in FIGS. 47-51.

15. FIG. 11 takes priority over how the Two Pre-launch Launch Platform Halves (211L and 211R) are shown in FIG. 1H and FIG. 1H-4, with special focus on the positioning and size relationship of Left and Right Suspension Support Plunger-rods (227LP and 227 RP, respectively, shown as: 227LP-Ph and 227RP-Ph in FIG. 11), relative to each of the respective Pre-launch Launch Platform Halves.

### Additional Drawing Exceptions and Comments.

1. FIG. 1F and FIG. 1G are at a different scale than FIG. 1D. The reason for this is that the total horizontal width of the overall MF device, by combining the horizontal widths of FIGS. 1D-1G (using the length of a canister in each individual drawing is the only way to approximate the relative “width” of that particular drawing compared to the other drawings) should approximately equal the overall horizontal width by combining FIG. 1A and FIG. 1L, when an overall width for the device (at the top of the device) is determined by going from the far left edge of the furthest left piece of equipment in FIG. 1A (which is best shown in FIG. 1A-2, and which is either one of the Curved Arc A Pathway Guides, 67F or 67R) over to the far right edge of either one of the Two (Front or Rear) Vertical Structural Beams 255R (for the Right Side of the Above-ground Coils and for the Pivot Bucket). In other words, to truly represent the physical nature of the device, the horizontal distance at the top of the device must equal the horizontal distance at the bottom of the device.

2. In FIG. 1I, the drawing shows that the Pair of the Floatation Point Retaining Pins (245L and 245R) AND the Underwater Launch Platform 233 are fully extended into the Vertical Floatation Pathway that a canister moves through. In actual operation of the device, this would only happen if a canister was positioned in between these pieces of equipment (between “the Pins” and the Launch Platform, just a split second prior to an Underwater Launch). Most of the time when the Two Retaining Pins, 245L and 245R, are extended (to block a canister from “floating out of” the Underwater Launch Area), the Underwater Launch Platform is retracted and out of the way of a Canister's vertical path.

For the sake of a better illustration, however, FIG. 1I does show these Three pieces of equipment fully extended with no canister in the Underwater Launch Area between them. There is a different situation in FIG. 1B, because that drawing shows a “phantom canister,” PhC, which is below the extended Air Side Launch Platform 93. Technically in FIG. 1B, the Leading Surface of this “phantom canister” should be resting on the top of the Two Spring Systems, 102SpF and 102SpR, but for the sake of making a better illustration, the Leading Surface of the canister in FIG. 1B is positioned slightly above the Two Spring Matrices.

3. In the same way as just described in #2 above, in FIG. 1H the drawing shows that both halves (211L and 211R) of the Launch Platform are “closed together” to form the complete Launch Platform. This would not happen without a canister being above these Two Platform Halves (and with the canister either “resting” on the tops of the Springs of these Two Platform Halves or in the process of falling back onto these Springs from above the Springs), as described in the explanation of the Coupling Process (see 13 Topics; #1, “Coupling Process”). For the sake of a better illustration, however, FIG. 1H does show both halves of the Pre-launch Launch Platform fully extended and making contact with each other, even though there is no canister in the Pre-launch Launch Area.

4. In FIG. 1I, even though the drawing shows an environment where all the equipment is surrounded by Fluid, and where all the equipment is totally within the walls of the Fluid Column, the walls of the Fluid Column are not shown due to lack of space on the drawing page.

5. The upper portion of FIG. 1G shows some “broken sections” of the Left-side Support Beams 299L coming down from the next diagram (FIG. 1H). However, these Beams are not shown in FIG. 1H, because there is no room for these Beams in FIG. 1H. But FIG. 1H does show the Right-side Support Beams 299R, and these Right-side Beams are a mirror image of the Left-side Beams. Therefore, even though there was no room to show these Left-side Support Beams 299L in FIG. 1H, FIG. 1G DOES SHOW where these Beams 299L would have extended down into the Arc C Area (shown in FIG. 1G).

Also, in FIG. 1H there are Two Vertical Support Beams as part of the Support Structure 213R (for Two Cylindrical Rods that support the Right Solenoid Interface) and these Two Vertical Beams (part of the 213R Support System) would have extend down (into FIG. 1G) and also all of the Right-side Pre-launch Positioning Solenoid Mounting System 216MR would have extended down into FIG. 1G, but there was not enough room on the right side of FIG. 1G to show these components. The same explanation applies for FIG. 1E-oz.

6. This is a general comment about some particular Alignment Rings in relationship to the Roller Conveyor 121. Every Alignment Ring that is mounted above the Roller Conveyor (shown in FIGS. 1D-1G) should actually be “sitting down” slightly, into the Roller Conveyor; that is, the lowest point of the “inner air space” inside an Alignment Ring (best shown in FIG. 8a) should be vertically positioned just slightly (about one millimeter) below the top surface of any of the Rollers 122. The purpose of any Alignment Ring in the Horizontal Bottom Portion of the overall MF device (shown in FIGS. 1D-1G) is Not to tweak the up and down motion of a traveling canister, but to only tweak the horizontal (left and right) motion of a traveling canister.

7. Also in FIGS. 7a and 7b, there are two sizes of canisters shown because of the lack of space on the drawing page to show the overall Arc B Area. The spatial problem with the relationship between the Roller Conveyor and the Three Alignment Rings in FIG. 1D is that the width of the Roller Conveyor does not properly match the height of these Alignment Rings. The three (connected) Alignment Rings (127, 128, and 129) were made smaller than they should be, so that a canister with the proper diameter that would fit snugly inside the Rings (which is a canister having the smaller diameter as shown in FIG. 7a) would also be exactly straight, horizontally, (its Back-end, its Left-side end would not still be elevated in the curved part of the Roller Conveyor on the far left) before entering the first Alignment Ring 127. This is shown in FIG. 1D, where a “phantom canister” PhC-3 is on the verge of entering Alignment Ring 127, and the entire body of the canister is straight, in the horizontal plane. The diameter of PhC-3 is the same diameter as the canister in FIG. 7a.

If larger, full-sized Alignment Rings that properly matched the proportion of the Roller Conveyor were shown, so that the larger canister in FIG. 7b would “snugly” fit inside the Rings, then those Rings would need to be placed much farther to the right (outside the drawing space) to allow for the longer body of the larger canister to be fully-straight on the Roller Conveyor before making contact with Alignment Ring 127. The tolerance (maximum air gap) between the inner diameter of an Alignment Ring and the outer diameter of a Canister is very small, and especially if more than one Alignment Ring is in proximity to another Ring, so a Canister has to be “almost perfectly straight,” anyway, before entering the first Alignment Ring situated on the left side of the Three “Connected” Alignment Rings.

However, if one visualizes the smaller canister (PhC-Sm in FIG. 7a) coming down and entering the Rings shown in FIG. 1D, that is fine for the Rings (as shown with canister PhC-3) but then the “width-gap” between the diameter of the Outside of the canister body and the Separation Between the Two Arc B Conveyor Rail Guides (123F and 123R) is very wrong. There will be far too much space between the body of a Smaller Canister (PhC-Sm in FIG. 7a) and the Two Guide Rails, 123F and 123R. Put another way, the size (diameter) of the canister PhC-Lg (in FIG. 7b) is the proper proportion for the Roller Conveyor and for the horizontal gap between the Two Arc B Conveyor Rail Guides 123F and 123R.

The tolerance (air gap) between a Canister's outer body surface and the inner edges of the Two Guides Rails (that is, the horizontal distance between the inside of the Two Guide Rails) is also rather small, a few millimeters, or so. Therefore, for the situation regarding how a canister would move along, and be guided by the Two Guide Rails, the larger canister body-width of PhC-Lg, as shown in FIG. 7b, should be used in order to properly visualize and understand this “Guide Rail Guidance and Alignment Process.”

8. It is typical that in all of the solenoids shown in isometric views, where the solenoid bodies are facing away from the viewer, the solenoids are in the Fully Extended Position. Consequently, in some of these Figures there are Three hidden line circles in the Bodies of the Solenoids. For example, in FIG. 1A-2, for the Front Drop Point Retaining Pin 81F the two uppermost hidden line circles show the “end portion” of the actual physical plunger of the solenoid that extends into the body of the solenoid, and then the Third Hidden Line Circle (the one closest to the viewer) and the two extended lines connecting the second circle with the third circle, represent the “hollowed-out” area inside the body of the solenoid that the plunger will move “further back” into, when the solenoid is in the Retracted State.

9. For all of these Linear Motors (there are Four used altogether in the preferred embodiment of the MF device), the Mounting Interface (what holds a Linear Motor up) wraps around the outer edges of the Two Outer Vertical “Strips” of the Linear Motor (for example, the vertical “Strip” of the actual Motor that is closest to the viewer in the Right Linear Motor 218R in FIG. 1H). More specifically, there is one definite spot in this drawing where the Right Pre-launch Solenoid Interface 215R that connects the Right LM-2 218R to the Plunger 216PR (for the Right-side Pre-launch Positioning Solenoid) is almost touching the Forcer 212R (for the Right LM-2). Even though these two pieces, 215R and 212R are almost touching in FIG. 1H, in reality there is another part of the Solenoid Interface 215R that “warps around,” at least a little bit, and “grabs onto” that vertical “Strip” (the one closest to the viewer) of the Linear Motor, itself, and this “grabbing” secures the Motor to the Solenoid Interface 215R in a much better manner than what is shown in the drawings.

10. In FIG. 1D-oz, because of space constraints to show the entire Fluid Reservoir 419, the curvature of the Curved Interface Pathway Section 424 is actually “too tight,” in that a canister could not “make the turn upward” in such a small radius. The curvature of the Curved Interface Pathway Section 424 should be more “flattened out” in order for a canister to be able to attain True Vertical Alignment before entering the Lower Truncated Vertical Quad Alignment Rail Assembly 450a. For this curvature of the Curved Interface Pathway Section 424 to be totally correct, the entire Reservoir Exit Launching System 426 would have been positioned more to the right and up higher in FIG. 1D-oz, but there wasn't room for that on the drawing page.

11. In FIG. 27, which has a separated and “broken” view of two vertical sections of the overall Reservoir Exit Launching System, due to lack of space, there are some Speed and Motion Sensors and Additional Pairs of Full-size Reservoir Exit Acceleration Electromagnets (identical to 457aR) not shown. In actual operation, many more of these components (the Acceleration EMs and related Mounting Systems) will be located at various places along the path a canister takes, as it moves up through the Reservoir Exit Launching System 426 towards the Exit Opening 459 at the top of the Fluid Reservoir 419.

12. FIG. 1A shows nine canisters in the cue on the Inclined Platform (so the entire MF device according to that illustration uses a Canister Set of 11 canisters). However, the “Sequence of Canister Movement” Diagrams, FIGS. 15-20 use a Canister Set of 12 canisters and show an embodiment of the device that has 10 canisters at start-up on the Inclined Platform. Since the actual length of the Inclined Platform is a function of the total width of the MF device at the bottom (as shown in the combined, left-to-right horizontal distance of: FIGS. 1D-1G) there is always a possible variation in the width of the Inclined Platform (and therefore a variation in the total number of canisters used in the device), depending on exactly how “wide” the bottom horizontal part of the device is. Also, the exact number of canisters that can fit onto the Inclined Platform is a function of how high a canister “flies into the air.”

If a canister “flies higher” in a certain embodiment, then the angle of incline of the Inclined Platform will be greater and this can lead to one extra canister fitting into the cue on the Inclined Platform. In addition, FIG. 1A shows a “phantom” Pivot Bucket 261, in the process of “ejecting” a canister out onto the Inclined Platform. Of course this process would never occur unless there was a “vacancy” of at least One Canister Length in the top upper right position of the Inclined Platform. This “phantom” Pivot Bucket in FIG. 1A is there to illustrate the spatial relationship between where the Pivot Bucket 261 is and where the Inclined Platform 59 is.

13. In FIG. 1B, the pairs of Stand-alone Canister Guides (for example, 100F and 100R) are shown Not to be positioned directly over the Two Funnel-tray Solenoids 103F and 103R, but instead are rotated approximately 15 degrees off of the center of the Two Funnel-tray Solenoids. This is also confirmed in FIG. 1B-3. For the sake of these drawings, it was easier to show everything this way. In reality, the Two Pairs of Stand-alone Canister Guides could definitely be positioned directly over the top of the Two Funnel-tray Solenoids 103F and 103R.

14. Also in FIG. 1B, the Air Side Launch Area Bottommost Alignment Ring 104 would be much closer (higher up towards) the bottom of the Two Final Release Funnel-trays, 102F and 102R, but because of the placement of the front Funnel-tray Solenoid 103F in the drawing, and the angle at which this component was shown in the drawing, the Alignment Ring 104 is shown down further on the vertical axis than it should be.

15. In FIG. 1E, there is no Rear Retracting Solenoid shown, due to lack of vertical space on the drawing page. Also in FIG. 1E, the rear part of the Roller Conveyor (frame) is only partially shown, (just shown in some short hidden lines on the far right); this frame was not shown throughout the majority of FIG. 1E to avoid conflicting with the bodies of the Two Slowdown Plungers.

16. Even though in “Appendix R Patent Rules, §1.84 Standards for drawings, (h)(2), Partial Views“it is stated that” . . . no partial view contains parts of another partial view,” I have to ask for an exception to that Rule for the transition between FIG. 1J and FIG. 1K. The Ceiling of the Fluid Column 254 is the Floor of the Above Ground Pivot Bucket Area. In addition, there is a Splash Guard 253 that is mounted over the “Exit Hole” in that Ceiling 254. These Two Components definitely need to be shown in FIG. 1J to complete the illustration of the Fluid Column.

However, in FIG. 1K this Ceiling-Floor also definitely needs to be shown because there are Four Vertical Support Beams that MUST be “standing” on something; these Beams cannot just be “floating in the air.” Therefore, the top of the Ceiling 254 is shown in FIG. 1K (with the same Splash Guard 253 attached to it), but in this FIG. 1K, the top part of this (Fluid Column) Ceiling 254 is actually the (Above Ground) Floor 254. There were a few other places where equipment from a “connected” drawing was shown with “phantom lines” and in all of these instances, it was necessary to at least represent the “illusion” of where that equipment was placed, mostly for the sake of illustrating proper vertical alignment between related components on the overall device.

17. With regards to the canister inside the Pivot Bucket in FIG. 1L, what is shown is a canister that has just entered the Pivot Bucket and is making contact with the Upper Pivot Bucket Stop-pins, 264L and 264R. FIG. 1L-2 shows the canister after it has fallen back down onto the Two Lower Stop-pins, 263L and 263R; FIG. 1L-2 shows the Equilibrium State of a canister, when it is motionless and is waiting for the Pivot Bucket to be rotated so the canister can be “ejected” onto the Inclined Platform (as is illustrated in FIG. 19).

18. In FIG. 13, the distance between these Two Walls 261W should obviously be greater than what is shown, and in fact the distance between the Two Walls 261W should be the same as the outside diameter of the Pivot Bucket 261. Also, use of the terms “Front” and “Rear” in the referencing of components in FIG. 13 is accurate because every component in FIG. 13 has been rotated 90 degrees in the horizontal plane, for the sake of illustration purposes.

19. In FIG. 36a, all of the Above Ground Coils, Alignment Rings and the Pivot Bucket Entry; Speed-adjusting Electromagnet (EM#3) 260 (not referenced in FIG. 36a) should all be “further back” (away from the viewer) and should be positioned equally between the FOUR Vertical Beams, as shown in FIG. 1L. In FIG. 36a, all of these components appear to be centered between the Two Front Vertical Beams and Not centered equally between all Four Vertical Beams. Also, the Top Two Components (just below the Pivot Bucket), the Alignment Ring 259 and EM#3 260, should be “behind” the Front Right Vertical Beam and should be shown with hidden lines (for those parts of these two components that are positioned behind that Front Right Beam).

20. In FIG. 1I, the height of the vertical movement of Forcer 234 for LM-3 236 is shown to be about two-thirds the length of a canister (which can be computed by using the diameter of “phantom canister” PhC-Uw as a way to find the scale of the drawing in relationship to the length of a canister; the length of a canister is about 3.14 times the canister's diameter in any of the embodiments presented). However, as described in great detail below in 13 Topics; #5, “The Over-sized embodiment,” where towards the end of the Section there is a discussion about: The Enlarged Underwater Launch Area sub-embodiment, and as can be seen in FIG. 35b, since the surface area of the “tight” portion of the Fluid Column is so much small than the surface area of the Underwater Launch Area, this creates a sizeable difference in Fluid Pressure between the pressure in the Underwater Launch Area and the pressure in the Lower Part of the “tight” portion of the Fluid Column.

So when an Underwater Launch is in progress, a canister is “pushed up” one full canister-length of distance into Fluid, where there is about 20 times MORE pressure in the Fluid the canister is going INTO than the pressure in the Fluid the canister is coming FROM. This is true for the preferred embodiment and also remains true for the Over-sized embodiment because of an adjustment in the Surface Area of the Underwater Launch Area (shown in FIG. 35c). The point is, in FIG. 1I, it is quite possible the height of LM-3 236 may actually be much greater than two-thirds the length of a canister. Or another alternative is for more than one Linear Motor to be used for the Underwater Launch (as shown in FIG. 38), which would allow the “distance of acceleration” to be kept shorter if Two Linear Motors were used, etc. In any event, what absolutely MUST happen is that a canister being launched must attain enough velocity (upward kinetic energy) so that the entire body of the canister makes its way up inside the “tight” portion of the Fluid Column, even though this process will be “fighting all the way” against the substantially-increased Fluid Pressure just mentioned. There is no problem for the Underwater Launch to be successful but the actual “distance of acceleration” by LM-3 236 may need to be longer than the height shown in FIG. 1I so that the required “release velocity” (kinetic energy) can be acquired by the canister before the Underwater Launch finishes.

21. In FIGS. 1D-1G and in any other Figures where any Rollers 122 are shown, for the sake of clarity in the drawings, ample space has been given between the individual Rollers 122 so the Rollers could be clearly shown. In the actual construction of a MF device, many more Rollers are placed in the same “pathway space” so that each individual Roller will actually be almost touching the Two Rollers adjacent to that particular Roller, except of course for the end Roller on the far left and the end Roller on the far right. This condition of “adding more Rollers” than what is shown in the drawings also applies to any Rollers 122R in the Right Arc C Roller Section of the Dual Arc C Roller Sections sub-embodiment.

22. In FIG. 1E-oz, for all of the canisters moving along the Circular Upward-Sloping Canister Pathway 420, it is not shown in this drawing but there be some amount of separation, from one canister to the next because of the Nose Cone Protrusions 70 and Matching Carved-Out Impressions 71 engaging with each other.

23. FIG. 39 shows six “snapshot” positions of a canister as it ascends up through the Right Arc C Roller Section 202 of the Dual Arc C Roller Sections sub-embodiment. These six positions are represented by using alternate line styles; Positions 1, 3, and 5 use solid lines and Positions 2, 4, and 6 use hidden lines. The bottom surfaces, Nose Cone Protrusions 70, and Matching Carved-out Impressions 71 are not shown on any of the canister snapshots. Also, in FIG. 39, FIG. 41A and FIG. 41E, there are no components shown such as: 213L and 216ML, as there is in FIG. 1G. This is because in the Dual Arc C Roller Sections sub-embodiment, these components do not exist because the configuration of the Pre-launch Area 308 (what is shown in FIG. 1H for the preferred embodiment) is completely different.

24. In FIG. 40, the Pullout Roller Section 350 is not accurately shown. Because of the angle of the drawing and the curvature of the Roller Conveyor 120, the individual Roller Assemblies are shown to Not be the same distance (from Retracting Solenoid 351, for example) in the “front to rear” plane. In other words, the back surfaces for each of the individual Push Blocks 354 (shown and referenced in FIG. 40-2) should all be the same distance from the front surface of the Back Wall of Puller Frame 352Bk (in FIG. 40). Each Roller Assembly should have a Connecting Rod (like 353a in FIG. 40) that is the same length as the other Four Connecting Rods. This also means that even though the first Roller Assembly (the bottom left Roller Assembly) is shown without a Connecting Rod, in fact this Roller Assembly should have a Connecting Rod of equal length to the other Four Connecting Rods.

Also, for the sake of clarity, the Five Front Beveled Blocks (362 in FIG. 40-2) are shown larger (in FIG. 40) than they are and each one is rotated at a different angle, to coincide with the curvature of the overall Roller Conveyor 121, where the Threaded Front End 363Thrd of each Roller Assembly Shaft 363 (and the corresponding Front Beveled Block) would be engaging into the front portion of the Roller Conveyor Frame. It should be understood that ALL of the Front Beveled Blocks merely fit into the front section of the Roller Conveyor Frame by a pressure fit; there is No permanent attachment of a Front Beveled Block to the front section of the Roller Conveyor Frame. The whole idea of the Pullout Roller Section 350 is that the entire Section moves freely forward and backward, about once every five seconds, over and over. That is, the Pullout Roller Section 350 is pulled to the back, five seconds later it is pushed to the front, five seconds later it is pulled to the back, etc. Therefore, even though all the individual Rollers (and their related Front Beveled Blocks) “pull back” (withdraw) from the front section of the Roller Conveyor Frame at a ninety degree angle (moving directly back from the Roller Conveyor), it does not matter at what particular angle in the vertical plane any one or all of the individual Front Beveled Blocks are rotated.

The only thing that does matter in this regard is that the angle of rotation of each individual Front Beveled Block (like Front Beveled Block 362 in FIG. 40-2) exactly matches the “angle of the carved beveled impression” in the front section of the Roller Conveyor Frame for that particular Front Beveled Block—and that these angles never change. Under these conditions just described, each and every time the Pullout Roller Section 350 moves forward (from the “retracted state”) the individual Front Beveled Blocks will ALL move forward towards, and seat perfectly in, the individual carved beveled impression, regardless of what particular angle each “matching pair” of [Front Beveled Block AND Respective Carved Beveled Impression] has permanently been fixed at. The Pullout Roller Section pulls all Five Roller Assemblies out as a complete unit, but how each individual Roller Assembly uniquely seats in the front is an individual matter for each particular Roller Assembly and the area of the Conveyor Housing its Front Beveled Block seats into. Also, see a “Roller Conveyor Construction Note” in the Structural Composition Section, near the beginning of the Dual Arc C Roller Section sub-embodiment, about how the Rear Beveled Blocks seat into the Rear Section of the overall Conveyor Frame and about the general method of construction required to assemble the overall Conveyor Frame, with respect to the size of the holes required in the Rear Section of the Conveyor Frame.

25. In FIGS. 41-A and 41-E, for the sake of clarity, the far left edge of the Right Arc C Roller Section 202 has been made to be a little farther to the right than it should be, so that edge could be seen better. The Right Arc C Roller Section 202 should “come in further” under the Left Arc C Roller Section 201, because as shown in FIG. 41E, a canister coming through the Left Section and moving into the Right Section cannot encounter a “gap” in the Roller Conveyor where there are no Rollers. The furthest left Roller (in the Roller Set 122R) in the Right Arc C Roller Section 202 should be just about one or two inches to the right of the furthest left Roller (the first, bottommost Roller) in the Pullout Roller Section 350. There is no problem with having this rather small clearance space, because the Pullout Roller Section pulls straight back to the rear.

26. FIG. 41B shows the status of the overall Net-catch Canister Transport System at a point when the “active canister” is at the top of the Left-side Catcher Net 396Nt. There is no drawing showing the canister that is “in the net” in FIG. 41B coming up through Alignment Ring 371 and moving up through the left side of the Net-catch Canister Transport Area 366. However, during such a period of time, the Left Transport Carriage 375 is positioned over to the far left, next to the Left-side Vertical Support Beam 369L (as shown in FIG. 41G).

Also, due to available vertical space on the drawing page in FIG. 41B, the “top surfaces” of all Three Inner Housing components (389L, 389R, and 389Mdl) are not as wide (not as high in the drawing) as they should be. FIG. 41B-2 does a better job showing that these Three Inner Housing components need to be wider because there is a Linear Motor sitting down underneath each one of these individual Inner Housing components.

27. FIG. 41B-2 does not show Forcer 391Fc “tucked-into” any permanent “beam-strip” of Left-side Linear Motor 391LM, and obviously even though a Forcer slides along the “Strips” of a Linear Motor, the Forcer is still somehow “tucked inside” the Linear Motor so the Forcer doesn't just fall off of, or fall away from the Linear Motor. Also in FIG. 41B-2, the right end-cap (in behind Forcer 391Fc) is not shown or referenced.

28. In FIG. 42D, it appears as though the Pre-launch Launch Platform 519 is rotated counterclockwise at a small angle, relative to the other components around it. This illusion should be ignored, because the main flat surface (the top surface of this Launch Platform) should definitely be at exactly the same (flat) angle as the top (flat) surfaces of the main components in both the Left and Right Floatation Holding Cues (such as Front Containment Block 506L, Rear Containment Block 507L, and Right Containment Block 517L).

29. In FIG. 42F the Pre-launch Launch Platform 519 is shown higher than it should be so as not to conflict with some of the other components that are shown in the area where this Pre-launch Launch Platform 519 should be. It can be seen in FIG. 42F that the far right top edge of the Launch Platform 519 is almost touching the far left edge of the Left Containment Block 517R. As mentioned in the latter portion of “13 Topics; #7, Dual Floatation Holding Cues sub-embodiment,” the Pre-launch Launch Platform 519 “sits down in” the cavity between the Two Floatation Holding Cues (499L and 499R). This vertical relationship between these components can be better seen in FIGS. 42D and 42E.

30. Also in FIG. 42F, it is not shown accurately how there should be no “distance of separation” between the respective outer partitions (Front Partition 539FPrt and Rear Partition 539RPrt) of the Horizontal Transport Linear Motor 539 and the two respective components of the Four-sided Support Frame 534Frm. FIG. 42F shows fairly accurately that Front Partition 539FPrt (referenced in FIG. 42F-3a) is “just about touching” Front Plank 534FrmFrnt (referenced in FIG. 42F). However, FIG. 42F inaccurately shows a “separation distance” between Rear Partition 539RPrt and Rear Plank 534FrmRear (both of these components referenced in FIG. 42F-3a).

31. In FIG. 43A and FIG. 43B, the Launch Platform Interface 519-I is “broken off.” The very short vertical hidden line to the left of the Launch Platform Interface 519-I represents where the Forcer of the Pre-launch Linear Motor 531 meets the Launch Platform Interface 519-I.

32. The number of “Circular Windings” on Canister Ejection EM 276 changes somewhat from FIG. 1L-2, FIG. 1M, FIG. 1N, and FIG. 53. The actual number of Windings used in a MF device for Canister Ejection EM 276 will be the number of Windings necessary to create substantial initial movement as a canister is being “pushed” out of Pivot Bucket 261 by Canister Ejection EM 276. In FIG. 1L-2, for example, a minimum number of Windings are shown so as not to “cover up” the Pivot Point Swivel Area (the circle with the inner circle, just below the lowest “Winding” shown in the drawing).

33. Rear Pivot Bucket Assembly 623 (in FIG. 52; used in the Dual Pivot Bucket sub-embodiment of the preferred embodiment) has exactly the same components and works in exactly the same way as Pivot Bucket 261 from the preferred embodiment (shown in FIGS. 1L, 1L-2, and 1M), except that Rear Pivot Bucket Assembly 623 is moved to the rear a specific amount, since this Assembly 623 is used in a system that has a Front and Rear Pivot Bucket Assembly (as seen in FIG. 53).

34. In FIG. 45, the top-left area of the drawing (inside the two circles) has been slightly modified from a “pure” left side view to show the upper “tip” of the third Guide Rail, that is hidden behind the “front” Rail in the majority of the drawing.

35. FIG. 50-2 shows all the components in FIG. 50 (the entire Ascent Pathway Conduit System for the Two Paths) rotated 90 degrees clockwise, and the components shown in FIG. 50 are essentially all of the components shown in FIGS. 47-49 and FIG. 51 (which is a “zoomed-out” view of what is shown in FIGS. 47-49). Therefore, in FIG. 50 what is shown is a “Left and Right” Ascent Pathway Conduit configuration for these components. Showing these components in a “Left and Right” configuration is the easiest way to show these components clearly, but the aforementioned drawings are inaccurate by an amount of 90 degrees (rotating clockwise). In the actual MF Device, these “Left and Right” Pathway Conduits are in fact “Front and Rear” Pathway Conduits. The need for this “Front and Rear” configuration is easy to understand, because as shown in FIG. 52, the Two Pivot Buckets are in a Front and Rear configuration, and the obvious goal of each Pathway Conduit System is to “feed” a vertically aligned canister directly up into the respective Pivot Bucket and where each Pivot Bucket is positioned directly above: a) the respective Vertical Alignment Cone (605 and 615) and b) the respective Ascent Pathway Splash Guard (610 and 620).

The need for this “Front and Rear” configuration is obvious when looking at FIG. 53, because for each individual Pivot Bucket, a canister coming out of a Pivot Bucket must be deposited TO THE LEFT of the Pivot Bucket, and onto the Inclined Canister Holder (66), which is on the Left Side of the overall Pivot Bucket area. For a “Left and Right” configuration of the Pivot Buckets, this result would not be possible because the Right Pivot Bucket would be depositing the canisters “into” the Left Pivot Bucket instead of onto the Inclined Platform Sliding Canister Holder Section (625SLD), as shown in FIG. 53.

36. In FIG. 52, for the sake of illustration, a “hidden” canister is shown in each of the Pivot Buckets; in actual operation of a MF Device this condition would never occur because the movement of the canisters, relative to each other, is always “staggered” by five seconds.

37. In FIG. 53, the “hidden” canisters in each of the Pivot Buckets is strictly for demonstration purposes. In fact, at a point when a canister (like Canister C98 in the drawing) is about ready to make contact with the Front and Rear Contact Pads (629CP and 630CP, respectively), No Pivot Buckets would be in their most downwardly rotated position. At this point related to Canister C98 in the drawing, one Pivot Bucket would be in a totally vertical position ready to accept the “next” canister and the other Pivot Bucket (the Pivot Bucket that had just deposited the canister, like Canister C98 in the drawing) would be in the process of being rotated back into the default “straight-up” vertical position.

38. In FIG. 1H-4, it's worth noting that even though FIG. 1H-4 shows the Two Suspension Solenoid Plunger-rods (227LP and 227RP) in the extended mode and blocking the path a canister needs to travel along, if these Two Rods are fully retracted, then the drawing shows that when the two Pre-launch Launch Platform Halves (211L and 211R; referenced in FIG. 1H) are fully pushed in towards each other and interlocked as one solid platform component, there is enough room for this platform component to elevate up through the open area between the front edges of the two Solenoid Bodies (for 227L and 227R) and the rear edges of the Two respective Support Cups, which are parts of Support Arms 229L and 229R, respectively. The outer edges of the platform component will be slightly larger than the bottom surface of the phantom canister shown in FIG. 1H-4 as C-101Ph.

### Detailed Description of the Magnafloat

Before going into the Structural Composition Section, which details the physical nature of a MF device on a component by component basis, explanations need to be given about: a) the meaning of “Cycle,” and b) the status of a MF device at the beginning of a Cycle. The “Pace of Operation” for a MF device is the rate at which the individual Cycles occur. Throughout these descriptions, there is a term “Five Second Cycle Rule.” According to calculations, the overall output of electricity for a MF device will be ultimately determined by how many Cycles there are for any given period of time. And also on a yearly basis, the number of days (or hours) the device is shut down for maintenance will be a factor, and this is simply the number of Cycles that must be subtracted from a “year's worth of time” that has 365 days and 24 hours per day. For the preferred embodiment, a certain determination (not included in these descriptions) has been made for the amount of electricity a MF device will produce, and this determination defines the length of a Cycle to be Five Seconds. In Brief Summary; Par. 6, “A Cycle” there is a technical definition of what a Cycle is, regarding a starting point for a Cycle and the related movements of a canister around a MF device. But here in this paragraph, the term “Cycle” is being examined in relationship to “time.” The Five Second Cycle Rule used in these descriptions is an arbitrary length of time for a Cycle and a Cycle could be more or less than Five Seconds.

However, part of the reason why several sub-embodiments are included herein is that if any ONE particular part of the overall MF device does not “keep up” with the rest of the device (if there is a “bottleneck” in the operation), then the entire device will suffer, in terms of the total output of electricity. For example, one potential bottleneck is in the Pivot Bucket Area 313 of the preferred embodiment (seen in FIG. 1L), and it's worth remembering that a “bottleneck,” for example, is something that takes five and one-half seconds instead of five seconds. The Six Sequence Diagrams, FIGS. 15-20, show the overall layout of a MF device (for the preferred embodiment) and analyze a Cycle in terms of how a canister moves from one area of the device to another. From these particular diagrams it is fairly easy to get a feel for how the overall device functions: a) by seeing multiple canisters moving in more than one area of the device at the same time, and b) by looking at one section of the device compared to another section. In any event, the idea of a Five Second Cycle Rule is just as important, and perhaps even more important, than any single component or any particular area or section of a MF device. It is not only critical that all of these components work together with each other in a harmonious manner, but it is also essential that Every area of a MF device “process” canisters in the most efficient manner possible, for the sake of maximizing the output of electricity, which can also be expressed as maximizing the Pace of Operation (or minimizing the length of a Cycle, but doing so in a trouble-free manner).

Related to the idea of a Cycle is how a MF device is configured when it is started for the very first time, and that configuration is also the same configuration for the start of every Cycle for the entire lifetime of the device, except for a change in what exact canisters are sitting on the Inclined Platform 59. In other words, every time a canister leaves the Drop Point 301 to start a new Cycle, the same amount of canisters will be sitting on the Inclined Platform 59, only the topmost canister will have just recently been supplied to the Inclined Platform by the Pivot Bucket 261.

FIG. 15 is the first of six drawings for the Cycle-sequence Descriptions and FIG. 15 shows how a MF device is configured when the device is started for the first time. Over the course of a Cycle and for the preferred embodiment, a canister comes to what can be considered as Five Primary Stopping Points, and several other “temporary” stops. The Five Primary Stopping Points are all shown in FIG. 15, which are: Drop Point 301; Final Release Point 303; Pre-launch Area 308 (stopped Two Times; one “temporary” stop and then one Primary Stop); Underwater Launch Area 310; on Inclined Platform Top Cue Position Canister Holder Section 625Ext (this Stopping Point is actually an extended temporary stopping point and is on the right side of Canister C-10, with regards to where Canister C-10 is shown in FIG. 15, but the equipment that stops the canister is not shown in FIG. 15; this equipment can be seen in FIG. 1N). It would almost be proper to also define Three of these Stopping Points just mentioned, except Drop Point 301 and except one stop in the Pre-launch Area, as “temporary” stops because the length of time a canister pauses at these other Three Points is “a little more than a split second.” The (other) “temporary” stops are: in the Pre-launch Area, on the Pre-launch Launch Platform just prior to a Pre-launch, at the top and bottom of the Pivot Bucket (when the Leading Surface of a canister is making contact with Stop-pins 264L and 264R, and then again when the bottom surface of that canister is making contact with Stop-pins 263L and 263R), and there is also a multi-second stopping point at each “Cue Position” on Inclined Platform 59.

There is one critical question that can be asked two ways, but these two versions of that question basically mean the same thing. These questions are: “Is there one key component or one key area of the device that Sets the Pace for the operation of the entire device?” and “Is there one key component or sub-operation that will trigger the start of a Cycle?” The reason these questions mean the same thing is that the “slowest” sub-operation of the device will be the one procedure that MUST be totally completed before the next Cycle can occur. Since a MF device is relatively sophisticated in some ways, has an Air-side Coil Stack and a Fluid-side Coil Stack each about 60 feet high, a Pivot Bucket 15 or 20 feet in the air, and 12 (or more) canisters each weighing about 50 pounds that can reach speeds of 40 miles per hour, being able to precisely determine, in fractions of a second, what the “slowest” sub-operation will be is very difficult without the ability to perform Test Trials on a full prototype of the device.

However, this analysis of the device looks at Two Key Areas, which are: a) the Pre-launch Area (at the exact moment just prior to the Pre-launch, which in the preferred embodiment is just after the Coupling Process is finished), and b) what happens on Inclined Platform Top Cue Position Canister Holder Section 625Ext. Also, these two “events” are directly linked because the point in time when a canister is “ejected” onto Canister Holder Section 625Ext (from the Pivot Bucket) is totally dependent upon when the related Underwater Launch occurs, and an Underwater Launch occurs a specific amount of time (perhaps about one second), in every Cycle, after a Pre-launch is finished. When a canister is on Canister Holder Section 625Ext, the “amount of processing time” for that canister is Not absolutely critical (but also see three paragraphs below) because after the canister exits Canister Holder Section 625Ext and moves onto Inclined Platform 59, the canister then “sits in a cue” for 50 seconds, anyway. And regarding what happens at Drop Point 301, this location is the Exact Point where a Cycle starts, but the release of a canister at Drop Point 301 is merely a function of the Two Drop Point Retaining Pins, 81F and 81R, responding to a signal sent by the “Cycle Trigger Component.” Put another way, there is no “decision” made at Drop Point 301 to start “new” Cycle; that decision comes from another sub-operation and the signal to start that “new” Cycle is only sent immediately after that particular sub-operation has completed.

So the “Trigger” to start a Cycle is at the exact moment a Pre-launch is ready to begin. In the preferred embodiment, this is the split second after the Coupling Process has finished. [And the Coupling Process entailed the Two Pre-launch Linear Motors (218L and 218R) elevating Both canisters (the Upper and Lower Canisters) to a pre-determined vertical point where: a) the Upper Canister is totally “in the Fluid” in the Underwater Launch Area, and b) the Lower Canister has been raised to the exact point where: i) the Two Suspension Support Rods (227L and 227R) can be extended in underneath the bottom surface of this Lower Canister, and ii) the Two Notch Grips, 219F and 219R, can move straight into the Notch of the canister.] What happens then, as a “new” Cycle starts, is that on the Air-side a canister starts falling downward but is soon stopped at the Final Release Point 303. And immediately after that, the Two Final Release Funnel-trays, 102F and 102R, are separated far enough apart so the canister can fall through the opening and continue descending all the way down through Air-side Coil Stack 321.

At the same time this canister just mentioned has moved from the Drop Point 301 to the Final Release Point 303, on the Fluid-side the Upper Canister is pushed up “into the Fluid” (as a result of the Pre-launch Process) and then that canister immediately floats-up a few inches so that the canister's Leading Surface is making contact with the bottom edges of the Two Floatation Point Retaining Pins 245L and 245R. (These Two Actions just described that occur at the start of a Cycle, for the Air-side and the Fluid-side, can be seen by comparing FIG. 15 with FIG. 16.) At that point this canister also stops for a split second before the Underwater Launch occurs. It is not mentioned in any of the descriptions below, but it is possible a “Cycle Synchronization Signal” can be exchanged between the Two Funnel-tray Retracting Solenoids 103F and 103R and the Two Floatation Point Retaining Pins 245L and 245R, so that these Four components are synchronized to make sure the “falling” canister and the “ascending” canister both start their “launches” at precisely the same time.

Or as a result of Test Trials performed on a full prototype, one side or the other can be delayed by a second (or a fraction of a second) so that there is some type of “Coordinated Balance of Movement” for the overall device, relative to how fast canisters on each side of the device move through Air and through Fluid, compared to each other. Another thing that MUST occur, and which can be understood by looking at FIGS. 15-17, is that in this example, Canister C-10 must be clear of (moved to the left of) the Two Ejection Impact Assemblies, so that these Two Assemblies can reset and move upwards to their default positions Before the next canister arrives on Canister Holder Section 625Ext. This means that all canisters on Inclined Platform 59 need to “slide down” one Cue Position to the left Before a canister finishes ascending through the Fluid, is “caught” by the Pivot Bucket, and is then “ejected” out onto Canister Holder Section 625Ext by the Pivot Bucket. (Note: in FIG. 17, one Ejection Impact Spring Assembly is shown, because the Rear Assembly is directly behind the Front Assembly in the drawing. Also, in FIG. 17, that Ejection Impact Spring Assembly has been “reset” and can be seen to be “in the path of” the “next” canister; this Spring Assembly is just to the right of Canister C-10 at the top of Inclined Platform 59.)

### Structural Composition of The MagnaFloat

The purpose of this Structural Composition Section is primarily to show the physical relationship between all of the parts in a MF device, including parts in the various embodiments and sub-embodiments. There are other explanations in other Sections that describe the operational functionality of the parts being introduced in this Structural Composition Section.

The Inclined Platform 59 is the overall name given to the area, and all of the equipment within that area, which is shown in FIG. 1A, except the Above Ground Floor 61 is separate from the Inclined Platform. The “Far Left Side of Inclined Platform” 60 is the overall name given to the more specific area of the Inclined Platform that refers to the (Left Side) portion of the Inclined Platform where all of the operating equipment is situated (FIG. 1A-2 is an enlargement that shows the Far Left Side of Inclined Platform). For an embodiment where a large hole is dug into the ground to house the Air Side Coil Stack and the Fluid Side Coil Stack and all the other equipment for a MF device that is installed below the Above Ground Floor (for the Inclined Platform) 61, as shown in the diagrams (as opposed to constructing an “above-ground” building to house the entire MF device), the Above Ground Floor 61 (in FIG. 1A) is at a level with, or resting upon, the Earth's surface.

The Front Vertical Beam 62F (to support Spring and respective Solenoid for Front Drop Point Retaining Pin 81F) has Spring 80SpF (in FIG. 1A-2) permanently attached at the very top of this Beam 62F. The Front Vertical Beam 63F (to support Spring and Solenoid for Front Inclined Platform Notch Pin 88F) has Spring 87SpF permanently attached at the very top of this Beam 63F. There are several vertical beams in the Set of Vertical Support Beams 64Set and all of these Beams, combined, support the Inclined Platform 59. The Base Support Platform 65 (for Curved, Open, Inclined Canister Holder) is a flat, rectangular base that acts as an interface between the Set of Vertical Beams 64Set and the Inclined Canister Holder 66 that actually holds the canisters. This Curved, Open, Inclined Canister Holder 66 (best seen in FIG. 1A-2) is a large component with a semi-circular cut-out area in the middle, that is the primary structural component of the Inclined Platform 59. The bottom portion of this inner-curvature (the “cut-out” area) of this Canister Holder 66 is made to conform perfectly to (be the mirror image of) the shape of a canister's cylindrical body.

The Curved Arc A Pathway Guide 67F is first piece of equipment that a canister encounters after leaving the Drop Point 301. A canister smoothly glides over this Curved Pathway Guide 67F, and its Rear Counterpart 67R, and as a result, the canister attains True Vertical Alignment by the time the Leading Surface (pointing downward) of the canister has reached a point slightly below the bottommost edge of this Curved Pathway Guide 67F. The Canister Waiting Cue 68 reference is a designation for the overall area where a canister waits to move down to the left of the Inclined Platform, one canister at a time, until a canister finally reaches the #1 Canister Position (where that canister's Leading Surface is at the Drop Point 301). At that point the Canister becomes next in line to begin a Cycle.

In the preferred embodiment shown in FIG. 1A, the Canister Waiting Cue 68 is holding a total of Nine canisters. A small piece of the “top edge” (in a rotated position) of the Pivot Bucket 261, with a canister beginning to come out (to the left) of the Pivot Bucket, is shown in FIG. 1A as a “phantom component” Ph261. Even though the Pivot Bucket would never be rotated and ready to deposit a canister onto the Inclined Platform unless there was a vacancy for such canister in the “top far right spot” on the Inclined Platform (see Drawing Exception 12), the Ph261 reference is in FIG. 1A to illustrate the spatial relationship between where the Pivot Bucket 261 is and where the Inclined Platform 59 is, in the horizontal plane.

Turning now to FIG. 2a, there is a reference for an overall canister 69; this reference includes the canister body and everything else that's inside a canister. FIG. 2a shows the actual canister body, the Canister Housing 69H cut in half, down the middle. All canisters on a MF device are identical. In all the embodiments at this point in time, the canister bodies are in two parts. The Threaded Properties of a Canister 75 illustrates that the overall Canister body is made of two adjoining circular parts, which are screwed together to make one seamless body. This method of construction is so that the magnet 77 can be inserted and sealed into the canister. In another embodiment, it is possible to “mold” the magnet into the body and have the body of the canister be one molded piece, so no threads would be required. However, a two-piece canister has advantages over a one-piece molded canister body because with a Threaded 2-piece Canister, the magnet can be changed without destroying the entire canister body.

There is a Nose Cone Protrusion 70, which has a cone-like triangular shape that extends out of, and above, the front surface (the Leading Surface) of every canister. In addition, there is a Matching, Carved-out Impression 71 in the bottom surface of every canister; and as the name implies, this Carved-out Impression matches the shape of the Nose Cone Protrusion 70. Every canister has an Air Space Chamber 72 and this Air Space gives a canister a particular “buoyancy factor.” In the preferred embodiment, this Air Space Chamber 72 is filled with Air. In other embodiments it is possible to fill the Chamber with another type of gas, but the results of using another gas instead of air can have additional consequences (as described above in “1” of the more specific explanations relating to the Shin '574 device).

Every canister has a circular Notch 73 that goes completely around the body of the canister (in the horizontal plane, when a canister is in the upright position). In the preferred embodiment, where a canister is approximately 26 inches long, the Notch on the canister is about 4 inches high; the height of the Notch 73 is about 15% of the overall canister length. (Note: any length given for a canister is from its bottom surface to its Leading Surface, so the Nose Cone Protrusion is not a part of this stated canister length; the protrusion is in addition to the stated length) Also, in all of the embodiments, the Notch is approximately three-eighths to one-half inch deep. The vertical placement of the Notch for a canister that is pointed upward with True Vertical Alignment, is that the Notch is positioned up above the bottom surface of the canister so that the center of the Notch is at a distance that is about 40% of the overall length of the canister.

FIG. 2a shows three particular areas of the overall canister, 74a, 74b, and 74c, and these are areas where a very hard material, such as a Nano-plastic or Polycarbonate-plastic has been embedded into these particular cut-away areas of the canister, where room has been made to insert this “super-hard” material in these three places. These particular areas are subject to the most wear-and-tear from high-speed contacts and/or from other Hardware or other canisters making contact with these areas; use of this material in those areas will help to minimize degeneration of the canister body. Each of these three areas (74a, 74b, and 74c) is shown twice in FIG. 2a; the reason for this is that what appears to be two separate pieces in the diagram is just the same piece, because, for example with material-piece 74a, this material-part follows the complete circular shape of the Notch, as the Notch (and the material-piece) goes all the way around the canister. Since in FIG. 2a the canister has been sectioned in half, it is not clear that the top material-part (74a) is in fact also the same bottom material-part (74a).

There is a Magnet Enclosure Inner Partition 76, and this Partition pushes tightly up against the (back) surface of the magnet 77, to make sure the magnet cannot move. For each canister there are Two Identical Beveled Screws 78; one of these screws is shown enlarged in FIG. 2c, which also shows how the screw goes through the Canister Housing 69H, and then goes into the Magnet Enclosure Inner Partition 76. These Two Screws are positioned directly across from each other; there is no “top” screw or “bottom” screw because the canisters are perfectly round. The head on each of these screws is beveled and the related hole on the Canister Housing where each of these screws is inserted is also beveled to match the beveled shape of the screw heads. After the screws are put in place, an adhesive is put over the heads of the Two Screws so that the outer surface of the canister, where the screws have been inserted, has a completely perfect and seamless exterior.

Turning now to FIG. 1A-2, showing the Far Left Side of Inclined Platform 60, each of the Three components 62R, 63R, and 67R operates as an exact mirror image to the operation of its Front Counterpart, 62F, 63F, and 67F, respectively, as described above; 63R is “broken off.” FIG. 1A-2 also shows the three furthest left canisters on the Inclined Platform, C-1, C-2, and C-3, respectively. There is an Air Gap 79 between the Two Canisters in the #1 position and the #2 position. This necessary Air Gap 79 is further explained below (see 13 Topics; #4, “Equipment on the Left Side of the Inclined Platform”). There is no other place on the Inclined Platform where there is an Air Gap between any two adjacent canisters.

The references for 81F, 81R, 88F, and 88R each include the respective Solenoid and respective Plunger as One Component. There is a Spring 80SpF that connects the Front Vertical Support Beam 62F to the Front Drop Point Retaining Pin Solenoid 81F. This Spring 80SpF absorbs some of the impact when a canister makes contact with the Front Drop Point Retaining Pin 81F. The Spring 80SpR operates as an exact mirror image to the operation of its Front Counterpart, 80SpF. As stated above, Front Drop Point Retaining Pin 81F includes the Solenoid Plunger (the “Pin”) and the related Solenoid Body. The working descriptions for all of the equipment on the Far Left Side of Inclined Platform (60) are explained below (see 13 Topics; #4, “Equipment on the Left Side of the Inclined Platform”). The Rear Drop Point Retaining Pin 81R operates as an exact mirror image to the operation of its Front Counterpart, 81F.

The Far Left Motion Sensor 83 detects when a canister has moved in front of it. At that point, this Sensor 83 sends an identical signal to each of the Two Far Left Miniature Deceleration Electromagnet (82F and 82R) and this signal causes these Two Electromagnets to create Magnetic Fields.

This Pair (Front and Rear) of Far Left Miniature Deceleration Electromagnets (“EMs”) 82F and 82R, respectively, are used to slow down a canister that is heading towards the Drop Point 301. These Two EMs simultaneously create Counter-magnetic Fields on the front and rear sides of the canister, upon receiving the Activation Signal from the Far Left Motion Sensor 83. While the canister is on the right of these Two EMs, the respective Two EM Fields repel the magnet inside the canister and this action tends to slow down the movement, towards the left, of the canister. As the canister moves to the left of these Deceleration EMs, this Front and Rear EM Pair, 82F and 82R, still keep generating the same Magnetic Fields, but now the fields will be attracting the opposite side (the back side) of the magnet, thus the attractive magnetic effects will continue to slow down the movement of the canister, even though the canister has moved to the left of the Pair of EMs, 82F and 82R. These Two EM Fields are terminated at a pre-determined time after the Fields were created.

The Magnetically-activated Notch Area Sensor 86 magnetically detects when a canister has moved in front of it. At that point, this Magnetically-activated Sensor 86 sends an identical signal to each of the Two Canister-Position #2 Miniature Deceleration Electromagnet (85F and 85R) and this signal causes these Two Electromagnets to create Magnetic Fields. This Pair (Front and Rear) of Canister-Position #2 Miniature Deceleration Electromagnets, 85F and 85R, respectively, are used to slow down a canister that is moving into the #2 Canister Position on the Inclined Platform (that is heading towards the Second Canister Position Motion Sensor 84). These Two EMs simultaneously create Counter-magnetic Fields on the front and rear sides of the canister, upon receiving the Activation Signal from the Magnetically-activated Notch Area Sensor 86. These Two Magnetic Fields repel the magnet inside the canister and tend to slow down the movement of the canister. Once activated, this Pair of EMs will continue generating their individual Magnetic Fields until they receive a shut-down signal from a different Sensor, the Second Canister Position Motion Sensor (84).

There is a Second Canister Position Motion Sensor 84; when this Motion Sensor 84 detects the Leading Edge of a canister moving in front of it, two things happen: a) an identical signal is sent to each of the Two Solenoids for the Inclined Platform Notch Pins (88F and 88R), causing these Two Solenoids to immediately extend their Plungers (the “Pins”) into the Notch of the canister that is in the #2 position on the Inclined Platform, and b) a different type of identical signal is sent to each of the Two Canister-Position #2 Miniature Deceleration Electromagnets 85F and 85R, which causes these Two EMs to immediately terminate the Magnetic Fields they have been generating.

There is a Pair of (Front and Rear) Inclined Platform Notch Pins, 88F and 88R, respectively; each of these Two Notch Pin Systems, 88F and 88R includes the Solenoid Plunger (the “Pin”) and the Solenoid Body. At a predetermined time after the Two Drop Point Retaining Pins 81F and 81R retract, this Pair of Inclined Platform Notch Pins, 88F and 88R, also simultaneously retract. The effect of this Pair of Notch Pins (88F and 88R) retracting is that this action frees up the canister in the #2 Canister Position to begin moving to the left, towards the Drop Point 301. As mentioned above, there is a Spring 87SpF that connects the Front Vertical Support Beam 63F to the Front Inclined Platform Notch Pin 88F. This Spring 87SpF absorbs some of the impact when the Front Inclined Platform Notch Pin 88F makes contact with the Notch of a canister, because even though the canister in front of the Two Notch Pins, 88F and 88R will have been substantially decelerated, there still can be some residual movement (to the left) at the time the Two Notch Pins are engaging into the Notch. The Spring 87SpR operates as an exact mirror image to the operation of its Front Counterpart, 87SpF.

Turning now to FIG. 1B, which shows the equipment in the Air Side Launch Area 302, there is an Air Side Launch Area Topmost Alignment Ring 91, which is used to ensure a canister is falling with True Vertical Alignment and that the canister is directly over the other essential pieces of equipment that operate in and around the Descent Pathway for a canister in the Air Side Launch Area 302 (see FIG. 15 for this “302” reference). Running all the way up the right side of the Air Side Launch Area, there is an Air Side Vertical Support Structural Beam System 298R (for the Right Side of the Air Side Launch Area and the Right Side of the Air Side Coil Stack); this Beam System 298R includes the Front and Rear Right-side Vertical Structural Beams and any Cross-member Beams that connect the Front and Rear Vertical Structural Beams.

The Air Side Launch Area Topmost Alignment Ring Mounting System 91M mounts the Alignment Ring, 91, to the Structural Beam System 298R. The Front Horizontal Beam of the Mounting System 91M is attached to the Front Vertical Structural Beam of the Structural Beam System 298R. The Rear Horizontal Beam of the Mounting System 91M is attached to the Rear Vertical Structural Beam of the Structural Beam System 298R, but the rear part of this Mounting System 91M is “broken off” and not fully shown.

Directly below the Alignment Ring 91 is the Air Side Launch Area; Speed-adjusting Electromagnet (EM#1) 92; the designation of “#1” is given because this EM is one of Three Full-size Speed-adjusting EMs used in the preferred embodiment of the overall MF device (see 13 Topics; #10, “Speed-adjusting Electromagnets”). This Full-size Electromagnet creates a very strong Magnetic Field that opposes the oncoming Magnetic Field of the magnet inside a canister. This Speed-adjusting EM#1 92 creates a Counter-magnetic Field upon receiving a signal to do so from Motion Sensor 90. As the canister moves through this EM#1 92 and then begins to exit out the bottom of this EM#1 92, the Magnetic Field remains intact and so that EM Field will start attracting the Magnetic Field of the opposite side of the magnet (which has an opposite polarity). This “second phase of speed reduction” will continue to slow down the rate of free fall of the canister, but the attraction of the EM Field will not be strong enough to stop the fall of the canister altogether.

As the canister moves further away from the bottom of the EM#1 92, the attraction between the Two Magnetic Fields will become weaker and weaker. At a pre-determined time, starting from when the EM Field was first created, the Sensor System 90 will signal the EM#1 92 to immediately terminate the Magnetic Field. EM#1 92 is solidly held in place by an Air Side Launch Area; Speed-adjusting Electromagnet (EM#1) Mounting System 92M. This Mounting System 92M includes: a) Two Horizontal Beams and b) a Circular Belt-type Mounting Band that goes completely around EM#1 92. The Front Horizontal Beam of the Mounting System 92M is attached to the Front Vertical Structural Beam of the Structural Beam System 298R and this Front Beam of the Mounting System 92M also attaches to the Circular Belt-type Mounting Band in the front of EM#1 92.

The Rear Horizontal Beam is attached to the Rear Vertical Structural Beam of the Structural Beam System 298R, and this Rear Horizontal Beam of the Mounting System 92M is also attached to the Circular Belt-type Mounting Band in the rear of EM#1 92. However, the rear part of this Mounting System 92M is “broken off” and not fully shown. As mentioned above, there is an Air Side Launch Area Motion Sensor 90; this Motion Sensor detects when the Leading Edge of a canister is moving in front of it and then immediately sends a signal to the Air Side Launch Area; Speed-adjusting Electromagnet (EM#1) 92. This Motion Sensor System 90 is also responsible for causing the Electromagnetic Field generated by EM#1 92 to be terminated at a pre-determined time relative to when the field was created. The Air Side Launch Area Motion Sensor Mounting System 90M includes two pieces, a short Horizontal Beam and a short Vertical Beam. The top of the Vertical Beam attaches to the bottom of the Motion Sensor 90 and the bottom of the Vertical Beam attaches to the Horizontal Beam. The Horizontal Beam is directly attached to the far right edge of the Alignment Ring 91.

There is an Air Side Launch Platform 93 which is thrust downward by the powerful force of Linear Motor #1 96; this downward movement occurs at the time of the Air Side Launch. An enlarged view of the underside (the launching side) of the Air Side Launch Platform 93 can be seen in FIG. 1B-2. There is a Nose Cone Protrusion Shape 93NC centered in the middle of, and mounted to, the Air Side Launch Platform 93; this Protrusion 93NC adds more stability to the alignment of a canister during the Air Side Launch Process.

There is a Circular Elevated Enclosure 93Evt (FIG. 1B-2) that surrounds the entire Air Side Launch Platform 93 (except for where the Two Cut-away Notches are in the Launch Platform). This Elevated Enclosure 93Evt is there to ensure that the bottom surface (the topmost surface because the canister is pointing downward) of a canister being launched by the Air Side Launch System is in exactly the right position required, as the canister is being launched downward by the force of LM-1 96. This downward Launch Force is applied to the canister by Launch Platform 93. The Air Side Launch Platform Notch Configuration 93N includes the Two Notches that are cut-out of the edge of the Launch Platform 93 and also cut-out of the Circular Elevated Piece 93Evt; the Two Notches 93N are across from each other and are there so that the Launch Platform can pass by the Four Stand-alone Canister Guides, 100F, 100R, 101F, and 101R, without making contact with any of those Stand-alone Guides. The Air Side Launch Platform Connecting Interface 94 connects the Launch Platform 93 to the Forcer 95 of LM-1 96. This Connecting Interface allows the Three Components, 93, 94, and 95 to move up and down as if they are one unit.

FIG. 1B shows the Air Side Launch Area LM-1 Forcer 95. The reference for the Air Side Launch Area LM-1 96 (LM-1) includes the entire Air Side Launch Area Linear Motor (the “1” represents the fact that this LM is the first of Four LMs used in the preferred embodiment, throughout the entire MF device). In FIG. 1B, this LM-1 96 is that collection of Multiple Vertical “Strips” all grouped very closely together; these Vertical “Strips” are enclosed by a Top and Bottom End-cap. Air Side Launch Area LM-1 Top End-cap 97T is there to keep the Vertical “Strips” of the LM-1 96 in the proper position, relative to the other Vertical “Strips.” As the LM-1 Positioning Solenoid (99P/99B) retracts or extends, the End-cap 97T moves right along with LM-1, itself, in the horizontal plane, either to the right or to the left of FIG. 1B. There is an Air Side Launch Area LM-1 Bottom End-cap 97B; this Bottom End-cap 97B operates as an exact vertical mirror image to the operation of its Top Counterpart 97T, and also 97B moves in the exact same manner, horizontally, as 97T.

Air Side Launch Area LM-1 Connecting Interface 98 (connecting to Positioning Solenoid 99P/99B) includes three pieces, the far left Cube-like component that wraps around and grabs on to LM-1 (see Drawing Exception 9); the Angled Middle Piece; the Circular Cap that is fitted onto the end of the Solenoid Plunger 99P. This important Connecting Interface 98 solidly attaches LM-1 to the Positioning Solenoid Plunger 99P. The Plunger 99P (of the LM-1 Positioning Solenoid), in combination with the Solenoid Body 99B, form the overall LM-1 Positioning Solenoid. (Note: for all of the Solenoids in a MF device, the Solenoid Body can be referred to as “the Solenoid” for whatever Solenoid is being discussed.) This LM-1 Positioning Solenoid 99B provides the power to move the LM-1 and the Air Side Launch Platform 93 back and forth, horizontally. The Body of LM-1 Positioning Solenoid 99B is the primary part of the overall Air Side Launch Area Positioning Solenoid; the Plunger 99P moves back and forth, horizontally, inside the Solenoid Body 99B, according to the creation and manipulation of Magnetic Fields inside this Solenoid Body 99B.

The Upper Horizontal Mounting Beam 99MU (for the LM-1 Positioning Solenoid) attaches to the top of the Solenoid Body 99B and also attaches to the far right surfaces of the Two Air Side, Right-side Vertical Support Structural Beams of the Structural Beam System 298R. There is also a Lower Horizontal Mounting Beam 99ML (for the LM-1 Positioning Solenoid) and this Mounting Beam 99ML attaches to the bottom of the Solenoid Body 99B and also is attached between the Two Vertical Structural Beams of the Structural Beam System 298R.

There is an Upper Front Stand-alone Canister Guide 100F which is there to ensure a canister is falling with True Vertical Alignment, as the canister heads down towards the Two Final Release Funnel-trays, 102F and 102R. Directly across from the Upper Front Guide 100F is a Rear Stand-alone Canister Guide 100R, and this Rear Guide 100R operates as an exact mirror image to the operation of its Front Counterpart, 100F. The Upper Front Stand-alone Canister Guide Mounting System 100MF includes Four Pieces; there is a Horizontal Beam, a Vertical Beam, a Slanted Beam and another Horizontal Beam at the bottom of the Mounting System 100MF. The top Horizontal Beam connects the Guide 100F to the Vertical Beam of the Mounting System 100MF. The Vertical Beam is attached to the Lower Horizontal Beam (of 100MF). The Slanted Beam is attached to the Vertical Beam and is attached to the Lower Horizontal Beam; the Slanted Beam is there to give strength to the entire Mounting Structure 100MF.

There is an Upper Rear Stand-alone Canister Guide Mounting System which is not shown but which is the exact mirror image of the Front Stand-alone Canister Guide Mounting System 100MF. There is a Lower Front Stand-alone Canister Guide 101F; this Canister Guide 101F serves the same exact purpose as the Upper Front Stand-alone Canister Guide 100F. There is a Lower Rear Stand-alone Canister Guide 101R; this Canister Guide 101R serves the same exact purpose as Upper Rear Stand-alone Canister Guide 100R. The Lower Front Stand-alone Canister Guide Mount 101MF is one Horizontal Beam that attaches to the Canister Guide (101F) on the back end of this Beam and attaches to the Vertical Beam of the Mounting System 100MF on the front end of this Beam. The Guide Mount for the Lower Rear Stand-alone Canister Guide 101R is only partially shown and is not referenced in FIG. 1B; this Guide Mount is the exact mirror image of the Lower Front Stand-alone Canister Guide Mount 101MF and would attach (in the rear) to the Vertical Beam of the Rear Mounting System coming down vertically from the “100R Mounting System,” but that Upper Rear Mounting System (for 100R) is not shown, as mentioned above.

There is a Front Final Release Funnel-tray 102F; this important component has a Beveled Bottom, which allows a canister to “fall deeper into the tray” as the Two Funnel-trays, 102F and 102R, pull farther and farther away from each other (see FIG. 4a to FIG. 4d; also Cycle-sequence Descriptions; FIG. 17, “Air Side Launch Area 302”). Rear Final Release Funnel-tray 102R operates as an exact mirror image to the operation of its Front Funnel-tray Counterpart, 102F. The Spring Matrix 102SpF (for the Front Final Release Funnel-tray) includes Three Springs that stick-up vertically on the top of the Front Final Release Funnel-tray 102F. The purpose of this Spring Matrix is: a) to absorb the “shock” of the downward impact when a canister falls onto the Front Final Release Funnel-tray, and b) to support the Leading Surface of the canister during the initial part of the process when the Two Funnel-trays begin separating away from each other. The Spring Matrix 102SpR (for the Rear Final Release Funnel-tray) works in the same way as Spring Matrix 102SpF. Front Funnel-tray Solenoid 103F retracts at a rather slow, continuous pace (over a period of about one second), allowing a canister to gradually fall into the “Funnel Shape” that is created by the combination of these Two Complementary Funnel-trays, 103F and 103R (see FIGS. 4a-4d). Rear Funnel-tray Solenoid 103R operates as an exact mirror image to the operation of its Front Funnel-tray Solenoid Counterpart, 103F.

The Front Funnel-tray Solenoid Mounting System 103MF includes Four Pieces, which are: one long, Horizontal Beam with a “Y-like shape;” one Cross-member piece that goes between the two arms of the “Y” near the Front Funnel-tray Solenoid; one slanted support Beam that attaches on the far right to the long “Y-like” Horizontal Beam and also attaches to the left side of the Front Beam of the Vertical Structural Beam System 298R; one semi-circular harness-type mount that goes over the top half of the body of the Funnel-tray Solenoid 103F. The Rear Funnel-tray Solenoid Mounting System 103MR is only partially shown, but operates as an exact mirror image to the operation of its Front Counterpart, 103MF, except that this Mounting System 103MR attaches on the right to the left side of the Rear Vertical Structural Beam of the Beam System 298R.

Air Side Launch Area Bottommost Alignment Ring 104 is used to ensure a canister is falling with True Vertical Alignment, as the canister begins dropping down into the First Coil 321TC (FIG. 20) at the top of the Air Side Coil Stack 321. The Air Side Launch Area Bottommost Alignment Ring Mounting System 104M is only partially shown, but this Mounting System 104M has the exact same Mounting Configuration as the Air Side Launch Area Topmost Alignment Ring Mounting System 91M.

In FIG. 1B there is a “phantom canister” PhC that is in straight vertical alignment and is positioned between the Air Side Launch Platform 93 and the top of the Two Spring Matrices, 102SpF and 102SpR, which are mounted on top of the Two Final Release Funnel-trays, 102F and 102R. This “phantom canister” PhC is there to show how all the equipment in the Air Side Launch Area is aligned, in relationship to the size and position of a falling canister. Please see Drawing Exception 2, regarding this “phantom canister” PhC and the Air Side Launch Platform 93.

The Topmost Coil of the Air Side Coil Stack 321TC, is shown in FIG. 20; this is the first Coil below Alignment Ring 104. But turning now to FIG. 1C, shown is a typical Coil 111a in the Air Side Coil Stack. In addition, FIG. 1C shows Four More Identical Coils, 111b, 111c, 111d, ille, moving downward from Coil 111a, respectively. These Coils are all stacked one above the other in perfect vertical alignment. The Left-side and Right-side Mounting Systems for all of the Coils are exactly the same as the respective Mounting Systems, 111aML and 111aMR, for the Coil 111a. Even though FIG. 1C shows two “broken” sections of the overall Air Side Coil Stack 321, these Five Coils represent the entire Air Side Coil Stack 321 (referenced in FIG. 20) and any reference to the Air Side Coil Stack refers to this type of configuration (even though the number of Coils in the Stack may be much more than just Five Coils).

The Left-side Mounting System 111aML (for Coil 111a) includes Two Horizontal Mounting Beams that are on the left side of Coil 111a; one Beam is in the front of the Coil and the other Beam is in the rear of the Coil. For each Beam, where it attaches to the Coil, the Beam has a curvature to it that matches the curvature of the Coil 111a. The Two Beams extend almost up to the middle of the Coil 111a, going in a horizontal direction. The left side of the Front Horizontal Beam (of 111aML) attaches to the Front Left-side Vertical Structural Beam (of the 298L Beam System); the left side of the Rear Horizontal Beam attaches to the Rear Left-side Vertical Structural Beam (of the 298L Beam System).

The Right-side Mounting System 111aMR for Coil 111a includes Two Horizontal Mounting Beams that are on the right side of the Coil; one Beam is in the front of the Coil and the other Beam is in the rear of the Coil. For each Beam, where it attaches to the Coil, the Beam has a curvature that matches the curvature of the Coil. The Two Beams extend almost up to the middle of the Coil 111a, going in a horizontal direction. The right side of the Front Horizontal Beam (of 111aMR) attaches to the Front Right-side Vertical Structural Beam (of the 298R Beam System); the right side of the Rear Horizontal Beam attaches to the Rear Right-side Vertical Structural Beam (of the 298L Beam System). The Air Side Vertical Support Structural Beam System 298L (for the Left Side of the Air Side Coil Stack) includes the Front and Rear Left-side Vertical Structural Beams and any Cross-member Beams that connect the Front and Rear Vertical Structural Beams.

The Air Side Quadrilateral Guide Assembly 112a ensures that a canister is falling down through the Air Side Coil Stack with True Vertical Alignment. The Quad Guide Assembly, 112b, is exactly the same as Quad Guide Assembly 112a. In addition, the Left-side and Right-side Mounting Configurations for 112a and 112b are identical. The Air Side Quadrilateral Guide Assembly Left-side Horizontal Mounting Beam 112aML includes one Horizontal Mounting Beam, which connects the left side of the Quad Guide Assembly 112a to a Cross Member Beam that runs between the Two Left-side Vertical Structural Beams (the Front and Rear Beams) of the Beam System 298L. The Air Side Quadrilateral Guide Assembly Right-side Horizontal Mounting Beam 112aMR includes one Horizontal Mounting Beam which connects the right side of the Quad Guide Assembly 112a to a Cross Member Beam that runs between the Two Right-side Vertical Structural Beams (the Front and Rear Beams) of the Beam System 298R.

Turning now to FIG. 1D, there are Two Arc B Vertical Structural Support Beams 120 (which includes the Front and Rear Beams) and these Vertical Beams support the far left side of the Arc B Roller Conveyor 121. The Two Arc B Structural Support Slanted Reinforcing Beams 120SL (includes Front and Rear Slanted Beams) help strengthen the Two Vertical Structural Support Beams 120. All of these Four Beams, and all other support beams shown in FIG. 1D, are sitting on the Subterranean Floor 317. The Roller Conveyor 121 is one continuous “Roller System” that goes through the Arc B Area (FIG. 1D), the Slowdown Plunger Area (FIG. 1E), the Mid-section of the Roller Conveyor (FIG. 1F) and the Arc C Area (FIG. 1G). There is a collection of Passive Rollers housed within the Roller Conveyor, and specifically the Frame of the Roller Conveyor has a Front and Rear section, where the bearings for the Rollers are located. There is a reference for all of, or any of, the individual Rollers 122 and therefore this reference also applies to the individual Rollers as a “Set of Rollers” located within the Roller Conveyor 121; this Roller 122 reference also applies to the other Rollers in FIGS. 1E-1G. (Note: as stated above in the Additional Drawing Exceptions and Comments #21, in actual construction of a MF device, many more Rollers 122 will be used in the overall Roller Conveyor 121 than what is shown in the Figures presented.)

The Rear Arc B Conveyor Guide Rail 123R works in combination with its Counterpart the Front Arc B Conveyor Guide Rail 123F, to ensure that a canister will be aligned properly as the canister travels along the Arc B Roller Conveyor. (Note: this Guide Rail System 123 is Not a continuous Rail System and a similar Guide Rail System is shown as starting in FIG. 1F, with different reference numbers 189R and 189F.) The Front Arc B Conveyor Guide Rail 123F functions exactly the same as the Rear Arc B Conveyor Guide Rail 123R. However, this Guide Rail 123F is shown in hidden lines, even though it is in front of all the Rollers 122 shown in FIG. 1D.

The Set of Rear Arc B Conveyor Guide Rail Paired Mounts 123MR all work to support the Rear Arc B Conveyor Guide Rail 123R; these Paired Mounts 123MR attach at the top to the Guide Rail 123R and attach at the bottom to the top surface of the Frame of the Roller Conveyor 121. The Set of Front Arc B Conveyor Guide Rail Paired Mounts 123MF all work to support the Front Arc B Conveyor Guide Rail 123F; these Paired Mounts 123MF attach at the top to the Guide Rail 123F and attach at the bottom to the top surface of the Frame of the Roller Conveyor 121. All of these Front Paired Mounts 123MF are shown in hidden lines.

Speed and Motion Sensor 124 detects when the Leading Edge of a canister is moving in front of it and immediately analyzes that data to determine how fast the canister is moving. Then, the Sensor System 124 causes the Three Arc B Canister Elevation Electromagnets: 125a, 125b, and 125c, to sequentially create Counter-magnetic Fields based on the analysis of the Motion Data. After receiving the signal from the Sensor System 124, the furthest left Arc B Canister Elevation Electromagnet 125a (also see FIG. 6) creates a “gentle” Counter-magnetic Field that is pulsed outward from this Canister Elevation Electromagnet 125a.

The net result is that a falling canister will be gently “lifted off of” the Roller Conveyor (or pushed away from the Roller System) for a brief instant by the force of this Counter-magnetic Field (see Ten Numbered Points of Comparison; #1, par. 3). The Middle Arc B Canister Elevation Electromagnet 125b works in exactly the same way as Canister Elevation EM 125a; there is a Pre-determined Delay (according to the analyzed results for each falling canister by the Sensor System 124) so that this EM 125b sends out its “EM Pulse” a split second after EM 125a sends out its pulse. The furthest right Arc B Canister Elevation Electromagnet 125c works in exactly the same way as Canister Elevation EMs 125a and 125b; there is a Pre-determined Delay so that this EM 125c sends out its “EM Pulse” a split second after EM 125b sends out its pulse. There is a Pair of Front and Rear Arc B Stand-alone Vertical Support Beams 126; these Two Beams help support the Roller Conveyor in the Arc B Area; the Rear Beam is “broken off.”

The Arc B Far Left Alignment Ring 127 ensures that a canister will have perfect alignment as the canister travels along the Arc B Roller Conveyor, before making contact with the Two Slowdown Plunger Tips 140F and 140R (in FIG. 1E). This Far Left Alignment Ring 127 is firmly attached to the other Two Alignment Rings (128 and 129) in the Arc B Area; these Three Alignment Rings are securely attached to each other by the Connecting Bar-cap, 130. The Arc B Far Left Alignment Ring Mounting System 127M includes both Front and Rear Vertical Support Structures and also includes the Two Angled Pieces that go from the Two Vertical Structures to the Alignment Ring 127, in the front of the Ring and in the rear of the Ring. The Rear Vertical Support Structure is partially shown. The Arc B Middle Alignment Ring 128 functions in exactly the same way as Alignment Ring 127. The Arc B Middle Alignment Ring Mounting System 128M uses exactly the same Mounting Configuration as the Mounting Configuration of 127M. The Arc B Far Right Alignment Ring 129 functions in exactly the same way as the Alignment Ring 127. The Arc B Far Right Alignment Ring Mounting System 129M uses exactly the same Mounting Configuration as the Mounting Configuration of 127M.

The Connecting Bar-cap 130 (for Arc B Alignment Rings: 127, 128, and 129) includes the Top Horizontal Section and also includes One Angled Piece that comes down in the front and One Angled Piece that comes down in the rear. The Horizontal Section and Both Angled Pieces all make full contact with all Three Alignment Rings, respectively, to ensure the Three Alignment Rings are totally solid and virtually immovable.

As mentioned above, all of the “Structural Vertical Support Beams and Mounting Equipment” (298L, 298R, 120, 120SL, 126, 127M, 128M, and 129M) are firmly mounted to the Subterranean Floor 317. This Subterranean Floor 317 is the same Floor shown in FIGS. 1D-1G. In the preferred embodiment, this Subterranean Floor 317 is the main floor at the bottom of the overall MF device and is the Floor that supports all the equipment at that lowest horizontal level of the MF device. However, there is another “Subterranean Floor,” which is Subterranean Floor 411 (for the Over-sized embodiment; see FIG. 1D-oz). In the Over-sized embodiment, the Subterranean Floor 317 does not really exist in the same way it exists in the preferred embodiment. The Fluid Reservoir Ceiling (427 in FIG. 1D-oz), on the right side, is basically where the Subterranean Floor 317 would be (see Movement of Canisters Section; Definition of Terms, “Subterranean Floor 317”).

The Speed and Motion Sensor 131 detects when the Leading Edge of a canister is moving in front of it and immediately analyzes that data to determine how fast the canister is moving. Then, this Sensor System 131 provides a set of operational instructions to the Hydraulic Accumulator Energy Recovery System 314 (HAERS, shown in FIG. 1E-2; also see Cycle-sequence Descriptions; FIG. 19, “Slowdown Area 306”).

In FIG. 7a there is a canister PhC-Sm partially shown; in FIG. 7b there is a canister PhC-Lg partially shown. A full explanation of why these two different sizes of canisters are shown in those drawings is given in Drawing Exception 7. In FIG. 1D there is a fully-shown “phantom canister” PhC-3 which is in a position ready to enter Alignment Ring 127. This “phantom canister” PhC-3 is there to demonstrate the relatively perfect vertical alignment a canister must-and-will have before entering the Set of Three Alignment Rings, 127, 128, and 129.

Also in FIG. 1D, sections of the Left and Right Air Side Vertical Support Structural Beam Systems, 298L and 298R, respectively, are shown. The purpose of including these Two Beam Systems in FIG. 1D is to show the approximate locations of these Two Beam Systems in relationship to the Roller Conveyor 121 and to the Subterranean Floor 317.

Turning now to FIG. 1E, the Front Slowdown Plunger Tip 140F is directly attached to (molded onto) the Front Slowdown Plunger 141PF and the Rear Slowdown Plunger Tip 140R is directly attached to (molded onto) the Rear Slowdown Plunger 141PR. These Two Slowdown Plunger Tips, 140F and 140R, are the components that make contact with a canister when the canister is in the Slowdown Area 306 (FIG. 15 shows this “306” reference). The horizontal distance between the Two Slowdown Plunger Tips is just enough so that the Nose Cone Protrusion 70 of a canister will fit within that horizontal distance between the “Tips” without making contact with either of the Slowdown Plunger Tips, 140F or 140R.

The Front Slowdown Plunger 141PF is a long Plunger that will absorb (or transfer) some of the kinetic energy from a fast-moving canister, as a result of backpressure being applied to the canister. A full explanation of this entire Hydraulic Accumulator Energy Recovery System (HAERS 314) sub-process is explained below (see Cycle-sequence Descriptions; FIG. 19, “Slowdown Area 306”). But a brief description of the process is that backpressure opposing the canister's forward movement is created (and is constantly increasing during the period of time a canister makes contact with the Slowdown Plunger Tips, 140F and 140R) as a result of the Fluid Pressure inside the Hydraulic Lines, 154F and 154R, and the overall “Hydraulic System” increasing because the volume of fluid inside the overall Hydraulic System is being reduced as the canister pushes the Plunger 141PF (and its Rear Counterpart, 141PR) further and further into the Body of the Plunger 141BF (and its respective Rear Counterpart Body, 141BR). All of this pressurization becomes concentrated, and stored in a Variable Pressure Chamber 156Pr of the Hydraulic Accumulator 156.

The Front Slowdown Plunger 141PF moves back and forth, horizontally, inside the Front Slowdown Plunger Body 141BF. This Plunger Body 141BF is solidly attached to a Mounting Harness 145F and is also reinforced in the back (the far right in FIG. 1E) by the Front Slowdown Plunger Back-end Stop-pin 152PnF. The Rear Slowdown Plunger, 141PR, moves back and forth, horizontally, inside the Rear Slowdown Plunger Body 141BR. This Rear Plunger Body 141BR is solidly attached to a Mounting Harness 145R (partially shown in FIG. 1E) and is also reinforced in the back (the far right) by the Rear Slowdown Plunger Back-end Stop-pin 152PnR.

The Slowdown Area Left Alignment Ring 142 ensures a canister will have perfect alignment while the canister is compressing the Two Slowdown Plungers into their Two Respective Slowdown Plunger Bodies. Slowdown Area Right Alignment Ring 143 functions in exactly the same way as Alignment Ring 142.

The Slowdown Area Left Alignment Ring Mounting System 142M includes both Front and Rear Vertical Support Structures and also includes the Two Angled Pieces that go from the Two Vertical Structures to the Alignment Ring 142, in the Front and in the Rear, respectively, of Alignment Ring 142. The Rear Vertical Support Structure of the Mounting System 142M is partially shown. The Slowdown Area Right Alignment Ring Mounting System 143M uses exactly the same Mounting Configuration as the Mounting System 142M and the Rear Vertical Support Structure of the Mounting System 143M is also partially shown. The Connecting Cap 144 (for the Two Slowdown Area Alignment Rings 142 and 143) includes the Top Horizontal Section and also includes Two Angled Pieces that come down in the front and Two Angled Pieces that come down in the rear, and these Angled Pieces are attached to the respective Alignment Ring that each of these Angled Pieces is positioned over. The Horizontal Section of Connecting Cap 144 also attaches to Both Alignment Rings, and the overall Connecting Cap 144 ensures that the Two Alignment Rings, 142 and 143, are totally solid and virtually immovable.

The Connecting Interface Harness 145F (for the Front Slowdown Plunger) includes the Four Horizontal, Curved Arms of the Harness and also includes a Horizontal Bar that runs almost the entire length of the Slowdown Plunger Body 141BF. On the far side of the Harness 145F (away from the viewer in FIG. 1E) the Four arms of the Harness 145F attach to the Horizontal Bar (of the Harness 145F). On the near side (closest to the viewer), these Four Arms converge, in that the Two Arms on the left side of the Harness come together and attach to the left side of the Fitted Cylindrical Extension-Mount 146F (for the Front Retracting Solenoid Plunger), and the Two Arms on the right side of the Harness come together and attach to the right side of the Fitted Cylindrical Extension-Mount 146F.

The Connecting Interface Harness for the Rear Slowdown Plunger 145R operates as an exact mirror image to the operation of its Front Counterpart 145F; this Rear Interface Harness 145R is only partially shown. The Front Fitted Cylindrical Extension-Mount 146F (for the Front Retracting Solenoid Plunger) also includes the Retracting Solenoid Plunger that the larger Cylindrical Part of the Extension-Mount 146F is fitted onto; the Rear Fitted Cylindrical Extension-Mount (and Rear Retracting Solenoid Plunger) is not shown.

There is a Front Retracting Solenoid Body 147F. When this very powerful Solenoid 147F retracts, it instantaneously pulls the Front Slowdown Plunger Body 141BF (and the related Front Plunger 141PF) out of the way of a canister's path. This Retracting Solenoid 147F only needs to retract about 1½ inches to accomplish this task. This Retracting Solenoid 147F is immovable, except for its motion in the horizontal plane to retract and extend. The Rear Retracting Solenoid Body and any mounting structures to do with the Rear Solenoid Body are not shown.

The Front Retracting Solenoid Body Left Vertical Mounting Structure 147MF-Lft includes Two Vertical Support Structures and an Angled Piece that connects these Two Vertical Structures. The taller of the Two Vertical Structures connects to the left side of the Solenoid Body 147F. The Front Retracting Solenoid Body Right Vertical Mounting Structure 147MF-Rgh includes Two Vertical Support Structures and an Angled Piece that connects these Two Vertical Structures. The taller of the Two Vertical Structures connects to the right side of the Solenoid Body 147F.

The Front Retracting Solenoid Body Upper Mounting Component 147MUF is a Curved Mounting Interface that attaches directly to the back upper portion of the Front Solenoid Body 147F and then also attaches to the “taller” Vertical Support Structure of the overall Front Right Vertical Mounting Structure (147MF-Rgh) and also attaches to the “taller” Vertical Support Structure of the overall Front Left Vertical Mounting Structure (147MF-Lft). The Front Retracting Solenoid Body Lower Mounting Component 147MLwrF is a Mounting Interface that attaches directly to the back lower portion of the Front Solenoid Body 147F and then also attaches to the “taller” Vertical Support Structure of the overall Front Right Vertical Mounting Structure (147MF-Rgh) and also attaches to the “taller” Vertical Support Structure of the overall Front Left Vertical Mounting Structure (147MF-Lft). The Rear Counterparts of: 147MF-Lft, 147MF-Rgh, 147MUF, and 147MLwrF are not shown, but all such components operate as mirror images to the operation of their front Counterparts.

The Stop-pin 148F (that makes contact with the Front Harness Connecting Interface 146F) does not move up or down, left or right. This Stop-pin 148F serves two purposes: a) when the Retracting Solenoid 147F is pulling the Mounting Harness (145F) and the Plunger Body (141BF) back (towards the viewer in FIG. 1E), this Stop-pin 148F acts to stop this “retracting horizontal movement;” this “stopping action” occurs when the (closest) right side of the (closest) right Harness Arm makes contact with the Stop-pin 148F.

The Anti-rotational Plunger Extension Backstop 149aF does not move up or down, left or right. The Fitted Cylindrical Extension-Mount 146F slides back and forth along the left surface of this Backstop 149aF; this left surface is curved to provide the smallest possible point of contact between the Backstop 149aF and the Extension-Mount 146F, for the sake of: reducing friction, reducing “wear-and-tear” on the parts, and to make the horizontal “sliding motion” of the Extension-Mount 146 as smooth as possible. The purpose of this Backstop 149aF, along with Backstop 149bF, is to act as an Anti-rotational System that helps ensure there is no rotational movement by the Front Solenoid Body 141BF while the Slowdown Plunger Tip 140F is making contact with a canister. Specifically, this Anti-rotational System keeps the Extension-Mount 146F from rotating clockwise in the horizontal plane; the force of the moving canister on the entire Slowdown Plunger System will be attempting to rotate the Front Slowdown Plunger System (and therefore including the Extension-Mount 146F) clockwise, to move the Front Slowdown Plunger out of the canister's path.

The Anti-rotational Plunger Extension Backstop 149bF (the one closest to the Solenoid Body 147F) works in exactly the same way as Backstop 149aF. In fact, Backstop 149bF is there to add “Double Strength” and help provide a maximum amount of Anti-rotational force, to counteract the tendency of the overall Plunger Stabilizing System to be pushed in a clockwise direction (in the horizontal plane) by the canister. The Two Rear Counterparts for the Two Front Plunger Extension Backstops (149aF and 149bF) are not shown; these Two Rear Counterparts work in exactly the same way as the Two Backstops 149aF and 149bF, except that the canister will be attempting to rotate the Rear Slowdown Plunger System counterclockwise to get that System out of the way of the canister.

The Front Vertical Housing Structure 150F is a solid vertical structure which houses the Three Components, 148F, 149aF, and 149bF. The Rear Counterpart for the Front Vertical Housing Structure 150F is not shown. There is a Front Slowdown Area Stand-alone Vertical Support Beam 151F that helps support the Roller Conveyor 121 in the Slowdown Area. There is also a Rear Slowdown Plunger Area Stand-alone Vertical Support Beam 151R that helps support the Roller Conveyor 121 in the Slowdown Area; this Rear Support Beam 151R is partially shown.

The Front Slowdown Plunger Back-end Stop-pin 152PnF extends up to a point that goes higher than the top of the end surface of the Front Slowdown Plunger Body 141BF. This Stop-pin 152PnF is actually the Plunger of the Solenoid 152BF. The back-end surface (far right end) of the Front Slowdown Plunger Body 141BF has a vertically concave contoured shape that is “carved out” of that back-end surface. This contoured shape has the exact diameter as the diameter of the Front Slowdown Plunger Back-end Stop-pin 152PnF. This Stop-pin 152PnF is engaged into that contoured shape during the time a canister is making contact with the Front Slowdown Plunger Tip 140F. Upon receiving a signal from the Hydraulic Accumulator Energy Recovery System, this Stop-pin 152PnF instantaneously retracts (is pulled downward by the Solenoid 152BF) and moves totally out of the way of the oncoming canister. This Stop-pin 152PnF is there to provide another level of resistance against “sideways motion” for the Front Slowdown Plunger System and to supplement the stationary forces being supplied by the (immovable) Plunger Retracting Solenoid 147F.

This Back-end Stop-pin 152PnF pushes back on the Plunger Body 141BF from another direction (giving resistance straight from the back of the Plunger Body), providing a counterforce that is applied in direct opposition to the exact forward path of a canister's movement. The Rear Slowdown Plunger Back-end Stop-pin 152PnR operates exactly the same as the Stop-pin 152PnF. The Front Slowdown Plunger Back-end Stop-pin Solenoid Body 152BF is what causes the Stop-pin 152PnF to move up and down. This Solenoid Body 152BF is solidly mounted in a Housing Structure (153). The Rear Slowdown Plunger Back-end Stop-pin Solenoid Body 152BR functions in exactly the same manner as the respective Front Solenoid Body, 152BF. The Vertical Housing Structure 153 is a large, Vertical Structure that houses both Back-end Stop-pin Solenoid Bodies, 152BF and 152BR. This Vertical Housing Structure 153 has an “Angular Lip” on the right that extends up higher than the rest of the Vertical Structure, and this “Lip” adds additional support to the backs (the far right side) of the Two Solenoid Bodies 152BF and 152BR.

The Front Hydraulic Pressure Line 154F is the Front Pressure Line that connects the Front Slowdown Plunger System to the Hydraulic Accumulator Energy Recovery System 314 (in FIG. 15). This Pressure Line 154F transmits the pressure that is felt, by way of the fluid in the line, to the HAERS when a canister is in contact with the Slowdown Plunger Tip 140F. There is only one Pressure Line for each Slowdown Plunger System. The Rear Hydraulic Pressure Line 154R connects the Rear Slowdown Plunger to the HAERS; this Rear Pressure Line 154R works exactly as its front Counterpart, 154F, and in fact even though these Two Pressure Lines (154F and 154R) are connected to different Slowdown Plungers, these Two Pressure Lines, 154F and 154R, basically always “feel” the same amount of Fluid Pressure because of how they are “mutually connected” on their other ends, into the Multi-surface Mounting Interface 155 (shown in FIG. 1E-2).

For an in-depth discussion on how this entire HAERS functions, see Cycle-sequence Descriptions; FIG. 19, “Slowdown Area 306.” Turning now to FIG. 1E-2, the Multi-Surface Mounting Interface Structure 155 includes various surfaces that provide the Mounting Surfaces and includes the Hardware onto which and by which the Two Hydraulic Pressure Lines, 154F and 154R, are attached to the overall HAERS structure. In addition, Pressure Gauge 164 is mounted into the lower surface (partition) of this Interface Structure 155. This Pressure Gauge 164 is the control unit for the entire Energy Recovery and Slowdown Plunger Reset Process.

The Hydraulic Accumulator 156 is an energy storage device. This Hydraulic Accumulator 156 has a pressure storage reservoir (Variable Pressure Chamber 156Pr) where a non-compressible hydraulic fluid is held under pressure by an adjacent chamber (156N) that is filled with a compressed gas. There is a one-way Pressure Check Valve (157) that allows pressurized fluid to enter the Variable Pressure Chamber (156Pr). At the beginning of each Cycle, Valve 157 is open (in other words, the “default” position for Valve 157 is open), but Valve 157 closes at a point when the fluid reaches its “Target Pressure.” There is another one-way Pressure Check Valve 158 connected to the Chamber 156Pr, and immediately after Valve 157 closes, Valve 158 opens, and as a result of this process, the pressurized fluid is allowed to exit the Variable Pressure Chamber 156Pr and enter the Hydraulic Motor 174.

There are Multiple Walls of the Hydraulic Accumulator 156W: these Four Walls form a rectangle and included inside the boundaries of such rectangle are: the Nitrogen Chamber 156N, the Variable Pressure Chamber 156Pr, and the Floating Piston 156FP. Also, Two of the Walls 156W have areas where Two Pressure Check Valves, 157 and 158, are mounted into those particular Walls. The Nitrogen Chamber 156N (of the Hydraulic Accumulator) expands and contracts according to the overall pressure in the system. The Variable Pressure Chamber 156Pr (of the Hydraulic Accumulator) also expands and contracts according to the overall pressure in the Hydraulic System. The Floating Piston 156FP (for the Hydraulic Accumulator) is a moveable partition that moves to the right or to the left, according to how much pressure is in the Variable Pressure Chamber 156Pr, and relative to the initial “default pressure” of the Nitrogen Chamber 156N.

Electronically-activated Pressure Check Valve 157 is the primary Valve responsible for how much pressure is transferred into the Hydraulic Accumulator. Reference 157Enlg shows an enlarged view (FIG. 10) of the Pressure Check Valve 157. Reference 157Intnl is a Cross-section View of the inside of this Electronically-activated Pressure Check Valve 157; this view illustrates how pressure moves (in one direction only) inside the Pressure Check Valve 157 and also shows how the Valve 157 closes.

FIG. 1E-2 shows Six Other Electronically-activated Pressure Check Valves that are used to manipulate and control the overall HAERS. These Six Valves are: 158, 159, 160, 161, 163; Vhg, and 163-Vlw. All of these Check Valves operate in exactly the same manner as Pressure Check Valve 157, from a technical standpoint, and they are all one-way Valves. There is a description below that explains when and why each Valve opens at a particular time, in relationship to the overall Energy Recovery Process.

Pressure Release Chamber 162 is the area responsible for pressure being taken out of the system at the exact point when contact between the canister and the Two Slowdown Plunger Tips (140F and 140R) is finished, for each Cycle. There is a reference for Multiple Walls 162W (of the Pressure Release Chamber 162); together, these various Walls 162W almost form a rectangular shape, except for the Angled Left Wall. Also, as shown in FIG. 1E-2, there are Five Pressure Check Valves, 159, 160, 161, 163-Vhg, and 163-Vlw mounted into some of these Walls 162W and into other Walls 165XW.

There are two smaller Pressure Adjustment Chambers connected to the Pressure Release Chamber 162, which includes a High Pressure Chamber 165-hg and a Low Pressure chamber 165-lw. As explained in Cycle-sequence Descriptions; FIG. 19, “Slowdown Area 306,” these two smaller chambers are used as a way to immediately have access to a higher or lower pressure at a point when the overall pressure in the HAERS has been modified, during each cycle, after fluid has passed through the Hydraulic Motor 174.

Inlet Port 166-In is an opening (a threaded connection mounting area) where pressure (if needed) flows INTO the High Pressure Chamber 165-hg from Pressure Pump 171. Outlet Port 166-Out is the opening (a threaded connection mounting area) where pressure (if necessary) is taken OUT OF the Low Pressure Chamber 165-lw by Pressure Pump 171. Inlet Pressure Hose 167 carries Fluid (and pressure) between the Pressure Pump 171 and the Inlet Port 166-In on the High Pressure Chamber 165-hg. Outlet Pressure Hose 168 carries Fluid (and pressure) between the Pressure Pump 171 and the Outlet Port 166-Out on the Low Pressure Chamber 165-lw. This Pressure Hose 168 is shown with a hidden line, even though it is in front of other pieces of equipment.

The Outlet Connection 169 is the Attachment Fixture on the Pressure Pump that holds the Inlet Pressure Hose 167. (Note: the term “Outlet” in regards to the Outlet Connection 169 is now defining this component as its purpose on the Pressure Pump 171; so this connection is where the “outlet” from the Pressure Pump meets with the “inlet” hose connected to the High Pressure Chamber 165-hg.) Fluid moving through this Outlet Connection 169 goes OUT of the Pressure Pump 171 and INTO the High Pressure Chamber 165-hg. The Inlet Connection on Pressure Pump 170 is the Attachment Fixture on the Pressure Pump that holds the Outlet Pressure Hose 168. Fluid moving through this connection comes INTO the Pressure Pump 171 from the Low Pressure Chamber 165-lw. Electrically Powered Pressure Pump 171 is used to add pressure to the Hydraulic System, when necessary, by way of the High and Low Pressure Chambers. The Hydraulic Accumulator 156 and the Pressure Pump 171 are mounted to the Subterranean Floor 317. There is an overall reference for the Walls 165XW of the Two Pressure Chambers, the High Pressure Chamber 165-hg and the Low Pressure Chamber 165-lw.

There is an Outlet Pressure Hose 172; Fluid (and pressure) passing through this Outlet Pressure Hose 172 goes only One Way, FROM the Variable Pressure Chamber 156Pr INTO the Hydraulic Motor 174. There is an Inlet Pressure Hose 173; Fluid (and pressure) passing through this Inlet Pressure Hose 173 goes only One Way, coming INTO the Pressure Release Chamber 162 FROM the Hydraulic Motor 174. The Hydraulic Motor 174 accepts Fluid (and pressure) from the Hydraulic Accumulator 156. This Hydraulic Motor 174 takes kinetic energy out of the pressurized fluid, which causes this Hydraulic Motor 174 to spin. The end result of this sub-process is that: a) Fluid is sent back into the Pressure Release Chamber 162 at a reduced pressure (compared to the level of pressure the Fluid had when it entered the Hydraulic Motor) and b) as the Shaft of the Hydraulic Motor 174Sh turns, this causes the Electric Generator 175 to turn and electricity is generated through this process. The Hydraulic Motor Shaft 174Sh is directly attached to, and is in perfect alignment with, the shaft of the Electric Generator 175. A Support Bearing for the Shaft 174Sh (halfway between the back of the Hydraulic Motor and the front of the Electric Generator) is not shown.

The Inlet Interface Area 174Inlt is the “contact area” on the Hydraulic Motor where the Outlet Pressure Hose 172 attaches; Fluid and pressure comes INTO the Hydraulic Motor through this Interface Area 174Inlt. The Outlet Interface Area 174Outl is the contact area on the Hydraulic Motor where the Inlet Pressure Hose 173 attaches; Fluid and pressure move OUT OF the Hydraulic Motor through this Outlet Interface Area 174Outl. The Mounting Structure 174M (for the Front of the Hydraulic Motor) includes Two Vertical Support Beams and One Horizontal Cross Beam. The Two Vertical Beams are underneath the Horizontal Cross Beam, and hold it up. The bottoms of the Two Vertical Beams are attached to the Subterranean Floor 317. The Horizontal Cross Beam is attached to the underside of the front of the Hydraulic Motor 174 and solidly supports the front of the Hydraulic Motor.

As stated above, the Electric Generator 175 moves in tandem (rotationally) with the movement of the Hydraulic Motor 174. The Mounting System for the Back-end of Electric Generator 175M includes Two Support Beam Structures (Front and Rear) and also includes the Bearing affixed to the Front and Rear Support Beam Structures; the Bearing supports the back-end of the Electric Generator and the end-part of the shaft coming out the back of the Electric Generator rotates inside the Bearing.

Turning now to FIG. 1F, Roller Conveyor Mid-section Alignment Ring #1 176 ensures that a canister will have perfect alignment as the canister travels along the Mid-section of the Roller Conveyor 318. In addition, Roller Conveyor Mid-section Alignment Ring #2 and Alignment Ring #3 (177 and 178, respectively) function exactly like Mid-section Alignment Ring #1 176. The Mid-section Alignment Ring #1 Mounting System 176M includes both Front and Rear Vertical Support Structures and also includes the Two Angled Pieces that go from the Two Vertical Support Structures to the Alignment Ring 176, in the front and in the rear of Alignment Ring 176. The Rear Vertical Support Structure of the Mounting System 176M is partially shown. In addition, the Mid-section Alignment Ring #2 Mounting System and the Mid-section Alignment Ring #3 Mounting System (177M and 178M, respectively) have exactly the same Mounting Configuration as Mounting System 176M.

The Connecting Bar-cap 180 (for the Three Roller Conveyor Mid-section Alignment Rings) includes the Top Horizontal Section and also includes Two Angled Pieces for each of the Three Alignment Rings, 176, 177, and 178, whereby One Angled Piece comes down in the front of each of the respective Alignment Rings and the other Angled Piece comes down in the rear for each of the respective Alignment Rings. All SEVEN parts just described for this Connecting Bar-cap 180 make contact with the respective Alignment Ring they are positioned over to ensure that the placement of each of the Three Alignment Rings is totally solid and that these Three Alignment Rings are virtually immovable.

The Roller Conveyor Mid-section Rear Conveyor Guide Rail System 189R serves the same purpose as the Conveyor Guide Rail 123R shown in FIG. 1D. This Rear Conveyor Guide Rail System 189R (in FIG. 1F) works in combination with its Front Counterpart Mid-section Guide Rail System 189F, and together these Two Guide Rail Systems, 189F and 189R, ensure that a canister will be aligned properly as the canister travels along the Mid-section of the Roller Conveyor 318 and moves in-and-through Alignment Rings 176, 177, and 178. The Roller Conveyor Mid-section Front Conveyor Guide Rail System 189F functions exactly the same as the Rear Mid-section Conveyor Guide Rail System 189R. However, this Front Guide Rail System 189F is shown in hidden lines, even though this Front Guide Rail System 189F is in front of all the Rollers 122 shown in FIG. 1F.

The Front and Rear “189 Guide Rail Systems” are in separate pieces that span: a) the short distance in front of (to the left of) Alignment Ring 176, b) the horizontal distance between Alignment Ring 176 to Alignment Ring 177, c) the horizontal distance between Alignment Ring 177 to Alignment Ring 178, and also d) the horizontal distance between Alignment Ring 178 and Alignment Ring 190 (shown in FIG. 1G; this section is “broken off” on the right of FIG. 1F and continues on the left of FIG. 1G).

Please note: these Two “189 Guide Rail Systems,” 189F and 189R, are Not a continuation of the Two Arc B Conveyor Guide Rails, 123R and 123F. The Set of Rear Mid-section Conveyor Guide Rail Paired Mounts 189MR support the Rear Mid-section Conveyor Guide Rail System; these Paired Mounts attach at the top to a respective “189R Guide Rail Section” and attach at the bottom to the top surface of the Frame of the Roller Conveyor 121. All of the Front Mid-section Conveyor Guide Rail System Paired Mounts 189MF function exactly like the “189MR Rear Paired Mounts.” However, all of these Front Paired Mounts 189MF are shown in hidden lines.

There is a Left Pair of Front and Rear Roller Conveyor Mid-section Stand-alone Vertical Support Beams 181 and these Two Beams help support the Roller Conveyor Mid-section. There is also a Right Pair of Front and Rear Roller Conveyor Mid-section Stand-alone Vertical Support Beams 182 and these Two Beams help support the Roller Conveyor Mid-section. The Rear Beams of both these Beam-pairs, 181 and 182, are “broken off.”

Turning now to FIG. 1G, there is a continuation of the Mid-section Rear Conveyor Guide Rail System 189R, but obviously the drawing is showing the Arc C Area 307 (referenced in FIG. 15) and not the Mid-section of the Roller Conveyor 318 (referenced in FIG. 1F). In any event and as mentioned above, on the far left of FIG. 1G there is a reference for the same straight section of the Guide Rail System 189R. Also shown in FIG. 1G, over more to the right, there is an additional “straight-and-curved” section of the Rear Conveyor Guide Rail System 189R. This Rear Conveyor Guide Rail System 189R (in FIG. 1G) works in combination with its Front Counterpart Guide Rail System, 189F, and together these Two Guide Rail Systems ensure that a canister will be aligned properly as the canister travels through the straight section and through the curved section of the Roller Conveyor 121 in the Arc C Area.

The Two Sections of the Roller Conveyor Arc C Front Guide Rail System 189F function exactly the same as the Two Sections of the Rear Guide Rail System 189R in FIG. 1G. However, these Two Sections of the Front Guide Rail System 189F are shown in hidden lines, even though these Two Sections are in front of all the Rollers 122 shown in FIG. 1G. The Set of Rear Arc C Conveyor Guide Rail Paired Mounts 189MR support the Rear Arc C Conveyor Guide Rail Sections; these Paired Mounts attach at the top to the Rear Guide Rail 189R and attach at the bottom to the top surface to the Frame of the Roller Conveyor 121. All of the Front Arc C Conveyor Guide Rail Paired Mounts 189MF function exactly like the Rear Paired Mounts 189MR. However, all of these Front Paired Mounts 189MF are shown in hidden lines.

The Arc C Vertical Alignment Ring 190 ensures that a canister will have perfect alignment as the canister travels along the Arc C Area Roller Conveyor 121. The Arc C Vertical Alignment Ring Mounting System 190M includes both Front and Rear Vertical Support Structures and also includes the Two Angled Pieces that go from the Two Vertical Structures to the Alignment Ring 190, in the front and in the rear of the Alignment Ring 190. The Rear Vertical Support Structure of 190M is partially shown. There is a Pair of Arc C Stand-alone Vertical Support Beams 191 and these Two Beams help support the Roller Conveyor 121 in the Arc C Area. The Rear Beam of this Beam-pair 191 is “broken off.”

Speed and Motion Sensor 192 detects when the Leading Edge of a canister is moving in front of it and immediately analyzes that data to determine how fast the canister is moving. Then, Speed and Motion Sensor System 192 causes the Three Arc C Canister Elevation Electromagnets: 192a, 192b, and 192c, to sequentially create Counter-magnetic Fields based on the analysis of the Motion Data. After receiving the signal from the Sensor System 192, the furthest left Arc C Canister Elevation Electromagnet 192a creates a “gentle” Counter-magnetic Field that is pulsed outward from this Canister Elevation EM 192a.

The net result is that a canister traveling horizontally will be gently “lifted off of” Roller Conveyor 121 in the Arc C Area (or pushed up and away from the Roller System) for a brief instant by the force of the Counter-magnetic Field (see Ten Numbered Points of Comparison; #1, par. 3). The Middle Arc C Canister Elevation Electromagnet 192b works in exactly the same way as Canister Elevation EM 192a; there is a Pre-determined Delay so that this EM 192b sends out its “EM Pulse” a split second after Elevation EM 192a sends out its pulse. The furthest right Arc C Canister Elevation Electromagnet 192c works in exactly the same way as Canister Elevation EMs 192a and 192b; there is a Pre-determined Delay so that Canister Elevation EM 192c sends out its “EM Pulse” a split second after Canister Elevation EM 192b sends out its pulse.

Speed and Motion Sensor 197S detects when the Leading Edge of a canister is moving in front of it and immediately analyzes that data to determine how fast the canister is moving. Then, the Speed and Motion Sensor System 197S causes the Three Vertical Angle Adjustment Electromagnets (VAA EMs): 197a, 197b, and 197c, to sequentially create Counter-magnetic Fields based on the analysis of the Motion Data. After receiving the signal from the Sensor System 197S, the Lowest Vertical Angle Adjustment EM 197a creates a “gentle” Counter-magnetic Field that is pulsed outward from this VAA EM 197a. The Middle VAA EM 197b works in exactly the same way as VAA EM 197a; there is a Pre-determined Delay so that this VAA EM 197b sends out its “EM Pulse” a split second after VAA EM 197a sends out its pulse. The Topmost VAA EM 197c works in exactly the same way as VAA EMs 197a and 197b; there is a Pre-determined Delay so that VAA EM 197c sends out its “EM Pulse” a split second after VAA EM 197b sends out its pulse.

This set of Three Vertical Angle Adjustment EMs has a much different purpose than the Canister Elevation EMs. The Canister Elevation EMs (192a, 192b, and 192c) work against the force of gravity and their purpose is to eliminate as much friction as possible by keeping a canister “suspended” away from the Roller System; it is understood that gravity will always be pulling the canister back down towards these Canister Elevation EMs. The Three Vertical Angle Adjustment EMs, however, are actually manipulating the angle of ascent for a canister and the sole purpose of the combined result of the Three VAA EMs, 197a, 197b, and 197c, is to make sure that the central axis of each canister is directly in line with the center of Alignment Ring 193, as much as possible, by the time the Leading Surface of the respective canister is entering Alignment Ring 193.

FIG. 39 shows a few various angles a canister will be at as it ascends up from a horizontal direction and as its Direction of Motion is converted to a True Vertical Alignment before entering Alignment Ring 193R, which is the horizontal mirror image of Alignment Ring 193. (FIG. 39 is for a Dual Arc C Roller Section sub-embodiment, but the ascent of a canister up through either of these two Roller Conveyor structures is the same for each individual Roller Conveyor structure.) There is a “margin of error” that is tolerable, because Alignment Ring 193 will guide a canister back towards the center of the Alignment Ring (see FIG. 8a), but a canister cannot be “too far off” of the center of Alignment Ring 193 or the canister's Leading Surface will smash directly and bluntly into the bottom surface of Alignment Ring 193 (as opposed to going through the center of the Alignment Ring) and the overall MF device will shut down and all operations will immediately cease.

The precise strengths of the EM pulses from these Three VAA EMs, 197a, 197b, and 197c, can be pre-determined during a testing period before a MF device is operated for the first time. If there is any question that this vertical alignment will not be performed successfully for every Cycle by these Three VAA EMs, a sub-embodiment can be utilized whereby a “pre-alignment” funnel-like ring (with the smaller part of the funnel at the top; with a larger diameter than Alignment Ring 193) can be placed below Alignment Ring 193 and such a “pre-alignment” ring will help guide a canister towards the center of Alignment Ring 193 if the horizontal position of the canister's primary (vertical) axis is not aligned close enough with the center of Alignment Ring 193.

The Arc C Horizontal Alignment Ring 193 ensures a canister is ascending with perfect vertical alignment and that the canister is perfectly centered underneath the Arc C Pre-launch; Speed-adjusting Electromagnet (EM#2) 195.

The Arc C Horizontal Alignment Ring Mount 193M attaches the Alignment Ring 193 to the Two Vertical Structural Beams of the “Fluid Side Lower Right-side Vertical Support Structural System” 299R. The “Fluid Side Lower Right-side Vertical Support Structural System” 299R supports the curved part of the Arc C Roller Conveyor in the Arc C Area and also supports other equipment in the Arc C Area. This Structural Beam System 299R extends upward into the Pre-launch Area and supports the equipment on the right side of the Pre-launch Area.

The Vertical Support Structural System 299R includes the Front and Rear Right-side Vertical Structural Beams and any Cross-member Beams that connect the Front and Rear Vertical Structural Beams. This System is designated as “Lower” because the Main vertical support structure for the Fluid Side Coil Stack is a different Structural System that starts (going upwards) in the Underwater Launch Area. The Two Arc C Structural Support Slanted Reinforcing Beams 299SL (includes Front and Rear Slanted Beams) help strengthen the Two Vertical Structural Support Beams in the 299R Beam System. The Four Beams just discussed are all sitting on the Subterranean Floor 317.

The Fluid Side Lower Left-side Vertical Support Structural Beam System 299L is a Vertical Beam Support System that passes through the Arc C Area, but does not support anything in the Arc C Area. This Beam Support System 299L extends upward into the Pre-launch Area and supports the equipment on the left side of the Pre-launch Area (see Drawing Exception 5).

The Lower Speed and Motion Sensor 194 (for Arc C Pre-launch; Speed-adjusting Electromagnet EM#2 195) detects when the Leading Edge of a canister is moving in front of it and immediately analyzes that data to determine how fast the canister is moving. Then, this Sensor System 194 immediately sends a signal to the Arc C Pre-launch; Speed-adjusting Electromagnet (EM#2) 195. The Lower Speed and Motion Sensor Mount 194M is one short Block-type piece and the top of this Block attaches to the bottom of Sensor 194 and the bottom of the Block attaches to the top surface of the Far Right Horizontal Beam (of 193M).

As described above, there is an Arc C Pre-launch; Speed-adjusting Electromagnet (EM#2) 195. When this EM#2 195 receives the Activation Signal from Motion Sensor 194, this EM#2 creates a Magnetic Field that will either oppose or attract the magnet inside the canister that is traveling upward; at that point the canister will be in the process of entering this EM#2 195 from the bottom. The reason there is a choice as to whether to speed up or slow down the canister is fully explained below (see 13 Topics; #1, “Coupling Process”). In any event, the canister will keep climbing upward, will move through this EM#2 195, and will then begin to exit out the top of this EM#2 195.

As the Leading Edge of a canister passes in front of the Upper Speed and Motion Sensor 196 (for Arc C Pre-launch; Speed-adjusting Electromagnet EM#2 195), this Sensor 196 detects that the Leading Edge of a canister is moving in front of it and then immediately analyzes that data to determine how fast the canister is moving. This Sensor System 196 will determine if EM#2 195 should either: a) keep the present Electromagnetic Field in place (a Magnetic Field that has already been affecting the magnet inside the canister that is passing through EM#2 195) or b) weaken, strengthen or reverse the Magnetic Field, or c) totally shut off the Magnetic Field.

All of these options regarding this EM#2 195 depend on how fast a canister MUST be traveling at the point when it moves in front of this Sensor 196, in order for that canister to achieve a successful “Coupling” with the other canister that is waiting in the Pre-launch Area, approximately 32 inches or 34 inches above this Sensor 196. There is more information below about the importance of the “Coupling Speed” between Two Canisters when they make initial contact with each other in the Pre-launch Area (see 13 Topics; #1, “Coupling Process”). At a pre-determined time after EM#2 195 was activated to create the Magnetic Field(s) being discussed for EM#2 195, the Magnetic Field will be terminated because the canister's magnet will be out of range of the Magnetic Field of EM#2 195.

The Arc C Pre-launch; Speed-adjusting Electromagnet (EM#2) Mounting System 195M includes: a) Three Horizontal Beams and b) a Circular Belt-type Mounting Band that goes completely around EM#2 195. The Front Horizontal Beam is attached to the Front Vertical Structural Beam (of the Structural Beam System 299R) and this Front Horizontal Beam also attaches to the Circular Belt-type Mounting Band in the front of EM#2 195. The Rear Horizontal Beam is attached to the Rear Vertical Structural Beam (of the Structural Beam System 299R) and this Rear Horizontal Beam also attaches to the Circular Belt-type Mounting Band in the rear of EM#2 195. However, the rear portion of this Mounting System 195M is not shown. The Third Horizontal Beam goes across the Front and Rear Vertical Beams of the Structural Beam System 299R and this Third Beam is “broken off” and this “break” is shown with hatched lines.

The Upper Speed and Motion Sensor Mount 196M is one short Block-type piece and the top of this Block attaches to the bottom of Sensor 196 and the bottom of the Block attaches to the top surface of a Horizontal Cross Beam of the Structural Beam System 299R. (Note: the Four “Fragment Pieces” of 213L and 216ML shown in the upper middle of FIG. 1G were discussed in Drawing Exceptions #5; reference for 216ML is found in the description given for the components related to FIG. 1H; 213L is referred to as the Left-side Counterpart of 213R.) Turning now to FIG. 1H, the Right Half of the Pre-launch Launch Platform 211R is one-half of the overall Launch Platform for the Pre-launch Area 308 (the “308” reference is shown in FIG. 15). When the Two Launch Platform Halves (211R and 211L) are coupled together, the combination of the two halves can be referred to as “the Pre-launch Launch Platform,” although there is no formal part reference of 211 by itself. This Pre-launch Launch Platform is used during the Pre-launch Process to elevate Two Canisters at the same time (see 13 Topics; #2, “Pre-launch Process”) so that the canisters end up with the Upper Canister being moved totally “into the Fluid” (into the Underwater Launch Area) and the Lower Canister is moved precisely into the position the Upper Canister had at the beginning of the Pre-launch Process (the Lower Canister becomes the Upper Canister).

FIG. 11 shows the best view of the Two Halves of the Pre-launch Launch Platform. The Left Half of Pre-launch Launch Platform 211L operates as an exact mirror image to the operation of its Right Counterpart, 211R. The Spring Matrix 211SpR (for Right Half of the Launch Platform) is there to cushion the downward impact that occurs when the Two “coupled canisters” fall back down onto the Launch Platform (see 13 Topics; #9, “Springs Absorb Shock, Sub-section C”), at the end of the Coupling Process. The Spring Matrix for Left Half of Launch Platform 211SpL operates in exactly the same manner as Spring System 211SpR. The Semicircular Elevated Enclosure 211EvtR is attached to the right half of the Launch Platform 211R; this Elevated Enclosure 211EvtR is there to ensure that the bottom surface of a canister is in exactly the right position: a) just prior to the start of the Pre-launch Process, and b) during the entire Pre-launch Process.

The Semicircular Elevated Enclosure for the Left Half of Launch Platform 211EvtL operates as an exact horizontal mirror image to its Right Counterpart, Elevated Enclosure 211EvtR. [Note: there is no Nose Cone Protrusion, in halves, mounted onto the Two Halves of the Pre-launch Launch Platform, 211L and 211R. Such “Protrusion” is not necessary during the Pre-launch because: a:) there will be very strong downward pressure on the Two Canisters (from the Leading Surface of the Upper Canister) and this pressure will help to keep the Two Canisters in alignment during the Pre-launch, and b) the Pre-launch is a much slower “Launch” than either of the other Two Launches (the Air Side Launch and the Underwater Launch).]

The Solid Horseshoe-shaped Bar 211HR (shown in FIG. 11) is the main “launching surface” on the Right Half of the Pre-launch Launch Platform 211R. This Horseshoe-shaped Bar 211HR makes the strongest contact with a canister on the right side of the Pre-launch Launch Platform and is the main surface that pushes the canister upwards, during the Pre-launch Process. Even though in FIG. 11 all of the Springs extend up higher than the Two Horseshoe-bars 211HR and 211HL, when a canister is sitting on the Pre-launch Launch Platform, and especially during the Pre-launch Process when upward force is applied to the canister, all of the Springs compress so that the Two Horseshoe-bars 211HR and 211HL are the primary surfaces providing the majority of the upward force to the canister during the Pre-launch Process. The Solid Horseshoe-shaped Bar 211HL (on the Left Half of Launch Platform) operates in exactly the same manner as the Horseshoe-bar 211HR. On the left side of the Pre-launch Launch Platform, during the Pre-launch Process it is the Horseshoe-Bar 211HL that makes most of the contact with the bottom surface of the canister, and Not the 211SpL Spring Matrix.

FIG. 11 also shows two things about the Two Suspension Solenoid Plunger-rods, 227LP and 227RP, which are shown as phantom components 227LP-Ph and 227RP-Ph in FIG. 11, and both illustrative points are to show how these Two Plunger-rods are extended out underneath the bottom surface of a canister that is making contact with the Two Horseshoe-bars 211HR and 211HL. First, the vertical height of each of the Two Plunger-rods is slightly less than the height of the respective Horseshoe-bar that a Plunger-rod is sliding next to, and therefore there is clearance between the bottom surface of the canister (that is sitting on the Two Horseshoe-bars) and the Two Plunger-rods, because the vertical distance between the flat surface of the Launch Platform (on each half) and the bottom of the respective canister (that is sitting on top of the Two Two Horseshoe-bars) is slightly more than the height of the respective Plunger-rod.

Second, FIG. 11 shows how all of the components “in the middle” of a united platform, after both halves have been completely shoved in towards each other, are concentrated in the center portion of a joined Launch Platform so that there is room for the Two Plunger-rods to slide in just outside the outer edges of the two Two Horseshoe-bars and still have enough room to also be in under the bottom surface of the respective canister that these Two Plunger-rods will be supporting. FIG. 1H-4 shows this relationship much better, between the Two Plunger-rods and the bottom surface of a respective canister; FIG. 11, with respect to the Two Plunger-rods, is just showing how these two rods operate and are positioned, in relationship to the peripheral components mounted onto the Two Halves of the overall Pre-launch Launch Platform.

Turning once again to FIG. 1H, the Connecting Interface 211MR (for Right Half of Pre-launch Launch Platform) connects the Right Half of the Launch Platform (211R) to the Forcer 212R (of LM-2R). This Connecting Interface 211MR allows the Three Pieces, 211R, 211MR, and 212R to move horizontally, to the left and right, and vertically, up and down, as if these three pieces were one unit. The Connecting Interface 211ML (for Left Half of Pre-launch Launch Platform) operates in exactly the same manner as its right side Counterpart, 211MR; in FIG. 1H, the Connecting Interface 211ML is “broken off” at its far left edge.

There is a reference for the Forcer 212R (for the Right LM-2); there is an explanation above about what a “Forcer” is (see Brief Summary; Par. 9, “A Forcer”). The Forcer for the Left LM-2 is not shown, but the Left LM-2 Forcer operates as an exact mirror image to the operation of its Right Counterpart, Forcer 212R. FIG. 1H-2 shows a Support Structure 213R (for Two Cylindrical Rods, 214FRd and 214RRd); the Cylindrical Rods 214RRd and 214FRd support the Right-side Solenoid Interface 215R. The Left-side Counterpart for this Support Structure 213R is not shown in FIG. 1H. However, FIG. 1G does show where the Two Vertical Legs of the Left-side Support Structure (the Left-side Counterpart of 213R) would extend down, as these Support Legs head towards the Subterranean Floor 317.

The Front Right Horizontal Cylindrical Rod 214FRd that supports the Right-side Solenoid Interface 215R is a non-moveable component and the bottom surface of the claw-like component of the Right Pre-launch Solenoid Interface 215R slides back and forth, horizontally, over Both Right-side Cylindrical Rods, 214FRd and 214RRd. The Two Front and Rear Left-side Counterparts of Cylindrical Rods 214FRd and 214RRd, respectively, are not shown, but Both Left-side Cylindrical Rods operate as exact horizontal mirror images to the operation of their Right-side Counterparts, 214FRd and 214RRd. The Right Pre-launch Solenoid Interface 215R includes three pieces: the far left Cube-like Piece that wraps around and grabs on to the right LM-2 218R (Linear Motor 2, Right) the Angled Middle Piece; the Circular “Cap” that is fitted onto the end of the Solenoid Plunger 216PR. The Left Pre-launch Solenoid Interface is not shown, but operates as an exact mirror image to the operation of its Right-side Counterpart, 215R.

There is a Plunger 216PR (for the Right-side Pre-launch Positioning Solenoid) but the combination of components 216PR and 216BR form the overall Right-side Positioning Solenoid, and this Solenoid provides the power to move the Right-side LM-2 218R and the Right Half of the Pre-launch Launch Platform 211R back and forth, horizontally. The Body of Right-side Pre-launch Positioning Solenoid 216BR is the primary part of the overall Right-side Pre-launch Positioning Solenoid. The Plunger 216PL (for the Left-side Pre-launch Positioning Solenoid) operates as an exact mirror image to the operation of its Right-side Counterpart, 216PR. This Left-side Plunger 216PL is only partially shown. The Body of Left-side Pre-launch Positioning Solenoid 216BL is the primary part of the overall Left-side Pre-launch Positioning Solenoid.

The Right-side Pre-launch Positioning Solenoid Mounting System 216MR is two pieces; the larger piece is one continuous piece that curves over the top of the Body of the Solenoid and then has Two Wide Legs (front and rear) that extend down all the way to the Subterranean Floor 317 (this Floor 317 is shown in FIG. 1G; however, Mounting System 216MR is not shown in FIG. 1G because the Mounting System 216MR is off too far to the right to be seen in FIG. 1G). The second piece of the Mounting System 216MR is a Supporting Piece for the “underbody” of the Solenoid; this Piece is curved to match the shape of the “underbody” of the Solenoid 216BR and this Supporting Piece fits up tightly along the front and rear “seams” into the top, larger piece of Mounting System 216MR, thus providing a tight-fitting complete enclosure into which the Solenoid 216BR is securely positioned. The Left-side Pre-launch Positioning Solenoid Mounting System 216ML operates as the horizontal mirror image to the operation of its right-side Counterpart, Mounting System 216MR. The two wide Legs (front and rear) of the Mounting System 216ML extend all the way down to the Subterranean Floor 317; in FIG. 1H both of these Legs are “broken,” but their position is shown in FIG. 1G, as these two Legs are headed towards the Subterranean Floor 317.

There is a Lower Motion Sensor 217LS and an Upper Motion Sensor 217US. The operation of this “217 Sensor Pair” is fully explained in 13 Topics; #1, “Coupling Process” and also the physical placement of this “217 Sensor Pair” is partially explained above in Overriding Priorities #2. However, to explain briefly here, the Upper Motion Sensor 217US is positioned about twelve inches below the bottom surface of a suspended Upper Canister (this canister is not shown in FIG. 1H, but is shown in FIG. 15; also the vertical placement for this Upper Motion Sensor 217US would be approximately twenty-four inches below the vertical mid-point of the Notch Grips 219F and 219R, for a canister with a length of twenty-eight inches, because about sixteen inches of such a canister will be above these Notch Grips; see FIG. 2a regarding Notch placement on a canister). This Upper Sensor 217US recognizes when the Leading Surface of a canister is passing in front of this Sensor 217US and the Sensor then immediately sends two sets of signals: first, two identical signals to the Two Suspension Support Rods (227L and 227R) causing them to immediately retract out from underneath the bottom surface of the suspended Upper Canister, and a split second later, a second set of signals to the Two Notch Grip Solenoids, 220F and 220R, and these Solenoids also go into the retract mode, thereby pulling the Two Notch Grips, 219F and 219R, out of the Notch of the Upper Canister. This means the Upper Canister will not “fall back down” any substantial distance because at roughly the same time the Upper Canister is released by the Two Notch Grips, the Lower Canister will be making contact with the Upper Canister (from below) and will be pushing the Upper Canister up, as part of the “Coupling Process.”

The Lower Motion Sensor 217LS is concerned with the bottom surface of that same Lower Canister. This Lower Motion Sensor 217LS is vertically positioned so that all the “detection information” is given for a vertical height that is approximately equal to the topmost point of any of the Springs in the Spring Systems 211SpL and 211SpR. In other words, when the bottom surface of the Lower Canister moves up above where the Spring Systems 211SpL and 211SpR would be (at that point when the Lower Canister is moving upwards in the Pre-launch Area, the Two Launch Platform Halves, 211L and 211R are obviously in the Retracted State), this Lower Sensor 217LS recognizes this fact and immediately sends an identical signal to each of the Two Pre-launch Positioning Solenoids, 216BL and 216BR. When these powerful Solenoids receive that Activation Signal, these Solenoids quickly push the Two Launch Platform Halves 211L and 211R together, while the Two Canisters are moving upward (from the momentum of the Lower Canister). Time is of the essence because shortly after the Lower canister passes the Sensor 217LS moving upward, that same canister will begin moving back downward with substantial downward force. At the end of the Coupling Process, the bottom surface of the Lower Canister lands on top of the Two Spring Systems, 211SpL and 211SpR (see 13 Topics; #1, “Coupling Process”).

The Lower Motion Sensor Mounting System 217MLS (for the Lower Motion Sensor 217LS) includes two pieces, an Angled, Upward-sloping Piece and a Horizontal Piece. The bottom of the Angled, Upward-sloping Piece attaches to the Sensor 217LS and the top of the Angled Piece attaches to the Horizontal Piece of the Mounting System 217MLS. This Horizontal Piece is attached to the Rear Vertical Beam (of the “Structural Beam System 299R). The Motion Sensor Mount 217MUS (for the Upper Motion Sensor 217US) is One Angled, Upward-sloping Piece. The top of this Angled, Upward-sloping Piece attaches to the Sensor 217US and the bottom of this Angled Piece attaches to the Horizontal Piece of the Mounting System 217MLS.

The reference for the Right LM-2 218R includes the entire Right-side Linear Motor #2 (LM-2); this LM-2 218R is that collection of Multiple Vertical “Strips” all grouped very closely together; these Vertical “Strips” are enclosed by a Top and Bottom End-cap, but the Bottom End-cap is not shown in FIG. 1H. Also, the Left LM-2 is not shown in FIG. 1H, but the Left LM-2 218L is shown by a non-detailed, graphical representation in FIGS. 15-20.

The reference for the Front Pre-launch Area Notch Grip 219F refers to the entire Horizontal Piece, all the way back to the Notch Grip Solenoid (220F). The round circular areas on each of the Two Notch Grips, 219F and 219R, (what might be considered as “pincer-like” when looking at both of the “219 Notch Grips” together in FIG. 1H) have a rubber-like coating on them, that extends back about three-eighths of an inch towards the individual Solenoid Bodies, respectively. In other words, wherever the Notch Grips 219F and 219R actually engage into the Notch and actually make contact with the Notch of a canister, all of these surfaces are coated with a rubber-like material. Below is more specific operational information regarding this Pair of Notch Grips (see 13 Topics; #2, “Pre-launch Process”).

The Rear Pre-launch Area Notch Grip 219R operates as an exact horizontal mirror image to the operation of its Front Counterpart, the Front Notch Grip 219F. The Solenoid 220F (for the Front Notch Grip 219F) operates in the horizontal plane and pulls the Front Notch Grip 219F in and out of the Notch on a Canister (a canister Notch is shown as 73; FIG. 2a). The Solenoid for Rear Notch Grip 220R operates as an exact mirror image to the operation of its Front Counterpart, Solenoid 220F, and these Two Notch Grip Solenoids, 220F and 220R, move their respective Notch Grips in and out of the Notch at precisely the same time.

The Mounting Assembly 221MF (for the Front Notch Grip Solenoid) includes a long Horizontal Cube-like Beam and a Curved Mounting Brace for additional strength. The Horizontal Beam and the Brace are both mounted to the Right-side Vertical Support Wall 224R. This Mounting Assembly 221MF supports the Solenoid 220F (which connects to the Front Notch Grip). The Mounting Assembly 221MR (for the Rear Notch Grip Solenoid) has the same Mounting Configuration and has the same purpose as its Front Counterpart, Mounting Assembly 221MF, except that the Rear Mounting Assembly 221MR supports the Solenoid 220R (which connects to the Rear Notch Grip).

The Top End-cap 222TR (for the 218R Right LM-2) is there to keep the Vertical “Strips” of the Right LM-2 218R in the proper position, relative to each other. As the Right Pre-launch Positioning Solenoid (216PR/216BR) retracts, this End-cap 222TR basically cannot move up and down, because the vertical position of this End-cap 222TR is fixed, according to the height of the various Vertical Strips of the Right LM-2 218R. However, this End-cap 222TR does slide back and forth over Two Horizontal Rods, 223FRd and 223RRd, and these Two Rods tend to add additional stability to that back-and-forth motion for the entire LM-2 System. The Bottom Right-side End Cap, the Top Left-side End Cap, and the Bottom Left-side End Cap are not shown. As mentioned in the “Hidden Line Exceptions,” the End-cap 222TR is shown in hidden lines, even though it is in front of (over the top of) other components that are shown in solid lines.

The Front Right Horizontal Support Rod 223FRd supports the Top End-cap 222TR (for the Right LM-2 218R), as explained in the preceding paragraph regarding the Top End-cap 222TR. The Front Horizontal Support Rod for the Top End-cap (for the Left-side LM-2) is not shown. The Rear Right Horizontal Support Rod 223RRd (for the 222TR Top End-cap) operates in exactly the same manner as the Front Right Horizontal Support Rod 223FRd. The Rear Horizontal Support Rod for the Top End-cap for the Left-side LM-2 is not shown. The Mounting System 223MFR (for the 223FRd Front Right Horizontal Support Rod) includes a Cube-like Mounting Block that attaches to Vertical Support Wall 224R and supports the Front Support Rod 223FRd. Also included in this Mounting System 223MFR is a Triangular Support Wedge that gives additional support to the Support Rod 223FRd. The Front Mounting System for the Left-side Horizontal Support Rod is not shown.

The Mounting System 223MRR (for the 223RRd Rear Horizontal Support Rod) has an identical Mounting Configuration as that of Mounting System 223MFR. The Rear Mounting System for the Left-side Horizontal Support Rod is not shown. The Front Vertical Support Beam 223SFR (for the 223FRd Front Right Horizontal Support Rod) goes directly underneath the Front Right Horizontal Rod (223FRd) and therefore the Top End-cap 222TR has clearance to move back and forth, horizontally, on the top of the Support Rod 223FRd. The Rear Right-side, and both Front and Rear Left-side Vertical Support Beams, which are like the Vertical Support Beam 223SFR, are not shown. There is a Right-side Vertical Support Wall 224R; only the upper portion (where the Right-side equipment is mounted) of this Support Wall 224R is shown, and therefore this wall is “broken off” at the bottom. The Left-side Vertical Support Wall is not shown.

There is a “phantom” Arc C Pre-launch; Speed-adjusting Electromagnet (EM#2) PH195 shown at the bottom of FIG. 1H. This “phantom” EM#2 195 is in this drawing to illustrate the related continuous vertical alignment that exists between the Arc C Area and the Pre-launch Area.

Turning now to FIG. 1H-3, the small Front Locking Pin 225F (for the Right Half of Pre-launch Launch Platform), along with the Rear Counterpart to this Front Locking Pin 225F, the Locking Pin 225R, are both there to ensure the two halves (211R and 211L) of the Launch Platform “mesh” into what is basically one solid Launch Platform.

The Front Female Counterpart 226F (for the 225F Front Locking Pin) is a Cut-away Area on the Left Half of the Pre-launch Launch Platform 211L. This cut-away area is exactly the same shape and slightly larger than the Locking Pin 225F. When the Locking Pin 225F moves into this “Cut-away Area” 226F, the two halves of the Pre-launch Launch Platform become as one piece. The Rear Female Counterpart 226R (for the Rear Locking Pin 225R) operates in exactly the same manner as the Front Female Counterpart 226F.

Turning now to FIG. 1H-4, there is a Left Suspension Support Rod 227L and a Right Suspension Support Rod 227R, and each of these components is a solenoid-type structure with a separately referenced plunger component, which are: Left Suspension Solenoid Plunger-rod 227LP and Right Suspension Solenoid Plunger-rod 227RP. The Solenoid Bodies of these two main components are supported by: Left Support Arm 228L (for Left Suspension Solenoid Body) and Right Support Arm 228R (for Right Suspension Solenoid Body). These Two Body-related Support Arms are identical and each have three parts (not referenced separately): Curved Vertical Strut; Horizontal Beam; Corner Brace. On the front side of the overall suspension system related to these components there are individual supports for the Two Suspension Solenoid Plunger-rods, and these individual supports are: Support Arm 229L (for Left Suspension Solenoid Plunger-rod) and Support Arm 229R (for Right Suspension Solenoid Plunger-rod). These Two Plunger-Rod Support Arms are identical and each have three parts (not referenced separately): Support Cup; Horizontal Beam; Corner Brace.

Left Suspension Support Rod 227L and Left Support Arm 228L (for Left Suspension Solenoid Body) are mounted in or on the Rear Beam of Vertical Support Structural Beam System 299L; Right Suspension Support Rod 227R and Right Support Arm 228R (for Right Suspension Solenoid Body) are mounted in or on the Rear Beam of Vertical Support Structural Beam System 299R. When the Two related Suspension Solenoid Plunger-rods are fully extended (towards the front of the drawing), the tips of these Plunger-rods are supported by Support Cups, which are part of respective Left and Right Supporting Arms (for the respective Plunger-rods), which are: 229L and 229R, respectively. The Horizontal Beam and the Corner Brace of Left Supporting Arm 229L (for Left Suspension Solenoid Plunger-rod) are attached to the Front Beam of Vertical Support Structural Beam System 299L. The Horizontal Beam and the Corner Brace of Right Supporting Arm 229R (for Right Suspension Solenoid Plunger-rod) are attached to the Front Beam of Vertical Support Structural Beam System 299R.

FIG. 1H-4 shows a Canister C-101Ph, and this phantom canister is being acted upon and supported in two ways, which is that: a) the two Notch Grips 219F and 219R are engaged into the Notch of Canister C-101Ph (and are stabilizing Canister C-101Ph horizontally), and also b) the two Suspension Solenoid Plunger-rods are extended out of the related Solenoid Bodies, and these Two Suspension Solenoid Plunger-rods are extended in underneath the bottom surface of Canister C-101Ph, and are therefore supporting the canister from underneath the bottom surface. In real operation of the MF device, the Two Pre-launch Launch Platform Halves (211L and 211R) would be in the retracted mode, so that another canister could come up underneath Canister C-101Ph and couple with this canister, but for the sake of showing spatial relationships, the Two Pre-launch Launch Platform Halves are extended out and are almost totally joined together as one solid Launch Platform, to show that there is enough room for a “united” platform to elevate up to the bottom surface of Canister C-101Ph, at a time when both Left Suspension Solenoid Plunger-rod 227LP and Right Suspension Solenoid Plunger-rod 227RP are in the retracted mode.

Turning now to FIG. 1I, the Bottom Partition 230 (of the Fluid Column) can be considered as the “Floor” of the Fluid Column. However, this component is not just the “Floor” of the Fluid Column because it is also the “Ceiling” of the Pre-launch Area 308. This “Partition” acts as a divider between air, on its underside, and Fluid (such as water) on its top side. There is a round hole in this Bottom Partition 230, which is directly below and which is slightly larger in diameter than the hole in the Mounting Plate 231; this Mounting Plate 231 is sitting directly on top of the Bottom Partition 230. The Mounting Plate 231 (for the Primary Seal 232) is a totally flat, rather thin component that has a perfectly round hole into which the Primary Seal 232 is mounted.

The hole in this Mounting Plate 231 is perfectly aligned with the slightly larger hole in the Bottom Partition 230. As mentioned above, this Mounting Plate 231 sits directly on the Bottom Partition 230. The method of attachment for securing the Bottom Partition 230 and the Mounting Plate 231 together provides for a Waterproof Seal (between the two components, 230 and 231) so that no Fluid, whatsoever, leaks out between these two components. In addition, no Fluid leaks out of the Primary Seal 232, either: a) around the edges where the Primary Seal is mounted to this Mounting Plate 231, or b) around the circular areas in the horizontal plane, where the Lip of the Primary Seal 232 makes contact with a canister. The Primary Seal 232 is a rubber-like, perfectly round Piece that is mounted in the hole in the Mounting Plate 231. This Primary Seal 232, although very simple in its construction, is one of the most important parts of the entire MF device (see 13 Topics; #2, “Pre-launch Process”).

FIG. 1I shows a “phantom canister” PhC-Uw (in the Underwater Launch Area 310). This “phantom canister” PhC-Uw is there to show that in the Pre-launch Phase, before the Pre-launch Process actually begins, a canister will be sitting for a brief period of time (about 3 seconds) with approximately 4 inches of the canister body sticking up “into the Fluid,” above the top of the Primary Seal 232. Also, by looking at the outer diameter of the body of this “phantom canister” PhC-Uw, the vertical path of travel for a canister, through the Underwater Launch Area 310, can be realized in relationship to the vertical alignment and general positioning of all the other related pieces of equipment above the canister. (Please see Drawing Exception 2 above about how the Underwater Launch Platform 233 would never be extended-out unless a canister was “fully up inside” the Underwater Launch Area).

The Underwater Launch Platform 233 includes an elevated section that helps to keep the bottom surface of a canister in proper alignment during the Underwater Launch Process. There is also a Nose Cone Protrusion Shape 233NC centered in the middle of, and mounted to, the Underwater Launch Platform 233; this Protrusion 233NC adds more stability to the alignment of a canister during the Underwater Launch Process. There are Three Cut-away Notches 233N (in the Underwater Launch Platform 233) and this Set of Notches 233N includes the Front Notch, the Rear Notch, and the Left-side Notch. Mounting Interface 233M (for the Underwater Launch Platform 233) attaches the Launch Platform 233 to the LM-3 Forcer 234, so that the Launch Platform 233 essentially acts as an extension of the Forcer 234.

There is a Forcer 234 (for LM-3); for what a Forcer is see Brief Summary; Par. 9, “A Forcer.” Vertical Stop-Beam 234Stp is there (referenced in FIG. 1I-2) to ensure that Forcer 234 always stops at the same vertical position when the Forcer 234 is reset after performing an Underwater Launch. The bottom of Forcer 234 makes contact with the top of this Stop Beam 234Stp. The Front Vertical Rod 234FRd is part of a Pair of Rods that in combination with each other, define the vertical pathway upon which the Forcer 234 travels. These Two Vertical Rods, 234FRd and 234RRd, are stationary and the Forcer 234 moves up and down on the Rods. The Rear Vertical Rod 234RRd works in combination with the Front Vertical Rod, 234FRd, as described above; this Rod 234RRd is shown in FIG. 1I-2. The Magnet Track 235 (of LM-3 236) is a stationary vertical component of LM-3 236. This Magnet Track 235 provides the Magnetic Power used by the Forcer 234 to create vertical movement. The best view of this Magnet Track 235 is in FIG. 1I-2. There is a reference for the entire Underwater Launch Area Linear Motor (LM-3) 236.

The Attachment Interface 237 (going between LM-3 236 and the Plunger 238P of the Underwater Area Positioning Solenoid) includes the entire Claw-like Piece that solidly holds LM-3 236. This Attachment Interface 237 also includes the Circular Fitting (on the far right of the Attachment Interface 237) that is “pressed on” to the left end of the Solenoid Plunger 238P. As just mentioned, there is a Plunger 238P (for the LM-3 Positioning Solenoid), but the combination of components 238P and 238B form the overall Positioning Solenoid, and this Solenoid provides the power to move LM-3 236 and the Underwater LM-3 Launch Platform 233 back and forth, horizontally.

The Body of the LM-3 Positioning Solenoid 238B is the primary part of the overall Underwater Launch Area LM-3 Positioning Solenoid. The Mounting System 238M (for the LM-3 Positioning Solenoid) includes a Pair of Mounting Straps and also includes Four “Legs and Feet” (a Left and Right, Front and Rear Set). This Pair of Mounting Straps attach to the Body 238B (of the LM-3 Positioning Solenoid) by going around and over the upper part of the Solenoid Body 238B, and then the Two Straps connect to the Four “Legs;” the Four Legs come down at an angle and are attached to the respective Four Feet. All of the Four Feet for this Mounting System 238M sit upon, and are attached to, the Bottom Partition (Floor) 230 (of the Fluid Column).

The Vertical Mounting Structure 239 is a sturdy two legged structure that is part of the Base for the Right-side Support Beam-system 248 (the Beam-system 248 supports the entire Right Side of the Fluid Column Coil Stack 322). This Vertical Mounting Structure 239 includes Two Vertical Legs with Two Adjoining Feet (the Rear Foot is positioned on the Bottom Partition Floor 230 and the Front Foot is positioned on the Mounting Plate 231). In addition, this Vertical Mounting Structure 239 includes an Angled Cube-like Piece that connects the Two Legs of the Structure to the Horizontal Extension 240. In an additional sub-embodiment, strength could be added to the Vertical Structure 239 by including Two Horizontal “Arms” that go from the Angled Piece at the top of the Vertical Structure 239 straight across to the left, and these Horizontal “Arms” would attach to the Vertical Structural Support Wall 249. These “Arms” would go on the outside (in the front and in the rear) of the Quad Guide Assembly 243. In such a sub-embodiment, the Vertical Structural Support Wall 249 would need to be wider, front to back, to make room to attach these two horizontal “Strengthening Arms.”

The Horizontal Extension 240 (an extension of the Vertical Mounting Structure 239) is a very important Mounting Piece that is firmly attached to the Vertical Mounting Structure 239. This Horizontal Extension 240 supports: a) the Right-side Floatation Point Retaining Pin Mounting System, 245MR, b) the right sides of the Two Quad Guide Assemblies, 242 and 243, and c) most importantly, the Main Vertical Support Beam for the Right Side of Fluid Side Coil Stack (this Beam is part of the Support Beam System 248).

The far left edge of the Modified Quadrilateral Guide Assembly 241 attaches directly to the Vertical Structural Support Wall 249. This Modified Quad Guide Assembly 241 has only three Canister Guides. The right Guide is omitted so that the Underwater Launch Platform 233 can pass by this Quad Guide Assembly 241 with no obstructions in its path. Having only three Guides for the beginning of the Underwater Launch Process will be sufficient because the next Quad Guide Assembly, 242, is mounted at a vertical point about equal to the top of LM-3 236, and the Quad Guide Assembly 242 will be able to bring a Canister (being launched) into Full Vertical Alignment, even if the Three Guides of the Modified Quad Guide Assembly 241 do not provide for an “absolutely perfect” vertical alignment at the beginning of the Underwater Launch Process.

The Modified Quadrilateral Guide Assembly Additional Mount 241M is a Curved Corner Brace that gives added strength to the Quad Guide Assembly 241. This Additional Mount 241M attaches to the Quad Guide Assembly 241 and also attaches to the Vertical Structural Support Wall 249. The left side of the Lower Quadrilateral Guide Assembly 242 mounts directly to the Vertical Structural Support Wall 249. Also, the left side of the Upper Quadrilateral Guide Assembly 243 mounts directly to the Vertical Structural Support Wall 249.

The right side of the Upper Quad Guide Assembly 243 mounts directly to the left surface of the Horizontal Extension 240. The right side of the Lower Quad Guide Assembly 242 mounts to the Vertical Drop-down Mounting Bar 244. Both of these Two Guide Assemblies, 242 and 243, help ensure a canister is ascending with True Vertical Alignment and that the canister is directly underneath other essential pieces of equipment that all operate inside the Fluid Column. The Vertical Drop-down Mounting Bar 244 is the component onto which the Lower Quad Guide Assembly 242 is mounted, as stated above. This Drop-down Mounting Bar 244 is firmly attached to the underside of a mounting block, which is part of the Upper Quad Guide Assembly 243 and is on the far right side of the Quad Guide Assembly 243. (Note: this Mounting Bar 244 could be a little wider and thicker and could also attach, at the top, to the left edge-surface of the Horizontal Extension 240, but for illustration purposes, this Mounting Bar 244 was kept “thinner” so as not to obstruct the view of other components.)

In the vertical plane, the bottommost point of the Left (or Right) Floatation Point Retaining Pins 245L (or 245R) is called the “Floatation Point” 309 (shown in FIG. 15) and this “Floatation Point” vertically separates the Underwater Launch Area 310 from the Floatation-ascent Phase 311. When these Two Retaining Pins 245L and 245R retract, a canister will begin moving upward on its own force, which includes a combination of TWO forces, buoyancy and the Canister Length Pressure Differential Force (however, the Underwater Launch occurs almost simultaneously when the Two Retaining Pins, 245L and 245R, are retracted). There will be a point in time when the UPPER PORTION of a canister will be in the Floatation-Ascent Area of the device and the LOWER PORTION of the canister (everything below the Floatation Point) will still be in the Underwater Launch Area. Specifically at that point, the canister's bottom surface will be in the process of being “Launched” by the LM-3 Launching System.

In addition, structurally, unlike most solenoids (with plungers) in a MF device, these Two Floatation Point Retaining Pins, 245L and 245R, have nothing else attached to their Plungers; both of these “Retaining Pins” are the actual Plungers. The Right Floatation Point Retaining Pin 245R operates as an exact mirror image to the operation of its Left Counterpart, 245L (see 13 Topics; #3, “Underwater Launch Process”). The Wall Mount 245MW (for the Left Floatation Point Retaining Pin Solenoid 245L) is a small Cube-like Structure that has a hole in the middle of it that allows for the Solenoid Body (of the Left Floatation Point Retaining Pin 245L) to fit snugly into that hole. This Wall Mount 245MW (for the Left Retaining Pin Solenoid 245L) attaches directly to the Vertical Structure Support Wall 249. In addition, there is another hole in the Vertical Structure Support Wall 249, and the far left portion of the Solenoid Body (for the Retaining Pin 245L) fits snugly into that hole, as well.

The Mounting System 245MR (for the Right Floatation Point Retaining Pin Solenoid 245R) includes three pieces: two small Horizontal Beams that attach to the top and bottom of the Solenoid Body (of the Retaining Pin 245R) and a Small Vertical Beam that attaches to the Two Horizontal Beams and also attaches to the Horizontal Extension 240.

The Lowest Alignment Ring 246 (in the Fluid Side Coil Stack) is used to ensure a canister is ascending with True Vertical Alignment and that the canister is directly underneath and perfectly aligned with the first few Coils that are directly above this Alignment Ring 246. The Right-side Alignment Ring Mount 246MR includes One Horizontal Piece to connect the right side of the Alignment Ring 246 to the Main Vertical Structural Beam of the Vertical Structural Support Beam System 248. The Left-side Alignment Ring Mounting System 246ML includes Two Horizontal Cube-like Pieces, one in the front of the Ring and one in the rear, both on the left side. For each of these Two Horizontal Cube-like Pieces, the right side is attached to the Alignment Ring 246 and the left side is attached to the Vertical Structural Support Wall 249.

The Lowest Coil in the Fluid Side Coil Stack 247Lwr is the First Coil a canister encounters as the canister begins the Floatation-ascent Phase 311. The Second to Lowest Coil in the Fluid Side Coil Stack, 247Upr, operates in exactly the same manner as the Lowest Coil 247Lwr. In these related references, “Upper” (Upr) and “Lower” (Lwr) refers to the vertical positioning of the Two Coils in FIG. 1I only; there are other Coils in the Fluid Side Coil Stack 322, as shown in FIG. 1J. However, the Coil 247Lwr will always be the “lowest Coil” in the Fluid Side Coil Stack. The Left-side “Lower Coil” Mounting System 247MLL includes Two Horizontal Cube-like Pieces, one in the front of the Coil and one in the rear, on the left side. These Two Cube-like pieces each attach, on their right side, to the Coil 247Lwr, and also attach, on their left side, to the Vertical Structural Support Wall 249. The Left-side Mounting System 247MUL (for the Upper Coil 247Upr) has exactly the same Mounting Configuration as the Mounting System 247MLL (for the Lower Coil 247Lwr). The Right-side “Lower Coil” Mounting Piece 247MLR includes One Horizontal Piece, which attaches on the left to the Coil 247Lwr and attaches on the right to the Main Vertical Structural Beam of the Vertical Structural Support Beam System 248. The Right-side “Second to Lowest Coil” Mounting Piece 247MUR has the exact same Mounting Configuration as the Mounting Piece 247MLR.

The Vertical Structural Support Beam System 248 (for the Right Side of Fluid Side Coil Stack) includes Three components: a very long Beam that runs vertically up the entire distance of the Fluid Side Coil Stack 322; a Short Vertical Section that rests on the Horizontal Extension 240; an Angled Section that connects the Two Vertical Sections (of the Support Beam System 248) just described. The most important component of this Beam System 248 is the very long Beam, which provides all of the Right-side support for all Coils and all Alignment Rings in the entire Fluid Column, starting at the lowest point with Alignment Ring 246 and going all the way up to the Ceiling of the Fluid Column, which is actually the underside of the Above Ground Floor 254. In some descriptions, this very long Beam can be referred to, individually, as the Main Vertical Structural Support Beam (of the Beam System 248). The Vertical Structural Support Wall 249 extends vertically up the entire distance of the Fluid Side Coil Stack 322, all the way up to the Ceiling of the Fluid Column. This Vertical Structural Support Wall 249 is the Left Side Support for all Coils and all Alignment Rings in the entire Fluid Column.

Turning now to FIG. 1J, there are five typical Coils (from the Fluid Side Coil Stack 322) shown: 250a, 250b, 250c, 250d, and 250e; however, Coil 250e is a little special in that Coil 250e is the topmost Coil in the entire Fluid Side Coil Stack. Even though these Five Coils are shown in two different “broken” Vertical Sections of the Fluid Side Coil Stack: a) all of these Five Coils are stacked one above the other in perfect vertical alignment, and b) these Five Coils represent the entire Fluid Side Coil Stack 322 (see FIG. 20, where the Top and Bottom Coils of the Fluid Column are referenced) and any reference to the “Fluid Side Coil Stack” refers to Coils with the identical configuration as what is shown for the Five Coils in FIG. 1J, even though the number of Coils in the “Stack” may be much more than just these Five Coils.

The Left-side Mounting Systems for all Five Coils in FIG. 1J are exactly the same and the Right-side Mounting Pieces for all Five Coils are exactly the same. The “Lowest Coil” Left-side Mounting System 250aML is exactly the same as the Mounting System 247MLL (in FIG. 1I) and includes Two Horizontal Cube-like Pieces, one in the front of Coil 250a and one in the rear, on the left side. These Two cube-like Pieces each attach, on their right side, to Coil 250a and also attach, on their left side, to the Vertical Structural Support Wall 249. The Right-side “Lowest Coil” Mounting Piece 250aMR is exactly the same as the Mounting Piece 247MLR and includes One Horizontal Piece, which attaches on the left to Coil 250a and attaches on the right to the Main Vertical Structural Support Beam 248.

In FIG. 1J there are Two Identical Quadrilateral Guide Assemblies, 251 and 252, and both of these Guide Assemblies serve basically the same purpose and are mounted in exactly the same way. However, the Quad Guide Assembly 252 is a little special in that it is the topmost piece of Alignment Equipment in the entire Fluid Side Coil Stack 322. In addition, the Lowest Quadrilateral Guide Assembly 251 helps ensure a canister is ascending with True Vertical Alignment and that the canister is directly underneath other essential pieces of equipment that operate inside the Fluid Column. The Top Quadrilateral Guide Assembly 252 helps ensure a canister is exiting the Fluid Column in such a way that the canister is perfectly aligned with the Fluid Column Exit Point 315 (this Exit Point 315 is basically a circular hole carved out of the Above Ground Floor 254; this “hole” is covered by the Splash Guard 253 that is located at the Top of Fluid Column 320.) For each of these Two Quad Guide Assemblies, 251 and 252, their left side mounts directly to the Vertical Structural Support Wall 249. There is a Horizontal Mounting Block 251M and an identical Horizontal Mounting Block 252M; these Blocks attach on the left to the respective Quad Guide Assembly and attach on the right to the Main Vertical Structural Support Beam 248.

The Splash Guard 253 (at the Top of Fluid Column 320) is a thin, light-weight rubber-like piece that does not inhibit the upward movement of a canister. This Splash Guard 253 sits directly over the Fluid Column Exit Point 315 (shown in FIG. 15). The purpose of this Splash Guard 253 is to keep a canister from “dragging out” any Fluid from the Fluid Column 320 when the canister exits the Fluid Column and begins the “Fly into the Air” Phase 312; this Splash Guard 253 also helps to minimize the evaporation process that occurs near the top of the Fluid Column. The Above Ground Floor 254 is potentially the same floor as Above Ground Floor 61 (for the Inclined Platform; shown in FIG. 1A) or at least Floor 254 is at the same horizontal level as Floor 61, but Floor 254 has different properties than Floor 61; Floor 254: a) is over to the right of Floor 61 and b) has a “hole” and other features related to the Fluid Side. The underside of this Floor 254 might also be looked upon as the Ceiling of the Fluid Column.

Turning now to FIG. 1K, the Two Vertical Structural Beams 255R (for the Right Side of the Above-ground Coils and for the Pivot Bucket) support the right side of all the equipment positioned in the “above-ground” area between (and including) the Above Ground Floor 254 and the Pivot Bucket Area 313. This 255R reference does Not include any of the Cross Member pieces, because any such pieces have been given their own separate designation(s) in the individual “Mounting References” for the various related pieces of equipment shown in FIG. 1K and FIG. 1L. The Front Beam of the Structural Beam System 255R is shown in hidden lines, even though it is in front of other pieces of equipment. The Two Vertical Structural Beams 255L (for the Left Side of the Above-ground Coils and for the Pivot Bucket) support the left side of all the equipment positioned in the “above-ground” area between (and including) the Above Ground Floor 254 and the Pivot Bucket Area 313. There is a Horizontal Cross-member Support Beam 255CM (for the Two Vertical Structural Beams 255L) and this Support Beam 255CM helps to strengthen the Two Vertical Structural Beams 255L and also provides a place to attach the Quad Guide Assembly 257. All Four Vertical Structural Beams in FIG. 1K are “broken off” at the top; these Four Beams extend upwards and are shown again in FIG. 1L.

In FIG. 1K there are Two Identical Coils, 256a and 256b; 256a is the “Lower” Coil and is positioned directly above the Splash Guard 253. These Two Coils, 256a and 256b, are stacked vertically on top of each other. Any other Coils that exist above the Coil 256b in the “Above Ground Coil Stack” are not shown. The Left-side “Lower Coil” Mounting System 256aML includes Two Horizontal Triangle-like Pieces, one in the front of Coil 256a and one in the rear, on the left side. The Front Triangle-like Piece attaches to the Front Left Side of Coil 256a and also attaches to the Front Vertical Structural Beam of the Structural Beam System 255L; the Rear Triangle-like Piece of the Mounting System 256aML attaches to the Rear Left Side of Coil 256a and also attaches to the Rear Vertical Structural Beam of the Structural Beam System 255L; the Triangle-like Piece in the rear is shown by hidden lines. The Mounting Configuration 256bML (for the left side of the “Upper” Coil 256b) is identical to the Left-side Lower Coil Mounting System 256aML.

The Right-side “Lower Coil” Mounting System 256aMR includes one Larger Horizontal Piece and one Short Horizontal Piece. The Larger Horizontal Piece attaches to the Two Right-side Vertical Structural Beams of the Structural Beam System 255R. The Short Horizontal Piece attaches to the Coil 256a and also attaches to the Larger Horizontal Piece of the Mounting System 256aMR. The Right-side Mounting System 256bMR (for Coil 256b) has exactly the same Mounting Configuration as the Mounting System 256aMR, except that in Mounting System 256bMR, the Larger Horizontal Piece is slightly higher than the Larger Horizontal Piece of the Mounting System 256aMR.

The Quadrilateral Guide Assembly 257 ensures that a canister is ascending with True Vertical Alignment and that the canister is directly underneath other essential pieces of equipment that operate in the Above Ground Coil Stack. The left side of this Quad Guide Assembly 257 mounts straight onto Cross-member 255CM. The Right-side Mounting Piece 257MR (for Quad Guide Assembly 257) includes One Horizontal Piece that attaches (on the left) to the right side of the Quad Guide Assembly 257 and also attaches (on the right) to the Larger Horizontal Piece of Mounting System 256bMR.

Turning now to FIG. 1L, there is a Pivot Bucket Entry; Speed-adjusting Electromagnet (EM#3) 260, and the purpose of this EM#3 260 is to properly regulate the ascending speed of a canister before that canister enters the Pivot Bucket 261. There is also a related Pivot Bucket Area Speed and Motion Sensor 258, which detects when the Leading Edge of a canister is moving in front of it and analyzes that data to determine how fast the canister is moving. Then, the Sensor System 258 immediately sends a signal to the Speed-adjusting EM#3 260. Upon receiving the Activation Signal from the Sensor System 258, Speed-adjusting EM#3 260 immediately creates a Magnetic Field that will either oppose or attract the magnet that is inside the canister that is traveling upward, and is in the process of entering this EM#3 260 from the bottom. The reason there is a choice as to whether to speed up or slow down the canister is fully explained below; see Cycle-sequence Descriptions; FIG. 18, “Pivot Bucket Area 313.”). In any event, the canister will keep climbing upward, will move through this EM#3 260, and then the canister will begin to exit out the top of the EM#3 260.

The Vertical Mount 258M (for Speed and Motion Sensor 258) is a short, Vertical Piece that attaches on the bottom to the Sensor 258 and on the top is attached to the Front Triangle-like Piece of the Mounting System 259ML. The Left-side Speed-adjusting Electromagnet (EM#3) Mounting System 260ML includes Two Horizontal Triangle-like Pieces, one in the front of EM#3 260 and one in the rear, on the left side; the Triangle-like Piece in the rear is shown by hidden lines. This Mounting System 260ML also includes a Circular Mounting Belt that goes completely around EM#3 260, and the Mounting Belt is vertically slightly below the middle of EM#3 260. The Front Triangle-like Piece of the Mounting System 260ML attaches to the Front Left Side of the Circular Mounting Belt and also attaches to the Front Vertical Structural Beam of the Structural Beam System 255L; the Rear Triangle-like Piece attaches to the Rear Left Side of the Circular Mounting Belt and also attaches to the Rear Vertical Structural Beam of the Structural Beam System 255L. The Right-side Speed-adjusting Electromagnet (EM#3) Mounting System 260MR includes one Larger Horizontal Piece and one Short Horizontal Piece. The Larger Horizontal Piece attaches to the Two Right-side Vertical Structural Beams of the Structural Beam System 255R. The Short Horizontal Piece (of the Mounting System 260MR) attaches to the right side of the Circular Mounting Belt and also attaches to the Larger Horizontal Piece of Mounting System 260MR.

The Pivot Bucket Area Alignment Ring 259 ensures that a canister is ascending with True Vertical Alignment and that the canister is directly underneath and perfectly aligned with the Pivot Bucket Entry; Speed-adjusting Electromagnet (EM#3) 260 and is also perfectly aligned with the Pivot Bucket 261. The Left-side Pivot Bucket Area Alignment Ring Mounting System 259ML includes Two Horizontal Triangle-like Pieces, one in the front of the Alignment Ring 259 and one in the rear, on the left side. The Front Triangle-like Piece (of the Mounting System 259ML) attaches to the Front Left Side of Alignment Ring 259 and also attaches to the Front Vertical Structural Beam of the Structural Beam System 255L; the Rear Triangle-like Piece attaches to the Rear Left Side of Alignment Ring 259 and also attaches to the Rear Vertical Structural Beam of the Structural Beam System 255L. The Right-side Pivot Bucket Area Alignment Ring Mounting System 259MR includes one Larger Horizontal Piece and one Short Horizontal Piece. The Larger Horizontal Piece of the Mounting System 259MR attaches to the Two Right-side Vertical Structural Beams of the Structural Beam System 255R. The Short Horizontal Piece attaches (on the left) to the right side of Alignment Ring 259 and also attaches (on the right) to the Larger Horizontal Piece of this Mounting System 259MR.

The Front Top Angled Extension 255TAEF (of the Two Front Vertical Structural Beams for the Above Ground Coil Stack and the Pivot Bucket) is a large, Angled Structural Component that connects Two (front, left and right) Vertical Structural Beams (that is, the Front Beam of the Beam System 255L and the Front Beam of the Beam System 255R). The Front Attachment Interface System 262F (for the Pivot Point Swivel Assembly 316) is located at the top of this Angled Extension 255TAEF. The Bearings of the Front Attachment Interface System 262F (for the Pivot Point Swivel Assembly 316) are mounted in a “hole” drilled in this 255TAEF, but the “hole” does not go all the way completely through to the front surface of 255TAEF (see FIG. 13).

The Rear Top Angled Extension 255TAER (of the Two Rear Vertical Structural Beams for the Above Ground Coil Stack and the Pivot Bucket) is also a large, Angled Structural Component that connects Two (rear, left and right) Vertical Structural Beams (that is, the Rear Beam of the Beam System 255L and the Rear Beam of the Beam System 255R). The Long Shaft 265 (of the Rotational Solenoid 266) passes through a hole at the top of this Angled Extension 255TAER and the Bearings of the Rear Attachment Interface System 262R (for the Pivot Point Swivel Assembly 316) are mounted on the inner edges of such hole, and therefore these Bearings (of Interface System 262R) are mounted directly to this Rear Top Angled Extension 255TAER (see FIG. 13). The Pivot Bucket 261 rotates on the Pivot Point Swivel Assembly 316 (this Swivel Assembly 316 is best shown in FIG. 13); there are other essential pieces of equipment attached to this Pivot Bucket 261, and much of the time there is a canister being held inside this Pivot Bucket 261.

Turning now to FIG. 13, there is a reference for the Pivot Bucket Walls 261W. (Note: the distance between these Two Walls 261W in FIG. 13 should obviously be greater than what is shown, and in fact the distance between the Two Walls 261W should be equal to the outside diameter of the Pivot Bucket 261. Also, use of the terms “Front” and “Rear” for FIG. 13 is accurate because every component in FIG. 13 has been rotated 90 degrees in the horizontal plane, for the sake of illustration purposes.) The Front Attachment Interface System 262F (for the Pivot Point Swivel Assembly 316) includes: a) a Semi-spherical Cup-like Piece that is affixed to the outside of the Pivot Bucket 261, b) a Cylindrical Rod that extends out from the Cup-like Piece towards the Front Surface of the Top Angled Extension 255TAEF, but this Cylindrical Rod, that is part of the Interface System 262F does not extend all the way out to that Front Surface-edge of this Top Angled Extension 255TAEF (this fact is designated by a circular hidden line that is seen “behind” the front surface of 255TAEF, in FIG. 1L), and c) also includes a set of small, spherical Ball Bearings upon which the Cylindrical Rod (that is part of 262F) rotates.

The Rear Attachment Interface System 262R (for the Pivot Point Swivel Assembly 316) includes: a) a Semi-spherical Cup-like Piece that is affixed to the outside of the Pivot Bucket and this Cup-like Piece is molded onto the front end of the Long Shaft of the Rotational Solenoid 265, and b) a set of small, spherical Ball Bearings upon which the Long Shaft of the Rotational Solenoid 265 rotates. These Two Front and Rear Attachment Interface Systems, 262F and 262R, respectively, are part of the overall Pivot Point Swivel Assembly 316, shown in FIG. 13.

Returning now to FIG. 1L, the Lower Left Pivot Bucket Stop-pin 263L is used in connection with the process that occurs once a canister enters the Pivot Bucket 261. The Lower Right Pivot Bucket Stop-pin 263R operates as an exact horizontal mirror image to the operation of its Lower Left Counterpart, Stop-pin 263L. For an in-depth explanation on the operation of these Four Pivot Bucket Stop-pins, 263L, 263R, 264L, and 264R, see Cycle-sequence Descriptions; FIG. 18, “Pivot Bucket Area 313”)

The Upper Left Pivot Bucket Stop-pin 264L operates in exactly the same manner as 263L, with reference to horizontal activity. However, this Stop-pin 264L operates as an exact vertical mirror image to the operation of its Lower Counterpart, 263L, in regards to vertically-oriented activity. Also, the overall Stop-pin System 264L includes a Pressure Gauge 275, which none of the other three “Pivot Bucket Stop-pin Systems” have. An enlarged view of the Stop-pin System 264L is shown in FIG. 12. The Upper Right Pivot Bucket Stop-pin 264R operates as an exact horizontal mirror image to the operation of its Left Counterpart, the Stop-pin 264L, except that the Stop-pin System 264R does not have a pressure gauge. Also, this Stop-pin 264R operates as an exact vertical mirror image to the operation of its Lower Counterpart, the Stop-pin System 263R.

As mentioned above, the front of the Long Shaft 265 (of the Rotational Solenoid 266) is “molded onto” the cup-like component of the Rear Attachment Interface System 262R (for the Pivot Point Swivel Assembly 316) and the rear of this Long Shaft 265 extends into the body of the Pivot Bucket Rotational Solenoid 266. This Long Shaft 265 is the component that actually transmits the rotational force to the Pivot Bucket 261 and causes the Pivot Bucket to rotate to the left (when looking at Rotational Solenoid 266 from the point of view shown in FIG. 1L). Then after the canister is “ejected out” onto the Inclined Platform 59 (see FIG. 1N), this Long Shaft 265 rotates the Pivot Bucket back to the default position for the Pivot Bucket, which is for the Pivot Bucket to be vertically aligned in a “straight up” position, as shown in FIG. 1L. Rotational Solenoid 266 provides the rotational power (torque) that rotates the Pivot Bucket 261; this Rotational Solenoid 266 attaches to the Pivot Bucket by the Long Shaft 265.

The Mounting Harness 266MH (for the Rotational Solenoid 266) includes the Semicircle-like Strap that goes over the Body of the Rotational Solenoid 266, and also includes a left and right extension of the Strap, that extends in each direction over the left and right Horizontal Mounting Beams, 266ML and 266MR, respectively, and such Strap extensions are also affixed to such respective Horizontal Mounting Beams. The Left-side Horizontal Mounting Beam 266ML (for the Rotational Solenoid Mounting Harness) is attached to the Back Left Side of the Rear Top Angled Extension 255TAER. The back portion of this Left-side Horizontal Mounting Beam 266ML provides a solid surface where the Left-side Strap Extension of 266MH is attached. The Right-side Horizontal Mounting Beam 266MR (for the Rotational Solenoid Mounting Harness) is attached to the back Right Side of the Rear Top Angled Extension 255TAER. The back portion of this Right-side Horizontal Mounting Beam 266MR provides a solid surface where the Right-side Strap Extension of 266MH is attached.

FIG. 1L shows Canister 267 positioned, vertically, inside Pivot Bucket 261. This particular “vertical positioning state” would occur at the end of the “Fly into the Air” Phase 312, when the canister's upward momentum has peaked, because the upper surface of the canister is contacting the bottom surface-edges of the Two Upper Pivot Bucket Stop-pins, 264L and 264R. As explained six paragraphs below with regards to Pressure Gauge 275, when a canister puts upward pressure on Stop-pins 264L and 264R, Pressure Gauge 275 sends signals to the Two Lower Pivot Bucket Stop-pins, 263L and 263R, causing these Stop-pins to “close” (extend in towards the center of the Pivot Bucket). With all four of these Stop-pins in the extended state, a canister has no way out of the Pivot Bucket. However, because of the Five Second Cycle Rule, the instant Pressure Gauge 275 sends those signals to the Two Lower Pivot Bucket Stop-pins, 263L and 263R, another signal is sent to Rotational Solenoid 266, and the entire Pivot Bucket begins quickly rotating towards Inclined Platform 59. And of course, since the canister is “trapped” inside the Pivot Bucket, the canister will be moving in direct relationship to the rotational movement of Pivot Bucket 261.

The following Explanation of the various components, 268UL to 274UL, shown in FIG. 12 (the enlarged view of the Upper Left Pivot Bucket Stop-pin System 264L) also applies to the other “Pivot Bucket Stop-pin Systems”: 263L, 263R, and 264R, except for the description regarding the Pressure Gauge 275. However, as explained above, the Two “Right-side Stop-pin Systems” 263R and 264R operate as mirror images, horizontally, to the Two “Left-side Stop-pin Systems” 263L and 264L, and the Two “Lower Stop-pin Systems” 263L and 263R operate as mirror images, vertically, to the Two “Upper Stop-pin Systems” 264L and 264R.

In FIG. 12, the Backstop Anti-rotational Restraining Arm 268UL ensures that the Upper Left Pivot Bucket Stop-pin 264L will not be forced upward to the point that the upward angle of the Stop-pin 264L causes unnatural strain to be put on the Upper Left Pivot Bucket Stop-pin Assembly Retracting Solenoid 270UL. After a “Flying Canister” enters the Pivot Bucket, it continues moving upward until it makes direct contact with the Upper Left Pivot Bucket Stop-pin 264L. (The canister also contacts the Upper Right Pivot Bucket Stop-pin 264R at the same time) Once the Pivot Bucket Stop-pin 264L is pushed upward by the canister, the first thing the Stop-pin 264L does is to make contact with the Backstop Restraining Arm, 268UL. (Note: the Restraining Arm 268UL is not attached to the Stop-pin 264L; the Stop-pin 264L only makes contact with, and slides back and forth under, this Restraining Arm 268UL. Since the far left “contact point” of this Backstop Restraining Arm 268UL is directly attached to the top of the Retracting Solenoid Body 270UL, the upward force of the canister will be felt equally by the Retracting Solenoid Body 270UL and by the Stop-pin 264L.)

Therefore, any counter-clockwise torquing effect will be minimized because both pieces, the Retracting Solenoid 270UL and the Stop-pin 264L (which is actually the Plunger of the Solenoid 270UL) will move upward in unison, when being pushed in that upward direction by a canister. Similarly for the Two Lower Stop-pin Systems 263L and 263R [the Two Lower Counterparts to this (upper left) Backstop Restraining Arm 268UL], their respective “Restraining Arms” will each help (in their respective “Stop-pin Systems”) protect the alignment between the Two Lower Pivot Bucket Stop-pins, 263L and 263R, and their respective Retracting Solenoids, when a canister is putting DOWNWARD force on these “Lower Stop-pins” 263L and 263R, at the point when these “Lower Stop-pins” 263L and 263R have been extended and are stopping a canister from falling back out of the bottom of the Pivot Bucket (see Cycle-sequence Descriptions; FIG. 18, “Pivot Bucket Area 313”).

The primary purpose of this Backstop Anti-rotational Restraining Arm 268UL is to ensure that the upward force being applied to the entire Upper Left Pivot Bucket Stop-pin Assembly (a force being applied through the Stop-pin 264L, itself, and the Backstop Restraining Arm 268UL) is Converted from a rotational counterclockwise “torquing” force to a direct upward force that causes the Spring 271SpUL to be compressed. Since the Solenoid Body 270UL is directly attached to the Spring 271SpUL, when the Solenoid Body 270UL is moving upward, the Spring 271SpUL is being compressed.

It is essential that this process of compressing the Spring 271SpUL takes place, because: a) the Spring 271SpUL needs to absorb as much of the upwardly-directed “impact energy” as possible. However, it is not a matter of extreme importance exactly how much kinetic energy this Spring 271SpUL absorbs, because the overall system is built to be Sturdy and there is a high level of structural integrity built into All Four Pivot Bucket Stop-pin Assemblies, so that these Stop-pin Assemblies will function properly during those times when any of the Four Stop Pins, 263L, 263R, 264L, and 264R are making contact with the surfaces of a moving canister. In addition, the Speed-adjusting EM#3 260 will be able to regulate the Final Approach Speed of a canister that is entering the Pivot Bucket 261, so any “impact” by a canister on the Two Upper Pivot Bucket Stop-pins, 264L and 264R will be properly regulated.

And b) but what is of critical importance is that Spring 271SpUL MUST be compressed at least a Pre-determined Minimal Amount so that Pressure Gauge 275 will reach its threshold pressure and send the required signal to the Two Lower Pivot Bucket Stop-pins, 263L and 263R (see Cycle-sequence Descriptions; FIG. 18, “Pivot Bucket Area 313”). If this important signal is Not sent, the Canister will fall back out of the Pivot Bucket through the bottom of the Pivot Bucket (because the Two Pivot Bucket Stop-pins, 263L and 263R will Not have extended) and the entire MF device will shut down. In conclusion regarding this Restraining Arm 268UL, even if some “torquing” occurs on the Four Stop-pins and their related Solenoids, this circumstance does not affect, in any substantive way, the functionality of these Four Pivot Bucket Stop-pin Assemblies.

The Vertical Structural Partition 269UL (for the Upper Left Pivot Bucket Stop-pin Assembly) gives strength to the overall Housing Structure for the Upper Left Pivot Bucket Stop-pin Assembly. This Partition 269UL has an oblong hole cut out of its middle area, so that the Pivot Bucket Stop-pin 264L and the Backstop Restraining Arm 268UL can move freely up and down through such hole when a canister is applying force to the Pivot Bucket Stop-pin 264L. The Upper Left Pivot Bucket Stop-pin Assembly Retracting Solenoid 270UL moves its plunger, the Stop-pin 264L, back and forth in a horizontal motion. In addition, this entire Solenoid 270UL moves up and down in a vertical direction, whenever a canister is applying force to the related Stop-pin 264L. A Spring 271SpUL is attached to the top of the Solenoid 270UL and an Anti-torquing Horizontal End-brace 274UL is positioned directly underneath the back end of the Solenoid 270UL.

The Impact-absorbing Spring 271SpUL (for the Upper Left Pivot Bucket Stop-pin Assembly) absorbs the force of the impact when the Leading Surface of a “flying” canister, going in an upward direction, makes contact with the Stop-pin 264L. This overall component, 271SpUL, includes the Spring and also includes a Curved Mounting Piece that is connected to the bottom of Spring 271SpUL; this Curved Mounting Component attaches the Spring 271SpUL to the Body of the Solenoid 270UL. The only Spring out of the Four identical Springs (“identical” except that the Springs for the Lower Pivot Bucket Stop-pin Assemblies are turned upside down, in relationship to the Spring 271SpUL) that has a Pressure Gauge 275 mounted onto the top of the Spring is this Spring 271SpUL.

There are Three Outer Housing Pieces 272UL (for the Upper Left Pivot Bucket Stop-pin Assembly). This overall Housing Component, 272UL, includes: the Top and Bottom Housing Pieces (both have a curved right edge so a canister will fit past these pieces), and the Rectangle Left Vertical Wall Piece. This Housing Component 272UL, in combination with the Vertical Structural Partition 269UL (for the overall Upper Left Pivot Bucket Stop-pin Assembly) form the Complete Housing Structure that contains all the equipment used in the overall Upper Left Pivot Bucket Stop-pin Assembly, except that the Pressure Gauge 275 is outside the “Housing Structure.”

The Front Vertical Alignment Rod 273ULF (for the Upper Left Pivot Bucket Stop-pin Assembly) is positioned so that this Rod 273ULF is always making contact with the outer edge (the edge closest to the viewer in FIG. 12) of the Solenoid Body 270UL and this Rod 273ULF is positioned towards the rear (towards the left) of the Solenoid 270UL. There is no room for the Solenoid 270UL to move towards the front or rear (when looking at the Solenoid 270UL and the Rod 273ULF from the point of view shown in FIG. 12). This Rod 273ULF, in combination with the Rod 273ULR, ensure that Solenoid 270UL and related Spring 271SpUL will move straight up and down as much as possible and therefore the effect of “torquing” towards the front or rear will be kept to a minimum. The Rear Vertical Alignment Rod 273ULR (for the Upper Left Pivot Bucket Stop-pin Assembly) is the rear Counterpart to the Front Rod 273ULF; this Rear Rod 273ULR works in precisely the same way as the Front Rod 273ULF.

The Anti-torquing Horizontal End-brace 274UL (for the Upper Left Pivot Bucket Stop-pin Assembly) helps minimize any counterclockwise “torquing effect” (when looking at the End-brace 274UL from the point of view shown in FIG. 12) that can occur when a “Flying Canister” is putting upward pressure on the Stop-pin 264L. Even though it has been described that the Stop-pin 264L and the Solenoid Body 270UL will rise upward as one unit, this End-brace 274UL adds another layer of anti-torquing protection by ensuring that the back-end of Solenoid 270UL cannot go any lower, even when the front right side of the Solenoid Assembly is being pushed upwards. This End-brace 274UL also serves to limit the DOWNWARD movement of the Solenoid Body 270UL to a fixed distance, when the Solenoid Body 270UL is sent downward as a result of Spring 271SpUL decompressing and applying downward force to the Solenoid Body 270UL.

Pressure Gauge 275 receives pressure data from Spring 271SpUL, as the Spring is being compressed by a “flying” canister. Once a pre-determined level of compression is reached (basically any amount of minimal compression will trigger this Pressure Gauge 275 because even a minimal amount of pressure means a canister is inside the Pivot Bucket), Pressure Gauge 275 immediately sends a signal to the Two Lower Pivot Bucket Stop-pin Solenoids, causing these Solenoids to extend. This action causes the Two Lower Pivot Bucket Stop-pins, 263L and 263R, to move into the path of the (now) “falling” canister, so that the canister cannot “fall through the bottom” of the Pivot Bucket 261. As a result of all FOUR Stop-pins (263L, 263R, 264L and 264R) being extended at this point, the canister eventually comes to rest on the Two Lower Pivot Bucket Stop-pins, 263L and 263R, due to the force of gravity acting on the canister, which has become “trapped” inside the Pivot Bucket 261. As mentioned above, at the same time these signals are sent to the Two Lower Stop-pins, a signal is sent to Rotational Solenoid 266, which causes this Solenoid 266 to begin rotating the entire Pivot Bucket towards Inclined Platform 59.

Turning now to FIG. 1L-2, the purpose of showing the two referenced components there (at the bottom of the drawing) is to emphasize how the Lower Stop-pin Assemblies operate, compared to how the Upper Stop-pin Assemblies operate. The Impact-absorbing Spring 271SpLL (for the Lower Left Pivot Bucket Stop-pin Assembly) absorbs the downward force that occurs when a canister is “falling backwards,” after: a) that canister has made contact with the Two Upper Stop-pins, 264L and 264R, and b) these related “Upper Springs” have compressed and then have decompressed. The result at that point is that the canister is sent back down towards the Two Lower Stop-pins, 263L and 263R, with the force of gravity and also with the force of the Two “Upper Springs” having decompressed and adding additional downward force to the movement of the canister.

So Spring 271SpLL (along with its Right-side “Lower Spring” Counterpart) will be compressing in a downward direction, and when that Spring 271SpLL (and its Right-side Spring Counterpart) decompresses, the canister will be pushed upward for some small distance. Whether the canister is pushed back up so far that the top surface of the canister reaches the Two Upper Stop-pins is irrelevant, because in any event, the Pivot Bucket will be rotating towards Inclined Platform 59 at the same time the canister is “rather gently” moving back and forth between the Upper and Lower Stop-pins, as the four Springs of these Two Stop-pin Systems keep compressing and decompressing, according to how a canister is “bouncing” back and forth inside Pivot Bucket 261. FIG. 1L-2 shows an “equilibrium state” of how a canister would “come to rest,” if the Pivot Bucket remained in the “perfectly vertical” direction and a canister had time to bounce back and forth enough, vertically, so that the canister eventually reached that “equilibrium state” (in FIG. 1L-2) where the bottom surface of the canister would be resting on the top surfaces of the Two Lower Pivot Bucket Stop-pins, 263L and 263R. It is worth noting in FIG. 1L-2 that Backstop Anti-rotational Restraining Arm 268LL ensures that the Lower Left Pivot Bucket Stop-pin 263L will not be forced DOWNWARD to the point that the downward angle of the Stop-pin 263L causes unnatural strain to be put on the Lower Left Pivot Bucket Stop-pin Assembly Retracting Solenoid (this Solenoid is shown but has no reference number).

Also in FIG. 1L-2, on the outside of Pivot Bucket 261 there is a Canister Ejection EM 276. This Canister Ejection EM 276 creates an EM Field that helps “push” a canister out of the Pivot Bucket, after the Pivot Bucket has been rotated so that the Mouth of the Pivot Bucket is directly in line with Inclined Platform Top Canister Holder Section 625Ext (in FIG. 1N). This Canister Ejection EM 276 initiates the EM Field when: a) the amount of rotation by Rotational Solenoid 266 reaches a pre-determined Degree of Rotation, and b) after the Two Upper Pivot Bucket Stop-pins, 264L and 264R, retract and create an opening in the Mouth of the Pivot Bucket for the canister to move through.

Also, at the same time Rotational Solenoid 266 sends the signal to Canister Ejection EM 276 to initiates its EM Field, another signal is sent to Top Cue Position Deceleration EM 626 (in FIG. 1N) and Deceleration EM 626 also initiates an EM Field that helps “pull the canister” out of the Pivot Bucket and onto Canister Holder Section 625Ext at a point when the canister has been partially ejected out of the Pivot Bucket and the magnet near the front of the canister comes within range of the EM Field that has been created by Top Cue Position Deceleration EM 626. This is explained in greater detail in “13 Topics; #8, Pivot Buckets; sub-section Single Pivot Bucket operation”). The Mounting System for Canister Ejection EM 276 is not shown, but Canister Ejection EM 276 fits very tightly around, and is permanently mounted (glued or otherwise attached) onto the outside of the circular body of Pivot Bucket 261.

Turning now to FIG. 1N and FIG. 53, the same equipment shown in these two drawings is used in the same way for two slightly different applications, the single pivot bucket application and the dual pivot bucket application, except FIG. 53 has a sliding version (625SLD) of Inclined Platform Top Cue Position Canister Holder Section 625Ext, and where 625Ext is used for the single pivot bucket application. Therefore, FIG. 53 has three additional components related to this sliding process, and also in FIG. 53, Inclined Platform Top Cue Position Canister Holder Section 625Ext, is named and referenced as: Inclined Platform Sliding Canister Holder Section 625SLD, respectively. Also, Canister C267 in FIG. 1N is Canister C98 in FIG. 53, and Canister C1-Cue in FIG. 1N is Canister C2-Cue in FIG. 53.

In FIG. 1N, the overall reference for Inclined Platform Top Cue Position Canister Holder Section 625Ext includes all of the components in the drawing to the right of, and including Canister Holder Section Exit Sensor Mounting System 632M; this means the only two components Not included in this “625Ext” reference are: Inclined Canister Holder 66, and Partial Canister C1-Cue. FIG. 1N shows: a) the status of Canister C267 (also referenced as C267PH in FIG. 1N) and this status has not changed from what is shown in FIG. 1M, showing that Pivot Bucket 261 (and the canister inside the Pivot Bucket) had been rotated and the canister is in the process of being “ejected” out of Pivot Bucket 261, and also b) FIG. 1N shows Canister C267 after this canister has moved completely out of Pivot Bucket 261 and has traveled more than one canister length (down and to the left) along Inclined Platform Top Cue Position Canister Holder Section 625Ext.

There is a Cut-out Hole 625Cut (Inclined Platform Top Cue Position Canister Holder Section 625Ext) and this “hole” is an area where the Two Ejection Impact Springs, 629Spr and 630Spr (and related equipment) move down into to get out of the way of a canister that is moving from Inclined Platform Top Cue Position Canister Holder Section 625Ext onto Inclined Canister Holder 66. There is a Top Cue Position Deceleration EM 626 that is used in Four ways: a) to help pull a canister out of a Pivot Bucket and onto Canister Holder Section 625Ext (after the canister is partially ejected out of the respective Pivot Bucket), b) to slow a canister down once the canister is moving out of the respective Pivot Bucket and the Leading Surface of the canister is headed into Top Cue Position Deceleration EM 626 (from the right), c) to repel a canister after it has made “First Contact” with the Front and Rear Contact Pads, 629CP and 630CP, respectively (the effect of this “Repelling Field” is to minimize the “Bounce” a canister makes off of the Two Contact Pads and related Ejection Impact Springs), and d) to temporarily suspend a canister off of, and away from, the Two Contact Pads 629CP and 630CP while the respective Retracting Solenoids (629Slnd and 630Slnd) are pulling the Two Ejection Impact Spring Assemblies down into Cut-out Hole 625Cut. The multiple functions of Top Cue Position Deceleration EM 626 are fully described in the latter portion of “13 Topics; #8, Pivot Buckets; sub-section Single Pivot Bucket operation.”

This Top Cue Position Deceleration EM 626 is mounted to Canister Holder Section 625Ext by a Deceleration EM Mounting System 626M. This “626M” reference includes both the Front and Rear Mounts, even though the reference in FIG. 1N goes to only the Front Mount. These EM Mounts attach on the top to Deceleration EM 626 and attach on the bottom to the side (Front Side and Rear Side, respectively) of Canister Holder Section 625Ext. Also, FIG. 54 shows how this Deceleration EM 626 is embedded down into Canister Holder Section 625Ext so that the bottom (curved) portion of Deceleration EM 626 actually goes below the bottommost (curved) portion of the Pathway, where the bottom of a canister makes contact with lowest curved portion of Canister Holder Section 625Ext. When a canister is passing through Deceleration EM 626, the bottom surface of the canister is riding over the lower inner diameter-portion of Deceleration EM 626 in a seamless manner, just as if the canister were moving along on the “contact surface” of Canister Holder Section 625Ext.

There is a Front Canister Ejection Impact Spring and a Rear Canister Ejection Impact Spring, 629Spr and 630Spr, respectively. Together, these Two Impact Springs absorb the downward (and left) impact when a canister makes contact with the respective Contact Pad (629CP and 630CP) as the canister is trying to move onto Inclined Canister Holder 66, but where the motion of the canister is impeded by these Two Ejection Impact Spring Assemblies. On the right side of both the Front Impact Spring 629Spr and Rear Impact Spring 630Spr, there is a Contact Pad, 629CP and 630CP, respectively, and these Two Contact Pads are the components that actually touch the Leading Surfaces of the canisters. On the left side of both the Front Impact Spring 629Spr and Rear Impact Spring 630Spr there is a Mounting Cube, 629MC and 630MC, respectively. The right side of each of these Two Mounting Cubes is attached to the respective Impact Spring, and the bottom surface of each of these Two Mounting Cubes is attached to the respective Retracting Solenoid.

For the Front Canister Ejection Impact Spring 629Spr and Rear Canister Ejection Impact Spring 630Spr, there is a Vertical Retracting Solenoid, 629Slnd and 630Slnd, respectively. These Two Retracting Solenoids, at the appropriate time (see the related explanation in “13 Topics; #8, Pivot Buckets; sub-section Single Pivot Bucket operation” regarding when that time is), pull the Two Ejection Impact Spring Assemblies down and out-of-the-way of a canister that is trying to move to the left on Canister Holder Section 625Ext and to move onto Inclined Canister Holder 66. There is a Front Vertical Retracting Solenoid Mount 629SMt, which firmly holds Vertical Retracting Solenoid 629Slnd in place. This Solenoid Mount 629SMt attaches at the top to the side of Canister Holder Section 625Ext and attaches at the bottom to the underside of Canister Holder Section 625Ext. The Retracting Solenoid 629Slnd is more or less “cradled inside” of Solenoid Mount 629SMt. The Solenoid Mount for the Rear Retracting Solenoid 630Slnd is not shown but works in the same way, and is the horizontal mirror image of Front Solenoid Mount 629SMt.

There is a Canister Holder Section Entry Sensor 631; this Sensor 631 detects when the Leading Surface of a canister passes in front of it and at that point causes Top Cue Position Deceleration EM 626 to reverse its currently-active EM Field and the effect of this “reversed EM Field” will be to decelerate the canister that is heading towards Deceleration EM 626. Based on the analysis of the speed data by Sensor 631, the Strength of this “Reversed Decelerating EM Field” is customized for the specific speed at which the canister is entering the right side of Deceleration EM 626. This “Decelerating EM Field” remains intact, and therefore continues to have a decelerating effect on the canister as the magnet inside the canister moves out of (to the left of) Deceleration EM 626. The polarity of the EM Field that was repelling the left side of the magnet (as the magnet entered Deceleration EM 626 from the right) is now attracting the right side of the magnet as the magnet is moving away from Deceleration EM 626 (on the left side). This overall “double decelerating force” helps to ensure that the canister makes a “reasonable impact” with the Two Ejection Impact Spring Contact Pads (629CP and 630CP). Canister Holder Entry Sensor 631 is attached to Canister Holder Section 625Ext by Canister Holder Entry Sensor Mounting System 631M. This Mounting System 631M curves over, and is attached to the top of Sensor 631. Mounting System 631M is “broken off” in the drawing, but this Mounting System 631M attaches on the front side (and down near the bottom) of Canister Holder Section 625Ext.

There is a Canister Holder Section Exit Sensor 632. When a canister is heading towards Inclined Canister Holder 66, this Canister Holder Section Exit Sensor 632 detects: a) first the Leading Surface of the canister (but no action is taken), and b) then detects the bottom surface of the canister. When the bottom surface is detected, this means that the bottom surface of the canister has completely cleared, to the left, all of the moveable components in the Two Canister Ejection Impact Spring Assemblies. At that point Sensor 632 sends a signal that goes to Both Vertical Retracting Solenoids 629Slnd and 630Slnd. These identical “Solenoid signals” cause the Two Retracting Solenoids to Both simultaneously fully extend upward and reposition the respective Ejection Impact Spring Assemblies into their default positions, which is a position where the Two Contact Pads, 629CP and 630CP, are directly in the Path of a canister exiting out the left side of Top Cue Position Deceleration EM 626 (as shown in FIG. 1N).

Canister Holder Section Exit Sensor 632 is attached to the Canister Holder Section 625Ext by Canister Holder Section Exit Sensor Mounting System 632M. This Mounting System 632M curves over, and is attached to the top of Sensor 632. Mounting System 632M attaches on the rear side (and down near the bottom) of Canister Holder Section 625Ext.

There is a Partial Canister C1-Cue in the lower left portion of FIG. 1N, and the real focus of this Partial Canister C1-Cue is on the bottom surface (the surface to the right of the canister where the “pointed shape” in hidden lines is; this “pointed shape” is the Matching Carved-out Impression 71). It is important to understand that when a canister like Canister C1-Cue is sitting on Inclined Canister Holder 66, all of the canisters on Inclined Canister Holder 66 are in contact with each other (the front of one canister is touching the bottom of the next canister, as seen in FIG. 1A). Therefore, when the Leading Surface of a canister (that has just moved from Canister Holder Section 625Ext and is now moving on Inclined Canister Holder 66) impacts the bottom surface of a canister like Canister C1-Cue, the real effect of how strong the impact is will be felt by Front and Rear Inclined Platform Notch Pins, 88F and 88R, respectively (see FIG. 1A-2). These Notch Pin components are not particularly “sturdy” pieces of equipment. Therefore it is very important that the speed of each canister moving along Inclined Canister Holder 66, and making contact with a canister like Canister C1-Cue, be a “reasonable speed” to avoid causing damage to the Front and Rear Inclined Platform Notch Pins, 88F and 88R, respectively.

The additional explanations for the equipment shown in FIG. 53, related to the sliding process and for any other relevant applications of this related equipment is provided below in a more detailed explanation about the Dual Pivot Bucket with Inclined Platform Canister Holder Section sub-embodiment of the preferred embodiment.

Turning now to FIG. 54, there is a Pressure Sensor 633PrSns and the reference for this component in FIG. 54 is showing that this Sensor 633PrSns is located inside Front Canister Ejection Impact Spring 629Spr. This Pressure Sensor 633PrSns is responsible for sending a signal to the Two Retracting Solenoids, 629Slnd and 630Slnd, which will cause these Retracting Solenoids to pull the Two Impact Spring Systems, 629Spr and 630Spr, down and out-of-the-way of the Pathway a canister needs to move on. This Sensor 633PrSns is also responsible for sending other signals to: a) Top Cue Position Deceleration EM 626 (as explained near the end of “13 Topics; #8, Pivot Buckets; sub-section Single Pivot Bucket operation”), and b) the appropriate Rotational Solenoid in the respective Pivot Bucket Assembly (that just deposited the canister onto Canister Holder Section 625Ext) and the signal sent to this Rotational Solenoid causes the Solenoid to Reset (rotate back to the upright default position) after the canister has fully-exited out of the respective Pivot Bucket.

Structural Descriptions for: a) Dual Arc C Roller Section of the preferred embodiment, b) Dual Floatation Holding Cues and Canister Sliding Transport sub-embodiment of the Over-sized embodiment, c) Above Ground Multi-Rail Curved Pathway sub-embodiment of the preferred embodiment, and d) Dual Pivot Bucket with Sliding Inclined Platform Canister Holder Section sub-embodiment of the preferred embodiment, are provided AFTER the Structural Description for the Over-sized embodiment.

Turning now to FIG. 1D-oz, shown there is the initial drawing for the Over-sized embodiment of a MF device. A complete description of the operation for all the equipment for the Over-sized embodiment is given below (see 13 Topics; #5, “Over-sized embodiment”). There are several related drawings for FIG. 1D-oz, but the first two are: FIG. 21 and FIG. 22. FIG. 21 is an enlargement of a section of the Lowest Portion of the Air Side Coil Stack 401 and shows a Falling Canister 399, which has almost completed the Drop Phase for the Over-sized embodiment. FIG. 22 shows the Splash Guard 405.

The Lowest Section of the Air Side Coil Stack 401 is simply the lowest portion of the Air Side Coil Stack, and contains Coils and Alignment Rings. The much larger portion of the Air Side Coil Stack that is ABOVE the Lowest Section of the Coil Stack 401 is not shown, but all of the Coils in the entire Air Side Coil Stack, including those Coils in the Lowest Section of the Stack 401 have exactly the same configuration as the Coils and Coil Mounting Systems that are shown for the Coils 111a-111e in FIG. 1C. As mentioned above in various places, for the Over-sized embodiment, the total height for each of the Two Coil Stacks, the Air Side Coil Stack and the Fluid Side Coil Stack, is hundreds of feet. Also as explained in 13 Topics; #5, “Over-sized embodiment,” because in the Over-sized Embodiment there is: no Arc B Area, no horizontal pathways at the bottom of the MF, and no Arc C Area, the horizontal distance of the overall MF device (for an Over-sized embodiment) is fixed, regardless of how high the Two Coil Stacks are (or how deep in the ground they go).

The Mouth 402b (of the Downward Sloping 3-Sided Guide Rail 402) provides extra strength to the Guide Rail 402; this Mouth 402b allows the Three Individual Rails of Guide Rail 402 to be firmly attached to each other at the very top of the overall Guide Rail 402. The Downward Sloping 3-Sided Guide Rail 402 has an “open air” configuration. Each one of the Three Individual Rails is a round, cylindrical-like structure, which has curves or is straight, as shown in FIG. 1D-oz. There is an “inner triangle” formed between any three points of the inner surfaces of the individual Guide Rails. The distance between the inner edges of the three Rails is wide enough so the canister can comfortably fit into this “inner triangle space” and the canisters can move downward (and to the right) inside the open area provided by this “triangular inner space” between the Three Rails. There is a Harness Connecting Strap 402HS which is a band that wraps around, and is attached to, each of the Three individual Guide Rails to keep the Guide Rails locked together as an overall unit. The Rails “gently” curve to the right and downward, so a canister can smoothly move all the way down through the Rails to the Mouth of the Low Pressure Fluid Reservoir 404, which is located at the Entrance Point to the overall Low Pressure Fluid Reservoir 406.

The Guide Rail Motion Sensor 403 detects when the Leading Edge of a canister is moving in front of it (there is no analysis for the speed of a moving canister) and this Sensor 403 then immediately sends a signal to the Anti-floatation Stop-pin 407, causing the Stop-pin 407 to fully withdraw (retract). The Mouth 404 (of the Low Pressure Fluid Reservoir Entrance Point) has a “lip” (not shown) similar to the lip on an Alignment Ring (see FIG. 8a) that has a curvature and a rounded sloping edge so that when a canister is passing through this Mouth 404, the center of the Leading Edge of the canister is “guided” towards the exact center (the center of the circular axis) of the Low Pressure Fluid Reservoir 406.

The Splash Guard and Evaporation Guard 405 (for the Low Pressure Fluid Reservoir 406; see enlarged view of Splash Guard, FIG. 22) is a thin, light-weight rubber-like piece that does not inhibit the downward movement of a canister. This Splash Guard 405 sits directly inside the Mouth 404, which as stated above is located at the Entrance Point of the Low Pressure Fluid Reservoir 406. The purpose of this Splash Guard 405 is to keep any Fluid from splashing out of the Low Pressure Fluid Reservoir 406 and to help minimize evaporation. The overall Low Pressure Fluid Reservoir has a reference number of “406” and includes a total of Three Sections: a) the Left-side Section of the Low Pressure Fluid Reservoir, b) the middle portion designated as the Low Pressure Canister Holding Area 409, and c) the Right Side portion designated as the Pre-Pressure Chamber Area 414Pr. The pressure of the Fluid in this Reservoir 406 is basically at the ambient pressure of the air surrounding the Fluid Reservoir 406.

There is a reference for the Fluid Level 406W (in the Low Pressure Fluid Reservoir), as shown in FIG. 1D-oz. This Fluid Level 406W does not significantly change, whether or not the Left-side Waterproof Sliding Panel of the Variable Pressure Chamber 414 is open or closed. That Waterproof Sliding Panel, not shown separately, provides access for a canister to go from the Pre-Pressure Chamber Area 414Pr and to pass through the opening on the left side of the Variable Pressure Chamber 414 (when the Left-side Sliding Panel of the Variable Pressure Chamber 414 is open), so that the canister can then completely enter the Chamber 414. The Anti-floatation Stop-pin 407 includes two components, a Solenoid and a Plunger; the Plunger is the “Stop-pin.” The purpose of this Stop-pin 407 is to keep the canisters in the Low Pressure Canister Holding Area 409 from floating up to the left towards the Fluid's surface (towards the Fluid Level 406W). There is an Anti-floatation Stop-pin Mounting System 407M that consists of Two small Beams that hold the Stop-pin 407 in place. Both of these Mounting Beams connect on the left to a vertical Beam, which is one of the Vertical Support Beams in the Set of Support Beams 410Srs and connect on the right to the Anti-floatation Stop-pin 407.

Canister Entry Sensor 408 detects when a canister's Leading Surface has passed in front of it, but more importantly, this Sensor 408 also understands when the “back-end surface” of the same canister has passed in front of it, as the canister has kept moving to the right of Sensor 408. At that point when the “back-end surface” of the canister passes in front of the Sensor 408, this Sensor 408 sends a signal to the Stop-pin 407, which causes the Stop-pin 407 to fully extend to its default position. The Low Pressure Canister Holding Area 409 is where canisters wait to be “pulled” into the Variable Pressure Chamber 414 by the Canister Puller-head, which is part of the Pre-Chamber Horizontal Canister Puller Assembly 413. As stated above, the Motion Sensor 403 causes the Anti-floatation Stop-pin 407 to retract, which will allow the falling canister to move past (to the right) the retracted Anti-floatation Stop-pin 407. Once the canister has actually done that and moved past the Stop-pin 407, then the Motion Sensor 408 causes the Stop-pin 407 to extend to the default position, thereby “trapping” the “original” canister inside the Canister Holding Area 409. As a result, all canisters that are waiting in the Canister Holding Area 409 will be “pushed over” one canister length (one position) to the right.

There is a Series of Vertical Support Beams 410Srs and the purpose of these Beams is to support various pieces of equipment, as shown in FIG. 1D-oz. This Series of Beams 410Srs includes all the Vertical Support Beams in FIG. 1D-oz, except those Vertical Beams that are Inside the Fluid Reservoir 419; the Beams inside the Fluid Reservoir 419 are designated as 429Ntwrk. There is a Set of Three Support Beams 410L (on the left side of FIG. 1D-oz) and this Set of Beams 410L includes: a) Two Horizontal Beams (which are both “broken off”); the lower Horizontal Beam helps support the Guide Rail 402 and the higher Horizontal Beam helps support the Section of the Air Side Coil Stack 401 that is shown in FIG. 1D-oz, and b) One Angled Beam (at the top left of FIG. 1D-oz) that helps support the Section of the Air Side Coil Stack 401 just mentioned; this Angled Beam attaches on the left to the Section of the Coil Stack 401 and on the top right to a Far Left, Air Side Extension of the Fluid Reservoir Ceiling 427. The Subterranean Floor 411 (for the Over-sized Embodiment) is the lowest floor in the overall MF device for this Over-sized embodiment. (Note: in the in the Over-sized embodiment, the Subterranean Floor 317 of the preferred embodiment does not exist in the form it existed in the preferred embodiment; see Movement of Canisters Section; Definition of Terms, “Subterranean Floor 317.”)

The Pre-Pressure Chamber Magnetically-activated Sensor 412 magnetically determines exactly where the far-right canister is in the Low Pressure Canister Holding Area 409, and then this Sensor 412 sends that data to the Pre-Chamber Horizontal Canister Puller Assembly 413. (Note: in FIG. 1D-oz it looks like this Sensor 412 could not detect any magnetic forces from any canisters, but that is simply because the “new, falling canister” has not pushed all the canisters in the Canister Holding Area 409 over one canister length to the right—which is just about to happen in FIG. 1D-oz. There is a full explanation below about the operation of the Three Puller Assemblies, 413, 418, and 425 see 13 Topics; #5, “Over-sized embodiment.”)

The Pre-Chamber Horizontal Canister Puller Assembly 413 includes: a) an Electromagnet Puller-head, b) an Interface Mounting Component that attaches to the Head and that also slides, horizontally, along the Horizontal Rail (of the Puller Assembly 413), c) a continuous Belt-type Drive mechanism (powered by a small electric Motor, not shown) that causes the Puller-head to move, horizontally, and d) a Horizontal Rail upon which the Puller-head slides back and forth. This Puller Assembly 413 is responsible for moving a canister from the Pre-Pressure Chamber Area 414Pr into the Variable Pressure Chamber 414. The top of the Left-side Mount 413ML (for the Pre-Chamber Horizontal Canister Puller Assembly) is attached to the left side of the Horizontal Rail (of the Puller Assembly 413) and the bottom of this Left-side Mount 413ML is attached to the Subterranean Floor 411 (of the Over-sized embodiment). The top of the Right-side Mount for the Pre-Chamber Horizontal Canister Puller Assembly 413MR is attached to the right side of the Horizontal Rail of the Puller Assembly 413 and the bottom of this Right-side Mount 413MR is attached to the Subterranean Floor 411 (of the Over-sized embodiment). The reference number for 413MR is shown in FIG. 23b.

The Variable Pressure Chamber 414 has a Left-side Waterproof Sliding Panel and a Right-side Waterproof Sliding Panel (neither Panel is shown); the outside of the Left-side Sliding Panel is under low pressure and the outside of the Right-side Sliding Panel is under high pressure. These Two Sliding Panels are never open at the same time. A canister passes through this Variable Pressure Chamber 414 (going from left to right) in order to enter the Fluid Reservoir 419 and specifically to move into the “first position” (the lowest position) on the Upward Sloping 3-sided Circular Guide Rail System 420. Eventually the canister will climb up to the Reservoir Exit Launching System Area 426, where the canister will be “Launched” out of the entire Fluid Reservoir 419, up towards the Pre-launch Area 308 (the same Pre-launch Area shown in FIG. 1H).

The Pre-Pressure Chamber Area 414Pr is a horizontal area (the farthest right part of the overall Low Pressure Fluid Reservoir 406); the left half of this Pre-Pressure Chamber Area 414Pr will usually have a canister sitting in it and the right half of the Pre-Pressure Chamber Area 414Pr basically remains empty except when a canister is being pulled from the left half of this Pre-Pressure Chamber Area 414Pr into the Variable Pressure Chamber 414. The reason the left half of this Pre-Pressure Chamber Area 414Pr is empty in FIG. 1D-oz is because the canister 399 has not moved into the Low Pressure Fluid Reservoir 406 and has not yet moved all the canisters sitting in the Low Pressure Canister Holding Area 409 over one canister position to the right. Also, there is a canister in the Variable Pressure Chamber 414, and that canister was just “pulled” from the left side of the Pre-Pressure Chamber Area 414Pr into the Variable Pressure Chamber 414.

The Variable Pressure Chamber Outlet Port and Passageway Entrance 4140P is a round “hole” in the back of the Variable Pressure Chamber 414, and is shown in FIG. 23a. This Outlet Port 4140P is where the High Pressure Fluid exits the Variable Pressure Chamber 414, after a canister has been “dragged out” of the Variable Pressure Chamber 414 by the Post-Chamber Angled Canister Puller Assembly 418, and also after the Right-side Waterproof Sliding Panel has closed (this Right-side Panel will automatically close once a canister has been “pulled” completely out of the Variable Pressure Chamber 414). The term “Passageway” in this 414OP reference refers to the long, tube-like component that is designated as 414Py in FIG. 1D-oz.

The Passageway 414Py (for Fluid Exiting the Variable Pressure Chamber) connects to the Variable Pressure Chamber 414 on the right and leads to the Two High Pressure Nozzles 416NZL (see FIG. 25) that spray Fluid onto the Fluid Turbine 416W. The Post-Pressure Chamber Area 414Pt is an area directly to the right of the Variable Pressure Chamber 414 and this Post-Pressure Chamber Area 414Pt is similar to the Pre-Pressure Chamber Area 414Pr, in that the Post-Pressure Chamber Area 414Pt is basically left empty except when a canister is being pulled out of the Variable Pressure Chamber 414 (to the right), and pulled all the way into the Upward Sloping 3-sided Circular Guide Rail System 420.

The Outlet Port Valve 415 is mounted inside Passageway 414Py and Valve 415 either blocks or allows Fluid to pass out of the Variable Pressure Chamber 414 and move further to the left, through the Exit Passageway 414Py. The precise location of this Valve 415 is a short distance behind and to the left of the Outlet Port 4140P (as shown in FIGS. 23a and 23b). In FIG. 1D-oz there is a reference for the Fluid Level 414PyW in the Passageway 414Py. This Fluid Level 414PyW in the Exit Passageway 414Py is a little higher than the Level of Fluid 406W in the Low Pressure Fluid Reservoir 406. This will be a workable scenario to have Fluid at two different levels because the Two “Fluid Systems” are actually independent in some ways. The main consideration is that every time any Waterproof Sliding Door opens or closes on the Variable Pressure Chamber 414 and/or every time the Outlet Port Valve 415 opens to let Fluid come into the Exit Passageway 414Py, there is always the same volume of Fluid that just keeps moving back and forth, from one area to another.

Each and every time a canister is inside the Variable Pressure Chamber 414, there is a specific volume of Fluid, the “Chamber-Fluid Volume” that is inside the Variable Pressure Chamber 414; this volume is: the total volume inside the Variable Pressure Chamber 414 MINUS the volume of a canister. Therefore, the High Pressure Nozzles 416NZL are “programmed” to allow an amount of Fluid precisely equal to the “Chamber-Fluid Volume” to pass through the Two Nozzles 416NZL, before these Nozzles 416NZL shut off. In this way, the volume of Fluid in the Low Pressure Fluid Reservoir 406 will never increase or decrease, because the same volume of Fluid that was sprayed out of the Nozzles 416NZL will be returned to the Low Pressure Fluid Reservoir 406 through the Low Pressure Fluid-return Funnel System 417. Also, since the Outlet Port Valve 415 is always closed when the left Waterproof Sliding Panel on the Variable Pressure Chamber 414 is open, and the left Waterproof Sliding Panel on the Variable Pressure Chamber 414 is always closed when the Outlet Port Valve 415 is open, these Two “Fluid Systems” can maintain different Fluid heights since they are basically independent systems. Put another way, the “Variable Pressure Chamber 414 (which is also a “Fluid Transfer System”) dumps the same amount of Fluid back into the “406 Fluid System” every time a canister is moved out of the Variable Pressure Chamber 414 and High Pressure Fluid is cycled through the Two Nozzles 416NZL. In any event, this entire “Fluid recycling sub-process” can be adjusted and fine tuned during the trial runs, when the device is being configured before the actual First Cycle of Use begins.

There is a reference for the overall Fluid Turbine Area 416; the Electric Generator, 430, is considered to be in the Fluid Turbine Area. FIG. 25 shows the Electric Generator 430 in back of the Fluid Turbine 416W. These Two components turn in unison, because the shaft of the Electric Generator 430 is molded onto the shaft that comes out the back of the Fluid Turbine 416W. The Fluid Turbine 416W is made to spin by the force of Fluid coming out of the Two High Pressure Nozzles 416NZL. FIG. 25 shows the Dual High-pressure Nozzle Configuration 416NZL (located in the Fluid Turbine Area). The purpose of having Two Nozzles is to add extra power and to add that power faster, when Fluid is being sprayed out of the Two Nozzles 416NZL onto the Fluid Turbine 416W to make it spin.

Returning now to FIG. 1D-oz, the Low Pressure Fluid-return Funnel System 417 is positioned below the area where the Two Nozzles 416NZL spray Fluid onto the blades of the Fluid Turbine 416W. This Funnel System 417 allows all of the Fluid sprayed out by the Nozzles 416NZL to return to the Low Pressure Fluid Reservoir 406. This Fluid enters the Low Pressure Fluid Reservoir 406 at 406W.

The Post-Chamber Angled Canister Puller Assembly 418 operates in a manner similar to the Pre-Chamber Horizontal Canister Puller Assembly 413. This Post-Chamber Puller Assembly 418 includes: a) an Electromagnet Puller-head, b) an Interface Mounting Component that attaches to the Puller-head and that also slides along the Semi-horizontal Rail, c) a continuous Belt-type Drive mechanism (powered by a small electric Motor, not shown) that causes the Puller-head to move, back and forth along the Semi-horizontal Rail, and d) a Semi-horizontal Slide Rail upon which the Puller-head slides back and forth. This Puller Assembly 418 moves a canister to the right, pulling the canister out of the Variable Pressure Chamber 414 and then continuing to pull the canister through the Post-Pressure Chamber Area 414Pt, and finally into a position where buoyancy will cause the canister to enter the Upward Sloping 3-sided Circular Guide Rail System 420 (see 13 Topics; #5, “Over-sized embodiment”).

The far left side of the Puller Assembly 418 is “in the air” and all the rest of the Puller Assembly 418 (to the right of that hatched vertical “Wall Section” on the left side of the Canister Puller Assembly 418) is “in the Fluid” (inside the Fluid Reservoir 419). There is a small circular passageway that is sealed with a waterproof seal where the far left section of the Semi-horizontal Slide Rail (of the Puller Assembly 418) goes through that particular Vertical Wall (this Wall of the Fluid Reservoir 419 is near the bottom of the Reservoir 419, just above the Variable Pressure Chamber 414).

The Left-side Mount 418ML (for the Post-Chamber Angled Canister Puller) is attached (as shown) to the Vertical Wall just described in the previous paragraph, and also at the bottom this Left-side Mount 418ML is attached to the left side of the Semi-horizontal Slide Rail. The top of the Right-side Mount 418MR (for the Canister Puller Assembly 418) attaches to the bottom of a Vertical Beam 418SR and the bottom of the Right-side Mount 418MR attaches to the far right end of the Semi-horizontal Rail (of the Canister Puller Assembly 418). The Right-side Vertical Mounting Beam 418SR (for supporting the Semi-horizontal Rail of the Canister Puller Assembly 418) is attached at the top to an inner extension of a section of a Horizontal Wall (for the Fluid Reservoir 419) and the Right-side Mount 418MR is attached to the bottom of this Vertical Mounting Beam 418SR.

The reference for the entire Fluid Reservoir 419 includes not only the Walls of the Reservoir 400, but this Fluid Reservoir 419 also includes all of the equipment inside the Fluid Reservoir 419, all the space occupied by the Reservoir 419 and all the Fluid inside the Reservoir 419. The reference for the Overall Wall and Floor Configuration 400 (for the Fluid Reservoir 419) includes: a) the Two (hatched) Vertical Walls, b) the (hatched) Floor Piece (lowest right area of FIG. 1D-oz), c) the Two Hatched Surfaces (one horizontal and one vertical) above the Variable Pressure Chamber 414, and d) the Hatched Surface that connects with the Variable Pressure Chamber 414 and also connects with the (hatched) Floor Piece just described above in this paragraph. This Overall “Wall Configuration” (for the Fluid Reservoir 419; shown in FIG. 1D-oz) includes every Hatched Surface where the Hatching Lines are going Up and to the Right, except for the Fluid Reservoir Ceiling 427, which is also one of the essential partitions that is a part of the overall set of bounding surfaces for the Reservoir 419, but this Reservoir Ceiling 427 is designated as a separate component.

The Upward Sloping 3-sided Circular Guide Rail System 420 has the same configuration as the Downward Sloping 3-Sided Guide Rail 402, in terms of how each of the Three Rails is positioned in regards to the other Two Rails (how there is a triangle-like space between the inner surface-edges of the Three Rails that a canister passes through), except that: a) the Guide Rail System 420 slopes gradually in an upward direction, and b) the Guide Rail System 420 gently winds around in two very large circles. In the Over-sized embodiment shown in FIG. 1D-oz, this Guide Rail System 420 climbs up a total vertical height of about 26 feet, until it connects with the Curved Interface Pathway Section 424.

[Note: as explained below, there is a different reference, 428, for the entire “Circular Upward-sloping Canister Pathway;” this Guide Rail System 420 reference is specifically for the Three Rails and any connecting interfaces that hold the Three Rails in the proper position, relative to each other. Also, if the upward slope of this Guide Rail System 420 is not steep enough so the canisters move smoothly and freely throughout this Guide Rail System 420, then the slope can be increased to an upward angle that will cause the canisters to move freely by either: a) making this Guide Rail System loop around only one time instead of two and/or b) by raising the height of the Fluid Reservoir. If the Guide Rail System 420 is modified to be One Loop instead of Two Loops, then the number of canisters in the entire Canister Set for the Over-sized embodiment will be reduced by about 25 canisters.]

The Temporary Stop-point Electromagnet #1 (EM#1) 421 (of Over-sized embodiment) creates a Magnetic Field that attracts the Magnetic Field of a magnet that is inside a canister, and where that magnet is directly above this Stop-point EM#1 421. For example, in FIG. 1D-oz (or FIG. 24a has an enlarged view of the same area being discussed) it is easy to see that the magnet that will be affected by this Stop-point EM#1 421 is in the Second canister in the “canister cue,” at the top of the Upward Sloping 3-sided Circular Guide Rail 420. (Note: a full explanation of how this sub-process works is given below, see 13 Topics; #5, “Over-sized embodiment.”) The magnetically attractive force created by this Stop-point EM#1 421 will be strong enough to hold the affected magnet (and the related canister) in place for a pre-determined period of time so separation occurs between: a) a canister that is the topmost canister in the “canister cue” and b) the canister that is being held by the Stop-point EM#1 421, which is a canister in the Second Topmost Canister Position in the “canister cue.”

The Top Canister Anti-floatation Stop-pin 423 is the component that allows the top canister (at the top of the Upward Sloping 3-sided Circular Guide Rail System 420) to move to the right and enter the Curved Interface Pathway Section 424. It is while that Top Canister is moving to the right that the Stop-point EM#1 421 creates the Magnetic Field to “hold” the second-to-the-top canister in place. The Temporary Stop Point Retaining Pin 422 extends out at a pre-determined split second after the Temporary Stop Point EM#1 421, is activated. This Temporary Retaining Pin 422 will block the “second-in-line” canister from moving to the right, until the adjacent canister to the right has cleared the Stop-pin 423, to the right. This “pre-determined split second” allows for the separation between the Two Canisters being discussed, so that Retaining Pin 422 has the physical space in which to extend. If EM#1 421 did not create this separation between the two canisters (if the second-to-the-top canister was allowed to move in unison with the top canister, after the Stop-pin 423 retracted), then Retaining Pin 422 would be “hitting” some part of a canister when it attempted to fully extend.

The Curved Interface Pathway Section 424 connects the top of the Upward Sloping 3-sided Circular Guide Rail System 420 with the bottom of the Reservoir Exit Launching System Area 426. The Curved Pre-exit Canister Puller Assembly 425 works in basically the same manner as the other Two Canister Puller Assemblies, 413 and 418. This Canister Puller Assembly 425 includes: a) an Electromagnet Puller-head, b) an Interface Mounting Component that attaches to the Puller-head and that also slides along the Curved Rail, c) a continuous Belt-type Drive mechanism (powered by a small electric Motor, not shown) that causes the Puller-head to move along the Curved Rail, to the left or right, and d) a Curved Rail upon which the Puller-head slides back and forth.

A canister that has been “released” by the Stop-pin 423 will be able to move to the right, up and through the Curved Interface Pathway Section 424, according to the force of buoyancy (the Canister Length Pressure Differential Force is weak because the canister is not pointing straight up in the Curved Interface Pathway Section 424). However, this movement could be slow and/or unpredictable. So to ensure that each canister moves quickly and efficiently through the Curved Interface Pathway Section 424, Canister Puller Assembly 425 is used. There is no Sensor to initiate the action of this Canister Puller 425 because the precise starting position is known for each and every canister that is to be pulled to the right. The Leading Surface of the canister that is to be “dragged” by the Puller 425 is at the same point where the canister is being released by the Stop-pin 423 (that is, where the Stop-pin 423 is permanently located). Therefore, the Electromagnet of the Puller 425 is activated at the same time the Stop-pin 423 retracts, so that the Puller 425 can immediately start moving the canister to the right and upward.

Throughout this whole “movement process,” the Puller-head (part of the Canister Puller Assembly 425) has “magnetic control” over the canister, as the canister is moved through the Curved Interface Pathway Section 424; the Curved Interface Pathway 424 has a curvature that is parallel to the curvature of the Curved Rail of the Puller Assembly 425. The top of the Curved Pre-exit Canister Puller Left-side Mount 425ML is attached to the Mounting Block at the bottom of the left arm of the Curved Pre-exit Canister Puller Vertical Mounting Beam 425 MB and the bottom of this Puller Left-side Mount 425ML is attached to the left side of the Curved Rail of the Puller Assembly 425. This reference for 425ML is shown in FIG. 24a. The top of the Curved Pre-exit Canister Puller right-side Mount 425MR is attached to the Mounting Block at the bottom of the right arm of the Curved Pre-exit Canister Puller Vertical Mounting Beam 425MB and the bottom of this Puller Right-side Mount 425MR is attached to the right side of the Curved Rail of the Puller Assembly 425. This reference for 425MR is shown in FIG. 24a.

The top of the Curved Pre-exit Canister Puller Vertical Mounting Beam 425MB is attached to the Fluid Reservoir Ceiling 427. At the bottom of this Mounting Beam 425MB, there are two arms, a left arm and a right arm, and each arm has a Mounting Block. These Two Mounting Blocks attach, respectively, onto the Left-side Mount 425ML and Right-side Mount 425MR for the Curved Rail of the Puller Assembly 425 (as described in the previous paragraph).

There is a reference for the overall Reservoir Exit Launching System 426 which includes all the equipment in this Launching System 426 and all the space occupied by this Launching System 426 (see FIG. 27). The Fluid Reservoir Ceiling 427 is slightly above the Fluidline for the Fluid inside the Fluid Reservoir 419. This Fluid Reservoir Ceiling 427 is attached on the left to the Left Vertical Wall and also is attached on the right to the Right Vertical Wall, where these “Walls” are essential parts of the Wall System 400 of the Fluid Reservoir 419. There is a circular “hole” cut out of this Reservoir Ceiling 427; this hole is designated as the Fluid Reservoir Exit Opening 459. This Exit Opening 459 is where canisters exit the entire Fluid Reservoir 419 (of the overall MF device for the Over-sized embodiment). This Exit Opening 459 is shown in FIG. 27.

There is a reference for the Entire Circular Upward-sloping Canister Pathway 428, which includes the Upward Sloping 3-sided Circular Guide Rail System 420 and also includes all the Support Beams (the 429Ntwrk of Beams) used to suspend the Upward Sloping 3-sided Circular Guide Rail System 420 in the Fluid inside the Fluid Reservoir 419. The Network of Mounting Beams 429Ntrwk (for the Circular Upward-sloping Canister Pathway 420) includes all the Vertical, Horizontal and Angled Beams and Horizontal Platforms used to support the entire Upward Sloping 3-sided Circular Guide Rail 420.

Turning now to FIG. 25, as mentioned above, the Electric Generator 430 spins in tandem with the Fluid Turbine 416W; when this Generator 430 spins, it produces electricity. The Mounting System 430M (for the back-end of the Electric Generator, for the Over-sized Embodiment) includes Two Support Beam Structures (Front and Rear) and also includes the Bearing affixed to the top of both the Front and Rear Support Beam Structures. The back end of the shaft that comes out the back of the Electric Generator goes through, and is supported by, the Bearings (of Mounting System 430M).

Turning now to FIG. 27, the Lower Truncated Vertical Quad Alignment Rail Assembly 450a includes: a) the Four Individual Rails, which are positioned in a vertical direction, except that there is an outward curvature to the bottom portion of each Rail, b) a set of Four Horizontal Support Rails (that form an octagon shape) that connect each Vertical Rail to the Two Vertical Rails next to it on either side, and c) the left and right Horizontal Mounting Beams that go: i) from the left Rail of the Quad Alignment Rail Assembly 450a to the Left-side Equipment Support Wall 463L, and ii) from the right Rail of the Quad Alignment Rail Assembly 450a to the Right-side Equipment Support Wall 463R. This Lower Truncated Quad Alignment Rail Assembly 450a ensures that a canister is ascending with True Vertical Alignment and that: a) the canister is perfectly centered between all the “Miniature Speed-adjusting Electromagnets” that are operating in the Reservoir Exit Launching System 426, and b) the canister is perfectly centered under the Two Notch Pin Systems and under the Two Stop-pin Systems. The Upper Truncated Vertical Quad Alignment Rail Assembly 450b has the exact same configuration as the Lower Quad Alignment Rail Assembly 450a and ensures that a canister is perfectly centered under the Two Stop-pin Systems.

The Right-side Miniature Speed-adjusting Electromagnet (Over-sized Embodiment Miniature EM#1) 451aR is used to slow the upward movement of a canister before such canister makes contact with the Right-side Reservoir Exit Notch Pin System 452R. There is an iron-like core inside Miniature EM#1 451aR, and this core is the rod-like piece that is extending out of the top and the bottom of Miniature EM#1 451aR. The other Five Miniature Speed-adjusting Electromagnets: 451bR (Miniature EM#2), 451cR (Miniature EM#3), and the Left-side Counterparts of 451aR, 451bR, and 451cR all operate in exactly the same manner as the Right-side Miniature Speed-adjusting Electromagnet (EM#1) 451aR. However, the Two Lower Pairs of Miniature EMs slow a canister down for a different reason than the Upper Pair of EMs. The operation of the entire Reservoir Exit Launching System 426 is fully explained in the latter portion of 13 Topics; #5, “Over-sized embodiment.”

The Horizontal Mounting System 451aMR (for the Right-side Miniature Speed-adjusting Electromagnet 451aR) includes: a) a Circular Belt-type Mounting Band that goes completely around Miniature EM#1 451aR and b) One Horizontal Beam. This Horizontal Beam attaches, on the left side, to the Mounting Band that goes around Miniature EM#1 451aR and on the right side attaches to the Right-side Equipment Support Wall 463R. This style of Mounting System is the same for all Six Miniature Speed-adjusting Electromagnets 451aR, 451bR, 451cR, and their Left-side Miniature Electromagnet Counterparts, in this overall Reservoir Exit Launching System 426. The right side of each Horizontal Beam for the Three Left-side Miniature Electromagnets attaches, on the right, to the respective Circular Mounting Band and the left side of each of these Three Mounting Beams attaches to the Left-side Equipment Support Wall 463L.

The Right-side Reservoir Exit Notch Pin System 452R operates in exactly the same manner as the Upper Left Pivot Bucket Stop-pin System 264L in the preferred embodiment (see FIG. 12), except that: a) the operation of this Notch-pin System 452R is the horizontal mirror image of the Stop-pin System 264L, b) there is no Pressure Gauge attached to this Notch Pin System 452R, and c) the Notch-pin System 452R extends into a Notch on a canister, whereas the Stop-pin System 264L merely extends “into mid-air.”

The Counterpart Left-Side Notch Pin System to this Notch Pin System 452R (shown in FIG. 27) and including the related Horizontal Mounting Beam counterpart do not have reference numbers, but the Left-side Notch Pin System and its Mounting Beam are the horizontal mirror image of this Right-side Notch Pin System 452R and its Mounting Beam 452MR. The Mounting Beam for the Notch Pin System on the Left Side is attached, on the right, to the Left-side Notch Pin System and attached on the left to the Left-side Equipment Support Wall 463L. The Horizontal Mounting Beam 452MR (for the Right-side Reservoir Exit Notch Pin System 452R) is one Triangle-shaped Horizontal Beam that attaches to the Notch Pin System 452R on the left and attaches to the Right-side Equipment Support Wall 463R on the right.

The Lower Magnetically-activated Sensor 453 (for the Two Lower Miniature Speed-adjusting EM Pairs, 451aR and 451bR, and also for their Left-side Counterparts) mounts directly to the Right-side Equipment Support Wall 463R. This Magnetically-activated Sensor 453 detects when a canister is moving in front of it. At that point, a signal is sent to the Four Lower Miniature Speed-adjusting Electromagnets named above in this paragraph and all Four of these Miniature Electromagnets immediately create Magnetic Fields that will help slow down the upward movement of the TWO Lower Canisters, that are trying to move upward due to the combined force of their buoyancies and the Compounded Force of the Canister Length Pressure Differential.

The term “compounded” is used here because the Pressure Differential in this instance, with Three Canisters “interconnected” with each other and pointing up in perfect vertical alignment is actually much greater than with one canister. (Note: the CLPDF is based around Three canisters interconnected, vertically, but the Four Lower EMs are only slowing down the Two Lower Canisters.) In other words, the pressure differential will be as if a canister is Three times as long as a “regular” canister; the force pushing up on the bottom of the lowest canister will be much greater than the force pushing down on the top surface of the top canister. The “Three canisters” being discussed here are the Two Lower canisters in FIG. 27 and an additional canister that will come up underneath the Lowest canister—a Fourth canister; the Top canister, that is being directly held by the Right-side Floatation Stop-pin System 455R and its Left-side Counterpart, in FIG. 27, will be released by the Two Floatation Stop-pins and will “float away” from the other canisters before the Right-side Reservoir Exit Notch Pin System 452R and its Left-side Counterpart release the Middle canister.

The Motion Sensor 454 (for Miniature Speed-adjusting Electromagnet #3 451cR and its Left-side Miniature EM Counterpart) detects when a canister is moving in front of it. At that point, a signal is sent to the Two Top Miniature Speed-adjusting Electromagnets 451cR (and its Left-side Counterpart) and these Two Electromagnets create Magnetic Fields that will tend to slow down the upward movement of the canister that is moving up towards the Fluid Reservoir Right-side Floatation Stop-pin System 455R (and also towards the Left-side Counterpart of this Stop-pin System 455R). This Sensor 454 mounts directly to the Right-side Equipment Support Wall 463R.

The Right-side Floatation Stop-pin System 455R, and its Left-side Counterpart (for the Over-sized embodiment) regulate the timing of the launches of canisters out of the Reservoir Exit Launching System 426. This Floatation Stop-pin System 455R operates in exactly the same manner as the Upper Left Pivot Bucket Stop-pin System 264L in the preferred embodiment (see FIG. 12), except that: a) the operation of this Floatation Stop-pin System 455R is the horizontal mirror image of the Stop-pin System 264L, and b) there is no Pressure Gauge attached to this Floatation Stop-pin System 455R.

The Left-Side Floatation Stop-pin System, including the related Horizontal Mounting Beam, do not have reference numbers, but the Left-side Floatation Stop-pin System and its Mounting Beam are the mirror image of this Right-side Floatation Stop-pin System 455R and its Mounting Beam 455MR. The Mounting Beam for the Left-side Floatation Stop-pin System on the right is attached to the Left-side Floatation Stop-pin System and attached on the left to the Left-side Equipment Support Wall 463L. The Horizontal Mounting Beam 455MR (for the Right-Side Floatation Stop-pin System 455R) is one Triangle-shaped Horizontal Beam that attaches to the Floatation Stop-pin System 455R on the left and attaches to the Right-side Equipment Support Wall 463R on the right.

The Mid-point Alignment Ring 456 includes one Horizontal Mounting Arm to the right and one Horizontal Mounting Arm to the left. This Alignment Ring 456 ensures that a canister is ascending with True Vertical Alignment and that the canister is directly underneath the other essential components that operate in the Reservoir Exit Launching System 426.

The lowest Right-side, Full-size Reservoir Exit Acceleration Electromagnet 457aR (Full-size EM#2 for the Over-sized Embodiment) is used to accelerate the upward movement of a canister, as the canister is in the process of being “Launched” out of the Reservoir Exit Launching System 426. There is an iron-like core inside this Full-size Reservoir Exit Acceleration EM#2 457aR, and this core is the rod-like piece that is extending out of the top and the bottom of Acceleration EM#2 457aR. The Lowest Left-side, Full-size Reservoir Exit Acceleration Electromagnet does not have a reference number, but the Left-side Counterpart of this Full-size EM#2 457aR operates in exactly the same way as Full-size EM#2 457aR.

In another embodiment, these Four Reservoir Exit Acceleration Electromagnets (457aR and 457bR and their Left-side Counterparts, and also any additional “Acceleration Electromagnets” not shown in FIG. 27) could be rotated 90 degrees. Either way, the purpose of all the Electromagnets in this “Canister Acceleration and Reservoir Exit Sub-system” is to accelerate an ascending canister in the most powerful and economically efficient manner. Any attraction these Four Full-size Electromagnets have that would tend to pull a canister to the left or to the right should be non-existent according to this MF embodiment shown in FIG. 27, because the magnetically attractive forces of the left and the right Electromagnetic Fields will be pulling EQUALLY on a canister-magnet (to go in both directions, to the left and to the right) and therefore any and all “horizontal pulling effects” will basically cancel themselves out and the canister will head upwards in a straight vertical direction.

The Horizontal Mounting System 457aMR (for the Right-side Full-size Reservoir Exit Acceleration Electromagnet 457aR) includes: a) a Circular Belt-type Mounting Band that goes completely around Full-size EM#2 457aR and b) One Horizontal Beam. This Horizontal Beam attaches, on the left side, to the Mounting Band that goes around Full-size EM#2 457aR and on the right side attaches to the Right-side Equipment Support Wall 463R. This exact Horizontal Mounting System is the same for all Four Full-size Reservoir Exit Acceleration Electromagnets (457aR, 457bR, and their Left-side Counterparts) shown in FIG. 27, except that the Mounting Beams for the two Left-side Counterparts attach to the Left-side Equipment Support Wall 463L.

The Right-side, Full-size Reservoir Exit Acceleration Electromagnet 457bR (Full-size EM#3 for the Over-sized Embodiment) operates in exactly the same manner as Full-size EM#2 457aR, except that there is a pre-determined time delay between when Full-size EM#2 457aR creates its Magnetic Field and when Full-size EM#3 457bR creates its Magnetic Field, explained in the latter portion of 13 Topics; #5, “Over-sized embodiment.” The Left-side Electromagnet Counterpart to this Full-size Reservoir Exit Acceleration Electromagnet (EM#3) 457bR does not have a reference number, but the Left-side Counterpart of this Full-size EM#3 457bR is the mirror image of this Right-side Full-size EM#3 457bR.

The Full-length Vertical Quad Alignment Rail Assembly 458 includes: a) the Four Individual Rails which are positioned in a vertical direction, except that there is an outward curvature to the bottom portion of each Rail, b) multiple sets of Four Horizontal Support Rails (that form an octagon shape) that connect each Vertical Rail to the Two Vertical Rails next to it on either side, and c) the left and right Horizontal Mounting Beams that go: i) from the left Rail of the Quad Alignment Rail Assembly 458 to the Left-side Equipment Support Wall 463L, and ii) from the right Rail of the Quad Alignment Rail Assembly 458 to the Right-side Equipment Support Wall 463R. This Quad Rail Assembly 458 starts at a vertical point above the Mid-point Alignment Ring 456, as shown in FIG. 27 (the bottom “broken-section” of this Quad Guide Rail 458) and goes upward as one continuous component, all the way up to the point where the top of this Quad Rail Assembly 458 is just inches below the Fluid Reservoir Exit Opening 459, as shown in the top “broken-section” of this Quad Rail Assembly, near the top of FIG. 27.

In FIG. 27, this Quad Guide Rail Assembly 458 is “broken off” into two different Sections, but this was done only due to a lack of vertical space on the drawing page. This Quad Rail Assembly 458 ensures that a canister is ascending with True Vertical Alignment and that: a) the canister is perfectly centered between all the Accelerating Electromagnets that are operating in the Reservoir Exit Launching System 426, and b) that the canister is perfectly centered under the Fluid Reservoir Exit Opening 459, as the canister is being accelerated and is in the process of exiting the Reservoir Exit Launching System 426.

The Fluid Reservoir Exit Opening 459 is just a circular “hole” cut-out of the Fluid Reservoir Ceiling 427. The Exit Opening Splash Guard 460 is slightly larger than the Exit Opening 459 “hole” (see FIG. 30) and this Splash Guard 460 is mounted so that the center of this Splash Guard 460 is aligned with the center of the Exit Opening 459. This Splash Guard 460 is the final component that makes contact with a canister when that canister is exiting the Reservoir Exit Launching System 426. This Splash Guard 460 is a thin, light-weight rubber-like piece that does not inhibit the upward movement of a canister. The purpose of this Splash Guard 460 is to keep a canister from “dragging out” any Fluid from the Fluid Reservoir 419 when the canister exits the Reservoir 419 (and also exits the Reservoir Exit Launching System 426); also, this Splash Guard 460 is there to keep Fluid from evaporating out of the overall Fluid Reservoir 419.

The Above Ceiling Alignment Ring 461 sits on top of, and is attached to, the Fluid Reservoir Ceiling 427. However, as shown in FIG. 27 on both the far right of the Right Mounting Arm and the far left of the Left Mounting Arm of this Alignment Ring 461, there is a small “spacer” component that elevates this Alignment Ring 461off of the top surface of the Reservoir Ceiling 427. This Air Gap between the Alignment Ring 461 and the top surface of the Reservoir Ceiling 427 gives the Splash Guard 460 some additional vertical space to “rise up” with a canister, as the canister is moving up-and-through the Exit Opening 459 and pushing the individual wedge-shaped sections of the Splash Guard 460 out of the way of the canister. This Alignment Ring 461 ensures that a canister is ascending with True Vertical Alignment and that the canister is directly under the next component the canister will encounter as it ascends towards the Pre-launch Area 308; this “next component” is the Arc C Pre-launch; Speed-adjusting EM#2 195 (even though the name for this component comes from the preferred embodiment, because there is No Arc C in the Over-sized embodiment), as shown in FIG. 1E-oz.

So this EM#2 195 in FIG. 1E-oz is the same Speed-adjusting Electromagnet (EM#2) 195 as the one used in the preferred embodiment (in FIG. 1G) because in the Over-sized Embodiment, once a canister reaches the Lower Speed and Motion Sensor 194, the canister is going through the exact same process that a canister goes through at that point in the preferred embodiment (except for any sub-embodiment modifications made to the Underwater Launch Area 310 to compensate for the added Fluid Pressure as a result of the Over-sized Embodiment calling for a much higher Fluid Column, as explained in the latter portion of 13 Topics; #5, “Over-sized embodiment”). The Fluid Refill Port and Refill Mechanism 462 monitors the Fluid Level inside the Fluid Reservoir 419 and replenishes Fluid in the Reservoir 419 as is necessary. The entire function of this Refill Mechanism 462 is also explained more in 13 Topics; #5, “Over-sized embodiment.”

In FIG. 27 the Right-side Equipment Support Wall 463R runs the entire vertical length of the Reservoir Exit Launching System Area 426 (see FIG. 1D-oz). All of the equipment on the right side of the Reservoir Exit Launching System 426 is mounted to this Support Wall 463R. The Left-side Equipment Support Wall 463L runs the entire vertical length of the Reservoir Exit Launching System Area 426. All of the equipment on the left side of the Reservoir Exit Launching System 426 is mounted to this Support Wall 463L.

Turning now to FIG. 29, shown there is a “phantom canister” PhC-5 entering the Lower Truncated Vertical Quad Alignment Rail Assembly 450a. The purpose of this drawing is to show the narrow clearance between the outer surface of a canister and the Four Individual, Equally-spaced Rails of the Lower Truncated Vertical Quad Alignment Rail Assembly 450a.

Turning now to FIG. 1E-oz, there are two small differences between the Over-sized embodiment and the preferred embodiment. There is a Lower Speed and Motion Sensor Mount 194MZ which is One Vertical Beam. The top of this Vertical Beam 194MZ attaches to the bottom surface of the Far Right Horizontal Beam (of the Mounting System 195M), which specifically is the Beam that goes between the Front and Rear Beams of the Structural Beam System 299R. The bottom of this Sensor Mount 194MZ attaches to the top of the Speed and Motion Sensor 194. Also, there is an Upper Speed and Motion Sensor Mount 196MZ which is One Vertical Beam. The top of this Vertical Beam 196MZ attaches to Sensor 196 and the bottom of this Vertical Beam 196MZ attaches to the top surface of the Far Right Horizontal Beam (of the Mounting System 195M).

Also in FIG. 1E-oz, there are Two “phantom components,” a phantom Fluid Reservoir Ceiling Ph427 and a phantom Exit Opening Splash Guard Ph460. These Two phantom components are in FIG. 1E-oz to show that a canister that is exiting the Reservoir Exit Launching System 426 will be in perfect vertical alignment with the Speed-adjusting Electromagnet (EM#2) 195. The Above-ceiling Alignment Ring 461 is not shown (as a phantom component) so as not to distract from the purpose of showing the alignment properties just mentioned. As explained near the end of 13 Topics; #5, “Over-sized embodiment,” a canister coming up through the (phantom) Splash Guard Ph460 will have enough velocity to execute a successful Coupling Process in the Pre-launch Area (shown in FIG. 1H), even though the Fluid Column for an Over-sized embodiment has a height of 200 feet or more (and therefore Excessive Fluid Pressure is created in the Underwater Launch Area 310 as a result of this added height to the Fluid Column).

Turning now to FIG. 36a, the Downward-sloping 3-sided Modified Circular Guide Rail System 464 has the same configuration as the Upward Sloping 3-Sided Circular Guide Rail System 420 in FIG. 1D-oz, in terms of how each of the three Rails is positioned in regards to the other Two Rails (how there is a triangle-like space between the inner surface-edges of the Rails that a canister passes through). However, on the Guide Rail System 464: a) canisters are pulled downward by the force of gravity, and b) this Guide Rail System 464 gently winds around in Three Circles, instead of Two Circles. In the Over-sized embodiment shown in FIG. 36a, this Guide Rail System 464 has a total height of about 39 feet. This Guide Rail System 464 ends (changes names) at the point over to the lower far right, after the Guide Rail System 464 has made its final “turn” (coming down towards the bottom of the drawing) and the canisters are in a “straight-line cue” and are heading in that straight line towards the Drop Point 301 (the Drop Point is not shown in FIG. 36a). At that precise point where the Guide Rail System 464 ends, the canisters still continue moving in a continuous fashion, but the name for the piece of equipment the canisters are moving on becomes the Modified Inclined Platform Cue 468.

The Modified Inclined Platform Cue 468 is the far left and lowest area where the canisters are, after a canister has begun moving in a straight line, as a canister is headed towards the Drop Point 301 (Drop Point not shown). The far left, lower portion of this Modified Inclined Platform Cue 468 has been “broken off” in FIG. 36a, but the configuration of this Modified Platform Cue 468 is exactly the same as the Inclined Platform 59 of the preferred embodiment, shown in FIG. 1A and FIG. 1A-2, except that the Modified Platform Cue 468 holds a few more canisters than the Inclined Platform 59.

The Network of Mounting Beams 465Ntwrk (for the Downward-sloping 3-sided Modified Circular Guide Rail System 464) includes all the Vertical Beams and Angled Beams used to support the entire Modified Circular Guide Rail System 464. There is a Set of Four Vertical Structural Beams 466 that support the Above-ground Coils, Above Ground Alignment Rings, and the Pivot Bucket 261 (in the Over-sized embodiment). These Four Vertical Structural Beams 466 are essentially the same Structural Beams as Vertical Structural Beam Systems 255L and 255R, combined, as shown in FIG. 1K and FIG. 1L, except the Vertical Structural Beams 466 are much higher. These Four “466 Beams” go from the Above Ground Floor 254, all the way up to the Two Top Angled Extensions, 255TAEF and 255TAER (that is, “extensions of” the Four Vertical Structural Beams 466). FIG. 1L shows the 255TAEF “extending onto the top” of the Two Front Beams shown and 255TAER “extending onto the top” of the Two Rear Beams shown, in the 255L and 255R, Four-Beam (combined) Structural System. In FIG. 36a, both Rear Beams in the Vertical Structural Beam System 466 are “broken off.” The Vertical Support Wall 467 (for the Angled Mounting Beams that support the Downward-sloping 3-sided Modified Circular Guide Rail System 464) is there to provide a solid structure onto which the Angled Support Beams in the Mounting Beam Network 465Ntwrk can be attached.

Turning now to FIG. 37b, shown are Four, equally shaped and equally sized Sections, LPQ1, LPQ2, LPQ3, and LPQ4, of One Total Launch Platform (for the Quad LM Underwater Launch sub-embodiment of the Over-sized embodiment). FIG. 37b shows these Sections pulled apart from each other somewhat for the sake of the illustration, but in a pre-launch scenario the Four Section should be far enough apart from each other so a canister has enough room to “come up in the middle,” between these Four Sections. Once the canister has moved above the Four Separated Sections, then the Four Sections are moved in towards each other by individual Positioning Solenoids (not shown in FIG. 37b). The result of this “moving in” process is shown in FIG. 37a, which shows how the Four Section “join together” to form a shape that is precisely the shape of a Nose Cone Protrusion 70 (FIG. 2a). Once these Four Sections have “been united” and have formed this “protrusion shape,” then an Underwater Launch can be performed. Each individual section is connected (by additional interfaces, not shown in FIG. 37a) to a separate Linear Motor. Therefore in this Quad LM Underwater Launch sub-embodiment, four times as much “launching force” can be applied in an Underwater Launch Process in order to overcome any additional Fluid Pressure in the “tight” area of the Fluid Column in the Over-sized embodiment (explained near the end of 13 Topics; #5, “Over-sized embodiment”).

Turning now to FIG. 38, another slightly different component in the Over-sized embodiment is the Modified Vertical Structural Support Wall 2490z. This component is similar to the Support Wall 249 in the preferred embodiment (shown in FIG. 1I), except Support Wall 2490z is wider than Support Wall 249 and also Support Wall 2490z includes an Angled Support Beam, as shown in FIG. 38.

Turning now to FIG. 40, there is a Dual Arc C Roller Section sub-embodiment (for the preferred embodiment) and in this sub-embodiment there is an entire Pullout Roller Section 350, whereby a combined unit of Five (or more) of the Rollers 122 in the Left Arc C Roller Section 201 are connected together in a way that allows all of these Five Rollers 122 to move directly towards the rear (away from the viewer in FIG. 40) at the same time. [Note: as stated above in Additional Drawing Exceptions and Comments #21, a greater number of Rollers 122 and Rollers 122R are used in the actual construction of a MF device than what is shown in the drawings; each individual Roller (except for any end-Rollers) is almost touching the Rollers that are on each side of that individual Roller. Therefore, Pullout Roller Section 350 includes more Roller Assemblies for the same amount of “Pathway Distance;” in actual construction the overall width of Pullout Roller Section 350 will remain the same, but more Roller Assemblies will be placed in that overall width.]

The purpose of retracting this group of Five (attached) Rollers and pulling these Rollers out of the “canister pathway” is to allow canisters to alternate going up the Left Arc C Roller Section 201 and the Right Arc C Roller Section 202 (see FIG. 41E). This alternating system is essential so that one canister can be “fed” onto the Pre-launch Launch Platform (see FIGS. 41B, 41C, 41D, 41F, and 41G) about every five seconds, to stay within the requirements of the Five Second Cycle Rule. When the Pullout Roller Section 350 is retracted, the next canister to enter the Arc C Area can “pass right through” the “original” Left Arc C Roller Section Area and head more to the right, thereby entering the second, duplicate Arc C Roller Section, known as “Right Arc C Roller Section” 202.

The Pullout Roller Section 350 is pulled straight back out of the way by Retracting Solenoid 351, which consists of a Solenoid Body 351B and a Plunger 351P. The front of Plunger 351P is permanently attached in the center of the rear surface of Back Wall 352Bk (of the overall Puller Frame). This Retracting Solenoid 351 is attached to the Subterranean Floor 317 by a Retracting Solenoid Harness Mount 351HM. The Pullout Roller Section 350 has an outer “Puller Frame,” which consists of three components, the Back Wall 352Bk, Left Wall 352L, and Right Wall 352R. The Puller Frame can also be made to include a top and bottom Wall or Partition, as well. The Puller Frame, as a complete unit, is not referenced.

Each of the Five Rollers 122 has their own individual Housing-frames but these Five Housing-frames are not individually referenced. Even though FIG. 40 does not show the first (lowest and to the left) Roller Housing-frame as having a Connecting Rod, this is more a result of the angle of the drawing and this First Roller Housing-frame will also have a Connecting Rod. In fact, as mentioned above in Additional Drawing Exceptions and Comments #24, all Five Roller Housings will be the same distance from Back Wall 352Bk (of the Puller Frame) and the length of all Connecting Rods going between Back Wall 352Bk and the back of each of the individual Push Blocks 354 (a sample Push Block is best seen in FIG. 40-2b) will be the same. So there are Individual Connecting Rods that connect the rear of each Roller Housing-frame (the “rear piece” of each individual Housing-frame is the respective “Push Block” 354) to the Back Wall 352Bk (of the Puller Frame). In FIG. 40 these Connecting Rods are: 353a, 353b, 353c, and 353d, starting with the second lowest (and second to the left) Roller Housing-frame and going up to the highest (and rightmost) Roller Housing-frame, respectively. Also, as mentioned above in Additional Drawing Exceptions and Comments #24, the first Roller Assembly (lowest and to the left in FIG. 40) should also have a Connecting Rod.

Turning now to FIG. 40-2b, this drawing shows an “exploded” view of the components inside the second lowest (and second-to-the-left) Roller Housing-frame. The front of Connecting Rod 353a is permanently attached to the rear of Push Block 354. There is a Roller Rod Cap 355, and this Roller Rod Cap is permanently attached to the Roller Assembly Shaft 363. This Roller Assembly Shaft 363 is one long continuous rod; for the sake of clarity regarding other components in FIG. 40-2b, this Shaft 363 is sometimes shown as a hidden line, even though this Shaft 363 is in front of other components. FIG. 40-2a is a non-exploded version of FIG. 40-2b, and FIG. 40-2a best shows that the front of Push Block 354 is making very firm contact with the rear of Roller Rod Cap 355. Thus the name “Push Block,” because when the entire Pullout Roller Section 350 is moved forward, not only are each of the individual Roller Housing-frames moved forward but each individual Roller Rod Cap 355 is pushed directly forward by the force being applied directly from the rear of Roller Rod Cap 355 by the respective Push Block 354, inside the individual Roller Housing-frames.

[Note: as shown in FIGS. 40, 41A, and 41E, each of the Three “Inner” Housing-frames (#2, #3, and #4) is attached to the Housing-frames on each side, and the two outer housing-frames (#1 and #5) are attached to the Left and Right Puller Frame Walls, 352L and 352R, respectively. Therefore, any forward or backward movement by the larger Puller Frame will also move all of the individual Roller Housing-frames and respective Roller Assemblies as if all of these components are all part of one “solid block.” ]

In FIG. 40-2b, there is a Left and Right Puller Block, 356L and 356R, respectively. These components work in exactly the opposite manner compared to a Push Block 354. The pair of Two “Phantom Puller Blocks” 356Ph shows that the actual Puller Blocks, 356L and 356R are positioned so that firm contact is always being made between the rear surfaces of the Two Puller Blocks and the front surface-edge of Roller End Cap 355. (This “contacting relationship” can also be clearly seen in FIG. 40-2a.) Therefore when the Puller Frame is being retracted, because each of the Two Puller Blocks is respectively attached to the Left and Right Walls of the Housing-frame (for any particular Roller Assembly), and because all of the Roller Housing-frames are connected together and move in absolute unison, back and forth with the motion of the Puller Frame, each Puller Block (for example, for the Two Puller Blocks, 356L and 356R for the Roller Assembly shown in FIG. 40-2b) will be putting direct pressure on the front of Roller End Cap 355 to move the permanently-connected Roller Assembly Shaft 363 backwards, as the entire Pullout Roller Section 350 (and the attached Puller Frame) is being pulled to the rear by Retracting Solenoid 351.

There is a Guide Block 357 and the two primary purposes of this Guide Block are to: a) provide additional structural strength and support to the overall Housing-frame and b) to hold Guide Sleeve 358, which is a sleeve-type bearing that helps directly support the relatively long Roller Assembly Shaft 363. There is a Rear Beveled Block 359 and a Front Beveled Block 362. The matching “carved-out” beveled impressions (for each of the five individual Roller Assemblies) in the Roller Conveyor Frame 121L are not shown, but when the entire Pullout Roller Section 350 is pushed forward to re-engage the Pullout Roller Section into the overall Roller Conveyor Frame 121L, the Front and Rear Beveled Blocks (for each individual Roller Assembly) seat into the matching beveled impressions in the Front and Rear Sections of the Roller Conveyor Frame. This “seating procedure” ensures that the entire Pullout Roller Section 350 will always be returning to the exact same position every time the Pullout Roller Section 350 is re-inserted into the Roller Conveyor Frame 121L.

[This Reference “121L” (shown in FIG. 41E) is referencing “original” Roller Conveyor Frame 121 from the preferred embodiment, with the exception that 121L is different from 121 in the Arc C Area. Specifically, 121L has these Beveled modifications and is missing Rollers where Pullout Roller Section 350 is inserted instead.

Roller Conveyor Construction Note:

from a manufacturing and initial assembly standpoint, the “hole” in the Rear Section of the Roller Conveyor Frame obviously has to be smaller than the perimeter dimensions of Rear Beveled Block 359 (or this Rear Beveled Block would never have any beveled surface to seat into). Therefore, when the Roller Conveyor 121L is actually being assembled on the site of the MF device, for each of the five individual Roller Assemblies, only the Roller Assembly Shaft 363 will be inserted through the particular “hole” drilled in the Rear Section of the Roller Conveyor 121L.

Thus, since only Roller Assembly Shaft 363 will be sticking out “into the front area” (where the actual Rollers are supposed to be—where the pathway for the canisters is), the actual Roller Bodies must be inserted onto Shaft 363 (first Rear Roller Retainer Cap 360R, then Roller Body 361, and then Front Roller Retainer Cap 360F) and then Front Beveled Block 362 is screwed onto the Front Threaded End of the Roller Assembly Shaft 363Thrd Before the front section of the Roller Conveyor Frame 121L is attached to the rest of the Roller Conveyor. In fact, the size of the “hole” in the rear of the Roller Conveyor (for each Roller Assembly) must be large enough so that the Two Roller Retainer Caps 360R and 360F can fit through the “hole” when being pulled backwards or pushed forward, because the entire Pullout Roller Section 350 has to move approximately 10 inches in each direction, backwards and forwards, and this means that Both Retainer Caps must pass through the area where the “hole” is.

That “10 inches of retraction” will be necessary so that the front part of all the Roller Assemblies (where the Roller Bodies 361 and Front Beveled Blocks 362 are) will be “out of the way” when Pullout Roller Section 350 is fully retracted. Under these conditions there will be a clear pathway for the arriving canister to “pass through” the large gap created in the Left Arc C Roller Section so the canister can proceed over to Right Arc C Roller Section 202. This means that when the Pullout Roller Section 350 is fully retracted, the Front Beveled Block 362 (for each of the Five Roller Assemblies) will be pulled back to a point where the rear surface of each Front Beveled Block will be just about touching (will be a few millimeters in front of) the front edge of the “hole” in the Rear Section of Roller Conveyor Frame 121L. Having all Five of the Front Beveled Blocks in that position will create the necessary clearance to allow a canister to pass in front of the front surfaces (the beveled faces) of the Front Beveled Blocks; essentially the Five Front Beveled Blocks will be “tucked underneath” (or pulled back into) the Rear Section of the overall Roller Conveyor Frame 121L.]

There is a Front and Rear Roller Retainer Cap, 360F and 360R, respectively, and these fitted Caps keep the Roller Body 361 from moving towards the front or the rear on the Roller Assembly Shaft 363. There is a Roller Body 361, which sits in between the two Roller Retainer Caps, 360F and 360R. This Roller Body 361 has its own internal bearing system so it can revolve on the Roller Assembly Shaft 363 as necessary, when a canister is moving along on top of this Roller Body 361. The Roller Assembly Shaft 363 is one continuous piece that goes from the Roller Rod Cap 355 in the rear, to the very front of the overall Roller Assembly. The front tip of the Roller Assembly Shaft is Threaded 363Thrd so that the Front Beveled Block 362 can be screwed onto the Roller Assembly Shaft 363 during installation of the Pullout Roller Section 350 and simultaneous installation of the overall Roller Conveyor 121L, as described above in the two preceding paragraphs.

There is a Left and Right Housing Partition, 364L and 364R, respectively, for each individual Roller Assembly and together these Two Housing Partitions provide unifying support and strength to each of the individual Roller Assemblies. Then even more “unifying support” is provided to the entire Pullout Roller Section 350 because, as described above, for each individual Roller Assembly, the Left and Right Housing Partitions are connected to the Housing Partitions of adjacent Roller Assemblies and all of the Five Roller Assemblies move in unison with the motion of the larger Puller Frame. The references 352L and 352R apply to Left and Right Housing Partitions for all of the individual Roller Assemblies, not just for the individual Roller Assembly shown in FIG. 40-2b.

The entire Pullout Roller Section 350 is supported by, and slides on top of, a very sturdy Slide Support 365, which is partially shown in FIG. 40-2b. This Slide Support 365 is not shown in any other drawings; it was not practical to show it in the Drawings. However, in another sub-embodiment (and as mentioned above), there can be a “Bottom Partition” for the overall Pullout Roller Section 350 and in that case, any such Bottom Partition will be the component that slides along, and makes continuous contact with, Slide Support 365. The vertical “legs” of this Slide Support 365 reach down all the way to the Subterranean Floor 317. A tiny portion of the left “leg” of Slide Support 365 is shown in FIG. 40-2b, but is “broken off” due to lack of space on the drawing page.

Turning now to FIG. 41A, there are references for the overall Left Arc C Roller Section 201 and the overall Right Arc C Roller Section 202.

Turning now to FIG. 41E, all of the references for components on the Left Arc C Roller Section 201 are the same references for the same exact components as shown in FIG. 1G for the preferred embodiment, except for the modified Roller Conveyor Frame 121L that is used in this Dual Arc C Roller Section sub-embodiment. In FIG. 41E, the Pullout Roller Section 350 is retracted and there is an unreferenced canister passing through the “vacant” area in the Left Arc C Roller Section 201; this canister is heading over to the right into the Right Arc C Roller Section 202.

Regarding Support Structures, supporting the Left Arc C Roller Section 201 there is the Left Vertical Structural Support System 199, which includes Two Vertical Beams. [Note: this “199 Beam System” is entirely different from the 299R Beam System of the preferred embodiment, because none of the equipment shown in FIG. 1H (of the preferred embodiment) exists in the Dual Arc C Roller Sections sub-embodiment and therefore the “199 Beam System” serves a different function from the “299R Beam System.” ] There is a Pair of Slanted Structural Support Reinforcing Beams 199SL, to support the “199 Structural System”.

There is a Pair (front and rear) of Right Arc C Roller Section Stand-alone Vertical Support Beams 191R (referenced together). There is a Right Vertical Structural Support System 200 and a Pair of Slanted Structural Support Reinforcing Beams 200SL (to support the “200 Structural System”). There is a reference for the separate Right-side Roller Conveyor 121R that exists only in the Right Arc C Roller Section 202. Any and all individual Rollers 122R in the Right Arc C Roller Section 202 are referenced either individually or collectively by that reference 122R.

There are Three Canister Elevation Electromagnets in the Right Arc C Roller Section 202, which are: the furthest left EM 192d, the middle EM 192e, and the furthest right EM 192f. FIG. 6 of the preferred embodiment shows a detailed example of how each of these Canister Elevation Electromagnets (192d, 192e, and 192f) is positioned and constructed. These Three Canister Elevation EMs have 192-related references because essentially they are just extensions of, or are connected to, the “192 Sensor System” (seen in FIG. 1G) that controls the overall “Canister Elevation Process.” In other words, these Three EMs are triggered by Motion Sensor System 192. There is really not much difference between the Canister Elevation EM 192a and Canister Elevation EM 192d, only just about three feet of horizontal distance. Therefore, when Speed and Motion Sensor 192 detects the Leading Edge of a canister that is going to be ascending through the Right Arc C Roller Section 202, Motion Sensor System 192 will analyzes the canister velocity data and take into account that minor differential of the extra horizontal distance the canister will need to travel to move into the Right Arc C Roller Section 202, instead of the canister ascending up through the Left Arc C Roller Section 201. The Sensor System 192 causes the Three right Canister Elevation Electromagnets: 192d, 192e, and 192f (in the Right Arc C Roller Section 202) to sequentially create Counter-magnetic Fields based on the analysis of the Motion Data. After receiving the signal from the Sensor System 192, the furthest left Canister Elevation Electromagnet 192d (in the Right Arc C Roller Section 202) creates a “gentle” Counter-magnetic Field that is pulsed outward from this Canister Elevation EM 192d.

The net result is that a canister traveling horizontally will be gently “lifted off of” the Right Arc C Roller Section (or pushed up and away from the Roller System) for a brief instant by the force of the Counter-magnetic Field from Elevation EM 192d. The Middle Right Arc C Canister Elevation Electromagnet 192e works in exactly the same way as Canister Elevation EM 192d; there is a Pre-determined Delay so that this EM 192e sends out its “EM Pulse” a split second after Elevation EM 192d sends out its pulse. The furthest right Canister Elevation Electromagnet 192f works in exactly the same way as Canister Elevation EMs 192d and 192e; there is a Pre-determined Delay so that Canister Elevation EM 192f sends out its “EM Pulse” a split second after Canister Elevation EM 192e sends out its pulse.

There is a Front and Rear Guide Rail (for Right Arc C Roller Section), 189RF and 189RR, respectively. The references for both of these Guide Rail Systems include the related Paired Mounts used to support the respective Guide Rail.

Speed and Motion Sensor 198S detects when the Leading Edge of a canister is moving in front of it and immediately analyzes the related velocity data to determine how fast the canister is moving. Then, this Sensor System 198S causes the Three Vertical Angle Adjustment Electromagnets (VAA EMs): 198a, 198b, and 198c, to sequentially create Counter-magnetic Fields based on the analysis of the Motion Data. After receiving the signal from the Sensor System 198S, the Lowest Vertical Angle Adjustment EM 198a creates a “gentle” Counter-magnetic Field that is pulsed outward from this VAA EM 198a. The Middle VAA EM 198b works in exactly the same way as VAA EM 198a; there is a Pre-determined Delay so that this VAA EM 198b sends out its “EM Pulse” a split second after VAA EM 198a sends out its pulse. The Topmost VAA EM 198c works in exactly the same way as VAA EMs 198a and 198b; there is a Pre-determined Delay so that VAA EM 198c sends out its “EM Pulse” a split second after VAA EM 198b sends out its pulse. FIG. 39 shows various positions and angles a canister has as that canister moves up through Right Arc C Roller Section 202 and as these Three VAA EMs create EM Fields that “gently” adjust the angle of ascent for the Leading Surface of a respective canister.

[Note: there is an explanation below (in 13 Topics; #6, “Dual Arc C Roller Sections sub-embodiment”) with regards to how Speed and Motion Sensors 197S and 198S not only detect the leading surface of a respective canister, but also detect the bottom surface of a respective canister, and this process of detecting the bottom surface of a canister is what triggers the operation of the Retracting Solenoid 351, so that Pullout Roller Section 350 can be moved back and forth, on a cycle-by-cycle basis, and can therefore regulate which particular Arc C Roller Section the next canister entering the overall area will ascend into.]

Positioned above VAA EM 198c there is a Horizontal Alignment Ring 193R which ensures a canister is ascending with perfect vertical alignment and that the canister is perfectly centered underneath the Right Arc C Roller Section Speed-adjusting Electromagnet (EM#5) 195R. The reference for Alignment Ring 193R also includes the Mounting System for the Alignment Ring. This Mounting System is the same as Mounting System 193M, except that this Right-side Mounting System is “flipped horizontally” and attaches to the opposite side of the “199 Vertical Beams” as compared to where Mounting System 193M attaches to the “199 Vertical Beams.”

The Lower Speed and Motion Sensor 194R (for Right Arc C Roller Section; Speed-adjusting Electromagnet EM#5 195R) detects when the Leading Edge of a canister is moving in front of it and immediately analyzes that data to determine how fast the canister is moving. Then, this Sensor System 194R immediately sends a signal to the Right Arc C Roller Section; Speed-adjusting Electromagnet (EM#5) 195R. The reference for Lower Speed and Motion Sensor 194R also includes the Mounting Block that sits directly underneath this Sensor 194R; the Mounting Block attaches to a Cross Beam of the Vertical Beam System 200.

As described above, there is a Right Arc C Roller Section Speed-adjusting Electromagnet (EM#5) 195R. When this EM#5 195R receives the Activation Signal from Motion Sensor 194R, this EM#5 195R creates a Magnetic Field that will either oppose or attract the magnet inside the canister that is traveling upward and entering this EM#5 195R from the bottom. The precision of the Speed-adjustment Action of EM#5 195R in this Dual Arc C Roller Section sub-embodiment is not as critical as the precisions required (see 13 Topics; #1, “Coupling Process”) for the Coupling Process in the preferred embodiment because a canister passing through EM#5 195R will end-up being caught by the Right-side Catcher Net 397Nt in the Net-catch Canister Transport Area 366. However, there is still a significant need for a speed adjustment to be performed on every canister passing through EM#5 195R. In any event, a canister will keep climbing upward, will move through this EM#5 195R, and will then begin to exit out the top of EM#5 195R. The reference for EM#5 195R also includes the Mounting System for EM#5 195R. This Mounting System is the same as Mounting System 195M, except that this Right-side Mounting System is “flipped horizontally” and attaches to the opposite side of the “199 Vertical Beams” as compared to where Mounting System 195M attaches to the “199 Vertical Beams.”

As the Leading Edge of a canister passes in front of the Upper Speed and Motion Sensor 196R (for Right Arc C Roller Section; Speed-adjusting Electromagnet EM#5 195R), this Sensor 196R detects that the Leading Edge of a canister is moving in front of it and then immediately analyzes that data to determine how fast the canister is moving. This Sensor System 196R will determine if EM#5 195R should either: a) keep the present Electromagnetic Field in place (a Magnetic Field that has already been affecting the magnet inside the canister that is passing through EM#5 195R) or b) weaken, strengthen or reverse the Magnetic Field, or c) totally shut off the Magnetic Field.

At a pre-determined time after EM#5 195R was activated to create the Magnetic Field(s) being discussed for EM#5 195R, the Magnetic Field will be terminated because the canister's magnet will be out of range of the Magnetic Field of EM#5 195R.

The reference for Upper Speed and Motion Sensor 196R also includes the Mounting Block that sits directly underneath this Sensor 196R; this Mounting Block attaches on the bottom to a Cross Beam of the Vertical Beam System 200.

Turning now to FIG. 41B, the general name and reference for the entire area shown is the Net-catch Canister Transport Area 366 (referenced in the left and right sides of the drawing). The primary horizontal support structure is the Floor Partition 368, which is supported by a Beam Support System 367Set. There is a Left-side Vertical Support Beam 369L and a Right-side Vertical Support Beam 369R, and together these Two Beams support the components in the upper portion of the Net-catch Canister Transport Area 366. There is a Slanted Reinforcing Beam for the Left-side and Right-side Vertical Support Beams, 369LSL and 369RSL, respectively.

(Note: as mentioned in the Additional Drawing Exceptions and Comments #26, FIG. 41B shows the status of the overall Net-catch Canister Transport System at a point when the “active canister” is at the top of the Left-side Catcher Net 396Nt. There is no drawing showing that canister coming up through Alignment Ring 371 and moving up through the left side of the Net-catch Canister Transport Area 366. During such a period of time, the Left Transport Carriage 375 is positioned over to the far left, next to the Left-side Vertical Support Beam 369L, as shown in FIG. 41G.)

There is a general reference for the Left Transport Carriage and the Right Transport Carriage, 375 and 385, respectively. The Left Transport Carriage 375 is rotated by a Left Rotational-positioning Solenoid 373. The Left Transport Carriage is connected to Rotational Solenoid 373 by a Connecting Arm 374, which specifically goes from the top of the rotating shaft of Rotational Solenoid 373 to the Circular Base 376 (of Left Transport Carriage 375). The Connecting Arm 374 is supported by an Underside Support Rail 370. Both the Rotational Solenoid 373 and the Underside Support Rail 370 are attached to the Floor Partition 368.

The lower portion of the Left Transport Carriage 375 is comprised of: a Circular Base 376 and a Spring Matrix 377Spg. The Spring Matrix 377Spg sits on top of Circular Base 376. The upper portion of Left Transport Carriage 375 is comprised of: Carriage Platform 375P, Carriage Wall System 375CrgW, and a set of Ball Bearings 375BB, which are permanently mounted on the top surface of the Carriage Platform 375P. The top of all of the Springs in the Spring Matrix 377Spg make contact with the bottom surface of the Carriage Platform 375P. The shape of the inner area inside the Carriage Wall System 375CrgW is such that the left wall-portion has a “diameter of curvature” just slightly larger than the diameter of a canister and the inner distance between the Front and Rear Walls (not referenced separately) of the Carriage Wall System is slightly more than the diameter of a canister. A canister positioned properly on the Left Transport Carriage 375 will fit “snugly” within the Carriage Wall System 375CrgW and also the canister will move easily to the right over the Ball Bearing “floor” of the Left Transport Carriage 375.

Regarding the Right Transport Carriage 385, the related components are: Right Rotational-positioning Solenoid 383; Connecting Arm 384; Underside Support Rail 380; Circular Base 386; Spring Matrix 387Spg; Carriage Platform 385P, a Carriage Wall System 385CrgW, and a set of Ball Bearings 385BB. The description of the inter-relationship of the components for Right Transport Carriage 385 is exactly as described above for Left Transport Carriage 375, except where it was described that “the left wall-portion is curved at a diameter just slightly larger than the diameter of a canister,” for Right Transport Carriage 385, that description is “the right wall-portion is curved at a diameter just slightly larger than the diameter of a canister.”

Regarding overall (rotational) motion of the Two Transport Carriages, the furthest left horizontal point for Left Transport Carriage 375 is over close to Left-side Vertical Support Beam 369L (shown in FIG. 41G) and the furthest right position for Left Transport Carriage 375 is when the right edge of Left Transport Carriage 375 is making contact with the left edge of Platform Component 398P (of Pre-launch Launch Platform 398; this “contact” is shown in FIG. 41F). The furthest Right horizontal point for Right Transport Carriage 385 is over close to Right-side Vertical Support Beam 369R (shown in FIG. 41B) and the furthest right position (not shown) is when the left edge of Right Transport Carriage 385 is making contact with the right edge of the Platform Component 398P (of Pre-launch Launch Platform 398). Both Transport Carriages do Not move up and down vertically and only rotate in the horizontal plane.

Also in the lower left portion of the Net-catch Canister Transport Area 366, there is an Alignment Ring 371 and Alignment Ring Mounting System 371M; Mounting System 371M consists of Two Mounting Blocks that both attach on one end to Floor Partition 368 and on the other end to Alignment Ring 371. In another sub-embodiment there can also be more Alignment Ring Mounting Blocks on the underside of Floor Partition 368 to more securely attach Alignment Ring 371 to Floor Partition 368. For the sake of clarity in these drawings, any such “underside Mounting Blocks” are not shown.

In the lower right portion of the Net-catch Canister Transport Area 366, there is an Alignment Ring 381 and Alignment Ring Mounting System 381M (which includes two pieces) and these components are all exactly the same as the “371” and “371M” components just described in the preceding paragraph, except that the “381” and “381M” components are the horizontal mirror images of the “371” and “371M” components.

[Note: the curvatures of Connecting Arms 374 and 384 are such that when the related Transport Carriages are in their default positions (when Left Transport Carriage 375 is over by Left-side Vertical Support Beam 369L and when Right Transport Carriage 385 is over by Right-side Vertical Support Beam 369R), a canister will have room to ascend through the respective Alignment Ring without hitting the respective Connecting Arm.]

Also in the lower left portion of the Net-catch Canister Transport Area 366, there is a Speed and Motion Sensor 372S. When the Leading Surface of a canister passes in front of this Sensor 372S the Motion Data of the canister is immediately analyzed and according to the upward speed the canister is traveling, this Sensor System 372S will cause these Three EM Retainers (396a. 396b, and 396c; EM Retainer 396c is shown and referenced in FIG. 41C) to create EM Fields precisely when the magnet inside the canister is passing in front of these Three EM Retainers, while that canister is still ascending, or approximately at the point in time when the Leading Surface of the canister (not just the Nose Cone Protrusion 70) makes contact with the Catcher Net 396Nt.

There is a similar Sensor, Speed and Motion Sensor 382S in the lower right portion of the Net-catch Canister Transport Area 366 and this Sensor 382S works in the exact same manner as Sensor 372S, except that Sensor 382S activates the Three Right-side EM Retainers, 397a, 397b, and 397c, and this activation starts at a time when the magnet inside the related canister is passing in front of these Three EM Retainers, as was just described in the previous paragraph for the Three Left-side EM Retainers. Both of the references for Sensor 372S and Sensor 382S include one small Mounting Block that is underneath each of the respective Sensors. Both of these Mounting Blocks are attached on the bottom to the Floor Partition 368.

In the upper portion of Net-catch Canister Transport Area 366, and across the entire Net-catch Canister Transport Area, there is an Overall Housing Structure 388 that holds the three individual “Inner Housings” where the three Linear Motors, 391LM, 393LM, and 395LM are located. [FIG. 41B-2 shows how Linear Motor 391LM is: a) turned on its side, b) is facing towards the rear, and c) is “tucked away” in under the top edge of Left-side Inner Housing 389L.] This Overall Housing Structure 388 attaches on the left to the Left-side Vertical Support Beam 369L and attaches on the right to the Right-side Vertical Support Beam 369R.

There is a Left-side Inner Housing 389L, a Right-side Inner Housing 389R, and a Middle Inner Housing 389Mdl. The front horizontal surfaces of All Three of these Inner Housings are attached to the rear surface of Overall Housing Structure 388.

There is a Left-side Horizontal Linear Motor 391LM that is attached to Left-side Inner Housing 389L (see FIG. 41B-2). Attached to, and part of, this Linear Motor 391LM is Forcer 391Fc. Permanently inserted into Forcer 391Fc is Left Upper-Lower Claw Positioner 390. Linear Motor 391LM moves both Forcer 391Fc and the attached Left Upper-Lower Claw Positioner 390 back and forth, horizontally, and Linear Motor 391LM moves along the “inside” of Left-side Inner Housing 389L. Claw Positioner 390 pushes the canisters off of Left Transport Carriage 375 and onto Pre-launch Launch Platform 398. (This process is illustrated sequentially with FIGS. 41D and 41F.) This “Transport Process” does not require a lot of force but the process must be completed within a couple of seconds once the Left Transport Carriage 375 has made contact with Pre-launch Launch Platform 398 (this “contact position” is shown in FIG. 41D).

There is a Right-side Horizontal Linear Motor 393LM that is attached to Right-side Inner Housing 389R. Attached to this Linear Motor 393LM is Forcer 393Fc. Permanently inserted into Forcer 393Fc is Right Upper-Lower Claw Positioner 392. Linear Motor 393LM moves both Forcer 393Fc and the attached Right Upper-Lower Claw Positioner 392 back and forth, horizontally, and Linear Motor 393LM moves along the “inside” of Right-side Inner Housing 389R. Claw Positioner 392 pushes the canisters off of Right Transport Carriage 385 and onto Pre-launch Launch Platform 398.

There is a Middle Horizontal Linear Motor 395LM that is attached to Middle Inner Housing 389Mdl. Attached to this Linear Motor 395LM is Forcer 395Fc. Permanently inserted into Forcer 395Fc is Positioner Backstop 394. Linear Motor 395LM moves both Forcer 395Fc and the attached Positioner Backstop 394 back and forth, horizontally, and Linear Motor 395LM moves along the “inside” of Middle Inner Housing 389R. Positioner Backstop 394 provides “backpressure” on the opposite side of where a canister is being pushed from. Depending upon which side a canister is coming from, Linear Motor 395LM will be moving this Positioner Backstop 394 in synchronized motion with the respective Left or Right Linear Motor (391LM or 393LM).

After a canister has been properly positioned onto Pre-launch Launch Platform 398, then Linear Motor 395LM moves Positioner Backstop 394 out of the way of Pre-launch Launch Platform 398 by continuing to move Positioner Backstop 394 further along in the direction Positioner Backstop 394 was moving when the canister was being positioned onto Pre-launch Launch Platform 398. For example, if the canister was “being fed” onto Pre-launch Launch Platform 398 by Left Transport Carriage 375, then after the canister is in place on the Pre-launch Launch Platform, Positioner Backstop 394 will be moved further to the right to get out of the way, so the Pre-launch can occur. In addition, this particular (horizontal) spot is where the Positioner Backstop needs to be, anyway, because if a canister is “fed” from the left, then the next canister to be “fed” will be coming from the right. So Forcer 395Fc (and therefore permanently-connected Positioner Backstop 394) need to be in the far right portion of Linear Motor 395LM so Positioner Backstop 394 can provide “backpressure” on the “next” canister that will be moving from right to left.

In the upper left portion of the Net-catch Canister Transport Area 366 there is the Left-side Net-catch Area 396Ar. In this area the upper portion of Left-side Vertical Support Beam 369L splits-off into Three Separate Mounting Prongs (these Mounting Prongs are not separately referenced). Attached to each of these Mounting Prongs is an “Electromagnet Retainer.” The purpose of these Three EM Retainers in this Left-side Net-catch Area 396Ar is that as a canister passes the Speed and Motion Sensor 372S, this Sensor System will analyze the motion data of the canister and determine precisely when the magnet inside the canister will be passing the Three EM Retainers, as the canister is on its way to being “caught” in Left-side Catcher Net 396Nt. At that precise moment when the magnet inside the canister is directly positioned between these Three rather powerful EM Retainers (as the canister is moving upwards), Three Identical EM Fields will be created to slow down and/or temporarily semi-suspend the canister in mid-air. The canister will still ascend a few inches into the Catcher Net after the EM Fields are initiated, but the canister will definitely come to a complete stop once it is “caught” by the Net.

Then as the canister begins to fall back down out of Left-side Catcher Net 396Nt, these Three (continuous) EM Fields will continue to help suspend the canister and/or to slow down its rate of fall. The overall effect of these Three EM Fields is not expected to completely suspend a “50-pound” canister in mid-air for an extended period of time, but instead to: a) give Left Transport Carriage 375 enough time to rotate in under the canister's bottom surface and b) to definitely slow down the canister's rate of fall to help cushion the impact when the canister “lands” on Carriage Platform 375P (of Left Transport Carriage 375). In addition, Left Transport Carriage 375 is ruggedly constructed and also Spring Matrix 377Spg will absorb a large amount of the “impact” when the bottom surface of the canister lands on Carriage Platform 375P (of Left Transport Carriage 375). Furthermore, the Connecting Arm 374 is also firmly supported by Underside Rail Support 370.

The components in the Left-side Net-catch Area 396Ar are: Left-side Catcher Net 396Nt; Frame (for Left-side Catcher Net) 396NF; Front Electromagnet Retainer 396a; Far-left Electromagnet Retainer 396b; Rear Electromagnet Retainer 396c (396c is shown in FIG. 41C).

Each of the Three EM Retainers has an Iron Core and also has a Circular Belt-type Mounting Band that goes almost completely around that particular EM Retainer. The Frame for the Catcher Net has several sides (including a rear side) and this Frame is supported by and attached to the Three Prongs of Left-side Vertical Support Beam 369L.

The Catcher Net 396Nt is securely attached to the Frame 396NF (for Left-side Catcher Net) in multiple places, more or less as shown in FIG. 41B. The Net, itself, is made of a semi-stretchy material, but is also made in a way that inhibits the Catcher Net from stretching too far, because the most desirable (vertical) point for a canister's ascent to “peak” inside the Catcher Net is at a height where the magnet inside the canister is as close to the Three EM Retainers as possible.

The components in the Right-side Net-catch Area 397Ar are: Right-side Catcher Net 397Nt; Frame (for Right-side Catcher Net) 397NF; Front Electromagnet Retainer 397a; Far-right Electromagnet Retainer 397b; Rear Electromagnet Retainer 397c. All of these components in the Right-side Net-catch Area 397Ar work in the exact same manner as the “mirror image” components just described above for the Left-side Net-catch Area 396Ar. There will never be a canister in both Nets at the same time; the canisters are “fed into the Nets” at about five second intervals. A good “Rule of Thumb” for the Left and Right “Sides” of the overall Net-catch Canister Transport Area 366 is that as a canister from one side is being moved onto Pre-launch Launch Platform 398 from one side, the “next” canister will be ascending through the Alignment Ring on the other side (as shown in FIG. 41F).

In the upper middle of the overall Net-catch Canister Transport Area 366 is Pre-launch Launch Platform 398. This Launch Platform does not have any “lower portion” containing a Spring Matrix or Secondary Platform Base. The components of this Pre-launch Launch Platform are: Platform Component 398P; Ball Bearings 398BB; Front Guide Partition 398F; Rear Guide Partition 398R.

Ball Bearings 398BB are permanently mounted on the top surface of Platform Component 398P. The horizontal distance between Front Guide Partition 398F and Rear Guide Partition 398R is slightly more than the diameter of a canister. This distance is exactly equal to the distance between the front and rear sections of the Carriage Walls (375CrgW and 385CrgW) for the two Transport Carriages. Because during the Pre-launch Process the Nose Cone Protrusion 70 of a canister sitting on the Pre-launch Launch Platform will be fitting into the Matching Carved-out Impression 71 in the bottom surface of the canister (the Upper Canister) being suspended above by the Two Suspension Support Rods 227L and 227R (the same suspension system is used for this sub-embodiment as what is shown in FIG. 1H and FIG. 1H-4), there will be a certain amount of “self-alignment” for the canister sitting on Pre-launch Launch Platform 398 during the Pre-launch Process when the two canisters merge into essentially one “long” canister-unit. (Note: this “Merging Process” is not part of a “Coupling Process;” it is part of the Pre-launch Process. Also, in this sub-embodiment there is a two-part Pre-launch process.)

Pre-launch Launch Platform 398 starts elevating the respective canister, and once contact is made between the leading surface of this Lower ascending Canister and the bottom surface of the stationary suspended canister, there is a temporary stopping point. Then: a) the Two Suspension Support Rods 227L and 227R are retracted out from underneath the bottom surface of the suspended canister, and b) the Two Notch Grips 219F and 219R are retract out of the Notch of the Upper Canister (for this sub-embodiment the Two Notch Grips 219F and 219R are not used for suspension purposes but only to help stabilize the upper portion of the suspended canister, in the horizontal plane). After these two actions are completed, then both canisters will be suspended by the upward force the Pre-launch Launch Platform 398 is applying to the bottom surface of the Lower Canister. Also, this “self-alignment” process for the two canisters can occur at a slower speed because this type of Pre-launch Process is rather slow, relative to the other “launches” in a MF device.

Shown behind Rear Guide Partition 398R of Pre-launch Launch Platform 398 is a sizeable section of Pre-launch Launch Platform Interface 398x; this Interface 398x is “broken-off” in the drawing. This Interface 398x connects the rear of Pre-launch Launch Platform 398 with the Forcer of the Pre-launch Linear Motor. It should definitely be mentioned here (and is also mentioned elsewhere), that the same kind of Pre-launch Process will occur in this Dual Arc C Roller Sections sub-embodiment as was discussed for the preferred embodiment, except that there is no “Coupling Process,” where the Upper Canister is “pushed up into the Fluid” about four inches and then both canisters fall back down onto a Pair of Pre-launch Launch Platform Halves. In the preferred embodiment, these Two Processes occur in sequence, first the Coupling Process and then the Pre-launch Process. However, it is possible to have a Pre-launch Process and not have a Coupling Process beforehand, and this condition is illustrated through the use of the Dual Arc C Roller Sections sub-embodiment (of the preferred embodiment).

Furthermore, almost all of the equipment shown in FIG. 1H, except the Two Notch Grip Systems 219F and 219R (and all related peripheral equipment used to suspend the Two Notch Grips) is Not required or used in this Dual Arc C Roller Sections sub-embodiment. Also, the equipment shown in FIG. 1H-4, related to the operation of the Two Suspension Support Rods 227L and 227R is used in this sub-embodiment. However, in the preferred embodiment, Upper Sensor 217US (shown in FIG. 1H) sends almost simultaneous signals to: a) the Two Suspension Support Rods 227L and 227R, and then b) the Two Notch Grips 219F and 219R, and all of these signals cause these four solenoid-related components to go into a retraction mode and respectively (first) retract the Two Suspension Support Rods out from underneath the suspended canister and also (secondly) retract the Two Notch Grips out of the Notch of the Upper Canister, thereby “releasing” the canister and allowing the canister to become freely moveable in a vertical direction. In this Dual Arc C Roller Sections sub-embodiment, as just stated above, there is No Upper Sensor 217US. Therefore in this sub-embodiment, the retracting action of the Two Suspension Support Rods 227L and 227R and the Two Notch Grips 219F and 219R is initiated by signals sent to the Suspension Support Rods and to the Notch Grips by the Pre-launch Linear Motor, but only after contact is made between the ascending canister and the suspended canister. This Pre-launch Linear Motor “knows” exactly where the leading surface or bottom surface of an ascending canister is, vertically, just like Upper Sensor 217US would “know” the vertical position of a canister, when the leading surface of that canister passed in front of that Sensor.

Specifically, in this sub-embodiment it is the Pre-launch Linear Motor that moves the (Lower) canister up underneath the Upper Canister and Not the Upward Momentum of the Lower Canister, as in the preferred embodiment. So when the Pre-launch Linear Motor has reached a pre-determined vertical point in the overall ascent of this Pre-launch Linear Motor, which is a point where the Leading Surface of the canister being elevated (the canister sitting on the attached Pre-launch Launch Platform 398) will have made initial, gentle contact with the bottom surface of the canister being suspended by the Two Suspension Support Rods 227L and 227R (and also being held in place, horizontally, by the Two Notch Grips 219F and 219R), then at that point the signal from the Pre-launch Linear Motor is sent, causing the Two Suspension Support Rods 227L and 227R and the Two Notch Grips 219F and 219R to retract.

After this retraction process is complete, the Pre-launch Launch Platform 398 will then be supporting the weight of Two canisters (approximately 100 pounds of weight plus the combined downward force of the Fluid Pressure on the Upper Canister, whose Leading Surface is “inside the Fluid” in the Underwater Launch Area), but the Pre-launch Linear Motor will keep ascending anyway and will only stop ascending at the same point as described in the preferred embodiment, when: a) the Leading Surface of the “ascending/lower” canister (the canister sitting on Pre-launch Launch Platform 398) is sticking up about Four inches “into the Fluid” inside the Fluid Column, b) what was the Upper Canister is totally “inside the Fluid” and is creating vertical separation from the “Lower Canister” because this canister is ascending (floating up) on its own power of buoyancy towards the Two Floatation Point Retaining Pins, 245L and 245R (shown in FIG. 1I), and c) the “ascending/lower” canister described in “a” has stopped at exactly the proper vertical position so that: i) the Two Suspension Support Rods 227L and 227R can immediately extend out and slide in underneath the bottom surface of the canister that at that point is being held up by Pre-launch Launch Platform 398, and ii) the Two Notch Grips 219F and 219R can fully extend into the Notch of that “ex-ascending, stopped” canister.

As soon as these two types of operations have been performed, and all related components are extended into the proper positions, “confirmation signals” are sent by each of these four individual solenoid-type components to the Pre-launch Linear Motor, and after all four of these signals have been received, the Pre-launch Linear Motor moves the related Forcer all the way down to the default position, which is a position where the Forcer is at the lowest possible point in the vertical movement of the Pre-launch Linear Motor. This vertical position is the position shown in FIG. 41C, which shows a vertical position for Pre-launch Launch Platform 398, which is permanently connected to the Forcer of the Pre-launch Linear Motor by Interface 398x.

To continue from the first sentence four paragraphs above, in this Dual Arc C Roller Sections sub-embodiment there are Not Two Linear Motors, one on the left and one on the right. There is only ONE Pre-launch Linear Motor (not shown) and that Linear Motor is directly in the rear, with the front of the Linear Motor facing forward (towards the viewer in FIG. 41B). The Pre-launch Linear Motor does Not move horizontally and is therefore permanently attached, for example, to a set of Vertical Structural Beams that extend down to, and are attached to, some wider and deeper version of Floor Partition 368 (for Net-catch Canister Transport Area 366). There is not much additional explanation required about the Pre-launch Linear Motor and about the related Pre-launch Process for this sub-embodiment. The next step is for an Underwater Launch to occur, with the equipment shown in the Underwater Launch Area, as seen in FIG. 1I of the preferred embodiment.

Turning now to FIG. 42A, there is a Dual Floatation Holding Cues and Canister Sliding Transport sub-embodiment for the Over-sized embodiment. References are given for Four canisters in FIG. 42A so canister movement can be tracked over several sequentially-related drawings. These canisters are: C51; C52; C53; C54.

There are general references for: a) most of the entire area shown in FIG. 42A, which is primarily a fairly large enclosed area, with a curved front portion (this area can be seen in a left side view in FIG. 43A), that is filled with Fluid; this overall area is the Curved-front Fluid Reservoir 498 (referenced in the lower right corner); b) Left-side Floatation Holding Cue 499L (referenced in FIGS. 42B and 42C); Right-side Floatation Holding Cue 499R (referenced in FIGS. 42B and 42C). The references for the Two Floatation Holding Cues not only include the specific space where the canisters are floating in the Fluid and all of the components that comprise each of the Two Floatation Holding Cues, but the references also include the immediate areas around the canisters, where the related Solenoid components are positioned.

There is an overall reference for a Lower Semi-horizontal Puller Assembly 500. This Puller Assembly 500 is essentially the same system and works in the same manner as Puller Assemblies 413, 418, and 425 in the Over-sized embodiment mentioned above. Puller Assembly 500 consists of: Puller Head 500PH; Slide Rail 500SRL; Left Mount 500LMt; Right Mounting System 500RM; a continuous Belt-type Drive mechanism (powered by a small electric Motor, not shown) that causes Puller Head 500PH to move back and forth on Slide Rail 500SRL.

Puller Head 500PH includes an Electromagnet that creates an EM Field strong enough to engage with the Magnetic Field of the magnet inside a canister and therefore Puller Assembly 500 is able to move a canister as a result of magnetic attraction. Slide Rail 500SRL has a long, straight section but over on the far right curves up somewhat. Left Mount 500LMt supports the left side of Slide Rail 500SRL and this Left Mount 500LMt is attached to Subterranean Floor 411 (of the Over-sized embodiment). The Right Mounting System 500RM consists of two pieces. The larger piece is attached to Subterranean Floor 411 (of the Over-sized embodiment). The smaller Mounting “cube” sits on top of the larger piece and this smaller “cube” supports the right end of Slide Rail 500SRL. Puller Assembly 500 is positioned below (and over to the right of) Variable Pressure Chamber 414.

There is an overall reference for a Curved Puller Assembly 501. This Puller Assembly 501 consists of: Puller Head 501PH; Slide Rail 501SRL; Left Mount 501LMt; Right Mounting System 501RM; a continuous Belt-type Drive mechanism (powered by a small electric Motor, not shown) that causes Puller Head 501PH to move back and forth on Slide Rail 501SRL. This Puller Assembly 501 works in the same manner as Puller Assemblies 413, 418, and 425 in the Over-sized embodiment mentioned above. Puller Assembly 501 is located entirely above the Variable Pressure Chamber 414 and there is a short, straight horizontal portion of Slide Rail 501SRL but most of Slide Rail 501SRL, over which Puller Head 501PH travels, is curved (starting out horizontal and ending up vertical). Left Mount 501LMt is attached to Left Wall 508LWL (of the overall Curved-front Fluid Reservoir 498). Right Mounting System 501RM consists of Two Pieces; one piece is a small “Mounting Cube” and the other piece is a large rectangular cube that reaches from the near the top of Curved Slide Rail 501SRL all the way down to Subterranean Floor 411 (of the Over-sized embodiment). The smaller cube of this Right Mounting System 501RM attaches to Curved Slide Rail 501SRL (near the top of the Rail) and also attaches to the top of the large rectangular cube (of Right Mounting System 501RM).

Two items to note are: a) the canisters coming out of Variable Pressure Chamber 414 are taken to the Two Vertical Guide Rail Systems (502 and 503) in alternate fashion, a canister goes to one Vertical Guide Rail System and then the next canister goes to the other Vertical Guide Rail System, etc., and b) all canisters are initially pulled out of Variable Pressure Chamber 414 by Curved Puller Assembly 501. Then if that particular canister is “scheduled” to go to Vertical Guide Rail System 502, Curved Puller Assembly 501 continues pulling that canister along Slide Rail 501SRL (of Puller Assembly 501) up into Vertical Guide Rail System 502 (shown in FIG. 42B). If the canister is “scheduled” to go up Vertical Guide Rail System 503, then Curved Puller Assembly 501 only pulls the canister out of Variable Pressure Chamber 414 far enough so Puller Head 500PH (of Puller Assembly 500) can have access to the magnet of the canister. When the “hand-off” occurs, Puller Head 501PH terminates its EM Field and at that point Puller Assembly 500 initiates its EM Field and continues pulling the canister along Slide Rail 500SRL. At the same time as the canister is being pulled to the right by Puller Assembly 500, Puller Head 501PH (of Puller Assembly 501) resets to the default position, which is over to the far left of Slide Rail 501SRL (a position shown for Puller Head 501PH in FIG. 42A).

Variable Pressure Chamber 414 is the same component shown in FIG. 1D-oz (the main Figure for the Over-sized embodiment). In FIG. 42A, Left Wall 508LWL of the overall Curved-front Fluid Reservoir 498 is “broken off” at the topmost point shown, but this Wall 508LWL extends completely up to Left-side Floatation Holding Cue 499L (referenced in FIG. 42B) In fact, this Wall 508LWL forms a boundary between Air (on the left of the Wall) and Fluid (on the right of the Wall). All other components to the left of Wall 508LWL and to the left of Variable Pressure Chamber 414 can be seen in FIG. 1D-oz (the main Figure for the Over-sized embodiment). FIGS. 43A and 43B are the same side view of the overall Curved-front Fluid Reservoir 498 and the view would be looking from a point to the left of Wall 508LWL, but the view in FIG. 43A and FIG. 43B is made as if Wall 508LWL is not there. In FIGS. 43A and 43B, the Three Sectioned surfaces with cross-hatching for the other boundary-sides (of the overall Curved-front Fluid Reservoir 498): Back Wall 508BckWL, Subterranean Floor 411, and Curved Front Wall 508CWL are all surfaces that are attached to Left Wall 508LWL.

In FIG. 42A, the right-side Waterproof Sliding Panel (not shown or referenced) of Variable Pressure Chamber 414 has retracted to allow Canister C51 to begin exiting the Variable Pressure Chamber to the right. This condition is understood to have happened because the tip of Nose Cone Protrusion 70 of Canister C51 is sticking out to the right, past the right edge of Variable Pressure Chamber 414.

There is a Vertical Guide Rail System 502. This overall Vertical Guide Rail System 502 has a total of Four individual circular Rails (only a very tiny portion of the fourth, rear Rail is shown at the very top of this Vertical Guide Rail System 502) that collectively form a “bounding shape” and this “bounding shape” is configured so that a canister can travel freely up the Vertical Guide Rail System 502 but cannot “escape” through the gaps between the individual Guide Rails. The Two Vertical Guide Rail Systems, 502 and 503, are similar to the Downward Sloping 3-Sided Guide Rail 402 (described above for the Over-sized embodiment) that has an “open air” configuration. However, the “402 Guide Rail System” uses Three Individual Rails and forms an “inner triangle” (between any three points of the inner surfaces of the individual Guide Rails).

The Four Individual Rails for each of the Vertical Guide Rail Systems 502 and 503 form an “inner square” that is wide enough so a canister can comfortably fit into this “inner square” and can move upward through the Fluid (powered by the canister's own buoyancy). The Rails of the 502 and 503 Vertical Guide Rail Systems head upwards in “gentle” curves and no portion of either of the overall “curved pathways” is so “tight” that a canister cannot easily move through such a section. However, in the event any curves were too tight for a canister, heading upward, to freely move through, then the overall pathways (for each Vertical Guide Rail System, 502 and 503) could be made to “loop” semi-horizontally at least one time, like what is seen in FIG. 1D-oz for the Circular Upward-Sloping Canister Pathway 420. In the event these “modified Vertical Guide Rail Systems,” 502 and 503, did have a semi-horizontal loop, there would be only one canister on the “loop” at a time and the canister would be “moving rather quickly” up the loop and in a matter of seconds would go from the bottom of the “loop” up to the upper portion of the Vertical Guide Rail System, where the Four Guide Rails would be pointing straight up, vertically, like what is seen near the top of the Vertical Guide Rail System 502 above that last “bend” of the Rails.

Making such a “large, semi-horizontal, gradually upward-sloping loop” would decrease the speed by which a canister could go from the bottom of a loop to either of the Floatation Holding Cues (499L or 499R), but since the canisters are being held in the Floatation Holding Cues anyway for an extended period of time (about 90 seconds from the time a canisters enters a Floatation Holding Cue until the canister is moved onto the Pre-launch Launch Platform), having the canisters take a little longer to reach the Floatation Holding Cues while they pass through some type of modified Vertical Guide Rail System (a modified 502 and modified 503) is acceptable.

The Vertical Guide Rail System 502 consists of: Vertical Guide Rail Set 502RLSet; Mounting Set 502MSet; Harness Connecting Strap(s) 502HS. The Rail configuration of Vertical Guide Rail Set 502RLSet is described two paragraphs above, in the discussion about the “Four individual circular Rails.” The Mounting Set 502MSet consists of several long leg-like components and each separate component attaches at the top to a particular individual Guide Rail and is attached at the bottom to Subterranean Floor 411 (of the Over-sized embodiment). FIG. 42A shows Four components in each Mounting Set (502MSet and 503MSet), but there could be more than Four components in each of these Mounting Sets. The Harness Connecting Strap 502HS is a band that wraps around, and is attached to, each of the Four individual Guide Rails. FIG. 42A shows only one such Harness Connecting Strap 502HS (and only one Harness Connecting Strap 503HS) but there are several more Harness Connecting Straps for each of the individual Vertical Guide Rail Systems, 502 and 503.

FIG. 42A shows that the bottom shape of the overall Vertical Guide Rail System 502 “flares out” along the area where the canisters are initially brought into this Vertical Guide Rail System 502. This “flared-out” configuration is simply to make it easier for a canister to get started upwards through Vertical Guide Rail System 502. In general, the way in which the Puller Head 501PH controls the position of a canister as the canister is being moved into Vertical Guide Rail System 502 will be fairly consistent, and having this “flared opening” for Vertical Guide Rail System 502 is simply a matter of style. Even before a canister reaches the top of Vertical Guide Rail System 502, the canister will already have “straightened out” and will be ascending with “true vertical alignment” by the time the Leading Surface of the canister reaches the absolute top of the Four Guide Rails. The horizontal positioning of a canister coming out of Vertical Guide Rail System 502 is such that the canister will float straight up into a fairly well-defined “Cue position” (such as where Canister C53 is in FIG. 42A), within the Left-side Floatation Holding Cue 499L.

(Note: explained below in “13 Topics; #7, Dual Floatation Holding Cues sub-embodiment,” any canister floating in a Floatation Holding Cue has about 30% of its overall length, not counting the Nose Cone Protrusion 70, sticking above and outside of the Fluid.)

There is a Vertical Guide Rail System 503 (on the right side of the overall Curved-front Fluid Reservoir 498). This Vertical Guide Rail System 503 consists of exactly the same components as the Vertical Guide Rail System 502 described above, except that the precise curvature of Vertical Guide Rail System 503 differs slightly from the curvature of Vertical Guide Rail System 502 because of the different angle of entry canisters have for the Two Vertical Guide Rail Systems. Specifically, Vertical Guide Rail System 503 includes: Vertical Guide Rail Set 503RLSet; Mounting Set 503MSet; Harness Connecting Strap(s) 503HS. The Canister Entry Area for Vertical Guide Rail System 503 is also “flared-out.” FIG. 42A shows a Canister C52 entering Vertical Guide Rail System 503. When C52 ascends to the top of Vertical Guide Rail System 503, C52 will be directly below the “Cue Position” within the Right-side Floatation Holding Cue 499R where C54 is shown in FIG. 42A.

In the Left-side Floatation Holding Cue 499L there is a Left-side Positioning Solenoid (not generally referenced as a unit) that is comprised of: Solenoid Body 504LB; Solenoid Plunger 504LP; Solenoid Harness Mount 504LHM. In addition, attached to the end of Plunger 504LP is a Dual Pronged Claw 504LClw. The Solenoid Harness Mount 504LHM attaches to the top of Solenoid Body 504LB and the “front strip” of Harness Mount 504LHM is attached to the top surface of Front Containment Block 506L and the “rear strip” of Harness Mount 504LHM is attached to the top surface of Rear Containment Block 507L. The purpose of this Positioning Solenoid and Dual Pronged Claw 504LClw is that about once every ten seconds this “positioning system” pushes all the canisters that are floating in Left-side Floatation Holding Cue 499L over to the right a distance of about one canister diameter.

In the Right-side Floatation Holding Cue 499R there is a Positioning Solenoid (not generally referenced as a unit) that is exactly like the Positioning Solenoid just described in the previous paragraph, except that it is the mirror image of the Positioning Solenoid just described. This Right-side Positioning Solenoid consists of: Solenoid Body 504RB (partially shown); Solenoid Plunger 504RP; Solenoid Harness Mount (not referenced or shown). In addition, attached to the end of Plunger 504RP is a Dual Pronged Claw 504RClw. The Solenoid Harness Mount for this Right-side Positioning Solenoid attaches in the same manner as the Left-side Positioning Solenoid Harness Mount, except that this Harness Mount attaches to the top surfaces of the Front and Rear Containment Blocks, 506R and 507R, respectively (in the Right-side Floatation Holding Cue 499R). The purpose of this Right-side Positioning Solenoid and Dual Pronged Claw 504RClw is that about once every ten seconds this “positioning system” pushes all the canisters that are floating in the Right-side Floatation Holding Cue 499R over to the left a distance of about one canister diameter.

In Left-side Floatation Holding Cue 499L there is a Left Retaining Solenoid 505L and this reference includes the Solenoid Body and the Solenoid Plunger. There is a Harness Mount 505LHM for this Left Retaining Solenoid 505L and this Harness Mount 505LHM attaches to the top of the Solenoid Body and then both “legs” of Harness Mount 505LHM extend down and attach to Rear Containment Block 507L (in Left-side Floatation Holding Cue 499L). The purpose of Left Retaining Solenoid 505L is to keep all the canisters that are floating in Left Floatation Holding Cue 499L in a tightly-organized line, so that no canister moves so far over to the left that the canister gets in the way of a canister ascending up into the far left “Cue Position” of Left Floatation Holding Cue 499L, at the point in time when any such canister exits the top of Left Vertical Guide Rail System 502.

In Right-side Floatation Holding Cue 499R there is a Right Retaining Solenoid 505R and this reference includes the Solenoid Body and the Solenoid Plunger. There is a Harness Mount 505RHM for this Right Retaining Solenoid 505R and this Harness Mount 505RHM attaches to the top of the Solenoid Body and then both both “legs” of Harness Mount 505RHM extend down and attach to Rear Containment Block 507R (in Right-side Floatation Holding Cue 499R). The purpose of Right Retaining Solenoid 505R is to keep all the canisters that are floating in Right-side Floatation Holding Cue 499R in a tightly-organized line, so that no canister moves so far over to the right that the canister gets in the way of a canister ascending up into the far right “Cue Position” of Right Floatation Holding Cue 499R, at the point in time when any such canister exits the top of Right Vertical Guide Rail System 503.

The “bounding components” in Left-side Floatation Holding Cue 499L that create the “Cue Area” where the canisters float in the Fluid are: Front Containment Block 506L, Rear Containment Block 507L, and Right Containment Block 517L (shown and referenced in FIG. 42D). The Plunger of Left Retaining Solenoid 505L could also be considered as a “bounding component” for the “Primary Cue Area” of Left Floatation Holding Cue 499L.

For the Right-side Floatation Holding Cue 499R the “bounding components” for the canisters are: Front Containment Block 506R, Rear Containment Block 507R, and Left Containment Block 517R (shown and referenced in FIG. 42D). The Plunger of Right Retaining Solenoid 505R could also be considered as a “bounding component” for the “Primary Cue Area” of the Right Floatation Holding Cue 499R. (Note: the reference for Right Containment Block 517L has an “L” and the reference for Left Containment Block 517R has an “R” because these components are in the Left and Right Floatation Cues, respectively.)

The Wall-type structures that together form the “boundary partitions” of the overall Curved-front Fluid Reservoir 498 are: Curved Front Wall 508CWL; Back Wall 508BckWL; Left Wall 508LWL; Right Wall (that is not referenced or shown). All of these Walls are attached at the bottom to Subterranean Floor 411 (of the Over-sized embodiment). Curved Front Wall 508CWL is represented in all of the Drawings by Phantom Lines, except in FIGS. 43A and 43B. There is a Spacer Partition Block 509 that is shown in FIGS. 43A, 43B and 43C in a “broken-off” style; this Block 509 is also shown (not “broken”) in the side views: 43A and 43B. This Spacer Partition-block 509 goes the full length of Back Wall 508BckWL and is positioned between the front of Back Wall 508BckWL and the back of: Rear Containment Block 507L (for Left-side Floatation Holding Cue 499L) and Rear Containment Block 507R (for Right-side Floatation Holding Cue 499R).

In FIG. 42C there is a Canister C-New and this canister is ready to be pulled out of Variable Pressure Chamber 414 by Puller Assembly 501.

Turning now to FIG. 42D, on the right side (the “inner” portion) for Left-side Floatation Holding Cue 499L (the portion not shown in FIGS. 42A, 42B, and 42C), there are Four vertical “block-type” components that are used to keep a canister in the proper vertical alignment as that canister is being pushed upwards by Vertical Positioning Linear Motor 525; see explanation below in this Structural Composition Section about the Dual Floatation Holding Cues sub-embodiment). Two of these vertical “block-type” components are moveable (510L and 512L) and two of these vertical “block-type” components are stationary (511L and 513L). Specifically, these Four functionally-related components for Left-side Floatation Holding Cue 499L are: Outer Moveable Divider 510L; Front Stationary Alignment Block 511L (partially shown); Inner Moveable Alignment Block 512L; Rear Stationary Alignment Block 513L. There is an identical matching set of Four functionally-related components for Right-side Floatation Holding Cue 499R. Since these groups of components are the mirror images of each other, the “Outer Moveable Dividers” (510L and 510R) are on the far left and on the far right, respectively, which leaves the “Inner Moveable Alignment Blocks” (512L and 512R) both “towards the inside” of the individual Floatation Holding Cues.

In the Left-side Floatation Holding Cue 499L the two moveable components just discussed, Outer Moveable Divider 510L and Inner Moveable Alignment Block 512L are moved from the front to the rear, and from the rear to the front, as applicable, by a Solenoid System, and the general reference for this (left-side) Solenoid System is 514L. Specifically, this Left-side Solenoid System consists of: Solenoid Body 514LB; Solenoid Plunger 514LP (this 514LP reference includes a disk-type “End Cap” on the front tip of the Solenoid Plunger); Mounting Harness 514LMH. This Mounting Harness 514LMH attaches to the top of the (Left) Solenoid Body 514LB and each of the two “legs” of Mounting Harness 514LMH attaches at the bottom onto the top of Spacer Partition Block 509 (this mounting configuration is shown, in a graphic representation, in FIG. 43A). There is a system of Two (Circular) Connection Arms, which includes a Left and a Right Arm, and each Arm has an upper and lower “branch” (these Two Arms are referenced as 515L and 515R, respectively). These Two Connection Arms connect the End Cap of the (Left) Solenoid Plunger 514LP with the Two Moveable components, 510L and 512L.

Specifically, the Left Connecting Arm 515L goes from the End Cap to the Outer Moveable Divider 510L and the top branch of this Connecting Arm 515L attaches near the top (in the rear; away from the viewer) of Divider 510L and the lower branch attaches near the bottom (in the rear) of Divider 510L. The Right Connecting Arm 515R goes from the End Cap to the Inner Moveable Alignment Block 512L, and the top branch of this Connecting Arm 515R attaches near the top (in the rear; away from the viewer) of Alignment Block 512L and the lower branch attaches near the bottom (in the rear) of Alignment Block 512L.

(Note: the complete workings of this Solenoid System 514L and the importance of having the Two Moveable Canister Alignment Components, 510L and 512L, is fully-described below in Structural Composition Section, about the Dual Floatation Holding Cues sub-embodiment.)

On the left side (the “inner” portion) of the Right-side Floatation Holding Cue 499R, there are the same Four vertical “block-type” components as just described above in the preceding paragraphs. Specifically, these Four functionally-related components are: Outer Moveable Divider 510R; Front Stationary Alignment Block 511R; Inner Moveable Alignment Block 512R; Rear Stationary Alignment Block 513R.

There is also a general reference for a (right-side) Solenoid System 514R that is responsible for moving the Outer Moveable Divider 510R and Inner Moveable Alignment Block 512R from the front to the rear, and from the rear to the front, as applicable. Specifically, this Right-side Solenoid System consists of: Solenoid Body 514RB; Solenoid Plunger 514RP (this 514RP reference includes a disk-type “End Cap” on the front tip of the Solenoid Plunger); Mounting Harness 514RMH. This Mounting Harness 514RMH attaches to the top of the (Right) Solenoid Body 514RB and each of the two “legs” of Mounting Harness 514RMH attaches at the bottom onto the top of Spacer Partition Block 509. There is a system of Two (Circular) Connection Arms, which includes a Left and a Right Arm, and each Arm has an upper and lower “branch” (these Two Arms are referenced as 516L and 516R, respectively). These Two Connection Arms connect the End Cap of the (Right) Solenoid Plunger 514LP with the Two Moveable components, 510R and 512R.

Specifically, the Right Connecting Arm 516R (partially shown) goes from the End Cap to the Outer Moveable Divider 510R, and the top branch of this Connecting Arm 516R attaches near the top (in the rear; away from the viewer) of Divider 510R and the lower branch attaches near the bottom (in the rear) of Divider 510R. The Left Connecting Arm 516L goes from the End Cap to the Inner Moveable Alignment Block 512R, and the top branch of this Connecting Arm 516L attaches near the top (in the rear; away from the viewer) of Alignment Block 512R and the lower branch attaches near the bottom (in the rear) of Alignment Block 512R.

There is a Separation Spacer Partition 518 that goes between the right side of the Right Containment Block 517L (for Left-side Floatation Holding Cue 499L) and the left side of the Left Containment Block 517R (for Right-side Floatation Holding Cue 499R). This Separation Spacer Partition 518 attaches at the bottom of the Two Containment Blocks and the spatial configuration of these components creates a space in which Pre-launch Launch Platform 519 can be positioned and can move back and forth, from front to rear (according to the viewing perspective in FIG. 42D).

There is a (circular) Pre-launch Launch Platform 519 which is slightly bigger than the diameter of a canister. In the center of this Pre-launch Launch Platform 519, on the top, there is a “partial protrusion” section (“partial protrusion” of a “full” Nose Cone Protrusion 70). The height of this “partial protrusion” is only about half the height of the “full” protrusion 70 (the reason for this height variance is also explained near the end of “13 Topics; #7, Dual Floatation Holding Cues sub-embodiment”). There is a Connection Interface 519-I and the front of Connection Interface 519-I is attached to the rear of Pre-launch Launch Platform 519 and the rear of Interface 519-I is attached to the front of the Forcer that moves up and down in the front of the (single) Pre-launch Linear Motor 531 (this Linear Motor is not shown in FIG. 42D, but is shown in FIG. 43A and FIG. 43B). In FIG. 42D, this Connection Interface 519-I is only partially shown and is “broken off” in the back. There is a Pressure Switch 548 shown in FIG. 42D as a circle-type object on the surface of Pre-launch Launch Platform 519, but this component is referenced in FIG. 42E.

Positioned “inside the Fluid” are a Left and Right Vertical Positioning Linear Motor, and these two components have general references of 525 and 529, respectively. Regarding the Left Vertical Positioning Linear Motor (VPLM) 525, there is a Forcer 524, and the right side of this Forcer 524 is connected to the VPLM 525. Forcer 524 is moved up and down by VPLM 525. The upward speed of Forcer 524, powered by VPLM 525 should not be considered as a “Launch” and instead is a much more casual vertical positioning maneuver that can be accomplished at a reasonably moderate speed; the downward “resetting” movement is rather slow and relaxed, as well.

The left side of Forcer 524 is attached to Base Interface 523. On top of this Base Interface 523 there is a permanently attached Linkage Positioning Stick 522. The shape of the pointed top end of this Linkage Positioning Stick 522 matches the “Carved-out” Impression 71 that exists in the lower portion of every canister.

VPLM 525 consists of the following: Linear Motor Body 525B; Top End Cap 525TEC; Bottom End Cap 525BEC; Top Stop-block 525TStp; Bottom Stop-block 525BStp. This VPLM 525 is held in place by Two Mounting Blocks: a Front Mounting Block 525FM and a Rear Mounting Block 525RM. These Mounting Blocks extend all the way down to Subterranean Floor 411 (of the Over-sized embodiment), but are “broken-off” in FIG. 42D.

The right side Vertical Positioning Linear Motor 529 performs exactly the same function, and is constructed in exactly the same manner, as VPLM 525, except that VPLM 529 is the horizontal mirror image of VPLM 525. VPLM 529 is used to position, vertically, the furthest left canister in the Right Floatation Holding Cue 499R.

For VPLM 529, there is a Forcer 528, and the left side of this Forcer 528 is connected to VPLM 529 and Forcer 528 is moved up and down by VPLM 529. The right side of Forcer 528 is attached to Base Interface 527. On top of this Base Interface 527 there is a permanently attached Linkage Positioning Stick 526. The shape of the pointed top end of this Linkage Positioning Stick 526 matches the “Carved-out” Impression 71 exists in the lower portion of every canister.

VPLM 529 consists of the following: Linear Motor Body 529B; Top End Cap 529TEC; Bottom End Cap 529BEC; Top Stop-block 529TStp; Bottom Stop-block 529BStp. This VPLM 529 is held in place by Two Mounting Blocks: a Front Mounting Block 529FM and a Rear Mounting Block 529RM. These Mounting Blocks extend all the way down to Subterranean Floor 411 (of the Over-sized embodiment), but are “broken-off” in FIG. 42D.

[Note: as shown in FIG. 43A, VPLM 525 is turned so that the left side of VPLM 525 is directly “in line” with the side view, which means for that pictorial representation, VPLM 525 would be facing directly towards the rear (away from the viewer in a front view, like what is shown in FIG. 42D and FIG. 42E). However, since the purpose of both of these Vertical Positioning Linear Motors is simply to “push straight up” the respective Linkage Positioning Stick, each Linear Motor could be positioned at any angle, whatsoever, over a complete 360 degree spectrum, because the only issue that matters is that the respective Linkage Positioning Stick is sitting directly below the center of the canister's bottom surface, when that canister is being vertically aligned by the Four vertical “block-type” components (510L-513L or 510R-513R) while a VPLM is pushing the canister upwards.

In addition, another issue regarding the combined purpose of these Four vertical “block-type” components (510L-513L or 510R-513R) during the period while a VPLM is pushing a canister upwards is that, together, each set of four functionally-related components forms a “bounding box” that has a distance across in either direction, left to right or front to back, that is just slightly larger than the diameter of the canister being pushed up inside the “bounding box.” FIG. 42E shows that when a canister is pushed up to the “maximum height” necessary before the “Horizontal Transport Process” is performed, it is possible that the canister could begin tilting one way or another if these Four “aligning components” are not forming a fairly tight “bounding box” around the elevated canister. Each canister that is “pushed-up” on either of the Floatation Holding Cues needs to consistently be in the exact same position, horizontally and vertically, when that canister is pushed up to the maximum height, because the Notch Suspension Arm 542 (in FIG. 42F) has only a limited range, vertically and horizontally, in which to engage into the Notch of a waiting, elevated canister.]

The Curved Front Wall 508CWL (of the Curved-front Fluid Reservoir 498) is shown in FIG. 42D by phantom lines and where this Curved Front Wall goes off the drawing page at the bottom is shown by a “broken” (mostly) horizontal phantom line.

There is a Canister C38 in FIG. 42D and the elevation of this canister after the canister is moved out of (raised above) Left Floatation Holding Cue 499L is shown in FIG. 42E. Canister C38 is also shown again in FIG. 42F, where the equipment used to transport Canister C38 to the right is shown, with special attention given to the relationship this equipment has to the elevated height of Canister C38 in FIG. 42E.

Turning now to FIG. 42E, Canister C38 has been “pushed up” by VPLM 525 (also note, Forcer 524 of VPLM 525 has reached Top Stop Block 525TStp). The purpose of this “elevation procedure” is so that the bottom surface of Canister C38 is higher than the top surface of Right Containment Block 517L (for Left-side Floatation Holding Cue 499L). In FIG. 42E, Inner Moveable Alignment Block 512L is not yet in the “retracted state.” However, FIG. 42F does show Inner Moveable Alignment Block 512L in the “retracted state” and it is obvious that when Alignment Block 512L is retracted and out of the way to the rear, there is a clear pathway for Canister C38 to be moved to the right and positioned directly over the center of Pre-launch Launch Platform 519. Pressure Switch 548 is embedded into the top surface of Pre-launch Launch Platform 519, and this component is used when Canister C38 and Pre-launch Launch Platform 519 make initial contact with each other.

Turning now to FIG. 42F, it should be noted that all of the components shown in FIG. 42F are “in the air;” nothing is “in the Fluid.” [Moving ahead to FIG. 43A, this Figure shows the vertical position of the Right Support Wall (and the Left Support Wall is at the identical vertical position) and in fact the bottom surface of this Right Support Wall 532R is sitting on the top surface of the Curved Front Wall 508CWL (of the Curved-front Fluid Reservoir 498).]

In the lower portion of FIG. 42F there is a Left Support Wall 532L and a Right Support Wall 532R. These Two sturdy structures are used to support all of the components utilized in the horizontal sliding-transport procedures performed by the various components shown in FIG. 42F. In the rear of FIG. 42F, the “innermost” portions of Left-side Floatation Holding Cue 499L and Right-side Floatation Holding Cue 499R are shown, along with Canister C38 from FIG. 42E. There is a Left Suspension Interface 533L and a Right Suspension Interface 533R; these Two Interfaces connect the Left Support Wall 532L and the Right Support Wall 532R, respectively, with the Four-sided Support Frame 534Frm. [Notes for the “Linear Motor Pit:” a) the components in the “Linear Motor Pit” are shown and referenced in FIG. 42F-3a, and b) no reference is given for the overall “Linear Motor Pit” Area.]

There is a general reference for the Four-sided Support Frame 534Frm (that surrounds the “Linear Motor Pit”) and this Support Frame 534Frm is the structure that actually attaches to the Front and Rear Partitions (539FPrt and 539RPrt, respectively) of Horizontal Transport Linear Motor (HTLM) 539. As mentioned in Additional Drawing Exceptions and Comments #30, for the sake of clarity in FIG. 42F, the Rear Plank 534FrmRear (referenced in FIG. 42F-3a) of this Four-sided Support Frame 534Frm is shown “farther back” than it should be. In other words, the front surface of the Rear Plank 534FrmRear is attached to the rear surface of the Rear Partition 539RPrt (of Horizontal Transport Linear Motor 539). Also, the rear surface of the Front Plank 534FrmFrnt is attached to the front surface of the Front Partition 539FPrt (of the Horizontal Transport Linear Motor 539). This physical and spatial relationship between these two parts, Front Plank 534FrmFrnt and Front Partition 539FPrt is shown fairly accurately in FIG. 42F, except that in order to more clearly show the Front Partition 539FPrt (of HTLM 539), Front Plank 534FrmFrnt (of Support Frame 534Frm) is “broken-off” on each end (this component is in the lower front of the drawing).

There is a Primary Support Beam 535 that is strong enough to hold-up the weight of an approximately 50-pound canister while any such canister is being horizontally transported from one of the Floatation Holding Cues to the center of Pre-launch Launch Platform 519. The entire Primary Support Beam 535 consists of a vertical column section and a curved section, not referenced separately.

The Base 535Bs (of Primary Support Beam 535) connects the bottom of this Primary Support Beam 535 with Connecting Interface Block 535Int (535Bs and 535Int are both referenced in FIG. 42F-3a). There are two perfectly round holes running the entire horizontal width of Connecting Interface Block 535Int, and this Connecting Block 535Int uses these two holes for the purpose of sliding, horizontally, from left to right and from right to left along the Front and Rear Slide Rods, 536 and 537, respectively.

References for all “536,” “537,” “538,” and “539” components are shown in FIG. 42F-3a. There is a Front Slide Rod 536 which is supported on the left by the Left Harness Mounting System 536LM and is supported on the right by the Right Harness Mounting System 536RM. Both of these Harness Mounting Systems extend down to, and are attached to, the top of the Curved Front Wall 508CWL (of the Curved-front Fluid Reservoir 498). There are Mounting Sleeves (not referenced separately) inside the curved parts of the Harness Mounts and the Left and Right ends of Front Slide Rod 536 each fit tightly into one of these Mounting Sleeves. This Front Slide Rod 536 is fixed permanently in one position and does not rotate or move up and down, etc.

There is a Rear Slide Rod 537 which is supported on the left by the Left Harness Mounting System 537LM and is supported on the right by the Right Harness Mounting System 537RM. Both of these Harness Mounting Systems extend down to, and are attached to, the top of the Curved Front Wall 508CWL (of the Curved-front Fluid Reservoir 498). There are Mounting Sleeves (not referenced separately) inside the curved parts of the Harness Mounts and the Left and Right ends of Rear Slide Rod 537 each fit tightly into one of these Mounting Sleeves. This Rear Slide Rod 537 is fixed permanently in one position and does not rotate or move up and down, etc.

There is a Left Support Block 538L and a Right Support Block 538R and these Two Support Blocks: a) give added structural strength to the Horizontal Transport Linear Motor 539, and b) also provide additional vertical support to the Primary Support Beam 535 at the times when the Primary Support Beam 535 is sitting directly over either one of the Support Blocks (for example, in FIG. 42F the Connecting Interface 535Int is at the far left of its horizontal movement, which occurs about once every ten seconds, when the Primary Support Beam is “picking up” a canister from the Left Floatation Holding Cue 499L).

There is a general reference for Horizontal Transport Linear Motor (HTLM) 539. As mentioned above, this HTLM 539 sits inside the Four-sided Support Frame 534Frm and the front face of this HTLM 539 is pointed upwards. Forcer 539Fcr (shown in FIG. 42F-3a) that is powered by, and runs along the entire horizontal length of, HTLM 539. Forcer 539Fcr also causes Primary Support Beam 535 to move back and forth, horizontally.

All of the components for HTLM 539 are: Body 539B; Forcer 539Fcr; Left End Cap 539LECp; Right End Cap 539RECp; Front Partition 539FPrt; Rear Partition 539RPrt.

Returning now to the upper portion of FIG. 42F, there are Two Electromagnet Grippers, a Front Electromagnet Gripper 540EM and a Rear Electromagnet Gripper 541EM. For each of these Grippers, 540EM and 541EM, there is a Connecting Interface, 540Int and 541Int, respectively, and these identical Connecting Interfaces are circular rods that are positioned vertically, and the top of each Connecting Interface attaches to the underside of the front (almost completely horizontal) section of the Primary Support Beam 535; the bottom of each Connecting Interface attaches to the top of the respective Electromagnet Gripper. The distance between the “inner edges” of the Two EM Grippers (as they face each other) is slightly more than the widest distance across the Nose Cone Protrusion 70 of a canister, at the point where the Nose Cone Protrusion 70 meets the flat Leading Surface of the canister. The Activation Signal for these Two EM Grippers to create their Magnetic Fields is sent from the Horizontal Transport Linear Motor System 539, and these signals are sent to initiate the EM Fields when the EM Grippers are precisely over the center axis (from front to rear) of an elevated canister in either of the Floatation Holding Cues. (The signal to terminate the EM Fields is sent by a Pressure Switch that is part of the Pre-launch System, and this “Termination Process” and the related “Release Process” are described near the end of “13 Topics; #7, Dual Floatation Holding Cues sub-embodiment”).

There is a Notch Suspension Arm 542 that moves from front to rear and from rear to front in the horizontal plane. This overall Notch Suspension Arm 542 has two separate “curved prongs” that split-out to the left and to the right. The relative curvature of each of these prongs matches as closely as possible the curvature of the diameter of the Notch on a canister. When the Insertion Solenoid 543 is extended, the two individual prongs of Notch Suspension Arm 542, as a unit, engage into the Notch of the canister that is to be “transported” either to the right or to the left. The ends of both of these prongs on this Notch Suspension Arm 542 are rounded and therefore this helps: a) allow for a “margin of error” in the horizontal placement of a canister, because the prongs will “find their way” into the Notch by gently sliding further into the Notch once initial contact is made between one or both of the prongs and the Notch of a canister, and b) to minimize the chance of any deterioration to the Notches of the canisters due to a sharp pointed object making contact with the surface of a canister (inside the Notch). The front end of the Notch Suspension Arm 542, where both prongs come together into basically one piece, is permanently attached to the end of the Plunger of the Insertion Solenoid 543 (this Plunger is not referenced separately).

There is an Insertion Solenoid 543 that is “pointed towards the rear” and this Insertions Solenoid 543 is attached to the Primary Support Beam 535 in such a way that the Body of this Insertion Solenoid 543 is perfectly horizontal. The reference for this Insertion Solenoid 543 includes both the Body of the Solenoid and the Plunger.

This Insertion Process (mentioned two paragraphs above) occurs Before the respective Vertical Positioning Linear Motor (525 or 529 in FIG. 42E) pulls the respective Linkage Positioning Stick (522 or 526) down and away from the Elevated/Supported canister. In other words, at the time when the Linkage Positioning Stick is taken away (pulled down), the Notch Suspension Arm (and indirectly the Insertion Solenoid), along with the Two EM Grippers, will be the only components that are holding the canister up and keeping the canister from falling back down into the Fluid.

There is a Mounting System 544 for the Body of the Insertion Solenoid 543, and this Mounting System 544 includes identical (left and right) Mirror Image Mounting Sub-systems. For each Mounting Sub-system, the rear piece has a curvature that matches the (round) curvature of the Body of the Insertion Solenoid 543. These left and right “rear pieces” are attached on each respective side to the Body of the Insertion Solenoid and are also attached to the “front pieces” of the respective Mounting Sub-systems. The “front pieces” of these Mounting Sub-systems are attached to the left and right sides, respectively, of the Primary Support Beam 535. There can be other sub-embodiments where a much stronger and more elaborate Mounting System 544 can be utilized, because even though the Two EM Grippers do help support the weight of the canister while the canister is being transported horizontally (to the left or to the right about 10 inches), it is possible a canister can weigh as much as 50 pounds, and therefore this Mounting System 544, in whatever version is being used, is required to support a substantial amount of weight.

There is a Front Guide Rod 546 and a Rear Guide Rod 547, and both of these Guide Rods, on the left, are attached to the Left Support Wall 532L (at different points on this Wall) and on the right, are attached to the Right Support Wall 532R (at different points on this Wall). Because the Primary Support Beam 535 must be totally free to slide horizontally across the length of the HTLM 539, Primary Support Beam 535 is Not “permanently attached” to any component, except at the bottom the Primary Support Beam 535 is permanently attached to Base 535Bs and this Base 535Bs is attached to the “sliding component,” Connecting Interface Block 535Int.

Therefore, the Front Guide Rod 546 ensures that Primary Support Beam 535 will not “tilt” outward toward the front (toward the viewer in FIG. 42F) and Rear Guide Rod 547 ensures that Primary Support Beam 535 will not “tilt” inward toward the rear. Obviously, this Rear Guide Rod 547 will be counteracting the majority of the “tilting” force, because when the Primary Support Beam 535 has “locked onto” a canister and is transporting that canister horizontally, the tendency will be for the weight of the canister to pull (or tilt) Primary Support Beam 535 down and towards the rear. There is a small amount of clearance between: a) the front surface of the Primary Support Beam 535 and the rear edge of Front Guide Rod 546 and b) the rear surface of the Primary Support Beam 535 and the front edge of Rear Guide Rod 547. These clearances are shown in the left side view of FIG. 43A, where Both Guide Rods, 546 and 547, the Primary Support Beam 535 and the Right Support Wall 532R can be clearly seen by looking straight at these components from the left side.

Turning now to FIG. 43A, there is a Support Partition System 530, which includes two pieces, a rather thin horizontal piece and a rather small vertical piece. The purpose of the horizontal piece is to provide a “floor-like” base to support Pre-launch Linear Motor 531. The vertical piece simply connects the front of the horizontal piece to the rear of Separation Spacer Partition 518 (Partition 518 is shown best in FIG. 42D). FIG. 43A provides a a two-dimensional graphic depiction of Pre-launch Linear Motor 531, but more explanation is given on this component in various places in “13 Topics; #7, Dual Floatation Holding Cues sub-embodiment”). It is a little hard to tell in FIG. 43A, but Launch Platform Interface 519-I (completely in hidden lines) is “broken-off” and for the sake of clarity in the drawing, Pre-launch Launch Platform 519 is not shown; the very short vertical line on the left side of Launch Platform Interface 519-I is where the front surface-edge of the Forcer for Pre-launch Linear Motor 531 meets the rear surface-edge of Launch Platform Interface 519-I.

FIG. 43A is primarily showing the relationship between the Floatation Cues (499L and 499R, even though Right Floatation Holding Cue 499R is not visible because it is directly “behind” Left Floatation Holding Cue 499L, which is shown), the Vertical Positioning Linear Motors (525 and 529, but 529 is also not visible because it is directly “behind” VPLM 525), and Primary Support Beam 535, with respect to: a) Vertical Guide Rail Systems (502 and 503), b) the overall Curved-front Fluid Reservoir 498 and c) especially with respect to Curved Front Wall 508CWL (of Curved-front Fluid Reservoir 498). Since the viewing perspective of FIG. 43A is showing the components “straight” from the left side, Pre-launch Linear Motor 531 and Pre-launch Launch Platform 519 are both “behind” all of the other components in Left-side Floatation Holding Cue 499L. This is the primary reason why it is not really practical to show Pre-launch Launch Platform 519 in FIG. 43A and FIG. 43B.

Turning now to FIGS. 44-46, there is an Above Ground Multi-Rail Curved Pathway sub-embodiment of the preferred embodiment. FIG. 44 shows the front view of this Multi-Rail Curved Pathway Section 596; FIG. 45 shows the left-side view; FIG. 46 shows the top view. [Note: FIG. 46 should show All Three Guide Rails, but the main purpose for All Three of these drawings is to show the general shape of the Pathway and not to provide excessive details. Therefore, for the sake of clarity, the center Guide Rail, when looking down from the top (which is the top Guide Rail when looking from the front or side), is not shown in FIG. 46. For the front view and the left-side view, FIG. 44 and FIG. 45, respectively, the two lower Guide Rails appear as only one Rail because these two lower Rails are directly in line with each other, from the viewer's perspective in these Two Drawings.] The phantom lines in these Three drawings show the outermost possible width of the Pathway, including any “over-hang” by a canister, because the Pathway is not enclosed. The Pathway consists of Three Open Circular Guide Rails and therefore at certain times parts of a canister may stick outside (beyond) the outer edge of any particular Rail.

The basic configuration of this Multi-Rail Curved Pathway Section 596 is the same as the Downward Sloping 3-Sided Guide Rail 402 from the Over-sized embodiment (FIG. 1D-oz). The overall Pathway consists of Three Individual Guide Rails, and each one of the Rails is a round, cylindrical-like structure which has curves or is straight, as shown in FIGS. 44-46. There is an “inner triangle” formed between any three points of the inner surfaces of the individual Guide Rails. The distance between the inner edges of the three Rails is wide enough so the canister can comfortably fit into this “inner triangle space” and therefore the canisters can move upwards inside the open area provided by this “triangular inner space” between the Three Rails. The Three Guide Rails “gently” curve and form a large upward-sloping circular-like Pathway as they curve, so a canister can smoothly move all the way up from the Ceiling 254 of the Fluid Column (where a canister comes through Splash Guard 253) until the canister is preparing to exit the Pathway by passing through the Pathway Exit Deceleration EM 598.

In “13 Topics; #8, Pivot Buckets; sub-section Above Ground Multi-Rail Curved Pathway sub-embodiment” there is a discussion on the advantages and disadvantages of this sub-embodiment over the merits of the preferred embodiment that uses a Pivot Bucket.

Even though FIGS. 44-46 do not show that a canister goes through any Coils during the Above Ground Ascent through this Pathway, it is certainly possible to have one or more Coils positioned in between straight or even curved sections of the overall Multi-Rail Curved Pathway 596. FIG. 44 shows how the Rails have been separated at a particular point and how the Pathway Exit Deceleration EM has been inserted into the gap created by that separation. Several Coils could also be inserted in this manner along the Pathway, where the Pathway would have multiple shorter sections and canisters would pass through Coils and produce “Above Ground Electricity.” FIG. 1K of the preferred embodiment shows “Above Ground Electricity” being created in a different way, in that a canister is “flying straight up through the air” while passing through a series of “Above Ground Coils.” For a MF device to be most efficient in producing electricity, several “Above Ground Coils” should be utilized to produce “Above Ground Electricity.” However, for the sake of clarity, FIGS. 44-46 do not show any such Coils because the primary purpose of these Three drawings is to show the shape of the Curved Pathway.

For the Above Ground Multi-Rail Curved Pathway sub-embodiment, when a canister exits the Multi-Rail Curved Pathway 596, the canister moves onto Inclined Platform Top Cue Position Canister Holder Section 625Ext, exactly as shown in FIG. 1N. The explanation given below in “13 Topics; #8, Pivot Buckets; sub-section Single Pivot Bucket operation” thoroughly explains what happens to a canister after it moves onto Canister Holder Section 625Ext.

FIG. 44 is a front view of the Multi-Rail Curved Pathway 596. The Mounting System for this Pathway 596 is not shown, but a Mounting System similar to the Set of Support Beams 410Srs (for the Over-sized embodiment; see FIG. 1D-oz) is used; these Vertical Beams are attached to the Rails of the Pathway and the Beams extend down from the Rails to the Ceiling of the Fluid Column 254. For the Lower Rails, the Beams are attached to the very bottom of the individual Rails so as not to get in the way of a moving canister; for the Top Rail, the Beams curve up over the Rail and attach to the Top of the Rail so as not to get in the way of a moving canister. The overall Pathway, as described above, consists of Three Individual Rails, and the Rail-related reference 596Rail refers to any individual Rail and also refers to All Three Rails collectively. There is a Harness Connecting Strap 596Hns that wraps around, and is attached to, each of the Three Individual Guide Rails 596Rail and this Strap 596Hns keeps the Rails locked together as an overall unified component. FIG. 44 shows two such Straps 596Hns, but more than two Straps can be used on the Multi-Rail Curved Pathway 596.

There is an Above Ground Pathway Exit Sensor 597. The Mounting System for this Sensor 597 is included in the overall reference and this Mounting System has two “legs” that either: a) extend down to the Ceiling 254 of the Fluid Column, or b) are attached to the very bottom of the two Lower Rails (out of the way of a canister moving over the Rails), or c) are attached to a Harness Connecting Strap 596Hns. The Pathway Exit Sensor System 597 detects when a canister is moving in front of it and at that point this Sensor 597 sends a signal to Above Ground Curved Pathway Speed-adjusting EM 598 that causes Speed-adjusting EM 598 to create an Electromagnetic Field.

There is an Above Ground Curved Pathway Speed-adjusting EM 598; the Mounting System for this component is not shown, but this Speed-adjusting EM 598 mounts to the outside of the Three Rails or is attached to Two Harness Connecting Straps 596Hns that are located on each side of this Speed-adjusting EM (this configuration of Straps is not shown). This Speed-adjusting EM 598 creates an Electromagnetic Field that will cause the speed of the canister (which has just passed Sensor 597) to be adjusted so that when the canister totally exits the Pathway and moves onto (lands on) the permanently fixed Inclined Platform Canister Holder Section (a non-sliding version of what is shown in FIG. 53), the canister will be moving at a reasonable speed so the equipment (shown in FIG. 53) will be able to accept the canister without any type of damage to the Inclined Platform Canister Holder Section and/or to any equipment attached to the Inclined Platform Canister Holder Section.

As mentioned in Additional Drawing Exceptions and Comments #32, FIG. 44 shows two canisters in the Multi-Rail Curved Pathway 596 at the same time, which will never happen; this illustration with Two Canisters is simply to show different angles a canister will be at when inside the Multi-Rail Curved Pathway 596.

Turning now to FIG. 47, there is a Dual Pivot Bucket with Inclined Platform Canister Holder Section sub-embodiment of the preferred embodiment. Because of the Five Second Cycle Rule, this Dual Pivot Bucket sub-embodiment exists to better ensure a canister can be moved onto the Inclined Platform once every five seconds. Essentially the Dual Pivot Bucket sub-embodiment utilizes the following features: a) near the top of the Fluid Column (inside the Fluid) there is equipment to route the canisters onto different “ascension pathway sections” on an alternating basis, that is, to send the canisters up alternate vertical pathways so that Both Pivot Buckets (in FIG. 52) will be used, one after another, and b) there is a “Sliding Section” (in FIG. 53) at the top, on the right, of the Inclined Platform (59; FIG. 1A) that moves to the front and to the rear, on an alternating basis, and is positioned in front of the Mouth of one Pivot Bucket (after that Pivot Bucket has been rotated towards the Inclined Platform) and then moves in front of the Mouth of the other Pivot Bucket, etc.

At the top of the “original” Fluid Column 320 (the Uppermost Section of the Fluid Column 599 has been modified in the Dual Pivot Bucket sub-embodiment; see FIG. 51) there is a Dual Ascent Pathway Sensor 600. This Sensor 600 causes either: a) the Two Right-side Ascent Adjustment EMs (603 and 604) to create EM Fields, or b) the Two Left-side Ascent Adjustment EMs (613 and 614) to create EM Fields (more explanation about this process is provided in “13 Topics; #8, Pivot Buckets; sub-section Dual Pivot Buckets”).

[Note: for the sake of clarity, the Two Ascent Pathway Conduits (601 and 611) in FIGS. 47-51 have been shown to go across the drawing page from left to right. However, in FIG. 52 the Two respective Pivot Buckets, that are directly above the Two Vertical Pathways created by the Two Pathway Conduits are shown going from Front to Rear. Even though these two situations are being illustrated and described with a “90 degree discrepancy,” the overall solution to this discrepancy is very easy to understand and to rectify. In fact, FIG. 50-2 (a top view showing the relationship of the Two Pathway Conduits and the spot where the canisters are exiting the Fluid Column) does rectify this discrepancy. Since the only thing that matters is that the bottoms of Both Pathway Conduits (601 and 611) are positioned exactly over the center of the Fluid Column, where the canisters are ascending out of (but never positioned there together at the same time), it does not matter at what horizontal angle the Pathway Conduits are turned relative to the top of the Fluid Column. The only thing that changes in rectifying this discrepancy is shown in FIG. 50-2, where the drawing shows that the Two Positioning Solenoids (602 and 612) are “over to the right,” whereas FIG. 50 shows the Two Positioning Solenoids (602 and 612) are “in the rear.”

These two “Versions” of how the Two Positioning Solenoids (602 and 612) are turned have a direct effect on how the components are shown in FIG. 51. Since FIG. 51 is showing a “zoomed-out” view of what was shown in FIGS. 47-49, FIG. 51 shows that the Enlarged Uppermost Section of the Fluid Column 599 has an “expanded dimension” in the rear, to accommodate the Two Positioning Solenoids (602 and 612), that are both shown to be “in the rear” in FIG. 47 and FIG. 49. If the Two Positioning Solenoids (602 and 612) are turned 90 degrees counterclockwise, so that the Right Ascent Pathway Conduit 601 is in the Front and the Left Ascent Pathway Conduit 611 is in the rear, then the “expanded dimension” of the Uppermost Section of the Fluid Column 599 would be over on the right side and Not in the rear, because the Two Positioning Solenoids will have been turned 90 degrees counterclockwise, moving Both Solenoids from the rear to the right side.

This 90 degree counterclockwise “rotational adjustment” is necessary so that the canisters exiting the Two Vertical Pathways (coming up through Splash Guards 610 and 620, respectively) will be coming up directly below the Two respective Pivot Buckets (shown in FIG. 52). After this 90 degree counterclockwise rotation, canisters that were exiting on the (original) right side will be coming up under the Front Pivot Bucket Assembly 621 (in FIG. 52) and canisters that were exiting on the (original) left side will be coming up under the Rear Pivot Bucket Assembly 623.]

There is a Right Ascent Pathway Conduit 601 and this Conduit 601 is suspended by, and attached to the Right Conduit Positioning Solenoid 602. This Right Conduit Positioning Solenoid 602 is fixed in position by the Right Conduit Positioning Solenoid Mounting Harness 602MH. In FIG. 47 the visible “Leg” of this Mounting Harness 602MH is “broken off,” but this “Leg” extends down, and attaches to, the Floor of the Enlarged Uppermost Section of the Fluid Column 599. This Floor is not referenced separately, but can be seen in FIG. 51. FIG. 47 and FIG. 50 show that the Right Conduit Positioning Solenoid 602 moves the Right Ascent Pathway Conduit 601 to the front (directly over where a canister exits the Fluid Column) and to the right-rear (out of the way of the Left Ascent Pathway Conduit 611). As shown in FIG. 47, Right Ascent Pathway Conduit 601 is “in the Fluid.”

Mounted on top of the Right Ascent Pathway Conduit 601 there are Two Right Ascent Adjustment EMs, 603 and 604. The EM Fields created by these Two EMs cause the canisters to be partially repelled away from the underside of the Right Ascent Pathway Conduit 601.

In FIG. 47, Canister C98 is shown to be ascending into the bottom portion of the Right Ascent Pathway Conduit 601.

Turning now to FIG. 49, Canister C98 is seen at the top of the Right Ascent Pathway Conduit 601 and is “floating up” into the Right Vertical Alignment Cone 605. This Alignment Cone 605 is firmly attached to the Two Vertical Structures (described below) by Four Right Vertical Alignment Cone Mounts 605M. These Four Cone Mounts are not referenced separately and only the Two Front Mounts are shown in FIG. 49. The Two Mounts on the left side of Alignment Cone 605 mount to the cone on the right and mount to the Right-side Short Vertical Support Wall 607 on the left. The Two Mounts on the right side of Alignment Cone 605 mount to the Cone on the left and mount to the Right-side Short Support Beam 606 on the right.

There is a Right-side Top Quadrilateral Guide Assembly 608. The left side of this Quad Guide Assembly 608 mounts directly to the Right-side Short Vertical Support Wall 607. There is a Horizontal Mounting Block 609 and this Mounting Block 609 attaches on the left to the Quad Guide Assembly 608 and attaches on the right to Right-side Short Support Beam 606. The Quad Guide Assembly 608 helps ensure a canister is exiting the Enlarged Uppermost Section of the Fluid Column 599 in such a way that the canister is in perfect vertical alignment with the Pivot Bucket of Front Pivot Bucket Assembly 621 (in FIG. 52). When a canister that has ascended through the Right Ascent Pathway Conduit 601 exits the Enlarged Uppermost Section of the Fluid Column 599, the canister exits through the Right-side Ascent Pathway Splash Guard 610. This Splash Guard 610 is permanently mounted on the right side of a modified Fluid Column Ceiling 254X; the modification to this Ceiling 254X is that Ceiling 254X is simply twice as wide as “original” Fluid Column Ceiling 254 to accommodate the left-side and right-side Canister Pathways in this Dual Pivot Bucket with Canister Ejection EM sub-embodiment

Turning now to FIG. 48, there is a Left Ascent Pathway Conduit 611 and this Conduit 611 is suspended by, and attached to the Left Conduit Positioning Solenoid 612. This Left Conduit Positioning Solenoid 612 is fixed in position by a Solenoid Mounting Harness (not shown; in FIG. 48 the rear portion of Positioning Solenoid 612 is “broken off”); this Mounting Harness for Positioning Solenoid 612 is the horizontal mirror image of Right Conduit Positioning Solenoid Mounting Harness 602MH. FIG. 48 and FIG. 50 show that the Left Conduit Positioning Solenoid 612 moves the Left Ascent Pathway Conduit 611 to the front (directly over where a canister exits the Fluid Column) and to the left-rear (out of the way of the Right Ascent Pathway Conduit 601). Left Ascent Pathway Conduit 611 is also “in the Fluid.”

Mounted on top of the Left Ascent Pathway Conduit 611 there are Two Left Ascent Adjustment EMs, 613 and 614. The EM Fields created by these Two EMs cause the canisters to be partially repelled away from the underside of the Left Ascent Pathway Conduit 611. In FIG. 48 a Canister C99 is shown to be ascending near the top of Left Ascent Pathway Conduit 611.

Turning now to FIG. 51, the Enlarged Uppermost Section of the Fluid Column 599 is shown. The thickness of the Walls for both the Enlarged Uppermost Section of the Fluid Column 599 and the “original” Fluid Column 320 are not shown; the purpose of showing the shape of these Two Fluid Column-related components in this drawing is to illustrate: a) how these two Fluid Column-related components are configured with regards to each other, and b) to show how other components are situated within the boundaries of the Enlarged Uppermost Section of the Fluid Column 599.

There is a Left Vertical Alignment Cone 615. This Alignment Cone 615 is firmly attached to the Two Vertical Structures (described below) by Four Left Vertical Alignment Cone Mounts 615M. These Four Cone Mounts are not referenced separately and only the Two Front Mounts are shown in FIG. 51. The Two Mounts on the left side of Alignment Cone 615 mount to the cone on the right and mount to the Left-side Short Vertical Support Wall 617 on the left. The Two Mounts on the right side of Alignment Cone 615 mount to the Cone on the left and mount to the Left-side Short Support Beam 616 on the right.

The Left-side and Right-side Short Vertical Support Walls, 617 and 607, respectively, are identical components, in that they have the exact same shape, are mounted in a vertical manner, and are mounted at the same height. They are Both mounted on, and attached to, the underside of the Ceiling of the Enlarged Uppermost Section of the Fluid Column 599. FIG. 51 shows that Left-side Support Wall 617 is mounted on the left side of the Left Pathway and Right-side Support Wall 607 is mounted on the left side of the Right Pathway. After rotating the entire configuration of components (shown in FIG. 51) counterclockwise 90 degrees, as described above, Left-side Support Wall 617 is positioned in the rear of the Rear Pathway (under Pivot Bucket Assembly 623) and Right-side Support Wall 607 is positioned in the rear of the Front Pathway (under Pivot Bucket Assembly 621).

The Left-side and Right-side Short Support Beam, 616 and 606, respectively, are identical components, in that they have the exact same shape, are mounted in a vertical manner, and are mounted at the same height. They are Both mounted on, and attached to, the underside of the Ceiling of the Enlarged Uppermost Section of the Fluid Column 599. FIG. 51 shows that Left-side Short Support Beam 616 is mounted on the right side of the Left Pathway and Right-side Short Support Beam 606 is mounted on the right side of the Right Pathway. After rotating the entire configuration of components (shown in FIG. 51) counterclockwise 90 degrees, as described above, Left-side Short Support Beam 616 is positioned in the front of the Rear Pathway (under Pivot Bucket Assembly 623) and Right-side Short Support Beam 606 is positioned in the front of the Front Pathway (under Pivot Bucket Assembly 621).

There is a Left-side Top Quadrilateral Guide Assembly 618. The left side of this Quad Guide Assembly 618 mounts directly to the Left-side Short Vertical Support Wall 617. There is a Horizontal Mounting Block 619 and this Mounting Block 619 attaches on the left to the Quad Guide Assembly 618 and attaches on the right to Left-side Short Support Beam 616. The Quad Guide Assembly 618 helps ensure a canister is exiting the Enlarged Uppermost Section of the Fluid Column 599 in such a way that the canister is in perfect vertical alignment with the Pivot Bucket of Rear Pivot Bucket Assembly 623 (in FIG. 52). When a canister that has ascended through the Left Ascent Pathway Conduit 611 exits the Enlarged Uppermost Section of the Fluid Column 599, the canister exits through the Left-side Ascent Pathway Splash Guard 620. This Splash Guard 620 is permanently mounted on the left side of a modified Fluid Column Ceiling 254X.

Turning now to FIG. 52, there is a Front Pivot Bucket Assembly 621 and a Rear Pivot Bucket Assembly 623. On the outside of Pivot Bucket for Pivot Bucket Assembly 621 there is a Front Pivot Bucket Canister Ejection EM 622. The description for a virtually identical component, Canister Ejection EM 276 (for Pivot Bucket 261 of the preferred embodiment; seen in FIG. 1L-2) was given above near the very end of the Structural Composition Section related to the preferred embodiment, specifically in the description for components shown in FIG. 1L-2. This Canister Ejection EM 622 creates an EM Field that helps “push” a canister out of the Pivot Bucket, after the Pivot Bucket has been rotated so that the Mouth of the Pivot Bucket is directly in line with Inclined Platform Sliding Canister Holder Section 625SLD (in FIG. 53). This Canister Ejection EM 622 initiates the EM Field when: a) the amount of rotation by the respective Rotational Solenoid (this Solenoid is shown but not referenced and functions as the horizontal mirror image to Rotational Solenoid 266 in the preferred embodiment) reaches a pre-determined Degree of Rotation, and b) after the Two Upper Pivot Bucket Stop-pins (that function exactly like 264L and 264R in the Rear Pivot Bucket Assembly 624) retract and create an opening in the Mouth of the Pivot Bucket for the canister to move through. More explanation about this procedure is given below in “13 Topics; #8, Pivot Buckets; sub-section Single Pivot Bucket operation.”

Also, at the same time the appropriate Canister Ejection EM (622 or 276) initiates its EM Field that will help push the canister out of the related Pivot Bucket, Top Cue Position Deceleration EM 626 initiates an EM Field that helps “pull the canister” out of the Pivot Bucket and onto Sliding Canister Holder Section 625SLD at a point when the canister has been partially ejected out of the Pivot Bucket and the magnet near the front of the canister comes within range of the EM Field that has been created by Top Cue Position Deceleration EM 626.

On Rear Pivot Bucket Assembly 623 there is a Canister Ejection EM 276. The operation of this Canister Ejection EM 276 has been described above and also works in exactly the same way as Front Canister Ejection EM 622, but the EM Field for Canister Ejection EM 276 is created according to a signal sent by Rotational Solenoid System 266; this Rear Pivot Bucket Assembly 623 has exactly the same components and works in exactly the same way as Pivot Bucket 261 from the preferred embodiment, shown in FIG. 1L and FIG. 1L-2. The Mounting Systems for the Two Canister Ejection EMs, 622 and 276, are not shown, but both of these Canister Ejection EMs fit very tightly around, and are permanently mounted (glued or otherwise attached) onto, the outside of the circular body the respective Pivot Bucket.

Turning now to FIG. 53, Inclined Platform Sliding Canister Holder Section 625SLD has all of the same components as used on Inclined Platform Top Canister Holder Section 625Ext (shown in FIG. 1N of the preferred embodiment), except Sliding Canister Holder Section 625SLD has: a) the ability to slide from front to rear and from rear to front, which is done by using a Slide Solenoid 628, Two Slide Rails 627, and Two cut-out areas that are directly above the tops of the Two Slide Rails 627 (Notes: these cut-out areas are not referenced and the Slide Rails are not referenced individually, and there are Three horizontal “Stop Positions” and movement of the solenoid is triggered by two specific components, where these components DO Not have this “triggering” function in the preferred embodiment). And b) there is a separation (an “air gap”) between Sliding Canister Holder Section 625SLD and Inclined Canister Holder 66. This description in this Structural Composition Section, related to FIG. 53 will only focus on these differences just described; a full description on all the other components on Inclined Platform Sliding Canister Holder Section 625SLD has previously been provided in the Structural Composition Sub-section about Single Pivot Bucket operations. (Note: Canister C2-Cue is in the same position as Canister C1-Cue, on Inclined Canister Holder 66, in FIG. 1N; Canister C2-Cue is physically shown differently than Canister C1-Cue, and therefore it has been given a different reference name.)

Sliding Canister Holder Section 625SLD is shown in between the Two Pivot Buckets (going from front to rear). As mentioned in Additional Drawing Exceptions and Comments #38, FIG. 53 shows Both Pivot Buckets (from FIG. 52) in a “rotated position,” where the respective canisters are about to be ejected out onto Sliding Canister Holder Section 625SLD. In actual operation of a MF device using the Dual Pivot Bucket sub-embodiment, only one Pivot Bucket would ever be ejecting a canister at any given time.

As explained below in the sixth paragraph of “13 Topics; #8, Pivot Buckets; sub-section Dual Pivot Buckets,” Sliding Canister Holder Section 625SLD has a total of Three Horizontal “Stop Positions,” which are: a) the “fully extended horizontal position,” where Sliding Canister Holder Section 625SLD is directly in front of the Front Pivot Bucket, b) the “partially extended horizontal position,” where Sliding Canister Holder Section 625SLD is positioned in front of (stationary) Inclined Canister Holder 66 (this position is shown in FIG. 53 and component “66” is in the lower left of the drawing), and c) the “fully retracted horizontal position,” where Sliding Canister Holder Section 625SLD is directly in front of the Rear Pivot Bucket. And of course, Sliding Canister Holder Section 625SLD slides back and forth from one of these “Stop Positions” to the next one, etc.

As shown in FIG. 53, there is an “air gap separation” (not referenced) to the left of Sliding Canister Holder Section 625SLD, and this “air gap” is between Sliding Canister Holder Section 625SLD and (stationary) Inclined Canister Holder 66. This “air gap” shows that Sliding Canister Holder Section 625SLD is not permanently attached to Inclined Canister Holder 66, but is instead free to move back and forth in front of and to the right of (stationary) Inclined Canister Holder 66.

In addition to the large cut-out portion (“625Cut” mentioned in the description for the preferred embodiment) in Sliding Canister Holder Section 625SLD there are also two other relatively small vertical cut-out areas, and these two cut-out areas are there so Sliding Canister Holder Section 625SLD can ride along on top of the Two Slide Rails 627 (not referenced individually). The Mounting System for these Slide Rails is not shown, but these Slide Rails can either: a) extend all the way down to the Above Ground Floor 61 (in FIG. 1A), or b) have “Mounting Legs” that extend all the way down to the Above Ground Floor 61. FIG. 53 shows how these cut-out vertical slots in Sliding Canister Holder Section 625SLD are positioned directly over the tops of the Two Slide Rails 627, and each Slide Rail fits up into one of these cut-out areas, and therefore this motion described above can smoothly take place.

Sliding Canister Holder Section 625SLD is pushed to the front and pulled to the rear by Slide Solenoid 628; this “628” reference includes both the Body of the Solenoid and the Plunger of the Solenoid. The Plunger of Slide Solenoid 628 is attached directly to the Rear side of Sliding Canister Holder Section 625SLD (this “point of attachment” is not shown). The rear end of Slide Solenoid 628 is “broken off” due to lack of space on the drawing page. Slide Solenoid 628 is firmly mounted to the Above Ground Floor 61 (or to Base Support Platform 65; see FIG. 1A) by Slide Solenoid Mounting Harness 628MH; the Two Legs of this Mounting Harness 628MH are shown “broken off” in the drawing. This Mounting Harness 628MH is curved at the top, and is positioned over and attached to the top half of Slide Solenoid 628.

As mentioned in the description for the preferred embodiment regarding FIG. 1N, where Canister Holder Section Exit Sensor 632 is concerned, this Exit Sensor 632 detects when a canister is moving from the Canister Holding Section (in FIG. 53 the proper name is Sliding Canister Holder Section 625SLD) onto Inclined Canister Holder 66. Specifically, Exit Sensor 632 first detects the Leading Surface of a canister (but no action is taken), and then detects the bottom surface of the canister. With regards to FIG. 53 and the Sliding Canister Holder Section 625SLD, when the bottom surface of a canister is detected by Exit Sensor 632, this means that the bottom surface of the canister has completely moved off of Sliding Canister Holder Section 625SLD and is now totally positioned on Inclined Canister Holder 66. At that point Exit Sensor 632 sends two types of signals. In the description for the preferred embodiment, the first signal was discussed, which causes the Two Retracting Solenoids to fully-extend upward and move the Two Ejection Impact Spring Assemblies up to their default positions, as shown in FIG. 53.

The second signal sent by Canister Holder Section Exit Sensor 632 goes to Slide Solenoid 628 and this Slide Solenoid 628 responds by moving the Sliding Canister Holder Section 625SLD to the “next” Pivot Bucket “Slot,” with regards to how the canisters are fed onto the Sliding Canister Holder Section 625SLD, by alternating a canister coming from Front Pivot Bucket Assembly 621 and then from Rear Pivot Bucket Assembly 623, etc. Movements of Canisters in a Cycle and How Equipment Functions over the Course of a Cycle Overview Comments.

In FIG. 15, all of the equipment shown is positioned in the “initial start-up position,” when the MF device is ready for the very First Cycle to begin. Also, for the beginning of every Cycle, the configuration for all the equipment is exactly the same as the configuration of the equipment shown in FIG. 15, except that the canisters change positions sequentially, to the left. A Cycle is: the completed journey a canister makes, by going from the starting position at the Drop Point 301 and moving counterclockwise around the entire overall MF device, and then eventually returning back again to the Drop Point, where that canister is then immediately ready to enter the next Cycle. Also in many cases, a name given to a piece of equipment may be designated more according to the area on the device where the component is located, rather than to describe what the component actually does. Use of the word “Fluid” can be taken to mean whatever fluid is being kept in the Fluid Column 320 to provide buoyancy for the canisters, as they go through the Floatation-ascent Phase 311 on the Fluid Side of the MF device. The Two Floatation Point Retaining Pins 245L and 245R are actually plungers of solenoids, so there is no additional interface (harness, mount, etc) between the Pins and the solenoids, like there is for most of these other solenoids (and plungers) on the device. The use of the capital letter combination “LM-” refers to a Linear Motor; there are a total of Four Linear Motors in the preferred embodiment of a MF device; LM-1 96, LM-2-Left 218L, LM-2-Right 218R, and LM-3 236. The 12 canisters in the system are designated with a “C-” in front of their individual numbers.

Other main pieces of equipment not shown in the “Sequence Diagrams” (FIGS. 15-20) are: Rear Drop Point Retaining Pin (directly behind 81F); Rear Inclined Platform Notch Pin (directly behind 88F); Rear Slowdown Plunger (directly behind 141PF); Rear Plunger Retracting Solenoid (directly behind 147F); Rear Plunger Back-end Stop-pin (directly behind 152PnF); Arc C Pre-launch; Speed-adjusting EM#2 195; Pivot Bucket Entry, Speed-adjusting EM#3 260; Pivot Bucket Rotational Solenoid 266 is not visible in any of the “Sequence Diagrams” because this Rotational Solenoid 266 is directly behind the Pivot Bucket 261, but there is a reference for this Rotational Solenoid 266 in all of the “Sequence Diagrams.”

### DEFINITION OF TERMS

Before beginning this “Cycle-sequence Description” Section, a few definitions of terms should be helpful.

Drop Point 301; is the exact spot where each canister begins a Cycle. The Drop Point is where the Two Drop Point Retaining Pins, 81F and 81R, make contact with the Leading Surface of a canister on the Far Left Side of the Inclined Platform 60.

Air Side Launch Area 302; includes all of the physical space and all of the equipment in an area that goes from (going down vertically) the bottom of the Above Ground Floor for the Inclined Platform 61, to the bottom of the Two Final Release Funnel-trays, 102F and 102R.

Final Release Point 303; is the center point (on the vertical axis) between the bottom surfaces of the Two Final Release Funnel-trays, when they are fully retracted. This point would actually be the center vertical axis of a canister and would intersect with the Leading Surface of the canister, just as the canister is beginning to start falling downward, when the Two Final Release Funnel-trays have pulled far enough apart so the canister can pass between the Two Funnel-trays (see FIGS. 4a-4d).

The canister changes direction as it slides over the Two Curved Arc A Pathway Guides 67F and 67R and after the canister moves to the left and down about two feet, at that point the canister will have attained True Vertical Alignment, heading downward. This precise moment when the canister attains True Vertical Alignment is the Official Beginning of the Drop Phase 304, and the canister is then beginning to fall straight down towards the Air Side Launch Area 302.

Drop Phase 304; the topmost point of the Drop Phase begins at the vertical point where the Leading Surface of a canister is when the entire body of that canister has come into True Vertical Alignment. This “beginning point” is really about the same for all canisters (give or take two or three millimeter) and occurs approximately at the point when the Leading Surface of a canister (the bottommost surface when the canister is pointing downward) is slightly below the bottommost point of Curved Arc A Pathway Guide 67F. The Drop Phase ends after a canister's bottom surface (as described above in this paragraph) has exited out of the bottom of the Bottom Coil in the Air Side Coil Stack 321BC (shown in FIG. 20) and has continued falling downwards and is making first contact with a Roller 122 on the Roller Conveyor 121 in the Arc B Area. (In other words, then end of the Drop Phase can be considered as: a) when the canister is exiting the Lowest Coil or b) when the canister has gone down further and is about ready to contact a Roller 122. The choice of “a” or “b” depends on whether the Drop Phase ends when no further electricity is being produced on the Air Side or if the Drop Phase ends when a canister is no longer in Free Fall and ascending downward with True Vertical Alignment.) However, the Drop Phase is really in two parts, because the downward motion of a canister is completely stopped by the Two Final Release Funnel-trays, 102F and 102R, so that the Air Side Launch can be performed, at which point the canister is again heading downward, but with more speed than before, due to the downward force of the Air Side Launch.

Arc B 305; this reference for Arc B 305 includes all of the physical space and all of the equipment in FIG. 1D. It is most natural to think of Arc B as the curved section of the Roller Conveyor 121, on the left side in FIG. 1D.

Slowdown Area 306; includes all of the physical space and all of the equipment between the Slowdown Plunger Tips 140F and 140R on the left, over to the right side of the Vertical Housing Structure for Both Back-end Stop-pin Solenoid Bodies 153 (shown in FIG. 1E).

Arc C 307; this reference for Arc C 307 includes all of the physical space and all of the equipment in the lower part of FIG. 1G, up to the top of the curved section of the Roller Conveyor 121 on the right side of the drawing. It is most natural to think of Arc C as the curved section of the Roller Conveyor 121, on the right side in FIG. 1G.

Pre-launch Area 308; includes all of the physical space and all of the equipment shown in FIG. 1H. The Arc C Horizontal Alignment Ring 193, the Arc C Pre-launch; Speed-adjusting Electromagnet (EM#2) 195, and the Two Sensors above and below EM#2 (194 and 196) might also be considered as part of the Pre-launch Area, especially because EM#2 and the Two Sensors play such a critical role in the Coupling Process. However, these components have “Arc C” names and are shown in FIG. 1G and not FIG. 1H.

Floatation Point 309; is similar to the Drop Point, only in reverse. The Floatation Point is the exact spot where each canister begins the Floatation-ascent Phase 311. The Floatation Point is where the Two Floatation Point Retaining Pins (245L and 245R) make contact with the Leading Surface of a canister, in the Underwater Launch Area 310. This exact (vertical) spot would be the underside of either of the Floatation Point Retaining Pins, 245L or 245R.

Underwater Launch Area 310; includes all of the physical space and all of the equipment in the lower portion of FIG. 1I, below the bottom surface of the Horizontal Extension 240 (an extension of the Vertical Mounting Structure 239).

Floatation-ascent Phase 311; the lowest point (the beginning) of the Floatation-ascent Phase 311 is at the Floatation Point 309; this Phase specifically begins when the Two Floatation Point Retaining Pins (245L and 245R) retract and allow a canister to begin ascending up towards the Fluid Side Coil Stack 322. The Floatation-ascent Phase ends when the bottom surface (this would be the “true” bottom surface since the canister is pointing upwards) clears the Splash Guard 253 that is mounted onto the Above Ground Floor 254; the underside of the Above Ground Floor 254 is also the Ceiling of the Fluid Column.

“Fly into the Air” Phase 312; begins precisely where the Floatation-ascent Phase 311 ends, as described in the previous paragraph. The “Fly into the Air” Phase ends when the Leading Surface of a canister makes contact with the underside of either of the Upper Pivot Bucket Stop-pins, 264L or 264R. However, contact by the Leading Surface of a canister with both of these Stop-pins, 264L and 264R, will happen simultaneously.

Pivot Bucket Area 313; includes all of the physical space and all of the equipment shown in FIG. 1L, starting at the bottom with the Pivot Bucket Area Speed and Motion Sensor 258 and ending at the top with the topmost part of the Pivot Bucket 261.

Hydraulic Accumulator Energy Recovery System (HAERS) 314; includes all of the equipment in FIG. 1E-2 and also includes: a) the Two Slowdown Plunger Systems (the Front and Rear Plungers and Bodies, 141PF, 141BF, 141PR, and 141BR), and b) the Two Hydraulic Pressure Lines, 154F and 154R.

Fluid Column Exit Point 315; is basically a circular hole carved out of the Above Ground Floor 254; the Splash Guard 253 sits over the top of this “hole,” at the Top of Fluid Column.

Pivot Point Swivel Assembly 316; includes everything shown in FIG. 13, except for the thin cross-sectioned parts (which are the Walls 261W of the Pivot Bucket 261).

Subterranean Floor 317; is the Floor shown in FIGS. 1D-1G. In the preferred embodiment, this Subterranean Floor 317 is the main floor at the bottom of the MF device and supports all of the equipment at that “bottommost horizontal level.” Even though this Subterranean Floor 317 is not mentioned in the related descriptions in this Sequence Diagram Section, the Subterranean Floor 317 reference is included in these “Sequence Diagrams” because all of the equipment shown in the lower portion of these “Sequence Diagrams” must be attached to something, on the bottom, and to omit the “317 reference” seemed to be inappropriate.

To continue this explanation about “Floors,” there is another Subterranean Floor 411 (for the Over-sized Embodiment). In the Over-sized embodiment, Subterranean Floor 317 does not really exist as it does in the preferred embodiment, because only a few Vertical Structural Beams on the far right of the overall MF device would need to be attached to the Subterranean Floor 317. However, the Fluid Reservoir Ceiling 427, on the right side of FIG. 1D-oz, is basically where the Subterranean Floor 317 would be. The “top side” of the Fluid Reservoir Ceiling 427 is actually the Subterranean Floor 317, which would be used on the far right side of the overall MF device to support the Vertical Beams shown in FIG. 1E-oz. On the far left side of the overall MF device, the Vertical Structural Beams that support the Air Side Coil Stack extend all the way down to the Subterranean Floor 411 (for the Over-sized Embodiment) and therefore no portion of the actual Subterranean Floor 317 would be used in the Over-sized embodiment. These “Extended” Air Side Coil Stack Vertical Support Beams are not shown in FIG. 1D-oz, but would come down from above FIG. 1D-oz and would be attached to the Subterranean Floor 411, somewhere on the left side of FIG. 1D-oz.

Mid-section of the Roller Conveyor 318; is all of the physical space and all of the equipment shown in FIG. 1F.

Designation for the Fluid Column 320; the reference 320 is the designation for the entire Fluid Column, which includes: a) all of the Walls (320W) and the bottom floor-like surface (Bottom Partition 230) that together comprise the boundaries for the fluid, b) the fluid, c) all of the equipment that is immersed in the fluid, and d) the physical space defined by the walls and floor-like surface of “a” above.

Air Side Coil Stack 321; the topmost point of the Air Side Coil Stack 321 is the top of the Top Coil in the Air Side Coil Stack 321TC. This Coil is shown in FIG. 20. The ending point of the Air Side Coil Stack is the bottom surface of the last Coil a canister passes through before encountering the Roller Conveyor 121, in the Arc B Area. This “Bottom Coil” is 321BC and is also shown in FIG. 20. Any reference to the Air Side Coil Stack also includes: a) the physical space taken up between the two points just described, and b) any and all equipment in that physical space, such as Coils, Alignment Rings, Mounting Hardware, Structural Support Beams, etc.

Top Coil in the Air Side Coil Stack 321TC; is the first Coil below the Air Side Launch Area 302 (is directly below Alignment Ring 104).

Bottom Coil in the Air Side Coil Stack 321BC; is the last Coil a canister passes through before encountering the Roller Conveyor 121 (in the Arc B Area).

Fluid Side Coil Stack 322; the bottommost point of the Fluid Side Coil Stack 322 is the bottom surface of the first (lowest) Coil a canister encounters when after leaving the Floatation Point 309, heading upwards. This Bottom Coil 247Lwr is shown in FIG. 1I. The ending point of the Fluid Side Coil Stack 322 is the top surface of the last Coil a canister passes through before exiting the Fluid Column (and then passing through the Splash Guard 253 at Top of Fluid Column). This Top Coil 250e is shown in FIG. 1J. Any reference to the Fluid Side Coil Stack also includes: a) the physical space taken up between the two points just described, and b) any and all equipment in that physical space, such as Coils, Alignment Rings, Mounting Hardware, Structural Support Beams, etc.

Top Coil in the Fluid Side Coil Stack 250e; is actually the Last Coil in the Floatation-ascent Phase 311. This Top Coil 250e is the first Coil below the Splash Guard 253 at Top of Fluid Column.

Bottom Coil in the Fluid Side Coil Stack 247Lwr; is the first Coil a canister encounters in the Floatation-ascent Phase 311.

The Coupling Process is fully described below (see 13 Topics; #1, “Coupling Process”), but briefly the Coupling Process is when one moving canister comes up underneath one stationary canister, in the Pre-launch Area, and as a result both canisters move up a few inches (due to the momentum of the Lower Canister) and then both canisters fall back down a few inches. During the time these Two Canisters “move up” those few inches, the Two Halves (211L and 211R) of the Pre-launch Launch Platform have the time to move into position below the bottom surface of the Lower Canister.

The Pre-launch Process is fully-described below (see 13 Topics; #2, “Pre-launch Process”), but briefly the Pre-launch Process occurs immediately after the Coupling Process. The Pre-launch Process vertically repositions the Two Canisters that were involved in the Coupling Process, so that the Lower Canister becomes the Upper Canister and the Upper Canister is moved fully “into the Fluid” and that canister “floats up” a few inches so that the Leading Surface of that canister is resting directly underneath, and making contact with (the underside of) the Two Floatation Point Retaining Pins (245L and 245R). Because this canister has “floated up” those few inches, the Underwater Launch Platform can be positioned under the canister so that an Underwater Launch can occur.

The Underwater Launch is fully-described below (see 13 Topics; #3, “Underwater Launch Process”), but briefly the Underwater Launch occurs when the Two Floatation Point Retaining Pins 245L and 245R retract, thus opening up the Floatation Pathway so a canister can ascend through the Floatation-ascent Phase 311. At the instant when the Two Retaining Pins 245L and 245R retract, the canister instantly starts to “float up” under its own power, but simultaneously the canister is also “Launched” in a process whereby Linear Motor-3 236 provides a strong upward thrust to the canister (this upward thrust is actually applied to the canister by the Launch Platform 233).

This LM-3 236 is permanently situated and totally operates “inside the fluid” (underwater, if water is used as the Fluid).

### Sequence Diagrams; Cycle-sequence Descriptions

FIG. 15; Shows the start-up position of the equipment when a MF device is put into operation for the very first time, and also this configuration of equipment will occur at the beginning of every Cycle, but the positions of the canisters will change (as in FIG. 20).

On the Inclined Platform 59: Drop Point Retaining Pins 81F (and 81R) are fully extended and are holding Canister #1 on the Inclined Platform, keeping it from falling off the Inclined Platform to the left. [Note, the combined downward force (of gravity) from all canisters on the Inclined Platform, C-1 through C-10, is Not being felt by these Two Drop Point Retaining Pins 81F (and 81R) because there is an Air Gap 79 between the Two Canisters that are in the #1 Position and the #2 Position (see FIG. 1A-2).] Inclined Platform Notch Pins 88F and 88R are fully extended into the Notch of Canister #2 and these Notch Pins 88F and 88R are holding back Canister #2 (and all other canisters above it and to the right) and are keeping all those canisters (C-2 through C-10) from moving downwards and to the left on the Inclined Platform.

In the Air Side Launch Area 302: Air Side Launch Platform 93, LM-1 96 and LM-1 Positioning Solenoid 99B are all in the “retracted state” so a canister can pass through this Downward Pathway to reach the Final Release Point 303. The Two Final Release Funnel-trays 102F and 102R are pushed in tight next to each other (to catch Canister #1 when it falls onto them); this means the Two Funnel-tray Retracting Solenoids 103F and 103R are fully extended-out.

Slowdown Area 306: The Two Slowdown Plungers 141PF (and 141PR; the rear Slowdown Plunger is not shown because it is behind the front one) are fully extended out to the left and are ready to absorb kinetic energy from Canister #1, when Canister #1 arrives in the Slowdown Area 306. Plunger Retracting Solenoids 147F (and its Rear Counterpart) are fully extended out so that the Two Slowdown Plungers WILL be in the path of Canister #1 when the canister enters the Slowdown Area 306. The Two Plunger Back-end Stop-pins 152PnF (and 152PnR; the rear Stop-pin, 152PnR is not shown; it is directly behind the Front Stop-pin 152PnF) are extended up and are fitting into the vertically concave contoured shape on the back (far right-end surface) of each Slowdown Plunger (see FIG. 1E). The Hydraulic Accumulator Energy Recovery System (HAERS) 314 is charged at a “default” pressure level. This level of pressure is just enough to “reset” the Two Slowdown Plungers 141PF and 141PR. This “resetting process” means there is just enough pressure in the overall Hydraulic System to push the Two Plungers back all the way to the left, after these Two Plungers have been engaged by a fast-moving canister and have been pushed to the right, and have moved deep inside the Two Respective Plunger Bodies (see Cycle-sequence Descriptions; FIG. 19, “Slowdown Area 306”).

Pre-launch Area 308: The Two Pre-launch Launch Platform Halves 211L and 211R (each is one-half of the overall circular shape; see FIG. 11) are pressing tightly against each other; this means the Two LM-2 Positioning Solenoids 216BL and 216BR are fully extended out. The Two Linear Motors (LM-2s), 218L and 218R have their Forcers reset to the bottommost point of their vertical movement and both LM-2 Systems are ready to provide Upward Force to Canister #11 and Canister #12 at the same time. The actual “point of application” of this upward Force will be made by the Pre-launch Launch Platform on the bottom surface of Canister #11 (C-11). Canister #11 is resting on the Two (Unified) Launch Platform Halves 211L and 211R, and these Two Launch Platform Halves are directly connected to the respective Forcers of the Two (right and left) Linear Motors. The Two Notch Grips 219F and 219R (Rear Notch grip 219R is not shown; it is directly behind 219F; see FIG. 1H) are in the extended mode and are making light contact with the Notch on Canister #12 (C-12), and the purpose of this contact is to keep Canister C-12 in proper horizontal alignment, thus keeping the Primary Seal 232 from having to do any horizontal alignment work. The Two Suspension Support Rods 227L and 227R are in the retracted mode and are therefore out of the way, so the (Unified) Pre-launch Launch Platform can elevate with no obstructions and can perform a successful Pre-launch operation at the proper time.

Canister C-12 is sticking up through the “hole” in the bottom surface of the Fluid Column 320; depending on the length of a canister, this Extended Distance (distance the upper portion of a canister sticks up “into the Fluid” and above the Primary Seal 232) is about four inches, or approximately 15% of the length of the cylindrical body of a canister. The Inner Lip of the Primary Seal 232 is “sealed” all the way around the body of Canister C-12 by: a) the natural shape and size of the Primary Seal, which is made to fit snugly around the cylindrical body of a canister, and b) the force of Fluid Pressure that is being exerted on the outer side of the Primary Seal, causing the upper side (the exposed side) of the Lip of the Primary Seal to firmly press against the cylindrical body of Canister C-12. These factors ensure that No Fluid leaks out of the Fluid Column. Despite all the “fancy equipment and elaborate processes” used in this MF device, without this simple, stationary piece of circular rubber working properly as a result of the most basic principles (a rubber shape that is cut the right way to “fit snugly” against the body of a canister and inherent constant pressure being applied to that rubber shape by fluid at a depth), the whole MF system will immediately shut down.

Underwater Launch Area 310: Underwater Launch Platform 233, LM-3 236 and LM-3 Positioning Solenoid 238B are all in the “retracted state,” and therefore Canister #12 will be able to “pass in front of” the Underwater Launch Platform and move freely up to the Floatation Point 309, when the time comes. (By definition, the Floatation Point 309 is the beginning point for the Floatation-ascent Phase 311.) The Two Floatation Point Retaining Pins 245L and 245R are extended out, for the purpose of stopping Canister #12 from floating up and out of the Underwater Launch Area before the Underwater Launch can occur.

[Note about the Pivot Bucket: the Pivot Bucket 261 is Not a closed container; the upper and lower surfaces of the Pivot Bucket are basically non-existent; these surfaces are nothing more than “holes” except for the walls of the Pivot Bucket (see Cycle-sequence Descriptions; FIG. 18, “Pivot Bucket Area 313”).]

Pivot Bucket Area 313: The Two Upper Pivot Bucket Stop-pins 264L and 264R (which stop further ascent by a “Flying Canister”) are fully extended so that these “Pins” can make contact with the Leading (upward) Surface of Canister #12 after this canister has entered the Pivot Bucket from the bottom of the Pivot Bucket. The Two Lower Pivot Bucket Stop-pins 263L and 263R (which stop a canister from falling downward out of the bucket) are in the retracted state to allow Canister #12 (which will be ascending “through the air”) to pass in front of these “Pins,” so that Canister #12 can fully enter the Pivot Bucket from the bottom of the Pivot Bucket. The Pivot Point Swivel System 316 is directly attached to the Pivot Bucket Rotational Solenoid 266, but Solenoid 266 is not shown because it is behind the Pivot Bucket 261 (see FIG. 14). The Pivot Point Swivel System 316 is in the “default” state, which is a condition where the Pivot Bucket is pointing straight upwards.

FIG. 16 [Note: there is an entire Section on “How the Equipment on the Left Side of the Inclined Platform Works” (see 13 Topics; #4, “Equipment on the Left Side of the Inclined Platform”), which details all of the rather complex interactions between Four Deceleration Electromagnets, 3 Sensors, Four Mounted Spring Systems and Two Sets of Retracting Pins.];

On the Inclined Platform 59: Drop Point Retaining Pins 81F (and 81R) have retracted to allow Canister #1 to move past the Drop Point 301. As the back end of Canister #1 totally cleared the Two Retaining Pins, 81F and 81R, Inclined Platform Notch Pins 88F (and 88R) retracted and allowed the entire cue of nine canisters to begin moving down and towards the left. The Drop Point Retaining Pins 81F (and 81R) have reset themselves by fully extending back to their original position; this has occurred after the back surface of Canister #1 cleared these Retaining Pins to the left. Inclined Platform Notch Pins 88F and 88R are about ready to extend and engage themselves into the Notch of Canister #3; when that happens everything will look almost the same as it was (in FIG. 15), except that all canisters will have “moved down and to the left” one position and there will be a Vacant Canister Position where Canister #10 was (in FIG. 15).

In the Air Side Launch Area 302: Canister #1 has fallen as far as it could, until it was “caught” by the Two Final Release Funnel-trays 102F and 102R; their Spring Systems have absorbed the “shock” of the contact (and the rate of fall was reduced by Air Side Launch Area; Speed-adjusting EM#1 92; see FIG. 1B and see 13 Topics; #10, “Speed-adjusting Electromagnets”). After the Back-end (the topmost surface) of Canister #1 has cleared (going downward) the bottommost point of Air Side Launch Platform 93, LM-1 Positioning Solenoid 99B has extended out, pushing LM-1 96 and the connected Air Side Launch Platform 93 over to the left; Launch Platform 93 is now centered over the bottom surface (topmost surface because the canister is facing downward) of Canister #1 and Launch Platform 93 is ready to launch Canister #1 downward, powered by the downward force of LM-1 96.

Slowdown Area 306: NO CHANGE

Pre-launch Area 308: [Note: there is a very big difference between the speeds of the Linear Motors. LM-2-Left 218L and LM-2-Right 218R obviously move at the same speed, because each “half of the overall pre-launch system” is pushing up on one half of a Pre-launch Launch Platform where both sides of the overall Platform are interlocked with each other (see FIG. 1H-3), but when comparing the speeds of the “LM-2 Pair” and LM-3 236, these speeds are greatly different. An analogy is the space shuttle launch; one system moves the rocket out to the launch pad (and moves a few feet per hour because there is no specific hurry to get the rocket to the launch pad) and the other system launches the rocket at thousands of miles per hour. On the MF device, the Two LM-2s, 218L and 218R, operate in the Pre-launch Process to “casually” vertically position a Lower Canister to move into the vertical position where the Upper Canister was at before the elevation process started; as an inherent benefit of the end result of the Pre-launch Process, what was the Upper Canister enters a floatation state and ascends to a point where that canister is ready for an Underwater Launch by LM-3. There is no specific “need for speed” in the Pre-launch Process.]

The Pre-launch Process has been performed, which started by the Two Notch Grips 219F and 219R retracting out of the Notch of Canister C-12 to prepare the way for the Pre-launch Process to begin. Following that, the Two LM-2s, 218L and 218R, have moved the Two Identical Launch Platform Halves, 211L and 211R upwards, which has also moved Canister #11 and Canister #12 upward, and the distance these Two canisters moved is exactly far enough so that the bottom surface of Canister #12 has moved out (going upwards) of the Primary Seal 232. The precise stopping point for the Pre-launch Process positions Canister #11 in the same exact vertical position Canister #12 was at in FIG. 15 (Sequence Diagram #1, before the start of the Pre-launch Process). Therefore, Canister #11 now has its leading portion sticking up above the Primary Seal 232 “into the Fluid” (about four inches) and the vertical location of the Notch of Canister #11 is perfectly aligned so that this Notch is sitting directly in front of the Two Notch Grips 219F and 219R, and these Two Notch Grips have been extended out to engage into the Notch of Canister #11. However, these Two Notch Grips at this point are only putting light horizontal pressure on the Notch of Canister #11 to keep it in proper horizontal alignment. The Two Suspension Support Rods 227L and 227R are also extended out, and each of these Support Rods has been moved in underneath the bottom surface of Canister #11. It is these Two Suspension Support Rod components that are providing the vertical support for Canister #11.

Immediately after the Two Suspension Support Rods have moved into the proper position underneath the bottom surface of Canister #11, the Two LM-2s have repositioned themselves (repositioned their respective Forcers; see FIG. 1H) so that these Two Forcers (212R and its Left-side Counterpart) are at the bottommost vertical point for each of the two respective Linear Motors. This bottommost point is the “default/reset” position for the Forcers and is the vertical position the Two Forcers were at before the start of the Pre-launch Process. Also, once the Two Forcers were moved to that bottommost vertical default position, the Two Pre-launch Positioning Solenoids (216BR and 216BL) retracted and pulled the Two Halves of the Pre-launch Launch Platform (211L and 211R) “out of the way,” so that in a few seconds Canister #1 will have a clear vertical passageway to move though and will be able to perform the Coupling Process with Canister #11.

Underwater Launch Area 310: At the precise moment when Canister #11 is stopped by the Notch Grips (in the Pre-launch Area 308), Canister #12 separates from Canister #11 because of the force of buoyancy acting on Canister #12 (in the Underwater Launch Area 310). When the bottom surface of Canister #12 moves above the top surface of Canister #11, Fluid rushes in under that bottom surface of Canister #12 and with considerable force tries to push the canister upward. But Canister #12 is only allowed to move upwards a few inches before the upward motion of this canister is totally stopped by the Two (extended) Floatation Point Retaining Pins 245L and 245R; these Two Retaining Pins, 245L and 245R, remain in the extended position. Once the bottom surface of Canister #12 has moved higher than the topmost point of the Underwater LM-3 Launch Platform 233, the LM-3 Positioning Solenoid 238B has extended, thereby moving LM-3 236 and the Underwater LM-3 Launch Platform 233 to the left, so that the Underwater Launch Platform is directly under the bottom surface of Canister #12. The entire LM-3 Launching System is ready to make the Underwater Launch.

Pivot Bucket Area 313: NO CHANGE

FIG. 17.

On the Inclined Platform 59: The nine canisters on the platform have moved into the exact position they need to be in to start the next Cycle. Canister #2 is now in the First Canister Position, all the other canisters have moved down one position to the left, and all equipment on the Inclined Platform is in the “reset” mode. There is still one open spot for a canister, at the top of the Inclined Platform where Canister #10 was in the beginning (in FIG. 15).

In the Air Side Launch Area 302: In a coordinated process, the Two Funnel-tray Retracting Solenoids 103F and 103R have retracted, thus causing the Final Release Funnel-trays 102F and 102R to separate. During this process the Two Funnel-trays kept retracting more and more at a moderate speed (FIGS. 4a-4d), until the Two Trays finally reached full separation over the period of approximately one second. While this process was occurring, the Two Spring Systems, 102SpF and 102SpR (which are attached to the top of the Two Funnel-trays) and other parts of the “body” of the Funnel-trays, were making contact at multiple points with the Leading Surface of Canister #1.

Near the end of the “separation process,” Canister #1 fell down into the “funnel area” and then at some point the Funnel-trays moved so far apart from each other that Canister #1 fell entirely through the opening created by the Funnel-trays being pulled apart. It was at that point the High-speed LM-196 thrust the Air Side Launch Platform 93 downward. (LM-1 knows exactly when to perform the Air Side Launch according to the exact distance the Funnel-trays have been pulled apart from each other.)

During this Air Side Launch, the Launch Platform 93 was moving downward with far greater speed than Canister #1 was falling on its own, because the canister was just beginning its fall and had virtually no downward momentum when the Launch Platform 93 made contact with the bottom surface of Canister #1 (the topmost surface because the canister was pointing downward). LM-1 96 and the Air Side Launch Platform 93 provided substantial initial downward velocity to Canister #1 and this velocity was used throughout the entire fall through the Drop Phase 304, so additional electricity was generated in each Coil in the Air Side Coil Stack 321. (In fact, in the preferred embodiment, by using this “Air Side Launch” process the speed of a “falling” canister can be increased by about 26% for the overall Drop Phase 304; specifically, this percentage increase exists for a sixty foot drop if the added velocity (by the Air Side Launch) is 15 mph. Furthermore, this 26% increase in speed increases the amount of electricity generated in the Drop Phase 304 by about 36%. A similar scenario exists with regards to the Underwater Launch and the respective Floatation-ascent Phase 311). It should be noted that Canister #1 has fallen through an approximately 60 foot drop (moved through the entire Drop Phase 304) and altogether Canister #1 was able to reach the Arc B Area in less than two seconds, starting from the time the bottom surface (uppermost surface) of the canister cleared the bottom of the Two Funnel-trays.

The moment LM-1 96 terminated its downward thrust, the Air Side Launch ended and then immediately Three “resetting procedures” took place in the Air Side Launch Area 302. First, the Two Funnel-tray Retracting Solenoids 103F and 103R extended outward towards each other and essentially “closed” the Two Funnel-trays, by moving them tightly next to each other in the “reset” mode. Second, the Forcer of LM-1 96 was reset by the internal action of LM-1 96, itself, so that the Forcer was moved up to the highest position possible; this also caused the Air Side Launch Platform to move to the highest position possible, which is the “reset” position. Third, the LM-1 Positioning Solenoid 99B retracted, thus pulling LM-1 and the connected Air Side Launch Platform 93 back to the right to the “reset” mode, so the Air Side Launch Platform 93 will be out of the way for the next canister to fall all the way down to the Final Release Point 303 (a canister that is at the Final Release Point 303 has its Leading Edge resting on the Spring Systems, 102SpF and 102SpR, of Funnel-trays 102F and 102R; see 13 Topics; #9, “Springs Absorb Shock, Section B” for a deeper description of what these “102 Springs” actually do).

Slowdown Area 306: NO CHANGE

Pre-launch Area 308: NO CHANGE; Canister #11 is in the position that Canister #12 was in (see FIG. 15) and Canister #11 is waiting for Canister #1 to come up underneath it and “couple” with it.

Underwater Launch Area 310: At the same time LM-1 was launching Canister #1 downward into the Air Side Coil Stack, LM-3 236 was launching Canister #12 upwards into the Fluid Side Coil Stack. These Two “Launching Procedures” are almost the same, only are done in opposite directions and with slightly different kinds of equipment. Canister #12 has buoyancy and also has a second upward accelerating force, the “Canister Length Pressure Differential Force” (see Brief Summary; Par. 7, “CLPDF”). This CLPDF is about Nine Times greater than the “NET” buoyancy force Canister #12 has (as explained above in: “D” of the Canister Section of Additional Technical Discussions about the MF Device). At the instant the Two Floatation Point Retaining Pins 245L and 245R retracted and moved out of the way of the canister's upward path, Canister #12 began “launching itself,” being pushed upward by its own Two Upward Forces just described. But the speed of the upward motion of LM-3 236 is far greater than the upward speed a canister has on its own at the beginning of the Underwater Launch, before these Two Accelerating Forces just mentioned have had time to begin propelling the canister upwards.

So at exactly the same time Canister #12 had begun moving upward on its own power (the instant the Two Floatation Retaining Pins retracted far enough to let Canister #12 pass through the opening created by the “Pins” retracting), the LM-3 Launching System made contact with the bottom surface of the canister and provided much more upward kinetic energy (velocity) to the ascending canister. This additional velocity provided by LM-3 236 was used throughout the entire Floatation-ascent Phase 311 and caused additional electricity to be generated in each Coil in the Fluid Side Coil Stack 322. (See similar discussion five paragraphs above for an Air Side Launch.) This additional velocity will also contribute to Canister #12 reaching a greater height during the “Fly into the Air” Phase 312, which will occur after Canister #12 exits out of the Fluid Column 320, at the top Exit Point 315 (of the Fluid Column).

The moment that LM-3 236 terminated its upward thrust, the Underwater Launch ended and then immediately Three “resetting procedures” took place in the Underwater Launch Area 310. First, the Solenoids of the Two Floatation Retaining Pins, 245L and 245R fully extended out, which positioned the Two Pins 245L and 245R directly in the “Floatation Path” that Canister #11 will be trying to move through. Therefore, these Two “Pins” will be able to block Canister #11 from floating upwards and out of the Underwater Launch Area, when Canister #11 arrives in the Underwater Launch Area. Second, the Forcer of LM-3 236 was reset by the internal action of LM-3 236, itself, so that the Forcer was moved down to the lowest position possible; this also caused the Underwater Launch Platform 233 to move to the lowest position possible, which is the “reset” position. Third, the LM-3 Positioning Solenoid 238B retracted, thus pulling LM-3 236 and the Underwater Launch Platform 233 back to the right to the “reset” mode, so the Underwater Launch Platform 233 will be out of the way for the next canister to ascend all the way up to the Floatation Point 309. Canister #11 still has its upper portion sitting in the Primary Seal 232, so no Fluid is leaking out of the Fluid Column.

Pivot Bucket Area 313: NO CHANGE

FIG. 18.

On the Inclined Platform 59: NO CHANGE

In the Air Side Launch Area 302: NO CHANGE

Slowdown Area 306: Canister #1 has moved through Arc B 305 and is at the point where its Leading Edge is making initial contact with the Two Slowdown Plunger Tips 140F (and 140R; see FIG. 1E, which shows these Two Slowdown Plunger Tips).

Pre-launch Area 308: NO CHANGE

Underwater Launch Area 310: NO CHANGE

Pivot Bucket Area 313: Initially, the Two Lower Pivot Bucket Stop-pins, 263L and 263R were retracted, so Canister #12 had a clear pathway to enter into the Pivot Bucket 261 through the bottom of the Pivot Bucket. Canister #12 has finished its extremely rapid ascent through the Fluid Column, has shot out of the Splash Guard 253 that sits on the top of the Fluid Column at the Exit Point 315 (see FIG. 1J), and has kept climbing approximately 15 to 20 feet, going through the “Fly into the Air” Phase 312 (this distance varies depending on the exact canister configuration used and the exact height of the Fluid Column).

In the preferred embodiment, the magnet inside a canister may weigh about 45 pounds, so for a canister to travel upwards 15-20 feet in the air, with only the Exit Momentum (when coming out of the Fluid Column) to propel that canister upward, means the canister's ascent through the Floatation-ascent Phase 311 was extremely rapid and powerful. Somewhere close to the vertical point where the ascent of Canister #12 peaked (where the canister had exhausted all of its upward kinetic energy), the canister made contact with the fully extended Upper Pivot Bucket Stop-pins 264L and 264R, whose purpose it is to stop a canister from ascending any further, once a canister makes contact with these Two Stop-pins 264L and 264R. Also: a) the MF device has been designed, through the process of making Test Runs, so that the uppermost portion of the Pivot Bucket 261 (the area where the Upper Pivot Bucket Stop-pins are located) is at a vertical position about equal to the “absolute maximum height” the Leading Edge of a canister will reach, before the canister loses its momentum and starts falling backwards towards the ground, and b) the speed at which a canister will enter the Pivot Bucket is “tweaked” by Pivot Bucket Entry; Speed-adjusting EM#3 260. (This Speed-adjusting EM#3 260 is not shown in any of the Six Sequence Diagrams; see FIG. 1L; more information on this sub-process is given near the end of: 13 Topics; #9, “Springs Absorb Shock, Sub-section D”).

Once the Leading Edge of Canister #12 made contact with the Two Upper Pivot Bucket Stop-pins: a) the Two Individual Springs (271SpUL and its Right-side Counterpart) working within the Two Upper Stop-pin Systems 264L and 264R absorbed all of the additional upward force the canister had, and b) the compression of the Spring System 271SpUL in the Stop-pin System 264L was monitored by a Pressure Gauge 275 attached to Spring 271SpUL and at the instant when this Spring 271SpUL was compressed by a pre-determined minimal amount, an identical electronic signal was sent to each of the Two Lower Pivot Bucket Stop-pins 263L and 263R, causing each of their Solenoids to extend out and push these Two Stop-pins, 263L and 263R (from the left and from the right, respectively) directly into the Vertical Pathway that the bottom surface of Canister #12 would be moving along, once the Two Respective Springs (271SpUL and its Right-side Counterpart) decompressed. In other words, because the Two Lower Stop-pins 263L and 263R were fully extended, they now had the ability to stop Canister #12 from falling out of the bottom of the Pivot Bucket. At the same time these two identical signals were sent, another signal was sent by Pressure Gauge 275 to Rotational Solenoid 266. This signal caused Rotational Solenoid 266 to begin rotating the entire Pivot Bucket towards Inclined Platform 59.

Canister #12 reached the top of its ascent, was stopped by the Two Upper Pivot Bucket Stop-pins from ascending any further, and then Canister #12 fell back down towards the ground a few inches, but was stopped from falling any further (stopped from falling out of the Pivot Bucket) by the Two Lower Pivot Bucket Stop-pins, 263L and 263R. Each of these Two Lower Pivot Bucket Stop-pin Systems, 263L and 263R, has a Spring (271SpLL and its Right-side Counterpart, respectively; the reference for this “271SpLL” is in FIG. 1L-2), which is UNDERNEATH the respective “263 Stop-pin System Solenoids.” At the point when Canister #12 made initial contact with the Lower Stop-pins, 263L and 263R, the Two Springs (271SpLL and its Right-side Counterpart) in the Lower Stop-pin Systems, 263L and 263R, respectively, began absorbing all the additional DOWNWARD force the canister had and therefore the Two Springs, 271SpLL and its Right-side Counterpart, compressed.

But then these Two Springs immediately decompressed, which sent Canister #12 moving upward again with limited-and-reduced force (the canister did not exactly move “upward” because the entire Pivot Bucket was being rotated by the time the Springs in the Two Lower Pivot Bucket Stop-pin Assemblies were decompressing). After one or two times of Canister #12 making such contacts with these Lower Stop-pins 263L and 263R (after Canister #12 bounced up and down a little), Canister #12 stopped “bouncing around” inside the Pivot Bucket. To recap about the Spring configuration, the Two Individual Springs (left and right) for the Two Upper Pivot Bucket Stop-pin Systems 264L and 264R are ABOVE these Two Upper Stop-pins to absorb Upward canister motion and the Two Individual Springs (left and right) for the Two Lower Pivot Bucket Stop-pin Systems 263L and 263R are BELOW these Two Lower Stop-pins to absorb Downward canister motion.

FIG. 19.

On the Inclined Platform 59: NO CHANGE

In the Air Side Launch Area 302: NO CHANGE

Slowdown Area 306: Canister #1 has moved totally through-and-out-of the Slowdown Area 306. The process that occurred as that happened is as follows. Canister #1 was traveling at an extremely high speed (37-38 mph) when the canister made its initial contact with the Two Slowdown Plunger Tips 140F and 140R (shown in FIG. 18). The entire movement of the canister to fully compress the Two Slowdown Plungers takes a fraction of a second, but during this time the forward movement of the canister is being opposed by a back-pressure which: a) initially exists as a “pre-loaded” pressure from the Hydraulic Accumulator System being in its default state (before any contact is made between a canister and the Slowdown Plunger Tips), but b) then this back-pressure increases in proportion to how much additional pressure is being added into the Hydraulic System.

Put another way, before contact between the canister and the Slowdown Plungers Tips is finished, the effect of all the combined back-pressure during the “contact period” will have produced two results. First, the speed of the canister will have been dramatically reduced. Second, the Hydraulic Accumulator Energy Recovery System 314 will have converted the majority of the kinetic energy of the canister into a much higher level of Fluid Pressure (compared to the “default pressure” level of the Hydraulic Accumulator System) and all of this additional Fluid Pressure will be stored in the Hydraulic Accumulator 156 (in FIG. 1E-2); the Hydraulic Accumulator is one component of the HAERS 314. This Speed Manipulation Process is done in an exact and precise manner so that Canister #1 will reach the Pre-launch Area 308 in such a way that the speed of Canister #1 will not be “too fast” or “too slow.”

In addition, as the Leading Edge of the canister has made contact and “moved against” the Tips 140F and 140R of the respective Slowdown Plungers, any tendency of the Slowdown Plungers to be pushed “out of the way” by the fast-moving canister was counteracted by two stationary forces. First, each Slowdown Plunger 141PF and 141PR is perfectly fitted into a larger Plunger Body, 141BF and 141BR, respectively. Each of these Two Plunger Bodies is solidly attached (by a large Harness that has Multiple Arms; see FIG. 1E) to a Plunger Retracting Solenoid 147F (and its rear Retracting Solenoid Counterpart, not shown). Both of these Plunger Retracting Solenoids are immovable, except for their motion in the horizontal plane to retract and extend, so the Slowdown Plunger Systems 141PF/BF (and 141PR/BR) will not be moving sideways while each of the respective Plunger Tips, 140F and 140R, is in contact with the high-speed canister.

Second, at the far right of the Plunger Bodies (141BF and 141BR) for each of the Two Slowdown Plunger Systems, there is a Slowdown Plunger Back-end Stop-pin, 152PnF and 152PnR, for each Plunger Body (shown over to the right in FIG. 1E) and while contact is occurring between a canister and the Two Slowdown Plungers, these Two Back-end Stop-pins, 152PnF and 152PnR, are extended up to a point that goes higher than the end surface of the respective Slowdown Plunger Bodies. (The Stop-pins, themselves, are actually Plungers of the Two Respective Solenoids, 152BF and 152BR.) Carved out of the back-end (the far right end) of each of the Two Slowdown Plunger Bodies, there is a vertically concave contoured shape that has the exact diameter as the diameter of a “152 Stop-pin,” for example, 152PnF (FIG. 1E shows these “contoured shapes” directly to the left of Stop-pins 152PnF and 152PnR). These Two “152 Stop-pins” are engaged into these respective contoured shapes during the time a canister is making contact with the Two Slowdown Plunger Tips, 140F and 140R. Upon receiving a signal from the Hydraulic Accumulator Energy Recovery System, these Two “152 Stop-pins” instantaneously retract (are pulled downward by their respective solenoids) and these Two Individual “152 Pins” move totally out of the way of the oncoming canister.

These Two Back-end Stop-pins are there to provide another level of “resistance against sideways motion” for the Slowdown Plungers and to supplement the stationary forces being supplied by the (immovable) Plunger Retracting Solenoids 147F (and its Rear Counterpart). These Two Back-end Stop-pins, 152PnF and 152PnR, push back on the Two Plunger Bodies, 141BF and 141BR, from another direction (giving resistance straight from the back of the Plungers), thereby providing a counterforce that is applied in direct opposition to the exact forward path of a canister's movement.

The Slowdown Plungers 141PF and 141PR, the Plunger Retracting Solenoids 147F (and its rear Retracting Solenoid Counterpart), the Plunger Back-end Stop-pins 152PnF and 152PnR, and the Two Pressure Lines, 154F and 154R, are all part of a precise and exquisite pressure-regulated system. Together, FIG. 1E and FIG. 1E-2 show the entire HAERS. When the HAERS 314 is in the default state, Valves 158, 159, 160, and 161 are closed and Valve 157 is open; this means the Fluid Pressure has only one place to go, and that is into the Variable Pressure Chamber 156Pr (which is a part of the Hydraulic Accumulator 156). During the “contact period” just described between the Leading Surface of a canister and the Two Slowdown Plunger Tips, 140F and 140R, the pressure in the overall HAERS will increase until the pressure reaches a Pre-determined Target Pressure, according to data that was sent to the HAERS by the Speed and Motion Sensor 131 (shown in FIG. 1D).

The exact level of any particular Target Pressure is uniquely and individually created each time a canister passes in front of the Speed and Motion Sensor 131, and as a result, a specifically-tailored Energy Recovery Process will be performed by the HAERS for each new contact made between a canister and the Two Slowdown Plunger Tips, 140F and 140R. However, the end result of the Energy Recovery Process will be the same for Every canister and that result will be that every canister will have exactly the same amount of kinetic energy remaining (at least within a very “tight range”) when that canister EXITS the Slowdown Plunger Area. Even before contact is made between the canister and the Two Slowdown Plunger Tips, the overall Sensor System 131 will have instantaneously determined exactly how much kinetic energy needs to be subtracted from the kinetic energy a canister has just prior to contacting the Slowdown Plunger Tips, so that the HAERS will know exactly how much kinetic energy to convert into Fluid Pressure before “releasing” the canister by retracting the Two Slowdown Plunger Back-end Stop-pins (downward) and pulling the Two Slowdown Plungers (horizontally) out of the way of the moving canister.

This pre-determined amount of kinetic energy to be taken away from a canister will in turn leave a canister, at the point the canister is “released” by the HAERS, with precisely enough kinetic energy so that the canister can travel through the Mid-section of the Roller Conveyor, pass through the Arc C Area, climb up into the Pre-launch Area and successfully execute the Coupling Process with the canister that is waiting in the Pre-launch Area (the next canister to be pushed up into the Fluid Column, which in this case is Canister #11). From an Energy Recovery standpoint, the amount of kinetic energy subtracted away from Canister #1 will cause a related pressure increase in the Variable Pressure Chamber 156Pr, and this increase in pressure will be the difference between the Default Pressure of the Hydraulic System and the Pre-determined Target Pressure. In other words, essentially almost all of the kinetic energy that is taken away from Canister #1, in this case, will be converted into an increase in Fluid Pressure in the Variable Pressure Chamber 156Pr.

The pressure in the Variable Pressure Chamber 156Pr will be the same pressure that is felt by the Pressure Gauge 164 because at the point when Valves 158, 160, and 161 are closed and Valve 157 is open, the two components, Chamber 156Pr and Pressure Gauge 164 are part of the same sub-system that is feeling equal pressure in all of its parts. When the Pressure Gauge 164 reaches the assigned Target Pressure, a signal is sent by the Pressure Gauge and Valve 157 closes and a split second later, Valves 160 and 161 open; Valves 158 and 159 remain closed. This means two things: a) all of the added pressure is now being stored in the Hydraulic Accumulator 156, and b) there is an immediate decrease in the backpressure being felt by Canister #1, because the volume of the Pressure Release Chamber 162 takes on a substantial amount of the Fluid (or at least Fluid Pressure) that was in the system, thereby immediately reducing the pressure everywhere in the system (except the Hydraulic Accumulator, which is now sealed off from the “original system” because Valve 157 and Valve 158 are closed, and except in the Two Pressure Adjustment Chambers, 165-hg and 165-lw).

This immediate decrease in pressure at the point of contact between Canister #1 and the Slowdown Plunger Tips allows for a minimum amount of resistance when the Slowdown Plunger System: a) retracts the Two (Front and Rear) Slowdown Plunger Back-end Stop-pins (152PnF and 152PnR), and b) pulls the Two Slowdown Plungers out of the way of the moving canister by causing the Two (Front and Rear) Retracting Solenoids (147F and its Rear Counterpart) to retract. It is important to note that there is an (approximate) millisecond delay between when the Two Plunger Back-end Stop-pins 152PnF and 152PnR retract (move downward) and when the Two Plunger Retracting Solenoids 147F (and its Rear Counterpart) retract in the horizontal plane. The tops of the Two Plunger Back-end Stop-pins, 152PnF and 152PnR must be clear of the Plungers Bodies (must be totally below the bottom back edge of the Plunger Bodies) before the Plunger Retracting Solenoids can move horizontally, otherwise the Two Plunger Back-end Stop-pins, 152PnF and 152PnR, will be pushed or pulled horizontally, because these Two “152 Stop-pins” will be caught in the concaved, cut-out vertical “slots” that these Two “152 Stop-pins” fit into when they are providing counter-pressure against the moving canister.

By the time this entire Retraction Process is finished, the result is that Each Slowdown Plunger Unit (each “Unit” being comprised of having a Tip, a Plunger, and Body) will have moved out of the way (each Plunger only needs to move horizontally about 1½ inches, and these Plungers are being pulled out of the way by extremely powerful Retracting Solenoids) and also the Two Plunger Back-end Stop-pins will have moved out of the way, so Canister #1 was able to move out of the Slowdown Area 306, enter and move through the Mid-section of the Roller Conveyor 318 (FIG. 1F), and is now heading towards Arc C 307, as shown in FIG. 19. At this point, Canister #1 will be traveling with a “regulated” amount of kinetic energy remaining so that the canister has enough velocity to move through Arc C and then make the climb upwards to the Pre-launch Area 308. Also, the final speed of Canister #1, just before reaching the Pre-launch Area, will be regulated again (increased or decreased) by the Arc C Pre-launch; Speed-adjusting EM#2 195 (this Speed-adjusting EM#2 is not shown in any of the Six Sequence Diagrams; see FIG. 1G and 13 Topics; #1, “Coupling Process”).

Referring back to the HAERS 314, after the canister has passed out of the Slowdown Area, the Hydraulic Accumulator 156 is loaded with pressure and that pressure needs to be released into the Hydraulic Motor 174, which will cause the Motor to spin. In addition, there is an Electric Generator 175 attached to the shaft of the Hydraulic Motor (see FIG. 1E-2). Electricity will be generated by the rotational movement of the Electric Generator and the amount of electricity generated in this process is almost equal to all of the kinetic energy that was acquired by the HAERS as a result of pressure being transferred into the Accumulator by the Two Slowdown Plungers. This sub-process happens in the following way.

In order to transfer the pressure from the Hydraulic Accumulator into the Hydraulic Motor, Valves 158 and 159 open; Valve 157 remains closed and Valves 160 and 161 remain open. This causes Fluid (and Fluid Pressure) to move through Valve 158, through the Hydraulic Motor, and then move back into the Pressure Release Chamber 162 through Valve 159. This transfer of pressure through the Hydraulic Motor causes the Motor to spin and the “work” done by the Hydraulic Motor causes an equivalent reduction, from a “work” standpoint, in the Fluid Pressure. Once the Pressure Gauge 164 reaches its “default pressure,” signals are sent to all of the Valves, causing the Four Valves that are open, 158, 159, 160, and 161 to close, and Valve 157 to open. At this point the entire Hydraulic System is (theoretically) exactly back to its original state (see two paragraphs below for more explanation on this), which also means the pressure inside the entire Hydraulic System has caused the Two Slowdown Plungers to become fully extended so that the Plunger Tips (140F and 140R) are ready to make contact with the next canister in the next Cycle.

Two final notes on what was said in the previous paragraph. First, if one Hydraulic Motor cannot handle an exchange of the Fluid-pressure fast enough (be able to fully transfer the Fluid-pressure through the Hydraulic Motor in about two seconds), then Two or More Hydraulic Motor-Electric Generator System combinations can be junctioned into the Variable Pressure Chamber 156Pr. This Multiple Hydraulic Motor sub-embodiment of the preferred embodiment has multiple Valves 158 built into either of the Two Outside Walls (part of the Set of Walls 156W) of the Variable Pressure Chamber 156Pr, multiple Outlet Pressure Hoses 172, multiple Inlet Pressure Hoses 173, multiple Valves 159 built into any of the Outside Walls (part of the Set of Walls 162W) of the Pressure Release Chamber 162, and multiple Hydraulic Motor-Electric Generator System combinations. All such Valves 158 open and close simultaneously and all such Valves 159 open and close simultaneously, according to the “timing scenarios” described above. The end result of the Multiple Hydraulic Motor sub-embodiment is that the same amount of Recovered Electricity is generated, but the time it takes to pass the Fluid-pressure from the Variable Pressure Chamber 156Pr, through the Hydraulic Motors, and back into the Pressure Release Chamber 162 will be a fraction of the time it takes to perform this operation by using only One Hydraulic Motor, as shown in FIG. 1E-2.

The second note is that if for some reason the Pressure Gauge does not reach the “default pressure” (which means all Valves are still open, except Valve 157) after a pre-determined time (for example, two seconds after Valve 158 opens), then Valves 158 and 159 close. At this point one of two conditions will exist, either there will be too much pressure in the system or too little pressure. Pressure Gauge 164 will immediately determine this, and if there is too little pressure, then Check Valve 163-Vhg will open and pressure will be released into the overall system from High Pressure Chamber 165-hg. If there is too much pressure in the system, then Check Valve 163-Vlw will open and pressure will flow out of the overall system and go into Low Pressure Chamber 165-lw. Either of these two changes in pressure for the overall HAERS will be immediate and within one or two seconds, Pressure Gauge 164 will acknowledge the Target Pressure has been reached and will immediately close the respective Check Valve responsible for having provided the appropriate Pressure Adjustment just described and that was needed by the system to achieve the Overall Default Pressure. In addition, once this Default Pressure has been reached, Check Valve 157 will open and Check Valves 160 and 161 will close (158 and 159 are already closed).

Going back to the Pressure Adjustment Chamber that has just provided the Pressure Adjustment, the instant the related Check Valve has been closed, this has sealed-off the respective Pressure Adjustment Chamber. Then over the next several seconds, the Pressure Pump 171 can “work on” whichever particular Pressure Adjustment Chamber has just provided the overall Pressure Adjustment (to the overall HAERS) and get that Chamber back to whatever pressure (higher or lower) that particular Chamber is supposed to have as its individual “default” pressure.

This whole “Pressure Release and Reset Process” has to occur over a period of about four seconds, because a New Cycle is occurring about every five seconds. Also note, Pressure Pump 171 is used to initially charge the entire Hydraulic System to its “default pressure,” before the MF device is ever started for the first time.

Pre-launch Area 308: NO CHANGE

Underwater Launch Area 310: NO CHANGE

Pivot Bucket Area 313: During the time Canister #1 has moved through the Slowdown Area 306, the Pivot Bucket Rotational Solenoid 266 has rotated the Pivot Bucket 261 by using the Pivot Point Swivel System 316. The Pivot Bucket has been rotated to the left (when looking at the drawings; but from the perspective of the Rotational Solenoid 266, the Pivot Bucket has rotated to its right).

As is fully explained in “13 Topics; #8, Pivot Buckets; sub-section Single Pivot Bucket operation,” at a pre-determined Degree of Rotation, Rotational Solenoid System 266 sends out Three types of signals. One type of signal goes to the Two Upper Pivot Bucket Stop-pin Assemblies, 264L and 264R, causing these Stop-pins to retract and thereby creating an open pathway in the “Mouth” of the Pivot Bucket for the canister to move through. One signal goes to Canister Ejection EM 276 (that is surrounding the Pivot Bucket, as seen in FIG. 1L-2 and FIG. 1M), causing this Canister Ejection EM 276 to initiate an EM Field that “pushes” the canister out of the Pivot Bucket. The third signal goes to Top Cue Position Deceleration EM 626 (in FIG. 1N) and this signal causes this Deceleration EM 626 to initiate an EM Field that will attract the magnet inside the canister and will help “pull the canister out” of the Pivot Bucket and onto Inclined Platform Top Cue Position Canister Holder Section 625Ext at a point when the canister has been partially ejected out of the Pivot Bucket (as seen in FIG. 19) and the magnet near the front of the canister comes within range of the EM Field that has been created by Deceleration EM 626.

FIG. 20.

On the Inclined Platform 59: NO CHANGE, except Canister #12 is now in the top position on the Inclined Platform, where Canister #10 was originally (in FIG. 15). This process is further explained in the Pivot Bucket Section below.

In the Air Side Launch Area 302: NO CHANGE

Slowdown Area 306: as explained previously, electricity has been generated and the Slowdown Plungers have been reset. The HAERS is ready for the next Cycle.

Pre-launch Area 308: Canister #1 has entered the Pre-launch Area with exactly the right speed; “not too fast and not too slow,” as a result of its speed being “tweaked” by the Arc C Pre-launch; Speed-adjusting EM#2 195 (not shown). Canister #1 has performed a Coupling Process with Canister #11 and this Coupling Process is fully explained in 13 Topics; #1, “Coupling Process,” and also a short Definition of this Coupling Process was given above at the start of this Section. The highlights of the Coupling Process are:

1. The Lower Canister's speed is initially regulated by the HAERS and then regulated again by the Arc C Pre-launch; Speed-adjusting Electromagnet (EM#2) 195, so that there is just enough kinetic energy remaining for the Lower Canister to push the Upper Canister up about four inches higher than where the Upper Canister started;

2. The Upper Motion Sensor 217US is vertically positioned about twelve inches below where the bottom surface of a suspended (Upper) Canister is located (which is about twenty-four inches below the vertical midpoint of the Two Notch Grips, 219F and 219R), and when this Motion Sensor detects the Leading Surface of the Ascending Lower Canister (C-1), two sets of signals are sent out: first, two identical signals are sent to the Two Suspension Support Rods (227L and 227R) causing them to immediately retract out from underneath the bottom surface of the suspended Upper Canister, which means at that point the Two Notch Grips, 219F and 219R, are suspending all the weight of Canister C-11. However, this process only lasts for a split second, because immediately after the Two Suspension Support Rods retract, the second set of signals are sent to the Two Notch Grips, which causes them to immediately retract. In pre-operation test trials, the sequencing of these retraction processes are worked-out perfectly so by the time the Two Notch Grips retract, causing the respective Upper Canister to enter a temporary freefall state, the Leading Surface of the ascending Lower Canister will be a split second away from making contact with the bottom surface of the un-suspended Upper Canister, and therefore a “freefalling” Upper Canister will never be able to build up any substantial downward momentum in any Coupling Process, before the bottom surface of a “freefalling” Upper Canister makes contact with the leading surface of an Ascending (Lower) Canister.

3. The momentum of the Lower Canister pushes both canisters upward, and during the time the Two Canisters are ascending and then descending [ascending to a Peak Height at which point the Lower (Ascending) Canister will have exhausted all of its upward kinetic energy], the Lower Motion Sensor 217LS has detected that the bottom surface of this Ascending Lower Canister has moved in front of this Sensor 217LS, and therefore this Sensor 217LS has caused the Launch Platform Positioning Solenoids (216BL and 216BR) to horizontally re-position the Two Halves of the Pre-launch Launch Platform, 211L and 211R, in underneath the Two Canisters during that time the bottom surface of the Lower Canister was above the topmost point of the Two Spring Systems, 211SpL and 211SpR (that are respectively attached to and sitting on top of these Two Launch Platform Halves).

4. After reaching the Peak Height, both canister fall back down to the point where the bottom surface of the Lower Canister is resting on the Two Horseshoe-bars, 211HL and 211HR, that are mounted on the top of the Two respective Launch Platform Halves, 211L and 211R.

5. The Two Notch Grips are extended out so that light horizontal pressure is applied to the Notch of Canister #11 to keep the canister in perfect alignment, horizontally.

The final status of the equipment in the Pre-launch Area, when the bottom surface of Canister #1 is stationary and is resting on the Two Horseshoe-bars 211HL and 211HR (of the Two respective Launch Platform Halves 211L and 211R) is that: a) the Two Notch Grips 219F and 219R are in the fully retracted mode, b) the Two Suspension Support Rods (227L and 227R) are in the fully retracted mode, c) the Launch Platform is in place underneath the Lower Canister, and d) the Two Linear Motors, 218L and 218R are ready to perform a Pre-launch on the Two “Coupled” canisters, Canister #11 and Canister #1. This Pre-launch Process will begin shortly after the next Cycle begins; that is, the next Pre-launch Process will start precisely when the next Air Side Launch occurs.

Underwater Launch Area 310: NO CHANGE

Pivot Bucket Area 313: as a result of all processes being performed by the components shown in FIG. 1N, Canister #12 was ejected out of the Pivot Bucket, was decelerated while on Inclined Platform Top Cue Position Canister Holder Section 625Ext, and “slid down” to the left and the Leading Surface of Canister #12 made “gentle contact” with the bottom surface of Canister #10, that had been waiting as the topmost canister on Inclined Platform 59.

The Pivot Bucket Rotational Solenoid 266 has rotated the Pivot Bucket (and everything attached to the Pivot Bucket, see FIG. 1L-2) back into the original, completely vertical “reset” position. The Upper Pivot Bucket Stop-pins 264L and 264R have “reset” and they are extended out, ready to block the upward motion of the next canister to enter the Pivot Bucket, which will be Canister #11. The Lower Pivot Bucket Stop-pins 263L and 263R have retracted, thus leaving the bottom portion of the Pivot Bucket completely open, so that Canister #11 can “fly into the Pivot Bucket” from the bottom, when the time comes.

All pieces of equipment in all areas of the device have been reset and the next Cycle will now begin. Drop Point Retaining Pins 81F (and 81R) will retract; Canister #2 will start moving to the left and will consequently enter the Drop Phase 304.

### 13 Topics; Eight Specific Operational Descriptions Plus Five Additional Significant Issues

### 1. The Coupling Process.

The launching of a canister on the Fluid Side is a fairly complex and demanding event that combines a Coupling Process, a Pre-launch Process and an Underwater Launch; these three processes will be fully described here. In the Pre-launch Process, an Upper Canister is moved upward by an “Ascending (Lower) Canister” that is below the Upper Canister and is perfectly aligned with the Upper Canister in a vertical direction. Essentially the Ascending Canister pushes the Upper Canister up and out of the Primary Seal and all the way up “into the Fluid.” However, starting back in the overall Cycle of a MF device, even before the Pre-launch Process begins, there is a Coupling Process. At the start of the Coupling Process, the “original” Upper Canister in this discussion will be by itself in the Pre-launch Area 308 (as seen in FIG. 16). [Note: in the very first Boot-Up Launch (shown in FIG. 15), when the device has never before been in operation and is starting for the very first time, Two Canisters are already “Coupled Up” with each other and both canisters are waiting, motionless in the Pre-launch Area.]

However, for every other Pre-launch Process after that, there will be a period of time (about three seconds) where only One Canister will be in the Pre-launch Area and that canister will be in a situation where it is being suspended from its bottom surface by the Two Suspension Support Rods 227L and 227R, and also the Two Notch Grips 219F and 219R will be in the extended mode, and will be helping to stabilize the canister, horizontally, by applying light pressure on the Notch of the respective canister, from at least two directions. [Note: FIG. 1H shows Two Notch Grips, but an MF device could use Four Notch Grips, all at the same vertical height, and spread out at equal distances from each other, going around the Notch of a canister.]

The canister is being held in a vertical position where: a) the body of the canister is inside the Primary Seal (inside the hole in the bottom surface of the Fluid Column), and b) the canister will have about four inches of its upper portion sticking above the Primary Seal (or 15% of its overall cylindrical body; that four inches is the vertical distance from the Leading Surface, the topmost surface, not counting the Nose Cone Protrusion 70, down to the top edge of the Primary Seal; see FIG. 1I); this upper part of the canister's body will be “in the Fluid.” The lower 85% of the canister's body will be below the Primary Seal and will be surrounded by air. There will be very strong Fluid Pressure pushing downward on the Leading Surface of this “original” canister because the canister's Leading Surface is “in the Fluid.” In this Coupling Process description, this “original” canister starts out as the Upper Canister.

The next step in the Coupling Process is that since the Two Halves of the Pre-launch Launch Platform 211L and 211R are in the “retracted state” (see FIG. 16), a second canister has the Open, Available Space to come up underneath the first canister (this Upper Canister) and “Couple up” with this canister from directly below. The speed of the second canister (the Lower Canister) has been controlled by: a) the Hydraulic Accumulator Energy Recovery System 314, and also by b) the Speed-adjusting EM#2 195 (FIG. 1G), so that the Leading Surface of the Lower Canister will be contacting the bottom surface of the Upper Canister with a firm but relatively gentle upward “push.”

These Two Speed Manipulation Systems, HAERS and EM#2 195, will have left enough remaining kinetic energy in the Ascending (Lower) Canister (left that canister with enough upward momentum) so that this Lower Canister will be able to push the Upper Canister high enough to give the Two Halves of the Pre-launch Launch Platform, 211L and 211R, time to come in under the bottom surface of the Lower Canister and “catch” both canisters when the Two Canisters begin falling downwards, after the Lower Canister has exhausted all of its upward kinetic energy. Also, in this initial part of the Coupling Process, the Ascending (Lower) Canister will be fighting to push the Two Canisters upwards against this very strong Fluid Pressure Force that will be pushing downwards on the Leading Surface of the Upper Canister, and of course, gravity will be imposing a relatively strong downward force on both canisters.

As is explained in Drawing Exceptions #3, even though FIG. 1H shows the Two Halves of the Pre-launch Launch Platform extended in towards each other, this would never happen without a canister (the Ascending Canister) being in the Pre-launch Area, and vertically positioned above an interlocked, unified Pre-launch Launch Platform. Another thing that FIG. 1H and FIG. 1H-4 do not show is that for all of the embodiments presented, when the Two Suspension Support Rods 227L and 227R (in FIG. 1H-4) are holding the Upper Canister in place, there is a vertical distance equal to approximately one canister length between where the bottom surface of the canister being held by these Two Suspension Support Rods 227L and 227R is (that is, the bottom surface of the Upper Canister) and the uppermost point of the Spring Systems, 211SpL and 211SpR (see Overriding Priorities #2). In any event, in the Coupling Process the Lower Canister ascends up into the Pre-launch Area in perfect horizontal alignment with the bottom surface of the Upper Canister (the center of the Lower Canister is directly below the center of the Upper Canister) and the momentum of this Ascending (Lower) Canister causes it: a) to move upwards one full canister length above the top of the Two Spring Systems, 211SpL and 211SpR (at which point the Leading Surface of the Ascending Canister makes initial contact with the bottom surface of the suspended Upper Canister), and b) to push BOTH canisters up about four inches higher than the point where this Initial Contact is made with the Upper Canister by the Lower (ascending) Canister. This vertical “Peak Height” around the Four-inch Mark will also be where the Ascending Canister will have exhausted all of its upward kinetic energy. This means that the total distance the two canisters will fall downward (from the Peak Height) will be about four inches, before that downward motion is stopped.

The Upper Sensor 217US is the next critical component in this overall Coupling Process. Before explaining what the 217US Sensor does, it should be understood why this 217US Sensor is there. One of the most important issues necessary to complete a successful Coupling Process focuses around WHEN the Two Notch Grips, 219F and 219R, withdraw from the Notch of the suspended Upper Canister. [Note: even though for the majority of the time the Two Suspension Support Rods 227L and 227R are supporting a suspended canister, in the last split second before a suspended canister enters the freefall state, it is the Two Notch Grips that are suspending the respective canister.] The exact moment when these Two Notch Grips withdraw from the Notch of the respective suspended canister has a critical relationship to: a) how far below the bottom surface of the suspended Upper Canister the Leading Surface of the Ascending Lower Canister is, and b) how fast the Lower Canister is ascending when the Two Notch Grips withdraw from the Notch. Technically, there is about a three and one-half inch “margin of error.” In other words, since the Upper Surface of a suspended Upper Canister is “in the Fluid” by four inches above the top of the Primary Seal (before the Coupling Process even starts), the Upper Canister could drop down three and one-half inches, for example, before the Ascending Canister begins pushing the Upper Canister back up “into the Fluid” with an upward force.

However, to let the Upper Canister drop down three and one-half inches is cutting things pretty close, considering: a) the very strong downward Fluid Pressure on the Leading Surface of the Upper Canister, and b) considering the entire MF device will shut down (and all the fluid will come gushing out) if the Upper Canister is somehow “pushed down through the Primary Seal.” So the Upper Sensor 217US is there to ensure everything works smoothly and no such “operational disaster” ever occurs. The 217US Sensor detects when the Leading Surface of a Lower Canister is moving in front of it and then immediately sends two (almost simultaneous) sets of signals to: a) the Two Suspension Support Rods 227L and 227R, and then b) the Two Notch Grips 219F and 219R, and all of these signals cause these four solenoid-related components to go into a retraction mode and respectively retract (first) the Two Suspension Support Rods out from underneath the suspended canister and also (second) retract the Two Notch Grips out of the Notch of the Upper Canister, thereby “releasing” the Upper Canister and allowing this Upper Canister to become freely moveable in a vertical direction.

There is a specific reason why there are two sets of suspension components used to suspend a canister. The Suspension Solenoid Plunger-rods (227LP and 227RP, in FIG. 1H-4) for the Two identically manufactured Suspension Support Rods (227L and 227R) are fairly long. During the typical time these Two Suspension Solenoid Plunger-rods are actually supporting all the weight (and applied downward pressure) of a suspended canister, there is a permanently mounted Support Cup (part of the respective Support Arm: 229L and 229R) that supports the front side of each of these fairly long Plunger-rods (so these respective Support Cups are holding up one-half of the overall weight). But as these Plunger-rods begin to retract, almost immediately as this process is happening, the ends of these Plunger-rods withdraw from the Support Cups and there is no longer support on both sides, and therefore all of the supported weight will be out of balance, relative to the angle and position of the respective Solenoid Body (of 227L or 227R) and also relative to the length of the Plunger-rods. Extreme downward torque would be applied to each of the “exposed” ends of these Two Plunger-rods the instant they withdraw out of their respective Support Cup.

This problem is solved by using the Two Notch Grips to hold-up all of the downward weight (and applied downward force), during the time when these Two Suspension Solenoid Plunger-rods are transitioning from the extended mode to the retracted mode. There are also two other advantages to using the Two Notch Grips to actually release a suspended canister and allow the canister to enter the freefall state, and those advantages are: a) these Two Notch Grips are always balanced around the body of the canister; there is no torquing or mysterious effects that might be felt as what would happen if these long Plunger-rods were required to support this extreme weight AND withdraw at the same time, and b) the actual event of withdrawing the Two Notch Grips can happen in a very small fraction of a second. Each of the individual Notch Grips is only engaged into the Notch of a canister approximately three-eighths of an inch, and therefore the total horizontal movement of a retracting Notch Grip is approximately one-half inch, which can happen in the blink of an eye.

On the other hand, it's also worth noting that these Two Notch Grips would not be appropriate to be used as the only method of supporting a canister. It is essential that the Two Suspension Support Rods 227L and 227R are used 95% of the time to suspend the respective canister, because the strength of using a large solenoid, a long and relatively thick Plunger-rod and then supporting one-half of the weight of the canister with a permanently attached, strong Supporting Arm is definitely much better than having a smaller Plunger-rod (of a smaller solenoid) engaged into a thin three-eighths inch deep Notch. There is a constant and very substantial downward force of Fluid Pressure that is acting on the Leading Surface (uppermost surface) of any suspended canister, and this force is always trying very hard to push a suspended canister downward and out of the Primary Seal. It would not be a good design feature to have the Two Notch Grips do all of the Suspension work all of the time.

What is just as important, in a related issue, is the vertical position of this Upper Sensor 217US. Without the benefit of performing any testing trials, it can be stated that this Upper Motion Sensor 217US should be vertically positioned about twelve inches below where the bottom surface of a suspended (Upper) Canister is vertically located. Also as stated above, this vertical positioning location depends on how fast an ascending canister will be moving in that vertical distance between where the Sensor is and where the bottom surface of a suspended canister is. The “target result” would be to have the upper canister drop down about one and one-half inches before contact was made between the two canisters. This would mean that if the “mounting distance” between the vertical location of the Sensor and the bottom surface of the suspended canister was twelve inches, then the overall “target distance” of “ascending travel time” would be the time it would take for the Lower Ascending Canister to travel ten and one-half inches. In that exact time the Two Suspension Support Rods, 227L and 227R, have to be fully retracted out from underneath the bottom surface of the suspended Upper Canister, then the Two Notch Grips also need to go into the fully retracted mode, and then the Upper Canister could drop down one and one-half inches before the Lower Canister contacted this Upper Canister.

There is no margin of error for these Two Notch Grips to Not be retracted out of the Notch of the canister, because the Lower Canister cannot begin pushing the Upper Canister upwards if one (or both) of these Notch Grips is still engaged into the Notch of the Upper Canister. In this case this upward movement of the Notch will “drag the Notch Grips” along with it, causing the Notch Grips (and the related Solenoid Plungers for these Notch Grips) to bend, break, become upwardly twisted and torqued and to definitely become inoperable and also such an event would cause the bottom edge of the Notch to become compromised. The entire MF device will have to be shut down and it will be necessary to make repairs on the damaged parts. And also as stated above, there is really no margin of error for an Upper Canister to drop down more than a total of three and one-half inches from the “suspended height” a respective Upper Canister is at when that canister is being suspended by the Two Suspension Support Rods.

In any event, at the point when the Four Suspension-related components have all entered into the fully retracted mode and the respective Upper Canister is in a “freefall state,” there is an interesting situation regarding the upward and downward forces of the Two Canisters. The Upper Canister will immediately be starting a downward “free fall,” according to the force of gravity. But in addition to gravity, there will be an even much stronger downward force felt by the Upper Canister, and this is the force being applied by the Fluid Pressure that is pushing down on the Leading Surface of the Upper Canister (the Leading Surface that is “in the Fluid” above the Primary Seal). At the same time, however, the Ascending Lower Canister is in a state of “anti-free fall” and is heading upwards at a speed regulated: a) by the amount of kinetic energy the HAERS has taken away from the very high speed (approximately 37 miles per hour) the canister had only two or three seconds prior to making contact with the Upper Canister, and then b) by the strength of the Electromagnetic Pulse(s) provided by the Arc C Pre-launch; Speed-adjusting EM#2 195, as this EM#2 195 has “tweaked” the upward speed of the Ascending Canister, just before that canister entered the Pre-launch Area.

As this “Coupling Event” actually occurs between the Two Canisters, even though both canisters are unrestrained: a) the Nose Cone Protrusion of the Lower Canister is pushing itself up into the Matching Carved-out Impression in the bottom surface and bottom portion of the Upper Canister, b) this Ascending (Lower) Canister has More Momentum Moving Upward than the forces pushing down on the top surface of the Upper Canister (combined with the force of gravity acting in a downward direction on Both canisters) and this upward force (momentum) from the Ascending Canister will cause BOTH canisters to move upwards a few inches above the vertical point where the Ascending Canister contacted the Upper Canister, and c) as the upward motion progresses and the Two Canisters become Fully Coupled, they will be moving as one seamless unit because Nose Cone Protrusion 70 of the Ascending Canister will have perfectly and fully merged into the Matching Carved-out Impression 71 in the bottom surface of the Upper Canister (see FIG. 2a).

As mentioned above, there is a very substantial force pushing down on the Leading Surface of the Upper Canister and specifically the force of the pressure of all the Fluid in the Fluid Column will be trying to push BOTH canisters down with tremendous force. But the speed and overall kinetic energy of the Ascending Canister is great enough that for a split second, the momentum of this Ascending Canister will push both canisters up a “few inches,” to what can be considered a Peak Height, which is the exact point where the Ascending Canister will have exhausted all of its kinetic energy. Having reached that Peak Height, the Two Canisters will then reverse directions and will start moving back down with considerable force, and these Two Canisters would Potentially be able to move at substantial speed, if the canisters were allowed enough time to acquire such speed (downward momentum).

The lower this Peak Height is (of course there is a minimum height that MUST be achieved to allow the Two Launch Platform Halves enough time to get into the proper position underneath the Two Canisters), then the less downward speed these two relatively heavy canisters will have by the time the bottom surface of the Lower Canister “lands on top of” (crashes down on) the Two Spring Systems, 211SpL and 211SpR, as explained below. (And a reminder, the combined weight of the Two Canisters can be about 90 pounds in the preferred embodiment, even before considering additional Fluid Pressure that is adding more downward force.) So there is a very fine relationship between: a) making sure these two canisters are pushed up high enough to allow enough time for the Pre-launch Launch Platform to be positioned in underneath the bottom surface of the Lower Canister, but b) not randomly allowing the canisters to go any higher than the required time, to reduce the downward force of all this weight crashing down onto the spring matrices attached to the tops of the Two Pre-launch Launch Platform Halves.

So the next critical component in this Coupling Process is the Lower Sensor 217LS, and this Sensor is responsible for triggering the horizontal positioning of the Two Pre-launch Launch Platform Halves. Once again, the sophistication of the related calibration to successfully complete this sub-process, over and over, Cycle after Cycle, can only be fully understood and properly analyzed by doing extensive testing trials. It can be stated, without the benefit of such testing trials, that for a canister length of twenty-eight inches (bottom flat surface to top flat surface; protrusion excluded), this Lower Sensor 217LS is vertically positioned about sixteen inches below the Upper Sensor 217US.

[Note: according to how the Notch of a canister is configured, relative to the overall length of a canister (as seen in FIG. 2a), since the Upper Sensor 217US is about twenty-four inches below the vertical midpoint of the Notch Grips, this means this Lower Sensor 217LS would be about forty inches below the vertical midpoint of the Notch Grips, which is the combination of: a) the distance between the midpoint of the Notch Grips and the bottom surface of a suspended canister (about twelve inches), and b) the length of a canister in this discussion (28 inches). This is quite proper because since the two canisters move at least four inches above the point of contact between the two canisters, and since the point of contact is about thirty-eight or thirty-nine inches above the top of the Two Spring Systems, 211SpL and 211SpR (considering an Upper Canister drops one and one-half inches before contact is made, after the Two Notch Grips retract), this allows enough time for the Two Pre-launch Launch Platform Halves to be properly horizontally positioned while these two canisters: ascend, peak, and then descend back down onto the properly positioned Pre-launch Launch Platform.]

Another benefit in this situation is that the Lower Canister will not be “traveling that fast” at the point when it passes in front of this Lower Sensor 217LS (at least compared to the 37-38 mph the canister had been traveling before the HAERS took a majority of the kinetic energy away from the canister).

It could be argued that there is no need for the Lower Sensor 217LS, since the Upper Sensor 217US is detecting the vertical position of an ascending canister. However, the Moment of Contact between the Two Canisters is a rather strange occurrence, because of how the upward momentum of the Ascending (Lower) Canister is fighting the strong downward forces of the Upper Canister, and also how both canisters are actually “Unrestrained in Mid-air” at that Exact Moment of Contact. Therefore, the Lower Sensor 217LS is there to make sure the BOTTOM surface of the Ascending Canister has cleared the Two Spring Systems (gone above the topmost point of the Two Spring Systems, 211SpL and 211SpR), before the Two Launch Platform Halves, 211L and 211R, start moving in towards each other. The Lower Sensor 217LS will detect when the bottom surface of the Ascending Canister is passing in front of it (heading upward) and at that point this Lower Sensor System 217LS immediately sends an identical signal to the Two (very powerful) Launch Platform Positioning Solenoids, 216BL and 216BR, causing these Solenoids to extend out (in the horizontal plane), which pushes the Two Launch Platform Halves, 211L and 211R in towards each other until the Locking Pins, 225F and 225R (in FIG. 1H-3), fully mesh with their Front and Rear Female Counterparts (226F and 226R) and the Pre-launch Launch Platform essentially becomes one piece.

At the instant when the Leading Surface of the Upper Canister reaches Peak Height, the Two Pre-launch Launch Platform Halves will have merged (or will almost be finished merging) together and will have become one “United” Pre-launch Launch Platform. This Launch Platform will now be sitting in the same exact path that the previously Ascending (Lower) Canister used only one or two seconds before to come up underneath the Upper Canister, at the beginning of the Coupling Process. The result is that this “United” Platform will be able to catch the Two Canisters when these canisters start falling back down. This process of the Two Launch Platform Halves joining into One Combined Launch Platform MUST be done by the time the Two Canisters fall back down to the vertical position where the bottom surface of the Lower Canister is at a height equal to the highest point of the Two Spring Systems, 211SpL and 211SpR (which is also the height where Lower Sensor 217LS is vertically positioned). It is this Lower Sensor 217LS that plays a critical role in making sure this sub-process related to the proper horizontal positioning of the Pre-launch Launch Platform happens perfectly, for every Cycle.

The Pre-launch Launch Platform is designed to be in Two Halves simply so that no one part of the Pre-launch Launch Platform has to move the full distance (which is a little more than the outside diameter of a canister) to get fully underneath the bottom surface of the Lower Canister during this Coupling Process. Speed is of the essence during that split second when the Two Canisters are peaking in their upward motion, and it is twice as fast to move two halves of the Launch Platform only one-half the distance. But there is one other issue to consider in creating the most suitable Coupling Process; that issue is to have the least amount of wear-and-tear on the Spring Systems (211SpL and 211SpR) and all the other Interface Components that are moving in the horizontal plane. When the two (heavy) canisters do fall back down onto the “211 Spring Systems,” it is better if the Pre-launch Launch Platform and all the other Interface Components (that are only supposed to move in the horizontal plane) are not subjected to excessive vertical movement from a Significant Downward Impact by the Two Falling Canisters, especially Cycle after Cycle, that occurs about every five seconds. And as stated above, the Two Falling Canisters will only be moving faster (be hitting the Spring Systems harder) if these canisters have had more time to develop downward speed before contact is made with the Two “211 Spring Systems.”

This means that the real objective to optimize efficiency in this Coupling Process is to have the canisters more upward just the minimum amount of distance possible, before reaching their Peak Height, but which is still a point high enough to give the Two Pre-launch Launch Platform Halves enough time to get into the correct position under the Two Falling Canisters, before contact is made between the bottom surface of the Lower Canister and the Top Edge of any of the “211 Springs.” The more sophisticated the Two Motion Sensor Systems, 194 and 196 are, acting in combination with the Arc C Pre-launch; Speed-adjusting Electromagnet (EM#2) 195, to accurately determine precisely how much Final Kinetic Energy to leave the Lower Canister with, as that canister ascends towards the Pre-launch Area, then the less wear-and-tear there will be on the “211 Spring Systems” and the related Interface Components.

As has been discussed, mounted on the top of each individual Pre-launch Launch Platform Half there is a heavy-duty matrix of very strong and highly resilient Springs, and these Two Springs Systems, 211SpL and 211SpR will absorb a substantial amount of “shock” when contact is made between these Springs and the bottom surface of a “falling” Lower Canister. But regardless of how hard the Two Canisters fall back down onto the Two Spring Systems, these Two Spring Systems, 211SpL and 211SpR, and the overall construction of the Launch Platform and all the Interface Components in the entire Launch Platform System have been designed to be Sturdy and are able to take such “impacts” as just described, Cycle after Cycle, without any loss of integrity to the Springs or to any other equipment connected to the Two Pre-launch Launch Platform Halves, 211L and 211R. Therefore no problems with the Pre-launch Launch Platform will ensue. After the Two Canisters have fallen back down onto the “211 Spring Systems” (onto the Pre-launch Launch Platform), there is an instant in time when both canisters are motionless, sitting on the Pre-launch Launch Platform waiting for the Pre-launch to begin. This is the conclusion of the Coupling Process.

### 2. The Pre-Launch Process.

This Process begins a split second after the conclusion of the Coupling Process. The Two Identical Linear Motors, 218L and 218R, begin to move both canisters upward as a result of each of these Two LMs being attached to one of the Two Launch Platform Halves, 211L and 211R (FIG. 1H). [Note: this phase of the MF device is called the “Pre-launch Process” because there is a huge difference between the kind of motion (momentum) supplied by the Two LM-2s vs. the kind of very high-speed motion that is supplied by LM-3 to the Upper Canister during the Underwater Launch. The rate of vertical ascent for the LM-2s is quite slow compared to the vertical speed of LM-3, and also the “real” launch occurs with only one canister that is “inside the fluid,” not in the air outside of the fluid. This Pre-launch Process is simply a re-positioning maneuver and not any type of “launch.”]

There are Two purposes for the “Dual Linear Motor, LM-2L 218L and LM-2R 218R, Pre-launch System,” and the second purpose comes as an inherent result of the first purpose. The first purpose is to simply get the Lower Canister into the exact vertical position of where the Upper Canister was at the start of the Pre-launch Process. Once a Lower Canister has been elevated up to that “Upper” position, the canister can be suspended at that height by the Two Suspension Support Rods 227L and 227R, with about four inches of that canister's upper portion sticking above the Primary Seal “into the Fluid.” The other purpose of the Pre-launch Process is related to the actual “Underwater Launch,” because the inherent result of the Pre-launch Process is that the “Original Upper Canister” ends up being elevated enough so that this canister is fully “in the Fluid,” and this result happens automatically once the Lower Canister is lifted to the exact position of where the Upper Canister was at before the Pre-launch Process started. As stated above, this Pre-launch Process does not have to be performed at some amazingly high speed, except of course the process, including the resetting portion of the process, has to be completed before the next canister (which would be the third canister in this scenario) shows up and is seeking to become the Next Lower Canister.

In terms of the Pre-launch Process, itself, there is the actual ascent of the two canisters, and also the related events that occur after that. Once the elevation of the two canisters comes to a “complete and gentle” stop, at the exact vertical point where the Lower Canister has been moved precisely to the “Upper Canister Position,” two independent sub-events occur, which are: a) the Two Suspension Support Rods 227L and 227R will be extended out and positioned in underneath the bottom surface of the canister that is still sitting on the Pre-launch Launch Platform [the Two respective Plunger-rods of these Two Suspension Support Rods 227L and 227R will slide into the respective open spaces just on the outsides of the two respective Horseshoe-bars, 211HL and 211HR, in the related vertical open spaces between the flat top surface of each of the Two Pre-launch Launch Platform Halves and the bottom surface of the canister resting on top of the Two Horseshoe-bars, as shown with “Phantom Plunger-rods” in FIG. 11.], and b) the Two Notch Grip Retracting Solenoids 220F and 220R will extend out and the Two Respective Notch Grips, 219F and 219R, will move into the Notch of the canister that is in the “Upper Canister Position” (and these Two Notch Grips will initially help stabilize the suspended canister, horizontally).

The Two LM-2s have performed their task, what was the Lower Canister is now being properly suspended in the “Upper Canister Position,” and so at that point the Two Forcers for the Two LM-2s (212R and its Left-side Counterpart) automatically move back down to the lowest vertical point possible and are “reset” for the next Pre-launch. Once this vertical resetting process has occurred, then the Two LM-2 Positioning Solenoids 216BL and 216BR retract and pull the Two Pre-launch Launch Platform Halves 211L and 211R apart and out of the way so the next canister (the third canister) can move up through that space where the Launch Platform Halves just were. The next step in the overall process occurs in the lower portion of the Fluid Column and is the execution of the Underwater Launch, which is performed by LM-3 236 and its related Underwater Launching System.

### 3. The Underwater Launch.

The first thing that happens in the Underwater Launch Area 310 (at the end of the Pre-launch Process) is that the canister that is “in the Fluid” gently floats up about three or four inches (above the point where the canister originally started at the end of the Pre-launch). The canister is stopped from floating up any further by the Floatation Point Retaining Pins 245L and 245R. When the canister reaches those “245 Retaining Pins,” this also means that the canister's bottom surface has Cleared the Area where the Underwater LM-3 Launch Platform 233 needs to be; that is, the bottom surface of the canister is above the top edge of the Underwater Launch Platform. So at that point, the LM-3 Positioning Solenoid 238B extends out and pushes the Underwater LM-3 Launch Platform 233, which is firmly connected to this Positioning solenoid, into position so that the Underwater Launch Platform is exactly under the bottom surface of the canister, even though there is a couple of inches of vertical space between the top edge of the Underwater Launch Platform and the bottom surface of the Canister (see FIG. 16).

This movement to the left by the Positioning Solenoid 238B will commence at a pre-determined time after the Two Suspension Support Rods 227L and 227R have extended out and are positioned in underneath the bottom surface of the canister. Since every canister will “float up” these three or four inches (described above in the first sentence of the previous paragraph) at roughly the same speed, it will be very simple to configure this “time delay” so that the bottom surface of every canister will be higher than the topmost point of the Underwater Launch Platform, before the “Horizontal Positioning Process” is performed by Positioning Solenoid 238B. Since there is no real hurry for this Underwater Launch Platform to get in under the canister, there is no sense of urgency for this Underwater Launch Platform “Horizontal Positioning Process” to be completed in a frantic manner, like there was in the Pre-launch Process, where the overall Launch Platform was even designed in halves, just for the sake of saving a fraction of a second so the Pre-launch Launch Platform could be positioned under a canister in time. The Underwater LM-3 Launch Platform 233 is in one piece, not two halves.

The next step in the Underwater Launch is that the Two Floatation Point Retaining Pins 245L and 245R retract and create an open “Pathway Space” so the canister can start ascending upward towards Alignment Ring 246 and towards the First Coil 247Lwr (see FIG. 1I) in the Floatation-ascent Phase 311. When these Retaining Pins retract, the canister will begin floating upward on its own, powered by the upward force of buoyancy, which is also combined with the Canister Length Pressure Differential Force. However, in the first split second after the Retaining Pins have retracted and before the canister has a chance to begin its initial upward journey through the Fluid on its own power, LM-3 imparts a significant amount of additional upward speed to the canister by applying a tremendous upward force (to the canister's bottom surface) over a vertical distance of, for example, 17 inches (or about two-thirds the length of the Cylindrical Portion of the canister body; also see: Drawing Exceptions #20, which discusses the vertical distance of an Underwater Launch with respect to the pressure differences between the Fluid Pressure in the Underwater Launch Area and the Fluid Pressure in the Lower Part of the “Tight” Portion of the overall Fluid Column).

In that vertical distance through which the canister is being propelled upwards by the LM-3 Launching System there are no Coils for generating electricity, because there can be no “obstructing circular objects” going completely around the body of the canister. The reason for this is that the Launch Platform, as it is ascending, will collide with anything that is totally encircling the body of the canister. There is, however, one Modified Alignment Guide Assembly 241 that is permanently mounted in such as way so that the Cut-out Areas (233N) on the circular edge of the Underwater Launch Platform 233 (FIG. 1I) pass by the Three Alignment Guides in the Modified Guide Assembly without making contact with those Guides, because the Cut-out Areas (233N) in the Underwater Launch Platform are slightly wider than the actual Alignment Guides. The Alignment Guides need to be close to the body of the canister to help provide precise vertical alignment, but the Guides do not necessarily need to be “wide” to provide that alignment.

So LM-3 236 launches the canister upward, the canister begins the Floatation-ascent Phase 311 and then continues ascending through the entire Fluid Side Coil Stack 322. Once LM-3 has finished supplying the required force to the canister, LM-3 moves its Forcer 234 back to the lowest possible “reset” position and LM-3 is ready for the next Underwater Launch. The LM-3 Positioning Solenoid 238B retracts (to the right) immediately after LM-3 has “reset” itself, and therefore as a result of this Positioning Solenoid 238B retracting, the Underwater LM-3 Launch Platform 233 is also pulled back to the right far enough so that the area to the left of the Underwater Launch Platform is clear for the next canister to float-up to the Floatation Point Retaining Pins 245L and 245R. A few seconds will pass, according to the length of a Cycle, and when that “next” canister reaches that position (the Floatation Point 309), the next Underwater Launch will be ready to occur.

### 4. How the Equipment Works on the “Left Side of the Inclined Platform” 60.

FIG. 1A-2 is an enlarged view of the Left Side of the Inclined Platform 60, showing a total of Three Sensors, Four Speed-adjusting Electromagnets, Two Inclined Platform Notch Pins (with Solenoids and attached Springs), Two Drop Point Retaining Pins (with Solenoids and attached Springs), and Two Curved Arc A Pathway Guides. FIG. 1A-2 shows how the device will look at initial start-up and how the Left Side of the Inclined Platform 60 will look every time a new Cycle is ready to begin and a canister (the far left canister on the Inclined Platform 59) is ready to enter the Drop Phase 304. The point where the Drop Point Retaining Pins 81F and 81R are contacting the Leading Surface of the far left canister is called the Drop Point 301. The instant these Retaining Pins 81F and 81R retract, the way will be clear for a canister to begin moving to the left and to subsequently enter the Drop Phase 304 (see Cycle-sequence Descriptions; “Definition of Terms”).

The first event that happens to begin a Cycle is that the Two Drop Point Retaining Pins 81F and 81R retract and gravity then immediately begins pulling the Canister C-1 (in FIG. 1A-2) out-and-off of the Platform to the left. The canister changes direction as it slides over the Two Curved Arc A Pathway Guides 67F and 67R. The canister keeps moving downward and at some point the entire body of that canister comes into True Vertical Alignment, heading downward. This exact point for a canister to achieve True Vertical Alignment is where the Leading Surface of a canister (the bottommost surface when the canister is pointing downward) is slightly below the bottommost point of Curved Arc A Pathway Guide 67F, and this precise vertical point is the Official Beginning of the Drop Phase 304. At that point the canister is beginning to fall straight down towards the Air Side Launch Area 302. During this brief period just described, all the other canisters that are still on the Inclined Platform are being held back (from moving to the left) by the Inclined Platform Notch Pins 88F and 88R.

There is a slight delay (a fraction of a second) between the time the Drop Point Retaining Pins 81F and 81R retract and when the Two Inclined Platform Notch Pins 88F and 88R retract. This delay gives the first canister some lead time to begin moving, although there already was an Air Gap 79 between the Canisters in the #1 Position and the #2 Position, as seen in FIG. 1A-2. Since all canisters will fall off the Platform (to the left at the same speed), the exact amount of Pre-determined Time Delay is the same standard amount of time, each time this overall procedure is executed. The delay is there to make sure that the back surface (the far right surface) of the “falling” canister has enough time to Clear the Drop Point Retaining Pins 81F and 81R (to the left) and that these Two “81 Pins” have time to extend out into their default (reset) position between the time that back surface of the “falling” canister has cleared these Two Retaining Pins 81F and 81R and before the next canister arrives at the Drop Point 301.

So the First Canister has “fallen off” the Inclined Platform 59 (to the left), the Time Delay has occurred, and as a result, the Drop Point Retaining Pins 81F and 81R have extended out into their “reset” (blocking) position. Slightly before that (according to the Pre-determined Timing Sequence), the Inclined Platform Notch Pins 88F and 88R have retracted, and the second canister and third canister (and all other canisters above those canisters to the right on the Inclined Platform) have begun to move in unison (with no separation between them) to the left, towards the Drop Point 301. The C-2 canister (Canister #2) is on its way to becoming the First Canister in the “cue.”

It is important to understand, there are a total of NINE canisters (or more, depending on the embodiment) and inside each canister there is a magnet 77 that potentially weighs 45 pounds (depending on the specific embodiment), so if the individual canister approaching the Drop Point Retaining Pins 81F and 81R was not separated from the rest of the canisters, and/or if no other speed reduction procedures were implemented on this batch of moving canisters (a total of over 400 pounds worth of canisters), then considerable force would be put on the Two Drop Point Retaining Pins 81F and 81R every time the Leading Surface of the First Canister made contact with these Two Retaining Pins. Under these conditions, it would be very difficult for the Two Retaining Pins 81F and 81R to try and stop the entire group of canisters that was coming at these Two Retaining Pins from the right. It is important that each canister makes contact with the Two Drop Point Retaining Pins 81F and 81R as gently as possible, so that the Two Springs, 80SpF and 80SpR (in the Two Drop Point Retaining Pin Systems) will be able to absorb any and all of the “shock” that will result when that contact is made, without any other piece of equipment being damaged or destroyed by an Excessive Impact Event.

For Canister #2 (C-2), as it starts moving left, the first piece of equipment that begins working is the Far Left Motion Sensor 83. The instant this Motion Sensor 83 detects the Leading Edge of Canister #2, the Sensor activates the Two Far Left Miniature Deceleration Electromagnets 82F and 82R. These Two Electromagnets immediately create individual Magnetic Fields and the overall effect of these Two Magnetic Fields is balanced with regards to the magnet inside the canister, because one Magnetic Field is in the front of the canister and one Magnetic Field is in back of the canister. Together, while the magnet inside the canister is on the RIGHT of these Two EMs 82F and 82R, the Two Respective Magnetic Fields will REPEL the Magnetic Field of magnet 77 and therefore there will be an overall Magnetic Counter-force that will help to slow down Canister #2. The Two EMs 82F and 82R hold their Electromagnetic Fields in tact even as the magnet (inside Canister #2) moves past the Two EMs and continues moving away from these Two EMs towards the left. Once the Back-side of magnet 77 has moved to the LEFT of the Two EMs, 82F and 82R, the Two Respective EM Fields will then be Attracting the “Back-side Magnetic Field” of magnet 77, because this “Back-side Field” will have a polarity that is opposite to the polarity on the front side of magnet 77.

This Reversal of Forces is quite acceptable, however, because this Magnetic Attraction (occurring on the left of the Two EMs 82F and 82R) continues to slow down the movement of Canister #2, in the exact same way the Magnetic Repulsion (occurring on the right of the Two EMs 82F and 82R) slowed down the movement of the canister. In any event, the Total and Overall Repulsive and Attractive Forces of the Magnetic Fields of the Two EMs, 82F and 82R, has been pre-calibrated so that a canister will Not be stopped altogether, but in fact the canister will eventually (after a couple of seconds) make contact with the Two Drop Point Retaining Pins 81F and 81R. However, this contact will be “as gentle as possible” as a result of the deceleration sub-process just described. During the time this deceleration process has been occurring, the Leading Surface (front edge) of Canister #3 has always been in contact with the rear surface (the far right surface) of Canister #2.

Also simultaneously occurring during this time, the other FIVE remaining pieces of equipment on the Left Side of the Inclined Platform 60, will be “working” on Canister #3 (C-3), as Canister #3 is in the process of becoming the Second Canister. The Sensor to the far right is the Magnetically-activated Notch Area Sensor 86. The reason why this Sensor 86 is Magnetically-activated is because when the canisters are passing in front of this Sensor 86, the Two Canisters essentially appear to be as one combined unit (the Nose Cone Protrusion 70 of the right canister is perfectly dovetailed into the Matching Carved-out Impression in the back portion of the left canister). Therefore, a motion detector will not be able to tell the difference between the end of one canister and the beginning of another canister.

So when Magnetically-activated Notch Area Sensor 86 magnetically detects the presence of Canister #3, the Sensor 86 immediately does two things. First, it sends a signal that activates the Two Canister-Position #2 Miniature Deceleration Electromagnets 85F and 85R. Each of these Two EMs immediately creates a Magnetic Field that works in opposition to the Magnetic Field of Canister #3. Exactly as described above for the Two EMs 82F and 82R, these Two EMs 85F and 85R will create Magnetic Fields that Repel the magnet inside Canister #3 while the magnet is on the Right Side of EMs 85F and 85R, and then the magnet will be Attracted to the Two Respective EM Fields as the magnet (inside Canister #3) is moving on the Left Side of the Two EMs 85F and 85R.

The one difference between these Two Slowdown Processes (between the “82 EM Fields” and the “85 EM Fields”) is that the strength of the Two EM Fields for the Two EMs 85F and 85R is calibrated to be an overall Stronger Combined Magnetic Field than the combined Magnetic Field Strength of the Two Magnetic Fields generated by the Two EMs 82F and 82R. This will cause Canister #3 to move slower towards the left than Canister #2, so separation will begin to develop between the back surface of Canister #2 and the Leading (front) Surface of Canister #3. This is a natural part of the process, because Canister #2 needs to keep moving over to the Drop Point 301, but Canister #3 will soon need to be completely stopped by the Inclined Platform Notch Pins 88F and 88R, so it is beneficial that Canister #3 be moving slower than Canister #2.

The second thing that this Dual-purpose Magnetically-activated Notch Area Sensor 86 does is to send a signal to the Two Inclined Platform Notch Pins 88F and 88R. Each Solenoid for the individual Notch Pins, 88F and 88R, works on a Dual Pressure System, which means a small amount of pressure is applied by the Solenoid in the First Phase and then in Phase Two, more pressure is applied to allow the Solenoid to reach the end of its stroke. (Note: as mentioned in the Structural Composition Section, the references for 81F, 81R, 88F, and 88R each include the respective Solenoid and respective Plunger as One Component.) So when the Two Inclined Platform Notch Pin Solenoids 88F and 88R get that initial Activation Signal from Sensor 86, these Two Solenoids “gently” try to fully extend their respective Plungers (the actual Notch Pins) into the Notch of Canister #3. But because the Notch of Canister #3 is not yet far enough to the left for this Full Engagement to occur, the Two Notch Pins, 88F and 88R, will remain in a state where the ends of the Two Pins 88F and 88R are applying just light pressure on the round part of the body of Canister #3 (at a spot equal on both side of the canister, and to the left of the upcoming Notch), and therefore these Two “88 Pins” will not have fully extended into the Notch of Canister #3.

The reason for this Dual-Phase Procedure is so that when the Notch does arrive, the Two Pins 88F and 88R will immediately engage into the Notch (instead of having to start from their “retracted” position when the Notch is in front of them) and there will be no chance that the Notch will pass by and go too far to the left, past these Two “88 Pins” altogether, before the Two “88 Pins” can engage into the Notch. These Notch Pins 88F and 88R will remain at this Semi-extended Position and will keep applying light pressure against the outer body of Canister #3, as Canister #3 keeps moving to the left, and therefore the Notch keeps getting closer to the Two “88 Pins.”

As Canister #3 moves further to the left, the Second Canister Position Motion Sensor 84 will detect the front, Leading Surface of Canister #3. At that exact instant when this Leading Surface is detected, this Motion Sensor 84 sends a signal to the Two Inclined Platform Notch Pins 88F and 88R to fully extend. The Solenoids 88F and 88R, for the Two Respective Pins 88F and 88R will “try harder” to extend, and this time there will be success. These Two Notch Pins, 88F and 88R, will fully extend-out and will be perfectly positioned inside the Notch. The reason this procedure works is because the distance between the Second Canister Position Motion Sensor 84 and the Two Notch Pins 88F and 88R has been pre-determined to be the exact distance between the Leading Surface of a canister and the front-left portion of the Notch on a canister. After all of these procedures just described have been completed, the status of Canister #2, Canister #3 (and a fourth canister, not shown) will be such that everything will look exactly as it did in FIG. 1A-2, except that each canister will have moved down One Canister Position to the left. Canister #2 is now ready to begin the next Cycle.

### 5. The Over-Sized Embodiment.

This embodiment includes Five Main Sets of Components: a Low Pressure Fluid Reservoir 406; a Water Turbine combined with an Electric Generator; a Variable Pressure Chamber 414 (combined with a Pair of Canister Pullers); a Fluid Reservoir 419; a Reservoir Exit Launching System 426. In addition, there are six sub-embodiments o the Over-sized embodiment, which are: a) Vertically-expanded Pivot Bucket Area that also uses a Modified Inclined Platform; b) Vertically-expanded Reservoir Exit Launching System that uses Additional Accelerating Electromagnets; c) Vertically-expanded Reservoir Exit Launching System that uses No Accelerating EMs but uses one or more Underwater Linear Motors in the Reservoir Exit Launching System Area; d) Enlarged Underwater Launch Area; e) Quad LM Underwater Launch that utilizes a “Combined Launch” which is powered by Four Linear Motors (and that also uses the Enlarged Underwater Launch Area sub-embodiment); f) Dual Floatation Holding Cues and Canister Sliding Transport.

This Over-sized embodiment (main view in FIG. 1D-oz) is what might be considered as a “Bulk Electricity” Version of the preferred embodiment (which is the “70-home, Neighborhood Co-op” Version) of the MF device. This Over-sized embodiment is not be confused with what was stated above (in “Brief Summary, Technological Impact”) about using a MF to provide electricity to factories or to businesses situated in an industrial complex. The basic size of a MF for an industrial complex is more or less the same size as a MF used to power a 70-home Co-op Local Grid. (Of course, depending on the requirements of any factory located in an industrial complex, there might be two or three standard sized MFs providing electricity to the overall industrial complex.)

However, the Over-sized embodiment of the MF device shown in FIG. 1D-oz relates more to a design for the MF that is absolutely several times larger in scope than anything that could be built in a neighborhood or in an industrial complex, at least for the most part. If there is still a power grid remaining, with long distance power lines so electricity can be transmitted over longer distances (instead of all electricity being created locally by full implementation of MF technology), FIG. 1D-oz shows an embodiment of the MF device where the height of the Coil Stacks could be literally hundreds of feet high. By implementing the Over-sized embodiment of the MF device, a whole matrix of Over-sized MF devices could be built (for example, in some cave-like area, or in a large, hollowed out area inside of a mountain, or in a very, very large hole in the ground), where this “Complex of Devices” would essentially have all of these Over-sized MagnaFloat devices lined up in rows, one device next to another in a very large, uniform matrix of Over-sized MF devices.

Under these conditions, instead of having one Fluid Reservoir 419 for each individual MF, all of the devices in the MF Matrix could actually share one gigantic Fluid Reservoir that could be, for example, hundreds of feet wide, by hundreds of feet long by 40 feet high. The equipment for Each Individual Device (in this Matrix of Over-sized embodiment MF devices) would still exist as shown in FIG. 1D-oz, except the Walls of the Fluid Reservoir for a “Group of MF devices” could be merged to create one single, super-sized Fluid Reservoir that “serviced” this Entire Group of Over-sized MF devices. The advantage of having a Whole Group of Over-sized MF devices sharing one massive Fluid Reservoir would be that the overall temperature of the Fluid could be cooler as a result of this Fluid Sharing Process.

But turning back again specifically to the Over-sized embodiment shown in FIG. 1D-oz, even though the scale is not shown in FIG. 1D-oz, by comparing the length of a canister (shown in FIG. 1D-oz as 399) to the height of the Fluid Reservoir 419 (also shown in FIG. 1D-oz), it can be approximately calculated that for a canister having a 26 inch length (that is, the length of its cylindrical body, not counting the Nose Cone Protrusion 70), the Fluid Reservoir 419 would then be about 40 feet high.

With the individual Over-sized embodiment shown in FIG. 1D-oz, much more electricity is produced by this device than is produced by the standard sized device (the preferred embodiment; the “70-home, Neighborhood Co-op” Version of the MF device) because of the added Coils: a) in the entire Air Side Coil Stack (this “401” reference to a few Coils is only showing perhaps the last 6% of the entire Air Side Coil Stack 321; also see FIG. 21 and Overriding Priorities #3 about how there are actually more Coils in the Lowest Section of the Air Side Coil Stack 401 than what is shown in FIG. 1D-oz) which is Hundreds of Feet High, and situated above what is shown as the Lowest Section of the Air Side Coil Stack 401, and b) on the other side of the device, the Fluid Side Coil Stack 322, which is also Hundreds of Feet High. Even though the entire height of the Over-sized embodiment is not shown, there is really no limit to how high the Two Coil Stacks could be, except the higher the Fluid Side Coil Stack 322 is, the more Fluid pressure there is on a canister's Leading Surface, that is sticking up through the Primary Seal 232 when the canister is waiting for the Pre-launch Process to occur. This Extreme Fluid Pressure for a Fluid Side Coil Stack 322 that is Hundreds of Feet High is a very important issue and is discussed in the latter portion of this Section: 13 Topics; #5, “Over-sized embodiment.”

The Three Launching Processes used in the preferred embodiment, the Air Side (downward) Launch (FIG. 1B), the Pre-launch (FIG. 1H), and the Underwater Launch (FIG. 1I) are all used in the Over-sized embodiment. However, there is no Hydraulic Accumulator Energy Recovery System 314 and in fact all of the equipment shown in FIG. 1D-FIG. 1G is Not used in the Over-sized embodiment, except for the components that are in the upper portion of FIG. 1G; these specific components that are used from the Arc C Area are reshown in FIG. 1E-oz, with the same component reference numbers as those referred to in the preferred embodiment, because these components shown in FIG. 1E-oz are the same exact components, but are being used in both the preferred embodiment and in the Over-sized embodiment.

So as indirectly stated in the previous paragraph, there is no Roller Conveyor, no Slowdown Plungers, no Energy Recovery System and therefore no Electric Generator 175 producing electricity from Recovering and Recycling kinetic energy acquired by slowing down a fast-moving canister (in fact, there is no “Bottom Part of the whole MF device” that was there in the preferred embodiment). However, the added electricity produced by having, for example Two Coil Stacks 200 feet in length (in the Over-sized embodiment vs. having Two Coil Stacks 60 feet in length in the preferred embodiment) more than compensates for the amount of electricity Not produced in the Over-sized embodiment because there is no HAERS 314 recovering-and-converting kinetic energy from the canisters in the Slowdown Area, as there is in the preferred embodiment.

What also happens though, in the Over-sized embodiment, is that during each Drop Phase and each Floatation-ascent Phase, the canisters (and the magnets) will be experiencing much greater heat build-up because these components are making a much greater fall (and ascent). As a technical point, it should be noted that in the Over-sized embodiment the total height of the Coil Stack in the Fluid Column will be a specific distance shorter than the total height of the Air Side Coil Stack. As can be seen in FIG. 1D-oz (on the left side), there are some Extra Coils that exist in the Air Side Coil Stack (the Coils in the Lowest Section of the Air Side Coil Stack 401 will comprise the majority of these Extra Coils) compared to the number of Coils that are in the Fluid Side Coil Stack, because of the height of the Fluid Reservoir 419, where there are No Coils.

In other words, the Fluid Side must sacrifice a specific number of Coils, directly proportional to the height of the Fluid Reservoir 419. For example, if the height of the Fluid Reservoir 419 is 40 feet, then the additional number of Coils on the Air Side would be about 13 feet more worth of Coils (about 30 more Coils), at least as can be approximated by looking closely at FIG. 21. In addition, the Air Side Coil Stack has additional Coils that are not in the Fluid Side Coil Stack, which are those Coils that are Not on the Fluid Side during the combined vertical distances shown in FIG. 1E-oz, FIG. 1H, and FIG. 1I, up to where the first Coil (the lowest Coil in the Fluid Side Coil Stack is located, Coil 247Lwr in FIG. 1I). In the preferred embodiment, the lowest point, vertically, for both Coil Stacks is about the same, and the Arc C Area, the Pre-launch Area and the Underwater Launch Area are all more or less below the Lowest Coil on the Air Side, which is Coil 321BC, shown in FIG. 20.

However, in the Over-sized embodiment, these three areas that are shown in FIG. 1E-oz, FIG. 1H, and FIG. 11, DO have Air Side Coils in those areas on the left side of the MF device, even though there are no Coils on the Right Side of the MF device in those areas. But in the end, for the Over-sized embodiment, there are just a few less Coils on the right side of the device as there is on the left side of the device, because even though many Coils will be “sacrificed” on the left side of the device as just described, there is a large batch of Additional Above Ground Coils (FIG. 36a shows approximately 40 Coils in this area) below the Pivot Bucket, because the canisters “fly so high” into the air as a result of the increased acceleration on the canisters during the 200-foot-plus Floatation-ascent Phase 311.

As FIG. 36a shows, another substantial difference between the preferred embodiment and the Over-sized Embodiment is that with the Over-sized Embodiment, a canister will achieve a much greater height during the “Fly into the Air” Phase 312, as a result of the canister being accelerated for 200 feet or more by the combined upward forces of buoyancy, the Canister Length Pressure Differential Force, and any additional initial velocity a canister receives from the Underwater Launch. By using one canister length (at approximately 26.4 inches) as a multiplying factor, FIG. 36a shows the Pivot Bucket to be approximately 36 feet above the Above Ground Floor 254. Because the Pivot Bucket must be placed so much higher above the Above Ground Floor 254 (or what could also be looked at as being so much higher above the Above Ground Floor for Inclined Platform 61; these Two “Floors” are at the same level, but Floor 254 is over to the right under the Pivot Bucket and Floor 61 is over to the left under the Inclined Platform. In FIG. 36a, these Two “Connected Floors” are shown in the same diagram.), the angle of incline for the Inclined Platform would be too great if the Inclined Platform went straight up to the Pivot Bucket in a linear fashion, like it does in the preferred embodiment.

Therefore, there is a sub-embodiment of the Over-sized embodiment which uses a Downward-sloping 3-sided Modified Circular Guide Rail System 464 (the overall shape of this Modified Platform is similar to the shape of the Circular Upward-sloping Canister Pathway 420) to successfully facilitate the smooth and gradual downward movement of canisters from a considerable height (up near the Pivot Bucket) down to the Drop Point 301. FIG. 36a shows a set of approximately 85 canisters (a few canisters are not shown because the Inclined Platform is “broken off” on the left) waiting in a cue to gradually get down to the Drop Point 301. In this sub-embodiment (the Vertically-expanded Pivot Bucket Area that also uses a Modified Inclined Platform sub-embodiment), the canisters are continuously making their way down to the Drop Point 301, by going around three fairly large loops which the Modified Inclined Platform makes.

As a technical note, FIG. 36b shows how the very top of the Downward-sloping 3-sided Modified Circular Guide Rail System 464 (that last upper portion that holds the top eight canisters), curves back in towards the center of itself, so that the Pivot Bucket 261 will be aligned properly with the top end of this Circular Guide Rail System 464 and therefore the Pivot Bucket can keep depositing canisters onto this Circular Guide Rail System 464 in a smooth and efficient manner.

Some general Initial Overview Information is given in this paragraph, and the next five paragraphs, about the Over-sized Embodiment. It should be noted that FIG. 1D-oz shows a complete array of equipment used in the lower section of the Over-sized embodiment, for both the Air Side portion (left side in drawing) and the Fluid Side portion (right side in drawing), but any such equipment that is operating Inside the Fluid Reservoir 419 will be operating totally underwater, if water is the Fluid used in the Reservoir 419. As was mentioned above, in this Over-sized embodiment there is no Arc B 305, no Slowdown Area 306 (no Slowdown Plungers, no Hydraulic Accumulator Energy Recovery System), and no Arc C 307, but like what was shown in the Arc C Area of the preferred embodiment, in FIG. 1G, the Over-sized Embodiment still utilizes a Pre-launch; Speed-adjusting Electromagnet (EM#2) 195, as shown in FIG. 1E-oz.

In the preferred embodiment a canister moves down and curves to the right (through Arc B), goes horizontal across the bottom of the device (the Slowdown Plunger Area and the Mid-section of the Roller Conveyor Area), and then curves up, on the far right (as the canister goes through Arc C), to finally ascend up into the Pre-launch Area 308. In the Over-sized embodiment, as shown in FIG. 1D-oz and FIG. 1E-oz, a canister comes straight down from the Air Side Coil Stack and enters the Lowest Section of the Air Side Coil Stack 401. The canister then passes through two different types of passageways, moving to the right, and enters a Variable Pressure Chamber 414. The canister then makes its way, climbing upward, through the Fluid Reservoir 419 by using the Upward Sloping 3-Sided Circular Guide Rail System 420. Finally, near the top of the Fluid Reservoir 419, the canister enters the Reservoir Exit Launching System 426.

The canister is still “in Fluid” in the Reservoir Exit Launching System, so by combining the canister's own power of buoyancy, the Canister Length Pressure Differential Force and also with additional upward acceleration applied to the canister by the Reservoir Exit Launching System 426, a canister goes “shooting upward” through the Fluid Reservoir Exit Opening 459 (FIG. 1E-oz), passes through an Alignment Ring 461, and then continues moving straight up into the Pre-launch; Speed-adjusting Electromagnet (EM#2) 195. After that, the canister moves up into the same Pre-launch Area (FIG. 1H) and executes a Coupling Process with another canister that has been waiting in the Pre-launch Area for the Coupling Process to occur.

In addition to the primary advantage of having a MF device that produces more electricity than the preferred embodiment of the device, the Over-sized embodiment in FIG. 1D-oz also provides three other very important benefits. First, this Over-sized embodiment allows the total number of canisters for one MF device to be substantially increased, for example, going from a set of 11 or 12 magnet-canisters in the preferred embodiment to a set of almost 180 magnet-canisters in the Over-sized embodiment [10 canisters on the Inclined Platform 59, one canister always in the Primary Seal 232, about 80 canisters in the Fluid Reservoir 419, another 85 canisters above the ground on the Modified Inclined Platform Circular Cue 464 (FIG. 36a), and at any given time one canister falling in the Air Side Coil Stack and another canister ascending in the Fluid Side Coil Stack].

Second, the Over-sized Embodiment allows the canisters ample time to cool down in a very large body of Fluid, while the canisters slowly make their climb “up through the Fluid” on the Circular Upward-Sloping Canister Pathway 420 (due to the upward slope of the this Pathway 420, the canisters can “float up to the top” by using their own power of buoyancy) to the point where each canister passes through the Curved Interface Pathway Section 424 and then enters the Reservoir Exit Launching System 426. Even in the Reservoir Exit Launching System 426 a canister is still “in the Fluid” (underwater, if water is used as the Fluid). But within approximately 10 seconds after a canister enters the Reservoir Exit Launching System (from the bottom of the Launching System), the canister will have been “Launched” out of (the top of) the Fluid Reservoir 419 by the Reservoir Exit Launching System 426.

Third, in the Over-sized embodiment, the overall horizontal distance of the entire MF device is set at a fixed distance, because there is no need to slow down the horizontal movement (momentum) of a falling canister. Therefore, since the horizontal distance is fixed, regardless of the height of the MF device, the overall height of the device can Potentially be Increased to an Unlimited Amount, except for two problems. The first problem is that of drilling deeper and deeper into the Earth, or constructing a higher and higher building enclosure to house the entire device (especially since the Two Coil Stacks for the Over-sized embodiment could potentially be Hundreds of Feet High). The second problem, discussed below near the end of the upcoming “Technical Explanation” Section (for the Over-sized Embodiment) has to do with the Extreme Fluid Pressure in the entire lower part of the Fluid Column, as the combined weight of Hundreds of Feet of Fluid keeps adding more Fluid Pressure at any given point in the lower parts of the overall Fluid Column [that is: a) the lower part of the “tight” portion of the Fluid Column, and b) the Underwater Launch Area] as the height of the Fluid Column is increased more and more.

### A Complete Technical Explanation on the Operation of the Over-Sized Embodiment, Including any Sub-Embodiments

In the Over-sized Embodiment, a canister starts a Cycle at the Drop Point 301 (FIG. 1A-2) just like in the preferred embodiment and then the canister falls all the way down through the Air Side Coil Stack until it finally reaches the Lowest Section of the Air Side Coil Stack 401. The canister keeps falling and in a split second reaches the bottom of the Lowest Section of the Air Side Coil Stack. However, the canister's motion does not stop at that point and the canister goes directly through the Mouth of the Downward Sloping 3-Sided Guide Rail 402b and enters the Downward Sloping 3-Sided Guide Rail 402. The canister is gently guided to the right by this Guide Rail 402 and the canister is traveling extremely fast. The canister passes Guide Rail Motion Sensor 403. This Motion Sensor sends a signal to the Anti-floatation Stop-pin 407 and this Stop-pin 407 fully retracts. The canisters that are in the Low Pressure Canister Holding Area 409 (in FIG. 1D-oz there are five such canisters) will have a tendency to float upwards, to the left, due to the force of buoyancy, once Stop-pin 407 retracts and the path is clear for the canisters to float up and to the left.

However, the speed of the falling canister is such that the canisters in the Low Pressure Canister Holding Area 409 will have only a fraction of a second to move towards the left before the “falling” canister contacts the furthest left canister in the Low Pressure Holding Area and pushes all the canisters in the Low Pressure Canister Holding Area 409 over towards the right with a reasonable (and regulated) amount of force. The term “regulated” refers to how the exact distance of Fluid a canister travels through before making contact with another canister in the Canister Holding Area 409 can be pre-configured during Test Runs of the device (see next paragraph). Even though the falling canister will be going extremely fast, perhaps 80 to 100 miles per hour when the canister first makes contact with the Fluid inside the Low Pressure Fluid Reservoir 406 (the Fluid Level in the Low Pressure Fluid Reservoir is 406W in FIG. 1D-oz), the Fluid will quickly “break the fall” of the canister.

Therefore, by the time this “falling” canister makes contact with the canister on the far left of the Canister Holding Area 409, the speed of the “falling” canister will be at an acceptable level to push all the canisters about One Canister Length to the right; the “falling” canister should not be allowed to hit the canisters any harder than that. What is meant by “not be allowed” is that adjustments can be made to the exact height differential of Fluid (the total amount of Fluid) in the Low Pressure Fluid Reservoir 406 during a series of “Practice Runs” before the first “official” start-up of the device occurs. In this way the MF device can be configured so the Fluid Level 406W will be exactly at the right height to cause a “falling” canister to push all of the canisters in the Canister Holding Area 409 over just a little more than one canister length to the right, but the impact from a “falling” canister on the far-left canister in this Canister Holding Area 409, Cycle after Cycle, will never be any greater than that.

It is worth noting, however, that the speed at which a canister makes contact with the far left canister does need to be within a certain range, because the canister MUST be going fast enough to push all the canisters over at least one canister length to the right. The back surface of a falling canister Must Move Completely to the right of the Anti-floatation Stop-pin 407, so that when this Stop-pin 407 receives the Activation Signal from the Canister Entry Sensor 408 to fully extend-out and go into the Blocking Mode, by that time the body of the “falling” canister will be completely to the right of the Stop-pin 408, so that the Stop-pin 408 will not be obstructed as it extends out. On the other hand, the canister cannot be going so fast that it pushes all the canisters to the right so hard that the far right canister goes shooting into the inside of the Variable Pressure Chamber 414, or more precisely goes all the way through Chamber 414 and then crashes into the Left Side Surface of the Waterproof Sliding Panel (the Sliding Panel that is on the right side of the Chamber 414, but is not shown separately in FIG. 1D-oz).

There is no similar problem like that with the Left-side Sliding Panel (of the Variable Pressure Chamber 414) because the Left-side Panel, at this point in the “Process,” will need to be open so that the next canister (the one on the left side of the Pre-Pressure Chamber Area 414Pr; that is, the furthest right canister in the Low Pressure Canister Holding Area 409) can be “pulled” into the Variable Pressure Chamber 414. Another way to describe this is that this Left-side Panel will always be open every time a canister completes the Drop Phase and is preparing to enter the Low Pressure Fluid Reservoir 406.

To go back and look at this “Process” from the “falling” canister's perspective, the canister passes the Guide Rail Motion Sensor 403 and then enters the Mouth of Low Pressure Fluid Reservoir Entrance Point 404. At about the point, when the entire body of the canister is inside the Low Pressure Fluid Reservoir 406, the Leading Edge of the canister will encounter Fluid; this Fluid will immediately slow down the speed of the canister. Since the Anti-floatation Stop-pin 407 is in the Retracted State, as mentioned above, the uppermost surface of the far left canister (that is already inside the Low Pressure Canister Holding Area 409) will have moved slightly to the LEFT of the Anti-floatation Stop-pin 407 due to the force of buoyancy trying to move all these (five shown) canisters in the Low Pressure Canister Holding Area 409 up and to the left. The “falling” canister makes contact with furthest left surface of the far left canister just mentioned and the momentum of the “falling” canister pushes all the canisters inside the Low Pressure Canister Holding Area 409 to the right. The Entering Canister Sensor 408 registers when the far left edge (the back edge) of the “falling” canister has moved to the right of the Entering Canister Sensor 408 and at that point a signal is immediately sent to the Anti-floatation Stop-pin 407 for this Stop-pin 407 to extend. As shown in FIG. 1D-oz, the Canister Sensor 408 is permanently positioned just slightly to the right of the Anti-floatation Stop-pin 407, and therefore if the back edge of a “falling” canister is to the right of Canister Sensor 408, then that back edge is also to the right of (has cleared) the Stop-pin 407, as well. Once the Stop-pin 407 extends out completely, the “falling” canister is then “trapped” inside the Low Pressure Canister Holding Area 409; the “falling” canister cannot go to the left past a certain point because the Stop-pin 407 will block its motion.

As shown in FIG. 1D-oz, there is a fairly wide Empty Space directly below the Magnetically-activated Variable Pressure Chamber Sensor 412. However, since the “falling” canister is now also inside the Low Pressure Canister Holding Area 409, that Empty Space will be partially filled up (on the left) with a canister, the canister that was moved over to the right one canister length as a result of the “falling” canister pushing all of the canisters over one canister length to the right. That Empty Space is the Pre-Pressure Chamber Area 414Pr. The Magnetically-activated Variable Pressure Chamber Sensor 412 determines just how strong the Magnetic Field is that is being generated by that “waiting” canister (the far right canister in the Low Pressure Canister Holding Area 409, or put another way, the only canister in the Pre-Pressure Chamber Area 414Pr). This “Magnetic Field Strength” information allows the Sensor 412 to know the precise horizontal position of where this “waiting” canister is. (It seems like this canister being described would have automatically been moved over One Canister Length to the Right, but in case there is any discrepancy in the precise position of the canister, this fact will be recognized by Magnetic Sensor 412).

Sensor 412 sends a signal to the Pre-Chamber Horizontal Canister Puller 413. There is a Belt-type Mechanism (not shown) that moves the Puller-head along the Horizontal Slide Rail of the 413 Puller System. At the instant the Puller-head receives the Activation Signal from Sensor 412, the first thing that happens is that the Puller-head creates a Magnet Field that will be strong enough to form a Magnetic Bond of Attraction between the Puller-head and the magnet inside the canister; the strength of this Magnet Field will be the same every time the Puller-head creates such a Magnetic Field. Then also, according to the information received by the Canister Puller 413 from the Magnetically-activated Sensor 412, the Belt-drive will initially position the Puller-head slightly to the right of the right edge of the magnet inside the canister.

The Belt-drive then moves the Puller-head to the right at a quick pace. The canister is (magnetically) pulled along by the Puller-head until the Puller-head stops, which is over at a point to the far right side of the Horizontal Slide Rail of the Puller Assembly (FIG. 1D-oz or FIGS. 23a and 23b); there is a small Stop-block on the far right side and on the top of the Horizontal Slide Rail, just to the left of the Right-side Puller Assembly Mount. Therefore, the “stopping point” for the Puller-head will always be the same every time the Puller System executes this sub-process and the exact position where the Puller-head stops has also been pre-determined to be a point where the Canister being “pulled” will also stop with its entire body inside the Variable Pressure Chamber 414. The instant the Puller-head reaches the Stop-block, the Puller-head terminates the Magnetic Field and the Belt-drive of the Canister Puller 413 resets the Puller-head to its default position, by moving the Puller-head over to the far left of the Horizontal Slide Rail of the Puller System 413.

Regarding the Variable Pressure Chamber 414, the Left Waterproof Sliding Panel (not shown) of the Pressure Chamber 414 immediately closes at the precise instant when the EM on the Canister Puller shuts off. Pressure Check Valve 415 (in FIG. 23a) has been closed and remains closed. Also, immediately after that, the Right Waterproof Sliding Panel (not shown) of the Variable Pressure Chamber 414 opens. Fluid from the high pressure side (the Fluid inside the Fluid Reservoir 419) immediately comes into the Variable Pressure Chamber 414, or even if the Fluid does not rush in, at least the Chamber 414 instantly becomes pressurized. Immediately after the right Waterproof Sliding Panel has opened, the Post-Chamber Angled Canister Puller 418 is activated. This Post-Chamber Angled Canister Puller 418 is similar to the Pre-Chamber Horizontal Canister Puller 413, except that the Rail of the Canister Puller System 418 is curved slightly and the Puller-head (and the Belt-drive System powering the Puller-head) is operating “inside the Fluid.”

A split second after the Right Waterproof Sliding Panel of the Variable Pressure Chamber opens, the electromagnet on the 418 Puller-head activates and the Belt-drive Mechanism of the Canister Puller Assembly 418 causes the Puller-head to quickly move to the right. (Note: there is no need for a Sensor to detect exactly where the canister is, because the Pressure Chamber is just slightly larger than a canister, so there is no question where a canister is located at this point in the “pulling” process.) Because of the magnetic attraction between the Puller-head and the magnet inside the canister, the canister will “follow along” to the right as the Puller-head moves to the right. The Puller-head will keep moving to the right until the Puller-head reaches the Stop-block on the Semi-horizontal Slide Rail. This Stop-block is the “tiny point” on the bottom of the Semi-horizontal Slide Rail that is about two-thirds of the way over to the right of the Semi-horizontal Slide Rail.

This “stopping point” for the Puller-head (of the Canister Puller 418) will always be the same every time the Puller System 418 executes this process and the exact position where the Puller-head stops has also been pre-determined to be a point where the Canister being Pulled will also stop at a position where the canister's entire body is outside (to the right) of the Variable Pressure Chamber 414. (The canister will now be in that Empty Spot at the beginning of the Upward Sloping 3-sided Circular Guide Rail 420, specifically, the Leading Surface of the canister will be just a little to the left of the Stop-block just described. This Empty Spot is the Post-Pressure Chamber Area 414Pt.)

The canister will now be the first (lowest) canister in the cue of many other canisters waiting to “climb up” to the Reservoir Exit Launching System 426 by moving along the Upward Sloping 3-sided Circular Guide Rail 420. The instant the Puller-head (of the Canister Puller 418) reaches the Stop-block, the Puller-head terminates the Magnetic Field and the Belt-drive of the Canister Puller 418 resets the Puller-head to its default position, by moving the Puller-head over to the far left of the Semi-Horizontal Slide Rail of the Puller System 418. At this point the Right-side Sliding Panel of the Variable Pressure Chamber 414 quickly closes.

As soon as this Right-side Sliding Panel (of the Variable Pressure Chamber 414) is fully closed, the Outlet Port Valve 415 opens and allows the Fluid that is under high pressure inside the Variable Pressure Chamber 414 to move to the left through this Valve 415 and out along the Passageway 414Py; the Fluid is heading over more to the left, towards the Dual Nozzle System, 416NZL (FIG. 25). It should be noted that any Fluid moving inside the Passageway 414Py, as such Fluid exits the Variable Pressure Chamber 414 and moves to the left towards the Fluid Turbine 416W, must also raise itself up several feet. This means some energy will be taken away from the Fluid as this process of the Fluid elevating itself is performed (some kinetic energy will be converted into potential energy).

Exactly how much pressure the Fluid has when coming out of the Variable Pressure Chamber 414 will depend on how high the Fluid Reservoir 419 is. Also, the Passageway 414Py is initially “loaded” with Fluid, almost up to the top of the Passageway (this Fluid Level is seen on the left side of Passageway 414Py and referenced by 414PyW). Therefore, any “new” Fluid being pushed out of the Variable Pressure Chamber 414, as a result of the pressure differential between Fluid under high pressure inside the Variable Pressure Chamber 414 and the “old” Fluid that is basically at ambient air pressure out at the far left of the Passageway 414Py (out by the Fluid Turbine), will be pushing the “old” Fluid out of the Passageway 414Py on the left side, as the “new” pressurized Fluid moves to the left along the Passageway 414Py from the Variable Pressure Chamber 414.

Going back to the canister that has just exited the Variable Pressure Chamber 414, the force of buoyancy allows the canister to slowly-and-gradually make its way up the Upward Sloping 3-sided Circular Guide Rail 420. The canister moves one canister length each time the Top Canister Anti-floatation Pin 423 retracts and allows ONE canister to move over to the right, enter the Curved Interface Pathway Section 424, and then move up into the Reservoir Exit Launching System 426. This slow, upward climb allows the canister ample time to cool down in the Fluid.

Eventually this “original” canister arrives near the top of the Upward Sloping 3-sided Circular Guide Rail 420 and in fact is the second-to-top canister on the Circular Guide Rail 420. The top canister, just to the right of the “original” canister, is being held in position by the Top Canister Anti-floatation Stop-pin 423. Next, this Anti-floatation Stop-pin 423 retracts, which frees up the Top Canister to move, uninhibited to the right, as a result of the force of buoyancy. At the exact moment the Stop-pin 423 retracts, the Temporary Stop Point Electromagnet 421 (EM#1; of the Over-sized embodiment) creates a Magnetic Field that attracts the Magnetic Field of the magnet in the “original” canister. The “original” canister is Momentarily Stopped by this EM Field and the “original” canister remains held in place just long enough so there is separation between the right surface (the Leading Surface) of the “original” canister and the back, far left surface of the Top Canister, that is moving to the right.

The “original” canister is being held in place by EM#1 421 so the Temporary Stop Point Retaining Pin 422 can have the open space necessary to extend itself out without hitting the body of the “original” canister; this Retaining Pin 422 needs to be in a proper Blocking Position during the time it takes for the Top Canister to move to the right and clear the Anti-floatation Stop-pin 423. A pre-determined split second goes by and then the Temporary Stop Point Retaining Pin 422 extends (as a result of the Pin's solenoid making that happen) and immediately after that, EM#1 421 terminates the Magnetic Field it has been generating, so the “original” canister then moves over to the right just a small amount and then is blocked from moving any further right when the “original” canister comes in contact with the extended Retaining Pin 422, that is blocking the canister's path. A brief pre-determined period of time goes by while the Top Canister moves to the right far enough so that the back, far left surface of this Top Canister clears (to the right) the Top Canister Anti-floatation Stop-pin 423.

There is no Sensor to signal the Anti-floatation Stop-pin 423 to extend, but after a specific and brief amount of pre-determined time passes (starting from when the Stop-pin 423 retracted, and because each canister will be “pulled” away from the Anti-floatation Stop-pin at a consistent speed by the Canister Puller Assembly 425; see below), this Anti-floatation Pin 423 extends, which puts this Anti-floatation Pin 423 in a position to Block the “original” canister, that will be making its way over to this Stop-pin 423. At the same instant the Anti-floatation Pin 423 extends, Temporary Stop Point Retaining Pin 422 retracts, and the “original” canister is free to move to the right and become the Top Canister on the Upward Sloping 3-sided Circular Guide Rail 420. The “original” canister floats about one canister length over to the right (and slightly upwards), at which point the Leading Surface of the canister makes contact with the Anti-floatation Pin 423. About four seconds go by and then the Anti-floatation Stop-pin 423 retracts and the “original” canister begins moving to the right, into the Curved Interface Pathway Section 424; this canister is being pulled to the right by the Puller Assembly 425.

As can be seen in FIG. 1D-oz, it is very easy for the Drive-belt Mechanism of the Canister Puller Assembly 425 to precisely position the respective Puller-head slightly to the right of the magnet that is inside a canister being “held” by the Anti-floatation Stop-pin 423. Therefore, at the exact instant the Anti-floatation Stop-pin 423 retracted for the purpose of “releasing” the “original” canister, the Electromagnet on the Puller-head (of the Canister Puller Assembly 425) created a Magnetic Field and therefore this Puller-head gained complete magnetic control over the “original” canister. At that point, the Drive-belt of the Canister Puller Assembly 425 began quickly moving the respective Puller-head over to the right, along the Curved Slide Rail (of the Canister Puller Assembly 425). The Puller-head continued “pulling” the canister all the way over to the right, and up. The canister is moved through the Curved Interface Pathway Section 424, which has a curvature that is parallel to the curvature of the Curved Slide Rail (of the Canister Puller Assembly 425). At the point when the Puller-head reached the Stop-block, in the far right upper portion of the Curved Slide Rail, the EM Field being generated by the Puller-head was terminated and the “original” canister was “released” and at that point was in a position to continue ascending “through the Fluid” under its own power of buoyancy (and with a partial CLPDF, because the canister was not pointing exactly straight-up when it was released by the Puller-head 425).

(Note: as explained in Drawing Exceptions #10, due to lack of space on the drawing page, the curvature of the Curved Interface Pathway Section 424 should be more “flattened out” and in general this Pathway Section 424 should have much more room devoted to it in FIG. 1D-oz.) By the time a canister is actually exiting this Pathway Section 424, the direction of motion of the canister will be basically in perfect vertical alignment. This fact can be further seen by looking at FIG. 29, where it shows there is very little “gap” between the outer surface-edges of a canister and the inner edges of the Four Rails of the Lower Truncated Vertical Quad Alignment Rail Assembly 450a. If a canister was not already in almost perfect vertical alignment before entering this Rail Assembly 450a, the canister could never move through the Rail Assembly and instead would have its body wedged at some angle in between the Rail Assembly 450a and the (curved) surfaces of the Curved Interface Pathway Section 424. This problem is solved by allowing the Curved Interface Pathway Section 424 to basically become “straight” for approximately one canister length before the Pathway Section 424 ends and at the same point “meets-up” with the Lower Truncated Vertical Quad Alignment Rail Assembly 450a. These two components are not touching and are not “connected;” the Pathway Section simply ends around a vertical point where the bottom of the Rail Assembly 450a begins.

So the “original” canister will travel a little more than one canister length through the basically “straight” section (not shown) of Pathway Section 424, after the Puller-head has terminated the related Electromagnetic Field. The canister almost immediately achieves perfect vertical alignment and will be moving with substantial force at that point, as a result of buoyancy AND the CLPDF both acting on the canister. The “original” canister enters the Reservoir Exit Launching System 426 when it makes its first contact with the Rails of the Lower Truncated Vertical Quad Alignment Rail Assembly 450a. This Quad Alignment Rail 450a ensures the canister is in perfect alignment with the other pieces of equipment above the canister, as the canister begins moving further up into the Reservoir Exit Launching System 426. At the top of the Truncated Quad Alignment Rail 450a, the Leading Surface of the “original” canister makes contact with the bottom surface of the same canister that the “original” canister has been “following” all the way up through the Upward Sloping 3-sided Circular Guide Rail 420, except now, both canisters are pointing straight up in a vertical direction. There is also one other canister above the adjacent canister, so the “original” canister is the third canister (the lowest canister) in the Reservoir Exit Launching System 426 (see FIG. 27).

Next, the Two Reservoir Floatation Stop-pin Systems, 455R (and its Left-side Counterpart) fully retract, which allows the topmost canister to begin rapidly moving up towards the actual Launch Area of the Reservoir Exit Launching System 426. [Note: the references for the Floatation Stop-pin System 455R (and its Left-side Counterpart) and for the Reservoir Exit Notch Pin System 452R (and its Left-side Counterpart) all include the Pins (which are the Solenoid Plungers) as the Component of Reference, as well as having each of these references also refer to the overall individual “System.” For example, it is acceptable to say, “the Stop-pin 455R” or also to say, “the Floatation Stop-pin System, 455R.” ]

The Two Lower Canisters do not move upwards at this point, because the Middle Canister, the one directly above the “original” canister, is being held in place because each of the Floatation Stop-pin Systems, 452R (and its Left-side Counterpart), has its “Pin” extended into the Notch of the Middle Canister. A pre-determined amount of time goes by that allows for the Top Canister to move upwards far enough so that its bottom surface has cleared (has moved above) the top edge of the Two “Pins” of the Reservoir Floatation Stop-pin Systems, 455R (and its Left-side Counterpart). Once that time has expired: a) the Two Floatation Stop-pins 455R (and its Left-side Counterpart) extend so they are now ready to Block the next canister that will be coming up to where these “455 Pins” are, and b) the Two Notch Pins 452R (and its Left-side Counterpart) fully retract, thus allowing the Middle Canister to start moving upward so that this canister can become the Top Canister.

The Middle Canister and the “original” canister move upward in unison, as if they are one unit because of the Temporary Merging Effect of the Nose Cone Protrusion 70 (of the “original” canister) fitting inside the respective Matching Carved-out Impression 71 (of the canister above the “original” canister); see Additional Technical Discussions; Canister Section, C. “Nose Cone, Matching Impression Feature.” As the leading (topmost) surface of the Middle Canister moves past Motion Sensor 454 (for Miniature Speed-adjusting Electromagnets 451cR and its Left-side Counterpart), this Sensor 454 causes the Electromagnets in each of the Two Topmost Miniature Speed-adjusting Electromagnets, 451cR (and its Left-side Counterpart) to create a Magnetic Field and these Two Magnetic Fields act in opposition to the Magnetic Field of the magnet inside the Middle Canister (that is now at the point of becoming the Top Canister).

The effect of the counter-magnetic forces slows the upward motion of the Middle Canister, and when the canister reaches the fully extended Pins of the Reservoir Floatation Stop-pin System 455R (and its Left-side Counterpart), the reduced upward impact of the canister against these Two “455 Stop-pins” will still cause the Springs in the Two Stop-pin Systems, 455R (and its Left-side Counterpart) to compress. But because the upward speed of the canister has been reduced, there will be only a minor compression in these Two Stop-pin Springs. The Springs will decompress a little and at that point the upward motion of this now Top Canister will stop.

In the meantime, the “original” canister, which is now becoming the Middle Canister, was proceeding upward as the (now) Top Canister was proceeding upward. However, at the point when the magnet of the “original” canister came in proximity to the Lower Magnetically-activated Sensor 453 (for the Two Lower Miniature Speed-adjusting EM Pairs), this Sensor 453 caused the Two Lower Pairs of Miniature EMs—the Right-side Miniature Speed-adjusting Electromagnet (Over-sized embodiment Miniature EM#1) 451aR (and its Left-side Counterpart) and the Right-side Miniature Speed-adjusting Electromagnet (Over-sized embodiment Miniature EM#2) 451bR (and its Left-side Counterpart) to all create their own Magnetic Fields. These Four Magnetic Fields had the overall effect of slowing down the upward motion of the “original” canister and also slowing down the newly added Lowest Canister that is moving upwards underneath, but moving in unison with, the “original” canister.

At a pre-determined time after the Magnetically-activated Sensor 453 (for the Two Lower Miniature Speed-adjusting EM Pairs) has Sensed the Presence of the “original” canister (as the canister is making its way upward), the Two “Pins” of the Reservoir Exit Notch Pin System 452R (and its Left-side Counterpart) will extend out and will engage into the Notch of the “original” canister (now the Middle Canister). There has been no urgency for these Two Notch Pins to engage into the Notch of the “original” canister, because all upward motion for all the canisters will have been halted by the Two Reservoir Floatation Stop-pin Systems, 455R (and its Left-side Counterpart). In any event, the Two Notch Pins have engaged and are holding the “original” canister in place so that when the Top Canister is released by the Reservoir Floatation Stop-pin System 455R (and its Left-side Counterpart), there will be separation between the Top Canister and the “original” canister, in the exact manner described a few paragraphs above.

The next step in this overall Launch Process is that the “original” canister becomes the Top Canister, in the exact same manner described above. At exactly the right time in the next Cycle, the Two “Pins” of the Reservoir Floatation Stop-pin System 455R (and its Left-side Counterpart) will retract. The “original” canister begins ascending, and first passes through the Mid-Point Alignment Ring 456. Then at a pre-determined time AFTER the Two “Pins” of the Reservoir Floatation Stop-pin Systems 455R (and its Left-side Counterpart) have retracted, the upward acceleration process begins, as the first set of Acceleration Electromagnets (that are at the lowest height) initiate their respective Electromagnetic Fields.

During this launching process that occurs in the upper portion of this Reservoir Exit Launching System 426, many sets of strategically-placed powerful electromagnets keep pulling the respective canister upwards, and so the overall upward acceleration combines these forces with a canister's own force of buoyancy, in combination with the Canister Length Pressure Differential Force. FIG. 43b shows one example of how many sets of these large Reservoir Exit Acceleration Electromagnets (multiple sets of 457aR and its Left-side Counterpart) may be used in this overall acceleration process. FIG. 27 shows that a “set” (all at the same height) could be two Acceleration Electromagnets, but a “set” could include four Acceleration Electromagnets at the same height.

There are five basic keys to creating a successful acceleration process, which are: the size (and power) of each individual Acceleration Electromagnet, the distance each set of Acceleration Electromagnets is above the previous set, maintaining a perfect balance of the EM pulses within a set of “firing” electromagnets that are all at the same height, the overall “acceleration height” of the entire acceleration process, and finally, the timing precision for the firing sequence of the EM pulses—from one set to another.

The first four of these factors will be determined without that much trouble according to trial-and-error and the outcomes really have more to do with physical relationships between the components than anything else. For example, regarding having a “perfect balance” of the EM pulses is basically a matter of making sure each individual Acceleration Electromagnet in the same “set” is exactly the same distance from the vertical centerline that a canister will be ascending up through and making sure all EMs in a “set” fire at exactly the same time, and the size (and power) of each individual EM can be somewhat determined by trial and error in a testing process for a prototype, especially in relationship to the overall height of the entire acceleration process.

So the precision of the firing sequence is perhaps the most important factor, or the factor that has to be controlled perfectly. The goal for each EM set is to have the respective EM Fields “fire” as very short-term pulses that exist just long enough to impart an upward force on the magnet of the ascending canister, but not to exist so long that the magnet in the canister can move higher than the mid-point of the EM Field, because if the pulse is attracting the polarity of the magnet that is on the top half of the magnet, but then the magnet moves too high and the EM field begins attracting the bottom of the magnet, the second part of the effect will be that the EM Field begins pulling the magnet back down towards the EM Field, and this cannot happen.

Every pulse at every height for every set has to only keep pulling the magnet higher, and in fact if each set of EM Fields is considered as one pulse (because this entire pulse is coming from only one height), then one by one, as a pulse begins decreasing in strength because the magnet is moving higher and is therefore moving away from the “last” pulse, the next pulse (being provided by the set of electromagnets above the previous set) is felt to become stronger and stronger by the magnet, as the magnet climbs higher and comes closer and closer to this next set of EM Fields. In this way, each “higher” pulse replaces the previous pulse, and since the next pulse is coming from a location that is higher than the previous pulse, the collective result of the composite upward force on the magnet will feel as if there is only one constantly-accelerating upward magnetic attraction being applied to the magnet and the canister, even though the overall magnetic attraction is actually being provided by a series of individual sets of electromagnets, all at different heights from each other. The bottom line is that the overall effect is to keep adding upward kinetic energy to the motion of the related canister.

[Note: or maybe the EM Fields of each set of Acceleration Electromagnets can be reversed at exactly the right time to “repel upwards” the bottom portion of the magnet, but in any event the sequence of pulses, in relationship to the proper polarities, for each set, from one set to another, can only produce upward acceleration on the magnet.]

This acceleration process has to be accomplished with great precision because the final upward velocity for a canister has to be perfect, within a fairly tight range, in order for the canister to successfully complete a Coupling Process with an upper canister that is waiting up above to make contact with this ascending canister (for a full description of the Coupling Process see 13 Topics; #1, “Coupling Process.”) As discussed in the third paragraph below, there is another sub-embodiment of the Over-sized embodiment that allows for the “original” canister to “Couple up” with the canister that is waiting in the Pre-launch Area, in the same way that canisters in the preferred embodiment coupled up with each other, even though there is approximately three and one-half times more Fluid pressure pushing down on the Leading Surface of the Upper Canister (the canister that is waiting in the Pre-launch Area for the “original” canister to come up underneath it and execute the Coupling Process) than there is in the preferred embodiment.

The “original” canister exits the Fluid Reservoir 419 by passing through the Exit Opening Rubber-like Splash Guard 460, which is mounted over the Fluid Reservoir Exit Opening 459; this Exit Opening 459 is a hole that has been cut-out of the Fluid Reservoir Ceiling 427. The Splash Guard 460 is there to minimize the amount of Fluid that: a) is either “dragged out” by canisters exiting the Fluid Reservoir and/or b) that will be lost due to evaporation. For any Fluid that does evaporate or that passes above the Splash Guard 460, the Fluid can be replenished according to the function of the Fluid Refill Port and Refill Mechanism 462, which also has a Fluid level gauge (not shown) inside the Fluid Reservoir; this gauge, even though it is submerged in the Fluid and is a short distance away from the actual Refill Mechanism, is still considered as part of the overall Fluid Refill Port and Refill Mechanism 462. Finally, the rapidly-ascending canister comes literally “flying out of” the Above-ceiling Alignment Ring 461 and the canister now has enough upward momentum to take it through the Arc C Pre-launch; Speed-adjusting Electromagnet (EM#2) 195 (FIG. 1E-oz) and up into the Pre-launch Area 308 (FIG. 1H).

Any canister being Launched by the Reservoir Exit Launching System 426 will end up with just the right speed at the Coupling Point in the Pre-launch Area, exactly the same as if the canister's speed had been manipulated by the HAERS 314 in the preferred embodiment (except for the fact that in the Over-sized embodiment the Lower Canister needs to be able to execute the Coupling Process in an environment where there is much more Fluid Pressure in the Underwater Launch Area than there was in the preferred embodiment, because of the additional 140 feet of Fluid in the 200-foot high Fluid Column; this subject is discussed in the next paragraph). Just as was discussed regarding the speed a canister needs to have when leaving the Slowdown Area 306 in the preferred embodiment, even with the Over-sized embodiment, there is a Range of Speeds that are acceptable when a canister exits the Reservoir Exit Launching System 426, because the Over-sized embodiment still utilizes the Arc C Pre-launch; Speed-adjusting Electromagnet (EM#2) 195, which has the ability to “tweak” the final speed a canister has at the precise point when the canister is about to enter the Pre-launch Area (see 13 Topics; #1, “Coupling Process”).

However, now comes a discussion regarding one huge difference between the preferred embodiment and the Over-sized Embodiment, and this discussion focuses on the amount of Fluid Pressure that is pushing down on the Leading Surface of the canister that has been waiting in the Pre-launch Area (the Upper Canister), and where such canister has about four inches of its Leading Surface sticking up “into the Fluid,” at a Fluid Depth of approximately 200 feet, for example. This amount of downward force, in an Over-sized embodiment that has a Fluid Side Coil Stack 200 feet high, is approximately three and one-half times more Fluid Pressure Force in the Underwater Launch Area than the Fluid Pressure being “felt” by a canister in the Underwater Launch Area in the preferred embodiment. This amount of additional Fluid Pressure is basically too much pressure for the approaching canister (approaching from underneath) to overcome in the Coupling Process, without other substantial modifications being made to other components (and sections of the MF device) in various areas of this Over-sized embodiment of a MF device.

As was stated above, when the Coupling Process occurs the Ascending Canister must push Both Canisters up about four inches above the point the canisters were at, vertically, when contact was first made between the Two Canisters at the beginning of the Coupling Process. In addition, the combined weight of the Two Canisters can be around 90 pounds in all of these embodiments and sub-embodiments. Then add to that (in the Over-sized Embodiment) a downward Fluid Pressure of three and one-half times more than the Fluid Pressure in the preferred embodiment, and the situation begins to look very doubtful that the Series of Full Sized EMs (457aR, 457bR, etc. in FIG. 27) in the Reservoir Exit Launching System 426 could give a canister enough velocity in the Reservoir Exit Launch to compensate for the large amount of downward forces the canister will be required to overcome in order to make a successful Coupling in the Pre-launch Area, even if the canister only needs to fight those forces and move both canisters up about Four inches (so the two halves of the Pre-launch Launch Platform, 211L and 211R, will have enough room to come in under the bottom surface of the Lower Canister). But there are two ways this “Extra Fluid Pressure” problem can be solved for the Over-sized Embodiment.

The First Alternate sub-embodiment will solve this problem; the Vertically-increased Reservoir Exit Launching System (using Additional Accelerating Electromagnets) sub-embodiment (of the Over-sized Embodiment) extends the vertical distance of the Reservoir Exit Launching System up about 30 feet more (which also extends the entire Fluid Reservoir the same amount, because the Launching System is only one area within the larger Fluid Reservoir 419), compared to the approximate height of only about 10 feet for the Reservoir Exit Launching System 426 for the (original) Over-sized embodiment, as shown in FIG. 1D-oz. This Vertically-increased Launching System is shown in FIG. 34b, and a comparison can be made with FIG. 34a, which shows the original size (original height) of the Reservoir Exit Launching System 426. In this Vertically-increased Launching System (using Additional Accelerating Electromagnets) sub-embodiment, all of the pieces of equipment below-and-including the Curved Pre-exit Canister Puller Assembly 425 (FIG. 1D-oz) remains exactly the same. Also in this sub-embodiment, the Fluid Reservoir Ceiling 427 is about 70 feet above the Subterranean Floor 411 (for the Over-sized embodiment), as a result of the Ceiling 427 being extended up by an additional 30 feet to accommodate the height increase of the Vertically-increased Reservoir Exit Launching System. And of course, the Reservoir Exit Launching System 426 still remains completely “inside the Fluid” (or underwater, if water is used as the Fluid).

So in the Vertically-increased Reservoir Exit Launching System (using Additional Accelerating Electromagnets) sub-embodiment, there is a total of approximately 40 feet of “Launching Height” for this “Enhanced Launching System” 426, which allows a canister to acquire more speed in two ways: a) the force of buoyancy and the Canister Length Pressure Differential Force have about six times more distance and time (during the “Launch”) to accelerate the canister, and also b) this 30 foot height increase allows for an additional six times more Full Size Reservoir Exit Acceleration Electromagnets to be added to the Set of sequentially “firing” EMs, that combined, keep accelerating a canister more and more as the canister moves up through the entire Vertically-increased Reservoir Exit Launching System. [The reason the Additional Force Multiplying Factor is Six for the Accelerating EMs is that in the original Launching System 426 (FIG. 27), it is shown that about the lower FIVE feet of that Ten foot high “original” Launching System 426 (the entire distance below the bottom of Accelerating EM 457aR) is used just to position a canister, vertically, so that the canister is ready to be accelerated by the numerous Pairs of Full Size Reservoir Exit Acceleration Electromagnets, such as 457aR (and its Left-side Counterpart). Therefore, since the additional 30 feet is filled completely with more Acceleration Electromagnets (and a few Alignment Rings), the net result is SIX times more acceleration from the combined forces of all the “Accelerating EM Pairs” in the Vertically-increased Launching System.]

There is Another Sub-embodiment which also uses a Vertically-increased Reservoir Exit Launching System (an additional 30 feet of vertical “Launching Height”) and this sub-embodiment is the “Vertically-increased Reservoir Exit Launching System (using Linear Motor #4)” sub-embodiment (the Over-sized LM-4 sub-embodiment). In this LM-4 sub-embodiment, there are absolutely No Full-size Reservoir Exit Acceleration Electromagnets (457aR, 457bR, etc). Instead, in this sub-embodiment all of the required Vertical Launch Force is supplied by one very large, custom designed Linear Motor. In this LM-4 sub-embodiment, the Launch Process occurring in the Reservoir Exit Launching System Area is basically identical to the Underwater Launch Process for the preferred embodiment, as shown in FIG. 1I and described in the related text explanations, except that: a) the LM-4 Launch Process is being performed under Fluid inside the Fluid Reservoir 419, and b) the size of this LM-4 is 16 to 18 times larger than the LM-3 used in the Underwater Launch Process in the preferred embodiment. The height of the Magnetic Track for LM-4 is approximately 32 feet. (Note: this Over-sized LM-4 Launch Process is Not replacing the Underwater Launch Process that uses LM-3; the LM-4 Launch Process is merely being used to get a canister up into the Pre-launch Area to perform the Coupling Process.)

With either of these Two sub-embodiments, where a multitude of Accelerating EMs are used or where a very large Linear Motor is used, regarding modifications to the Reservoir Exit Launching System 426, this additional 30 feet of overall height for the Fluid Reservoir also has another bonus. Adding approximately 30 feet of height to the Fluid Reservoir creates more pressure differential inside the Variable Pressure Chamber 414, which translates into more pressure-power coming out of the Nozzles 417NZL, which means the Fluid Turbine will spin faster and/or longer and additional electricity will be produced by the Electric Generator 430 (for the Over-sized embodiment; FIG. 25).

However, all of this extra equipment, extra Fluid (or water), extra construction preparation and increased construction costs to build a Fluid Reservoir 419 that is 75% larger (70 ft/40 ft) than the “original” Reservoir 419, will be time consuming and expensive.

Therefore, Another Alternative sub-embodiment that solves this Additional Fluid Pressure problem By Modifying the Underwater Launch Area 310 and Not by modifying the Reservoir Exit Launching System 426 is as follows. This sub-embodiment providing the required and preferred solution is: the Enlarged Underwater Launch Area (Enlarged ULA) sub-embodiment (of the Over-sized Embodiment) and in this sub-embodiment the height of the Fluid Reservoir is Not increased by 30 feet and remains at approximately 40 feet high, as shown in FIG. 1D-oz, and Not as shown in FIG. 34b. In this Enlarged ULA sub-embodiment (of the Over-sized embodiment), instead of increasing the velocity of the canister that will be initiating the Coupling Process (the canister being launched by the Reservoir Exit Launching System), this Enlarged ULA sub-embodiment results in establishing an amount of Fluid Pressure in the Underwater Launch Area that is equal to the amount of Fluid Pressure in the preferred embodiment.

The height of the Fluid Column for the Over-sized embodiment can still be approximately 200 feet, for example, but this Enlarged ULA sub-embodiment (of the Over-sized embodiment) will create more surface area in the Underwater Launch Area, which will therefore decrease the Fluid Pressure at every given point for any height within the Underwater Launch Area. Since Fluid Pressure is the force (in this case, the weight of the Fluid in the Fluid Column) per unit area, by enlarging the area of the Underwater Launch Area (at every point along the vertical axis in the Underwater Launch Area), in proportion to the increase in height of the “tight” portion of the Fluid Column, then the “Unit Pressure” being placed on the Primary Seal and at all other points inside the Underwater Launch Area remains basically unchanged between the preferred embodiment and an Over-sized Embodiment that uses this Enlarged ULA sub-embodiment. There will be almost exactly the same Fluid Pressure throughout the Underwater Launch Area 310, regardless of whether the height of the Fluid Column is about 60 feet (with a “regular sized” ULA) or about 200 feet (with an Enlarged ULA). This Enlarged ULA sub-embodiment (of the Over-sized embodiment) is shown in FIG. 35c.

FIG. 35a shows a completely enclosed Underwater Launch Area that is the size of the “original” Underwater Launch Area used in the preferred embodiment and FIG. 35a also shows that the same plane is used to create the sectional views for Both FIG. 35b and FIG. 35c. For Both FIG. 35b and FIG. 35c, the “tight” portion of the Fluid Column is basically cut in half, so that 50 percent of the “tight” portion of the Fluid Column is shown in the drawings and 50 percent is not shown. What can also be seen from the comparing the drawings is that: a) in FIG. 35b, about 67% of the Total Depth of the Underwater Launch Area is shown (the “depth” is the distance going away from the viewer), and b) in FIG. 35c, about 81% of the Total Depth of the Underwater Launch Area is shown. In any event, FIG. 35b shows the size of the “original” Underwater Launch Area used in the preferred embodiment, so the Two Horizontal Surface Sizes (the “surface area” at any height) can easily be compared, because the height of the Underwater Launch Area is the same in both embodiments (as shown in FIG. 35b and FIG. 35c).

However, there is more to this discussion, because enlarging the Underwater Launch Area does decrease the Fluid Pressure at any point within in the Underwater Launch Area, but creating a Fluid Column that is about 200 feet tall still means there is a much greater level of Fluid Pressure in the lower areas of the “tight” portion of the Fluid Column. What this means then is that when a canister moves upwards and out of the Underwater Launch Area and the body of the canister first begins to try and enter the bottommost point of the “tight” portion of the Fluid Column, there will be an EXTREME PRESSURE DIFFERENTIAL between the pressure being felt on the lower part of the canister (the part that is still in the Underwater Launch Area) and the upper part of the canister (that is beginning to enter and is continuing to move further up into the “tight” portion of the Fluid Column). On a much smaller scale, this Pressure Differential Variation already exists even in the preferred embodiment. FIG. 15 shows that the Fluid Column 320 is actually a combination of two rectangular shapes (of course, in reality, the Fluid Column is a 3-dimensional object). There is a “tight” Fluid Column portion on top of a “wider” Fluid Column portion.

The “tightness” in the “tight” part of the Fluid Column can be understood quite well, as shown in FIG. 1J. The “almost square” boundaries of the inside surfaces of the Four Walls of the Fluid Column 320W are only slightly larger than the Outer diameter of a Coil. In one embodiment, the INNER diameter of a Coil is approximately 8.875 inches to accommodate a magnet-canister that has an 8 inch diameter magnet inside a canister that has an outer diameter of 8.375 inches (meaning the walls of the canister 69H are 0.1875 inches). In such an embodiment, all the Coils in the MF device (and of course not counting any Speed-adjusting Electromagnets) have an outer diameter (about) 1.38 times their inner diameter. This results in an outer diameter of a Coil that is (about) 12.25 inches. As FIG. 1J shows, there is some moderately thin Hardware used in the Fluid Side Coil Stack 322. So in such an embodiment being discussed, and according to what can be seen in FIG. 1J, the Walls of the Fluid Column in the “tight” section basically form a square; the inner dimensions of that square, based on the inside surfaces of the Four Walls of the Fluid Column 320W, are approximately 14 inches by 14 inches (for an embodiment that uses a canister with an outer diameter of about 8.4 inches). In addition, when trying to find the Fluid Pressure at a specific depth, the area of the Hardware at that depth has to be subtracted away from the overall Surface Area at that depth, because the Hardware is not adding Fluid Pressure, it is just “taking up space,” in regards to any Fluid Pressure calculations.

With all this in mind, the analysis needs to focus on the Underwater Launch Area, as shown in FIG. 1I, FIG. 35b and FIG. 35c. The height of the Underwater Launch Area can be defined as a distance that starts at the bottom from a point on the top surface of the Bottom Partition (Floor) of the Fluid Column 230 (shown in FIG. 1I) and continues up to the bottom edge of the Walls of the “tight” section of the Fluid Column 320W. In other words, the height of the Underwater Launch Area includes any vertical space that exists below the “tight” portion of the Fluid Column. Looking at this in FIG. 1I, even though it is not shown in FIG. 1I (see Drawing Exceptions, #4), the bottommost point of the Walls of the Fluid Column 320W would be somewhere in that short vertical distance between the bottom of the Alignment Ring 246 and the top of Wall Mount 245MW (for the Left Floatation Point Retaining Pin Solenoid). Another way to say this is that the bottommost point of the Walls of the Fluid Column 230W for the “tight” portion of the Fluid Column is at the vertical level where the Angled Piece of the Vertical Support Beam System 248 meets the long, Main Vertical Support Beam of the Vertical Support Beam System 248 (also shown in FIG. 1I).

When determining the volume of space that is considered to be “the Underwater Launch Area,” the height has just been established. Once again looking at FIG. 1I, the width goes from the left side to the right side, and the “depth” is the distance going away from the viewer. So it might be safe to say that for any given height in that volume, the Hardware is taking up between 10% to 20% of the Surface Area. For the sake of this Sample Sub-embodiment being described, the Hardware is determined to take up 13% of the Surface Area at any height in the Underwater Launch Area, and a) the Inside Wall Dimensions of the width and depth of the Underwater Launch Area are (about): 55 inches wide (going from left to right) and 20 inches deep (going away from the viewer), and b) the height is (about) 38 inches. This makes the average Surface Area of Fluid for any given height in the Underwater Launch Area (approximately) 957 square inches. (This is 87% of 55×20; 87% being used because at any given height, there is 87% Fluid and 13% Hardware)

In the preferred embodiment, the total height of the Fluid Column is about 60 feet (720 inches). Since the height of the Underwater Launch Area is about 38 inches, the height of the “tight” portion of the Fluid Column is about 682 inches (720-38). In one sub-embodiment of the Over-sized embodiment, the height of the Fluid Side Coil Stack is 200 feet, or 2,400 inches (this is the “tight” portion of the overall Fluid Column for this sub-embodiment, and does not include the additional 38 inches of Underwater Launch Area). So the weight of the Fluid pushing down on the Underwater Launch Area, in this “200-foot Coil Stack” embodiment is 3.52 times the weight of the Fluid pushing down on the Underwater Launch Area in the preferred embodiment (2400/682). “Pushing down on” can also be taken to mean “pushing at any point inside of” because Fluid Pressure acts on all points equally, at any given height. The purpose of this analysis is to show approximately how much wider and deeper the Underwater Launch Area must be to achieve a result that yields about the same level of Fluid Pressure as there was in the preferred embodiment, at any given height within the Underwater Launch Area. It is true that by increasing the size of the Underwater Launch Area, this will add even more Fluid-weight to the Underwater Launch Area, itself, but the amount of extra Fluid-weight is very small, even with an Expanded Underwater Launch Area, compared to the Fluid-weight of all the Fluid in the “tight” portion of the Fluid Column, which is about 200 feet tall.

In order to increase the surface area in the Underwater Launch Area 3.52 times, there needs to be a total Surface Area, not counting the Hardware occupying the space at any height, of approximately: 3,368 square inches (3.52×957). Therefore, if the size of the Underwater Launch Area is increased to a volume that is approximately 92.23 inches wide×35 inches deep×38 inches high, there would be approximately the same amount of Fluid Pressure in the Underwater Launch Area for both the preferred embodiment and for an Over-sized Embodiment that is also using an Enlarged Underwater Launch Area sub-embodiment. Specifically that is to say there would be an equal force, in both scenarios, pushing down on the Leading Surface of a canister that is sitting in the Pre-launch Position, where the Leading Surface of that canister is sticking up into the Fluid about four inches above the Primary Seal 232 (like the “phantom canister” PhC-Uw shown in FIG. 1I).

However, to get the True Dimensions of the Underwater Launch Area in the Enlarged Underwater Launch Area sub-embodiment (of the Over-sized embodiment), the surface area of the Hardware at any given height needs to be “added back in” to the depth and width dimensions, for the particular volume being discussed. So the actual inner wall size of the Underwater Launch Area for this scenario is approximately: 106 inches wide×40.23 inches deep×38 inches high (1/0.87×92.23 and 1/0.87×35).

But unfortunately what this Enlarged ULA sub-embodiment does is to simply move the problem of High Fluid Pressure from one point on the vertical axis to another. However, what will now be described will demonstrate how there is an advantage to increasing the “inside wall dimensions” of the Underwater Launch Area to the approximate size of: 106 inches wide×40.23 inches deep×38 inches high, in order to solve the overall problem of Additional Fluid Pressure in the Over-sized embodiment. The next challenge for this Enlarged ULA sub-embodiment is that now LM-3 must provide a much more forceful Underwater Launch.

The reason for this is that prior to the Underwater Launch, the entire canister body will be sitting in relatively Low Fluid Pressure in the Underwater Launch Area. But just three or four inches above the Floatation Point (just an inch or so above the tip of the Nose Cone Protrusion on the canister), there is extreme downward pressure from the weight of 200 feet of Fluid being “forced” into a fairly narrow Surface Area (approximately 14 inches by 14 inches, which is the inner wall size of the “tight” portion of the Fluid Column). So the amount of force supplied by LM-3 236 must be enough to get the Entire Canister up into the “tight” portion of the Fluid Column. In other words, for an embodiment where a canister length for the cylindrical body of the canister is about 26.4 inches (not counting the Nose Cone Protrusion), any canister being launched into this Extreme Fluid Pressure that exists up inside the “tight” portion of the Fluid Column will be fighting millimeter by millimeter to keep climbing upwards against a very powerful force of 200 feet of Fluid above the canister. With regards to the “tight” portion of the Fluid Column, Hundreds of Feet of Fluid is being constricted into a fairly “tight” space and the concentrated weight of all of this Fluid is pushing down very hard against the Leading Surface of the canister (during the Underwater Launch) and is attempting to stop that canister from even being able to ascend far enough (about 26.4 inches) so that the bottom surface of the canister is up inside this “tight” portion of the Fluid Column.

Until the Entire canister is up inside the “tight” part of the Fluid Column, there will be very little buoyancy and virtually No Canister Length Pressure Differential Force. In order for the canister to experience the Canister Length Pressure Differential Force, the pressure differential has to be such that the pressure pushing up on the bottom surface is more than the pressure pushing down on the top (leading) surface of the canister. But the exact instant the bottom surface of the canister is fully up inside the “tight” portion of the Fluid Column, there will be a rush of tremendous upward pressure pushing up on the bottom surface of the canister. However, as long as that bottom surface of the canister is in the Underwater Launch Area (below the bottom edge of the “tight” portion of the Fluid Column), there will only be a very minimal amount of force (pressure) pushing up on that bottom surface of the canister. This unfortunate fact is a result of Expanding the Surface Area of the Underwater Launch Area for the sake of making it easier for the Reservoir Exit Launch System 426 to provide enough upward force so a successful Coupling Process can occur.

So understanding that the Enlarged Underwater Launch Area sub-embodiment WILL allow for a successful Pre-launch, even with a Fluid Column that is about 200 feet tall, all attention can now be totally focused on the next event, the Underwater Launch. Even though the main purpose of the Underwater Launch for an Enlarged Underwater Launch Area sub-embodiment is to get the bottom surface of the Canister Completely up inside the “Tight” portion of the Fluid Column, it is still valuable for a canister to have some initial velocity (remaining upward kinetic energy) after the canister is fully up inside the “tight” portion of the Fluid Column. This initial velocity does not necessarily need to be approximately 15 mph, as a canister has at the end of an Air Side Launch, but an initial velocity of around 10 mph for a canister is a worthwhile target speed.

Plenty of electricity will be generated by the additional 300+ feet of Coils in the overall MF device for the Over-sized embodiment, so there is no real need to “squeeze out” each watt of electricity by trying to achieve a “maximum” amount of initial velocity in the related Enhanced Underwater Launch. The only requirement for the Underwater Launch in the Over-sized embodiment is to move a canister upwards and completely out of the “low pressure” and make sure the bottom surface of that canister is allowed to experience the “high pressure” inside the “tight” portion of the Fluid Column. Once that happens, the canister will go shooting up towards the Fluid Column Exit Point 315 “like a rocket” being launched and also the canisters will have almost 200 feet to keep accelerating during this Expanded Floatation-ascent Phase. The instant that bottom surface of the canister is feeling this “tight/high pressure,” the Canister Length Pressure Differential Force will come into effect and the canister will be moving with a total upward force approximately equal to 1.135 times the force of gravity, and this will continue for about 200 feet.

The advantage of this Enlarged ULA sub-embodiment is that it is much easier to control the amount of force needed-and-applied to get the canister up through this difficult 26.4 inches (about one canister length), which starts from the point where the Leading Surface of the canister first encounters the bottom of the “tight” portion of the Fluid Column and ends when the bottom surface of the canister is fully up inside the “tight” portion of the Fluid Column. An efficient and successful Underwater Launch can be achieved by allowing a sophisticated Linear Motor (a customized LM-3) to apply that force in a very defined and controlled launch environment.

This type of sub-embodiment, using the Enlarged ULA sub-embodiment, is in comparison to trying to accelerate a canister to just the right speed within a very tight Range of Speeds, but trying to do so starting 15 feet or 30 feet or 40 feet below the Pre-launch Area, by having a long “chain” of Accelerating Electromagnets (in a Vertically-increased Reservoir Exit Launching System, using Additional Accelerating Electromagnets sub-embodiment) supplying the precise upward force required to combat this Additional Fluid Pressure described above. Regardless of how much Fluid Pressure is pushing down on the Upper Canister's Leading Surface during the Coupling Process, the Ascending Canister still MUST HAVE the exact amount of kinetic energy (must have the proper velocity, within a specific range) so that there is not too much extra force or too little force. Allowing the Coupling Process to proceed Without the burden of overcoming an additional 140 feet of Fluid pressure, but then dealing with that Extreme Pressure Issue in one clean, precise and controlled Underwater Launch performed by a Customized LM-3 Launching System, is how the Enlarged ULA sub-embodiment can be successful. This Enlarged Underwater Launch Area sub-embodiment is the key to having a properly functioning MF device that delivers the added electricity of about 300 Extra Feet of Coils (140 extra feet of Coils on each side of the device and at least an additional 20 feet of additional Above Ground Coils, as shown in FIG. 36a).

In view of the fact that more Underwater Launching Power is required in the Enlarged Underwater Launch Area sub-embodiment, to overcome the additional Fluid Pressure at the bottom of the “tight” portion of the Fluid Column, the LM-3 required for this particular kind of Underwater Launch can be custom built. However, Another Alternate Sub-embodiment of the Over-sized embodiment utilizes FOUR LM-3s, which are positioned in a Four-quadrant configuration, using a Launch Platform that is in Four Sections, where each section is attached to a separate Linear Motor. This sub-embodiment is: the Quad LM Underwater Launch sub-embodiment (of the Over-sized embodiment). FIG. 37a and FIG. 37b show the configuration for the Launch Platform for this sub-embodiment, where there are Four Equally-shaped and Equally-sized Launch Platform Sections: LPQ1, LPQ2, LPQ3, and LPQ4. When the Four Positioning Solenoids that are connected to these Four Platform Sections push these Four Sections together, then the result is a United Cone-shaped Protrusion that is in the middle of the overall Underwater Launch Platform (as seen in FIG. 37a).

This United Cone-shaped Protrusion, which is an integral part of the Underwater Launch Platform for the Quad LM Underwater Launch sub-embodiment is the same shape and size as the Nose Cone Protrusion 70 (seen in FIG. 2a). This United Cone-shaped Protrusion adds additional stability to a canister during an Underwater Launch, because the Launch Platform is not just pushing the canister from the bottom surface, but is in fact also applying upward force to surfaces “directly up inside” the lower portion of the canister. In addition, all such forces applied “directly up inside” the canister are balanced within the interior of the canister and Circular Rings of Upward Force are applied equally at every height inside the canister where this United Cone-shaped Protrusion is making contact with the inside of the canister and pushing the canister upwards.

FIG. 38 shows Two of the Four Positioning Solenoids and related Interface Mounting Components that connect the respective Two Individual Section (of the Four Sections of the overall Launch Platform) to the respective Two Linear Motors. All components above the Underwater Launch Area, for this Quad LM Underwater Launch sub-embodiment, are exactly the same as what is shown in FIG. 1I, which includes everything above the Lower Quadrilateral Alignment Guide Assembly 242, and also includes the Lower Quadrilateral Alignment Guide Assembly 242. One difference, however, regarding this equipment is that the Vertical Structural Support Wall 249 in this Quad LM Underwater Launch sub-embodiment is wider than in the other embodiments and also the base of this Vertical Structural Support Wall 249 is mounted in a different location and is also mounted in a different manner.

The Modified Quadrilateral Guide Assembly 241 and the Modified Quadrilateral Guide Assembly Additional Mount 241M are not used in this sub-embodiment. These two components are not necessary: a) because the Nose Cone Protrusion of the Combined Quad LM Underwater Launch Platform (after Launch Platform Sections LPQ1, LPQ2, LPQ3, and LPQ4 combine, as shown in FIG. 37a) will help stabilize and vertically align the canister that is being launched in the Underwater Launch, and b) for the reason stated in the next two paragraphs.

As seen in FIG. 37a, after the Four Sections of the Quad LM Underwater Launch Platform are combined (pushed tightly against each other), there are Four Angular “gaps” in the overall horizontal plane, based on the shape of the individual Platform Sections and on the angle that each Section is retracted along by its respective, individual, Positioning Solenoid. These “gaps” allow for Sets of FOUR Stand Alone Canister Guides, such as 100F and 100R (in FIG. 1B) to be used to help add more Guidance to all canisters being Launched in the Underwater Launch Process. The vertical distance of the actual Underwater Launch in this Quad LM Underwater Launch sub-embodiment is approximately two to three feet (in other words, the vertical distance the Four Forcers travel from the “default” position at their lowest point, to their highest point when the LMs stop applying upward force to the canister).

One Set of Four Stand-alone Canister Guides can be positioned for approximately every foot of vertical height over those two to three feet of “launching distance,” similar to what is shown in FIG. 1B, except in FIG. 1B the Air Side Launch is headed downward instead of upward, and also there are only Two Guides in a Set (for example, the Upper Set in FIG. 1B, the “100 Set” and the Lower Set in FIG. 1B, the “101 Set”). In other words, where in FIG. 1B the Air Side Launch Platform 93 had Two Notches (93N) cut out of the Launch Platform 93 so there would be room for the Launch Platform to miss hitting the Stand-alone Guides (that must be close-in to the body of the canister to serve any substantial Guidance purpose), because of the inherent Angular “gaps” in how the Four Platform Sections join together in the Quad LM Underwater Launch sub-embodiment, no Notches are required to be cut-out of the Quad LM Underwater Launch Platform, as was required in the Air Side Launch Platform 93. FIG. 38 does not show these Multiple Sets of Four Stand-alone Canister Guides just described.

Unlike in the Pre-launch Process in the preferred embodiment, where the purpose of using Two Halves of the Launch Platform was to save time in getting the Pre-launch Launch Platform in underneath the Two Canisters, this Quad LM Underwater Launch sub-embodiment (of the Over-sized embodiment) uses the Four Launch Platform Quarters so that the upward power of the Underwater Launch can be Four times as much. There is no “frantic hurry” to push the Four Individual Sections of this Quad Launch Platform together. Each individual LM-3 works together with the other Three LM-3s to make one unified launch (as was done in the Pre-launch Process of the preferred embodiment, where Two LMs worked together in unison to make one launch), but the composite upward force of these Four Motors acting together as One Unit will result in an upward force strong enough to easily propel any canister upwards with enough initial velocity so that the canister's entire body can overcome the additional Fluid Pressure in the “tight” area of the Fluid Column (resulting from about 200 feet of Fluid above the Underwater Launch Area). Therefore, this Multi-Motor Underwater Launch can efficiently move a canister all the way up inside this “tight/pressurized” area of the Fluid Column.

It should be noted that there is obviously a relationship between exactly how many LMs are used to make this “Enhanced Underwater Launch” and the “Distance of Acceleration” needed so that a canister can acquire the necessary “release velocity” (upward kinetic energy) in order for the canister to fully ascend up into the “tight” portion of the Fluid Column. Two other sub-embodiments (of the Over-sized embodiment) exist, where instead of using Four LMs for the Enhanced Underwater Launch: a) Two LMs are used and b) Three LMs are used. In both of these sub-embodiments, the Launch Platforms are configured so Stand-alone Canister Guides can be positioned where needed, as described two paragraphs above. The choice of whether to use Two LMs, Three LMs or Four LMs is dependent on: a) the Launching Force applied by the specific model of LMs used, b) the overall height of the specific model of LMs, and c) how much additional Net Launching Velocity should remain after a canister has fully entered the “tight” portion of the Fluid Column. As stated above, it is still desirable for a canister to have “initial velocity” when moving through the entire Floatation-ascent Phase 311, for the sake of generating additional electricity in the Fluid Side Coil Stack and in the Above Ground Coils.

### 6. Dual Arc C Roller Sections Sub-Embodiment.

There is a Dual Arc C Roller Sections sub-embodiment of the preferred embodiment. Compared to the “original” preferred embodiment, there are considerable differences regarding the equipment used, required or not required in the Arc C Area (FIG. 1G vs. FIG. 41A) and in the Pre-launch Area 308 (FIG. 1H and FIG. 1H-4 vs. a Pre-launch Area that uses only one Linear Motor and that is positioned in the rear, facing straight towards the front). Specifically, the Dual Arc C Roller Sections sub-embodiment provides Two almost identical “Roller Sections” (a Left and Right Section, 201 and 202, respectively; seen in FIGS. 39, 41A and 41E) and a Net-catch Canister Transport Area 366 (in FIG. 41B). Use of this sub-embodiment totally eliminates the Coupling Process described previously and also virtually eliminates all of the equipment shown in FIG. 1H, except for the Two Notch Grip Systems 219F and 219R, and all of the related components used to support these Two Notch Grip Systems. Also, the equipment shown in FIG. 1H-4, related to the operation of the Two Suspension Support Rods 227L and 227R is used in this sub-embodiment. Instead of having Two Pre-launch Linear Motors (218R and its left-side counterpart) that are positioned on the left and right sides of the Pre-launch Area 308 (in the preferred embodiment), this Dual Arc C Roller Sections sub-embodiment uses only One Pre-launch Linear Motor that is positioned directly in the rear of the Pre-launch Area and this One Linear Motor faces directly towards the front of the Pre-launch Area (towards the viewer in FIG. 1H). This One Linear Motor configuration is shown in a non-detailed manner in FIG. 43A and this Pre-launch Linear Motor has a reference 531. However, even though FIG. 43A is a drawing for another sub-embodiment altogether, the exact same configuration of having only ONE Pre-launch Linear Motor facing towards the front is used in both sub-embodiments.

It should be noted that the original preferred embodiment that uses the Coupling Process: a) is a much more efficient, time-sensitive method to prepare a canister for a Pre-launch Process, b) is physically streamlined, and c) uses only ONE pathway to get each and every (lower) canister ready for the Pre-launch Process to take place. In the preferred embodiment, a Lower Canister simply comes into Pre-launch Area 308 through one simple pathway, pushes the Upper Canister up a few inches, and then falls directly back down onto the Two Pre-launch Launch Platform Halves (211L and 211R). But as mentioned above, pushing the top portion of the Upper Canister up into a highly pressurized Fluid Column (in the Underwater Launch Area), and doing so with the precise amount of kinetic energy, Cycle after Cycle, is a very technical undertaking and in the end, is only one method that can be used to prepare two canisters (upper and lower) for the Pre-launch Process. The Dual Arc C Roller Sections sub-embodiment uses a larger physical space but in both overall processes (the first “original” embodiment and this sub-embodiment), about the same amount of equipment is required. The “original” preferred embodiment that uses the Coupling Process and the Dual Arc C Roller Sections sub-embodiment will both work successfully, but having two distinctly different options to accomplish the same result allows for twice as much experimentation, in terms of making advancements to the overall MF technology.

The need for having this “dual system” that uses Two Arc C Roller Sections (201 and 202) and duplicate Net-catch Areas (Left-side and Right-side, 396Ar and 397Ar, respectively) is so that a canister can be “fed” onto Pre-launch Launch Platform 398 about every five seconds. This “Feeding” Area where canisters are “deposited” onto Pre-launch Launch Platform 398 is shown in FIG. 41B. This rate of “canister processing” is necessary to comply with the Five Second Cycle Rule. Using the Dual Arc C Roller Sections sub-embodiment will allow for this “five second schedule,” but more specifically, the Five Second Cycle Rule becomes a Ten Second Cycle Rule for each individual “side.” In other words, each “side” will have 10 seconds to “process” a canister.

This “10 Second Processing Time” starts when a canister first enters a particular Roller Section (coming in horizontally, as shown in FIG. 41A) and includes that canister: a) rising up through one of the Arc C Sections, b) entering the Net-catch Canister Transport Area 366 (by coming through either Alignment Ring 371 or 381), c) “flying up into a Net,” d) dropping back down onto the respective Transport Carriage, e) having the Transport Carriage rotate a few degrees so the Transport Carriage is making contact with Pre-launch Launch Platform 398, f) using a system of Two Linear Motors, a Claw Positioner and the Positioner Backstop to transfer the canister off of the Transport Carriage and onto the Pre-launch Launch Platform, and then g) getting the Claw Positioner and the Positioner Backstop clear of the vertical pathway Pre-launch Launch Platform 398 will be using, so the Pre-launch Process can begin.

One of the main features of the Dual Arc C Roller Sections sub-embodiment is that it utilizes a Pullout Roller Section 350 which allows a sizeable “chunk” of the Left Arc C Roller Section 201 to be “retracted” out of the way, thus allowing for a canister to proceed “through this missing portion of Rollers” and move onto other Rollers 122R in the (duplicate) Right Arc C Roller Section 202. It should be noted that the Left Net-catch Area 396Ar is directly above the Left Arc C Roller Section 201 and the Right Net-catch Area 397Ar is directly above the Right Arc C Roller Section 202. These conditions must exist because in either case, left side or right side, canisters travel upwards in a straight vertical path out of the respective Roller Section and up into the respective Net-catch Area. There are still the same speed adjustment procedures used in the Two Roller Sections (201 and 202) that were used in the preferred embodiment (using an upper and lower sensor system and a speed-adjustment EM). However, the level of precision of these “speed adjustments” has a larger range (or larger “margin of error”) in the Dual Arc C Roller Sections sub-embodiment because instead of one canister precisely coupling with another canister in the Pre-launch Area, in the Dual Arc C Roller Sections sub-embodiment, a canister is simply “caught in a Net” (396Nt or 397Nt) at the peak of the canister's ascent in the related Net-catch Area (396Ar or 397Ar).

One of the other main features, as mentioned two paragraphs above, is that there is a “horizontal transport system” (seen in the upper middle of FIG. 41B) and the equipment and techniques used in this “transport process” allows the system to have total control over the vertical stability of a canister as that canister is being transferred (pushed over horizontally) from a “Transport Carriage” (a Left or Right Carriage, 375 or 385, respectively) onto Pre-launch Launch Platform 398.

Turning to FIG. 41A, a canister is shown entering the Left Arc C Roller Section 201; we know the canister is entering the “left side” because the Pullout Roller Section 350 is Not in the retracted state. Since canisters are continuously alternated from ascending through the Left and Right Roller Sections (201 and 202, respectively), it does not matter which “side” this explanation starts with, but according to how the drawings are, this explanation will start with a canister ascending through the Left side. So in the description to follow, a canister will pass through Left Arc C Roller Section 201 and then its Direction of Motion is manipulated by Vertical Angle Adjustment Electromagnets (VAA EMs for the Left side, 197a, 197b, and 197c; see FIG. 41E for these references). Also, explanation about this “angle manipulation” process is provided above in the description related to the processes occurring in the Arc C Area, for the preferred embodiment). As a result of the combined effect of these VAA EMs, the canister is heading upward with True Vertical Alignment before the Leading Surface of the canister enters Alignment Ring 193 (see FIG. 1G from preferred embodiment). Just as in the preferred embodiment, the speed of the canister is analyzed and adjusted by the Upper and Lower Motion Sensor Systems, 194 and 196 (referenced in FIG. 41E), working in conjunction with the Arc C Pre-launch; Speed-adjusting Electromagnet (EM#2) 195. This speed adjustment procedure is instantaneously performed through one or more EM Pulses sent out by EM#2 195 and the canister keeps ascending and exits the Arc C Roller Sections Area 201.

The difference in this sub-embodiment compared to the preferred embodiment is that the “target speed” for a canister is not a speed that will provide for a successful “Coupling Process.” Instead, the “target speed” is one that will ensure a canister climbs all the way up into a Catcher Net (396Nt for the Left-side pathway) that is situated in the top portion of the Net-catch Canister Transport Area 366.

Before moving ahead to discuss the Net-catch Canister Transport Area 366, an explanation regarding the operation of Retracting Solenoid 351, in relationship to the movement of Pullout Roller Section 350 needs to be given. Both Speed and Motion Sensors 197S (shown in FIG. 41E but referenced in FIG. 1G) and 198S (in FIG. 41E) not only detect the leading surface of a respective canister (for the sake of activating the respective Vertical Angle Adjustment EMs), but also detect the bottom surface of a respective canister. This process of detecting the bottom surface of a canister is what triggers the operation of the Retracting Solenoid 351, so that Pullout Roller Section 350 can be moved back and forth, on a cycle-by-cycle basis.

In order for Speed and Motion Sensors 197S to have detected a canister, this means that Pullout Roller Section 350 must have been in the extended mode and was guiding that respective canister up through Left Arc C Roller Section 201. In just a split second after Speed and Motion Sensors 197S detects the bottom surface of a canister, the bottom surface of that ascending canister will have moved completely above the topmost point of Pullout Roller Section 350. Therefore, when the bottom surface of a canister is detected by Speed and Motion Sensors 197S, a signal is sent to Retracting Solenoid 351, causing this Retracting Solenoid to enter the retracted mode and this action pulls the attached Pullout Roller Section 350 back out of and away from this Left Arc C Roller Section 201. This action creates an access passageway for the next canister approaching these two Roller Sections, and therefore such “next” canister can simply pass through Left Arc C Roller Section 201 and continue moving horizontally until this “next” canister begins making contact with Right Arc C Roller Section 202.

In the same type of process, as the bottom surface of this “next” canister is detected by Speed and Motion Sensors 198S, then the same type of signal is sent by Speed and Motion Sensors 198S to Retracting Solenoid 351, and the result of receipt of such signal is that Pullout Roller Section 350 is extended forward to the point that all of the passive rollers attached to Pullout Roller Section 350 are firmly re-positioned back into Left Arc C Roller Section 201, thereby creating a condition where the next canister-like object that approaches these two Roller Sections will ascend up into Left Arc C Roller Section 201 in a normal fashion, because all of the passive rollers in this Left Arc C Roller Section 201 are positioned in their normal location.

Turning now to FIG. 41B, as a result of previous actions, an unreferenced canister is being elevated in a Pre-launch Process, and that is shown in the top middle of the drawing. Regarding the “current” description for the canister that just ascended through the Left Arc C Roller Section 201 (in FIG. 41A), this ascending canister next encounters Alignment Ring 371 in the lower left portion of Net-catch Canister Transport Area 366. (Note: as mentioned in Additional Drawing Exceptions and Comments #26, when a canister is passing through Alignment Ring 371, the Left Transport Carriage 375 will be “pulled over to the far left” as shown in FIG. 41G.) The canister keeps ascending based on its own momentum (which is a function of how the speed was regulated by EM#2 195), and the canister's upward ascent will peak around the point when the Leading Surface of the canister is making contact with Catcher Net 396Nt in the Left-side Net-catch Area 396Ar (as shown in FIG. 41B). This Catcher Net 396Nt will stretch upwards a little bit, but the Catcher Net will absolutely stop the upward motion of the canister.

To back-up a little in this process, as the canister's Leading Surface is exiting, upward, through Alignment Ring 371, the canister's Nose Cone Protrusion 70 will be passing in front of Motion Sensor 372S. This Motion Sensor 372S works with the Three “396 (left-side) EM Retainers,” 396a, 396b, and 396c. and also sends a time-delayed signal to Left Rotational-positioning Solenoid 373 so Left Transport Carriage 375 can be rotated in under the canister at the proper time.

With regards to suspending a canister in a vertical position up by the respective Catcher Net, the goal for either of the Sensor Systems, 372S or 382S is for the Three respective EM Retainers to initiate EM Fields precisely when a canister is being “caught” by the respective Catcher Net, which in this case is Catcher Net 396Nt. If these Three EM Retainers initiate their EM Fields too soon, the result will be that the combined EM counter-effect will tend to push the canister back down a certain amount (or at least slow the canister's rate of ascent), Before the canister's ascent has had a chance to “peak,” and this “peaking event” should only happen when the canister's Leading Surface has made contact with the respective Catcher Net (or some of the Nose Cone Protrusion has passed through the Catcher Net).

What this does, if these Three EM Fields are initiated too soon, is to basically cancel out all the sophisticated analysis and speed adjustment procedures performed by Sensor Systems 194 and 196, in combination with the Speed-adjustment work EM#2 195 (or 195R in Right Arc C Roller Section 202) has performed. So as a result of Sensor System 372S working properly, EM Retainers 396a, 396b, and 396c will all three simultaneously initiate their respective EM Field precisely when the canister's upward ascent has peaked and the canister's upward momentum is temporarily stopped by the respective Catcher Net. Even though the combined EM effect of the three EM Retainers (to simultaneously be attracting the magnet inside the canister from Three directions) will not be enough to totally suspend the canister (perhaps weighing 50 pounds) in mid-air for several seconds, the effect that does occur is that by combining: a) the “stopping effect” of the Catcher Net at b) exactly the same time the “stopping effect” of the Three Retaining EMs is initiated, the canister shown in FIG. 41B will be Temporarily suspended in the Catcher Net just long enough so Left Transport Carriage 375 can be rotated in under the canister by Left Rotational-positioning Solenoid 373. This operation can be accomplished successfully because: a) the actual Degree of Rotation of the Left Transport Carriage 375 is very small, b) the Left and Right Rotational-positioning Solenoids (373 and 383, respectively) are both very powerful Solenoids, and c) the actual time to perform this rotation procedure will take no more than one second.

The Three EM Retainers will maintain their EM Fields at a constant level for approximately one second, but there is communication between the Left Rotational-positioning Solenoid 373 and these Three “396” EM Retainers, so that when the Left Rotational-positioning Solenoid has moved the Left Transport Carriage in underneath the bottom surface of the respective canister, individual signals are simultaneously sent to each of these “396” EM Retainers by the Left Rotational-positioning Solenoid, and these signals cause the individual EM Fields to be gradually reduced, simultaneously, according to a structured pattern of decreasing strength in the Fields that will be the same every time for each Cycle of operation. The goal of these Three EM Fields for this portion of the overall process (when a canister is falling back down out of the Catcher Net) is that the combined effect of the Three EM Fields will cause the respective canister to descend down onto (to semi-fall down on top of) the Ball Bearings 375BB of the respective Transport Carriage as gently as possible. (These Ball Bearings, 375BB and 385BB, are permanently embedded into Carriage Platforms 375P and 385P, respectively, for the Left and Right Transport Carriages.)

The overall combined shape of the Left Transport Carriage Wall System 375CrgW is such that a canister descending down out of Left-side Net-catch Area 396Ar will end-up being centered between the Three Walls (front, back, and curved-left) of Left Transport Carriage 375 and the same situation applies for Right-side Net-catch Area 397Ar and Right Transport Carriage Wall System 385CrgW. The next step in the process, which is triggered on a time-delay after the Three EM Retainers have fully terminated their respective EM Fields and which specifically happens a split second after the canister has “landed” on Carriage Platform 375P (of Left Transport Carriage 375), is that Left-side Linear Motor 391LM will move Left Upper-Lower Claw Positioner 390 a tiny distance over to the right so that the top Claw Positioner Arm will be making contact with the left side of the canister and the bottom Claw Positioner Arm will be engaged into the Notch 73 of the canister (as in FIG. 41C).

[Note: Since all canisters will be landing on the respective Transport Carriage (left 375 or right 385) at about the same place (front to rear and left to right), this “contact” by both Arms of the Claw Positioner can be achieved by having the respective Linear Motor (left or right, 391LM or 393LM) move the Claw respective Positioner a pre-determined amount each time this process occurs. In addition, since the canister in this description is going to be pushed about nine inches to the right anyway, “contact” will definitely be made sooner or later by both the Upper and Lower Arms of the Claw Positioner.]

As described two paragraphs above, Linear Motor 391LM has moved Upper-Lower Claw Positioner 390 over enough to the right so the Two Arms of this Claw Positioner 390 are making contact with the left side of the canister. The overall Linear Motor System 391LM is made so that when Linear Motor 391LM has reached that exact horizontal position (every time this procedure is conducted; this position is shown in FIG. 41C), a signal is sent to Left Transport Carriage 375 and these Two components, Linear Motor 391LM and Left Transport Carriage 375, move in a synchronized manner a very short distance to the right (where Claw Positioner 390 is moving in a linear, horizontal manner at exactly the same “net” speed Left Transport Carriage 375 is moving in a rotational manner). This “very short distance” is a horizontal distance that goes halfway between what is shown in FIG. 41C and FIG. 41D.

At that exact “halfway spot,” contact will be made between the right side of the canister and the left side of Positioner Backstop 394. The overall Linear Motor System 391LM is made so that when that exact horizontal position is reached, a signal is sent to Linear Motor 395LM and this signal causes Linear Motor 395LM to also begin moving in a synchronized speed to the right, in unison with Linear Motor 391LM and Left Transport Carriage 375. The result of these three components moving at a synchronized speed is that as the bottom of the canister is moved a little more to the right, the upper portion of the canister is being pressed in between the Left Upper-Lower Claw Positioner 390 and Positioner Backstop 394.

This process just described provides a very stable environment for the movement of the canister to the right. The goal for the movement of these three sub-systems is that the Two Arms of Claw Positioner 390 and the left edge of Positioner Backstop 394 will all stay in contact with the respective surfaces of the canister as Left Transport Carriage 375 is being rotated this short rotational amount of approximately five degrees. However, it is not mandatory that such constant contact be maintained by the Claws of the Claw Positioner and/or by the Positioner Backstop during this brief period of movement, as the Left Transport Carriage is being rotated towards Pre-launch Launch Platform 398. The amount of time required to perform this rotational procedure is about one second.

As explained six paragraphs above, the Left Rotational-positioning Solenoid 373 will have given a signal to the Three “396” EM Retainers to gradually terminate their respective EM Fields, and for every Cycle, the length of time it will take for a canister to descend down onto the respective Transport Carriage will be almost exactly the same, and therefore at a pre-determined time after that “termination signal” was sent, the respective Rotational-positioning Solenoid can begin rotating the respective Transport Carriage some more. In the scenario being described, Left Rotational-positioning Solenoid 373 rotates Left Transport Carriage 375 this very small pre-determined (rotational) amount, and the end result of this rotation (seen in FIG. 41D) is that the right edge of Carriage Platform 375P (of Left Transport Carriage 375) makes contact with left edge of Platform Component 398P (of Pre-launch Launch Platform 398).

Around the same time this “rotational movement” is being performed, the “Next” canister arrives in the Right Arc C Roller Section 202 (as shown in FIG. 41E).

Continuing with FIG. 41D or turning to FIG. 41F, since the Two Platform Components 375P and 398P of the Left Transport Carriage and the Pre-launch Launch Platform, respectively, are totally covered with a matrix of embedded Ball Bearings (375BB and 398BB), and since at this point the Two Platform Components (375P and 398P) are at the same height and are touching each other in the proper place, the canister can easily be “transported” off of Left Transport Carriage 375 and onto Pre-launch Launch Platform 398. This process is performed as a continuation of the description from two paragraphs above. The Two Linear Motors (391LM and 395LM) move in synchronized fashion to the right, and therefore the canister is “vertically stabilized” by the Left Upper-Lower Claw Positioner 390 and by Positioner Backstop 394 as this “transporting process” is quickly performed.

At the same time the canister is moved from Left Transport Carriage 375 to Pre-launch Launch Platform 398, the “Next” canister has ascended all the way up through Right Arc C Roller Section 202 and now this “Next” canister is beginning to enter Net-catch Canister Transport Area 366. As seen in FIG. 41F: a) the “First” canister has been completely transferred onto Pre-launch Launch Platform 398, b) that canister is still being pressed in between Left Upper-Lower Claw Positioner 390 and Positioner Backstop 394, and c) the “Next” canister is moving up through Alignment Ring 381 (on the right side of Net-catch Canister Transport Area 366).

What must happen now is that Left Upper-Lower Claw Positioner 390 must withdraw to the left (out of canister Notch) and Positioner Backstop 394 needs to move a couple of millimeters to the right to give ample clearance for the Pre-launch Process to be initiated. The “Next” canister will continue ascending through Alignment Ring 381 and will ascend all the way up into the Right-side Net-catch Area 397Ar.

FIG. 41G shows that: a) Left Upper-Lower Claw Positioner 390 has not only moved to the left a little (out of the way of the canister), but has also moved totally over to the far left, to the reset/default position, b) Left Transport Carriage 375 has also been rotated to the reset/default position and is on the far left, next to Left-side Vertical Support Beam 369L, c) Positioner Backstop 394 has moved to the right, out of the way of Pre-launch Launch Platform 398 and Positioner Backstop 394 is now already in the proper horizontal position to act as a Backstop for the “Next” canister, when Right Upper-Lower Claw Positioner 392 begins pushing that “Next” canister from the right to the left (towards the Pre-launch Launch Platform), d) the “Next” canister has continued to ascend up into Catcher Net 397Nt, e) Right Transport Carriage 385 has been rotated (by Right Rotational-positioning Solenoid 383) so that this Right Transport Carriage 385 is now directly underneath the “Next” canister, and f) the Pre-launch Process has started for the “original” canister, as can be seen because the canister and Pre-launch Launch Platform 398 are now both elevated to a vertical position higher than they were in FIG. 41F.

It is important to note, that there is one final difference in this sub-embodiment from the preferred embodiment, and that has to do with the “Release Processes” for: a) the Two Suspension Support Rods 227L and 227R, and b) the Two Notch Grips, 219F and 219R. In the preferred embodiment, this “Release Process” was initiated when a (Lower) canister ready to perform the Coupling Process passed in front of Sensor 217US (in FIG. 1H). But as stated in the first paragraph of this Dual Arc C Roller Sections sub-embodiment section, No component shown in FIG. 1H is used in this sub-embodiment, except the Two Notch Grips, themselves, and any components used to support these Two Notch Grips, 219F and 219R. Therefore, the “Release Process” that causes: a) the Two Suspension Support Rods 227L and 227R, and b) the Two Notch Grips, 219F and 219R, to enter the retracted mode and release the canister being supported, vertically, by the Two Suspension Support Rods, and stabilized, horizontally, by the Two Notch Grips is triggered by almost simultaneous signals going first to the Two Suspension Support Rods, and then to the Two Notch Grips, and where all such signals are sent by the Pre-launch Linear Motor.

Specifically, when the Pre-launch Linear Motor reaches a vertical point where the Leading Surface of the canister that is being elevated (by the Pre-launch Linear Motor) is making gentle contact with the bottom surface of the canister being suspended, all of these signals sent by the Pre-launch Linear Motor cause these four solenoid-related components to go into a retraction mode and respectively retract the Two Suspension Support Rods out from underneath the suspended canister and then also retract the Two Notch Grips out of the Notch of the Upper Canister. These related actions thereby “release” the canister and allow the canister to become freely moveable in a vertical direction. At that point this Upper Canister is sitting directly on top of the Lower Canister, and this Lower Canister is sitting directly on top of the Pre-launch Launch Platform 398.

To go back a little bit, however, and to return to the overall Net-catch Canister Transport Area 366, and to expand on the “a” portion from three paragraphs above describing events before a canister is elevated, regarding the Left Upper-Lower Claw Positioner 390 withdrawing to the left and moving the Two Claws away from the canister (and the Positioner Backstop 394 moving a couple of millimeters out of the way of the Pre-launch Launch Platform), individual “confirmation signals” are sent to the Pre-launch Linear Motor (a Linear Motor similar to Linear Motor 531 in FIG. 43A) so the Pre-launch Process can begin. Specifically in this case being described, Left-side Linear Motor 391LM sends one signal (confirming that its Lower Claw has withdrawn from the Notch in the canister) and Middle Linear Motor 395LM sends the other signal, confirming that it has “moved a few millimeters” out of the way. BOTH signals must be received by the Pre-launch Linear Motor before the Pre-launch can begin. If the canister had been coming from the right side of the Net-catch Canister Transport Area 366, Right-side Linear Motor 393LM and Middle Linear Motor 395LM would be the components sending these confirmation signals.

Once all confirmations are received that there are no obstructions to elevating the Pre-launch Launch Platform 398, the Pre-launch Launch Platform and the respective canister are elevated to the first stopping point described two paragraphs above. Once the four respective solenoid-related components have withdrawn, and confirmation of the completion of all these actions is received by the Pre-launch Linear Motor, the Pre-launch Linear Motor performs a standard Pre-launch Process and elevates the Lower Canister a second time, stopping the Pre-launch Process at a vertical point where the Lower Canister is at the exact height the Upper Canister was at when the Upper Canister was being suspended by the Two Suspension Support Rods 227L and 227R. Once these four respective solenoid-related components have extended out into the proper horizontal position, and confirmation of the completion of all these actions is received by the Pre-launch Linear Motor, then this Pre-launch Linear Motor moves downward and in the end, Pre-launch Launch Platform 398 is reset to be at the proper vertical position so that the Next Canister can be received by this Pre-launch Launch Platform, and where this Next Canister will be coming from the other side of this Pre-launch Launch Platform.

### 7. Dual Floatation Holding Cues and Canister Sliding Transport Sub-Embodiment.

There is a Dual Floatation Holding Cues and Canister Sliding Transport sub-embodiment of the Over-sized embodiment. This sub-embodiment uses the power of buoyancy for upward motion to totally replace Reservoir Exit Launching System 426 (best seen in FIG. 27). The whole purpose of the Reservoir Exit Launching System 426 (in the Over-sized embodiment) is to accelerate a canister fast enough so the canister can ascend up into the Pre-launch Area 308 and perform a successful Coupling Process with an Upper Canister. But just like with the Dual Arc C Roller Sections sub-embodiment (of the preferred embodiment), for the Over-sized embodiment there is also another way to get a canister onto the Pre-launch Launch Platform without having the canister perform the Coupling Process. This “other way” uses the totally natural upward force of buoyancy in the First, Second, and Third Steps of a 5-Step Process that starts by pulling a canister out of Variable Pressure Chamber 414 and ends by depositing that canister on Pre-launch Launch Platform 519. (FIG. 42E shows when a canister is ready to be “deposited” and FIG. 42F shows the equipment that deposits the canister onto Pre-launch Launch Platform 519).

The Five Steps in the overall process are: a) pulling a canister out of Variable Pressure Chamber 414 and “pulling” that canister to the Mouth of a Vertical Guide Rail System (502 or 503); b) allowing the canister to float up into a Floatation Holding Cue (499L or 499R); c) causing the floating canister, in an organized and systematic manner over a period of about 90 seconds, to move along the channel of the respective Floatation Holding Cue towards the innermost Cue Position; d) elevating the canister out of the Fluid (above the respective Floatation Holding Cue) by using a Vertical Positioning Linear Motor and also keeping the canister vertically aligned during the elevation process by using a set of Four functionally-related components that form a temporary “bounding box” around the canister while the canister is being elevated; e) moving the canister, horizontally, about 10 inches (for an 8-inch diameter canister) by suspending the canister and at the same time sliding the entire “suspension system” horizontally, where this sliding motion is powered by a Horizontal Transport Linear Motor 539.

At the end of this “sliding process,” when the canister is centered directly over Pre-launch Launch Platform 519, the Pre-launch Linear Motor System takes control of the process and carefully and cautiously moves the Pre-launch Launch Platform up to meet the bottom surface of the suspended canister, instead of the “elevation and transport system” simply releasing the canister and letting it fall down onto Pre-launch Launch Platform 519. After Pressure Switch 548 confirms that the canister is properly “seated” onto Pre-launch Launch Platform 519, a “Release Process” occurs where Two EM Grippers (540EM and 541EM) terminate their Magnetic Fields and simultaneously Notch Suspension Arm 542 withdraws from the Notch of the canister. The overall Suspension System is moved a little more, horizontally, to get out of the way of Pre-launch Launch Platform 519, and at that point the Pre-launch Process begins.

And just as with the Dual Arc C Roller Sections sub-embodiment, the Five Second Cycle Rule becomes the “Ten Second Rule” because of using a left side and a duplicate mirror-image right side to process canisters through.

Since this Dual Floatation Holding Cues and Canister Sliding Transport sub-embodiment starts out with a group of approximately eight canisters in each of the Floatation Holding Cues, the 90 seconds mentioned above in the Third Step is not an issue regarding time, because there is always a canister in a Cue ready to be elevated in the Fourth Step. So in terms of second-by-second requirements, each canister needs to go through: a) the First and Second Step and b) the Fourth and Fifth Step in a combined total of eight seconds, which leaves two seconds at the end for the “Release Process” and for the Suspension System to be moved a centimeter or so out of the way of Pre-launch Launch Platform 519.

Turning now to FIG. 42A, the Dual Floatation Holding Cues and Canister Sliding Transport starts by taking a canister out of Variable Pressure Chamber 414 (which is the exact same component used in the “regular” Over-sized embodiment and shown in FIG. 1D-oz). It should be noted that virtually all of the equipment shown on the right half of FIG. 1D-oz (the equipment that is “inside the Fluid”) is Not used in the Dual Floatation Holding Cues and Canister Sliding Transport sub-embodiment except that Two Canister Puller Assemblies are used (like components: 413 and 418). So this also means that all of the equipment in the Reservoir Exit Launching System 426 (in FIG. 50) and also the equipment in FIG. 1E-oz is Not used.

FIG. 42A shows the equipment that is used, and the overall process starts by Curved Puller Assembly 501 pulling a canister out of Variable Pressure Chamber 414. This Puller Assembly 501 knows a canister is “ready to be pulled out” when Puller Assembly 501 receives a signal from Variable Pressure Chamber 414 that the Chamber has retracted the Waterproof Sliding Panel (on the right side of the Chamber). This action of Variable Pressure Chamber System 414 of retracting the Right-side Waterproof Sliding Panel creates a clear pathway so a canister (such as Canister C51 in FIG. 42A) can be moved to the right and out of Variable Pressure Chamber 414 altogether.

It should be noted that there is a definite discrepancy in the “Flow of the Sequence” in the related drawings, 42A through 42F, but this discrepancy does not really matter. Just as with the Dual Arc C Roller Sections sub-embodiment, canisters being processed in the Dual Floatation Holding Cues and Canister Sliding Transport alternate from “going up through” the right side and then the left side. The “discrepancy” just mentioned is this: the sequence of drawings starts out by showing a canister going up through the RIGHT side (FIGS. 42A-42C), but then in FIGS. 42D-42F the steps shown (and described) explain the processing of a canister on the LEFT side (coming out of the Left Floatation Holding Cue 499L). The explanation for the Steps in FIGS. 42D-42F would be the same if the canister were in the Right Floatation Holding Cue 499R, except there would be a few “horizontal mirror image” statements and all of the equipment in the steps described below related to FIGS. 42D and 42E would have an “R” instead of an “L.”

Turning back to FIG. 42A, each and every canister being taken out of Variable Pressure Chamber 414 is “pulled out” of Chamber 414 ONLY by Puller Assembly 501 because Puller Assembly 500 is not able to go far enough over to the left so that Puller Head 500PH can “magnetically reach” a canister coming out of Variable Pressure Chamber 414. FIG. 42A shows the initial default condition for one situation that will happen in the future (that is shown in FIG. 42B) and FIG. 42A also shows another situation that has just happened in the immediate past.

Regarding what Will happen, and using FIG. 42A as a reference point: it can be seen that the Waterproof Sliding Panel (on the right side of Chamber 414) is in the “retracted state” and that means there is a clear pathway for Canister C51 to be moved out of the Chamber 414 altogether. Therefore, Puller Assembly 501 will immediately be receiving the “start signal” (this signal comes from Chamber 414) and at that point Puller Assembly 501 will create a Magnetic Field in Puller Head 501PH. In addition, Puller Head 501PH will begin (magnetically) pulling Canister C51 to the right and out of Variable Pressure Chamber 414. Because the previous canister (C52) is going to ascend up through Vertical Guide Rail System 503, Canister C51 will be ascending up through Vertical Guide Rail System 502. Therefore, when Puller Assembly 501 begins pulling Canister C51 out of Variable Pressure Chamber 414, this pulling process will continue in one continuous motion and Puller Head 501PH will maintain its “magnetic power” over Canister C51 long enough to keep moving Canister C51 to the right, and up, in a curved trajectory along Slide Rail 501SRL. As a result, before the magnetic field in Puller Head 501PH is terminated, the front portion of Canister C51 will be pulled all the way into the “Mouth” of Left Vertical Guide Rail System 502 (this result is shown in FIG. 42B).

[Note: FIG. 42A shows Puller Head 501PH in its default position on the far left of Slide Rail 501SRL, which is a horizontal position where Puller Head 501PH can get close enough to the magnet inside a canister (that is in Variable Pressure Chamber 414) so that the magnetic attraction between Puller Head 501PH and the Magnet inside the canister is strong enough that Puller Head 501PH can actually pull the canister out of Variable Pressure Chamber 414.]

Regarding the situation that Just Happened, and once again using FIG. 42A as a reference point, Puller Head 501PH has brought Canister C52 out far enough to the right so Lower Semi-horizontal Puller Assembly 500 was able to take over moving Canister C52 over to the right. FIG. 42A shows that Puller Head 500PH has moved Canister C52 as far to the right as possible and that Puller Head 500PH has just terminated its EM Field, thereby “releasing” Canister C52 so that the canister is free to “float up” through the Right Vertical Guide Rail System 503, due to the force of buoyancy that will be moving Canister C52 upwards.

Also shown in FIG. 42A is that both Left Retaining Solenoid 505L and Right Retaining Solenoid 505R are keeping the canisters floating in a tightly organized “Cue” within a respective channel for each of the respective Floatation Holding Cues, because when the respective Plungers of these Two Retaining Solenoids are fully extended (as in FIG. 42A), the Plungers of the Solenoids and blocking the “outside” canister in the respective Floatation Holding Cue from floating further “towards the outside” (floating to the left in the Left Cue or floating to the right in the Right Cue).

[Two items to note: a) there is no method to stop a canister at the top of a Vertical Guide Rail System (502 or 503), so for example, a canister reaching the top of the Right Vertical Guide Rail System 503 will seamlessly keep moving out of the Guide Rails and up into the Right Floatation Holding Cue 499R, and b) the Fluidline is indicated, and a canister will have enough buoyancy to float-up to a vertical point (inside a Floatation Holding Cue) that is approximately shown in these related drawings. In other words, FIG. 42A is showing an arbitrarily-chosen portion of each of the “ascended” canisters that is sticking up above the Fluidline, which is a distance of about 30% of the overall length of a canister body (not counting the Nose Cone Protrusion 70). The exact percentage by which a canisters “sticks out of the Fluid” while floating in the channel of a Floatation Holding Cue will be a precise function of how much the magnet weighs inside the canister and exactly how long and how wide the canisters is. The distance of about 30% that a canister “sticks up” above the Fluidline was chosen to be a realistic and definitely possible distance based on the anticipated weight of the magnet and the approximate volume of the canisters being used in the preferred embodiment (which is the same exact size of canisters used for the Over-sized embodiment).]

By the time a canister is at the top of either of the Vertical Guide Rail Systems (502 or 503), a Vacant Cue Position in the respective Flotation Holing Cue will have been created for the canister to “float up” into. FIG. 42B shows a space being created (in Right Floatation Holding Cue 499R) for Canister C52. What has happened in FIG. 42B is that as Right Retaining Solenoid 505R has withdrawn (retracted to the rear away from the canisters), the rather long Right Positioning Solenoid Plunger 504RP has extended and all the canister shown in Right Flotation Holding Cue 499R have been moved over one “Cue Position” to the left. The canister that Was the furthest left fully-shown canister in the Right Floatation Holding Cue 499R (from FIG. 42A) is Now, in FIG. 42B, the very tiny piece of a “broken” canister on the far left side of the Right Floatation Holding Cue 499R. In the next drawing, FIG. 42C shows that the long Plunger of Retaining Solenoid 505R has been fully extended outward and is therefore blocking Canister C54 from being able to float over to the right and into the Empty Cue Position that has just been created in FIG. 42B.

Also, by the time Canister C52 ascends the final distance up into Empty Cue Position on the far right of the Right Floatation Holding Cue 499R (which takes about one or two seconds), Right Positioning Solenoid Dual Pronged Claw 504RClw will have been retracted (because of the related retracting movement of Right Positioning Solenoid Plunger 504RP), thus creating a Vacant Cue Position (the furthest right Cue Position in Right Floatation Holding Cue 499R) into which Canister C52 can ascend with no conflict or obstruction from any piece of equipment or from any other canister.

In summary, regarding the right side of FIG. 42B: a) Canister C52 has floated up on its own buoyancy power to the top of Right Vertical Guide Rail System 503, b) as mentioned in the preceding paragraph, Right Retaining Solenoid 505R has retracted and immediately after that, c) Right Positioning Solenoid Dual Pronged Claw 504RClw has moved to the left and pushed all the canisters in the Right-side Floatation Holding Cue 499R over one position to the left to create a Vacant Cue Position for Canister C52 on the far right side of Right-side Floatation Holding Cue 499R.

On the left side of FIG. 42B: a) Curved Puller Assembly 501 has pulled Canister C51 out of the Variable Pressure Chamber 414 and into Left Vertical Guide Rail System 502, and b) Lower Semi-horizontal Puller Assembly 500 has reset, where Puller Head 500PH has been positioned as far as possible to the left, next to Left Mount 500LMt (of Puller Assembly 500) on Slide Rail 500SRL.

Turning now to FIG. 42C, on the right side of the drawing: a) the Plunger of Right Retaining Solenoid 505R has fully extended into the “blocking position” and is holding all canisters in place in the channel of the Right Floatation Holding Cue 499R (specifically blocking Canister C54), b) Right Positioning Solenoid Dual Pronged Claw 504RClw has retracted and this action has given Canister C52 a Vacant Cue Position to ascend up into, and c) Canister C52 has ascended into that Empty Cue Position.

On the left side of FIG. 42C: a) Canister C51 has floated up on its own buoyancy power to the top of Left Vertical Guide Rail System 502, b) Left Retaining Solenoid 505L has retracted, c) immediately after that Left Positioning Solenoid Dual Pronged Claw 504LClw has pushed all canisters that are floating in the channel of the Left Floatation Holding Cue 499L over one position to the right to create a Vacant Cue Position for Canister C51, and d) the right-side Waterproof Sliding Panel of Variable Pressure Chamber 414 has retracted to allow Canister C-New to begin exiting Variable Pressure Chamber 414 to the right.

[Note: even though there is no specific force pushing or pulling a canister out of Variable Pressure Chamber 414 when the Right-side Waterproof Sliding Panel is retracted, a canister will still be “nudged out a little” from Chamber 414 as a result of Fluid under high pressure (Fluid that is pressurized by gravity in the Curved-front Fluid Reservoir 498) interacting with Fluid under Low Pressure inside Chamber 414.]

As mentioned above, the description now focuses on an (“inner”) area of the Two Floatation Cues (and also focuses on a canister) not shown in the Three preceding drawings. Turning now to FIG. 42D, attention is centered on Canister C38, which is the furthest right canister floating in the Left Floatation Holding Cue 499L. FIGS. 42D-42F will show the equipment responsible for elevating Canister C38 up above Left Floatation Holding Cue 499L and then moving that canister over to the right so the canister is centered directly over Pre-launch Launch Platform 519. In FIG. 42D, Outer Moveable Divider 510L and Inner Moveable Alignment Block 512L are extended out (towards the viewer). This condition has TWO results: a) the front beveled edge of Outer Moveable Divider 510L has caused a separation between Canister C38 and the canister to the left of C38, and b) because Outer Moveable Divider 510L and Inner Moveable Alignment Block 512L are now combining with the Front and Rear Stationary Alignment Blocks 511L and 513L, respectively, Canister C38 has a “bounding box” around it so this canister will remain in the proper vertical alignment as this canister is being pushed up (about 20 inches) to eventually reach a vertical position where the canister can be moved to the right (by the equipment shown in FIG. 42F). When Canister C38 is “fully elevated,” the bottom surface of the canister is above the top surface of the Right Containment Block 517L (of the Left Floatation Holding Cue 499L).

FIG. 42E shows Canister C38 after the canister has been “fully elevated.” The process that has occurred, which has changed the vertical position of Canister C38 between FIG. 42D and FIG. 42E is that the Left Vertical Positioning Linear Motor 525 has pushed Canister C38 up so high that the bottom surface of Canister C38 is now (in FIG. 42E) about ½ inch higher than the top surface of Left-side Floatation Holding Cue 499L. In other words, the bottom surface of Canister C38 is now above the top surfaces of: Front Containment Block 506L, Rear Containment Block 507L, and Right Containment Block 517L. This “elevation process” has occurred at a “reasonable pace,” not too slow and not too fast and should Not be considered as a “Launch.”

Even though it is not shown in 42D, there are Two Separate Steps that occur in a defined sequence to create vertical stability for a canister once the canister has been “elevated” by a Vertical Positioning Linear Motor (525 or 529) and before the canister is moved horizontally by Horizontal Transport Linear Motor 539 and the related equipment necessary for this “transporting” procedure. And then a Third Step occurs so that a canister can be moved, horizontally, to the right and onto the Pre-launch Launch Platform 519.

[Note: FIG. 42E shows Left-side Retracting Solenoid 514L, Outer Moveable Divider 510L, and Inner Moveable Alignment Block 512L in the extended, non-retracted state and this means that Outer Moveable Divider 510L and Inner Moveable Alignment Block 512L are still combining with Front Stationary Alignment Block 511L and Rear Stationary Alignment Block 513L to form the “bounding box” for Canister C38. However, since it is clear that Canister C38 has been “fully elevated,” we know that Left-side Retracting Solenoid 514L is “almost ready” to retract (see next paragraph).]

Specifically in this example with Canister C38, those Two Preparatory Steps that occur before the canister is ready to be moved are: a) Before Left-side Retracting Solenoid 514L causes Outer Moveable Divider 510L and Inner Moveable Alignment Block 512L to be retracted (before the “bounding box” is disassembled), Primary Support Beam 535 (in FIG. 42F) moves in place over Canister C38 and the Two EM Grippers (540EM and 541EM) create EM Fields to help provide vertical stability for the canister. Then, b) Outer Moveable Divider 510L and Inner Moveable Alignment Block 512L are retracted (pulled towards the rear) in a simultaneous action as Insertion Solenoid 543 extends out (moves away from the viewer) and causes Notch Suspension Arm 542 to engage into the Notch of Canister C38. Since the two outer tips of Notch Suspension Arm 542 need to move into some of the same space where the outer and inner partitions originally are positioned, these two partitions have to be moved out of the way, anyway, but having the Notch Suspension Arm move in so close that these outer tips of this Notch Suspension Arm are almost touching the front edges of the two partitions, and then moving the Notch Suspension Arm and the two partitions towards the rear in a synchronized motion, allows the retraction of one stabilizing method and the introduction of another stabilizing method to take place at basically the same time; moving all of these components at the same time also speeds-up the overall process, as well.

And another partition also plays an important role in this process, because during the time when Notch Suspension Arm 542 is being pushed into the Notch of the canister (this action occurs going “from the front to the rear”), Rear Stationary Alignment Block 513L acts as a backstop to supply direct counter-pressure on the back side of the canister to ensure that Notch Suspension Arm 542 successfully and efficiently engages into the Notch of the canister without the canister “sliding around” or somehow moving away (to the rear) from Notch Suspension Arm 542. Or Rear Stationary Alignment Block 513R performs this same function if the canister is in Right Floatation Holding Cue 499R.

During all of these steps just described, another level of vertical stability is being provided for the canister because the Upper Tip of the Linkage Positioning Stick (either 522 or 526) is firmly seated into the Matching Carved-out Impression 71 of the canister that has been elevated. However, after Step #2 is completed and the Notch Suspension Arm 542 is fully-engaged into the Notch of the canister, then Step #3 is performed, which is that the respective Linkage Positioning Stick (522 or 526) withdraws (is pulled downward), and in fact is moved completely to the bottom of its movement path (a vertical position shown for Both Linkage Positioning Sticks in FIG. 42D).

With the Inner Moveable Alignment Block 512L retracted and out of the way (see retracted/broken-off Inner Alignment Block 512L in FIG. 42F) AND with Linkage Positioning Stick 522 retracted down and disengaged from the Matching Carved-out Impression 71 in bottom portion of C38, Horizontal Transport Linear Motor 539 (shown in FIG. 42F and best seen in an “exploded view” in FIG. 42F-3a) can move Primary Support Beam 535 over to the right far enough so Canister C38 will be almost perfectly positioned over Pre-launch Launch Platform 519. [Note: this horizontal positioning does not have to be perfect because Matching Carved-out Impression 71 in the bottom surface of Canister C38 will seat over the (half-high) “Partial Protrusion” that sticks up out of the middle of Pre-launch Launch Platform 519. This “Seating Process” will give Canister C38 perfect vertical alignment on top of Pre-launch Launch Platform 519.]

Specifically, Forcer 539Fcr (of Horizontal Transport Linear Motor 539 and referenced in FIG. 42F-3a) is attached to Connecting Interface Block 535Int. This Connecting Interface Block 535Int has Two holes in it that are running along the horizontal axis and are at the same height. These holes are there so Connecting Interface Block 535Int can “slide along” the Front Slide Rod and the Rear Slide Rod (536 and 537, respectively). Insertion Solenoid System 543 is designed to send a signal to Horizontal Transport Linear Motor 539 whenever Insertion Solenoid System 543 has just completed the action of causing Notch Suspension Arm 542 to become engaged into the Notch of a canister. This signal then activates Horizontal Transport Linear Motor 539 and this LM 539 then causes Primary Support Beam 535 (by way of Forcer 539Fcr being permanently attached to Connecting Interface Block 535Int) to be moved to the right or left, according to which Floatation Holding Cue the elevated/suspended canister is being moved out of. In the case of Canister C38, the canister will be moved to the right a pre-determined distance that will position the center of the canister directly over the center of Pre-launch Launch Platform 519.

Once Canister C38 has been moved that pre-determined distance, a “Release Process” occurs. The overall “Release Process” is a very efficient and smooth procedure that involves Two Parts.

[Note: even thought the bottom surface of Canister C38 is only about two inches (or less) above the general top surface of Pre-launch Launch Platform 519 (there has to be some vertical clearance because the bottom surface of Canister C38 has to be higher than the top edge of the Partial Protrusion Section on the Launch Platform), Canister C38 weighs approximately 50 pounds and allowing canisters to drop even a couple of inches onto Pre-launch Launch Platform 519 would cause continuous jarring on the Launch Platform, the Interface 519-I, the Forcer of the Pre-launch LM, the Pre-launch LM, itself, etc. However, to eliminate any jarring, whatsoever, Before the “Release Process” occurs—Before the Two EM Grippers terminate their Two EM Fields and Before the Notch Suspension Arm 542 retracts out of the Notch of Canister C38, Part One of the Release Process occurs.]

Part One of the Release Process is that the Pre-launch Linear Motor (referenced as 531 in FIG. 43A, but not shown in detail) causes Pre-launch Launch Platform 519 to be raised up to the point where “gentle” contact is made between: a) the sides of the “partial protrusion” on the center of Pre-launch Launch Platform 519 and the respective inner walls of the Matching Carved-out Impression 71 (that exists in the bottom portion of every canister), and b) the general, flat bottom surface of a canister and the general flat top surface of Pre-launch Launch Platform 519. There is a Pressure Switch 548 that is embedded into the top surface of the Pre-launch Launch Platform 519 and this Pressure Switch sticks up just high enough so pressure can be felt when contact is being made with the bottom surface of a canister. When this Pressure Switch determines that the “firm” contact just described above in this paragraph has been made between the top surface of the Pre-launch Launch Platform 519 and the bottom surface of the canister that is sitting directly above this Pre-launch Launch Platform, then the Pressure Switch System causes any further upward movement by Pre-launch Linear Motor 531 to cease at that point.

This type of delicate procedure is very important, because if Pre-launch Launch Platform 519 does not stop ascending once initial contact is made between the bottom surface of a canister and the top surface of Pre-launch Launch Platform 519: a) the Leading Surface of the canister will start “jamming into” the bottom surface-edges of the Two EM Grippers (540EM and 541EM), which will also put a strain on the respective Gripper Interface Connections (540Int and 541Int) and on the upper (horizontal) portion of Primary Support Beam 535, itself. And, b) the bottom “lip” of the Notch in the canister will start “jamming into” the bottom surface-edge of the Two Prongs of Notch Suspension Arm 542. Therefore, this Pressure Switch is configured to transmit the “Stop Ascending Signal” to Pre-launch Linear Motor 531 the instant the Pressure Switch detects even a fairly small amount of “contact-pressure,” which can be felt as torque or as some kind of resistance that is inhibiting the Forcer from moving upward.

So when the required amount of contact-pressure has been detected, signifying that the canister is “firmly seated” onto Pre-launch Launch Platform 519, then Part Two of the Release Process occurs. Part Two involves the Pressure Switch System immediately and simultaneously sending out two more types of signals: a) one identical signal is sent to each of the EM Grippers to fully terminate their respective EM Fields, and b) a signal is sent to Insertion Solenoid 543 which causes this Solenoid 543 to retract, thus pulling Notch Suspension Arm 542 out of the Notch in the canister.

The only Step left before a Pre-launch can occur is that after Part Two of the Release Process has been performed, Horizontal Transport Linear Motor 539 must move Primary Support Beam 535 out of the way to the right (because the next canister to be placed on Pre-launch Launch Platform 519 in the description will be coming from Right-side Floatation Holding Cue 499R and because HTLM 539 only needs to move Primary Support Beam 535 about five inches to the right to have all related components clear of the path of Pre-launch Launch Platform 519 vs. moving the Primary Support Beam 535 to the left about 20 inches).

Specifically, a “confirmation signal” is sent by Insertion Solenoid 543 to HTLM 539 confirming that Solenoid 543 is in the fully-retracted position and that Notch Suspension Arm 542 has been retracted and is clear of the canister body. At that point, HTLM 539 moves Primary Support Beam 535 far enough to the right so the left edges of the Two EM Grippers, 540EM and 541EM, will be clear of the right edge of Pre-launch Launch Platform 519. If the canister being placed on Pre-launch Launch Platform 519 is coming from Right-side Floatation Holding Cue 499R, then Horizontal Transport Linear Motor 539 will move Primary Support Beam 535 out of the way far enough to the left to provide clearance on that side for Pre-launch Launch Platform 519 to pass by freely when the Pre-launch occurs. When HTLM 539 has moved Primary Support Beam 535 this pre-determined distance, then HTLM System 539 sends a signal to Pre-launch Linear Motor 531 and this LM 531 performs an elevation procedure, which is done before the actual Pre-launch Process occurs.

[Note: as mentioned above, Primary Support Beam 535 simply moves back and forth in the horizontal plane, as a result of this Beam 535 being directly attached to HTLM 539, by way of Connecting Interface Block 535Int and Forcer 539Fcr. The entire distance of this horizontal movement is such that it includes about one-half of a canister diameter (about 4.3 inches) to the far left, about one-half of a canister diameter (about 4.3 inches) to the far right, and about one and one-half full canister diameters in the middle. This “middle distance” is the width of Right Containment Block 517L, Left Containment Block 517R, and width of Pre-launch Launch Platform, plus a small amount of horizontal clearance between Pre-launch Launch Platform 519 and these two components (517L and 517R).

However, as mentioned in Drawing Exceptions and Comments #29, FIG. 42F is not accurate in how this horizontal clearance is shown between Pre-launch Launch Platform 519 and Left Containment Block 517R. One of the reasons for this discrepancy in the drawing is that there is a vertical differential between the right edge of Pre-launch Launch Platform 519 and the left edge of Left Containment Block 517R. In other words, the top general surface of Pre-launch Launch Platform 519 is lower than the top surface-edge of Left Containment Block 517R by a distance equal to the vertical height of the “Partial Protrusion” sticking up in the middle of the Pre-launch Launch Platform 519. Pre-launch Launch Platform 519 is “sunk down into” the space between the Right and Left Containment Blocks (and also sits above Separation Spacer Partition 518). Therefore, the top edge of the “Partial Protrusion” is a couple of millimeters lower than the top surface-edge of either of the Containment Blocks, 517L or 517R. This vertical height relationship exists between these components so the bottom surface of an “elevated canister” only needs to be a few millimeters above the top surface of either of the Containment Blocks, 517L or 517R, depending on which Floatation Holding Cue the canister is being moved out of. The way the angles are and the way the related components are placed in FIG. 42F, it is difficult to see that there is any clearance at all between the right surface-edge of Pre-launch Launch Platform 519 and the left (inner) surface-edge of Left Containment Block 517R.

As mentioned above in the Structural Composition Section, there is a Front Guide Rod 546 and a Rear Guide Rod 547, and the purpose of these Guide Rods is to keep Primary Support Beam 535 from tilting either towards the front or the rear, respectively. Also mentioned in that Section is the fact that Rear Guide Rod 547 must work to counteract the majority of the “tilting” force, because when Primary Support Beam 353 has “locked onto” a canister and is transporting the canister horizontally, the tendency will be for the weight of the canister to pull (or tilt) Primary Support Beam 535 towards the rear. The respective clearances between these Two Guide Rods and Primary Support Beam 535 is shown in the left side view of FIG. 43A.]

The elevation process of Pre-launch Launch Platform 519, and the elevation of the respective canister sitting on top of this Platform, is the same as what happens at this point in the Dual Arc C Roller Sections sub-embodiment. There is a difference in this sub-embodiment from the preferred embodiment, and that has to do with the “Release Processes” for: a) the Two Suspension Support Rods 227L and 227R, and b) the Two Notch Grips, 219F and 219R. In the preferred embodiment, this “Release Process” was initiated when a (Lower) canister ready to perform the Coupling Process passed in front of Sensor 217US (in FIG. 1H). But in this Dual Floatation Holding Cues and Canister Sliding Transport sub-embodiment No component shown in FIG. 1H is used in this sub-embodiment, except the Two Notch Grips, themselves, and any components used to support these Two Notch Grips, 219F and 219R. Therefore, the “Release Process” that causes: a) the Two Suspension Support Rods 227L and 227R, and b) the Two Notch Grips, 219F and 219R, to enter the retracted mode and release the canister being supported, vertically, by the Two Suspension Support Rods, and stabilized, horizontally, by the Two Notch Grips is triggered by almost simultaneous signals going first to the Two Suspension Support Rods, and then to the Two Notch Grips, and where all such signals are sent by Pre-launch Linear Motor 531 (FIG. 43A).

Specifically, when the Pre-launch Linear Motor reaches a vertical point where the Leading Surface of the canister that is being elevated (by the Pre-launch Linear Motor) is making gentle contact with the bottom surface of the canister being suspended, all of these signals sent by the Pre-launch Linear Motor cause these four solenoid-related components to go into a retraction mode and respectively retract the Two Suspension Support Rods out from underneath the suspended canister and then also retract the Two Notch Grips out of the Notch of the Upper Canister.

These related actions thereby “release” the canister and allow the canister to become freely moveable in a vertical direction. At that point this Upper Canister is sitting directly on top of the Lower Canister, and this Lower Canister is sitting directly on top of the Pre-launch Launch Platform 519.

Once all confirmations are received that there are no obstructions to elevating the Pre-launch Launch Platform 519, the Pre-launch Launch Platform and the respective canister are elevated to the first stopping point described two paragraphs above. Once the four respective solenoid-related components have withdrawn, and confirmation of the completion of all these actions is received by the Pre-launch Linear Motor, the Pre-launch Linear Motor performs a standard Pre-launch Process and elevates the Lower Canister a second time, stopping the Pre-launch Process at a vertical point where the Lower Canister is at the exact height the Upper Canister was at when the Upper Canister was being suspended by the Two Suspension Support Rods 227L and 227R. Once these four respective solenoid-related components have extended out into the proper horizontal position, and confirmation of the completion of all these actions is received by the Pre-launch Linear Motor, then this Pre-launch Linear Motor moves downward and in the end, Pre-launch Launch Platform 519 is reset to be at the proper vertical position so that the Next Canister can be received by this Pre-launch Launch Platform, and where this Next Canister will be coming from the other side of this Pre-launch Launch Platform.

### 8. The Pivot Bucket and Canister Holder Section Operations.

This Section includes: a) Single Pivot Bucket operation of the preferred embodiment, b) Above Ground Multi-Rail Curved Pathway sub-embodiment of the preferred embodiment, and c) Dual Pivot Bucket with Canister Ejection EM sub-embodiment of the preferred embodiment.

By using a Pivot Bucket Canister Ejection EM 276, coupled with a Inclined Platform Top Cue Position Canister Holder Section 625Ext and also using a Top Cue Position Deceleration EM 626, it is possible that by using a Single Pivot Bucket in the preferred embodiment, canisters can be processed fast enough to comply with the Five Second Cycle Rule. However, if this situation is problematic, there is a Dual Pivot Bucket with Canister Ejection EM sub-embodiment of the preferred embodiment that uses Two Vertical Pathways (near the end of the vertical Floatation-ascent Phase) and this sub-embodiment directs canisters in an alternating fashion into Two Pivot Buckets. Then, instead of a stationary Inclined Platform Top Cue Position Canister Holder Section 625Ext, there is an Inclined Platform Sliding Canister Holder Section 625SLD (shown in FIG. 53), that shuffles back and forth between the “Mouths” of the Two Pivot Buckets. The overall effect of the Dual Pivot Bucket with Canister Ejection EM sub-embodiment is to convert the Five Second Cycle Rule to a Ten Second Cycle Rule, per Pivot Bucket “Slot.” The overall system works by having a canister ready to be ejected out of each individual Pivot Bucket once every Ten Seconds, but because there are Two Pivot Buckets, a canister can be deposited onto Inclined Canister Holder 66 once every Five Seconds.

[Note: the exact same Inclined Platform Top Cue Position Canister Holder Section 625Ext (from FIG. 1N) is used for both the Single Pivot Bucket operation and the Above Ground Multi-Rail Curved Pathway sub-embodiment for the preferred embodiment. A canister being “ejected” out of Pivot Bucket 261 and a canister exiting the Multi-Rail Curved Pathway 596 both “land on” the Canister Holder Section 625Ext in exactly the same manner and are “processed” in exactly the same way as described below in the explanation in the sub-section for the Single Pivot Bucket operation of the preferred embodiment. Also, even though the Above Ground Multi-Rail Curved Pathway sub-embodiment uses No Pivot Bucket, this sub-embodiment is included in this Section because even having No Pivot Bucket is a “Pivot Bucket Option,” and also as just mentioned, the Above Ground Multi-Rail Curved Pathway sub-embodiment uses the same equipment and same procedures on Canister Holder Section 625Ext as what is used for the Single Pivot Bucket operation.]

Single Pivot Bucket Operation of the Preferred Embodiment

In this Single Pivot Bucket with Canister Ejection EM sub-embodiment, important signals are sent from Pressure Gauge 275 (seen in FIG. 12 of the preferred embodiment) and also from the Pivot Bucket Rotational Solenoid Body 266 (seen in FIG. 1L of the preferred embodiment), and these signals cause various actions to be performed. Specifically, when an ascending canister reaches the Upper Pivot Bucket Stop-pins, 264L and 264R (seen in FIG. 1L), the Springs in the Upper Pivot Bucket Stop-pin Assemblies (271SpUL and its right-side counterpart) will compress and then immediately decompress, sending the canister back down (but not out the bottom of the Pivot Bucket because the Two Lower Pivot Bucket Stop-pin Assemblies, 263L and 263R, are fully extended and are blocking the canister from falling out the bottom of the Pivot Bucket). Pressure Gauge 275 waits until Spring 271SpUL decompresses and then a signal is sent to the Pivot Bucket Rotational Solenoid Body 266 to cause this Rotational Solenoid 266 to begin rotating the Pivot Bucket 261 towards the Inclined Platform 59 (rotating the Pivot Bucket to the left from the viewer's perspective; to the right from the Rotational Solenoid's perspective).

At a pre-determined Degree of Rotation, Rotational Solenoid System 266 sends out Three types of signals. One type of signal goes to the Two Upper Pivot Bucket Stop-pin Assemblies, 264L and 264R, causing these Stop-pins to retract and thereby creating an open pathway in the “Mouth” of the Pivot Bucket for the canister to move through. One signal goes to Canister Ejection EM 276 (that is surrounding the Pivot Bucket, as seen in FIG. 1L-2 and FIG. 1M), causing this Canister Ejection EM 276 to initiate an EM Field that will “push” the canister out of the Pivot Bucket.

[Notes: a) this “Ejection Push” only occurs AFTER the Pivot Bucket has been almost completely rotated towards the Inclined Platform, b) gravity will be helping somewhat to slide the canister out of the downward-sloping Pivot Bucket, but by using the “pushing force” of Canister Ejection EM 276, some considerable momentum can be given to a canister so that the canister quickly starts moving out of Pivot Bucket 261 to the left, and c) by adding a Pressure Gauge onto the one of the Springs in the Lower Pivot Bucket Stop-pin Assemblies (similar to Pressure Gauge 275 on the Spring of Left Upper Pivot Bucket Stop-pin 264L), even more “ejection momentum” (maximum exit velocity) can be achieved by coordinating the retracting of the Two Upper Pivot Bucket Stop-pin Assemblies, 264L and 264R, with the “final decompression thrust” of the Two Lower Pivot Bucket Stop-pin Assemblies, 264L and 264R. This rather sophisticated procedure could be precisely configured, based on results from a large number of Test Trials that are made to specifically determine how many “bounces” a canister makes inside the Pivot Bucket, according to how fast the Pivot Bucket is rotated towards Inclined Platform 59.]

The third signal goes to Top Cue Position Deceleration EM 626 and this signal causes this Deceleration EM 626 to initiate an EM Field that will attract the magnet inside the canister and will help “pull the canister out” of the Pivot Bucket and onto Inclined Platform Top Cue Position Canister Holder Section 625Ext at a point when the canister has been partially ejected out of the Pivot Bucket and the magnet near the front of the canister comes within range of the EM Field that has been created by Deceleration EM 626.

FIG. 1M shows Pivot Bucket 261 after it has been rotated to a downward-sloping angle, and Canister C267 is seen moving out of the Pivot Bucket, due to the force of gravity and because Canister Ejection EM 276 is “pushing” the canister out of Pivot Bucket 261 with the force of a “repelling” EM Field. On the right of FIG. 1N, this situation just described is shown again, but Canister C267 is shown with Phantom Lines (referenced as Canister C267PH). Then again, Canister C267 is shown with solid lines towards the middle of the drawing, which shows that the Leading Surface of Canister C267 has already moved through Deceleration EM 626 and is either: a) about to contact the Front and Rear Contact Pads, 629CP and 630CP, respectively, for the Two Canister Ejection Impact Spring Assemblies, or b) already made contact with the Two Contact Pads and has “bounced” off of the Contact Pads up and to the right. More on this specific situation is described below.

But an important Step has been skipped, and it is important to back up to the situation shown in FIG. 1N where “phantom canister” C267PH is exiting Pivot Bucket 261 and heading towards the right side of Deceleration EM 626. When “phantom canister” C267PH is attempting to exit Pivot Bucket 261, there will be a collective result of two EM Fields already mentioned above; these are the EM Fields that were created as a result of Two Signals sent by Rotational Solenoid 266 when Solenoid 266 reached the pre-determined Degree of Rotation towards the Inclined Platform. This “phantom canister” C267PH is being pushed to the left by the EM Field generated by Canister Ejection EM 276 and at the same time being pulled towards the right side of Deceleration EM 626 by an “attracting” EM Field coming from Deceleration EM 626. Therefore, due to these relatively strong forces, “phantom canister” C267PH will more or less “come flying out of” Pivot Bucket 261 towards the opening in the right side of Deceleration EM 626.

As “phantom canister” C267PH is moving towards Deceleration EM 626, the Leading Surface of the canister will pass in front of Canister Holder Section Entry Sensor 631. The instant the Leading Surface of the canister passes in front of Entry Sensor 631, a different signal is sent to Deceleration EM 626 by Sensor 631, and this signal causes Deceleration EM 626 to reverse the polarity of its EM Field, which immediately begins repelling the magnet inside the canister and slowing down the motion of the canister (motion that is headed down and to the left); at this point the canister is moving towards Deceleration EM 626 but is still on the right of Deceleration EM 626 and has not “entered” Deceleration EM 626. This procedure for Deceleration EM 626 to quickly reverse the polarity of its EM Field is similar to what commercial jet planes do when landing at an airport. Since runways at a large airport are usually compacted in between other runways and are constructed to be as short as possible, within a few seconds after a commercial jet “touches down” on a runway, the pilot reverses the jet engines so that the power that had previously been used to move the plane thousands of miles in a forward direction, in these last few seconds of the flight this power is suddenly “put in reverse” and used to quickly slow the plane down and bring the speed of the plane under control so the plane can taxi around the airport.

So Canister C267 is being decelerated as it moves through the open body of Deceleration EM 626 but the canister still has substantial momentum (for movement to the left), and the canister will quickly pass through Deceleration EM 626 and the Leading Surface of the canister will emerge out the left side of Deceleration EM 626 and the Leading Surface of the canister will continue moving down to a position as what is seen in FIG. 1N. However, since after emerging out of Deceleration EM 626 to the left, the “opposite side” of the magnet will be “facing” the EM Field which is still being generated by Deceleration EM 626, the result of the force from this EM Field on this “opposite side” of the magnet will be to attract the magnet (and the canister) back towards Deceleration EM 626. This attractive force will keep slowing the magnet down, because the force is working against the magnet's movement to the left. The first goal for this part of the movement of the canister, before the “First Contact” is made between the Leading Surface of the canister and the Two Contact Pads, 629CP and 630CP, is to make sure the canister impacts the Two Contact Pads at a “reasonably slow speed.”

There is a Pressure Sensor 633PrSns (shown in FIG. 54) that is connected to the Front Ejection Impact Spring 629Spr. On the “First Contact” between a canister and Front Contact Pad 629CP, when that first (compression) “impact” is felt, Pressure Sensor 633PrSns sends out Two types of signals at the same time. There is some importance attached to this “First Contact” being made between a canister and Contact Pad 629CP, because for one, this means that 100% of the canister body is sitting on Canister Holder Section 625Ext, which allows the respective Pivot Bucket to be rotated back to its default position.

The first signal Pressure Sensor 633PrSns sends goes to Deceleration EM 626, causing Deceleration EM 626 to reverse the polarity of its EM Field again, which means the EM Field will be repelling the magnet inside the canister and trying to “push the canister farther down” and to the left. The reason for this action is that since there is only a Five Second Window to “process” each canister and get it off of Canister Holder Section 625Ext, there is no time to waste having a canister just “bouncing around, up and down” off of the Two Ejection Impact Spring Assemblies.

By having the EM Field from the Deceleration EM 626 pushing (repelling) the canister down and to the left, this will minimize the tendency of the canister to “bounce back” to the right and up, when the Two Ejection Impact Springs decompress. However, some of that “bouncing” will occur. According to the results of Test Trials, it should be possible to configure the combination of these forces (the force of gravity, the compressing and decompressing of the Two Ejection Impact Springs, and the Strength of the Electromagnetic Repulsion from Deceleration EM 626) so that each canister “Bounces” Only TWICE. Since a “Bounce” occurs as a result of the decompression of the Two Ejection Impact Springs, before each of these Two “Bounces,” the Two Springs will be compressed and Pressure Sensor 633PrSns will “be aware” of Both times these Springs are compressed.

In this example-scenario, another signal goes to Rotational Solenoid 266 and the Solenoid rotates back to the original position it was in (from FIG. 1L), which causes Pivot Bucket 261 to go back to its “straight up,” default position.

Canister C267 “bounces off” of the Two Contact Pads, moving towards the right and up, but the repelling force from Deceleration EM 626 quickly pushes the magnet (and the canister) back down towards the left. As a result, the Leading Surface of Canister C267 makes contact with the Two Contact Pads for the Second Time. Ejection Impact Spring 629Spr and 630Spr compress and then decompress, and when Ejection Impact Spring 629Spr is decompressing for the Second “Bounce,” Pressure Sensor 633PrSns sends a signal to Deceleration EM 626 that causes a different, and “Final EM Field” to be created.

Specifically, when this “Second Bounce” occurs, this is the time when the Two (Front & Rear) Vertical Retracting Solenoids will be pulling the Two Ejection Impact Spring Assemblies completely down into the Cut-out Hole 625Cut. It is important that the Two Spring Systems have enough time to be completely “pulled down” below the bottom surface of the canister, so the bottommost portion of the Leading Surface of the canister does not “run into” the Contact Pads when those Contact Pads are in the process of being “pulled downward” or are in any vertical position other than in the default position for these Contact Pads, as is shown in FIG. 1N. The Leading Surface of any canister should only be making contact with the Two Contact Pads, 629Cp and 630CP, when these Contact Pads are in their default position.

So when Pressure Sensor 633PrSns “realizes” Front Canister Ejection Impact Spring 629Spr is decompressing for the Second Time, two events occur at the same time. A signal is sent to Deceleration EM 626, and this signal causes Deceleration EM 626 to reverse polarity again on the EM Field so the EM Field is attracting the magnet inside the canister and to also create a Slightly Stronger “Final EM Field.” The strength of this attraction on the magnet inside the canister will temporarily “suspend” the canister off of, and away from, the Two Contact Pads 629CP and 630CP. Now there is only one more set of signals to be sent in this process.

The second type of signal goes to each of the Two Retracting Solenoids, 629Slnd and 630Slnd and the related action is for these Two Solenoids to fully retract. For each Retracting Solenoid, when that Solenoid has reached a “Retraction Point” that is far enough down so that the topmost point of the related Ejection Impact Spring Assembly is below the lip of the Cut-out Hole 625Cut (“inside” Canister Holder Section 625Ext), then that particular Solenoid sends out a “Confirmation Signal” to Deceleration EM 626. When Deceleration EM 626 has received “Confirmation Signals” from Both Retracting Solenoids, then Deceleration EM 626 terminates the “Final EM Field” and the canister begins moving along the (inclined) Canister Holder Section 625Ext, moving down (and to the left) due to the force of gravity pulling on the canister and the magnet. The canister quickly moves along Canister Holder Section 625Ext (to the left) and keeps moving until the Leading Surface of Canister C267 makes contact with the bottom surface of Canister C1-Cue.

Even though in FIG. 1N Canister C1-Cue is shown to be in a position on Inclined Canister Holder 66 so that the bottom surface of Canister C1-Cue is barely below (to the left of) Canister Holder Section Exit Sensor Mounting System 632M, by the time this contact is made between the Two Canisters (C1-Cue and C267), a New Cycle will have started. This means that Canister C1-Cue will have moved a distance to the left about equal to one-half of a canister length. FIG. 16 (the Second of the SIX “Sequence” Diagrams for the preferred embodiment) shows all the canisters on the Inclined Platform 59 have moved down to the left a little, compared to what is seen in the “original” position in FIG. 15, which is the configuration for the canisters Before a New Cycle begins. The same type of “canister arrangement” is seen in FIG. 53, for the Dual Pivot Bucket sub-embodiment.

In any event, this process just described, where a canister has been “suspended” by the “Final EM Field” generated by Deceleration EM 626, creates a situation where a canister is moving as slowly as possible when that canister makes contact with the topmost canister in the “Cue” on Inclined Canister Holder 66. There is a fairly sensitive balance that must be achieved between getting a canister off of Canister Holder Section 625Ext as quickly as possible and yet keeping that canister from “crashing into” the stationary canister on the left, that is waiting at the top of Inclined Canister Holder 66. As stated above in the next to last paragraph at the end of the Structural Composition Section related to Single Pivot Bucket operation of the preferred embodiment, the impact felt when this contact is made between the “moving” canister (coming from Canister Holder Section 625Ext) and the “stationary” canister (that is waiting on Inclined Canister Holder 66) will be felt all the way down (six or seven canister lengths to the left) by the Front and Rear Inclined Platform Notch Pins, 88F and 88R, respectively. These Notch Pin components are not that sturdy and are not made to take large, sudden impacts, especially on a repetitive basis every five seconds.

Also shown in FIG. 1N is Canister Holder Section Exit Sensor 632; this Sensor 632 detects when the Leading Surface of a canister is passing in front of it, but waits until the bottom surface of the canister has also passed by Sensor 632. When Exit Sensor 632 detects the bottom surface of a canister, this means that the body of the canister is 100% off of Canister Holder Section 625Ext. What is shown in FIG. 17 (of the “Sequence Drawings”) is the situation just described, where the Leading Surface of a canister has passed in front of Exit Sensor 632, but due to the status of all the canister on the overall Inclined Platform 59, the canisters have not repositioned themselves in preparation of the “Next” Cycle. That is why, even though the components are not referenced, an Ejection Impact Spring Assembly can be seen in the “retracted state” (pulled down into the “hole” 625Cut, below the bottom of Canister C-10).

However, FIG. 18 shows that all the canisters on the Inclined Platform 59 have moved down One Full Canister Position to the left, and what has happened is that Exit Sensor 632 has detected the bottom surface of the canister (C267 in this example for FIG. 1N, not Canister C-10). Specifically, when Exit Sensor 632 detects that the bottom surface of the respective canister has passed in front of Exit Sensor 632 (moving to the left), then a signal is sent to each of the Two Retracting Solenoids, 629Slnd and 630Slnd. These identical signals cause the Two Retracting Solenoids to fully-extend upwards, thus raising the Two Ejection Impact Spring Assemblies to their respective default positions, as seen in FIG. 1N.

Above Ground Multi-Rail Curved Pathway sub-embodiment of the preferred embodiment

As shown in FIGS. 44-46, there is an Above Ground Multi-Rail Curved Pathway sub-embodiment of the preferred embodiment. This sub-embodiment is a fairly straight-forward process with a minimum of equipment and that equipment was described in the related Structural Composition Section above. Because there is a Five Second Cycle Rule, this Above Ground Multi-Rail Curved Pathway sub-embodiment allows ample time for each canister to make the Above Ground Ascent along the Multi-Rail Curved Pathway 596 and to reach the Inclined Platform within the allotted time. A rough example of how this Multi-Rail Curved Pathway 596 looks can also be understood by looking at the first, bottommost “loop” of the Downward-sloping 3-sided Modified Circular Guide Rail 464 in FIG. 35a, except that for the Above Ground Multi-Rail Curved Pathway 596: a) a canister is ascending and not descending and b) the top of Multi-Rail Curved Pathway 596 ends in front of (to the right of) a slightly modified, non-sliding version of (Sliding) Inclined Platform Canister Holder Section 625Ext (shown in FIG. 53).

[Note: as mentioned above in Additional Drawing Exceptions and Comments #32, for FIGS. 44-46, the phantom lines in these drawings show the outermost possible width of the Multi-Rail Curved Pathway, including any “over-hang” by a canister, because the Pathway is not enclosed. Since the Pathway consists of Three Open Circular Rails, there will be times when parts of a canister may stick outside (beyond) the outer edge of any particular Rail.]

The processes as related to this sub-embodiment start when a canister ascends through the Splash Guard 253 that is permanently mounted in the Ceiling 254 of the Fluid Column (these are the same components seen in FIG. 1K for the preferred embodiment). The canister continues ascending through an open, Multi-Rail Curved Pathway Section 596 (from FIG. 44). There are several “breaks” in the Rails where electricity-generating Coils are positioned (none of these “breaks” or Coils are shown in FIG. 44). The inside diameter of these Coils must be somewhat larger than the inside diameter of a Coil in the preferred embodiment because the canisters are not heading perfectly straight through the Coils in this sub-embodiment.

At the top of Multi-Rail Curved Pathway 596, a canister passes in front of an Above Ground Pathway Exit Sensor 597. This Sensor 597 sends a signal to Above Ground Pathway Exit Speed-adjusting EM 598, causing this Speed-adjusting EM 598 to create an EM Field that will help the canister move out the end(s) of the Rails (to the left) and onto the modified (non-sliding) Inclined Platform Canister Holder Section. Because of this “speed manipulation process,” the canister will exit the Pathway Section at a “reasonable speed” that is consistent with all the other canisters that are exiting the Pathway Section.

[Note: the “Speed-adjusting EM Field” can be in two parts; first the EM Field can attract or repel the magnet inside the canister (while the canister is on the right side of the EM and depending on if the canister is moving “too fast” or “too slow”) and then after the magnet inside the canister is emerging out the left side of Speed-adjusting EM 598, the EM Field can continue generating the proper field (either repelling or attracting, which will speed up or slow down the canister, respectively), based on the “original” decision made by the Above Ground Pathway Exit Sensor 597 Before the canister entered Speed-adjusting EM 598. This “decision” by the Exit Sensor 597 will be based on results collected from an extensive number of Experimental Test Trials that are conducted before a MF device using this Multi-Rail Curved Pathway sub-embodiment is actually put into operation.

Also, for the sake of shortening the time it takes for a moving canister to exit the Multi-Rail Curved Pathway 596 and then to have the canister quickly sitting in the top canister cue position on the Inclined Platform 59, with all forward motion stopped, or even related to the general idea that the exit speed could be an issue for a canister exiting this of Multi-Rail Curved Pathway 596, the equipment shown in FIG. 1N can be used, after a canister exits the Multi-Rail Curved Pathway 596, to help manipulate the speed of a canister that is attempting to move into the top canister cue position on the Inclined Platform 59, without causing any damage to the equipment or the canisters that are already sitting on this Inclined Platform 59.]

In general, there is an advantage to the Above Ground Multi-Rail Curved Pathway sub-embodiment over the preferred embodiment that uses a Single Pivot Bucket, because it is quicker for a canister to simply ascend up through one continuous Pathway and to always be headed in one direction, than to: a) ascend into a Pivot Bucket, b) wait for the related “hardware” to trap the canister inside the Bucket, c) wait for the Pivot Bucket to rotate, and then d) be “ejected” out onto Inclined Platform Top Cue Position Canister Holder Section 625Ext.

However, if the Single Pivot Bucket method of the preferred embodiment (shown in FIG. 1L) can operate fast enough to keep up with the Five Second Cycle Rule, then there is also an advantage to that system because in other ways a canister “flying straight up into the Pivot Bucket” is much simpler than a canister being forced to continuously curve-around on a large, Multi-Rail Curved Pathway, where friction between the canisters and the Rails (see next paragraph) has a certain amount of inconsistency, varying from one canister to the next. Also, more Above Ground Electricity can be produced in the Single Pivot Bucket method, because: a) the canisters will be moving faster when they go through the Coils, b) the Above Ground Coils can be positioned in a perfectly straight vertical line (one above another in a “stack”), and c) the inner diameters of the Coils can be smaller, which allows more electricity to be created

As mentioned above in the related Structural Composition Section for this sub-embodiment, if Coils are inserted at multiple points along the Pathway so “Above Ground Electricity” can be produced comparable to (but less than) what is produced in the preferred embodiment (see FIG. 1K), the remaining disadvantage of the Above Ground Multi-Rail Curved Pathway sub-embodiment is that the canisters must travel up a continuous (curved) Pathway and experience continuous friction during that entire upward ascent. The concern about this situation (the varying effects of friction along the Pathway for each individual canister) has to do with the consistency of the speed of each individual canister as it travels up Multi-Rail Curved Pathway Section 596. There must be a reasonable level of overall consistency regarding the speed of the canisters by the time each canister reaches the top of Multi-Rail Curved Pathway Section 596, because the speed at which a canister exits the Pathway is very important, with respect to what happens when a canister moves onto the modified (non-sliding) Platform Canister Holder Section.

Prior to a MF device being put into operation for the first time, numerous test runs will be made to determine what the exact shape of the Pathway should be (how large the curve should be, extending out to the front and the side) to provide the greatest level of consistency for the speed of the canisters and to ensure that Every canister will have enough upward momentum to reach the Top of Multi-Rail Curved Pathway Section 596.

Dual Pivot Bucket with Canister Ejection EM sub-embodiment of the preferred embodiment

Even though the name of this sub-embodiment mentions the Pivot Buckets, the related processes for this Dual Pivot Bucket sub-embodiment start down inside the Fluid Column 320. Also, as shown in the related Structural Composition Section, the upper portion of the Fluid Column is modified in this sub-embodiment so that a wider and deeper size of Fluid Column 320 (the Enlarged Uppermost Section of the Fluid Column 599; shown in FIG. 50) can be used to house the equipment specifically needed for this Dual Pivot Bucket sub-embodiment. This description could start with either the Right Ascent Pathway Conduit 601 or the Left Ascent Pathway Conduit 611, but to be consistent with the drawings, this description starts with the Right Ascent Pathway Conduit 601. In any event, both of these Right and Left Pathways use the same kind of components, and a canister comes up the right side, then the next canister comes up the left side, etc. This process allows Ten seconds for Each Side to process a canister (through the respective Pivot Bucket Assembly), and therefore since there are Two Sides, a canister can be deposited onto Inclined Platform 59 Every Five Seconds using this Dual Pivot Bucket with Canister Ejection EM sub-embodiment.

The central focus of upward movement is the same for Both of the Ascent Pathway Conduits, 601 and 611, and there are two requirements for that movement and the related equipment, which are: a) that at the proper time, a Conduit be positioned exactly over (on top of) the spot where a canister exits the “original” Fluid Column (shown in FIGS. 47, 48, 50, 50-2, and 51), and b) that each Conduit stay out of the way of the other Conduit, when that other Conduit is trying to position itself over that spot in the Fluid Column mentioned in “a.” The Two respective Positioning Solenoids, 602 on the right and 612 on the left, are responsible to satisfy these two positioning requirements. FIG. 50 is a top view that shows the spot where the canisters come out of the Fluid Column. A Canister C98 is shown centered perfectly inside of the topmost Coil 250e (seen in FIG. 1J of the preferred embodiment) that is inside the Fluid Column 320. Also shown in FIG. 50 is how the Two Conduits are pulled back and forth at angles so that there is always at least some narrow clearance between the rounded edges of the Two Conduits, and therefore the Conduits can never “run into each other.”

Starting with FIG. 47, Canister C98 ascends out of the Fluid Column 320 but is still “in the Fluid” because the canister merely goes from the “original” Fluid Column into the Enlarged Uppermost Section of the Fluid Column 599 (best seen in FIG. 51). Every canister ascending out of the “original” Fluid Column 320 must pass in front of Dual Ascent Pathway Sensor 600. After a canister passes in front of this Sensor 600, there is a very brief delay (a few milliseconds) and then this Sensor 600 causes the appropriate Set of (right-side or left-side) Ascent Adjustment EMs, 603 and 604 or 613 and 614, to be activated. These EMs function in a way similar to the “Canister Elevation EMs” used in the preferred embodiment (shown in FIGS. 1D and 1F), except that these Ascent Adjustment EMs push the Leading Surface of a buoyant canister down and away from the underside of the respective Ascent Pathway Conduit.

Since the canisters are ascending in Fluid, there is not necessarily any friction between the Leading Surface-edge of a canister and the underside of a Conduit, but any contact made between a canister and the underside of a Conduit might be more described as an “impact.” In any event, any such “impact” will tend to slow down the upward momentum of a canister and therefore these (sets of) Ascent Adjustment EMs are used to minimize any such contact events or “impact events.” Also, the effect of “pushing the Leading Surface down and away” from the underside of a Conduit only provides temporary results because: a) the canisters are moving at very high speeds, even inside the Fluid, by the time they have ascended the full length of the Fluid Column, and b) the force of buoyancy and the force of the Canister Length Pressure Differential will be having a counterclockwise rotational effect on the canisters (trying to rotate the canisters into an upright position) that will cause the Leading Surface-edge of a canister to head right back up towards the underside of the respective Conduit. Two Ascent Adjustment EMs per Conduit are shown in the drawings, but more than two of these EMs could be used on each Conduit. As FIG. 47 shows, the “Pathway Length” of an Ascent Pathway Conduit is about one and one-half canister lengths.

The purpose of these Two Ascent Pathway Conduits is to adjust the Direction of Motion of the canisters so that the canisters finally end-up ascending with True Vertical Alignment directly underneath the appropriate Pivot Bucket Assembly (shown in FIG. 52). The curvature of the Conduits is such that the canisters can make this Direction of Motion Adjustment in a smooth and efficient manner. There is no substantial effect related to how far apart the vertical sections of the Two Pathways are from each other (as seen in FIG. 51), except that the further apart the Pathways are (the greater the distance between the Two Splash Guards, 610 and 620), then the more distance the Inclined Platform Sliding Canister Holder Section 625SLD will have to travel to get positioned in front of the Two Pivot Bucket Ejection Points (shown in FIG. 53).

Once a canister moves onto this Sliding Canister Holder Section 625SLD, the allotted time is only five seconds for the canister to move completely down and off of Sliding Canister Holder Section 625SLD, and to move onto (stationary) Inclined Canister Holder 66. Also within this five seconds, Sliding Canister Holder Section 625SLD must be horizontally repositioned TWICE, in order to prepare Sliding Canister Holder Section 625SLD to be ready to take the “next” canister. The first horizontal repositioning moves Sliding Canister Holder Section 625SLD away from a Pivot Bucket “Slot” and places Sliding Canister Holder Section 625SLD in the position shown in FIG. 53, where Sliding Canister Holder Section 625SLD is positioned in front of (stationary) Inclined Canister Holder 66. The second horizontal repositioning moves Sliding Canister Holder Section 625SLD away from this “Middle Position” and positions Sliding Canister Holder Section 625SLD in front of the Pivot Bucket “Slot” where the “next” canister is being ejected. In other words, Sliding Canister Holder Section 625SLD will always be “partially repositioned” TO the “Middle Position” (shown in FIG. 53) when a canister is moved away FROM a Pivot Bucket “Slot;” or Sliding Canister Holder Section 625SLD will always be moved TO one of the Pivot Bucket “Slots” when moving away FROM the “Middle Position;” Sliding Canister Holder Section 625SLD will never go directly from one Pivot Bucket “Slot” to the other Pivot Bucket “Slot.”

So turning away from FIG. 53 and following Canister C98 from FIG. 47 to FIG. 49, the canister moves out of the top of the Right Ascent Pathway Conduit 601 and up into the Right Vertical Alignment Cone 605. Canister C98 keeps ascending and by the time the Leading Surface of the canister enters Right-side Top Quadrilateral Guide Assembly 608, the canister will have achieved True Vertical Alignment. Canister C98 keeps ascending and its upward momentum, as it fully exits the Enlarged Uppermost Section of the Fluid Column 599 (by passing through Splash Guard 610), allows this canister to “fly through the air” and ascend all the way up into the Pivot Bucket of Front Pivot Bucket Assembly 621.

As referred to in Additional Drawing Exceptions and Comments #35, and again in a fairly large, two paragraph “Note” in the Structural Composition Section discussing the Dual Pivot Bucket sub-embodiment, for the sake of clarity the Two Ascent Pathway Conduits (601 and 611) in FIGS. 47-51 have been shown to go across the drawing page from left to right. But FIG. 50-2 shows all the same components in FIG. 50 (except Fluid Column 320) rotated 90 degrees counterclockwise. There is no problem to build a MF device where these components are positioned exactly as shown in FIG. 50-2; it just means the Enlarged Uppermost Section of the Fluid Column 599 is also rotated 90 degrees counterclockwise from what is shown in FIG. 51. Constructing a MF device as shown in FIG. 50-2 is necessary in order to change the “right and left” Pathways into “front and rear” Pathways, so that the canisters will be ascending properly, coming out of the respective Splash Guard (610 or 620) and “flying straight up into” the respective Pivot Bucket. The Pivot Buckets must be positioned in a “front and rear” configuration to be able to rotate over to the Inclined Platform, as shown in FIG. 1A and FIG. 1L.

At a pre-determined time after Dual Ascent Pathway Sensor 600 recognized that a canister had passed in front of it, the Two Ascent Pathway Conduits essentially switch places. Since it will only take a canister one or two seconds to completely ascend up through an Ascent Pathway Conduit, this means the Positioning Solenoids (602 and 612) have a Time Window of about Three Seconds to position the other Ascent Pathway Conduit over the spot in the Fluid Column where the next canister will be coming out of. This Three Seconds is ample time to move each Conduit a few inches. The Conduit that just “processed” a canister moves first and when the Positioning Solenoid moving that Conduit reaches a certain “Retracted Position,” a signal is sent by that Solenoid to the other Positioning Solenoid, and this signal causes the other Positioning Solenoid to fully extend (towards the center of the Fluid Column). In the case of FIG. 48, after Right Ascent Pathway Conduit 601 was retracted out-of-the-way, Left Ascent Pathway Conduit 611 was positioned over the proper spot in Fluid Column 320. Any canister going up the left side, through Left Ascent Pathway Conduit 611 (and through all the other related components) follows the same procedures as just discussed for the Right-side Pathway.

FIG. 51 uses no hidden lines for the bottom portions of the Two Ascent Pathway Conduits, but this drawing shows the respective locations of the stationary components for the left and the right Pathways (for example, those components shown in the upper 40% of FIG. 49; the Right Vertical Alignment Cone 605; Right-side Top Quadrilateral Guide Assembly 608; Right-side Ascent Pathway Splash Guard 610), with respect to the spatial relationship the Two Pathways have with each other and with respect to how the Two Pathways are positioned inside the Enlarged Uppermost Section of the Fluid Column 599. FIG. 51 also shows how the position of each Ascent Pathway Conduit is related to the stationary components in that particular (left or right) Pathway. Obviously, the situation depicted in FIG. 51 could never exist, because the bottoms of both Conduits could never be in the same place at the same time.

FIG. 52 shows the Two Pivot Buckets (front to rear) and as mentioned above, Rear Pivot Bucket Assembly 623 is exactly like the Pivot Bucket shown for the preferred embodiment in FIG. 1L (and other related drawings for the preferred embodiment). Front Pivot Bucket Assembly 621 has all the same equipment and is the mirror horizontal image of Rear Pivot Bucket Assembly 623. What is not shown in FIG. 52, but what is shown in FIG. 1K, are the components that are positioned in the vertical space between the respective Splash Guards (610 and 620) and the respective Pivot Bucket Assemblies (621 and 623). All of this equipment shown in FIG. 1K also exists for each of the Two Pivot Bucket Assemblies (621 and 623) in the Dual Pivot Bucket sub-embodiment, so there are many Above Ground Coils positioned directly below each of the Two Pivot Bucket Assemblies. For the Rear Pivot Bucket Assembly 623 there is also a Pivot Bucket Area Speed and Motion Sensor 258 and a Pivot Bucket Entry; Speed-adjusting Electromagnet (EM#3) 260, and together these components regulate the “final speed” of a canister entering the Pivot Bucket for this Rear Pivot Bucket Assembly 623. For the Front Pivot Bucket Assembly 621, there is also an identical Speed and Motion Sensor and a Speed-adjusting Electromagnet; these components are shown but not referenced.

Just as in the Single Pivot Bucket operation of the preferred embodiment, each canister entering one of these Two Pivot Buckets in the Dual Pivot Bucket sub-embodiment will make contact with the respective Two Upper Pivot Bucket Stop-pins; the Rear Pivot Bucket Assembly 623 has Upper Stop-pins 264L and 264R. The Front Pivot Bucket Assembly 621 has identical Stop-pin components, but these components are not referenced. As stated above in the Single Pivot Bucket sub-embodiment explanation, the respective Pressure Gauge (for example, Pressure Gauge 275 for Rear Pivot Bucket Assembly 623) “knows” when the Springs of the Upper Pivot Bucket Stop-pin Assemblies have compressed and decompressed, which happens as a result of a canister moving up through the respective Pivot Bucket and making upward contact with these Two Upper Pivot Bucket Stop-pins. For example, the impact-pressure of any contact made by a canister with Upper Pivot Bucket Stop-pin 264L will be indirectly transmitted to (by the various components shown in FIG. 12 of the preferred embodiment), and will be felt by, Pressure Gauge 275.

In this example related to FIGS. 47-53, since the drawings follow Canister C98 moving up through the Right Ascent Pathway Conduit 601 (and as explained above, all components are rotated 90 degrees counterclockwise, so Conduit 601 is directly below the Front Pivot Bucket Assembly 621) and entering the Front Pivot Bucket (in FIG. 52), immediately at the point when the Front Counterpart of Spring 271SpUL (this Spring is in Left Upper Pivot Bucket Stop-pin Assembly 264L for Rear Pivot Bucket Assembly 623) decompresses, a signal is sent out to the Front Counterpart of Pivot Bucket Rotational Solenoid Body 266, causing this Front Rotational Solenoid (in FIG. 52) to begin rotating that Front Pivot Bucket towards Inclined Platform 59. Then as described above in the second paragraph in the explanation for the Single Pivot Bucket sub-embodiment, at a pre-determined Degree of Rotation, this (Front) Rotational Solenoid System sends out Three types of signals. One type of signal goes to the Two Upper Pivot Bucket Stop-pin Assemblies in the Front Pivot Bucket, one signal goes to the Canister Ejection EM 622, and one signal goes to Top Cue Position Deceleration EM 626.

It was mentioned in the Structural Composition Section in the description regarding the Dual Pivot Bucket sub-embodiment that there is some additional equipment used (shown in FIG. 53) vs. the equipment used in the Single Pivot Bucket operation of the preferred embodiment. All of this additional equipment exists so Inclined Platform Sliding Canister Holder Section 625SLD will have the ability to move back and forth, from front to rear and from rear to front. And of course, this moving is necessary because as shown in FIG. 53, there are Two Pivot Buckets vs. only One Pivot Bucket shown in FIG. 1N. As mentioned in Additional Drawing Exceptions and Comments #38, FIG. 53 shows Both Pivot Buckets in a “rotated position,” where the respective canisters are about to be ejected out onto Sliding Canister Holder Section 625SLD. In actual operation of a MF device using the Dual Pivot Bucket sub-embodiment, only one Pivot Bucket would ever be ejecting a canister out onto Sliding Canister Holder Section 625SLD at any given time.

As explained above in the sixth paragraph of this sub-section on the Dual Pivot Bucket sub-embodiment, Sliding Canister Holder Section 625SLD has a total of Three Horizontal “Stop Positions,” which are: a) the “fully extended position,” where Sliding Canister Holder Section 625SLD is directly in front of the Front Pivot Bucket “Slot,” b) the “partially extended position,” where Sliding Canister Holder Section 625SLD is positioned in front of (stationary) Inclined Canister Holder 66 (this position is shown in FIG. 53 and component “66” is in the lower left of the drawing), and c) the “fully retracted position,” where Sliding Canister Holder Section 625SLD is directly in front of the Rear Pivot Bucket “Slot.” And of course, Sliding Canister Holder Section 625SLD slides back and forth from one of these “Stop Positions” to the next one, etc.

As shown in FIG. 53, there is an “air gap separation” (not referenced) to the left of Sliding Canister Holder Section 625SLD, and this “air gap” is between Sliding Canister Holder Section 625SLD and (stationary) Inclined Canister Holder 66. This “air gap” shows that Sliding Canister Holder Section 625SLD is not permanently attached to Inclined Canister Holder 66, but is instead free to move back and forth in front of and to the right of (stationary) Inclined Canister Holder 66.

As explained four paragraph above (where that example is using Front Pivot Bucket Assembly 621), when the pre-determined Degree of Rotation is reached for the rotating Pivot Bucket, the Front Rotational Solenoid System sends out Three types of signals. It is worth noting that None of these signals is for the purpose of moving Sliding Canister Holder Section 625SLD directly in front of the Pivot Bucket “Slot” for the Pivot Bucket that is being rotated. The reason for this is that Sliding Canister Holder Section 625SLD will have already been positioned directly in front of the Pivot Bucket “Slot” where the next canister is going to be coming from (is going to be “ejected out of”). This “repositioning process” explained below is triggered by Canister Holder Section Exit Sensor 632, and will have already taken place PRIOR TO the respective Rotational Solenoid System sending out these Three types of signals mentioned above.

But to focus once again on what is shown in FIG. 52 and FIG. 53, as a canister is being “ejected out” of a Pivot Bucket and is moving towards a “waiting” Sliding Canister Holder Section 625SLD, the collective result of these Three signals that were sent by the respective Rotational Solenoid (sent either from Solenoid 266 or from the unreferenced “mirror image counterpart,” the Rotational Solenoid for Front Pivot Bucket Assembly 621), and the related actions taken by the respective components, is that the canister that is inside the “rotated” Pivot Bucket is “ejected out” onto Sliding Canister Holder Section 625SLD, and then that canister is also originally “pulled towards” Top Cue Position Deceleration EM 626 by the EM Field created by this Deceleration EM (this EM Field was created because Deceleration EM 626 received the signal from the respective Rotational Solenoid to create the EM Field).

All of the factors and processes of how a canister is accelerated, decelerated and even “held in a fixed position” by Deceleration EM 626 and the functions of any other related components and/or related processes that were previously described in the sub-section above about the Single Pivot Bucket operation (using components shown in FIG. 1N) are all exactly the same for the Dual Pivot Bucket sub-embodiment. Except in the Dual Pivot Bucket sub-embodiment there is a necessity for, and there are processes and components used to implement, a sliding action of Sliding Canister Holder Section 625SLD, and therefore this important component is continuously being moved from one Pivot Bucket “Slot” to a “Middle Position” to the other Pivot Bucket “Slot,” in this order. The remainder of this discussion will focus on these “slide-related” events and the components used to make these events happen.

In the Structural Composition Section for this Dual Pivot Bucket sub-embodiment, the physical components needed to implement this “sliding process” were described. In short, Slide Solenoid 628 (this “628” reference includes both the Body of the Solenoid and the Plunger) is attached directly to the Rear side of Sliding Canister Holder Section 625SLD and Slide Solenoid 628 either pushes or pulls Sliding Canister Holder Section 625SLD, to the front or to the rear, respectively. Shown in FIG. 53, there are two relatively small, identical vertical cut-out areas in Sliding Canister Holder Section 625SLD and these cut-out areas are directly above the tops of the Two Slide Rails 627 (these cut-out areas are not referenced and the Slide Rails are not referenced individually). These two cut-out areas are there so Sliding Canister Holder Section 625SLD can ride along, going from front to rear (and from rear to front), on the tops of the Two Slide Rails 627.

There are two additional types of “signal trigger” operations in this Dual Pivot Bucket sub-embodiment that are Not used in the Single Pivot Bucket operation of the preferred embodiment. First, in the Single Pivot Bucket operation described above, it is mentioned that the “First Contact” between a canister and Front Contact Pad 629CP is important because in order for this “First Contact” to occur, this means that 100% of the canister body is sitting on the Canister Holder Section 625Ext, and therefore the respective Pivot Bucket can be rotated back to its default position. In the Dual Pivot Bucket sub-embodiment, having a canister fully positioned (100%) onto Sliding Canister Holder Section 625SLD is important for another reason; under these conditions this means no part of the canister is still inside the Pivot Bucket, and therefore Sliding Canister Holder Section 625SLD can be freely moved to the “Middle Position,” which is the horizontal position shown in FIG. 53.

As mentioned above in the sixth paragraph in this sub-section about the Dual Pivot Bucket sub-embodiment, in each Five Second Cycle, Sliding Canister Holder Section 625SLD must be horizontally repositioned TWICE, in order to: a) move the canister to the “Middle Position” where the canister can slide straight down onto the (stationary) Inclined Canister Holder 66, and b) at the appropriate time, Sliding Canister Holder Section 625SLD must also be repositioned and moved directly in front of the “next” Pivot Bucket “Slot” to be ready to take the “next” canister.

Put another way, the first horizontal repositioning occurs after 100% of the canister body is sitting on Sliding Canister Holder Section 625SLD and this repositioning action moves Sliding Canister Holder Section 625SLD away from a Pivot Bucket “Slot” and places Sliding Canister Holder Section 625SLD in the “Middle Position” (shown in FIG. 53), where Sliding Canister Holder Section 625SLD is positioned in front of (stationary) Inclined Canister Holder 66. The second horizontal repositioning moves Sliding Canister Holder Section 625SLD away from this “Middle Position” and positions Sliding Canister Holder Section 625SLD in front of the Pivot Bucket “Slot” where the “next” canister will be ejected towards.

So what is shown in FIG. 53 is a situation where Sliding Canister Holder Section 625SLD has just been repositioned (within the past ONE second). It is not that important where the canister came from (the front or rear Pivot Bucket “Slot”), what is relatively important is what caused the Sliding Canister Holder Section 625SLD to move. The answer to this question is as follows. In the Single Pivot Bucket operation, when the first (compression) “impact” is felt between a canister and Contact Pad 629CP, Pressure Sensor 633PrSns sends out Two types of signals at the same time—one signal causes the Pivot Bucket to be rotated back to its default position and the other signal causes Deceleration EM 626 to reverse its EM Field. In the Dual Pivot Bucket sub-embodiment, these two events just described still occur, but in addition, even as the “First Bounce” is just about ready to occur, a third signal is sent to Slide Solenoid 628, causing this Solenoid 628 to move Sliding Canister Holder Section 625SLD to the “Middle Position” (shown in FIG. 53). So even while the entire Sliding Canister Holder Section 625SLD is being repositioned, the canister is still moving and is heading up to the right in the “First Bounce.” However, because the EM Field of Deceleration EM 626 is repelling the magnet inside the canister, the canister is immediately pushed back down to the left and the Leading Surface of the canister makes a Second Contact with Contact Pad 629CP (and Pad 630CP) which in turn causes the “Second Bounce.”

The “Second Bounce” occurs, and then moving ahead a few Steps, as was explained above in the description for the Single Pivot Bucket operation, after: a) the Two Ejection Impact Spring Assemblies are pulled down and out of the way, and then b) Deceleration EM 626 terminates the “Final EM Field” that has been holding the canister stationary (while this “retraction operation” was performed), the canister quickly slides down and to the left and in a very short time the entire body of the canister has moved completely onto Inclined Canister Holder 66. As that process was occurring, Inclined Platform Top Cue Position Exit Sensor 632 detected when the bottom surface of the canister passed in front of Sensor 632. At that precise moment, in the Single Pivot Bucket operation, Exit Sensor 632 sent identical signals to the Two Repositioning Solenoids 629Slnd and 630Slnd, causing these Solenoids to reset the respective Ejection Impact Spring Assemblies. In the Dual Pivot Bucket sub-embodiment, these same Two signals are sent but also, an additional signal is sent to Slide Solenoid 628, causing Slide Solenoid 628 to fully retract or to fully extend, thereby moving the entire Sliding Canister Holder Section 625SLD in front of the “next” Pivot Bucket “Slot” where the “next” canister will be moving towards. In the specific example for FIG. 53, upon receiving this “repositioning signal,” Slide Solenoid 628 will pull the entire Sliding Canister Holder Section 625SLD to the “fully retracted position” (moving Sliding Canister Holder Section 625SLD to the rear, over the tops of the Two Slide Rails 627), and therefore Sliding Canister Holder Section 625SLD will be sitting directly in front of the Rear Pivot Bucket, which is the Pivot Bucket “Slot” where Canister C99 will be heading towards in a second or two after this repositioning operation has been completed. 9. Areas on the MF Device where Springs Absorb Shock.

A) The first place where Springs Absorb Shock was described above in this general section, in Operational Description #4, regarding the Far Left Side of Inclined Platform 60. Specifically, the Four components absorbing this “shock” are: a) the Two Springs, 80SpF and 80SpR, that connect the Front Vertical Support Beams (62F and 62R) to the Front Drop Point Retaining Pin Solenoids (81F and 81R), and b) the Two Springs, 87SpF and 87SpR, which connect the Front Vertical Support Beams (63F and 63R) to the Front Inclined Platform Notch Pins (88F and 88R.)

B) When the Drop Phase begins, the next part of the MF device where Springs Absorb Shock is shown in FIG. 1B, the Air Side Launch Area. Specifically, the Two Spring Systems, 102SpF and 102SpR, which are on top of the Two Final Release Funnel-trays, 102F and 102R, will be required to absorb a substantial amount of downward impact in the beginning part of each Cycle, and in the preferred embodiment, a Cycle occurs about every five seconds. The “phantom canister” PhC in FIG. 1B shows that in the Air Side Launch Area, the Speed-adjusting Electromagnet EM#1 92 is several inches higher than one canister length above the top of the Two Spring Systems, 102SpF and 102SpR. In the preferred embodiment, the length of the canisters is about 26 inches, and so even if the EM#1 92 is reducing a canister's rate of fall somewhat, the Two Springs Systems, 102SpF and 102SpR, will still be absorbing the impact, in that embodiment, of about a 50-pound object falling directly down onto the Springs from a height of more than two feet.

So one of the key issues to consider is exactly how much can EM#1 92 slow down the rate of fall of the canister? The way this EM#1 92 works, in conjunction with the Air Side Launch Area Motion Sensor 90, is that when the Sensor detects that a canister is passing in front of it, the Sensor 90 sends an Activation Signal to EM#1 92, which causes EM#1 92 to create a very strong Counter-magnetic Field that will work in opposition to the canister's Magnetic Field, at the point when the canister is still approaching EM#1 92 from above. [Note: this Magnetic Field is not a “pulse” but will hold in place for a pre-determined amount of time, and that amount of time will be calculated so that the Field will shut-off once the magnet is basically Out of Range of the EM's Magnetic Field (when the magnet is too far below the bottom surface of EM#1 92).]

Similar to what was described above, regarding the Two Far Left Miniature Deceleration Electromagnets, 82F and 82R, while the magnet inside the canister is above EM#1 92, then there will be a magnetic effect to REPEL the falling canister, and when the magnet moves out of EM#1 92 at the bottom of EM#1 92 and the magnet continues heading downward, there will be a magnetic effect to Attract the magnet inside the canister, due to the Reverse Polarity being emitted by the Back Side of the magnet, because the magnet is positioned BELOW EM#1 92. So at that point EM#1 92 will be attempting to “pull the magnet back up” while the magnet is in fact falling further and further away from EM#1 92. The more powerful the Magnetic Field created by EM#1 92, the slower the magnet will “fall away” from EM#1 92. Because of the weight of the magnet (about 45 pounds) for this embodiment, the canister's downward motion cannot be totally stopped by any Magnetic Field that EM#1 92 can generate, but the rate of the canister's fall can be decreased to some extent, as a result of these deceleration procedures applied on the canister by the Magnetic Field of EM#1 92. In any event, the canister will make contact with the Two Spring System, 102SpF and 102SpR, while the canister is moving downward at a fairly substantial rate speed, and with substantial mass. However, the Two Spring Systems, 102SpF and 102SpR, and the overall construction of the Two Final Release Funnel-trays, 102F and 102R, have been designed to be Sturdy and to be able to take such “impacts” as just described without any loss of integrity to: any of these Springs, the Two Funnel-trays or any other equipment connected to the Two Funnel-trays.

One other issue not to do with “Springs absorbing Shock” that should be mentioned with regards to the operation of the Funnel-tray Systems, 102F and 102R, is the ways in which the Leading Surface of a canister will be making contact with the tops of the Two Spring Systems, 102SpF and 102SpR, and also making contact with the Angled Surfaces of the Final Release Funnel-trays, 102F and 102R, as the Two Funnel-trays begin pulling apart from each other. The first thing to notice is that in FIG. 3c, this drawing shows the Two Springs (there are really three Springs, but the Spring on the left has another Spring directly behind it) sticking up considerably higher than the thin, Angled Surface that comes up all the way from the bottom of the “Funnel” and almost touches the left Spring in FIG. 3c. This drawing is showing the Springs Without a heavy canister sitting on top of them, and so after contact has been made and a canister basically comes to rest, momentarily, on the Two Spring Systems, all of the six Springs will be compressed to the point where the height of the Springs will have been pre-determined (when they are supporting the weight of a canister) to match the height of the Angled Surface. In this manner, the Springs will be supporting some of the weight of a canister and the Two Angled Surfaces (which are flat on top; FIG. 3b shows the Second Angled Surface) will also be supporting some of the weight of the canister.

As the Two Final Release Funnel-trays start pulling apart, the Leading Surface of a canister at one point will not be resting on any Springs at all, but instead will be supported by sitting on the Four Flat Surfaces (the tops) of the Four Angled Surfaces. FIG. 4a shows that when the Two Funnel-trays have moved apart a small amount, the canister is resting on the Four “Inner Springs” and also on the Four Angled Surfaces, but the canister is no longer resting on the Two Springs that are furthest out from the center of the canister. Then FIG. 4b shows that the canister is Not resting on any Springs and is being supported completely by, and resting on, the Four Small Flat Areas on the top of the Four Angled Surfaces. FIG. 4c then shows that the Leading Surface of the canister has “slid down” the Angled Surfaces (the edges of the “Funnel”) and in so doing has moved down deeper into the “Funnel.” By the time the Two Funnel-trays are so far apart that the canister falls Completely Through the opening created by the Two Funnel-trays separating, the Leading Surface of the canister will have slid down so deep into the Funnel that it will almost be at the bottom the Funnel, anyway.

As with any funnel, the Body of a funnel is circular, and together the combined “body” of these Two Funnel-trays forms a circular shape that will very closely match the round shape of the Leading Edge of a canister. Even though the diameter of this circular shape of the “body” of the Two Trays, together, does get smaller towards the bottommost point of the Two Funnel-trays, since the Two Trays are continuously being pulled apart, the actual “body diameter” of the Two Trays (the distance across from one Tray to the other at any given height) that is in contact with the leading circular edge of the canister at any given point, will remain more or less constant as the canister keeps falling further down into the ever-widening funnel-body of the Funnel-trays. In this way, the canister will basically stay in the proper vertical alignment while the canister keeps sliding down deeper into the Funnel. Once the canister begins “falling into this funnel-body” (after the canister is no longer being supported by the Top Areas of the Four Angled Surfaces; at some point between FIG. 4b and FIG. 4c), there is a period of approximately one second (the period of time when a canister is moving “deeper into the “funnel body”) until the canister actually reaches a Free Fall State and falls all the way through the separation that has been created by the Two Funnel-trays being pulled apart from each other.

C) In the same way just described above in the preceding paragraphs of the “B” sub-section, where two halves of a larger “Unit” work in conjunction with each other, FIG. 1H shows there are Two Halves of the Pre-launch Launch Platform, 211L and 211R, that are “closed together” to form One Complete Unit (the Pre-launch Launch Platform) and both Halves of this Launch Platform have Spring Matrices mounted on top of them. As described above in various places, one of the sub-events near the end of the overall Coupling Process is that Two Canisters fall a distance of about four inches (or more) back down onto the Two Spring Matrices, 211SpL and 211SpR. And it is not just that 90 or 100 pounds of magnet-canisters are falling back down on these Springs, but there is also a very strong Fluid Pressure force pushing down on the Leading Surface of the top canister, and that entire force will actually be indirectly felt by these Two Spring Matrices, 211SpL and 211SpR, when they are required to absorb the shock of that short fall of a few inches by the Two Canisters. The Two Spring Matrices, 211SpL and 211SpR, and the overall construction of the Pre-launch Launch Platform, 211L and 211R, have been designed to be Sturdy and to be able to take such “impacts” without any loss of integrity to the Springs or to any other equipment connected to the Two Pre-launch Launch Platform Halves.

D) The final place on the device (for the preferred embodiment) where Spring Systems are used to absorb shock is inside the Pivot Bucket (FIGS. 1L, 1L-2 and 12). The basic idea with these Spring Systems is more or less like the Two Spring Systems just described in “C,” which operate in the Pre-launch Area of the device. But in the Pivot Bucket Area, a Pair of Upper Pivot Bucket Stop-pins (264L and 264R; these Springs are mounted Above these Solenoid-Pins) are extended out in the beginning of the process and are there to basically “catch” a canister that is moving upward and that is fully entering the Pivot Bucket. When that happens the canister makes contact with the Two Pins, 264L and 264R; also the Left Upper Pivot Bucket Stop-pin System, 264L, has a pressure gauge 275 on it, so when the Spring 271SpUL is compressed, then a signal is sent to the Pair of Lower Pivot Bucket Stop-pins (263L and 263R; these Stop-pins have Springs mounted on the Bottom of the respective solenoid) and these Two Lower “263 Pins” extended out and basically “trap” the canister inside the Pivot Bucket, because with the Two Lower “263 Pins” extended, the canister is Blocked from falling back out of the Pivot Bucket through the hole (that was open when the canister entered the Pivot Bucket). In any event, all of this “contacting” that goes on between a canister first “flying” upward and contacting the “264 Pins,” and then the canister “falling back down” and contacting the “263 Pins” in the opposite way (this is why the Springs are on the Top of the “264 Pins” and on the BOTTOM of the “263 Pins”) requires that the individual Springs (of these Four Pivot Bucket Stop-pin Systems) absorb a substantial amount of kinetic energy from a canister.

There are Two key design features, however, that help this overall situation regarding these Four Springs, 271SpUL and 271SpLL (and their Right-side Counterparts), which are mounted in the respective Pivot Bucket Stop-pin Assemblies. The first beneficial design feature is that the Pivot Bucket is mounted at a Pre-determined height, and that height is such that the Upper Pivot Bucket Stop-pins, 264L and 264R, are vertically positioned (when the Pivot Bucket is in the default position, pointing straight up, as in FIG. 1L) to be at a vertical point that is very close to where a canister will have exhausted all of its momentum (kinetic energy) acquired from its ascent all the way through the Fluid Column, because it will have already “flown into the air” approximately 18 or 20 feet at that point (in the preferred embodiment), when the Leading Surface of the canister actually makes contact with the Two Upper Pivot Bucket Stop-pins, 264L and 264R.

And second, there is a Pivot Bucket Entry; Speed-adjusting Electromagnet (EM#3) 260, that is mounted directly below the Pivot Bucket, and this EM#3 260, along with Sensor System 258, will help “tweak” the speed of a canister so that the canister makes the lightest possible impact when its Leading Surface makes contact with the “264 Pins.” This is important because the lighter the contact made while the canister is going upwards also means the lighter the contact will be when the canister falls back down onto the Lower “263 Pins.” In other words, the less the Two Springs that are on top of the Two Solenoids Bodies (270UL and its Right-side Counterpart) are compressed (the lighter the upward contact on these Springs, the less they will compress), then the less force there will be pushing the canister back down towards the Two “263 Pins” when the Two “264 Springs” decompress.

The only thing that absolutely needs to happen, however, is that the Spring 271SpUL needs to compress enough to trigger the Pressure Gauge 275, so this Pressure Gauge can send the signal to the Two “263 Pins” to close the bottom “Pin-door” on the Pivot Bucket. If there is not enough pressure applied to the 271SpUL Spring, then within about one second after the canister reaches the peak of its ascent, it will simply have fallen back out of the Pivot Bucket through the bottom of the Pivot Bucket and will continue falling 18 or 20 feet to the ground and the MF device will completely shut down and repair people will have to come to the site, etc. (see Cycle-sequence Descriptions; FIG. 18, “Pivot Bucket Area 313.”)

E) Another place where Springs Absorb Shock is in the Over-sized embodiment in the Reservoir Exit Launching System 426; specifically with regards to the Two Reservoir Exit Notch Pin Systems (452R and its Left-side Counterpart) and the Two Floatation Stop-pin Systems (455R and its Left-side Counterpart). The Springs in Both of these Two Right-side Systems, 452R and 455R function basically like the Spring in Upper Right Pivot Bucket Stop-pin 264R, except that there is less external force applied to the Springs of the 452R and 455R “Pin Systems.” Also, the Springs in Both of the Left-side Counterparts to the Right-side “Pin Systems” 452R and 455R, respectively, function basically like the Spring in the Upper Left Pivot Bucket Stop-pin 264L, except that there is less external force applied to the Springs of the Left-side Counterparts of the 452R and 455R “Pin Systems.” 10. The Speed-adjusting Electromagnets.

There are three places in the overall MF device (in the preferred embodiment) where Full-size Speed-adjusting Electromagnets are used. In each instance, there is a Speed and Motion Sensor above or below (“in front of” with regards to canister movement) the respective EM, and for EM#2 195 (in the Arc C Area), there is a Speed and Motion Sensor 196 above this EM#2 195, in addition to the Speed and Motion Sensor 194 that is below EM#2 195. The locations of these Three Speed-adjusting EMs in the MF device are: a) at the top of the Air Side Launch Area [Air Side Launch Area; Speed-adjusting Electromagnet (EM#1) 92, which receives instructions from the Air Side Launch Area Motion Sensor 90]; b) above the Roller Conveyor and below the Pre-launch Area, in the Arc C Area [Arc C Pre-launch; Speed-adjusting Electromagnet (EM#2) 195, which receives instructions from Two Sensors; Lower and Upper: Speed and Motion Sensor(s) for Arc C Pre-launch; Speed-adjusting Electromagnet (EM#2), 194 and 196, respectively]; c) just below the Pivot Bucket [Pivot Bucket Entry; Speed-adjusting Electromagnet (EM#3) 260 which receives instructions from the Pivot Bucket Area Speed and Motion Sensor 258].

The operation of these Three EMs is extremely critical to the overall successful operation of a MF device. EM#1 92 is necessary to help try and reduce the impact of a falling canister on the Spring Systems, 102SpF and 102SpR, mounted on top of the Two Final Release Funnel-trays. EM#2, 195, is absolutely the most critical EM of the three (that why it has an Upper and Lower Sensor) and is perhaps the most critical component of the entire MF device (except for the Primary Seal). The fine tuning of momentum that a Lower Canister has in initiating the Coupling Process is an extremely sensitive operation, especially in light of the fact there is so much Fluid Pressure pushing down on the Leading Surface of the Upper Canister in the Coupling Process. EM#3, 260, is also very important because a “Flying Canister” about to enter the Pivot Bucket MUST make strong enough contact with the Upper Left Pivot Bucket Stop-pin 264L to trigger the Pressure Gauge 275, or the entire MF device will immediately shut down. But the critical backbone for all of these Three EM Systems is not so much the Three Electromagnets, themselves. By far the more important and essential operational contributions come from the sophistication, analytical power and extreme accuracy of the Related Sensor Systems that are assigned to the individual EMs, and also it is very important how each of these Sensor Systems interacts with its respective Electromagnet.

One final note about all of the Speed-adjusting Electromagnets (and other Electromagnets that manipulate canister movement used on the MF device) is that if for any reason, when a magnet enters one of these EMs and creates a situation whereby both the North Pole and South Pole of a magnet 77 are completely inside a particular EM at the same time, if there is a tendency for any Magnetic Field Effects to cancel each other out, then all of the Sensor Systems can be modified to overcome any such Magnetic Field Cancellation Effects. In other words, as a magnet is heading towards the opening of one of these EMs, the magnet (and the canister) will have a certain amount of momentum, and this momentum will also have been increased as a result of the attractive powers of the particular EM the magnet is heading into. So at that point just prior to the magnet entering the EM (a fraction of a second beforehand), the Magnetic Field of the EM can be shut down, and so the magnet (and the canister) will still enter and pass completely through the EM because of the pre-existing momentum, even without a continuous Magnetic Field being generated by the EM.

Then once the magnet has totally passed through the EM, the Magnetic Field of the EM can Automatically be reinstated, or even reversed as applicable, and therefore there is no possibility of any Magnetic Field Cancellation Effects impeding or altering the movement of the magnet (and the canister). In this type of a situation, the strength of the Magnetic Field generated by the EM can simply be increased if necessary (according to pre-determined values) to make up for the fact that there was a certain amount of time (however long the magnet was actually moving through the inner diameter of the EM Coil) when no attractive or repulsive forces were being applied to the magnet.

In the Reservoir Exit Launching System 426 of the Over-sized embodiment, there is: a) a Set of Six Miniature Speed-adjusting Electromagnets (251aR, 251bR, 251cR, and the Left-side Counterparts for these three components), and b) a whole series of Full Size Reservoir Exit Acceleration Electromagnets (457aR, 457bR, and their Left-side Counterparts, and other identical EM components not referenced and not shown). These EM Components of the Over-sized embodiment are not being described here, but some of them are described in 13 Topics; #5, “Over-sized embodiment” and are shown in FIG. 27).

### 11. Notch Pins and Notch Grips.

There is one place in the preferred embodiment of the overall MF device where a Pair of Notch Pins are used and one place where a Pair of Notch Grips are used. A Pair of Inclined Platform Notch Pins (88F and 88R) are used on the Far Left Side of Inclined Platform 60, and each Notch Pin System (which includes a Plunger—which is “the Pin” and a Solenoid that the Plunger moves inside of) is attached to a Spring, 87SpF and 87SpR, respectively. A Pair of Pre-launch Notch Grips, 219F and 219R, are used in the Pre-launch Area 308 to: a) apply light pressure on the Notch of a suspended canister, from at least two directions, for the purpose of keeping the canister in proper horizontal alignment, and b) provide vertical suspension for a suspended canister for split second periods of time only while the Two Suspension Support Rods 227L and 227R are transitioning from the extended mode to the retracted mode. There is no Spring System attached to these Notch Grips, because during the Pre-launch Process, the Lower Canister stops at a Pre-determined height whereby the Notch in the related canister is positioned to be exactly in front of the Two Notch Grips, so the solenoids for the Two Notch Grips, 220F and 220R, respectively, simply extend out and move the Two Notch Grips, horizontally, into the Notch, with no additional vertical motion, no “shock,” no vibration, etc. The Two Notch Grip Solenoids only move the Notch Grips forward and back, in the horizontal plane, with a stroke of about one-half inch.

The Over-sized embodiment also uses the same Two Notch Pins and the same Two Notch Grips just described, but in addition, in the Reservoir Exit Launching System 426, there is another Pair of Reservoir Exit Notch Pins, 452R (and its Left-side Counterpart).

### 12. One Canister Body Experiencing Two Distinctly Different Pressures.

It is an interesting point that when an Upper Canister is sitting stationary (for a couple of seconds during every Cycle) in the Pre-launch Position, the body of the canister is actually experiencing two very different pressures. Approximately four inches of the canister's body (the Nose Cone Protrusion 70 is not included as part of this four inches, but obviously will still be under High Fluid Pressure), which includes the Leading Surface of the canister and about four inches of the Cylindrical Portion of the canister body, will be experiencing Substantially Strong Fluid Pressure. But then slightly below that (immediately below the Primary Seal), the pressure on the lower portion of the canister's body is simply the pressure of the ambient air that is filling the overall Pre-launch Area; this pressure is about 14 psi.

### 13. A MagnaFloat can Produce Alternating Current.

It is not necessarily true that a MF must produce only direct current. As a magnet enters a Coil a current with a certain polarity is created and then as the magnet passes out of the Coil on the other side, current with an opposite polarity is produced. So with the proper computerized switching sequences and with other equipment (such as invertors) built into an embodiment of the MF device, it is possible that the end product of a MF device can be alternating current. This truism of how the electricity changes its polarity as a magnet passes all the way through a Coil and out the other end of the Coil has been an underlying factor in the MF design, with regards to how the magnets pass through a multitude of Individual Coils. In this way, each separate amount of electricity produced can be processed in its own way and/or manipulated by invertors, etc. to sort, consolidate, switch and/or combine the various positive and negative currents that are potentially being generated at the same instant by a different magnet that is moving at precisely the same time on the other side of the device. The scope of this patent does not include the very complicated requirements of how a computer system can be utilized to perform such sorting, consolidating, switching and combining processes of the electricity being produced by the MF device in the Air Side Coil Stack 321, in the Fluid Side Coil Stack 322, and in the Above Ground Coils.

### Closing Provisions

By way of example only, this detailed description, in combination with the drawings, has presented certain novel features used in the best currently contemplated designs of the MF device, in order to provide the opportunity for others to gain a complete understanding of the device. All such information given in the descriptions and the drawings has been given for the purpose of providing a general representation of the device in its various forms and therefore should not be used for the purpose of attaching any limitations on, or to limit the scope of, the present invention. The spirit and scope of the present invention should be limited only by the following appended claims.

It should also be understood that the principles contained herein, including any omissions and any other alternatives, adaptations, and design modifications to the form or operation of the device may be envisioned or become readily apparent to those skilled in the art. Therefore, any such related changes, enhancements or improvements to the present invention as it has been illustrated and described should be made without departing from the spirit and scope of the invention, as further described in the appended claims.

Finally, the preferred embodiment and alternate embodiments of the present invention have been described using certain terminology, which has been used for the sake of clarity. However, it should be understood that the present invention is not intended to be limited by any such terminology. In fact, each component described above and below should be understood to include all of the technical equivalents of that component, in the event such equivalents: a) operate in a manner similar to how the component being described operates and/or b) accomplish a function similar to the function of the component being described.

I hereby claim the following:

1. A method of generating electricity, said method comprising:
allowing multiple canister-like objects to move along a series of open, non-enclosed pathway sections, and whereby each pathway section leads into the next pathway section;
using a set of four or more buoyant canister-like objects to cause electricity to be generated at certain points along these open, non-enclosed pathway sections, and whereby the buoyant property of each canister-like object is relative to the specific gravity of the water-like non-air fluid that is held in a fluid column-like pathway section;
positioning two or more inductors along certain areas of these open, non-enclosed pathway sections, and
allowing electricity to be generated each time the magnet attached to or located inside a canister-like object passes in proximity to an inductor;
having one of the pathway sections in the overall device be a fluid column-like pathway section which: a) is open on both ends, b) is partially filled with a water-like non-air fluid, c) is positioned in a vertically-oriented manner so that one of the open ends is approximately directly above the other open end, d) has a no-leak seal-like component fixed in and around the open end that is at a lower vertical point than the other higher open end, and whereby the exact shape of the inner area of such no-leak seal-like component is constructed so that this shape matches, as closely as possible, the shape of the outer surface of the main portion of the body of each canister-like object, and e) where none, or very little, of the water-like non-air fluid ever leaks out through the lower open end of this fluid column-like pathway section because the main portion of the body of a canister-like object is always inside of, and making tight enough contact with such no-leak seal-like component, to prevent any such leakage of water-like non-air fluid from ever occurring;
at all times to have the main portion of the body of a canister-like object positioned in a vertical or almost vertical direction, and also to be positioned inside of, and making tight contact with the no-leak seal-like component that is fixed in and around the lowest open end of the fluid column-like pathway section, and
causing a lower canister-like object to elevate an upper canister-like object, in a process that: a) pushes the upper canister-like object to a vertical point so that the bottom surface of the upper canister-like object is elevated higher than the topmost point of the no-leak seal-like component, b) to stop elevating the two canister-like objects at the precise vertical point where the lower canister-like object has reached the same vertical elevation that the upper canister-like object was at when such upper canister-like object was being suspended prior to contact being made between the two canister-like objects, and c) to have the bodies of the canister-like objects constructed in such a way that as a lower canister-like object moves into the same vertical position the respective upper canister-like object was at before such elevation process started, which also includes pushing such respective upper canister-like object through and past the no-leak seal-like component, none, or very little, of the water-like non-air fluid being held in the fluid column-like pathway section leaks out;
beginning each new repetitive cycle of movement for a respective canister-like object by allowing such canister-like object to move downward from a vertical point where the downward motion of this canister-like object had previously been stopped, and as a result of the force of gravity, allowing such canister-like object to drop off of the bottommost edge of an inclined platform-like structure and to continue falling downward in a freefall state, but
even before the initial start-up of the device, to pre-configure the arrangement of the canister-like objects so that in another pathway section, basically on the other side of the device from where a canister-like object drops off of the inclined platform-like structure and begins a new repetitive cycle, two canister-like objects are vertically coupled together, with an upper canister-like object positioned directly on top of, and making contact with, a lower canister-like object, and
whereby the vertical position of the upper canister-like object is such that: a) some portion of the body of this upper canister-like object is making contact with a no-leak seal-like component, b) some upper portion of this canister-like object's body is making contact with the water-like non-air fluid that is being held in the fluid column-like pathway section, and c) the lower portion of the body of this upper canister-like object is exposed to the air, and
whereby the bottom surface of the lower canister-like object is sitting on a coupled canister platform-like component, and
this coupled canister platform-like component has the ability to move up and down, along a vertical axis;
for the first repetitive cycle when the device is first put into operation, and for all other repetitive cycles after that, on or around the same time a respective canister-like object begins a new repetitive cycle by dropping off of the bottommost edge of an inclined platform-like structure and entering a freefall state heading downward, in a completely different pathway section on the other side of the overall device, causing the coupled canister platform-like component, with two canister-like objects stacked on top of each other and with the bottom surface of the lower canister-like object sitting on, and making contact with, such coupled canister platform-like component, to be elevated to a precise vertical height, which is a height whereby the bottom surface of the upper canister-like object is elevated completely above the topmost point of the no-leak seal-like component, and therefore the body of this upper canister-like object becomes completely surrounded by the water-like non-air fluid that is being held in the fluid column-like pathway section, and therefore as a result of the buoyancy such upper canister-like object has, the upper canister-like object begins floating upwards, and also
when such elevation process stops, the vertical position of the lower canister-like object is exactly the same vertical position the upper canister-like object was at before such elevation process started;
changing the downward motion of a descending canister-like object that is traveling in the pathway section a canister-like object moves along when descending in a freefall state, and changing such downward direction of motion to a horizontal or semi-horizontal direction of motion, as that same canister-like object moves into and along the next pathway section;
allowing a canister-like object to continue moving in a horizontal or semi-horizontal direction of motion, on a pathway section that connects the pathway section where the downward motion of a descending canister-like object is changed to a horizontal or semi-horizontal direction of motion with the pathway section that changes the direction of motion a canister-like object is traveling in from a horizontal or semi-horizontal direction of motion to a vertical or semi-vertical upward direction of motion;
in another pathway section, changing the horizontal or semi-horizontal direction of motion a canister-like object is travelling in to a vertical or semi-vertical upward direction of motion, and allowing such canister-like object to continue ascending out of this pathway section and to continue heading upwards;
whereupon an ascending canister-like object exits the top of the fluid column-like pathway section, to cause such canister-like object to be deposited back onto some portion of the surface of the inclined platform-like structure, and whereby this surface of such inclined platform-like structure is the same overall surface the respective canister-like object falls off of, at the lowest point of this surface, to begin a repetitive cycle.

2. The method of generating electricity according to claim 1, where said method comprises:
using an inclined platform-like structure to facilitate downward canister movement so that each canister-like object can begin its own respective repetitive cycle, and
whereby such inclined platform-like structure has multiple canister-like objects making contact with such inclined platform-like structure at any given time, and whereby all of the canister-like objects sitting on such inclined platform-like structure, as a group, are lined up one after another in a waiting cue-like configuration;
allowing one canister-like object at a time to move off of such inclined platform-like structure in a process that initially uses a means to hold in place the canister-like object whose turn it is to move off of such inclined platform-like structure and then causing such retaining means to be re-positioned in a way that allows the leading surface of the canister-like object being retained to move in an unobstructed manner towards the lowest edge of such inclined platform-like structure, and then to allow such canister-like object to drop off of this inclined platform-like structure as a result of gravity, potentially in combination with other forces pulling or pushing that canister-like object off of this inclined platform-like structure;
positioning inductors at unspecified intervals along the vertical height of the pathway section a canister-like object moves along while such canister-like object is descending in a freefall state, and also
positioning inductors at unspecified intervals along the vertical height of the fluid column-like pathway section,
and whereby the shape and construction of each of these inductors is such that there is an open area in the middle of each such inductor, and this open area is large enough for a canister-like object to pass through without making contact with any part of the inductor, and also positioning each such inductor so that this open area in the middle of such inductor is exactly in the pathway a canister-like object must use while such canister-like object is either: a) descending in a freefall state along this respective pathway section, therefore causing a canister-like object to pass through the middle of each such inductor when any canister-like object is moving in proximity to any such inductor and while such canister-like object is moving downward in a freefall state, or b) ascending from the bottom portion of the fluid column-like pathway section to the top of the fluid column-like pathway section, therefore causing a canister-like object to pass through the middle of each such inductor when any canister-like object is moving in proximity to any such inductor while such canister-like object is in a floatation state and moving upward through that respective fluid column-like pathway section, and
whereby the two ends of wire for each inductor are attached to an electrical load, and as a result of the interaction of the magnet, that is attached to or located inside the respective canister-like object, passing through the inner space of each respective inductor, electricity is generated, separately, in each such inductor and at the same time this electricity flows from the respective inductor into such electrical load;
shortly after a canister-like object has passed through the bottommost inductor that is located in the pathway section a canister-like object moves along while such canister-like object is descending in a freefall state, using a direction-altering means, that has a vertical section and an arc section and a horizontal section, to change the downward motion of a descending canister-like object to a horizontal or semi-horizontal direction of motion;
at some unspecified distance after the direction of motion of a canister-like object has been changed from a downward motion to a horizontal or semi-horizontal direction of motion, precisely aligning the direction of motion of the leading surface of such canister-like object, by using properly positioned direction alignment means, so that as this canister-like object passes through, or moves past such direction alignment means, the leading surface of such canister-like object is directly in front of, and at a right angle to, the respective outer flat head-like surfaces that are directly connected to two or more respective plunger-like means, and whereby such plunger-like means are attached, through hydraulic lines, to an overall hydraulic system;
for a canister-like object traveling in a horizontal or semi-horizontal direction of motion, and before any speed-adjustment procedures are performed on such canister-like object, and just after such canister-like object has passed through one or more direction alignment means, allowing the leading surface of this canister-like object to make contact with one or more outer flat head-like surfaces that are directly connected to respective plunger-like means;
keeping these two or more plunger-like means, and the respectively attached peripheral outer flat head-like surface components, directly in the pathway of this moving canister-like object for a regulated amount of time, and to allow the leading surface of the moving canister-like object to keep making continuous contact with the outer flat head-like surfaces that are directly connected to these respective plunger-like means at all times during this regulated amount of time;
causing the two or more plunger-like means, and the respectively attached peripheral outer flat head-like surface components, to be simultaneously moved out of the pathway the canister-like object is travelling along;
allowing the canister-like object to continue travelling in a horizontal or semi-horizontal direction for an unspecified distance by using a means to provide support for the body of such canister-like object while such canister-like object travels in a horizontal or semi-horizontal direction of motion through and along this respective pathway section;
at a pre-determined horizontal point, using a direction-altering means, that has a horizontal section and an arc section and a vertical section, to change the horizontal or semi-horizontal direction of motion of a canister-like object to a vertical or semi-vertical direction of motion;
with regards to the initial start-up of the device, and with regards to the two canister-like objects that are vertically coupled together, with one canister-like object positioned on top of the other, and
whereby these canister-like objects are basically on the other side of the device from where a canister-like object drops off of the inclined platform-like structure and begins a new repetitive cycle, on or around the time a canister-like object is released to drop off of the inclined platform-like structure to begin the very first cycle of the device, the method or methods of suspending the upper canister-like object, that is sitting on top of the lower canister-like object, is terminated;
at a specified point in time after the method of suspending an upper canister-like object that is directly above, and is making contact with a lower canister-like object, is terminated, elevating the lower canister-like object to the point where this lower canister-like object moves into the same vertical position the upper canister-like object was at before the method of suspending such upper canister-like object was terminated, and since this process of elevating the lower canister-like object to that specified vertical position ultimately results in the upper canister-like object entering a floatation state inside the fluid column-like pathway section, allowing the upper canister-like object that enters a floatation state to begin ascending through the fluid column-like pathway section as a result of the buoyancy properties such canister-like object has;
in looking more closely at the relationship of how multiple canister-like objects move at the same time within the overall device, on or around the time the leading surface of a canister-like object traveling in a horizontal or semi-horizontal direction begins making contact with the outer flat head-like surfaces that are directly connected to two or more respective plunger-like means, allowing the upper canister-like object, that was elevated into the water-like non-air fluid and that had subsequently entered a floatation state, to continue ascending through such water-like non-air fluid towards the top of the fluid column-like pathway section, and subsequently,
allowing the canister-like object that has ascended through the entire height of the fluid column-like pathway section to completely exit such fluid column-like pathway section, and also to further allow such upwardly moving canister-like object to continue ascending for an unspecified distance above and beyond the topmost point of this fluid column-like pathway section, and
to ascend in this next pathway section, that is above the top of the fluid column-like pathway section, through air or an air-like fluid, and
whereby the upward force for such ascension through air for this canister-like object is a result of the upward momentum such ascending canister-like object has acquired from the combined upwardly accelerating forces of buoyancy and a net upward pressure differential force this canister-like object has been experiencing during the entire ascension process through the water-like non-air fluid that is held in the fluid column-like pathway section;
to have pre-configured this pathway section that is above the fluid column-like pathway section so that the maximum vertical ascension point that an ascending canister-like object will reach, which is the vertical point on or around where an ascending canister-like object exhausts all of the upward kinetic energy the canister-like object has acquired while ascending through the entire height of the fluid column-like pathway section, is higher than the highest point of the inclined platform-like structure;
focusing again on the lower portion of the overall device, after the direction of motion of a moving canister-like object has been changed from moving in a horizontal or semi-horizontal direction to the canister-like object moving in a vertical or semi-vertical upward direction of motion, allowing the canister-like object to ascend out of the pathway section where this change in direction of motion occurred and to allow the canister-like object to continue ascending, according to one means or another, so that the leading surface of this ascending lower canister-like object comes in contact with the bottom surface of another upper canister-like object, and
whereby such upper canister-like object, prior to such contact being made between the two canister-like objects, was being held in suspension, so that such upper canister-like object could not move vertically or horizontally, and also
even while the initial contact is being made between the two canister-like objects, to allow at least some portion of the body of the upper canister-like object to keep making contact with the no-leak seal-like component, and also
to allow at least some upper portion of the body of this upper canister-like object to keep making contact with some of the water-like non-air fluid that is being held in the fluid column-like pathway section, and also
whereby the remainder of the body of such upper canister-like object that is below the no-leak seal-like component is exposed to the air;
at a pre-determined time after such vertical coupling event occurred, where the leading surface of the ascending lower canister-like object came in contact with the bottom surface of the upper canister-like object, using the coupled canister platform-like component to elevate the lower canister-like object and at the same time elevate the upper canister-like object, and
whereby such upper canister-like object is vertically coupled to such lower canister-like object;
for each of the canister-like objects in the set of canister-like objects, having the shape and overall configuration of each canister-like object equal, as closely as possible, the shape and configuration of all the other canister-like objects, and
on each of the canister-like objects in the set of canister-like objects, using a notch-like shape that is carved out of a portion of the main body section of each canister-like object, and whereby when a lower canister-like object has moved up into the precise position an upper canister-like object was at before the suspension of such canister-like object was terminated, using a means to insert one or more rod-like objects horizontally or at a semi-horizontal angle into the notch of the canister-like object that is positioned directly in front of such canister notch-related suspension means.

3. The method of generating electricity according to claim 2, where said method comprises:
on or around the time a canister-like object in the top region of the overall device has ascended through the pathway section that is located above the fluid column-like pathway section, and whereby such canister-like object has reached the maximum vertical ascension point in this respective pathway section,
another canister-like object in the lower portion of the overall device, whose direction of motion was changed from a horizontal or semi-horizontal direction to a vertical or semi-vertical direction of motion and whose leading surface has just risen above the top edge of the direction-altering means that has facilitated this change in the direction of motion for the canister-like object, monitoring and analyzing the upward speed of such canister-like object whose direction of motion was just changed;
after the upward speed the ascending canister-like object has been analyzed, adjusting the upward speed of the canister-like object for the purpose of allowing the canister-like object to make a successful coupling event with the canister-like object that is being held in suspension above this ascending canister-like object;
as the leading surface of the canister-like object is rising above the top surface of the component that is in the process of adjusting the speed of the canister-like object, monitoring and analyzing the upward speed of the canister-like object again;
if necessary, and based on the second analysis of the upward speed of the canister-like object, adjusting the upward speed of the canister-like object again;
allowing the canister-like object whose speed was just adjusted to continue ascending towards the bottom surface of the canister-like object being held in suspension above this ascending canister-like object;
detecting the presence of the leading surface of this ascending canister-like object, at a point when such canister-like object is approximately forty-three percent of the length of one canister-like object below the bottom surface of the upper canister-like object that is being held in suspension, and
whereby the length of a canister-like object is measured from the flat portion of the bottom surface to the flat portion of the top surface;
allowing electronic communication between the detection-related means that detected the leading surface of the ascending canister-like object and:
a) a first canister suspension means, and
b) a canister notch-related suspension means;
upon this means that detects the presence of the leading surface of the ascending lower canister-like object detecting the presence of such leading surface, having this detection-related means send:
a) a signal to the first canister suspension means, and
upon receipt of such signal by this first canister suspension means, causing this first canister suspension means to re-position certain peripheral components so that these components are extracted out from underneath the bottom surface of the lower canister-like object, and
b) signals sent to the canister notch-related suspension means, which immediately causes this suspension means to enter the retracted mode and to retract certain peripheral components out of and away from the notch of the suspended canister-like object;
detecting the bottom surface of the ascending canister-like object, when such bottom surface has passed in front of the means to detect such motion, and also whereby the vertical location of such motion detection means is at the same vertical height as the highest piece of equipment attached to the coupled canister platform-like component, or is at the same vertical height as the highest point on the coupled canister platform-like component, itself, if no peripheral equipment is attached to such coupled canister platform-like component, and whereby such coupled canister platform-like component will be horizontally repositioned, at a specified time, so that such coupled canister platform-like component will be positioned underneath the bottom surface of the ascending canister-like object, and
whereby this coupled canister platform-like component is part of an overall lower canister platform-like support means, and also there is a vertical positioning means attached to the coupled canister platform-like component and this vertical positioning means is also part of the overall lower canister platform-like support means;
as the leading surface of the ascending lower canister-like object ascends a little higher, the leading surface of this lower canister-like object makes contact with the bottom surface of the upper canister-like object that is no longer being suspended, and the two canister-like objects become coupled together, one above the other, and both canister-like objects continue to move upward to an approximately pre-determined maximum vertical ascension point, which is a vertical point where all of the upward kinetic energy of the upwardly moving lower canister-like object becomes exhausted, and at which point both canister-like objects, still coupled together, start moving back down over the same path these two canister-like objects used to ascend up to the maximum vertical ascension point, and
this maximum vertical ascension point will have been pre-configured as a result of the prior speed adjustment made to the ascending canister-like object before that canister-like object made contact with the upper canister-like object, so that the bottom surface of such lower canister-like object is higher, by an unspecified distance but for a specified amount of time, than the topmost point of the coupled canister platform-like component that will be positioned in underneath the bottom surface of such lower canister-like object, and more specifically with regards to this specified amount of time,
the total amount of time the bottom surface of such lower ascending canister-like object will be above the topmost point of a coupled canister platform-like component will be long enough for this coupled canister platform-like component to be re-positioned directly underneath, or almost directly underneath the bottom surface of this lower canister-like object, and
this specified amount of time between when the bottom surface of the ascending lower canister-like object moves above the coupled canister platform-like component and when contact is actually made between the bottom surface of the descending lower canister-like object and the topmost piece of equipment of this coupled canister platform-like component, is a combination of: a) the amount of time the lower canister-like object is ascending above and moving away from the coupled canister platform-like component plus b) the amount of time the lower canister-like object is descending down towards this coupled canister platform-like component;
electronic communication between the means that detects the bottom surface of the ascending canister-like object and a horizontal positioning means that moves the coupled canister platform-like component and at the same time moves a vertical positioning means attached to this coupled canister platform-like component, horizontally, and
whereupon the bottom surface of the ascending canister-like object is detected, to have the motion sensor-like means that detected the bottom surface of the canister-like object send a signal to the horizontal positioning means that is connected to the coupled canister platform-like component, and receipt of this signal causes the horizontal positioning means to move the coupled canister platform-like component into the proper position below the bottom surface of the ascending-and-descending lower canister-like object;
electronic communication, going in both directions, between the horizontal positioning means that moves the coupled canister platform-like component, horizontally, and a vertical positioning means that is attached to and that moves the coupled canister platform-like component, vertically, and
at a pre-determined time after such horizontal positioning means has properly positioned the coupled canister platform-like component, horizontally, and
whereby such pre-determined time is enough time for the lower descending canister-like object to have landed down upon the coupled canister platform-like component, to cause the vertical positioning means to elevate the coupled canister platform-like component to a pre-determined vertical point, and
whereby such pre-determined vertical point is such that the two canister-like objects, one on top of the other, are elevated until a vertical point is reached where the lower canister-like object, which is the canister-like object sitting directly on top of such coupled canister platform-like component, is at the exact same vertical position the upper canister-like object was at before the method of suspending such upper canister-like object was terminated;
electronic communication, going in both directions, between the vertical positioning means that moves the coupled canister platform-like component of the overall lower canister platform-like support means up and down along a vertical axis, and:
a) the first canister suspension means, and also
b) the canister notch-related suspension means;
whereupon this vertical positioning means elevates the coupled canister platform-like component to the pre-determined vertical point, this vertical positioning means sends:
a) a signal to the first canister suspension means, and
upon receipt of such signal by this first canister suspension means, causing this first canister suspension means to re-position certain peripheral components so that these components are extended in underneath the bottom surface of the lower canister-like object and this action results in this first canister suspension means having the ability to hold this lower canister-like object in a fixed position, vertically, and
b) a signal to the canister notch-related suspension means, and since the notch in the body of this lower canister-like object is sitting directly in front of this canister notch-related suspension means, the canister notch-related suspension means extends certain peripheral component out towards the notch of the respective canister-like object, and this canister notch-related suspension means applies light horizontal pressure against the notch of the respective canister-like object, and the interaction between this canister notch-related suspension means and the body of this lower canister-like object results in this lower canister-like object being held in a fixed position, horizontally;
whereupon each of these four such suspension means becomes extended out to the proper horizontal position, each such suspension means sends a signal to the vertical positioning means that moves the coupled canister platform-like component of the overall lower canister platform-like support means up and down along a vertical axis, and upon receipt of all four such signals, this vertical positioning means resets itself and thereby also resets the connected platform-like component, and
whereby such resetting process causes this vertical positioning means to move down to the lowest vertical position available, which is the default vertical position and which is a vertical position where the coupled canister platform-like component is down far enough to be moved in, horizontally, underneath the next canister-like object that can perform a coupling event with the canister-like object that is currently being suspended by the respective suspension means;
upon such vertical positioning means having re-positioned itself down to the lowest possible position, a signal is sent from such vertical positioning means to the horizontal positioning means, and upon receipt of such signal by the horizontal positioning means, causing that horizontal positioning means to retract the one or more pieces of the coupled canister platform-like component back out of the way of the path the next canister-like object will need to use in order to establish the necessary relationship between an upper canister-like object and a lower canister-like object, as the same exact coupling event occurs in the next repetitive cycle.

4. The method of generating electricity according to claim 3, where said method comprises:
whereupon an ascending canister-like object exits the top of the fluid column-like pathway section, using a method to cause such canister-like object to be deposited onto some portion of the inclined platform-like structure, by:
at a vertical point when the ascending canister-like object has fully exited the fluid column-like pathway section but where the leading surface of the ascending canister-like object is still below the bottommost point of a pivoting container-like means, monitoring the speed of such ascending canister-like object, and also,
immediately analyzing the results of such monitored data;
immediately after analysis of the speed-related data for a canister-like object is performed, manipulating the speed of such canister-like object to ensure the canister-like object has enough upward kinetic energy so that the leading surface of such canister-like object will reach a maximum vertical ascension point that is at least as high as an upper capture-related means that is a part of such pivoting container-like means;
after the leading surface of the ascending canister-like object has passed higher than the top point of the means that has adjusted the upward speed of such canister-like object, allowing this canister-like object to continue ascending even higher, and when the vertical position of the leading surface of such ascending canister-like object is at or near the maximum vertical ascension point the canister-like object can possibly ascend to, using a pre-positioned pivoting container-like means to stop the canister-like object from ascending further, and whereby such pivoting container-like means includes all the peripheral equipment attached to or located inside of such pivoting container-like means, and
whereby this pivoting container-like means has the ability to catch an ascending canister-like object completely inside of this pivoting container-like means, so that such canister-like object cannot go higher than the topmost point of the canister-like object and also so such canister-like object cannot fall back down out of the bottom of this pivoting container-like means, and more specifically,
to catch such canister-like object inside this pivoting container-like means by having an upper capture-related means and a lower capture-related means mounted on or inside this pivoting container-like means and whereby both such upper and lower means have shock absorber-like components, and
such shock absorber-like components allow the impact of the top surface or bottom surface of a captured canister-like object, respectively, to be minimized when such top surface or bottom surface makes respective contact with the upper capture-related and lower capture-related means being used to catch the canister-like object inside this pivoting container-like means, and also
as the canister-like object is initially ascending up into such pivoting container-like means, to have previously extended out into the path the canister-like object is heading along, the upper capture-related means, and also
to have previously retracted out of the path the canister-like object is heading along when such canister-like object is first trying to enter this pivoting container-like means, the lower capture-related means;
using a pressure measurement means connected to some part of the upper capture-related means, and
whereupon contact is made between the leading surface of an ascending canister-like object and the pressure measurement means connected to the upper capture-related means, to send a signal from this pressure measurement means to the lower capture-related means, and upon receipt of such signal by the lower capture-related means, to cause such lower capture-related means to fully extend out into the path of motion the bottom surface of the captured canister-like object will want to use when this canister-like object tries to fall out the bottom of the pivoting container-like means, and
whereby such action blocks the canister-like object from falling back out of the bottom of the pivoting container-like means;
upon such lower capture-related means being re-positioned into the extended mode, to cause a signal to be sent to a means used to rotate the entire pivoting container-like means, and
upon receipt of such signal from the lower capture-related means by such rotational means, to cause the pivoting container-like means to be rotated to an angled position such that the angle of slope of the body of the canister-like object after rotation, which will also be the angle of slope of the pivoting container-like means, equals or closely equals the angle of slope of the inclined platform-like structure, and
after the canister-like object has been rotated to the proper angle of slope, causing the means that rotated the pivoting container-like means to send a signal to the upper capture-related means, and
upon receipt of such signal by such upper capture-related means, causing this upper capture-related means to be re-positioned into a retracted mode so that in such retracted mode, the downwardly sloping mouth of the pivoting container-like means will be totally open and unrestricted, with regards to the path the canister-like object needs to move along in order to exit the pivoting container-like means, and
since the angle of slope of the pivoting container-like means is at a considerable downward angle, and since the canister-like object has an unobstructed pathway to exit the pivoting container-like means, and since the mouth of the pivoting container-like means has been pre-configured to be over or almost over a vacated canister cue position at or near the top of the inclined platform-like structure, allowing the canister-like object to move out of the pivoting container-like means and to move into such vacated canister cue position which is in the topmost portion of the inclined platform-like structure, and where this topmost portion of the inclined platform-like structure is at the opposite end from where a canister-like object drops off of this inclined platform-like structure to start a repetitive cycle;
at a pre-determined time after such upper capture-related means has been retracted, and whereby such pre-determined time is long enough to have allowed any captured canister-like object to have exited the pivoting container-like means and moved down onto the inclined platform-like structure, to cause the rotational means to re-position itself back to the default position, which is a position where the pivoting container-like means is in a straight-up vertical position, and also
on or around the same time the rotational means is re-positioning the pivoting container-like means back to the default position for such pivoting container-like means, having such rotational means send signals to both the upper capture-related means and the lower capture-related means, and upon receipt of such signals, to cause the upper capture-related means and lower capture-related means to both reset, so that the upper capture-related means is extended out into the pathway a canister-like object travels along if such canister-like object is attempting to ascend higher than the topmost point of such pivoting container-like means, and so that the lower capture-related means is in the retracted mode, which creates an opening in the bottom of the pivoting container-like means large enough so that the next canister-like object that approaches the pivoting container-like means will have an unobstructed path to enter into such pivoting container-like means.

5. The method of generating electricity according to claim 3, where said method comprises:
whereupon an ascending canister-like object exits the top of the fluid column-like pathway section, using a pathway section to cause such canister-like object to be deposited onto some portion of the inclined platform-like structure, by:
causing the direction of motion for a canister-like object that is exiting out the top of the pathway section to be gradually changed from a vertical or almost vertical direction to a more angled direction by using a multi-rail curved non-enclosed pathway section to achieve such gradual change in direction, and
continuing to gradually change the direction of motion of the ascending canister-like object throughout most of the time such canister-like object is traveling along this multi-rail curved non-enclosed pathway section, and
whereby this change in direction for the canister-like object is such that on or around the time the canister-like object reaches the maximum vertical ascension height which the canister-like object can possibly ascend to, at that point the canister-like object will be moving in a horizontal or almost horizontal direction, and
around the time a canister-like object has attained a direction of motion that is almost horizontal, and also a short distance before such canister-like object will be exiting this multi-rail curved non-enclosed pathway section, monitoring the speed of such canister-like object, and also
immediately after such speed has been monitored, analyzing the speed-related data obtained from such monitoring process;
immediately after the analysis of the speed-related data has occurred, adjusting the speed of the moving canister-like object and to either increase the speed the canister-like object has, so that the canister-like object will be able to successfully move from the multi-rail curved non-enclosed pathway section into the first available vacant cue position on the inclined platform-like structure, or
to decrease the speed the canister-like object has, so that the canister-like object, upon having moved from the multi-rail curved non-enclosed pathway section and onto the inclined platform-like structure, will not be going so fast as to cause damage to any equipment on the inclined platform-like structure or to cause damage to any of the canister-like objects sitting on the inclined platform-like structure;
to have pre-configured this multi-rail curved non-enclosed pathway section so that at the point when an ascending canister-like object is exiting such multi-rail curved non-enclosed pathway section, that this canister-like object will be pointed in a direction that is parallel or almost parallel to the direction the canister-like objects are pointing when such canister-like objects are sitting on the inclined platform-like structure, and this angle includes all three dimensions, front to back, left to right, and up and down, and also
that the canister-like object will be slightly higher than the topmost point of the inclined platform-like structure, and
as the momentum of a moving canister-like object causes a canister-like object to exit this multi-rail curved non-enclosed pathway section, such momentum will cause this exiting canister-like object to move from the multi-rail curved non-enclosed pathway section into the first available vacant canister cue position at the top of the inclined platform-like structure.

6. The method of generating electricity according to claim 3, where said method comprises:
whereupon an ascending canister-like object is nearing the top of the fluid column-like pathway section, using a method to cause such canister-like object to be deposited onto some portion of the inclined platform-like structure, and whereby such method uses an enlarged uppermost section of the fluid column-like pathway section, uses two identical pivoting container-like means for depositing a canister-like object onto a moveable extension of the inclined platform-like structure, and whereby these two identical pivoting container-like means means are both located above the top of the fluid column-like pathway section, and whereby this method comprises:
using an exit area for an ascending canister-like object, and
whereby such exit area is at the top of the fluid column-like pathway section, and also such exit area feeds into an enlarged uppermost section of the fluid column-like pathway section, and
whereby this enlarged uppermost section of the fluid column-like pathway section is also filled or partially filled with the same water-like non-air fluid that is being held in the fluid column-like pathway section;
on an alternating basis, making use of two independent direction-altering means that are both located within this enlarged uppermost section of the fluid column-like pathway section, and also
both of these direction-altering means are positioned and re-positioned, in a timed sequence from one repetitive cycle to the next repetitive cycle, in a way that causes each of these direction-altering means to share the same exit area, in an alternating manner, so that one such direction-altering means guides one ascending canister-like object up towards one pivoting container-like means and then after an unspecified length of time, the other direction-altering means guides the next ascending canister-like object up towards the other pivoting container-like means;
while a canister-like object is ascending through the enlarged uppermost section of the fluid column-like pathway section, that canister-like object has buoyancy and other pressure differential forces acting with a composite net upward force on the bottom surface of such canister-like object;
just prior to the point when the leading surface of a canister-like object begins passing through the exit area of the fluid column-like pathway section, monitoring the upward speed such canister-like object has;
as the leading surface of the respective canister-like object moves through the exit area of the fluid column-like pathway section, and as the canister-like object ascends further, the leading surface of the canister-like object comes into contact with the underside of the respective direction-altering means;
because of the overall shape of this direction-altering means, when the leading surface-edge of the ascending canister-like object begins making contact with the underside of the respective direction-altering means, the angle of ascent for the canister-like object is changed so that the canister-like object is no longer moving out of this exit area in a perfectly vertical ascent;
analyzing the speed-related data obtained by the motion sensor-like means that is located just below the exit area of the fluid column-like pathway section, and at the proper time which is according to an analysis based on the exact speed the canister-like object was traveling at the time the related ascending speed was monitored, causing a series of electromagnetic fields to be created, maintained, and terminated, and
whereby such electromagnetic fields are generated out from components mounted on the respective direction-altering means which will be guiding the ascending canister-like object, and
as a result of the magnet attached to or located inside the canister-like object coming in range of these electromagnetic fields, the effect is to cause the front portion of the body of the canister-like object to be pushed away from the underside of the respective direction-altering means, and whereby the effect of this repelling effect only tends to temporarily push the canister-like object away from the direction-altering means just enough to minimize the friction between the outer surface-edge of the canister-like object and the underside of the respective direction-altering means;
as the leading surface of the ascending canister-like object moves just beyond the topmost point of the respective direction-altering means, causing the direction of motion of this ascending canister-like object to be changed even more so that the modified direction of motion becomes perfectly, or almost perfectly aligned, in an upward direction;
by using even more precise direction alignment means, causing the direction of motion for the canister-like object to become basically perfectly aligned in an upward direction, and also regarding the horizontal position of such properly aligned canister-like object, the central vertical axis of the body of this canister-like object is also directly in line with the central vertical axis of the respective pivoting container-like means that is up above such ascending canister-like object;
at the moment the bottom surface of this ascending canister-like object passes above the topmost point of the direction-altering means that was just used to alter the direction of motion of the canister-like object, causing the two direction-altering means to switch places, so that the bottom portion of the direction-altering means that had just been used to alter the direction of the ascending canister-like object, is pulled far enough away from the exit area of the fluid column-like pathway section to allow the other direction-altering means to be re-positioned in such a way that the bottom portion of this other direction-altering means is directly over the exit area of the fluid column-like pathway section;
regarding the ascending canister-like object whose direction of motion has just been perfectly aligned in a vertical direction, allowing such canister-like object to continue ascending, so that the entire body of such canister-like object moves completely above and beyond the topmost point of the enlarged uppermost section of the fluid column-like pathway section, and then to allow such canister-like object to keep ascending towards the respective pivoting container-like means that is used for depositing a canister-like object onto a moveable extension of the inclined platform-like structure;
at a vertical point when the canister-like object has ascended further, but where the leading surface of this ascending canister-like object is still below the bottommost point of the respective pivoting container-like means, monitoring the speed of such ascending canister-like object, and also
immediately analyzing the results of such speed-related data;
immediately after analysis of the speed-related data for the canister-like object is performed, manipulating the speed of such canister-like object to ensure the canister-like object has enough upward speed so that the leading surface of such canister-like object will reach a maximum vertical ascension point that is at least as high as an upper capture-related means that is a part of such pivoting container-like means;
after the leading surface of the ascending canister-like object has passed higher than the top point of the means that has adjusted the upward speed of such canister-like object, allowing this canister-like object to continue ascending even higher, and when the vertical position of the leading surface of such ascending canister-like object is at or near the maximum vertical ascension point the canister-like object can possibly ascend to, using a pre-positioned pivoting container-like means to stop the canister-like object from ascending further, and whereby such pivoting container-like means includes all the peripheral equipment attached to or located inside of such pivoting container-like means, and
whereby this pivoting container-like means has the ability to catch an ascending canister-like object completely inside of this pivoting container-like means, so that such canister-like object cannot go higher than the topmost point of the canister-like object and also so such canister-like object cannot fall back down out of the bottom of this pivoting container-like means, and more specifically,
to catch such canister-like object inside this pivoting container-like means by having an upper capture-related means and a lower capture-related means mounted on or inside this pivoting container-like means and whereby both such upper and lower means have shock absorber-like components, and
such shock absorber-like components allow the impact of the top surface or bottom surface of a captured canister-like object, respectively, to be minimized when such top surface or bottom surface makes respective contact with the upper capture-related and lower capture-related means being used to catch the canister-like object inside this pivoting container-like means, and also
as the canister-like object is initially ascending up into such pivoting container-like means, to have previously extended out into the path the canister-like object is heading along, the upper capture-related means, and also
to have previously retracted out of the path the canister-like object is heading along when such canister-like object is first trying to enter this pivoting container-like means, the lower capture-related means;
using a pressure measurement means connected to some part of the upper capture-related means, and
whereupon contact is made between the leading surface of an ascending canister-like object and the pressure measurement means connected to the upper capture-related means, to send a signal from this pressure measurement means to the lower capture-related means, and upon receipt of such signal by the lower capture-related means, to cause such lower capture-related means to fully extend out into the path of motion the bottom surface of the captured canister-like object will want to use when this canister-like object tries to fall out the bottom of the pivoting container-like means, and
whereby such action blocks the canister-like object from falling back out of the bottom of the pivoting container-like means;
upon such lower capture-related means being re-positioned into the extended mode, to cause a signal to be sent to a means used to rotate the entire pivoting container-like means, and
upon receipt of such signal from the lower capture-related means by such rotational means, to cause the pivoting container-like means to be rotated to an angled position such that the angle of slope of the body of the canister-like object after rotation, which will also be the angle of slope of the pivoting container-like means, equals or closely equals the angle of slope of the inclined platform-like structure;
with the canister-like object still being held inside the pivoting container-like means, to continue rotating the pivoting container-like means towards the inclined platform-like structure so that what was the top of the pivoting container-like means begins to point towards the inclined platform-like structure;
but prior to any pivoting container-like means being rotated, to have previously positioned an inclined platform sliding canister holder section, to provide a way for a canister-like object to move out of a pivoting container-like means and into the topmost vacant canister cue position on the inclined platform-like structure, and whereby as part of this process to move a canister-like object from a pivoting container-like means onto the inclined platform-like structure, such inclined platform sliding canister holder section has been previously positioned to be directly in front of the specific area where the pivoting container-like means being rotated will be depositing the next canister-like object, at a time when such canister-like object moves out of the respective pivoting container-like means and onto this previously positioned inclined platform sliding canister holder section;
allowing electronic communication between the means that is rotating the pivoting container-like means, and:
a) the means that will be creating a repelling electromagnetic field behind the magnet that is attached to or located inside the canister-like object, and whereby behind refers to such electromagnetic field being positioned on the side of the magnet away from the inclined platform-like structure, and
b) the means that is located on the inclined platform sliding canister holder section and that increases the speed of a canister-like object exiting the pivoting container-like means by creating an electromagnetic field that will attract the magnet attached to or located inside the canister-like object, and
c) the upper capture-related means for the pivoting container-like means;
whereupon the angle of rotation for the pivoting container-like means is almost at the angle of rotation required for the respective canister-like object to exit such pivoting container-like means, then: a) both of these respective electromagnetic-related means will receive the appropriate signals to cause these two respective electromagnetic fields to be created and temporarily maintained, and also
b) the upper capture-related means will receive the respective signal causing this upper capture-related means to be re-positioned into a retracted mode, and while in such retracted mode, the mouth of the pivoting container-like means will be totally open and unrestricted, with regards to the path the canister-like object needs to move along in order to exit the pivoting container-like means;
to continue rotating the pivoting container-like means until the angle of slope of the pivoting container-like means is approximately equal to the angle of slope of the inclined platform-like structure;
as a result of such pivoting container-like means slanting downward, and as a result of the combined forces of gravity, and one electromagnetic force pushing the magnet of the canister-like object in a direction towards the inclined platform-like structure, and the other electromagnetic force pulling the magnet of the canister-like object in a direction towards the inclined platform-like structure, allowing the downwardly moving canister-like object to exit out of the pivoting container-like means and to move onto the inclined platform sliding canister holder section;
using a motion sensor-like means to detect exactly when the leading surface of the canister-like object that has just landed onto the inclined platform sliding canister holder section has moved in front of such motion sensor-like means, and
whereupon such motion sensor-like means detects the leading surface of the downwardly moving canister-like object, to have such motion sensor-like means send out a signal to the electromagnetic-related means that has the ability to alter the speed of a canister-like object, and
whereby such electromagnetic-related means is located on the inclined platform sliding canister holder section, and
whereupon such the related signal is received by this respective electromagnetic-related means, causing the polarity of the electromagnetic field of this means to be reversed so that a repelling effect will be felt by the magnet attached to or located inside the canister-like object, and because such electromagnetic field is positioned below and in front of the respective magnet, the effect of this electromagnetic field will be to repel the magnet, and therefore the downward momentum of the related canister-like object will be reduced, and an overall process to slow down the downward movement of the canister-like object will begin;
slowing the downward movement of the canister-like object, in speed-adjusted increments, while such canister-like object is still on the inclined platform sliding canister holder section, by using one or more means to accomplish this result, and to incorporate a spring-like action into such overall slowing process so that immediately after the canister-like object reaches the furthest point the canister-like object can move, going downward, because of the contact made between the leading surface of the canister-like object and the means being used to slow the canister-like object down, the direction of motion of the canister-like object is reversed as the spring-like components decompress, and the canister-like object is pushed in an upward direction;
the first contact between the leading surface of the related canister-like object and the means containing the spring-like components is also important beyond just the adjustment process to the speed of the related canister-like object motion, because for such first contact to have been made also means that the entire body of the canister-like object is completely situated on the inclined platform sliding canister holder section, and this fact then allows for multiple resetting processes to occur, and therefore
whereupon the first contact between the leading surface of the related canister-like object and the means containing the spring-like components occurs, to have the spring-related means send out four independent signals: one signal to the rotation-like means connected to the container-like component, one signal to the upper capture-related means and one signal to the lower capture-related means that are peripheral equipment of the respective pivoting container-like means, and one signal to a horizontal positioning means that moves the entire inclined platform sliding canister holder section, and
upon receipt of the respective signal by the rotational means connected to the container-like component, to re-rotate the pivoting container-like means so that such pivoting container-like means returns to the vertically upright position, and
upon receipt of the respective signals by the upper and lower capture-related means, to cause such two means to respectively reset, so that the upper capture-related means is re-positioned to the fully extended mode and the lower capture-related means is re-positioned to the fully retracted mode, and
upon receipt of the respective signal by the horizontal positioning means that moves the entire inclined platform sliding canister holder section, moving the inclined platform sliding canister holder section so that the lower portion of this inclined platform sliding canister holder section comes into perfect alignment with the top canister cue position on the inclined platform-like structure;
continuing to slow down the downward movement of the related canister-like object by using the same electromagnetic-related means that was previously used to modify the downward speed of the related canister-like object, and specifically,
causing such electromagnetic-related speed-adjusting means to create an electromagnetic field which results in repelling the magnet attached to or located inside the canister-like object, and therefore this electromagnetic field pushes the magnet and canister-like object back down towards the spring-like components;
continuing to use this incremental bounce-and-repel process until the downward speed of the canister-like object is at a point where the canister-like object is ready to just slide down the remainder of the inclined platform sliding canister holder section with little or no downward momentum, and will only be moving downward according to the force of gravity;
during the time duration of the final upward bounce off of the spring-like components, which is a time during which the canister-like object is repelled up and away from the spring-like components for the last time, causing the spring-like components and certain peripheral equipment attached to such spring-like components to be pulled down into the lower portion of the inclined platform sliding canister holder section, and
to pull such equipment down so far that all such equipment is out of the pathway upon which the canister-like object will be moving, as such canister-like object moves further downward towards the inclined platform-like structure;
monitoring when the bottom surface of the canister-like object has moved off of the inclined platform sliding canister holder section, and upon such event occurring, having the motion sensor-like device that has just detected the bottom surface of the canister-like object, send two signals, one signal to the one or more means used to push up and pull down the spring-like components, and one signal to the means that moves the entire inclined platform sliding canister holder section;
upon receipt of the respective signal, sent from the motion sensor-like device, by the one or more means used to push up and pull down the spring-like components, causing the spring-like components and certain peripheral equipment attached to such spring-like components to be pushed back up to the vertical point such equipment was at before that equipment was pulled down out of the pathway the canister-like object needed to travel along;
upon receipt of the respective signal, sent from the motion sensor-like device, by the means that moves the entire inclined platform sliding canister holder section, re-positioning the inclined platform sliding canister holder section to a location where such inclined platform sliding canister holder section is directly in front of where the other pivoting container-like means will be rotated to, and to have such re-positioning process be completed before the next canister-like object begins exiting this other pivoting container-like means;
after the bottom surface of the downwardly-moving canister-like object has moved completely off of the inclined platform sliding canister holder section, allowing this canister-like object to continue moving down a little more so that this canister-like object comes to a complete stop in the top canister cue position on the inclined platform-like structure, when an interlocking connection is made between the protrusion that is sticking out of the leading surface of this canister-like object meshes into the mirror-image, concaved cut-out shape in the bottom surface and lower portion of canister-like object that was the topmost canister-like object on the inclined platform-like structure, prior to this downwardly-moving canister-like object arriving on the inclined platform-like structure.

7. The method of generating electricity according to claim 2, where said method comprises:
for the pathway section where the direction of motion for a canister-like object is changed from a horizontal or semi-horizontal direction of motion to a vertical or semi-vertical upward direction of motion, using two almost identical but totally independent direction-altering means to change the direction of motion of canister-like objects from a horizontal or semi-horizontal direction to a vertical or semi-vertical direction of motion, and
whereby these two almost identical direction-altering means are located in a horizontal line with each other, one behind another with respect to the path of travel a canister-like object moves along as a canister-like object is approaching these two such almost identical direction-altering means, and also
whereby these two almost identical direction-altering means are used on an alternating basis, such that the first direction-altering means changes the direction of motion for one canister-like object, and causes this respective canister-like object to ascend up to a pathway section directly above such first direction-altering means, and
then the other, second direction-altering means changes the direction of motion for the next canister-like object and causes this next canister-like object to ascend up to a pathway section directly above this other, second direction-altering means, and also
having constructed the first direction-altering means so that there is a pullout section of passive rollers in the bottom of the arc area of this first direction-altering means, and
whereby when such pullout section of passive rollers is pushed in, this first direction-altering means is in a normal mode and a canister-like object approaching such first direction-altering means simply ascends up through this first direction-altering means and keeps ascending into the next pathway section, which is located above the top of this first direction-altering means,
but when this pullout section of passive rollers is fully retracted, a canister-like object approaching such first direction-altering means passes completely through the vacant area where the retracted passive rollers were and this canister-like object keeps moving in a horizontal direction until such time the canister-like object reaches the second direction-altering means, and then this canister-like object ascends up through this second direction-altering means and keeps ascending into the next pathway section, which is located above the top of this second direction-altering means, and more specifically,
as a canister-like object is heading in a horizontal or semi-horizontal direction and is approaching the first direction-altering means, and under the condition where the pullout section of passive rollers is not retracted and therefore all such rollers in this pullout section are in their normal position, the leading surface of this moving canister-like object continues moving into the arc portion of this first direction-altering means and as this occurs, the direction of motion of such moving canister-like object is changed from a horizontal or semi-horizontal direction of motion to a vertical or semi-vertical direction of motion;
near the point when the leading surface of this canister-like object is reaching the top of the arc-shaped portion of this first direction-altering means, detecting the leading surface of this canister-like object, and also monitoring the speed at which such canister-like object passes in front of the motion sensor-like means that has just detected such leading surface of the canister-like object, and
having the motion sensor-like means immediately analyze the results of such acquired motion-related data;
whereupon this motion-related data has been analyzed, causing a signal to be sent from the related motion sensor-like means to each repelling electromagnet in a set of such electromagnets, and
whereby such repelling electromagnets are located at different vertical points in the vertical portion of this first direction-altering means, and
to time the sequence of generation for each of the individual electromagnetic fields being created, by each of the individual repelling electromagnets, so that the net repelling effect felt by the ascending canister-like object, as a result of the magnet attached to or located inside such canister-like object being systematically repelled away from these individual repelling electromagnets, that are stacked one above another, is such that the direction of motion of the ascending canister-like object is altered in a way that counteracts any inherent tendencies this canister-like object may have to head in a direction that is not straight up, vertically;
as the bottom surface of such ascending canister-like object passes in front of this same motion sensor-like means, detecting the bottom surface of such canister-like object, and
whereupon such bottom surface of the canister-like object is detected by the motion sensor-like means, causing a signal to be sent to the means that retracts and extends the pullout section of passive rollers;
whereupon such means that retracts and extends the pullout section of passive rollers receives this specific signal from the motion sensor-like means mounted in this first direction-altering means, causing the pullout section of passive rollers to be retracted out of and away from this first direction-altering means, thereby creating an access passageway for the next canister-like object, and whereby the result of such access passageway will be that the next canister-like object approaching this first direction-altering means will pass through such first direction-altering means and will continue moving horizontally until such next canister-like object comes in contact with the second direction-altering means;
with regards to the canister-like object that has ascended up towards the top of this first direction-altering means, aligning the horizontal position of this canister-like object by having pre-positioned a direction alignment means in a horizontal manner, and
whereby such direction alignment means is located just above the top of this first direction-altering means;
after the canister-like object passes through the direction alignment means, but before the canister-like object completely ascends out of this overall first direction-altering means, monitoring the upward speed of the upwardly-moving canister-like object, and also
immediately after such speed has been monitored, analyzing the speed-related data obtained from such monitoring process;
adjusting the upward speed of this upwardly moving canister-like object, to either increase that speed, so that the upward force creating such speed for such canister-like object will be enough to propel this canister-like object up to the maximum height of ascension needed, so that the bottom surface of an ascending canister-like object will be higher than the topmost point of any equipment attached to the respective platform-like support component that is located in the next pathway section, and
whereby such next pathway section is located above this first direction-altering means, or
if necessary, to decrease the upward speed of this upwardly moving canister-like object, if it has been determined according to the analysis of the speed-related data that the canister-like object is moving so fast that the canister-like object will ascend too far and too fast into the next pathway section and will therefore cause damage to one or more components in the next pathway section;
allowing the canister-like object to seamlessly ascend up into the next pathway section, and whereby this next pathway section is in an overall net-catcher area, and whereby such net-catcher area has two individual vertical pathways, with one such vertical pathway located directly above the direction alignment means that is positioned above the top of the first direction-altering means, and the other vertical pathway in this net-catcher area is located directly above the direction alignment means that is positioned above the top of the second direction-altering means, and also
there is a common floor-like component in the net-catcher area, and whereby such common floor-like component is shared by each of these two vertical pathways, and for each of these two vertical pathways there is an individual hole-like means cut out of the common floor-like component, and each of these individual hole-like means is positioned so that the center of a respective hole-like means is directly over the center of the respective direction alignment means located above the top of the respective direction-altering means;
as the leading surface of the canister-like object this is ascending from the first direction-altering means moves above the respective hole-like means in the lower portion of the overall net-catcher area, detecting and analyzing the speed at which the canister-like object is ascending;
whereupon this speed-related data for the canister-like object has been analyzed, causing this motion sensor-like means that has just analyzed this speed-related data to send out two different types of signals, one set of signals being sent to a group of electromagnet retaining means located in the upper areas of this first pathway in the net-catcher area, around where the net component is located for this respective pathway, and
whereby this set of electromagnet retaining means is used to alter the speed of ascent and speed of descent of a canister-like object in the upper area of this vertical pathway, and
the second signal is sent from the respective motion sensor-like means to a means for rotating the respective platform-like support component, and
whereby such platform-like support component will be used to catch the respective canister-like object after this canister-like object has ascended up into the net component and has fallen back down an unspecified distance, and also
the horizontal location of this platform-like support component will have been pre-configured so that this platform-like support component will be positioned far over to the side of the overall net-catcher area and thus this platform-like support component will not be obstructing the path an ascending canister-like object needs to take to ascend up into the net component, and whereby such net component is located at the very top of this first vertical pathway in the net-catcher area, and also
where both types of signals sent by the respective motion sensor-like means also include a time delay factor, according to the results of the speed-related data, so that no actions are initiated the instant the signals are received by any of the components receiving such signals;
allowing the leading surface of the respective canister-like object to ascend up to the respective net component and to make contact with such net component;
according to the determined time delay, on or around the time the leading surface of the canister-like object is approaching the net component, to cause the group of electromagnet retaining means to create their individual electromagnetic fields, and the combined effect of these electromagnetic fields is to suspend the canister-like object at a vertical height as close to the net component as possible, or to at least slow down the rate of descent of the canister-like object, and to perform this action for the sake of giving the platform-like support component enough time to be rotated into position below the bottom surface of the canister-like object;
according to the outcome of the analysis of the speed-related data analyzed by the motion sensor-like means, causing the means that rotates the respective platform-like support component to wait the proper amount of time so that the bottom surface of the canister-like object is higher than any parts of the respective platform-like support component, and once this waiting period is over, immediately rotating this respective platform-like support component into a position so that the relative center of this platform-like support component is directly below, or almost directly below, the center of the bottom surface of the suspended, or slowly downward moving, canister-like object;
electronic communication between the respective rotational means, in each vertical pathway for the respective platform-like support component and the means, for that respective vertical pathway, that is temporarily suspending or slowing down the motion of descent of a respective canister-like object;
after such respective platform-like support component has been rotated to the proper position, signals are sent by the means that rotated this respective platform-like support component, and whereby such signals are sent to each of the electromagnet retaining means, and upon receipt, by the individual electromagnet retaining means, of these individual but simultaneously sent signals, causing each of the electromagnet fields, in unison, to be terminated in such a way that these electromagnetic fields are faded out, and
as a result of this composite fading electromagnetic field, the descent of the canister-like object is partially controlled so that the adjusted rate of descent for the suspended canister-like object causes the canister-like object to fall back down onto the platform-like support component in a reasonably short period of time, but not to descend so fast as to crash down upon this platform-like support component;
waiting a pre-calculated amount of time after the termination of the electromagnetic fields, and
whereby this amount of waiting time is enough time to allow the bottom surface of the canister-like object to fall down onto the platform-like support component;
prior to the platform-like support component being rotated to the point where such platform-like support component will stop moving for a second time, to have already properly positioned a coupled canister platform-like component, which is totally different and separate from the two platform-like support components used in the two respective vertical pathways, so that the floor-like area of this coupled canister platform-like component is at the same vertical height as the floor-like area of the platform-like support component;
after waiting that pre-determined amount of time, beginning to rotate the platform-like support component, upon which the canister-like object is sitting, towards the coupled canister platform-like component;
as the platform-like support component is being rotated towards the coupled canister platform-like component, stabilizing the upper portion of the canister-like object, and
whereby such means of stabilization of the upper portion of the canister-like object is synchronized to move in unison with the rotating platform-like support component that is moving the lower portion of the canister-like object,
except that the means of stabilizing the upper portion of the canister-like object is moving in a straight or almost straight line, horizontally;
to continue rotating the platform-like support component until such time that one edge of this platform-like support component comes in contact with an edge of the coupled canister platform-like component, and also
during all of the time this platform-like support component was being rotated, to have continued stabilizing the upper portion of the canister-like object;
whereupon the platform-like support component stops rotating, the components that previously had been stabilizing the upper portion of the canister-like object continue moving in the same direction, and thereby keep pushing the canister-like object over more until a pre-determined horizontal position is reached, and
whereby such pre-determined horizontal position will be a horizontal point where the canister-like object is properly positioned on the coupled canister platform-like component;
on or around the same time the platform-like support component stops rotating, in the general area where the first and second sets of direction-altering means are located, because the pullout section of passive rollers is in the retracted mode, the next canister-like object has moved, horizontally, beyond the first direction-altering means and has entered the second direction-altering means;
as this next canister-like object continues moving further into this second direction-altering means, the direction of motion of this next canister-like object begins changing from a horizontal or semi-horizontal direction of motion to a vertical or semi-vertical direction of motion;
as the leading surface of this next canister-like object passes in front of a motion sensor-like means, and whereby such motion sensor-like means is mounted near the top of the arc of this second direction-altering means, detecting the leading surface of this next canister-like object, and
whereupon such leading surface of this next canister-like object is detected by this motion sensor-like means mounted on this second direction-altering means, causing a signal to be sent to each of the repelling electromagnets, and whereby such repelling electromagnets are located at different vertical points in the vertical portion of this second direction-altering means, and
to time the sequence of generation for each of the individual electromagnetic fields being created, by each of the individual repelling electromagnets, so that the net repelling effect felt by this next ascending canister-like object, as a result of the magnet attached to or located inside such canister-like object being systematically repelled away from these individual repelling electromagnets, that are stacked one above another, is such that the direction of motion of this next ascending canister-like object is altered in a way that counteracts any inherent tendencies this canister-like object may have to head in a direction that is not straight up, vertically;
as the bottom surface of such next ascending canister-like object passes in front of this same motion sensor-like means this is mounted on this second direction-altering means, detecting the bottom surface of such next canister-like object, and
whereupon such bottom surface of this canister-like object is detected by the respective motion sensor-like means, causing a signal to be sent to the means that retracts and extends the pullout section of passive rollers;
whereupon such means that retracts and extends the pullout section of passive rollers receives this specific signal from this motion sensor-like means that is mounted in the second direction-altering means, causing the pullout section of passive rollers to be extended forward to the point that all of the passive rollers attached to such pullout section of passive rollers are firmly re-positioned back into the first direction-altering means, thereby creating a condition where the next canister-like object that approaches this first direction-altering means will ascend up into this first direction-altering means in normal fashion, because all of the passive rollers in this first direction-altering means are positioned in their normal location;
with regards to this next canister-like object that has ascended up towards the top of the second direction-altering means, aligning the horizontal position of this canister-like object by having pre-positioned a direction alignment means in a horizontal manner, and
whereby such direction alignment means is located just above the top of this second direction-altering means;
after this next canister-like object passes through the direction alignment means, but before this next canister-like object completely ascends out of the overall second direction-altering means, monitoring the upward speed of this upwardly-moving next canister-like object, and also
immediately after such speed has been monitored, analyzing the speed-related data obtained from such monitoring process;
adjusting the upward speed of this upwardly moving next canister-like object, to either increase that speed, so that the upward force creating such speed for such next canister-like object will be enough to propel this next canister-like object up to the maximum height of ascension needed, so that the bottom surface of this next ascending canister-like object will be higher than the topmost point of any equipment attached to the respective platform-like support component that is located in the next pathway section, or
if necessary to decrease the upward speed of this upwardly moving next canister-like object, if it has been determined according to the analysis of the speed-related data that this next canister-like object is moving so fast that this next canister-like object will ascend too far and too fast into the next pathway section and will therefore cause damage to one or more components in the next pathway section;
allowing this next canister-like object to seamlessly ascend up into the next pathway section, and whereby this seamless ascension into such next pathway section begins by this next canister-like object passing through a respective individual hole-like means cut out of the common floor-like component that is shared by both vertical pathways located in the net-catcher area;
as this next canister-like object has been ascending along and through the second direction-altering means, in the net-catcher area the canister-like object that was sitting on the respective platform-like support component has been completely transferred from the platform-like support component onto the pre-launch platform;
whereupon this transfer of the canister-like object is completed, the stabilizing-related components that have been pushing the canister-like object over onto this coupled canister platform-like component perform various functions, which include:
a) resetting one of the means that has been stabilizing the upper portion of the canister-like object, and whereby such means is the stabilizing component that has been making contact with the canister-like object on the outer side of the canister-like object, away from the center of the net-catcher area, and to reset such stabilizing component by moving this stabilizing component all the way towards the edge of the net-catcher area, which is the position where such component was at when the respective canister-like object originally entered the net-catcher area, and
b) moving the other stabilizing component slightly away from the surface-edge of the canister-like object that is sitting on the coupled canister platform-like component, by moving such stabilizing component a small distance towards the other vertical pathway, and
c) sending a signal to the rotational means that rotates the platform-like support component, and upon receipt of such signal by such rotational means, resetting the platform-like support component by rotating this platform-like support component to a point over towards the far edge of the overall net-catcher area, so that this platform-like support component will be completely out beyond the path a canister-like object takes when a canister-like object ascends above the first direction-altering means and begins entering the net-catcher area;
once all of these relative components that have been moving horizontally away from the surface-edges of the canister-like object are even just a minor distance away from the canister-like object, elevating the coupled canister platform-like component so that the canister-like object that is sitting on this coupled canister platform-like component also begins a controlled ascension process;
electronic communication, going in both directions, between the vertical positioning means that moves the coupled canister platform-like component up and down along a vertical axis, and:
a) the firsts canister suspension means, and
b) the canister notch-related suspension means;
to continue elevating such coupled canister platform-like component until such time that a vertical coupling event occurs, which happens when the leading surface of the canister-like object being elevated makes initial contact with the bottom surface of the upper canister-like object that is being suspended above such ascending canister-like object, and
whereupon such initial contact between the two canister-like objects is made, having the vertical positioning means that is elevating the coupled canister platform-like component send two sets of signals, which are:
a) signals sent to the first canister suspension means, which immediately causes this suspension means to enter the retracted mode and to retract certain peripheral components of such suspension means out from underneath the bottom surface of the suspended canister-like object, and
b) signals sent to the canister notch-related suspension means, which immediately causes this suspension means to enter the retracted mode and to retract certain peripheral components out of and away from the notch of the suspended canister-like object;
whereupon each of these four such suspension means have completely entered the retracted mode and therefore all such suspension-related components are clear of the respective canister-like object, each such suspension means sends a signal to the vertical positioning means that moves the coupled canister platform-like component of the overall lower canister platform-like support means up and down along a vertical axis, and
upon receipt of all four such signals, elevating the coupled canister platform-like component until the lower canister-like object, the canister-like object that is sitting on this coupled canister platform-like component, is at the same vertical height the previously suspended canister-like object was at before the suspension process was terminated, and then stopping the elevation process at that exact point;
whereupon the elevation process is stopped, which is a point where there is light contact between the leading surface of the ascending canister-like object and the bottom surface of the suspended canister-like object, the respective vertical positioning means that has been elevating the coupled canister platform-like component sends two sets of signals, which are:
a) signals sent to the first canister suspension means, which immediately causes this suspension means to enter the extended mode and to extend certain peripheral components of such suspension means in underneath the bottom surface of the suspended canister-like object, and
b) signals sent to the canister notch-related suspension means, which immediately causes this suspension means to become fully extended out to the point where such components are applying light horizontal pressure to the notch of the respective canister-like object, and the result of this light horizontal pressure is to keep the respective canister-like object in perfect alignment, horizontally, and to perform this task by using this canister notch-related suspension means, so that the no-leak seal-like component does not have to perform such horizontal alignment task on this canister-like object;
whereupon each of these four such suspension means have completely entered the extended mode, each such suspension means sends a signal to the respective vertical positioning means that moves the coupled canister platform-like component of the overall lower canister platform-like support means up and down along a vertical axis, and
upon receipt of all four such signals by this respective vertical positioning means, this vertical positioning means resets itself, and this resetting process involves causing this vertical positioning means to move downward to the lowest vertical position available, which is the default vertical position and which is a vertical position whereby the coupled canister platform-like component is at the same vertical position as when the canister-like object was transferred from the platform-like support component onto this coupled canister platform-like component, and
this vertical position is also the required vertical position so that the same exact kind of transfer can be made by the other platform-like support component in the other pathway, but where this next canister-like object being transferred will be pushed onto this coupled canister platform-like component from the opposite side of this coupled canister platform-like component.

8. A method of generating electricity, said method comprising:
allowing multiple canister-like objects to move along a series of open, non-enclosed pathway sections, and whereby each pathway section leads into the next pathway section;
using a set of twenty or more buoyant canister-like objects to cause electricity to be generated at certain points along these open, non-enclosed pathway sections, and whereby the buoyant property of each canister-like object is relative to the specific gravity of the water-like non-air fluid that is held in a fluid column-like pathway section;
positioning two or more inductors along certain areas of these open, non-enclosed pathway sections, and
allowing electricity to be generated each time the magnet attached to or located inside a canister-like object passes in proximity to an inductor;
having one of the pathway sections in the overall device be a fluid column-like pathway section which: a) is open on both ends, b) is partially filled with a water-like non-air fluid, c) is positioned in a vertically-oriented manner so that one of the open ends is approximately directly above the other open end, d) has a no-leak seal-like component fixed in and around the open end that is at a lower vertical point than the other higher open end, and whereby the exact shape of the inner area of such no-leak seal-like component is constructed so that this shape matches, as closely as possible, the shape of the outer surface of the main portion of the body of each canister-like object, and e) where none, or very little, of the water-like non-air fluid ever leaks out through the lower open end of this fluid column-like pathway section because the main portion of the body of a canister-like object is always inside of, and making tight enough contact with such no-leak seal-like component, to prevent any such leakage of water-like non-air fluid from ever occurring;
at all times to have the main portion of the body of a canister-like object positioned in a vertical or almost vertical direction, and also to be positioned inside of, and making tight contact with the no-leak seal-like component that is fixed in and around the lowest open end of the fluid column-like pathway section, and
causing a lower canister-like object to elevate an upper canister-like object, in a process that: a) pushes the upper canister-like object to a vertical point so that the bottom surface of the upper canister-like object is elevated higher than the topmost point of the no-leak seal-like component, b) to stop elevating the two canister-like objects at the precise vertical point where the lower canister-like object has reached the same vertical elevation that the upper canister-like object was at when such upper canister-like object was being suspended prior to contact being made between the two canister-like objects, and c) to have the bodies of the canister-like objects constructed in such a way that as a lower canister-like object moves into the same vertical position the respective upper canister-like object was at before such elevation process started, which also includes pushing such respective upper canister-like object through and past the no-leak seal-like component, none, or very little, of the water-like non-air fluid being held in the fluid column-like pathway section leaks out;
beginning each new repetitive cycle of movement for a respective canister-like object by allowing such canister-like object to move downward from a vertical point where the downward motion of this canister-like object had previously been stopped, and as a result of the force of gravity, allowing such canister-like object to drop off of the bottommost edge of an inclined platform-like structure and to continue falling downward in a freefall state, but
even before the initial start-up of the device, to pre-configure the arrangement of the canister-like objects so that in another pathway section, basically on the other side of the device from where a canister-like object drops off of the inclined platform-like structure and begins a new repetitive cycle, two canister-like objects are vertically coupled together, with an upper canister-like object positioned directly on top of, and making contact with, a lower canister-like object, and
whereby the vertical position of the upper canister-like object is such that: a) some portion of the body of this upper canister-like object is making contact with a no-leak seal-like component, b) some upper portion of this canister-like object's body is making contact with the water-like non-air fluid that is being held in the fluid column-like pathway section, and c) the lower portion of the body of this upper canister-like object is exposed to the air, and
whereby the bottom surface of the lower canister-like object is sitting on a coupled canister platform-like component, and
this coupled canister platform-like component has the ability to move up and down, along a vertical axis;
for the first repetitive cycle when the device is first put into operation, and for all other repetitive cycles after that, on or around the same time a respective canister-like object begins a new repetitive cycle by dropping off of the bottommost edge of an inclined platform-like structure and entering a freefall state heading downward, in a completely different pathway section on the other side of the overall device, causing the coupled canister platform-like component, with two canister-like objects stacked on top of each other and with the bottom surface of the lower canister-like object sitting on, and making contact with, such coupled canister platform-like component, to be elevated to a precise vertical height, which is a height whereby the bottom surface of the upper canister-like object is elevated completely above the topmost point of the no-leak seal-like component, and therefore the body of this upper canister-like object becomes completely surrounded by the water-like non-air fluid that is being held in the fluid column-like pathway section, and therefore as a result of the buoyancy such upper canister-like object has, the upper canister-like object begins floating upwards, and also
when such elevation process stops, the vertical position of the lower canister-like object is exactly the same vertical position the upper canister-like object was at before such elevation process started;
as a canister-like object finishes falling through the entire length of the pathway section where such canister-like object was in a freefall state, forcing the canister-like object to move along a downwardly pointing gently-curved non-enclosed pathway section, and
whereby while in such gently-curved non-enclosed pathway section, a canister-like object is situated inside a pathway configuration that is created from using the inner edges of three or more guide rails, and whereby such guide rails are the primary components of such gently-curved non-enclosed pathway section, and
whereby the minimum inner distance of such pathway configuration, between the inner edges of all the guide rails, is greater than the maximum width or maximum diameter of a canister-like object, and
whereby these guide rails of this gently-curved non-enclosed pathway section are surrounded, except for any mounting components or any other canister-like object direction guidance means, completely by air or by an air-like fluid;
using a pathway section as a holding cue for a group of canister-like objects, and
whereby such pathway section has wall-like surfaces, going in the longest direction, but is totally open on one end, and
is also open on the other end, except that this other end has the ability to be sealed-off by an air-lock-type component, and
whereby the majority of such holding cue pathway section is filled with a water-like, non-air fluid;
allowing a canister-like object to move from the holding cue pathway section, which is at low pressure, to a fluid reservoir-like structure, which is at high pressure, using a variable pressure chamber, and
whereby such variable pressure chamber has two identical waterproof sliding panels, one identical waterproof sliding panel on each side, and
whereby the entrance out of the variable pressure chamber into such fluid reservoir-like structure is near the bottom of such fluid reservoir-like structure;
detecting the presence of a canister-like object at the instant when the leading surface of such canister-like object moves in front of a motion sensor-like means, and
whereby this motion sensor-like means has the ability to send a signal to a stop-mechanism-like means, on or around the time the detection of the leading surface of a canister-like object has occurred, and
whereby this motion sensor-like means is located near the bottom of the gently-curved non-enclosed pathway section;
allowing a stop-mechanism-like means to receive a signal from the motion sensor-like means which is mounted near the bottom of the gently-curved non-enclosed pathway section, and
upon receipt of such signal from this motion sensor-like means, causing certain parts of the stop-mechanism-like component to be retracted, and
whereby these certain parts are retracted far enough so that these certain parts are completely out of the pathway a canister-like object travels along while such canister-like object is moving in that part of the holding cue pathway section that is in proximity to this stop-mechanism-like means;
detecting the presence of the bottom surface of a canister-like object at the time when such bottom surface of a canister-like object moves in front of a motion sensor-like means, and also
whereby this motion sensor-like means has the ability to send a signal to the stop-mechanism-like means, and
whereby such signal is sent on or around the time when the bottom surface of a canister-like object has passed in front of such motion sensor-like means, and also
whereby such motion sensor-like means is mounted a considerable distance below the fluidline of the water-like non-are fluid in the holding cue pathway section, but this motion sensor-like means is also a reasonable distance away from and above the closest bottom surface of any canister-like object in the holding cue pathway section, and also
whereby this motion sensor-like means and the stop-mechanism-like means are mounted so that both pieces of equipment are located in the same area, relative to the location and manner in which the canister-like objects are passing in front of these pieces of equipment;
allowing a canister-like object to move from the bottommost point of the gently-curved non-enclosed pathway section into the holding cue pathway section, and
then allowing that canister-like object to continue moving past the stop-mechanism-like means and
whereby according to the forward momentum any such canister-like object has at that point, allowing the leading surface of such canister-like object to continue moving a total distance that is greater than the length of one canister-like object past the stop-mechanism-like means, and
more specifically, allowing such moving canister-like object to continue moving in that same direction inside the holding cue pathway section until such canister-like object exhausts all of its kinetic energy by pushing the entire group of canister-like objects some unspecified distance, and to push such group of canister-like objects in the direction the canister-like object is heading when such canister-like object passes in proximity to the stop-mechanism-like means;
blocking a canister-like object that has just pushed the group of canister-like objects some unspecified distance, so that the bottom surface of such canister-like object cannot float up past certain parts of the stop-mechanism-like means, at a point in time when such canister-like object begins heading in the other direction and is trying to float up to the fluidline, after having pushed the group of canister-like objects towards the variable pressure chamber, and
whereby prior to such canister-like object trying to float up to the fluidline, the stop-mechanism-like means will have received a signal from the motion sensor-like means that is in the same area as this stop-mechanism-like means, and
whereby such signal will have been sent and received at the time when the bottom surface of the canister-like object, that is now trying to float up to the fluidline, went past the general area where the stop-mechanism-like means is located, and whereupon this signal is received, the stop-mechanism-like means extends certain parts into the pathway a canister-like object needs to travel along while passing in proximity of the stop-mechanism-like means, in the holding cue pathway section, and as a result all canister-like objects located in the holding cue pathway section, and which are also between the stop-mechanism-like means and the variable pressure chamber, will essentially be trapped inside of the holding cue pathway section;
allowing a group of two or more canister-like objects to accumulate in the holding cue pathway section as a result of allowing the individual canister-like objects to enter the holding cue pathway section one at a time, and
whereby the canister-like objects in this group of canister-like objects will be positioned in such a way that basically both ends of each canister-like object are touching the opposite ends of two other canister-like objects, except for the two outermost canister-like objects, which have only one of their ends touching another canister-like object, and
whereby the canister-like object that is located on the outermost edge of the group of canister-like objects that is closest to the variable pressure chamber will be the next canister-like object to enter the variable pressure chamber, and accordingly
the canister-like object which is located at the other outermost edge of the group of canister-like objects will be the last canister-like object to have entered the holding cue pathway section, and after: a) this canister-like object has entered the holding cue pathway section, b) the leading surface of such canister-like object has made contact with the bottom surface of the next adjacent canister-like object in the group of canister-like objects, c) all canister-like object were pushed over some unspecified distance, and d) this most outer canister-like object attempted to float back up to the fluidline, then at that point the bottom surface of that last canister-like object will begin making continuous contact with those parts of the stop-mechanism-like means that were re-positioned to be blocking the pathway the canister-like objects move along when trying to exit, or float back out of the holding cue pathway section, and also
the bottom surface of such canister-like object will keep making continuous contact with these respective parts of the stop-mechanism-like means until just slightly prior to such time as the next canister-like object enters the holding cue pathway section, and also
the overall movement of the group of canister-like objects will be such that, one-by-one, the position of the canister-like objects will change within the group, as one canister-like object is pulled into the variable pressure chamber and on or around that same time, one canister-like object enters the holding cue pathway section from the other side of the group of canister-like objects;
at a certain point in time, relative to the requirements of the repetitive cycle, moving the canister-like object, that is in the holding cue pathway section and that is closest to the variable pressure chamber, by using one or more canister-like object pullers, and
whereby each such canister-like object puller is comprised of a head-like component that has the ability to create, maintain, and terminate an electromagnetic field, a moveable body, and
whereby the moveable body of one or more of these canister-like object pullers is attached to a moveable component that is some form of belt-driven pulley-like component, and
whereby each of these pulley-like components has the ability to move the attached canister-like object puller body;
using a magnetic-sensor means to determine exactly where the magnet is located that is attached to or located inside a canister-like object, and
whereby such canister-like object whose magnet is being detected is the canister-like object that is on the outside of the group of canister-like objects and is also the next canister-like object that will be entering the variable pressure chamber, and
prior to the time such magnetic-sensing procedure is being performed, to have pre-configured the two variable pressure chamber waterproof sliding panels so that the waterproof sliding panel on the side of the variable pressure chamber that is connected to the holding cue pathway section is open, and also
to have the other variable pressure chamber waterproof sliding panel, which will be experiencing a much higher pressure on the outer surface of this waterproof sliding panel because of the much greater weight of water-like fluid that is pressing against such outer surface of this waterproof sliding panel, be tightly closed so no extreme fluid pressure will be felt inside the variable pressure chamber, and also
to have such magnetic-sensor means send a signal to the head-like component of a canister-like object puller, and
whereby this canister-like object puller is the canister-like object puller located closest to such magnetic-sensor means, and
to allow such head-like component of the respective canister-like object puller to receive any signals sent by the magnetic-sensor means, and
whereupon such signal sent by the magnetic-sensor means is received by head-like component of the respective canister-like object puller, to cause the respective head-like component to create and maintain an electromagnetic field, and also
to have such magnetic-sensor means send one or more signals to the pulley-like component that has the ability to move the body of the canister-like object puller, and whereby this canister-like object puller is the canister-like object puller located closest to such magnetic-sensor means, and
whereupon this pulley-like component receives such one or more signals from the magnetic-sensor means, this pulley-like component that is attached to the respective canister-like object puller moves the attached canister-like object puller horizontally to a first pre-determined position that is close enough to the canister-like object so that the magnetic attraction of the electromagnetic field being generated by the head-like component of the canister-like object puller and the magnet inside the canister-like object, is strong enough to allow the canister-like object puller to pull the canister-like object horizontally, and
whereby such magnetic attraction is also stronger than any friction that exists as a result of such canister-like object, which is a canister-like object that is floating in the water-like fluid, but whereby the upper edge of the body of such floating canister-like object, going along the length of the canister-like object, is making some contact with one or more points along the lowest edge of the upper inside surface of the holding cue pathway section;
whereupon the pulley-like component that is attached to the respective canister-like object puller has moved the attached canister-like object puller horizontally to the first pre-determined position, to immediately cause the direction of horizontal motion of the canister-like object puller to be reversed, so that the pulley-like component immediately begins moving the canister-like object puller in the other direction, horizontally, and such horizontal motion continues until the canister-like object puller reaches a second pre-determined point, and
whereby such second pre-determined point for the canister-like object puller to be moved to is also a point where the entire body of the canister-like object, that has been pulled by the canister-like object puller, is completely inside the variable pressure chamber, and
whereupon the pulley-like component has moved the canister-like object puller to this second pre-determined horizontal position, causing such pulley-like component to send a signal to the means that opens and closes the waterproof sliding panel which is located on the side of the variable pressure chamber that is connected to the holding cue pathway section, and
allowing this opening and closing mechanism for the respective waterproof sliding panel to receive such signal from the pulley-like component that is attached to the respective canister-like object puller, and
upon receipt of such signal from the pulley-like component, causing such opening and closing mechanism to completely close that waterproof sliding panel that is located on the side of the variable pressure chamber that is connected to the holding cue pathway section, and
immediately after this waterproof sliding panel has been completely closed, causing the mechanism that has closed the waterproof sliding panel that is located on the side of the variable pressure chamber connected to the holding cue pathway section, to send a signal to a means that opens and closes the other waterproof sliding panel of the variable pressure chamber, which is the waterproof sliding panel that is located on the high pressure side of the variable pressure chamber, and
allowing this opening and closing mechanism connected to this waterproof sliding panel located on the high pressure side of the variable pressure chamber to receive such signal from the other opening and closing mechanism for the waterproof sliding panel that is located on the low pressure side of the variable pressure chamber, and
whereupon receipt of such signal by the opening and closing mechanism connected to the waterproof sliding panel on the high pressure side of the variable pressure chamber, causing such opening and closing mechanism connected to this waterproof sliding panel on the high pressure side of the variable pressure chamber to completely open this respective waterproof sliding panel on the high pressure side of the variable pressure chamber, and
immediately after this waterproof sliding panel on the high pressure side of the variable pressure chamber has been completely opened, causing the mechanism that has opened this respective waterproof sliding panel on the high pressure side of the variable pressure chamber to send a signal to the head-like component of the respective canister-like object puller that has just finished puling the related canister-like object, and
to allow the head-like component of the canister-like object puller to receive such signal from the mechanism that has just opened the waterproof sliding panel located on the high pressure side of the variable pressure chamber, and also
upon receipt of such signal by the head-like component of the respective canister-like object puller, to cause this head-like component to terminate the electromagnetic field that was being generated by such head-like component of the canister-like object puller;
a system that moves a canister-like object out of the variable pressure chamber on the high pressure side of such variable pressure chamber and moves such canister-like object into a fluid reservoir-like structure, and
then continues, through various means, to move or cause such canister-like object to move up to a vertical point where the same canister-like object is then ascending through air or ascending through an air-like fluid, and also
such ascending canister-like object at that point, is centered below an upper canister-like object that is being suspended, with: a) some portion of the body of this upper canister-like object making contact with a no-leak seal-like component, b) some upper portion of this canister-like object's body making contact with the water-like non-air fluid that is being held in a water-like non-air fluid column-like pathway section, and c) the lower portion of the body of this upper canister-like object exposed to the air;
after a coupling event has occurred for the ascending canister-like object, and after this same canister-like object, acting as a lower canister-like object, has elevated an upper canister-like object to a vertical point whereby the entire body of such canister-like object is surrounded by the water-like non-air fluid held in the fluid column-like pathway section, then for such upper canister-like object that has entered the floatation state while in the fluid column-like pathway section, to allow the rate of ascension up through such fluid column-like pathway section, for this completely submerged canister-like object, to be either totally unmodified and to be governed only by the inherent upward forces based on the design and construction of the canister-like object or to enhance the rate of such ascension by applying additional upward forces to the bottom surface of such canister-like object, and whereby such additional upward forces are then added to the inherent upward forces the canister-like object has as a result of the design and construction of this canister-like object;
whereupon an ascending canister-like object exits the top of the fluid column-like pathway section, to cause such canister-like object to be deposited back onto some portion of the inclined platform-like structure, and whereby this surface of such inclined platform-like structure is the same overall surface the respective canister-like object falls off of, at the lowest point of this surface, to begin a repetitive cycle.

9. A method of generating electricity, according to claim 8, such method comprising:
using an inclined platform-like structure to facilitate downward canister movement so that each canister-like object can begin its own respective repetitive cycle, and
whereby such inclined platform-like structure has multiple canister-like objects making contact with such inclined platform-like structure at any given time, and whereby all of the canister-like objects sitting on such inclined platform-like structure, as a group, are lined up one after another in a waiting cue-like configuration;
allowing one canister-like object at a time to start a new repetitive cycle by moving off of the inclined platform-like structure in a process that initially uses a means to hold in place the canister-like object whose turn it is to move off of such inclined platform-like structure and then causing such retaining means to be re-positioned in a way that allows the leading surface of the canister-like object being retained to move in an unobstructed manner towards the lowest edge of such inclined platform-like structure, and then to allow such canister-like object to drop off of this inclined platform-like structure as a result of gravity and/or other forces pulling or pushing that canister-like object off of this inclined platform-like structure;
positioning inductors at unspecified intervals along the vertical height of the pathway section a canister-like object moves along while such canister-like object is descending in a freefall state, and also
positioning inductors at unspecified intervals along the vertical height of the fluid column-like pathway section,
and whereby the shape and construction of each of these inductors is such that there is an open area in the middle of each such inductor, and this open area is large enough for a canister-like object to pass through without making contact with any part of the inductor, and also positioning each such inductor so that this open area in the middle of such inductor is exactly in the pathway a canister-like object must use while such canister-like object is either: a) descending in a freefall state along this respective pathway section, therefore causing a canister-like object to pass through the middle of each such inductor when any canister-like object is moving in proximity to any such inductor and while such canister-like object is moving downward in a freefall state, or b) ascending from the bottom portion of the fluid column-like pathway section to the top of the fluid column-like pathway section, therefore causing a canister-like object to pass through the middle of each such inductor when any canister-like object is moving in proximity to any such inductor while such canister-like object is in a floatation state and moving upward through that respective fluid column-like pathway section, and
as a result of the interaction between the magnet attached to or located inside of the respective canister-like object and each of the respective inductors that the respective canister-like object passes through, electricity is generated, separately, in each such inductor;
with regards to the initial start-up of the device, and with regards to the two canister-like objects that are vertically coupled together, with one canister-like object positioned on top of the other, and
whereby these canister-like objects are basically on the other side of the device from where a canister-like object drops off of the inclined platform-like structure and begins a new repetitive cycle, on or around the time a canister-like object is released to drop off of the inclined platform-like structure to begin the very first cycle of the device, the method of suspending the upper canister-like object, that is sitting on top of the lower canister-like object, is terminated;
at a specified point in time after the method of suspending an upper canister-like object that is directly above, and is making contact with a lower canister-like object, is terminated, elevating the lower canister-like object to the point where this lower canister-like object moves into the same vertical position the upper canister-like object was at before the method of suspending such upper canister-like object was terminated, and since this process of elevating the lower canister-like object to that specified vertical position ultimately results in the upper canister-like object entering a floatation state inside the fluid column-like pathway section, allowing the upper canister-like object that enters a floatation state to begin ascending through the fluid column-like pathway section as a result of the buoyancy properties such canister-like object has;
allowing the canister-like object that has ascended through the entire height of the fluid column-like pathway section to completely exit such fluid column-like pathway section, and also to further allow such upwardly moving canister-like object to continue ascending for an unspecified distance above and beyond the topmost point of this fluid column-like pathway section, and
to ascend in this next pathway section, that is above the top of the fluid column-like pathway section, through air or an air-like fluid, and
whereby the upward force for such ascension through air for this canister-like object is a result of the upward momentum such ascending canister-like object has acquired from the combined upwardly accelerating forces of buoyancy and a net upward pressure differential force this canister-like object has been experiencing during the entire ascension process through the water-like non-air fluid that is held in the fluid column-like pathway section;
to have pre-configured this pathway section that is above the fluid column-like pathway section so that the maximum vertical ascension point that an ascending canister-like object will reach, which is the vertical point on or around where an ascending canister-like object exhausts all of the upward kinetic energy the canister-like object has acquired while ascending through the entire height of the fluid column-like pathway section, is higher than the highest point of the inclined platform-like structure;
focusing again on the area of the overall device where a canister-like object is being held in suspension, and where the upper portion of such canister-like object is extended up into the lowest part of the fluid column-like pathway section and the lower portion of such canister-like object is exposed to the air or air-like fluid, allowing a lower canister-like object to ascend up towards the bottom surface of such suspended canister-like object, and
whereby this ascension process is performed according to one means or another, and to allow the ascension process to continue so that the leading surface of the ascending lower canister-like object comes in contact with the bottom surface of the suspended upper canister-like object, and
during the initial period of contact between the two canister-like object, but before any elevation process occurs related to use of a coupled canister platform-like component to power such elevation process, to allow at least some portion of the body of the upper canister-like object to keep making contact with the no-leak seal-like component, and also
to allow at least some upper portion of the body of this upper canister-like object to keep making contact with some of the water-like non-air fluid that is being held in the fluid column-like pathway section, and also
to allow the remainder of the body of such upper canister-like object to be below the no-leak seal-like component and exposed to the air or air-like fluid;
at a pre-determined time after such vertical coupling event occurred, where the leading surface of the ascending lower canister-like object came in contact with the bottom surface of the upper canister-like object, using a coupled canister platform-like component to elevate the lower canister-like object and at the same time to simultaneously elevate the upper canister-like object, and
whereby throughout this elevation process, this upper canister-like object is vertically coupled to the lower canister-like object by having a protrusion on the leading surface of the lower canister-like object stick up inside of a matching concaved mirror-image, cut-out shape in the bottom surface and lower portion of the upper canister-like object;
for each of the canister-like objects in the set of canister-like objects, having the shape and overall configuration of each canister-like object equal, as closely as possible, the shape and configuration of all the other canister-like objects.

10. A method of generating electricity, according to claim 9, such method comprising:
prior to the coupling process between a suspended upper canister-like object and an ascending lower canister-like object, and as the respective lower canister-like object is below such suspended upper canister-like object by an unspecified distance, aligning the vertical axis of ascent for the lower canister-like object, in the horizontal plane, by having pre-positioned a direction alignment means, and
as a result of such ascending canister-like object passing through such direction alignment means, the center of the ascending canister-like object becomes positioned exactly, or almost exactly, below the center of the suspended upper canister-like object located above this ascending canister-like object;
after the leading surface of this ascending canister-like object has moved some unspecified distance above the top edge of the direction alignment means, monitoring and analyzing the upward speed of the ascending canister-like object, and
immediately after such speed-related data has been analyzed, adjusting the upward speed of the ascending canister-like object, for the purpose of allowing the canister-like object to make a successful coupling event with the canister-like object that is being suspended above this ascending canister-like object;
as the leading surface of the canister-like object is rising above the top surface of the component that is in the process of adjusting the speed of the canister-like object, monitoring and analyzing the upward speed of the canister-like object again, and
if necessary, based on the second analysis of the upward speed of the canister-like object by this second motion sensor-like means, adjusting the upward speed of the canister-like object again;
allowing the canister-like object to continue ascending towards the bottom surface of the canister-like object being held in suspension above this ascending canister-like object;
detecting the presence of the leading surface of this ascending canister-like object, at a point when such canister-like object is approximately forty-three percent of the length of one canister-like object below the bottom surface of the upper canister-like object that is being held in suspension, and
whereby the length of a canister-like object is measured from the flat portion of the bottom surface to the flat portion of the top surface;
allowing electronic communication between the detection-related means that detected the leading surface of the ascending canister-like object and:
a) a first canister suspension means, and
b) a canister notch-related suspension means;
upon this means that detects the presence of the leading surface of the ascending lower canister-like object detecting the presence of such leading surface, having this detection-related means send:
a) a signal to the first canister suspension means, and
upon receipt of such signal by this first canister suspension means, causing this first canister suspension means to re-position certain peripheral components so that these components are extracted out from underneath the bottom surface of the lower canister-like object, and
b) signals sent to the canister notch-related suspension means, which immediately causes this suspension means to enter the retracted mode and to retract certain peripheral components out of and away from the notch of the suspended canister-like object;
detecting the bottom surface of the ascending canister-like object, when such bottom surface has passed in front of the means to detect such motion, and also whereby the vertical location of such motion detection means is at the same vertical height as the highest piece of equipment attached to the coupled canister platform-like component, or at the same vertical height as the highest point on the coupled canister platform-like component, itself, if no peripheral equipment is attached to such coupled canister platform-like component, and whereby such coupled canister platform-like component will be horizontally repositioned, at a specified time, so that such coupled canister platform-like component will be positioned underneath the bottom surface of the ascending canister-like object, and
whereby this coupled canister platform-like component is part of an overall lower canister platform-like support means, and also there is a vertical positioning means attached to the coupled canister platform-like component and this vertical positioning means is also part of the overall lower canister platform-like support means;
allowing electronic communication between the detection-related means that detected the bottom surface of the ascending canister-like object and a horizontal positioning means for the coupled canister platform-like component;
using a horizontal positioning means for the coupled canister platform-like component to move this coupled canister platform-like component in underneath the bottom surface of the ascending canister-like object, and
whereupon this horizontal positioning means for the coupled canister platform-like component receives a signal from the respective detection-related means, immediately causing such re-positioning process to occur, and
to have pre-configured the speed-adjustment made on the ascending canister-like object just a split-second prior to the leading surface of this ascending canister-like object making contact with the bottom surface of the suspended canister-like object, so that there will be enough time for this coupled canister platform-like component horizontal positioning means to re-position the coupled canister platform-like component, horizontally, into a horizontal position whereby the center of such coupled canister platform-like component is directly underneath or almost directly underneath the center of the bottom surface of the canister-like object that just passed in front of the motion sensor-like means that detected the bottom surface of such canister-like object, and more specifically,
this re-positioning operation must be completed between the time a) the bottom surface of the ascending canister-like object moves higher than any parts connected to such coupled canister platform-like component, and b) the time the ascending canister-like object exhausts all of its upward kinetic energy while moving two canister-like objects upwards against the forces of gravity and substantial downward fluid pressure forces, and c) the amount of time it takes for the bottom surface of this lower canister-like object to descend back to a point where the bottom surface of such lower canister-like object is making contact with the topmost parts on this coupled canister platform-like component;
allowing the bottom surface of the ascending canister-like object to pass in front of the related motion sensor-like means, and to have such motion sensor-like means cause the horizontal positioning means for the coupled canister platform-like component to move such coupled canister platform-like component into the proper position directly underneath the bottom surface of the ascending and then descending canister-like object;
allowing a pre-determined time to pass, which is slightly longer than the pre-determined time it takes for the bottom surface of a lower canister-like object to pass in front of the related motion sensor-like means, for the canister-like object to ascend to the maximum vertical ascension point and then for the bottom surface of such canister-like object to fall back onto this coupled canister platform-like component, and then using a vertical positioning means to elevate the coupled canister platform-like component to a pre-determined vertical point, and
whereby such pre-determined vertical point is such that the two canister-like objects, one on top of the other, are elevated until a vertical point is reached where the lower canister-like object, which is the canister-like object sitting directly on top of such coupled canister platform-like component, is at the exact same vertical position the upper canister-like object was at before the method of suspending such upper canister-like object was terminated;
electronic communication, going in both directions, between the vertical positioning means that moves the coupled canister platform-like component of the overall lower canister platform-like support means up and down along a vertical axis, and:
a) the first canister suspension means, and also
b) the canister notch-related suspension means;
whereupon this vertical positioning means elevates the coupled canister platform-like component to the pre-determined vertical point, this vertical positioning means sends:
a) a signal to the first canister suspension means, and
upon receipt of such signal by this first canister suspension means, causing this first canister suspension means to re-position certain peripheral components so that these components are extended in underneath the bottom surface of the lower canister-like object and this action results in this first canister suspension means having the ability to hold this lower canister-like object in a fixed position, vertically, and
b) a signal to the canister notch-related suspension means, and since the notch in the body of this lower canister-like object is sitting directly in front of this canister notch-related suspension means, the canister notch-related suspension means extends certain peripheral component out towards the notch of the respective canister-like object, and this canister notch-related suspension means applies light horizontal pressure against the notch of the respective canister-like object, and the interaction between this canister notch-related suspension means and the body of this lower canister-like object results in this lower canister-like object being held in a fixed position, horizontally;
whereupon each of these four such suspension means becomes extended out to the proper horizontal position, each such suspension means sends a signal to the vertical positioning means that moves the coupled canister platform-like component of the overall lower canister platform-like support means up and down along a vertical axis, and upon receipt of all four such signals, this vertical positioning means resets itself and thereby also resets the connected platform-like component, and
whereby such resetting process causes this vertical positioning means to move down to the lowest vertical position available, which is the default vertical position and which is a vertical position where the coupled canister platform-like component is down far enough to be moved in, horizontally, underneath the next canister-like object that can perform a coupling event with the canister-like object that is currently being suspended by the respective suspension means;
upon such vertical positioning means having re-positioned itself down to the lowest possible position, a signal is sent from such vertical positioning means to the horizontal positioning means, and upon receipt of such signal by the horizontal positioning means, causing that horizontal positioning means to retract the one or more pieces of the coupled canister platform-like component back out of the way of the path the next canister-like object will need to use when the leading surface of such next canister-like object, in the next repetitive cycle, will be trying to make contact with the bottom surface of the canister-like object that was just elevated and is now being held in suspension;
with regards to the upper canister-like object that was pushed up so high, by the lower canister-like object, that the bottom surface of such upper canister-like object is now totally above the no-leak seal-like component, since the entire body of this upper canister-like object is totally surrounded by water-like non-air fluid, and since the design of the canister-like object is such that this canister-like object will have buoyancy when the canister-like object is completely submerged in such water-like non-air fluid, allowing this completely submerged canister-like object to begin floating upwards;
allowing this completely submerged canister-like object to continue ascending up to a vertical point whereby the leading surface of such canister-like object moves above the topmost point of the fluid column-like pathway section.

11. A method of generating electricity, according to claim 10, such method comprising:
having the means that opens and closes the waterproof sliding panel on the high pressure side of the variable pressure chamber, at such time when this waterproof sliding panel has been completely opened, to send a signal to the head-like component of a second canister-like object puller, and
whereby before such signal has been sent by that means that opens and closes the waterproof sliding panel on the high pressure side of the variable pressure chamber, to have moved this second canister-like object puller to a position whereby the magnetic attraction between the electromagnetic field that will be generated by the head-like component of this second canister-like object puller and the magnet inside the canister-like object, will be strong enough to allow the second canister-like object puller to pull a canister-like object, and
to allow the head-like component of such second canister-like object puller to receive any signals sent by the means that opens and closes the waterproof sliding panel on the high pressure side of the variable pressure chamber, and
whereupon receipt of such signal sent by the means that opens and closes the waterproof sliding panel on the high pressure side of the variable pressure chamber by the head-like component of this second canister-like object puller, to cause this respective head-like component to create and maintain an electromagnetic field, and also
to have the means that opens and closes the waterproof sliding panel on the high pressure side of the variable pressure chamber, at such time when this waterproof sliding panel has been completely opened, to send one or more signals to the pulley-like component that is attached to the body of the second canister-like object puller;
whereupon the pulley-like component that is attached to the second canister-like object puller receives one or more signals from the means that opens and closes the waterproof sliding panel on the high pressure side of the variable pressure chamber, to cause such respective pulley-like component to begin moving the second canister-like object puller, and
whereby such movement is away from the variable pressure chamber, and
to allow such pulley-like component that is attached to the second canister-like object puller to continue moving this second canister-like object puller to a pre-determined position,
and whereupon such respective pulley-like component reaches such pre-determined position, to cause such pulley-like component to stop moving the second canister-like object puller, and also
whereby this pre-determined position that this second canister-like object puller has been moved to is also a point at which the entire body of the canister-like object that has been moved by the canister-like object puller, is completely outside the variable pressure chamber on the high pressure side of this variable pressure chamber, and also the canister-like object will have been pulled far enough past the waterproof sliding panel on the high pressure side of the variable pressure chamber so that when the second canister-like object puller stops moving, the canister-like object is completely inside of an upwardly sloping non-enclosed pathway section, and also
at the point when this second canister-like object puller stops moving, to cause the pulley-like component to send a signal to the head-like component of the second canister-like object puller, and also
at the point when this second canister-like object puller stops moving, to cause the pulley-like component attached to such second canister-like object puller to move this canister-like object puller in the other direction, so that the canister-like object puller is moved back to the original position this canister-like object puller was at before the process of pulling the canister-like object out of the variable pressure chamber started, and also
at the point when this second canister-like object puller stops moving, to cause the pulley-like component to send a signal to the means that opens and closes the waterproof sliding panel that is located on the high pressure side of the variable pressure chamber, and
to have this means that opens and closes this waterproof sliding panel on the high pressure side of the variable pressure chamber to receive this signal from the pulley-like component attached to the second canister-like object puller, and upon receipt of such signal, to cause this waterproof sliding panel on the high pressure side of the variable pressure chamber to be fully closed;
at the point when this waterproof sliding panel located on the high pressure side of the variable pressure chamber has been fully closed, to cause the component which closed such waterproof sliding panel to send a signal either: a) directly to the means that opens and closes the other waterproof sliding panel, which is located on the low pressure side of the variable pressure chamber, or b) to a control valve-type means located on the variable pressure chamber, and
whereby as a result of these signals being received, to cause the waterproof sliding panel on the low pressure side of the variable pressure chamber to open;
at the point when this second canister-like object puller stops moving, and also when the head-like component of this second canister-like object puller receives the signal from the pulley-like component attached to this second canister-like object puller, at such time the head-like component of the second canister-like object puller terminates the electromagnetic field;
using an upwardly sloping non-enclosed pathway section, and
whereby such upwardly sloping non-enclosed pathway section begins at a point on or near the waterproof sliding panel of the variable pressure chamber that is on the high pressure side of the variable pressure chamber, and
whereby while in such upwardly sloping non-enclosed pathway section, a canister-like object is situated inside the pathway configuration that is created from using the inner edges of three or more guide rails, and
whereby such guide rails, in combination with some connectors used to hold the guide rails in place relative to each of the other guide rails, are the primary components of such upwardly sloping non-enclosed pathway section, and
whereby the minimum inner distance of such pathway configuration, between the inner edges of the guide rails of this upwardly sloping non-enclosed pathway section, is greater than the maximum width or maximum diameter of a canister-like object, and
whereby these guide rails of the upwardly sloping non-enclosed pathway section are completely surrounded, except for any connecting components or except for any mounting components, by a water-like non-air fluid, and
as a result of this upwardly sloping non-enclosed pathway section being completely surrounded by this water-like non-air fluid, any canister-like objects inside such upwardly sloping non-enclosed pathway section, as a result of the buoyant force created by the nature of the construction of the canister-like objects, will have the ability to move upward without forces being applied from any external equipment, even considering the non-vertical angle of slope of the pathway configuration of the upwardly sloping non-enclosed pathway section, and
whereby this overall upwardly sloping non-enclosed pathway section, at any given time, holds at least two canister-like objects;
allowing a canister-like object to float upwards along the pathway configuration of the upwardly sloping non-enclosed pathway section, as such pathway section winds around in one or more large circular loops, where large is defined as relative to the length of an individual canister-like object;
using an anti-floatation rod-like means to keep the topmost canister-like object in the upwardly sloping non-enclosed pathway section from continuing to float upwards through a tightly-curved non-enclosed pathway section, until the appropriate time, and
whereby such appropriate time occurs at the point in time when a canister-like object that is adjacent to the canister-like object being held back by the anti-floatation rod-like means has been pulled all the way through the tightly-curved non-enclosed pathway section, and
whereby such previously-adjacent canister-like object that has just been pulled all the way through the tightly-curved non-enclosed pathway section is also headed up into an area that is above the tightly-curved non-enclosed pathway section, and whereby such area is an upper extension of the large fluid reservoir-like structure, and also
the primary purpose of this upper extension of the large fluid reservoir-like structure is to upwardly accelerate a canister-like object at such time when that canister-like object is exiting the overall large fluid reservoir-like structure and ascending up to another area of the overall device to perform a coupling event with an upper canister-like object being held in suspension directly above the particular point of exit where such accelerated ascending canister-like object will be exiting the overall large fluid reservoir-like structure;
at the appropriate time, causing certain parts of a the anti-floatation rod-like means to be re-positioned so that such parts are not extending into the pathway used by a canister-like object to move from the top of the upwardly sloping non-enclosed pathway section into the tightly-curved non-enclosed pathway section, and
at the same time these parts of the anti-floatation rod-like means are being re-positioned, to cause an electromagnetic holding-mechanism to create an electromagnetic field, and
after creating such electromagnetic field, to cause that electromagnetic holding-mechanism to maintain that electromagnetic field for a specified period of time, and
as a result of the manner in which the canister-like objects always position themselves on the upwardly sloping non-enclosed pathway section, as all the canister-like object move up the length of one canister-like object at a time, according to a repetitive sequence of movement, the location of the magnet attached to or located inside of each canister-like object, when that canister-like object is stopped in front of this electromagnetic holding-mechanism, will be close enough to the electromagnetic field that was created by the electromagnetic holding-mechanism so that the strength of this electromagnetic magnetic field will be able to temporarily hold this canister-like object in place, as long as such electromagnetic field is maintained by the electromagnetic holding-mechanism;
shortly after the electromagnetic holding-mechanism has created an electromagnetic field and as a result the canister-like object in front of such electromagnetic holding-mechanism is being held in place, causing certain parts of a temporary retaining pin means to be re-positioned so that such parts are extending into the pathway that the canister-like object being temporarily held in place by the electromagnetic holding-mechanism would be moving along were it not for the fact the movement of such canister-like object cannot occur because of the existence of the electromagnetic field that has been created and maintained by the electromagnetic holding-mechanism, and
immediately after such parts of the temporary retaining pin means are re-positioned so that such parts are extending into the pathway that the canister-like object being held by the electromagnetic holding-mechanism would be using to move over and through, causing the electromagnetic holding-mechanism to terminate the electromagnetic field it is maintaining, and
at a pre-determined time after the temporary retaining pin means has entered the extended mode, causing certain parts of the anti-floatation rod-like means to be re-positioned so that such parts are extending into the pathway used by a canister-like object to move from the top of the upwardly sloping non-enclosed pathway section into the tightly-curved non-enclosed pathway section, and
whereby such pre-determined time for the repositioning of these certain parts of the anti-floatation rod-like means is a time when the bottom surface of the canister-like object that has just moved from being in the topmost cue position on the upwardly sloping non-enclosed pathway section to fully entering the tightly-curved non-enclosed pathway section has completely moved past these certain parts of such anti-floatation rod-like means, and
immediately after these certain parts of the anti-floatation rod-like means have been re-positioned, so that such parts are extending into the pathway that the next canister-like object will be moving along, those certain parts of the temporary retaining pin means that were re-positioned to extend into the pathway that the canister-like object moves along, are re-positioned so that such parts are not in the pathway that canister-like objects move along, and
as a result of these certain parts of the temporary retaining pin means being re-positioned out of the pathway for the canister-like objects, all canister-like objects in the upwardly sloping non-enclosed pathway section ascend a distance equal to the length of one canister-like object, and as a result of such movement, the canister-like object that was being held in place by certain parts of the anti-floatation rod-like means becomes the topmost canister-like object in the upwardly sloping non-enclosed pathway section, but
whereby this topmost canister-like object cannot move upwards any further than the point where the leading surface of such canister-like object is making contact with those certain extended parts of the anti-floatation rod-like means;
forcing a canister-like object to move along a tightly-curved non-enclosed pathway section, and
whereby such tightly-curved non-enclosed pathway section begins at the top of the upwardly sloping non-enclosed pathway section, and ends at a point where a canister-like object inside this pathway configuration has reached perfect, or almost perfect, vertical alignment, and
while in such tightly-curved non-enclosed pathway section, a canister-like object is situated inside the pathway configuration that is created from using the inner edges of three or more guide rails, and
whereby such guide rails, in combination with some connectors used to hold the guide rails in place relative to each of the other guide rails, are the primary components of such tightly-curved non-enclosed pathway section, and
whereby the minimum inner distance of such pathway configuration, between the inner edges of the guide rails of this tightly-curved non-enclosed pathway section, is greater than the maximum width or maximum diameter of a canister-like object, and
whereby these guide rails are surrounded, except for any mounting components, completely by a water-like fluid;
controlling the movement of a canister-like object inside the tightly-curved non-enclosed pathway section by using a canister-like object puller, and
whereby such canister-like object puller moves along a curved, or mostly curved path of motion, and
whereby such canister-like object puller creates and maintains an electromagnetic field in a head-like component of the canister-like object puller, and
whereby the magnetic attraction between this electromagnetic field created and maintained by the head-like component of the canister-like object puller and the magnet attached to or located inside a canister-like object is strong enough so that the canister-like object puller can pull the canister-like object along and through this tightly-curved non-enclosed pathway section, and
the canister-like object puller continues moving until it reaches a pre-determined position, at which time the canister-like object puller stops moving, and
such pre-determined position is a point at which the canister-like object being pulled by the canister-like object puller has attained perfect, or almost perfect, vertical alignment, and also
upon the canister-like object puller arriving at this pre-determined position, a signal is sent to the head-like component of the canister-like object puller by the mechanism moving the canister-like object puller, and
allowing the respective head-like component to receive such signal sent by the mechanism moving the canister-like object puller, and
upon receipt of such signal coming from the mechanism moving the canister-like object puller, the head-like component of the canister-like object puller terminates the electromagnetic field, and
once this electromagnetic field has been terminated, allowing the canister-like object to float in an upward direction, powered by buoyancy and other pressure differential forces created by the canister-like object, itself, and also
whereupon the head-like component of the canister-like object puller terminates the electromagnetic field, causing the means that has moved the canister-like object puller to such designated stopping position to reset the respective canister-like object puller, which involves moving such canister-like object back over to the position this canister-like object was at before the process of pulling the respective canister-like object through the tightly-curved non-enclosed pathway section started;
using an overall configuration of many various pieces of equipment to allow a canister-like object to ascend from the vertical point where this canister-like object has just exited the tightly-curved non-enclosed pathway section to the vertical point where the entire body of the canister-like object has moved completely above the water-like non-air fluid being held in this large fluid reservoir-like structure and where this canister-like object is completely ascending out through an exit opening at the top of the upper extension of the large fluid reservoir-like structure, and
whereby all such components located in this upper extension of the reservoir structure act together as a system that combines the upward kinetic energy a canister-like object acquires, as a result of the upward forces imparted on the canister-like object from the canister-like object's own buoyancy as the canister-like object ascends through such upper extension of the reservoir structure, with additional upward kinetic energy that is supplied by a series of large acceleration electromagnets, which are timed to create electromagnetic pulses that keep adding to the upward kinetic energy every time a canister-like object ascends higher and higher past each set of such acceleration electromagnets, and
whereby large is defined as being relative to the size of a canister-like object and relative to other smaller-sized decelerating electromagnets used in the upper extension of the reservoir structure, and
whereby such smaller-sized decelerating electromagnets are used to restrict the buoyancy effect a canister-like object has while such canister-like object is in the lower part of the upper extension of the reservoir structure, and
whereby throughout almost the entire ascension of a canister-like object through this upper extension of the reservoir structure, the canister-like object is surrounded by a water-like fluid;
overall, a canister-like object that exits out the top of the upper extension of the reservoir structure needs to continue ascending through air or an air-like fluid, the required distance so that such canister-like object can make contact with an upper canister-like object that is considerable distance above the point where the ascending canister-like object exits the upper extension of the reservoir structure, and
whereby considerable is defined relative to the length and weight of a canister-like object, and also
with regards to all of the equipment in the upper extension of the reservoir structure, in the lower portion of the upper extension of the reservoir structure, the smaller decelerating electromagnets and other pieces of equipment are basically used to slow the upward movement of a canister-like object, up to the point where that canister-like object is forced to come to a complete stop,
and whereby this complete stop for a canister-like object is a long enough period of time so that the canister-like object above the canister-like object that has been stopped can go through the required acceleration process, performed in the upper portion of the upper extension of the reservoir structure, so that the canister-like object being accelerated can acquire all the necessary upward kinetic energy;
with regards to the lower portion of the upper extension of the reservoir structure, once that canister-like object which has been held in place in such lower portion of the upper extension of the reservoir structure is released by the equipment that has been holding that canister-like object in place, then such canister-like object is accelerated in the same way the canister-like object above that canister-like object was accelerated;
using multiple sets of guide rails, whereby each guide rail is positioned so that the axis running along the length of the body of such guide rail is at an approximately straight-up angle, and
whereby a pathway configuration is created from using the inner edges of each guide rail in a set of guide rails, and
whereby the minimum inner distance of such pathway configuration, between the guide rails in a set of guide rails, is greater than the maximum width or maximum diameter of a canister-like object, and
whereby these guide rails are completely surrounded by a water-like fluid, except for any mounting components or any other canister-like object direction guidance means that are attached to such guide rails;
using multiple sets of smaller-sized decelerating electromagnets to control the speed of ascent a canister-like object has, as the canister-like object moves the length of one canister-like object at a time, up through the lower portion of the upper extension of the reservoir structure, and
whereby the term smaller is used as being relative to the larger acceleration electromagnets, and also
since there is more than one canister-like object in the upper extension of the reservoir structure at the same time, the advancement of the canister-like objects, in an upward direction, occurs in such a way as to create a time-delay gap between when each adjacent canister-like object, one by one, exits the upper extension of the reservoir structure, and therefore
the smaller-sized decelerating electromagnets in the lower part of the upper extension of the reservoir structure create electromagnetic fields that interact with the magnet attached to or located inside a canister-like object to slow down the ascent of that canister-like object, so that according to these combined deceleration effects, an ascending canister-like object will be going slow enough so that no damage occurs to such pieces of equipment that extended out into the pathway of motion for that canister-like object and are being used to bring that ascending canister-like object to a complete stop;
stopping a canister-like object, and holding that canister-like object in place for a required length of time, and
whereby that canister-like object is directly below the canister-like object that is being accelerated by the larger acceleration electromagnets in the upper portion of the upper extension of the reservoir structure, and
whereby such stopping process is performed by a rod-like retaining means which results in various components extending directly out into the pathway a canister-like object uses to ascend through the upper extension of the reservoir structure, or
by causing one or more parts of various components to engage into the notch area of a canister-like object, or
by using some other means to keep a canister-like object from ascending, until the proper time, by applying some type of friction to the sides of a canister-like object;
using multiple sets of larger-sized accelerating electromagnets to accelerate the speed of ascent a canister-like object has, as that canister-like object moves through the upper portion of the upper extension of the reservoir structure, and
each set of larger accelerating electromagnets is comprised of two or more such electromagnets, and
whereby all such electromagnets in a set are positioned at approximately the same vertical position in the horizontal plane, and
whereby in the horizontal plane, these electromagnets are distributed around the center axis of an ascending canister-like object in such a way as to provide a balance with regards to the individual upward pulling forces being applied, electromagnetically, to an ascending canister-like object by each of the individual electromagnetic fields being maintained by each of the individual electromagnets in the set of electromagnets, and also
in the horizontal plane, the electromagnets in a set are positioned in such a way so that the strength of the magnetic attractive force of each individual electromagnetic field, for each individual electromagnet in the set of electromagnets, is as close as possible to being equal to the strength of the magnetic attractive force of each of the other individual electromagnetic fields, with regards to how the magnet attached to or located inside a canister-like object is being attracted to each of these individual electromagnetic fields, and
one of the primary factors determining the relative attractive force for each individual electromagnetic field, in a set of electromagnets, is exactly how far away from a magnet attached to or located inside a canister-like object, each such electromagnet is, relative to the other electromagnets in the set, and
whereby a temporary electromagnetic field is created in all electromagnets in a set at at the same exact instant, and also
all such electromagnetic fields for the set of electromagnets in a set exist for a very short period of time, so that these electromagnetic fields essentially create a magnetically attractive pulse, that exists long enough to impart an upward force on the magnet of the canister-like object, but these electromagnetic fields do not exist so long that as the magnet in the canister-like object moves above these electromagnets, the attractive forces of all the electromagnetic fields in the set begin pulling on the magnet in a way that would try and pull the magnet in a downward direction, which would occur once a magnet ascends so far that the bottom half of the magnet is higher than the electromagnetic fields or if the magnet has the ability to significantly feel the forces of the electromagnetic fields from the underside of the magnet, and also
with regards to the timing of such electromagnetic pulses, from one set to another, each individual set of electromagnets creates the related composite electromagnetic pulse in such a way so that the magnet attached to or located inside a canister-like object feels an overall resulting magnetic attraction that is almost like one continuous upward magnetic attraction, even though the overall magnetic attraction is being provided by a series of individual sets of electromagnets that are timed to pulse, electromagnetically, and therefore
one by one, these pulses occur in each set so that as one pulse is decreasing in strength, the next pulse being provided by the set of electromagnets above the previous set, is felt by the magnet and this next pulse tends to replace the previous pulse, but since the next pulse is coming from a location that is higher than the previous pulse, the collective result of all the pulses, from each set, one by one, will continuously keep pulling the magnet upward and will, as a result, keep adding upward kinetic energy to the overall motion of the related canister-like object;
using various direction alignment means in the upper extension of the reservoir structure, and whereby such pieces of direction alignment components are securely-mounted to various vertical or semi-vertical support beams within the upper extension of the reservoir structure, and
whereby such direction alignment means are used for the purpose of adjusting the angle of ascent of the canister-like objects so that the centerpoint of each canister-like object, in the horizontal plane as each individual canister-like object is moving upwards, is directly in line, as much as possible, with the exit opening at the top of the upper extension of the reservoir structure.

12. A method of generating electricity, according to claim 11, such method comprising:
with respect to the fluid column-like pathway section, using a greatly expanded lower portion of this overall pathway section, comprised of:
the fluid column-like pathway section that has a tight portion of the overall fluid column-like pathway section and a greatly expanded lower portion of the overall fluid column-like pathway section, and more specifically,
almost all of the height of the fluid column-like pathway section will be the tight portion, and such tight portion means that the surface area at any given height is just slightly larger than the surface area needed to have room for the inductors, the mounting equipment and any necessary vertical structural support beams, in the horizontal plane, and
at the lowest portion of the overall fluid column-like pathway section, a combined set of underwater acceleration equipment is located there, and the majority of such equipment is completely mounted inside of and operates inside of the fluid column-like pathway section and therefore is surrounded by the water-like non-air fluid, and
as a result of this equipment being located at the lowest portion of the fluid column-like pathway section, the surface area where this equipment is located is much larger than the tight portion of the fluid column-like pathway section, because this acceleration-related equipment is much larger than the size of an inductor;
the height of this greatly expanded lower portion of the fluid column-like pathway section is just slightly higher than the tallest piece of acceleration-related equipment used inside of the fluid column-like pathway section;
the width and depth of this greatly expanded lowest portion of the fluid column-like pathway section is much larger than the space required for this acceleration-related equipment in the horizontal plane,
because by greatly expanding the measurements for the width and for the depth in this particular portion of the fluid column-like pathway section, which is where the leading surface of a canister-like object is pushed up through the no-leak seal-like component, the fluid pressure at any given height is reduced in direct proportion to the increase in the size of the surface area for that same height, and therefore,
for the overall device, if the height of the pathway a canister-like object uses in the freefall state and respectively the total height of the fluid column-like pathway section are greatly increased, then this also means the amount of fluid pressure around the area of the no-leak seal-like component will also be greatly increased because of the additional weight of the water-like non-air fluid in the fluid column-like pathway section, but
by creating a greatly expanded lower portion of the fluid column-like pathway section, this greatly increased fluid pressure can be reduced down to a much smaller level, according to exactly what sizes of width and depth are used for this greatly expanded lower portion of the fluid column-like pathway section, and
for an elevation process when a lower canister-like object is elevating an upper canister-like object, each amount of incremental decrease in fluid pressure felt by an upper canister-like object makes the elevation process by the lower canister-like object much easier to perform, and therefore
to accordingly adjust any enhanced upward momentum applied to the bottom surface of a canister-like object when such canister-like object is first beginning to float upwards, so that the amount of such applied upward momentum takes into account exactly what the fluid pressure is throughout this greatly expanded lower portion of the fluid column-like pathway section, with respect to the height of the overall fluid column-like pathway section in relationship to the width and the depth of this greatly expanded lower portion of the fluid column-like pathway section, and also
the amount of upward kinetic energy transferred to the bottom surface of a canister-like object that is being accelerated as the canister-like object first begins the floatation process, must also take into account the fact that for a vertical distance equal to the length of one canister-like object, there will be substantial additional kinetic energy required so that during that entire time while the leading surface of such canister-like object is inside the tight portion of the fluid column-like pathway section but the bottom surface of such canister-like object is still in the greatly expanded lower portion of this fluid column-like pathway section, almost the total amount of net fluid pressure will be pushing down from the top of the canister-like object because the force of buoyancy the canister-like object has in the greatly expanded lower portion of this pathway section is very weak, compared to the force of the weight of the water-like non-air fluid pushing down on the leading surface of the canister-like object that is experiencing fluid pressures at a much higher level inside the tight portion of the fluid column-like pathway section, and
therefore the overall amount of upward acceleration applied to the bottom surface of a canister-like object needs to be greater than the combined differential, over a distance equal to the length of one canister-like object, of the net downward fluid pressure the ascending canister-like object experiences under those conditions where the leading surface of the canister-like object is in the tight portion of this overall fluid column-like pathway section and the bottom surface of the canister-like object is in the greatly expanded lower portion of this overall pathway section.

13. A method of generating electricity, according to claim 12, such method comprising:
with regards to increasing the rate of ascension for the overall floatation process for a canister-like object ascending through the overall fluid column-like pathway section, this method starts first by allowing the canister-like object to initially ascend only far enough upwards so that a multi-section underwater platform-like object can be positioned in underneath the canister-like object and then releasing the canister-like object to move upwards and at the same time applying considerable upward thrust to the bottom surface of this canister-like object by this multi-section underwater platform-like object, and such acceleration process comprises:
electronic communication between: a) the first canister suspension means that has the ability to suspend a lower canister-like object after such lower canister-like object has elevated an upper canister-like object so that the bottom of such upper canister-like object is higher than the topmost point of the no-leak seal-like component, and b) a number of horizontal positioning means that are located inside of the fluid column-like pathway section, and whereby each individual horizontal positioning means independently moves one of the sections of a multi-section underwater platform-like object;
at a pre-determined timed delay after the respective first canister suspension means has been re-positioned into the extended mode, which is around the same time the bottom surface of the upper canister-like object was moved completely above the topmost point of the no-leak seal-like component, and whereby such timed delay is enough time for the upper canister-like object, which is in the floatation state, to float up to the vertical point where such floating canister-like object was stopped, causing the overall multi-section underwater platform-like object to be moved, horizontally, so that this multi-section platform-like component of the overall underwater platform-like object is properly positioned, horizontally, underneath the bottom surface of the temporarily stopped canister-like object;
this multi-section underwater platform-like object has a platform-like component that is comprised of a total of two or more sections, and
whereby this multi-section underwater platform-like object is completely surrounded by the water-like non-air fluid being held in the fluid column-like pathway section, except for any connection points where contact is made with other peripheral equipment, and
whereby each individual section is as close as possible to being identical to every other individual section, except that in the horizontal plane, each individual section of the overall multi-section underwater platform-like object is rotated to an angle, in the horizontal plane, that is different from the angle any of the other individual sections are rotated to, and also
for this overall multi-section underwater platform-like object, when all of the individual sections are properly joined together and each individual section is making proper and snug contact with the section or sections adjacent to each such individual section, then the overall width of the resulting shape of all such joined sections, or the overall outside diameter of the resulting shape of all such joined sections, is approximately as great as the width or diameter of the bottom surface of a canister-like object, and also
when properly joined together, the centerpoint of the resulting shape of all such joined sections, or the centerpoint of the overall outside diameter of the resulting shape of all such joined sections, is positioned so that this centerpoint of the resulting shape is directly underneath, or is as close as possible to being directly underneath, the centerpoint of the bottom surface of the canister-like object that is positioned a short distance above such multi-section underwater platform-like object;
allowing each individual section of the multi-section underwater platform-like object, in the horizontal plane, to be moved independently from every other section of this multi-section underwater platform-like object, and accordingly each individual section has its own horizontal positioning means that is attached to no other individual section, but
causing the individual horizontal movements off all of the individual sections of the multi-section underwater platform-like object to be moved more or less at the same time, which includes all of these individual sections being: a) moved in unison towards each other, horizontally, and therefore to become joined as one composite underwater platform-like object, or b) moved in unison away from each other, horizontally, and
when being pulled apart from each other, with regards to the path of motion an ascending canister-like object will need to use in order for such canister-like object to float-up into that area where this multi-section underwater platform-like object is located, each individual section of the multi-section underwater platform-like object is pulled far enough away from such path a canister-like object moves along so that the pathway is completely clear and unobstructed;
allowing each individual section of the multi-section underwater platform-like object to be moved, vertically, independently from every other section of this multi-section underwater platform-like object, and whereby each individual section of this multi-section underwater platform-like object has its own vertical positioning means that is attached to no other individual section, but
all moving parts that move vertically up and down, for each individual set of peripheral equipment for each individual section of this multi-section underwater platform-like object: a) move at the exact same time, or as close as possible to the exact same time and b) move for approximately the same distance, up or down along the vertical axis, and also
upward vertical movement by all such vertically-moving component is: a) to allow the upper floor-surface area of the properly joined multi-section underwater platform-like object to make initial contact with the bottom surface of a canister-like object being retained above such multi-section underwater platform-like object, or b) to provide upward acceleration to such canister-like object at a point immediately after such canister-like object is no longer being retained from floating upwards in the fluid column-like pathway section;
electronic communication between all of the individual horizontal positioning means and the retaining means that has stopped the canister-like object that was in the floatation state;
whereupon each horizontal positioning means for each individual section of the overall multi-section underwater platform-like object has fully extended the respective individual section into the proper position, which has subsequently caused individual confirmation signals to be sent by each of the horizontal positioning means to the retaining means that is temporarily keeping the canister-like object from re-entering the floatation state, and upon such signals being received by this retaining means, then such retaining means is retracted out of the path the canister-like object needs to take to continue floating upwards;
electronic communication between the retaining means and each of the individual vertical positioning means of the overall multi-section underwater platform-like object;
whereupon the retaining means releases the canister-like object and allows such canister-like object to continue ascending up into the fluid column-like pathway section, immediately upon such release of the canister-like object, individual signals are sent to each of the vertical positioning means of the overall multi-section underwater platform-like object, and upon receipt of such signals by the individual vertical positioning means, causing these means to initiate an upward thrusting process that will provide tremendous upward acceleration to the multi-section platform component of the overall multi-section underwater platform-like object, but
there is also a governor means that provides simultaneous communication between each of the individual vertical positioning means, and this governor means causes each of the individual vertical positioning means to move in perfect, or almost perfect synchronization as each individual vertical positioning means is accelerated upwards along the vertical axis;
all of the vertical positioning means move upwards until each such vertical positioning means reaches a pre-determined stopping point, which is an equal vertical point for all of the vertical positioning means, and at that point all vertical upward thrust being applied to the bottom surface of the canister-like object is terminated;
as the bottom surface of the vertically accelerated canister-like object continues moving upwards, each of the vertical positioning means, more or less at the same time, moves downward and resets the respective section of the overall multi-section underwater platform-like object by moving all the way back down to the lowest, default, vertical position, which is the vertical point the multi-section platform-like component was at when this multi-section platform-like component of the overall multi-section underwater platform-like object was moved, horizontally, into position underneath the bottom surface of the canister-like object before the upward acceleration process was initiated;
electronic communication between the individual vertical positioning means and the respective individual horizontal positioning means, and upon each respective vertical positioning means reaching the lowest vertical default position and which signifies that all of the individual sections of the multi-section underwater platform-like object are in place for the next repetitive cycle, a signal is sent to each of the respective horizontal positioning means, and
upon receipt of such signals by each of the respective horizontal positioning means from each of the respective vertical positioning means, each respective horizontal positioning means pulls the respective attached individual section of the overall multi-section underwater platform-like object, horizontally, back out of the path the next canister-like object will be ascending through.

14. Apparatus for generating electricity, comprising:
a series of open, non-enclosed pathway sections, and whereby each pathway section leads into the next pathway section;
a plurality of four or more canister-like objects, whereby there is one or more magnets attached to or located inside each such canister-like object, and whereby each such canister-like object, when positioned properly in a no-leak seal-like component, completely stops or almost completely stops any water-like non-air fluid from leaking out the bottommost hole-like cut-out area of the fluid column-like pathway section, and whereby the top surface of each such canister-like object has a means to interlock into the bottom surface of any other such canister-like object whenever any two such canister-like objects are adjacent to each other and are making the applicable form of contact that allows such interlocking connection to exist between the two adjacent canister-like objects, and also whereby the specific shape of the body of each canister-like object matches as closely as possible the specific shape of the body of every other canister-like object, and whereby the buoyant property of each canister-like object is relative to the specific gravity of the water-like non-air fluid that is held in a fluid column-like pathway section, and
on each of the canister-like objects in the set of canister-like objects, using a notch-like shape that is carved out of a portion of the main body section of each canister-like object, and whereby when a lower canister-like object has moved up into the precise position an upper canister-like object was at before the suspension of such canister-like object was terminated, using a means to insert one or more rod-like objects horizontally or at a semi-horizontal angle into the notch of the canister-like object that is positioned directly in front of such canister notch-related suspension means;
a system of distribution for the individual canister-like objects, throughout the overall apparatus, and
whereby this system of distribution of the individual canister-like objects is such that not all canister-like objects are making contact at the same time with the inclined platform-like structure, and also
this system of distribution of the individual canister-like objects dictates that at all times some part of the main portion of the body of a canister-like object is positioned in a vertical or almost vertical direction, and also that a part of the outer surface of the main portion of the body of such canister-like object is pressing against the inner area of the no-leak seal-like component in a way that completely inhibits, or almost completely inhibits, any water-like non-air fluid that is being held in the fluid column-like pathway section, from flowing out of or flowing through or flowing around or flowing over the general area where such contact is being made between the outer surface of the main part of the body of that canister-like object and the inner open area of the no-leak seal-like component;
for some portion of time during each repetitive cycle, a first canister suspension means is used and whereby the body of each consecutive canister-like object being held in suspension by such first canister suspension means, is held in a specific position, vertically, so that: a) some part of the main portion of the canister-like object body being suspended is making contact with the no-leak seal-like component, b) the top surface of the body of this canister-like object being suspended is sticking up above the no-leak seal-like component by an unspecified distance, and c) the lower portion of such canister-like object is exposed to air or an air-like fluid, and also
at all times when such first canister suspension means is interacting with the respective canister-like object, such first canister suspension means functions by applying upward force to the bottom surface of a respective suspended canister-like object;
a canister notch-related suspension means, and whereby this canister notch-related suspension means has three distinctly different functions, which are:
a) during the time when the first canister suspension means is in the extended mode and is suspending the related canister-like object from the bottom surface of such canister-like object, then this canister notch-related suspension means is engaged into the notch of the respective canister-like object and is applying light horizontal pressure to the notch of the canister-like object, and this light horizontal pressure keeps the body of the canister-like object in perfect alignment, horizontally, and
b) during the time when the first canister suspension means is transitioning between the extended mode and the retracted mode, this canister notch-related suspension means provides all of the vertical suspension for the canister-like object, so that the first canister suspension means can withdraw certain peripheral components without downward pressure being applied by the bottom surface of the suspended canister-like object during the time these peripheral components are being retracted, and
c) after the first canister suspension means has fully entered the retracted mode, then this canister notch-related suspension means also enters the retracted mode, and therefore this canister notch-related suspension means has the responsibility to release a suspended canister-like object and allow such canister-like object to enter the freefall state;
an inclined platform-like structure, which is also a pathway section means, comprising a horizontal or semi-horizontal surface and various support means to maintain the integrity of the overall inclined platform-like structure, and
whereby multiple canister-like objects are making contact with the horizontal or semi-horizontal surface of this inclined platform-like structure at any given time, and
whereby all of the canister-like objects sitting on such inclined platform-like structure, as a group, are lined up one after another in a waiting cue-like configuration, and except for the topmost canister-like object, the bottom surface of each canister-like object is in line with the top surface of the adjacent canister-like object, and
this inclined platform-like structure facilitates downward canister movement so that each canister-like object, according to a time-delayed sequence, can begin its own respective new repetitive cycle, and such inclined platform-like structure is surrounded by air or an air-like fluid;
a means to control the movement of any and all canister-like objects that are sitting on the inclined platform-like structure;
a pathway section means along which the canister-like objects travel while such canister-like objects are descending in a freefall or semi-freefall state;
a direction-altering means which causes the downward direction of motion of a canister-like object to be changed to a horizontal or semi-horizontal direction of motion;
a pathway section means that supports the weight of a canister-like object and provides a pathway for such canister-like object to travel along, when such canister-like object is moving in a horizontal or semi-horizontal direction of motion;
a direction-altering means which causes the horizontal or semi-horizontal direction of motion of a canister-like object to be changed to a vertical or semi-vertical direction of motion;
a means to cause contact to be made between the leading surface of an ascending lower canister-like object and the bottom surface of a suspended upper canister-like object;
a fluid column-like pathway section which: a) is open on both ends, b) is partially filled with a water-like non-air fluid, c) is positioned in a vertically-oriented manner so that one of the open ends is approximately directly above the other open end, d) has a no-leak seal-like component fixed in and around the open end that is at a lower vertical point than the other higher open end, and whereby the exact shape of the inner area of such no-leak seal-like component is constructed so that this shape matches, as closely as possible, the shape of the outer surface of the main portion of the body of each canister-like object, and e) where none, or very little, of the water-like non-air fluid ever leaks out through the lower open end of this fluid column-like pathway section because the main portion of the body of a canister-like object is always inside of, and making tight enough contact with such no-leak seal-like component, to prevent any such leakage of water-like non-air fluid from ever occurring;
a no-leak seal-like component, that is attached to and goes completely around the inner edge of the bottommost hole-like cut-out area of the fluid column-like pathway section, and also whereby the exact shape of the inner open area of this no-leak seal-like component after such no-leak seal-like component is installed into the inner edge of the bottommost hole-like cut-out area of the fluid column-like pathway section, matches as perfectly as possible, the shape of the outer surface of the main portion of the body of each of the canister-like objects;
during the initial action to start the apparatus for the first time, and then afterwards on a regular and continuing cyclical basis, on or around the time a canister-like object is dropping off of the edge of the inclined platform-like structure, another canister-like object, an upper canister-like object, that is positioned roughly on the opposite side of the overall apparatus is elevated to a specific height, by a lower canister-like object, so that the bottom surface of this upper canister-like object is elevated so high that this bottom surface of this upper canister-like object is completely above the topmost point of the no-leak seal-like component, which also means that at that point, because the entire body of this upper canister-like object will be completely surrounded by the water-like non-air fluid being held in the fluid column-like pathway section, this upper canister-like object will automatically begin ascending towards the topmost hole-like cut-out area of this fluid column-like pathway section, due to the effects of buoyancy and the effects of other net upward pressure differential forces, and
this overall system of precisely sequenced simultaneous canister-like object movement thus creates a never-ending cyclical condition where on or around the same time one canister-like object enters a downward state of freefall, another canister-like object enters a state of ascension;
various direction guidance means positioned in strategic locations throughout the overall apparatus, and whereby all such direction guidance means are permanently mounted to various primary support structures of the apparatus, and also all such direction guidance means have open inner areas for the canister-like objects to pass through and whereby the size and shape of all such open inner areas are just slightly larger than the maximum outer dimension of the canister-like objects, relative to the direction in which a canister-like object is heading as such canister-like object is passing through each such direction guidance means;
two or more inductors positioned along certain areas of these open, non-enclosed pathway sections, and
whereby the mounting of such inductors is such that the inductors are aligned directly below each other so that the central axis, going vertically, of a canister-like object traveling in the freefall state will pass as close as possible along the central axis, going vertically, of each of these vertically-aligned inductors, and
whereby the approximate diameter of the inner area of space at the inside of each of these inductors is slightly greater than the approximate diameter of the outer surface of the main part of the body of each individual canister-like object, and
whereby the two ends of wire for each inductor are attached to an electrical load, so that electricity created in each inductor, as the magnet attached to or positioned within a canister-like object passes through the inner area of space of the inductor, can flow from the inductor into such electrical load;
a combination of means used to cause a canister-like object exiting the topmost hole-like means of the fluid column-like pathway section to be deposited back onto some portion of the inclined platform-like structure;
multiple means that are used as support structures for the overall apparatus or to support individual large primary components;
a floor-like component for the overall apparatus.

15. An apparatus for generating electricity, according to claim 14, such apparatus comprising:
a rod-like means used to stop the leading surface of the bottommost canister-like object on the inclined platform-like structure, so that this bottommost canister-like object only enters the freefall state at the proper time, relative to the overall cyclical requirements of the apparatus, and also
at the proper time, relative to the requirements of a repetitive cycle, using the same rod-like means that stopped this respective bottommost canister-like object to release such bottommost canister-like object, so that this respective canister-like object can slide off the inclined platform-like structure;
at a point in time after the bottommost canister-like object on the inclined platform-like structure has been released to drop off the edge of the inclined platform-like structure, and whereby the front portion of the body of such bottommost canister-like object is beginning to move off of this inclined platform-like structure, a rod-like means remains in a position to continue delaying the downward movement of the canister-like object that is in the closest position to the canister-like object that is dropping off of the inclined platform-like structure, and
such closest canister cue position to the bottommost canister cue position can be considered as the second canister cue position on the inclined platform-like structure;
at a point in time after the bottommost canister-like object has completely dropped off of the inclined platform-like structure, the rod-like means that was preventing the downward movement of the canister-like object in the second canister cue position releases the respective canister-like object that was being held by such rod-like means;
shortly after all canister-like objects on the inclined platform-like structure have begun moving downward, a magnetic sensor-like means, to detect the magnet inside the canister-like object that has been moving downward from the third canister cue position towards the second canister cue position, and
such magnetic detection occurs as the magnet attached to or located inside the respective canister-like object that is moving from the third canister cue position towards the second canister cue position comes in proximity to such magnet sensor-like component;
as the canister-like object that is moving towards the second canister cue position keeps moving downward even more on the inclined platform-like structure, a motion sensor-like means to detect the leading surface of such canister-like object;
electronic communication between the motion sensor-like means that is detecting the leading surface of the canister-like object moving towards the second canister cue position and a means that creates and maintains electromagnetic fields created for the purpose of slowing the downward movement of such respective canister-like object;
as this respective canister-like object almost reaches the second canister cue position, a motion sensor-like means to detect when the leading surface of such canister-like object is positioned in front of such motion sensor-like means, and to have pre-positioned the location of such motion sensor-like means so that when the leading surface of a canister-like object is detected at this precise location, the notch component carved out of the body of such canister-like object will be positioned directly in front of the rod-like means used to detain a canister-like object that is positioned in the second canister cue position;
a means of communication between such motion sensor-like means that is detecting the leading surface of the canister-like object that has now entered the second canister cue position and the rod-like notch-related means that retains a canister-like object in the second canister cue position, and
whereupon a related signal is received from the motion sensor-like means by the rod-like notch-related means that retains a canister-like object in the second canister cue position, the rod-like notch-related means goes into the extended mode so that certain parts of this rod-like notch-related means engage with the body of the canister-like object that is positioned in the second canister cue position, and this engagement process stops this respective canister-like object, and all other canister-like objects above this canister-like object on the inclined platform-like structure, from moving downward on the inclined platform-like structure, until such time as this rod-like notch-related means goes into the retracted mode;
with regards to the canister-like object that has now become the bottommost canister-like object on the inclined platform-like structure, a motion sensor-like means in electronic communication with: a) a means to slow the downward movement of a canister-like object that is heading towards the bottommost canister cue position, and b) the rod-like means that will temporarily be stopping the downward movement of such canister-like object;
a means that uses electromagnetic fields, and that has the ability to slow the downward movement of a canister-like object whose leading surface is approaching the means that is used to stop a canister-like object that reaches the bottommost canister cue position on the inclined platform-like structure;
whereupon the leading surface of this respective canister-like object is detected by the motion sensor-like means located just slightly higher than the bottommost point on the inclined platform-like structure, this motion sensor-like means sends a signal to the means that uses electromagnetic fields to slow the descent of the respective canister-like object and also sends a signal to the rod-like means that will be temporarily stopping the canister-like object, and as a result, the downward movement of the respective canister-like object is slowed and then stopped;
in another pathway section of the apparatus, after the direction of motion of a canister-like object has been changed from heading in a downward direction to heading in a horizontal or semi-horizontal direction of motion, and before the leading surface of such moving canister-like object makes contact with any outer flat head-like surfaces that are directly connected to plunger-like means, a direction alignment means whereby the entire body of such canister-like object can be aligned in any specific way that is required so that such canister-like object can make the proper contact, or non-contact, with all other pieces of equipment used by the overall device while the canister-like object is moving over or along that particular pathway section;
a means of monitoring the speed a canister-like object has while such canister-like object is traveling in a horizontal or semi-horizontal direction and just prior to the leading surface of such moving canister-like object making contact with any outer flat head-like surfaces that are directly connected to plunger-like means, and
a means of immediately analyzing the speed-related data obtained from such monitoring process;
immediately after the respective analysis of the speed-related data for this canister-like object traveling in a horizontal or semi-horizontal direction is performed, a means of manipulating the speed of such canister-like object, and
whereby the nature of this speed-manipulation system uses counter pressure in relationship to hydraulic pressure to decrease the speed of such canister-like object;
whereupon the required amount of kinetic energy has been extracted from the canister-like object that is traveling in a horizontal or semi-horizontal direction, a horizontal positioning means to move out of the path the canister-like object is traveling along, any components associated with the process that was used to decrease the speed of such canister-like object and whereby before this retraction process takes place, such respective component are in the path the moving canister-like object needs to travel along;
in a totally different area of the overall apparatus, in the pathway section that is the highest pathway section above the top hole-like cut-out area in the fluid column-like pathway section, a pivoting container-like means that is permanently positioned, vertically, according to pre-configured calculations, so that such pivoting container-like means will stop a canister-like object near or at the maximum vertical ascension point, which is the highest vertical point the leading surface of a canister-like object will reach on or around the time when an ascending canister-like object exhausts all of the upward kinetic energy the canister-like object has acquired while ascending through the entire height of the fluid column-like pathway section, and also
whereby this pivoting container-like means is used to alter the direction a canister-like object is pointing, by changing this direction from the canister-like object being pointed straight-up or almost straight-up and having its leading surface at this maximum vertical ascension point to where the canister-like object is pointed at a downward angle, and more specifically, changing the angle of slope of the entire body of the canister-like object to equal or almost equal the angle of slope of the surface of the inclined platform-like structure upon which the canister-like objects are sitting, and also
to have pre-configured the inclined platform-like structure so that the highest point on the surface where the canister-like object are sitting is below the lowest point of this pivoting container-like means, when this pivoting container-like means is fully rotated to the point where the angle of slope of the body of the canister-like object inside this pivoting container-like means equals or almost equals the angle of slope of the surface of the inclined platform-like structure upon which the canister-like objects are sitting, and also
at a point when this pivoting container-like means is fully rotated, and the mouth of such pivoting container-like means is then positioned directly in front of the edge of a vacant canister cue position at the top of the inclined platform-like structure, to retract an upper capture-related means located within this pivoting container-like means so that the canister-like object that is positioned inside such pivoting container-like means can move out of this pivoting container-like means and move into this vacant canister cue position at the top of the inclined platform-like structure.

16. An apparatus for generating electricity, according to claim 15, such apparatus comprising:
with regards to a set of components used after the direction of motion of a canister-like object has been changed from heading in a horizontal or semi-horizontal direction of motion to heading in a vertical or semi-vertical direction of motion, and before the leading surface of such ascending canister-like object is ready to make contact with the bottom surface of a suspended canister-like object, a direction alignment means to align the horizontal position of this ascending canister-like object by having pre-positioned a direction alignment means in a horizontal manner, and
whereby such direction alignment means is located just above the top part of the means that is used to change the direction of motion for the canister-like object from a horizontal or semi-horizontal direction of motion to a vertical or semi-vertical direction of motion, and
whereby this direction alignment means causes the vertical direction of ascension to be such that the center vertical axis of this ascending canister-like object is directly below the center vertical axis of the canister-like object being suspended up above such ascending canister-like object;
after a canister-like object passes through the direction alignment means located just above the top part of the means that is used to change the direction of motion for the canister-like object from a horizontal or semi-horizontal direction of motion to a vertical or semi-vertical direction of motion, but before this canister-like object completely ascends out of this overall area where the direction of motion of the canister-like object has been changed, a means of monitoring the upward speed of this canister-like object, and also
a means of immediately analyzing the speed-related data obtained from such monitoring process;
a means of adjusting the speed of this upwardly moving canister-like object, to either increase that speed, so that the upward force creating such speed for this canister-like object will be enough to propel this canister-like object up to a vertical point where the leading surface of such ascending canister-like object will make contact with the bottom surface of a suspended canister-like object directly up above this ascending canister-like object and also
so that the adjusted upward speed of this canister-like object will be enough to push both canister-like objects up high enough, after this lower canister-like object makes contact with the upper suspended canister-like object, so that the bottom surface of this ascending lower canister-like object will be higher than the topmost part of a coupled canister platform-like component, or
if necessary, to decrease the upward speed of this upwardly moving canister-like object, if it has been determined according to the analysis of the speed-related data that the ascending canister-like object is moving so fast that after making contact with the upper suspended canister-like object, that this ascending canister-like object will push the upper canister-like object so far up into the fluid column-like pathway section that the bottom surface of such upper canister-like object will be pushed higher than the topmost point of the no-leak seal-like component;
as the leading surface of the canister-like object ascends higher than the topmost point of the speed-adjustment means, a means to monitor and analyze the upward speed of the ascending canister-like object again, and if necessary, and based on the second analysis of the upward speed of the canister-like object, to adjust the upward speed of the canister-like object again by using the same means that had previously just adjusted the upward speed of such ascending canister-like object;
a means to detect when the leading surface of an ascending canister-like object is approaching the bottom surface of a stationary suspended canister-like object, and whereby such suspended canister-like object is being held in place by a first canister suspension means that is holding the respective canister-like object in a specific position, vertically, so that: a) some part of the main portion of the body of such suspended canister-like object is making contact with the no-leak seal-like component, b) the top surface of the body of this canister-like object being suspended is sticking up above the no-leak seal-like component by an unspecified distance, and c) the lower portion of such canister-like object is exposed to air or an air-like fluid, and
whereby the vertical position of this means to detect the leading surface of an ascending canister-like object is such that there is enough distance between the first canister suspension means and also enough distance between the canister notch-related suspension means so that after the leading surface of an ascending canister-like object is detected:
a) the first canister suspension means and the canister notch-related suspension means can fully enter the retracted mode, and
b) the canister-like object, after entering a freefall state which occurs after these four suspension-related means have fully retracted, will not drop down so far that the leading surface of such canister-like object goes below the topmost point of the no-leak seal-like component,
before the leading surface of this ascending canister-like object makes contact with the bottom surface of the canister-like object that was in a suspended state, but which was released to enter a freefall state as a result of the leading surface of the respective ascending canister-like object being detected by the related detection means;
a means of electronic communication between the means that detects when the leading surface of an ascending canister-like object is approaching the bottom surface of a suspended canister-like object and:
a) the first canister suspension means, and
b) the canister notch-related suspension means;
as the first canister suspension means is terminating the suspension of the upper canister-like object, and as the leading surface of the ascending canister-like object keeps getting closer to the bottom surface of the canister-like object that was previously suspended, but which is about to enter a freefall state, a means to detect when the bottom surface of the ascending canister-like object has moved in front of such detection means, and
whereby such detection means is positioned, vertically, so that this detection means is approximately at the same vertical position as the topmost point of the coupled canister platform-like component of the overall lower canister platform-like support means;
a means of electronic communication between the means that detects when the bottom surface of an ascending canister-like object has passed in front of such detection means and the horizontal positioning means that moves the overall lower canister platform-like support means, horizontally;
for some portion of time during each repetitive cycle, a lower canister platform-like support means is used, and
for each repetitive cycle, this lower canister platform-like support means will: a) temporarily stay in a fixed vertical position long enough for the bottom surface of a lower canister-like object to make contact with such lower canister platform-like support means, and then b) elevate that lower canister-like object and an upper canister-like object that is sitting directly on top of such lower canister-like object, to a pre-determined vertical point, and then c) temporarily stay in a fixed vertical position long enough for the first canister suspension means to fully extend certain peripheral components of such first canister suspension means, and
whereby these peripheral components will be extended in underneath the bottom surface of a lower canister-like object and will therefore:
a) be able to provide all required vertical support for the respective lower canister-like object, which will
b) allow this lower canister platform-like support means to be repositioned in a downward manner, and to move away from the bottom surface of this respective lower canister-like object, and
whereby at all times while such lower canister-like object is being supported by such lower canister platform-like support means, the respective upper canister-like object will be sitting directly on top of the lower canister-like object, so that this lower canister platform-like support means never elevates just one canister-like object, but is always elevating two canister-like objects, and
whereby before stopping this elevation process for each lower canister-like object in each repetitive cycle, this lower canister platform-like support means always elevates the respective lower canister-like object to the same specific vertical position, which is such that this lower canister-like object is stopped at precisely the vertical position the upper canister-like object was at before such elevation process started;
a coupled canister platform-like component, which is part of the overall lower canister platform-like support means, and
whereby such coupled canister platform-like component is the means that makes contact with the bottom surface of the lower canister-like object;
a vertical positioning means that is attached to the coupled canister platform-like component, and whereby this vertical positioning means is also a part of the overall lower canister platform-like support means, and
whereby this vertical positioning means moves the coupled canister platform-like component, of the overall lower canister platform-like support means, up and down along the vertical axis;
a horizontal positioning means, that moves the coupled canister platform-like component and at the same time moves the vertical positioning means that is attached to such coupled canister platform-like component, back and forth, horizontally, to two specific positions, which are: a) in the extended mode, the centerpoint of the coupled canister platform-like component, of the overall lower canister platform-like support means, is positioned directly below, or almost directly below the centerpoint of the bottom surface of the respective lower canister-like object that will be above the respective coupled canister platform-like component, and b) in the retracted mode, the coupled canister platform-like component, of the overall lower canister platform-like support means is moved completely out of the path a canister-like object needs to take when ascending through the area where this lower canister platform-like support means is located;
a means of electronic communication, going in both directions, between the vertical positioning means that moves the coupled canister platform-like component of the lower canister platform-like support means up and down along a vertical axis, and:
a) the first canister suspension means, and also
b) the canister notch-related suspension means;
whereupon this vertical positioning means that moves the respective coupled canister platform-like component up and down along a vertical axis, elevates the respective coupled canister platform-like component to a pre-determined vertical point, and
whereby such pre-determined vertical point is such that the lower canister-like object is at the same vertical point the upper canister-like object was at before the start of such elevation process, then sets of signals are sent by the respective vertical positioning means to:
a) the first canister suspension means, and
b) the canister notch-related suspension means, and
while these communications are taking place, and while the related actions as a result of these communications are taking place, the lower canister-like object is held at a fixed vertical position by the lower canister platform-like support means;
upon receipt of such signals by the four respective suspension-related means, all such suspension-related means enter the extended mode, and therefore these four suspension-related means take over the responsibility to suspend the respective lower canister-like object, and also at that point, such lower canister-like object is still sitting on, and being vertically supported by, the coupled canister platform-like component;
whereupon each of these four such suspension means becomes extended out to the proper horizontal position, each such suspension means sends a signal to the vertical positioning means that moves the coupled canister platform-like component up and down along a vertical axis, and
upon receipt of all four such signals, this vertical positioning means resets itself and thereby also resets the connected platform-like component, and
whereby such resetting process causes this vertical positioning means to move down to the lowest vertical position available, which is the default vertical position and which is a vertical position where the coupled canister platform-like component is down far enough to be moved in, horizontally, underneath the next canister-like object that, in the next repetitive cycle, can perform a coupling event with the canister-like object that is currently being suspended by the respective suspension means;
a means of electronic communication between the vertical positioning means of the lower canister platform-like support means and the horizontal positioning means of the lower canister platform-like support means, and after the vertical positioning means has reset itself, and has moved the coupled canister platform-like component downward to the lowest possible vertical point available, a signal is sent by the vertical positioning means to the horizontal positioning means, and this signal causes the horizontal positioning means to retract the one or more pieces of the coupled canister platform-like component back out of the way of the path the next canister-like object will need to use in order to establish the necessary relationship between an upper canister-like object and a lower canister-like object, as the same exact coupling event occurs in the next repetitive cycle.

17. An apparatus for generating electricity, according to claim 16, such apparatus comprising:
in the pathway section that is the highest pathway section above the top hole-like cut-out area in the fluid column-like pathway section, but below where a canister-like object enters into a pivoting container-like means,
a means to monitoring the speed of such ascending canister-like object, and also
a means to immediately analyze the results of the acquired speed-related data;
immediately after analysis of the speed-related data for the canister-like object is performed, manipulating the speed of such canister-like object to ensure the canister-like object has enough upward speed so that the leading surface of such canister-like object will reach a maximum vertical ascension point that is at least as high as an upper capture-related means that is a part of such pivoting container-like means,
or to decrease the upward speed of the respective canister-like object if it is determined the canister-like object is ascending too fast and there is potential for damage, by the ascending canister-like object, to any components of the apparatus;
with regards to the pivoting container-like means of claim 21, when the vertical position of the leading surface of an ascending canister-like object is at or near the maximum vertical ascension point the canister-like object can possibly ascend to, a pre-positioned pivoting container-like means to stop the canister-like object from ascending further and to subsequently capture the canister-like object inside of such pivoting container-like means, and where such pivoting container-like means also includes having an upper capture-related means and a lower capture-related means, and
whereby the distance between the bottommost point of the upper capture-related means and the topmost point of the lower capture-related means is slightly more than the distance between the bottom surface and the top surface of a canister-like object, and
whereby both such upper capture-related means and lower capture-related means have a shock absorber-like component, that allows the impact of the top surface or bottom surface of a captured canister-like object, on these upper and lower capture-related means, to be minimized, and
whereby for each repetitive cycle, before a canister-like object approaches the pivoting container-like means, the upper capture-related means is pre-configured to have certain moveable parts in the extended mode, so that these parts will be blocking the path a canister-like object would need to take to move beyond the top of this pivoting container-like means, when such pivoting container-like means is positioned straight-up, vertically, and also
for each repetitive cycle, before a canister-like object approaches the pivoting container-like means, the lower capture-related means is pre-configured to have certain moveable parts in the retracted mode, so that these parts will be not be blocking the path a canister-like object needs to take to enter this pivoting container-like means from the bottom of such pivoting container-like means, and
whereby such pivoting container-like means is attached to a rotational means;
a pressure sensor-like means attached to such upper capture-related means, so that this pressure sensor-like means can detect when a leading surface of an ascending canister-like object is making contact with such upper capture-related means;
electronic communication between this pressure sensor-like means and the lower capture-related means, so that once the pressure sensor-like means detects that the leading surface of an ascending canister-like object is making contact with the upper capture-related means, at that point this pressure sensor-like means can send a signal to the lower capture-related means causing such lower capture-related means to extend a portion of such lower capture-related means into the pathway the captured canister-like object would need to take in order for the canister-like object to fall out the bottom of this pivoting container-like means;
electronic communication between this pressure sensor-like means and the lower capture-related means, so that once the pressure sensor-like means detects that the leading surface of an ascending canister-like object is making contact with the upper capture-related means, at that point this pressure sensor-like means can send a signal to the lower capture-related means causing such lower capture-related means to extend a portion of such lower capture-related means into the pathway the captured canister-like object would need to take in order for the canister-like object to fall out the bottom of this pivoting container-like means;
electronic communication between lower capture-related means and the rotational means, so that once the lower capture-related means has gone into the extended mode, a signal is sent from the lower capture-related means to the rotational means, so that the rotational means begins rotating the pivoting container-like means;
electronic communication between the rotational means and the upper capture-related means, so that once the pivoting container-like means has been rotated to the pre-determined angle of slope, which is an angle of slope that equals or approximately equals the angle of slope of the inclined platform-like structure, a signal is sent from the rotational means to the upper capture-related means that will force such upper capture-related means to retract a portion of such upper capture-related out of the path the canister-like object needs to move along in order for the canister-like object to fall out the top of this pivoting container-like means, and
whereby at that point this pivoting container-like means is in a downward-sloping position so that when the container slides out of this pivoting container-like means this canister-like object will directly move into the topmost vacant canister cue position on the inclined platform-like structure.

18. An apparatus for generating electricity, according to claim 16, such apparatus comprising:
a multi-rail curved non-enclosed pathway section, and
whereby such multi-rail curved non-enclosed pathway section begins at a point just above the exit area of the fluid column-like pathway section, and whereby such exit area is the topmost hole-like cut-out area of this pathway section, and
whereby such multi-rail curved non-enclosed pathway section ends at a specific point so that any canister-like object exiting this multi-rail curved non-enclosed pathway section will be aligned with the topmost canister cue position on the inclined platform-like structure, and
this multi-rail curved non-enclosed pathway section, for the most part, is continuously curving and continuously sloping upward, and
whereby such multi-rail curved non-enclosed pathway section comprises three or more guide rails, and a canister-like object travels along and between the pathway configuration that is created from using the inner edges of such respective guide rails, and
whereby the minimum inner distance of such pathway configuration, between the inner edges of all the guide rails, is greater than the maximum width or maximum diameter of a canister-like object, and
whereby these guide rails are surrounded, except for any connecting components or except for any mounting components, by air or by an air-like fluid;
at a point near the top of this multi-rail curved non-enclosed pathway section, and
around the time a canister-like object has attained a direction of motion that is almost horizontal, a means of monitoring the speed of the canister-like object, and also
a means of immediately analyzing the speed-related data obtained from such monitoring process;
immediately after the speed-related data obtained from the monitoring process has been analyzed, and also
a short distance after the horizontal point where the respective canister-like object passed in front of the means that has just monitored the speed of such canister-like object, a means to adjust the speed of the moving canister-like object and
whereby such speed-adjusting means will either increase the speed the canister-like object has, so that the canister-like object will be able to successfully move from the multi-rail curved non-enclosed pathway section into the topmost canister cue position on the inclined platform-like structure, or
will decrease the speed the canister-like object has, so that the canister-like object, upon having moved from the multi-rail curved non-enclosed pathway section and onto the inclined platform-like structure, will not be going so fast as to cause damage to any equipment on the inclined platform-like structure or to cause damage to any other canister-like objects sitting on the inclined platform-like structure.

19. An apparatus for generating electricity, according to claim 16, such apparatus comprising:
near the top of the fluid column-like pathway section, an enlarged uppermost section of the fluid column-like pathway section, and whereby such enlarged uppermost section of the fluid column-like pathway section is big enough to accommodate two individual vertical pathways, and
whereby each such vertically-oriented pathway has a direction-altering means that guides a moving canister-like object into a set of vertically-oriented direction alignment means, and
whereby each set of set of vertically-oriented direction alignment means, is directly underneath an individual pivoting container-like means, and
whereby all components located in such enlarged uppermost section of the fluid column-like pathway section are surrounded by the water-like non-air fluid held in the fluid column-like pathway section, except at points where connections are made to other components, and
the enlarged uppermost section of the fluid column-like pathway section is an extension of the tight portion of the fluid column-like pathway section, so that the top exit area of such tight portion of the fluid column-like pathway section leads seamlessly into the bottom of the enlarged uppermost section of the fluid column-like pathway section, and therefore there is only one exit area out of the tight portion of the fluid column-like pathway section, where all canister-like objects ascend through, even though all such ascending canister-like objects are then distributed into the two individual vertically-oriented pathways;
a canister-like object moving from this exit area into the enlarged uppermost section of the fluid column-like pathway section is continuously surrounded by the water-like non-air fluid, while in these areas, and also
since the tight portion of the fluid column-like pathway section and the enlarged uppermost section of the fluid column-like pathway section are actually each part of one larger reservoir that is filled with a water-like non-air fluid, all canister-like objects have buoyancy and other pressure differential forces acting with a composite upward force on the bottom surface of such canister-like object while in each of these sections of the overall fluid column-like pathway section;
two direction-altering means, whereby each such individual direction-altering means changes the direction of motion for a canister-like object that has just passed through the exit area at the top of the tight section of fluid column-like pathway section, and
whereby each such direction-altering means alters the direction of motion for a respective canister-like object from a vertical or almost vertical direction to a more angled direction, and
it is the underside of each such means that actually makes contact with the surface of a canister-like object and causes the change in direction to occur, and also
these two separate and individual direction-altering means share the same exit area at the top of the tight section of fluid column-like pathway section, and
this sharing process is performed on a canister-object by canister-object basis, so that the path of motion for one canister-like object is altered by one such direction-altering means and then the path of motion of the next canister-like object is altered by the other such direction-altering means;
a motion sensor-like means, and
whereby such motion sensor-like means is permanently positioned so that just prior to the point when the leading surface of an ascending canister-like object begins passing through the exit area at the top of the tight section of fluid column-like pathway section, the monitoring process occurs, and also
a means to analyze the speed-related data obtained from such monitoring process;
one or more components that can create, maintain, and terminate electromagnetic fields, and
whereby each of the two direction-altering means has its own related set of these components that can create these electromagnetic fields are attached to or situated upon, and
whereby according to the analysis of the speed-related data for an ascending canister-like object, the electromagnetic fields created by these components that can produce electromagnetic fields will cause an ascending canister-like object to be temporarily repelled away from the underside of the respective direction-altering means, and therefore no damage occurs to the underside of such direction-altering means because there is never any strong contact made between an underside surface of a direction-altering means and some portion of the body of an ascending canister-like object;
a means to cause the vertical alignment of an ascending canister-like object to be changed even more towards a perfectly vertical direction, after the leading surface of such canister-like object has moved just beyond the topmost point of the direction-altering means that has initially caused the direction of motion to be changed for the canister-like object, and
whereby this additional change to the direction of motion for this respective canister-like object is such that the canister-like object will be heading in a perfectly vertical direction, or almost perfectly vertical direction, at a point in time before such canister-like object exits out of the enlarged uppermost section of the enlarged uppermost section of the fluid column-like pathway section;
for the two direction-altering means, a separate horizontal-positioning means attached to each of these individual direction-altering means, and whereby each such horizontal-positioning means repositions the attached direction-altering means, and at the same time, re-positions certain peripheral equipment attached to the respective direction-altering means;
for the two individual direction-altering means, a system related to time and with respect to the repetitive cycle of the apparatus, whereby each of these two such direction-altering means are re-positioned in an alternating manner, so that first the bottom surface of one such direction-altering means is positioned directly over the exit area of the tight portion of the fluid column-like pathway section, thus forcing the next canister-like object that ascends out of that exit area to continue ascending in a path that moves along the underside of such direction-altering means, and then at the proper time, to move the direction-altering means that is positioned over the exit area far enough away from the exit area so the other direction-altering means can be moved directly over the top of this exit area for the of the tight portion of the fluid column-like pathway section, and therefore
this other direction-altering means will interact with the next canister-like object that will be ascending through such exit area for the tight portion of the fluid column-like pathway section, and
whereby the proper time to re-position both of these direction-altering means occurs after the leading surface of an ascending canister-like object has moved along the entire underside of a direction-altering means, and then
that canister-like object has continued ascending further so that the bottom surface of that canister-like object has ascended higher than the topmost point of the direction-altering means that has just been interacting with such canister-like object;
in another pathway section near the very top of the overall apparatus, at or around the vertical point where the leading surface of a canister-like object has almost ascended to the maximum vertical ascension point the canister-like object can ascend to, an upper capture-related means, that is part of the overall pivoting container-like means, to stop the canister-like object from going past that maximum vertical ascension point, and also
within such pivoting container-like means, a lower capture-related means, to stop the bottom surface of the respective canister-like object from falling back down very far below the vertical height the bottom surface of such canister-like object was at when the canister-like object was stopped from ascending any further;
shortly after a canister-like object has been confined inside a pivoting container-like means, a means to rotate the pivoting container-like means the canister-like object is being held in, and
to rotate such pivoting container-like means towards the inclined platform-like structure, so that what was the top of the pivoting container-like means, after becoming fully rotated, is pointing at a downward angle towards the inclined platform-like structure;
a system to continue rotating such pivoting container-like means until the point where the angle of slope of the pivoting container-like means is approximately equal to the angle of slope of the inclined platform-like structure;
an inclined platform sliding canister holder section means, and whereby such means is a moveable extension of the inclined platform-like structure, and also
this inclined platform sliding canister holder section means receives respective canister-like objects that come sliding out of each of the two pivoting container-like means, and whereby such inclined platform sliding canister holder section has the ability to move, horizontally;
a means to increase the speed of a canister-like object as such canister-like object is exiting out of the downwardly-sloping pivoting container-like means and moving onto the inclined platform sliding canister holder section;
a means to re-position the inclined platform sliding canister holder section, so that such inclined platform sliding canister holder section can be moved a total of four times over every two repetitive cycles, which includes being moved one time directly in front of each of the two pivoting container-like means, after these individual pivoting container-like means have been fully rotated, at different times, towards the inclined platform-like structure, and being moved twice so that the bottom portion of the inclined platform sliding canister holder section where a canister-like object slides out of is directly in front of the topmost point of the inclined platform-like structure where a canister-like object slides into;
a means to detect exactly when the leading surface of a canister-like object is moving in front of such motion sensor-like means, and
whereby such motion sensor-like means is located near the top of the inclined platform sliding canister holder section, and
a means for this motion sensor-like means to send a related signal to one of the electromagnetic-related means that has the ability to increase or decrease the downward speed of the respective canister-like object, as this canister-like object moves further down the inclined platform sliding canister holder section;
a means to increase or decrease the speed at which the canister-like object is moving downward on the inclined platform sliding canister holder section, and whereby such means creates an electromagnetic field that will cause the downward speed of the canister-like object to be decreased immediately after receipt of the related signal sent by the respective motion sensor-like means located near the topmost point of the inclined platform sliding canister holder section;
after the canister-like object has moved further down on the inclined platform sliding canister holder section, a spring-related means to reduce the downward speed at which a canister-like object is moving, and to continue reducing such speed, in incremental fashion, until all initial downward momentum the canister-like object had before making contact with such speed-reduction means is cancelled out, leaving the canister-like object with basically only the force of gravity pulling the canister-like object downward along the remainder of the inclined platform sliding canister holder section;
whereupon first contact is made between this spring-related means being used to reduce the downward speed at which a canister-like object is moving, allowing electronic communication between such spring-related means,
whereby this spring-related means sends out four independent signals: one signal to the rotation-like means connected to the container-like component, one signal to the upper capture-related means and one signal to the lower capture-related means that are peripheral equipment of the respective pivoting container-like means, and one signal to a horizontal positioning means that moves the entire inclined platform sliding canister holder section, and
upon receipt of the respective signal by the rotational means connected to the container-like component, the pivoting container-like means is re-rotated so that such pivoting container-like means returns to the vertically upright position, and
upon receipt of the respective signals by the upper and lower capture-related means, these two means respectively reset, so that the upper capture-related means is re-positioned to the fully extended mode and the lower capture-related means is re-positioned to the fully retracted mode, and
upon receipt of the respective signal by the horizontal positioning means that moves the entire inclined platform sliding canister holder section, this horizontal positioning means moves the entire inclined platform sliding canister holder section so that the lower portion of this inclined platform sliding canister holder section comes into perfect alignment with the top canister cue position on the inclined platform-like structure;
a means to pull the components that were used to slow the downward speed of the respective canister-like object, out of the way so that the respective canister-like object can continue moving down the inclined platform sliding canister holder section, and
using the same means to push these components that were used to slow the downward speed of the respective canister-like object back up into their original vertical default position;
a means to detect when the bottom surface of a canister-like object has moved off of the inclined platform sliding canister holder section, and
a means to have such motion sensor-like means, upon detecting that the bottom surface of a canister-like object has moved off of the inclined platform sliding canister holder section, send a signal to the component that positions and re-positions the inclined platform sliding canister holder section.

20. An apparatus for generating electricity, according to claim 15, such apparatus comprising:
a means to alter the direction of motion of a canister-like object that is heading in a horizontal or semi-horizontal direction, so that such direction of motion is changed from such horizontal or semi-horizontal direction to an upward vertical or semi-vertical direction, and
using two individual sets of direction-altering equipment to perform such changes in the direction of motion to canister-like objects, and
whereby there is a system that acts over two repetitive cycles of canister-like object movement, so that as one canister-like object enters the area where these two individual sets of direction-altering equipment are located, the direction of motion of such canister-like object is altered to ascend up through one set of direction-altering equipment and then for the next canister-like object entering this area where these two individual sets of direction-altering equipment are located, for the next repetitive cycle, the direction of motion of that next canister-like object is altered by the other set of direction-altering equipment, and
whereby relative to the direction a canister-like object is moving as the canister-like object is approaching these two individual sets of direction-altering equipment, the second set of direction-altering equipment is directly past, but is also directly in line with, the first set of direction-altering equipment, so that a canister-like object that is not ascending up into the first set of direction-altering equipment proceeds along the same natural horizontal or semi-horizontal pathway upon which the canister-like object is moving, and then as the canister-like object moves further, the canister-like object begins ascending up into the second set of direction-altering equipment;
a pullout section comprised of several attached passive rollers, and whereby when such pullout section of passive rollers is fully retracted out of the pathway a canister-like object would use to ascend up into the first set of direction-altering equipment, the vacant area created by the removal of such pullout section of passive rollers allows access for the canister-like object to move past the first set of direction-altering equipment, without ascending up into such first set of direction-altering equipment, and forces this canister-like object to ascend up into the second set of direction-altering equipment, and
whereby such pullout section of passive rollers is part of the first set of direction-altering equipment, and also
whereby the total height, going in a vertical direction, of the overall pullout section of passive rollers is slightly greater than the height of the body of a canister-like object, as such canister-like object is moving in a horizontal or semi-horizontal direction;
a set of a few passive rollers that are permanently mounted at the bottom of the vacant area that exists in the first section of direction-altering equipment whenever the pullout section of passive rollers is in the retracted mode, and also
whereby such set of passive rollers are aligned in a horizontal manner, one after another, and
during the time the pullout section of passive rollers is in the retracted mode, these permanently mounted passive rollers provide a short horizontal or semi-horizontal pathway section upon which a canister-like object can travel in order to move completely past the first set of direction-altering equipment and reach the second set of direction-altering equipment;
a horizontal positioning means to pull the pullout section of passive rollers out of the pathway a canister-like object travels along, and also
after having pulled such pullout section of passive rollers out of the pathway a canister-like object travels along, using the same horizontal positioning means, at the proper time, to push the pullout section of passive rollers forward and move this pullout section of passive rollers back into the position the passive rollers were in before these passive rollers were pulled out of the pathway, in the first set of direction-altering equipment, a canister-like object travels along, and
after this pullout section of passive rollers is re-positioned and all of the passive rollers are pushed back into the overall configuration of passive rollers in the first set of direction-altering equipment, the direction of motion of the next canister-like object is altered from a horizontal or semi-horizontal direction to an upward vertical or semi-vertical direction of motion by this first set of direction-altering equipment, and such change in the direction of motion for that next canister-like object occurs just as if the pullout section of passive rollers had never been retracted;
a means to detect, through use of a motion sensor-like means, when the leading surface of a canister-like object has moved past such motion sensor-like means, and also by using the same motion sensor-like means, to detect when the bottom surface of a canister-like object has moved past such motion sensor-like means, and
whereby the first set of direction-altering equipment and the second set of direction-altering equipment has its own individual motion sensor-like means functioning as a part of the respective set of direction-altering equipment, and
whereby each of the two individual motion sensor-like means is attached at or attached around the same vertical position as where the other motion sensor-like means is located, vertically, in the other direction-altering set of equipment;
independent electronic communication between each of the two motion sensor-like means that are mounted on and are a part of each of the two direction-altering sets of equipment and the horizontal positioning means attached to the pullout section of passive rollers;
whereupon the detection of the bottom surface of a canister-like object occurs by the motion sensor-like means located in the first set of direction-altering equipment, at a very short pre-determined point in time after such detection of the bottom surface of a canister-like object has occurred, this motion sensor-like means sends a signal to the horizontal positioning means that moves the pullout section of passive rollers back and forth, horizontally, and
whereupon such horizontal positioning means attached to the pullout section of passive rollers, receives such this signal from the motion sensor-like means located in the first set of direction-altering equipment, this horizontal positioning means retracts the pullout section of passive rollers to the point where all of these passive rollers are out of the pathway the next canister-like object will be heading towards when such next canister-like object enters the area where these two sets of direction-altering equipment are located, and also
whereupon the detection of the bottom surface of a canister-like object occurs by the motion sensor-like means located in the second set of direction-altering equipment, at a very short pre-determined point in time after such detection of the bottom surface of a canister-like object has occurred, a means for this motion sensor-like means in the second set of direction-altering equipment to send a signal to the horizontal positioning means that moves the pullout section of passive rollers back and forth, horizontally, and
whereupon such horizontal positioning means for the pullout section of passive rollers receives such signal from the motion sensor-like means located in the second set of direction-altering equipment, this horizontal positioning means will push the pullout section of passive rollers forward so that all of the related passive rollers are moved back into the overall configuration of passive rollers in the first set of direction-altering equipment;
a means of properly aligning the direction of motion of a canister-like object by pre-positioning a permanently mounted direction alignment means in a horizontal manner, and
whereby an identical direction alignment means is positioned just above the topmost point of each respective direction-altering set of equipment, and
whereby each such respective direction alignment means is constructed so that it has a circular-like hole in the middle of it, or has a cut-out hole area approximately just slightly larger than the shape of the outer body of a canister-like object when that canister-like object is traveling vertically or traveling almost vertically in an upward direction, and
whereby as a result of a canister-like object passing through such circular-like hole in the respective direction alignment means, the vertical axis and the direction of motion of such canister-like object will become aligned, or as closely as possible aligned in such a way that the respective ascending canister-like object will be positioned directly below, and pointed directly towards the center of a respective hole-like means that is cut-out of a floor-like component above the ascending canister-like object, and
whereby such respective hole-like means is the first component an ascending canister-like object comes to when such canister-like object ascends beyond and above the overall area where the two sets of direction-altering equipment are located and thereby ascends up into the next pathway section;
after a canister-like object passes through the respective direction alignment means that is located just above the topmost point of the respective direction-altering set of equipment the canister-like object has just ascended through, but before such canister-like object ascends up into the circular hole-like means for the next pathway above the ascending canister-like object, a means of monitoring the upward speed of this upwardly-moving canister-like object, and also
a means of immediately analyzing the speed-related data obtained from such monitoring process;
a means to adjust the upward speed of an upwardly moving canister-like object, to either increase that speed, so that the upward force creating such speed for the canister-like object will be enough to propel such canister-like object up to the maximum height of ascension that will be reached near the top of the next pathway section, and more specifically,
so that the bottom surface of the ascending canister-like object, in the next pathway section, will be higher than the topmost point of any equipment attached to the respective platform-like support component in that next pathway section that is located above such speed-adjusting means, or
if necessary, to decrease the upward speed of an upwardly moving canister-like object in the event that if the upward speed of the canister-like object is not adjusted, such non-adjusted speed will cause the canister-like object to ascend a considerable distance further than expected before reaching a maximum height of ascension;
above each of the two individual sets of direction-altering equipment, two individual vertical pathways, each with an array of specifically positioned and specifically configured equipment, and
whereby each of these vertical pathways is separate from the other vertical pathway, except for a common floor-like component shared by both vertical pathways and except for a positioner backstop-like stabilizer means that is used in each of the separate pathways in an alternating manner, and
whereby such alternating manner refers to how this positioner backstop-like stabilizer means is used in the upper portion of a particular pathway to stabilize a canister-like object being transported, horizontally, and then this same positioner backstop-like stabilizer means is used in the upper portion of the other pathway to stabilize the next canister-like object, from the next repetitive cycle, that is being transported, horizontally, from the other vertical pathway;
for each of the two individual vertical pathways, canister-like objects ascending through both of these individual pathways ascend through air or an air-like fluid, and
each individual vertical pathway has an overall set of equipment that is more or less identical to the set of equipment that is in the other vertical pathway, except that certain identical pieces of equipment are the same shape and size, but are the mirror image of their identical counterparts, and
whereby all or most of the equipment used in one vertical pathway, is at the same vertical height, or almost the same vertical height, as the same type of equipment that is used in the other pathway;
a floor-like component that provides a foundation upon which all or most of the equipment in both pathways is mounted and supported;
an individual hole-like means, cut out of the floor-like component, for each vertical pathway, and
whereby each of these individual hole-like means is located at the bottom of each individual vertical pathway, and
whereby each such individual hole-like means allows a respective canister-like object to ascend through such hole-like means and each of the respective individual hole-like means provides entry into the respective vertical pathway so that an ascending canister-like object can continue ascending up further through the respective vertical pathway;
a motion sensor-like means for each vertical pathway, and whereby each motion sensor-like means is positioned just slightly above the top of the respective hole-like means, for each respective vertical pathway, that is cut-out of the common floor-like component, and
whereby each such motion sensor-like means, for each vertical pathway, has the ability to send signals to other components in the respective set of equipment for that respective vertical pathway;
a platform-like support component for each pathway, comprising:
a horizontal, or almost horizontal platform floor-like component, that primarily acts as a floor-like component for the overall platform-like support component,
a means to help hold the bottom portion of a canister-like object on the platform floor-like component,
a means to allow a canister-like object to slide off of such platform floor-like component, horizontally, and
whereby this overall slide-related means can include the use of round semi-sphere-like objects that are permanently fixed and permanently mounted onto the top of the platform floor-like component of the overall platform-like support component,
a means to help cushion the downward impact that occurs when a canister-like object falls back down onto the platform floor-like component of the overall platform-like support component, and
a means to connect the overall platform-like support component to the respective arm that is connected to a respective rotational means that rotates the respective platform-like support component;
for each platform-like support component for each vertical pathway, an individual and separate means in each vertical pathway to rotate the respective platform-like support component, comprising:
the rotational means, itself, and
an arm that connects the means to rotate the respective platform-like support component to the respective platform-like support component;
an individual means, for each of the individual connecting arms for each of the rotational means, that supports the respective connecting arm;
for whichever pathway that the next canister-like object will be ascending up through, and whereby such next canister-like object will first be passing through the respective hole-like means that is cut-out of the common floor between the two vertical pathways, to have previously rotated the platform-like support component to a horizontal point whereby such platform-like support component is completely out of the path that the next canister-like object will need to use in order to ascend further up into that next related pathway;
for each vertical pathway, a means to support all of the equipment in the upper portion of the respective vertical pathway;
for each vertical pathway, a means to stop any further upward motion by a canister-like object at or around the pre-determined maximum vertical ascension point, which occurs at a vertical point where a canister-like object has ascended through the entire vertical distance of a related vertical pathway;
a means to temporarily suspend or slow down the motion of descent of a canister-like object that has just been stopped at or around the maximum vertical ascension point for the ascending canister-like object, and
a means, according to a time delay that is based around the analysis of the speed-related data performed by the motion sensor-like means that is positioned just slightly above the top of the respective hole-like means that is cut-out of the common floor-like component between the two vertical pathways, to re-position the respective platform-like support component, by a rotational process, so that the respective platform-like support component is rotated to the proper position at the proper time, and
whereby such proper time is to commence such rotational process immediately after the bottom surface of any ascending canister-like object has passed higher than the topmost point of any piece of equipment attached to the respective platform-like support component, and
whereby the proper position is to rotate the respective platform-like support component to a point where the center of such rotated platform-like support component is directly below, or almost directly below, the center of the bottom surface of the canister-like object that is being suspended above such platform-like support component or that is descending slowly towards such platform-like support component;
electronic communication between the respective rotational means, in each vertical pathway for the respective platform-like support component and the means, for that respective vertical pathway, that is temporarily suspending or slowing down the motion of descent of a respective canister-like object;
after such respective platform-like support component has been rotated in underneath the bottom surface of the respective canister-like object, which is the canister-like object being suspended above, or that is descending slowly towards, that platform-like support component, a means to cause the electromagnetic fields that are suspending the canister-like object to be terminated or to be gradually faded out, so that such previously suspended canister-like object can descend down onto or fall back down onto the platform-like support component that has been re-positioned and rotated to be directly below such falling canister-like object;
a means to support, even if such means extends from one pathway to the other, any and all equipment that will be used to stabilize the upper portion of a canister-like object, while such canister-like object is being transported from the central vertical portion of a vertical pathway over towards the coupled canister platform-like component, and
whereby such coupled canister platform-like component is located between the two vertical pathways;
after waiting until the respective canister-like object has fallen back down onto the respective platform-like support component, a means to stabilize, in a synchronized manner, the upper portion of such canister-like object throughout the entire time the lower portion of this canister-like object is being rotated towards a coupled canister platform-like component, and
whereby such overall stabilizing means has an outer stabilizing component, which is on the side of the canister-like object that is furthest away from the coupled canister platform-like component, and a positioner backstop-like stabilizer means which is located on the side of the canister-like object that is closest to the coupled canister platform-like component, and
whereby each of the stabilizing components applies pressure to the outer surface of the body of the canister-like object being stabilized, so that the stabilizing components on one side of the body of the canister-like object are pushing in towards the stabilizing components on the other side of the body of the canister-like object, and therefore a stabilizing effect is felt by such upper portion of the body of a canister-like object because the upper body of such canister-like object is essentially trapped in between all of the stabilizing components;
a coupled canister platform-like component, which only moves in a vertical manner, and which is totally different and separate from the two platform-like support components that are used to transport canister-like objects, horizontally, from the two vertical pathways over towards this coupled canister platform-like component, and
whereby such coupled canister platform-like component has a means to help keep a canister-like object in the proper horizontal and vertical position when such canister-like object is being moved onto, or is totally sitting on, this coupled canister platform-like component, and more specifically,
such coupled canister platform-like component has a guide rail in front and a guide rail in back, but on each side of this coupled canister platform-like component there are no direction guidance means of any kind, because all canister-like objects being transferred from either of the two platform-like support components will be transferred onto this coupled canister platform-like component from either one side or the other of this coupled canister platform-like component,
and therefore the sides of this coupled canister platform-like component are clear and unobstructed for a distance slightly greater than the width or depth of a canister-like object when such canister-like object is pointed in a straight-up manner, and
because both sides of this coupled canister platform-like component are clear, a canister-like object can be transferred onto this coupled canister platform-like component from either of the two pathways, and
whereby such coupled canister platform-like component has a floor-like component that has a means, which can include the use of round semi-sphere-like objects that are permanently fixed and permanently mounted onto the top of this floor-like area, so that the bottom surface of a canister-like object can move easily across such floor-like area of this coupled canister platform-like component;
a vertical positioning means that is connected to this coupled canister platform-like component, and
whereby such vertical positioning means has the ability to move the coupled canister platform-like component up and down, along a vertical axis;
after a platform-like support component has been rotated as far as possible and the edge of such platform-like support component has made contact with the edge of the coupled canister platform-like component, at that time even though the canister-like object is no longer being moved horizontally by rotating the platform-like support component that this canister-like object is sitting on, the outer stabilizing component of the overall stabilizing means converts from a stabilizing means to a transport means, and
this outer stabilizing component continues moving in the same direction, horizontally, and such continued motion results in a pushing effect being felt by the canister-like object, even though the canister-like object is only being pushed from the upper portion of the body of the canister-like object, and
such horizontal pushing motion continues in the same direction until the respective canister-like object is completely moved from the platform-like support component onto the coupled canister platform-like component, and
as this pushing motion is executed, the positioner backstop-like stabilizer means continues moving in a synchronized manner with the outer stabilizing component, and such positioner backstop-like stabilizer means continues providing counter pressure to the horizontal pushing forces being applied to the canister-like object by the outer stabilizing component;
electronic communication between the positioner backstop-like stabilizer means of the overall stabilizing means for the upper portion of a canister-like object and the rotational means connected to the respective platform-like support component;
the positioner backstop-like stabilizer means knows, according to horizontal positioning, when the respective canister-like object has been moved completely onto the coupled canister platform-like component, and
whereupon this horizontal pushing movement is completed, a signal is sent from the positioner backstop-like stabilizer means to the rotational means connected to the respective platform-like support component, and
upon receipt of such signal by the rotational means connected to the respective platform-like support component, this same respective rotational means resets the respective platform-like support component to the horizontal position where such platform-like support component is completely on the other side of the respective hole-like cut out area of the floor-like component;
once the canister-like object has been moved from the respective platform-like support component onto the coupled canister platform-like component, the positioner backstop-like stabilizer means continues moving a slight distance more in the same direction to clear itself of the canister-like object and also to reach the necessary horizontal position so that the next canister-like object, which will be coming from the other vertical pathway, can be successfully moved onto the coupled canister platform-like component;
electronic communication between the positioner backstop-like stabilizer means of the overall stabilizing means for the upper portion of a canister-like object and the vertical positioning means that is connected to the coupled canister platform-like component, and
whereupon the positioner backstop-like stabilizer means of the overall stabilizing means has moved to the pre-determined horizontal point where such positioner backstop-like stabilizer means is clear of the respective canister-like object, then such positioner backstop-like stabilizer means sends a signal to the vertical positioning means connected to the coupled canister platform-like component, and
this positioner backstop-like stabilizer means has the ability to send the same type of signal to the vertical positioning means connected to the coupled canister platform-like component, regardless of which vertical pathway a canister-like object has been moved from, and also
whereupon such signal from the positioner backstop-like stabilizer means is received by this vertical positioning means, this vertical positioning means begins ascending, which also moves the canister-like object that is sitting on the coupled canister platform-like component at the same speed and for the same vertical distance, and
whereby the leading surface of the respective canister-like object is ascending towards the bottom surface of another canister-like object that is being held in suspension above the respective canister-like object that is sitting on the coupled canister platform-like component, and
whereby this upper canister-like object is being held in suspension at a specific position, vertically, so that: a) some part of the main portion of the body of the suspended canister-like object is making contact with the no-leak seal-like component, b) the top surface of the body of this suspended canister-like object is sticking up above the no-leak seal-like component by an unspecified distance, and c) the lower portion of such canister-like object is exposed to air or an air-like fluid;
electronic communication, going in both directions, between the vertical positioning means that moves the coupled canister platform-like component up and down along a vertical axis, and:
a) the firsts canister suspension means, and
b) the canister notch-related suspension means;
whereupon this respective vertical positioning means elevates the coupled canister platform-like component to a pre-determined vertical point, which is where there is light contact between the leading surface of the ascending canister-like object and the bottom surface of the suspended canister-like object, this vertical positioning means sends two sets of signals, which are:
a) signals sent to the first canister suspension means, which immediately causes this suspension means to enter the retracted mode and to retract certain peripheral components of such suspension means out from underneath the bottom surface of the suspended canister-like object, and
b) signals sent to the canister notch-related suspension means, which immediately causes this suspension means to enter the retracted mode and to retract certain peripheral components out of and away from the notch of the suspended canister-like object, and
the result of these actions by these suspension-related means allow this upper canister-like object the ability to move freely, along a vertical axis, but no vertical motion occurs for this upper canister-like object, because this upper canister-like object is sitting directly on top of a lower canister-like object, and such lower canister-like object is the canister-like object sitting directly on top of the coupled canister platform-like component;
whereupon each of these four such suspension means have completely entered the retracted mode and therefore all such suspension-related components are clear of the respective canister-like object, respective signals are sent by each of these four suspension means to the vertical positioning means that moves the coupled canister platform-like component of the overall lower canister platform-like support means up and down along a vertical axis, and
upon receipt of all four such signals by this vertical positioning means, the coupled canister platform-like component and both canister-like objects being vertically supported by this coupled canister platform-like component are elevated to a pre-determined vertical point, and this pre-determined point is such that when the vertical positioning means stops elevating the two canister-like objects, the lower canister-like object is at the precise vertical elevation the upper canister-like object was at when such upper canister-like object was being suspended by the related first canister suspension means;
whereupon the elevation process is stopped, the respective vertical positioning means that has been elevating the coupled canister platform-like component sends two sets of signals, which are:
a) signals sent to the first canister suspension means, which immediately causes this suspension means to enter the extended mode and to extend certain peripheral components of such suspension means in underneath the bottom surface of the suspended canister-like object, and
b) signals sent to the canister notch-related suspension means, which immediately causes this suspension means to become fully extended out to the point where such components are applying light horizontal pressure to the notch of the respective canister-like object, and the result of this light horizontal pressure is to keep the respective canister-like object in perfect alignment, horizontally, and to perform this task by using this canister notch-related suspension means, so that the no-leak seal-like component does not have to perform such horizontal alignment task on this canister-like object;
whereupon each of these four such suspension means have completely entered the extended mode, each such suspension means sends a signal to the respective vertical positioning means that moves the coupled canister platform-like component of the overall lower canister platform-like support means up and down along a vertical axis, and
upon receipt of all four such signals by this respective vertical positioning means, this vertical positioning means resets itself, and this resetting process involves causing this vertical positioning means to move downward to the lowest vertical position available, which is the default vertical position and which is a vertical position whereby the coupled canister platform-like component is at the same vertical position as when the canister-like object was transferred from the platform-like support component onto this coupled canister platform-like component, and
this vertical position is also the required vertical position so that the same exact kind of transfer can be made by the other platform-like support component in the other pathway, but where this next canister-like object being transferred will be pushed onto this coupled canister platform-like component from the opposite side of this coupled canister platform-like component.
